(19) United States
(12) Patent Application Publication
(10) Pub. No.: US 2018/0032997 A1
(43) Pub. Date: Feb. 1, 2018

(54) SYSTEM, METHOD, AND COMPUTER PROGRAM PRODUCT FOR DETERMINING WHETHER TO PROMPT AN ACTION BY A PLATFORM IN CONNECTION WITH A MOBILE DEVICE

(71) Applicants: George A. Gordon, Frisco, TX (US); Christopher M. Edgeworth, Longview, TX (US); Joseph A. Cerrato, Longview, TX (US); Kevin J. Zilka, Los Gatos, CA (US); Ronald A. Johnston, Longview, TX (US)

(72) Inventors: George A. Gordon, Frisco, TX (US); Christopher M. Edgeworth, Longview, TX (US); Joseph A. Cerrato, Longview, TX (US); Kevin J. Zilka, Los Gatos, CA (US); Ronald A. Johnston, Longview, TX (US)

(21) Appl. No.: 14/050,332

(22) Filed: Oct. 9, 2013

Related U.S. Application Data
(60) Provisional application No. 61/711,727, filed on Oct. 9, 2012.
(60) Provisional application No. 61/722,122, filed on Nov. 2, 2012.
(60) Provisional application No. 61/728,803, filed on Nov. 20, 2012.
(60) Provisional application No. 61/748,371, filed on Jan. 2, 2013.
(60) Provisional application No. 61/751,212, filed on Jan. 10, 2013.

(51) Int. Cl. G06Q 20/32; G06Q 30/02; G06Q 20/20

(52) U.S. Cl. CPC G06Q 20/3224; G06Q 20/20; G06Q 30/0261; G06Q 30/0269

(57) ABSTRACT

A system, method, and computer program product are provided.

### RELATED APPLICATION(S)

The present application claim priority to Application No. 61/711,727, filed Oct. 9, 2012; Application No. 61/722,122, filed Nov. 2, 2012; Application No. 61/728,803, filed Nov. 20, 2012; Application No. 61/748,371, filed Jan. 2, 2013; and Application No. 61/751,212, filed Jan. 10, 2013; all of which are incorporated herein by reference in their entirety for all purposes.

### FIELD OF THE INVENTION AND BACKGROUND

The present invention relates to devices, and more particularly to using devices.

### SUMMARY

A system, method, and computer program product are provided for determining whether to prompt an action by a platform in connection with a mobile device. In operation, action criteria is received utilizing a platform capable of advertising. Additionally, information from an application is received by the platform. Further, it is determined whether to prompt an action by the platform in connection with a mobile device, based on the action criteria and the information.

A system, method, and computer program product are provided for mobile device transactions. In operation, an indication is received that a mobile device has established communication with a point-of-sale terminal. Additionally, in immediate response to the receipt of the indication, indicia is displayed for prompting user input to allow a transaction to occur in response thereto. Also provided is a system, method, and computer program product for storing profile information associated with members of a service network, as well as advertisement trigger information associated with advertisements of an advertiser. In use, presentation of at least one of the advertisements is caused outside of the service network, based on the profile information and the advertisement trigger information.

A system, method, and computer program product are provided for executing an instruction in connection with a mobile device. In operation, one or more triggers are identified. Additionally, the one or more triggers are processed to identify an instruction. Further, it is determined whether to execute the instruction in connection with a mobile device, based on the one or more triggers.

### BRIEF DESCRIPTION OF THE DRAWINGS

FIG. 1 illustrates a network architecture, in accordance with one embodiment.

FIG. 2 shows a representative hardware environment that may be associated with the servers and/or clients of FIG. 1, in accordance with one embodiment.

FIG. 3 shows a method for determining whether to prompt an action by a platform in connection with a mobile device, in accordance with one embodiment.

FIG. 4 shows a system for prompting an action by a platform in connection with a mobile device, in accordance with another embodiment.

FIG. 5 shows a system for contextual advertisement management in connection with a mobile device, in accordance with another embodiment.

FIG. 6 shows a system for downloading/executing feeder applications in connection with a mobile device, in accordance with another embodiment.

FIG. 7 shows a mobile device interface for downloading/executing feeder applications in connection with a mobile device, in accordance with another embodiment.

FIG. 8 shows a method for presenting contextual advertisements, in connection with a mobile device, in accordance with another embodiment.

FIG. 9 shows a method for presenting contextual advertisements, in connection with a mobile device, in accordance with another embodiment.

FIG. 10 shows a method for presenting contextual advertisements, in connection with a mobile device, in accordance with another embodiment.

FIG. 11 shows a mobile device interface for displaying advertisements/content, in accordance with another embodiment.

FIG. 12 shows a mobile device interface for displaying advertisements/content, in accordance with another embodiment.

FIG. 13 shows a mobile device interface for displaying advertisements/content, in accordance with another embodiment.

FIG. 14 shows a mobile device interface for displaying advertisements/content, in accordance with another embodiment.

FIG. 15 shows a mobile device interface for configuring advertisement/content display, in accordance with another embodiment.

FIG. 16 shows a mobile device interface for configuring advertisement/content related notifications, in accordance with another embodiment.

FIG. 17 shows a mobile device interface for configuring advertisement/content related notifications, in accordance with another embodiment.

FIG. 18 shows a mobile device interface for configuring advertisement/content related settings, in accordance with another embodiment.

FIG. 19 shows an advertisement interface flow, in accordance with another embodiment.

FIG. 19A shows an advertisement interface, in accordance with another embodiment.

FIG. 20 shows an advertisement interface, in accordance with another embodiment.

FIG. 21 shows a system for contextual advertisement management in connection with a mobile device, in accordance with another embodiment.

FIG. 21A shows a mobile device interface for configuring advertisement/content related notifications, in accordance with another embodiment.

FIG. 21B shows a mobile device interface for configuring advertisement/content related notifications, in accordance with another embodiment.

FIG. 21C shows a mobile device interface for configuring advertisement/content related notifications, in accordance with another embodiment.

FIG. 22 shows a system for presenting contextual advertisements, in connection with a mobile device, in accordance with another embodiment

FIG. 23 shows a mobile device interface for configuring advertisement/content related notifications, in accordance with another embodiment.

FIG. 24 shows a mobile device interface for configuring advertisement/content related notifications, in accordance with another embodiment.

FIG. 25 shows a mobile device interface for interacting with advertisement/content related notifications, in accordance with another embodiment.

FIG. 25A shows a mobile device interface for interacting with advertisement/content related notifications, in accordance with another embodiment.

FIG. 26 shows a mobile device interface for interacting with advertisement/content related notifications, in accordance with another embodiment.

FIG. 27 shows a mobile device interface for interacting with advertisement/content related notifications, in accordance with another embodiment.

FIG. 28 shows a method for presenting contextual advertisements, in connection with a mobile device, in accordance with another embodiment.

FIG. 29 shows a method for presenting contextual advertisements, in connection with a mobile device, in accordance with another embodiment.

FIG. 30 shows a mobile device interface for receiving advertisement/content related notifications, in accordance with another embodiment.

FIG. 31 shows a mobile device interface associated with a ticket/deal, in accordance with another embodiment.

FIG. 32 shows a mobile device interface associated with a ticket/deal, in accordance with another embodiment.

FIG. 33 shows a method for presenting contextual advertisements, in connection with a mobile device, in accordance with another embodiment.

FIG. 34 shows a mobile device interface for interacting with advertisement/content related notifications, in accordance with another embodiment.

FIG. 35 shows a mobile device interface for interacting with advertisement/content related notifications, in accordance with another embodiment.

FIG. 36 shows a mobile device interface for interacting with advertisement/content related notifications, in accordance with another embodiment.

FIG. 37 shows a mobile device interface for interacting with advertisement/content related notifications, in accordance with another embodiment.

FIG. 38 shows a mobile device interface for creating an advertisement/content, in accordance with another embodiment.

FIG. 39 shows a mobile device interface for interacting with advertisement/content related notifications, in accordance with another embodiment.

FIG. 40 shows a mobile device interface for interacting with advertisement/content related notifications, in accordance with another embodiment.

FIG. 41 shows a method for operating a mobile device in a vehicle control mode for controlling at least one vehicular feature, in accordance with one possible embodiment.

FIG. 42 illustrates a communication system, in accordance with one possible embodiment.

FIG. 43 shows a configuration for an automobile capable of interfacing with the mobile device of FIG. 42, in accordance with one possible embodiment.

FIG. 44 shows a mobile device system for interacting with advertisement/content, in accordance with another embodiment.

FIG. 45 shows a mobile device interface for interacting with advertisement/content related notifications, in accordance with another embodiment.

FIG. 46 shows a mobile device interface for interacting with advertisement/content related notifications, in accordance with another embodiment.

FIG. 47-1 illustrates a network architecture, in accordance with one embodiment.

FIG. 47-2 shows a representative hardware environment that may be associated with the servers and/or clients of FIG. 1, in accordance with one embodiment.

FIG. 47-3 shows a method for a mobile device transaction, in accordance with one embodiment.

FIG. 47-4 shows a system for mobile device transactions, in accordance with another embodiment.

FIG. 47-5 shows a system for presenting advertisements/content, in accordance with another embodiment.

FIG. 47-6 shows exemplary interfaces for configuring and/or registering advertisement/content triggers, in accordance with another embodiment.

FIG. 47-7 shows a system flow for presenting advertisements, in accordance with another embodiment.

FIG. 47-8 shows a method for communicating advertisement/content trigger IDs, in accordance with one embodiment.

FIG. 47-9 shows a system for mobile device transactions, in accordance with another embodiment.

FIG. 47-10 shows a method for a mobile device transaction, in accordance with another embodiment.

FIG. 47-11 shows a method for a mobile device transaction, in accordance with another embodiment.

FIG. 47-12 shows a method for a mobile device transaction, in accordance with another embodiment.

FIG. 47-13 shows a system flow for presenting advertisements, in accordance with another embodiment.

FIG. 47-14 shows a mobile device interface for facilitating a payment, in accordance with another embodiment.

FIG. 47-15 shows a mobile device interface for facilitating a payment, in accordance with another embodiment.

FIG. 47-16 shows a mobile device interface for facilitating a payment, in accordance with another embodiment.

FIG. 47-17 shows a mobile device interface for facilitating a payment, in accordance with another embodiment.

FIG. 47-18 shows a mobile device interface for presenting post-payment functionality, in accordance with another embodiment.

FIG. 48-1 illustrates a network architecture, in accordance with one embodiment.

FIG. 48-2 shows a representative hardware environment that may be associated with the servers and/or clients of FIG. 48-1, in accordance with one embodiment.

FIG. 48-3 shows a system for sending a control message to a mobile phone utilizing a tablet, in accordance with another embodiment.

FIG. 48-4 shows an exemplary system flow for sending a control message to a mobile phone utilizing a tablet, in accordance with one embodiment.

FIG. 48-5 shows an exemplary system flow for sending a control message to a mobile phone utilizing a tablet, in accordance with another embodiment.

FIG. 48-6 shows a method for implementing an integration profile, in accordance with one embodiment.

FIG. 48-7 shows a method for handling an incoming call utilizing a tablet/mobile phone integration, in accordance with one embodiment.

FIG. 48-8 shows a method for integrating a tablet and a mobile phone while a call is in progress, in accordance with one embodiment.

FIG. 48-9 shows a method for escalating a voice call to a video conference utilizing a tablet/mobile phone integration, in accordance with one embodiment.

FIG. 48-10 shows a method for disintegrating a tablet/mobile phone integration, in accordance with one embodiment.

FIG. 48-11 shows a method for performing a partial disintegration of a tablet/mobile phone integration, in accordance with one embodiment.

FIG. 48-12A shows a user interface for defining an integration profile, in accordance with one embodiment.

FIG. 48-12B shows a user interface for defining integration functionality as part of an integration profile, in accordance with one embodiment.

FIG. 48-12C shows a user interface for defining application migration settings as part of an integration profile, in accordance with one embodiment.

FIG. 48-12D shows a user interface for defining disintegration parameters as part of an integration profile, in accordance with one embodiment.

FIG. 48-12E shows a user interface for defining integration channels as part of an integration profile, in accordance with one embodiment.

FIG. 48-13 shows a plurality of user interfaces for prompting a user to initiate an integration, in accordance with one embodiment.

FIG. 48-14 shows a plurality of user interfaces for prompting a user regarding an automatic integration, in accordance with one embodiment.

FIG. 48-15 shows a plurality of user interfaces for managing integration settings, in accordance with one embodiment.

FIG. 48-16 shows a plurality of user interfaces for managing an integrated device, in accordance with one embodiment.

FIG. 48-17A shows a plurality of user interfaces for implementing a virtual phone interface, in accordance with one embodiment.

FIG. 48-17B shows a user interface for implementing a virtual phone interface, in accordance with another embodiment.

FIG. 48-17C shows a user interface for implementing a virtual phone interface, in accordance with another embodiment.

FIG. 48-18 shows a user interface for facilitating the operation of touch-sensitive applications without the use of a touchscreen, in accordance with one embodiment.

FIG. 48-19 shows a plurality of user interfaces for receiving and responding to a voice call, in accordance with one embodiment.

FIG. 48-20 shows a user interface for modifying an ongoing voice call, in accordance with one embodiment.

FIG. 48-21- shows a user interface for modifying an ongoing voice call with multiple participants, in accordance with another embodiment.

FIG. 48-22 shows a plurality of user interfaces for using a calendar application, in accordance with one embodiment.

FIG. 48-23 shows a plurality of user interfaces for receiving a shared calendar event, in accordance with one embodiment.

FIG. 48-24 shows a user interface for using a note application, in accordance with one embodiment.

FIG. 48-25 shows a user interface for using an email application, in accordance with one embodiment.

FIG. 48-26 shows a user interface for using a web browser application, in accordance with one embodiment.

FIG. 48-27 shows a user interface for using a shared workspace, in accordance with one embodiment.

FIG. 48-28 shows a user interface for using an address book application, in accordance with one embodiment.

FIG. 48-29- shows a plurality of user interfaces for launching applications, in accordance with one embodiment.

FIG. 48-30- shows a method for sharing content, in accordance with one embodiment.

FIG. 48-31 shows a plurality of user interfaces for sharing content, in accordance with one embodiment.

FIG. 48-32 shows a plurality of user interfaces for receiving and responding to an invitation to a video conference, in accordance with one embodiment.

FIG. 48-33 shows a plurality of user interfaces for modifying an ongoing video conference, in accordance with one embodiment.

FIG. 48-34 shows a plurality of user interfaces for modifying an ongoing video conference, in accordance with another embodiment.

FIG. 48-35- shows a plurality of user interfaces for utilizing a secondary display, in accordance with one embodiment.

FIG. 48-36 shows a method for modifying the user experience, in accordance with one embodiment.

FIG. 48-37 shows a method for facilitating the use of content, in accordance with one embodiment.

FIG. 49-1 illustrates a network architecture, in accordance with one embodiment.

FIG. 49-2 shows a representative hardware environment that may be associated with the servers and/or clients of FIG. 1, in accordance with one embodiment.

FIG. 49-3 shows a method for executing an instruction in connection with a mobile device, in accordance with one embodiment.

FIG. 49-4 shows a system for triggering an instruction in connection with a mobile device, in accordance with another embodiment.

FIG. 49-5 shows a method for saving one or more instructions with a mobile device, in accordance with another embodiment.

FIG. 49-6 shows a method for executing one or more instructions with a mobile device, in accordance with another embodiment.

FIG. 49-7 shows a method for executing one or more instructions with a mobile device, in accordance with another embodiment.

FIG. 49-8 shows a method for executing one or more instructions with a mobile device, in accordance with another embodiment.

FIG. 49-9 shows a mobile device interface for receiving one or more triggers, in accordance with another embodiment.

FIG. 49-10 shows a mobile device interface for receiving one or more triggers, in accordance with another embodiment.

FIG. 49-11 shows a mobile device interface for creating one or more instructions, in accordance with another embodiment.

FIG. 49-12 shows a mobile device interface for creating one or more instructions, in accordance with another embodiment.

FIG. 49-13 shows a mobile device interface for creating one or more instructions, in accordance with another embodiment.

FIG. 49-14 shows an online interface for selecting one or more instructions, in accordance with another embodiment.

FIG. 49-15 shows an online interface for viewing one or more selected instructions, in accordance with another embodiment.

FIG. 49-16 shows an online interface for modifying an instruction, in accordance with another embodiment.

FIG. 49-17 shows an online and mobile interface for sending and receiving an instruction, in accordance with another embodiment.

FIG. 49-18 shows a mobile interface for managing one or more instructions, in accordance with another embodiment.

FIG. 49-19 shows a method for executing one or more instructions with a mobile device in a vehicle control mode, in accordance with another embodiment.

FIG. 49-20 shows a communication system, in accordance with another embodiment.

FIG. 49-21 shows a configuration for an automobile capable of interfacing with the mobile device of FIG. 49-20, in accordance with another embodiment.

FIG. 49-22 shows a mobile device interface for interacting with one or more instructions, in accordance with another embodiment.

FIG. 49-23 shows a method for executing one or more instructions with a mobile device in a travel mode, in accordance with another embodiment.

FIG. 49-24 shows a mobile device interface for interacting with one or more instructions, in accordance with another embodiment.

FIG. 49-25 shows a mobile device interface for interacting with one or more instructions, in accordance with another embodiment.

FIG. 49-26 shows a mobile device interface for interacting with one or more instructions, in accordance with another embodiment.

### DETAILED DESCRIPTION

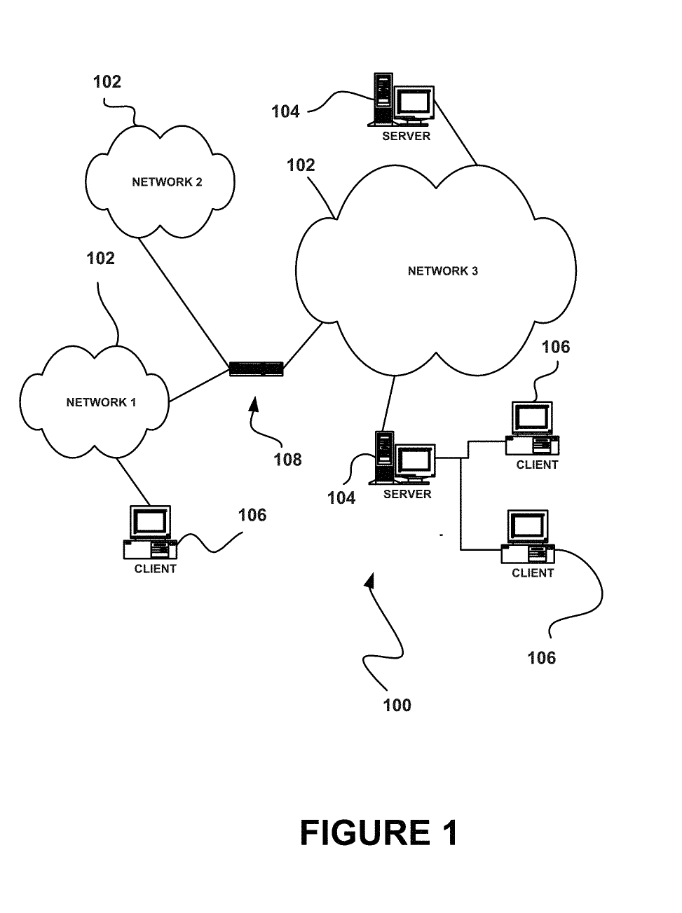

FIG. 1 illustrates a network architecture 100, in accordance with one embodiment. As shown, a plurality of networks 102 is provided. In the context of the present network architecture 100, the networks 102 may each take any form including, but not limited to a local area network (LAN), a wireless network, a wide area network (WAN) such as the Internet, peer-to-peer network, etc.

Coupled to the networks 102 are servers 104 which are capable of communicating over the networks 102. Also coupled to the networks 102 and the servers 104 is a plurality of clients 106. Such servers 104 and/or clients 106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 102, at least one gateway 108 is optionally coupled therebetween.

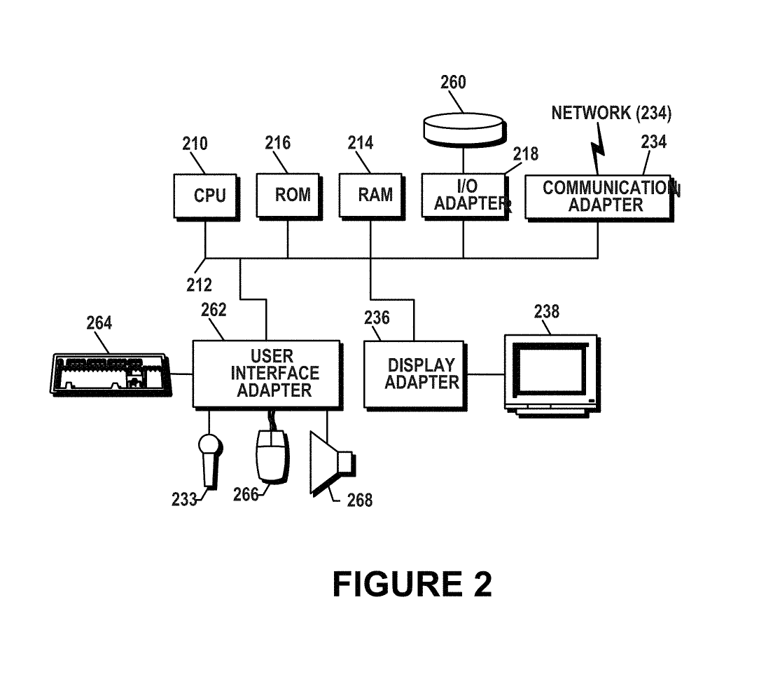

FIG. 2 shows a representative hardware environment that may be associated with the servers 104 and/or clients 106 of FIG. 1, in accordance with one embodiment. Such figure illustrates a typical hardware configuration of a workstation in accordance with one embodiment having a central processing unit 210, such as a microprocessor, and a number of other units interconnected via a system bus 212.

The workstation shown in FIG. 2 includes a Random Access Memory (RAM) 214, Read Only Memory (ROM) 216, an I/O adapter 218 for connecting peripheral devices such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

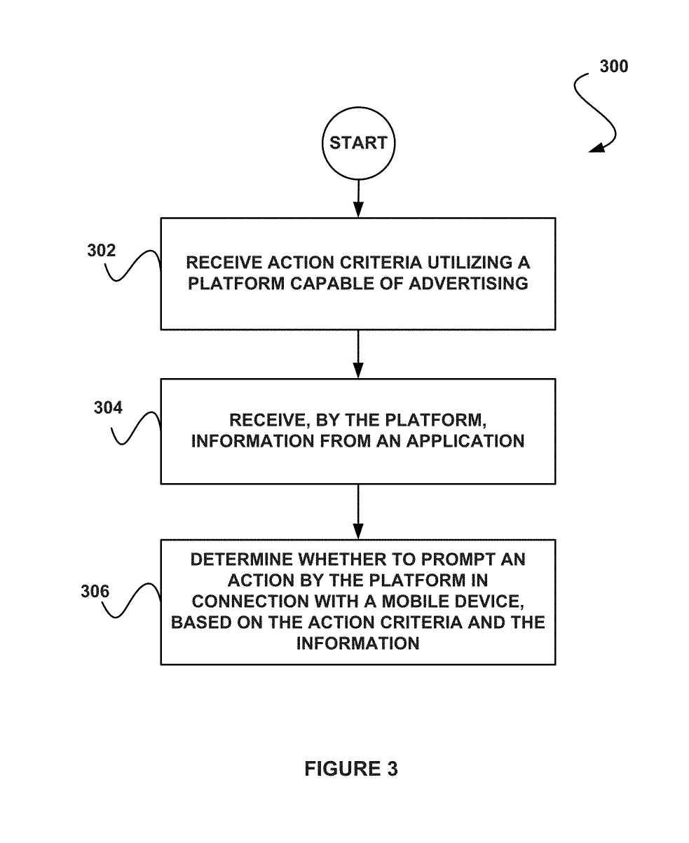

FIG. 3 shows a method 300 for determining whether to prompt an action by a platform in connection with a mobile device, in accordance with one embodiment. As an option, the method 300 may be implemented in the context of the architecture and environment of the previous Figures and/or any subsequent Figure(s). Of course, however, the method 300 may be carried out in any desired environment.

As shown, action criteria is received utilizing a platform capable of advertising. See operation 302. Additionally, information from an application is received by the platform. See operation 304. Further, it is determined whether to prompt an action by the platform in connection with a mobile device, based on the action criteria and the information. See operation 304.

The mobile device may include any type of mobile device, including a cellular phone, a tablet computer, a handheld computer, a media device, a mobile device associated with a vehicle, a PDA, an e-reader, and/or any other type of mobile device.

The platform capable of advertising may include may include any type of platform capable of presenting (e.g. displaying, audibly outputting, etc.) advertisements and/or causing any such presentation of advertisements on or off the platform. In various embodiments, the platform may or may not receive the advertisements from a separate advertiser. For example, in various embodiments, the platform may include a social network platform, an operating system platform, a retailer platform, a mobile wallet application platform, a search engine platform, a gaming platform, an entertainment and/or media (e.g. music, video, pictures, etc.) platform, a networked application platform, a locally stored application platform, and/or various other platforms.

The action criteria may include any type of action criteria. For example, in various embodiments, the action criteria may involve at least one of aggregated data collected from a plurality of users, machine-related data, location data, payment data, social data, application usage data, event data, and/or search data. In one embodiment, the action criteria may involve information associated with a social network service. In another embodiment, the action criteria may involve information associated with a browser. In another embodiment, the action criteria may involve information associated with a calendar. In another embodiment, the action criteria may involve information associated with an online retailer. In another embodiment, the information may involve information associated with a mobile payment service and/or application. Further, in another embodiment, the action criteria may involve information associated with a customer relationship management (“CRM”) system. Of course, the action criteria may be associated with any data from any source.

Additionally, the action prompted may include an advertisement, a suggestion, incentive, useful information, a utilitarian function, and/or any type of an output. Useful information and/or utilitarian function may include, but are not limited to passes (e.g. boarding or travel passes, etc.), tickets (e.g. movie or event tickets, etc.), commerce-related programs/cards (e.g. loyalty program/cards, etc.), etc. In the context of the present description, an advertisement may include anything (e.g. media, deal, coupon, suggestion, helpful information/utility, etc.) that has at least a potential of incentivizing or persuading or increasing the chances that one or more persons will purchase a product or service. In one embodiment, the action criteria may be received from an advertiser and the action may include displaying an advisement. In one embodiment, the advertisement may be displayed in a non-intrusive manner. For example, in one embodiment, the action (e.g. advertisement, etc.) may be manifested utilizing a lock screen, or any other type of additional screen (e.g. swipe down screen, etc.), of the mobile device. In another embodiment, the action (e.g. advertisement, etc.) may be manifested during an unlocking of a lock screen of the mobile device. In still other embodiments, the action (e.g. advertisement, etc.) may be manifested in a manner that is integrated in any regular usage of the mobile device. Of course, any such manifestation of the aforementioned action may be presented in any manner that reduces an intrusiveness of a presentation thereof.

Further, in one embodiment, the action (e.g. advertisement, etc.) may be manifested when it is determined a user of the mobile device is available to view the advertisement. For example, in one embodiment, the action (e.g. advertisement, etc.) may be conditionally manifested based on a facial recognition in connection with a user of the mobile device. In one embodiment, if it is determined that the user is viewing the mobile device, utilizing facial recognition, the action (e.g. advertisement, etc.) may be manifested utilizing the mobile device. In another embodiment, the action may be manifested based on movements by the user and/or device (e.g. as determined by accelerometers, gyroscopes, etc.).

Additionally, the application may include any type of online or locally stored application. In various embodiments, the application may include a social network application, a dating service application, an on-line retailer application, a browser application, a gaming application, a media application, an application associated with a product, an application associated with a location, an application associated with a store (e.g. an online store, a brick and mortar store, etc.), an application associated with a service, an application associated with discounts and/or coupon services, an application associated with a company, any application that performs, causes, or facilitates the aforementioned action(s), and/or any other type of application including, but not limited to those disclosed herein.

In one embodiment, the application may be available via the platform. For example, in various embodiments, the application may be available in via a social network platform, an operating system platform, a retailer platform, a mobile wallet application platform, a networked application platform, a locally stored application platform, any platform that performs, causes, or facilitates the aforementioned action(s), and/or various other platforms. This may be accomplished, for example, via an application store or center or interface where a plurality of application are available for selection (and possibly for purchase), for use on or off the platform.

When used “on” the platform, the application may be executed, accessed, etc. after (and/or conditioned upon) executing, accessing, etc. (e.g. logging in, etc.) the platform, and possibly in the context of (or during simultaneous usage of) the platform. This may or may not be accomplished by framing the application with platform graphical user interface component or simply branding at least a portion of the application with platform branding. When used “off” the platform, the application may be executed, accessed, etc. in a manner that is less connected with the platform.

Further, in one embodiment, the application may be available in connection with a machine. The machine may include any type of machine. For example, in various embodiments, the machine may include a machine associated with a vehicle (e.g. a vehicle heads-up display, an entertainment system, etc.), a television, a set-top box, a computer, a display unit, a machine associated with a retailer/service provider, a machine associated with a business, and/or any other machine.

More illustrative information will now be set forth regarding various optional architectures and features with which the foregoing techniques discussed in the context of any of the present or previous figure(s) may or may not be implemented, per the desires of the user. For instance, various optional examples and/or options associated with the action criteria of operation 302, the information of operation 304, the prompting of the action of operation 306, and/or other optional features have been and will be set forth in the context of a variety of possible embodiments. It should be strongly noted, however, that such information is set forth for illustrative purposes and should not be construed as limiting in any manner. Any of such features may be optionally incorporated with or without the inclusion of other features described.

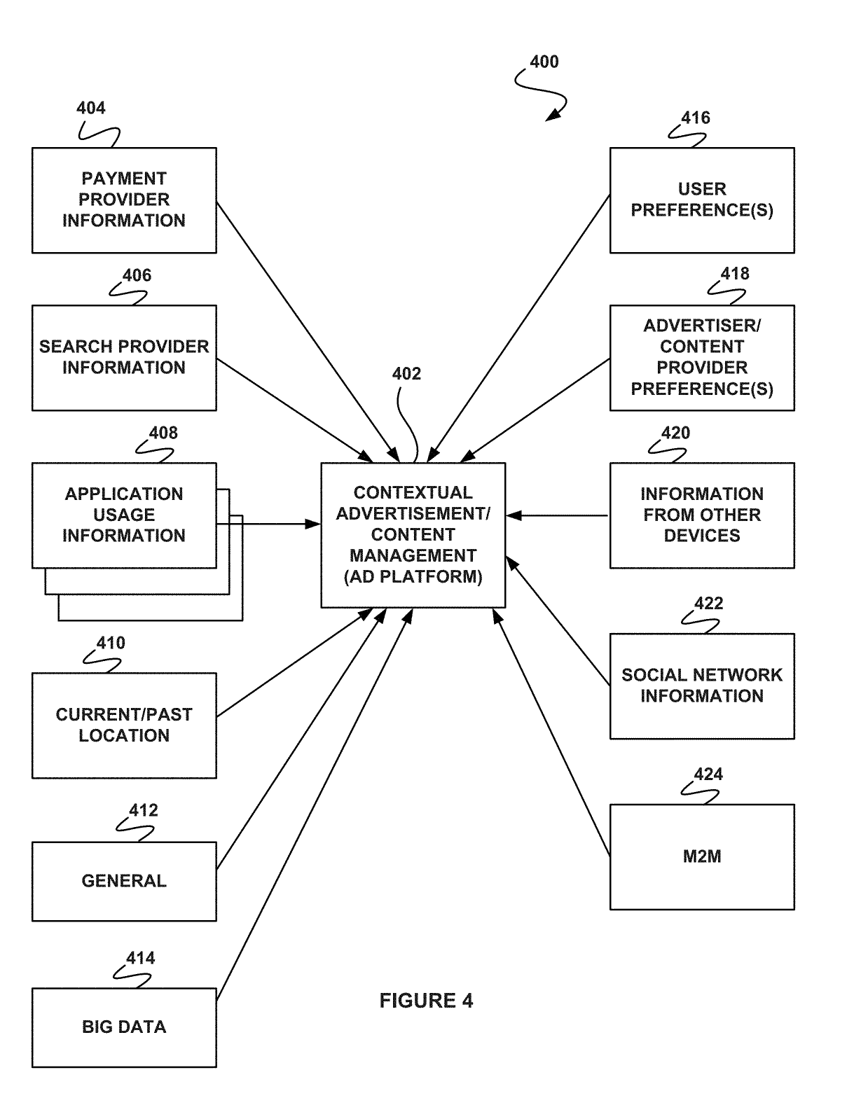

FIG. 4 shows a system 400 for prompting an action by a platform in connection with a mobile device, in accordance with another embodiment. As an option, the system 400 may be implemented in the context of the architecture and environment of the previous Figures and/or any subsequent Figure(s). Of course, however, the system 400 may be implemented in the context of any desired environment. It should also be noted that the aforementioned definitions may apply during the present description.

As shown, a contextual advertisement/content management platform or module (AD platform) 402 is in communication with one or more other modules or platforms 404-424. In various embodiments, the AD platform 402 may include software (e.g. computer code, etc.) and/or hardware (e.g. one or more servers, one or more processors, one or more databases, etc.). Additionally, in various embodiments, the AD platform 402 may include decision logic capable of determining advertisements and/or content to be output, selected, and/or displayed. For example, in one embodiment, the AD platform 402 may utilize information provided by the other modules/platforms 404-424 to determine advertisements and/or content to be output, selected, and/or displayed to one or more users of a mobile device. While the present embodiments and subsequent embodiments may or may not involve advertisements and/or content delivery, it should be strongly noted that, in any of the embodiments disclosed herein, other actions (e.g. see, for example, those disclosed in connection with FIG. 3, etc.) may be substituted for such advertisements and/or content. To this end, the AD platform 402 may just as readily be considered an action platform, in various embodiments.

The modules/platforms 404-424 may include any type of module/platform capable of providing information to the AD platform 402. While the modules/platforms 404-424 are shown to be discrete from the AD platform 402 in the embodiment of FIG. 4, it should be noted that any amount (e.g. partial, full, etc.) of integration may or may not be implemented with respect to any one or more or all of the modules/platforms 404-424 and the AD platform 402. Still yet, the AD platform 402 may or may not be integrated with any of the platforms disclosed herein (e.g. see platforms disclosed in connection with the description of FIG. 3, etc.).

For example, in various embodiments, the modules/platforms 404-424 may include, but are not limited to modules/platforms configured to provide payment provider information (e.g. user billing information, user awards point information, purchase information, etc.—see, for example, U.S. Pat. No. 8,127,982, U.S. Pat. No. 8,239,276, US 2002/0179704A1 filed Jun. 5, 2001, which are each incorporated herein by reference), search provider information (e.g. search query terms, search results, etc.), application usage information (e.g. information associated with the types of applications used, information provided to applications, information gleaned from applications, information determined by applications, stored information associated with applications, information collected by the application from other platforms, applications, etc.), information associated with a current or past location associated with a device and/or a user (e.g. IP address information, GPS information, cellular network information, social network check-in information, etc.), general information (e.g. general information associated with a device, general information associated with a user, etc.), big data information (e.g. mobile device generated or logged data, user generated or logged data, automobile generated or logged data, etc.), and/or various other information.

As additional examples, the modules/platforms 404-424 may include, but are not limited to modules/platforms configured to provide user preference information (e.g. user product preferences, user setting preferences, user advertisement preferences, user personal preferences, etc.), advertiser/content preference information (e.g. advertisement/content selection hierarchy, advertisement/content output/display preferences, etc.), information from other devices (e.g. mobiles phones, tablet computers, desktop computers, televisions, vehicles or vehicle computers, machines associated with a business, etc.), social network information (e.g. user provided information, posted information, “Like” information, membership information, demographic information, friend information, career information, hobby information, marital information, location information, etc.), machine to machine (M2M) information (e.g. protocol preference information, device ID information, etc.), and/or various other information.

In various embodiments, the modules/platforms 404-424 may include software and/or hardware. In one embodiment, the modules/platforms 404-424 may represent software applications. In this case, in various embodiments, the applications may be stored on one or more devices (e.g. one or more mobile devices, one or more network devices, etc.) and/or on one or more servers (e.g. a social network server, an advertisement server, etc.). Further, in various embodiments, the applications may include applications that are automatically executable (e.g. based on location, based on an action, etc.), and/or capable of being executed by a user (e.g. the user of a mobile device, etc.).

In one embodiment, the modules/platforms 404-424 may provide the AD platform 402 with information automatically by monitoring any aspect of a user. In another embodiment, the modules/platforms 404-424 may provide the AD platform 402 with information in response to a user action or user interaction with the modules/platforms or any other entity. In another embodiment, the modules/platforms 404-424 may provide the AD platform 402 with information in response to receiving a request for information (e.g. a request from the AD platform 402, a request authorized by a user, etc.).

In one embodiment, the AD platform 402 may store the information received by the modules/platforms 404-424. In another embodiment, the AD platform 402 may associate the information received by the modules/platforms 404-424 with a user and/or a device. In another embodiment, the information sent by the modules/platforms 404-424 may be associated with a user and/or a device. For example, in one embodiment, the modules/platforms 404-424 may be associated with one or more applications. In this case, in one embodiment, instances of the applications (or the applications) may be associated with a user of a mobile device (e.g. utilizing a device ID, user login credentials, cookies, etc.). Accordingly, in one embodiment, the applications may share information that is associated with the user and/or the mobile device. In other embodiments, the information that is shared may be done so such that the user and/or mobile device remains anonymous using anonymous identifiers and/or encryption techniques.

In one embodiment, the AD platform 402 may utilize the information received to determine advertisements and/or content to present or provide to a user device (or initiate any action, for that matter). In another embodiment, the AD platform 402 may utilize the information received to determine advertisements and/or content to present or provide to a service, module, and/or application capable of presenting or providing the advertisements and/or content.

Further, in one embodiment, the AD platform 402 may be associated with (or may be integrated with) another application, such as a master application. In this case, in one embodiment, the AD platform 402 may provide content and/or advertisements for display in association with the master application. For example, in one embodiment, the master application may include a social network application. In this case, the AD platform 402 may utilize the information provided by feeder applications (e.g. the modules/platforms 404-424, etc.) to select and/or provide targeted advertisements to the master application. In one embodiment, the master application may include the AD platform 402. In another embodiment, the AD platform 402 may include a third party platform capable of providing or suggesting content/advertisements to the master application.

In various embodiments, the master application may include any application capable of receiving information from one or more feeder applications. For example, in various embodiments, the master application may include a social network application, a mobile wallet application, an online retailer/service provider application, a network browser application, an application associated with an operating system of a mobile device, and/or any other capable of receiving information from one or more feeder applications.

In one embodiment, a feeder application may be provided by a company along with a purchased product and/or service. In this case, in one embodiment, the provided feeder application may feed information to the master application (e.g. a social networking application, a mobile operating system, etc.). In one embodiment, the master application may drive advertisement/content presentation decisions, based on the provided information. In various embodiments, the feeder application may include a generic feeder application, a company specific feeder application, a product/service specific feeder application, an application with functionality that includes information feeding functionality, and/or various other applications.

In one embodiment, the master application may provide information to company advertisements and/or other relater and/or other related-third party advertisers to trigger advertisements. More information about providing dynamic advertisements may be found in U.S. Provisional Patent Application No. 61/590,764, filed Jan. 25, 2012, titled “SYSTEM, METHOD, AND COMPUTER PROGRAM PRODUCT FOR PRESENTING INFORMATION TO A USER BASED ON DETERMINED SATISFACTION-RELATED INFORMATION ASSOCIATED WITH THE USER,” which is incorporated herein by reference in its entirety.

The feeder applications may include any application capable of providing information to one or more other applications (e.g. master applications, etc.). For example, in various embodiments, the feeder applications may include one or more applications associated with a restaurant, a store (e.g. a grocery store, a clothing store, an online store, etc.), a social network, a mobile wallet, entertainment (e.g. a cinema, a stadium, a club, etc.), an inventory system, a Supply Chain Management system, a vehicle, a service, a CRM service, and/or any other application capable of providing information to a master application.

In one embodiment, a user of a mobile device may be prompted to download a feeder application. In one embodiment, a user may be prompted to download one or more applications based on a determined location of the user and/or the mobile device.

For example, in one embodiment, the location of the mobile device may be determined. Based on the determined location, the user may be prompted to download (or execute, etc.) an application relevant to the location. For example, the determined location may be determined to be near a retail store or establishment. Accordingly, an option to download an application associated with the retail store or establishment may be presented to the user on the mobile device.

In one embodiment, the feeder application may be configured to operate as a one-click download (and/or install, execute, etc.) and initiate in response to a wizard pop-up (e.g. in response to a location determination, etc.). In this way, users of mobile devices may be presented with the option to download feeder applications to feed one or more master applications. In one embodiment, a user may be presented an option to download a feeder application when the user enters a network (e.g. at or around the time the user is prompted to determine whether to connect to the network, after the user joins a network, etc.). In another embodiment, a user may be presented an option to download a feeder application when the user is within a geographic distance of another device (e.g. a device associated with a store, a friend, a carrier, etc.).

In one embodiment, after or before joining a wireless network, a user may be invited to download an application from a server (e.g. an application store) via the wireless network. In one embodiment, the application may include a feeder application associated with a business that may or may not own and/or manage the wireless network (e.g. the owner, etc.). In one embodiment, upon identifying a network (or entering a location, etc.) the user may be presented with an option to join the network (which may or may not be free).

In one embodiment, the aforementioned option to join the network may be presented simultaneously with a description of the network and/or an associated application available for download, and/or a link to an application store web site. In such embodiment, the network and application (or at least the application) may be identified/described together as a single option so that, upon selection of such option, multiple actions may be initiated (e.g. both joining of the network and downloading (and possibly execution, etc.) of the application, etc.).

In another embodiment, the network and application may be simultaneously identified and/or described as separate options so that, upon selection of a first network-related option, the network is jointed and, upon selection of a second application-related option, the application may be downloaded (and possibly executed). Of course, the execution may require a separate option selection, as well. In yet another embodiment, the option to join the network may be presented with a network description of the network first, and, only after joining, an associated application available for download and/or a link to an application store web site may be displayed thereafter.

As an option, the network description may describe the availability of the application (after the network has been joined). To accomplish this, in one embodiment, a “network name” may be expanded to describe the feeder application, so that, when the network name is presented to a user of a mobile device, the user understands that at least one purpose of such network connectivity is to download the feeder application, to download a relevant coupon/discount, and/or to interact with the network in some manner. Further, after the network is joined, a browser application may or may not be automatically executed for displaying a predetermined hot-spot web page that includes feeder application description, download instructions (along with necessarily link(s), etc.) for downloading the feeder application. Of course, such web page may or may not include log-in functionality, as well as payment functionality, etc. In one embodiment, the mobile device (or OS thereof) may be configured to identify (or be notified of) the availability of the feeder application via the network connection and avoid the launch of the aforementioned browser by simply displaying one or more icons (similar to the one or more icons that prompted network connection), for downloading and/or executing the feeder application in response to a selection thereof.

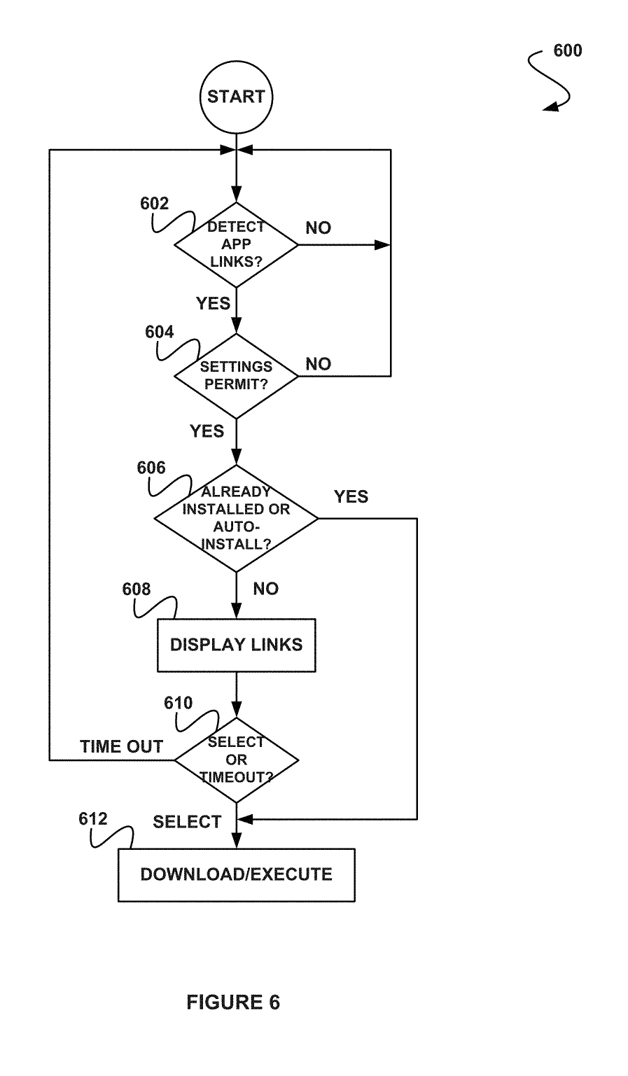

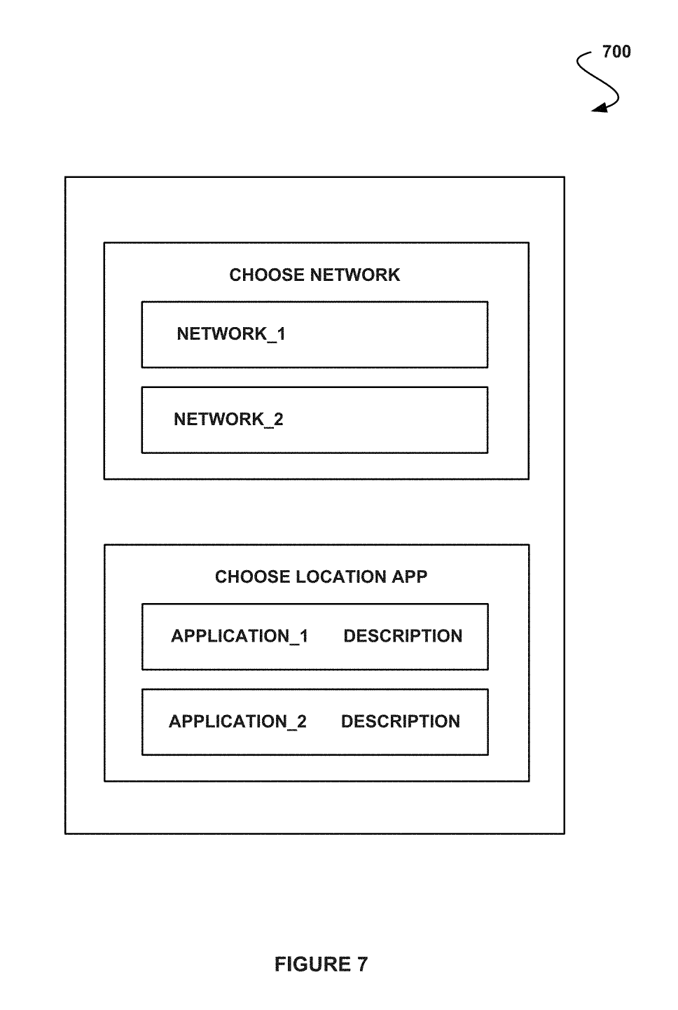

In one embodiment, the operating system associated with the mobile device may include an option (e.g. as part of a “Settings” menu, etc.) capable of indicating whether the aforementioned feeder application invitations are to be presented, and/or whether they can be automatically downloaded and/or executed. For example, in one embodiment, the feeder application may be automatically downloaded and/or executed in response to a connection with a trusted source (e.g. trusted friend, recommended business, store associated with royalty program, etc.). In other embodiments, the user may select settings associated with the trusted source to determine the level of automatic actions (e.g. download, execute, synchronize, update status on social networking site, etc.) taken in response to a detection of a feeder application. More information regarding various options that may or may not be utilized in connection with any of the above embodiments will be set forth during the description of FIGS. 6-7.

In another embodiment, feeder applications may be downloaded utilizing an associated website. In one embodiment, a user may access a website, launch a feeder application, download a feeder application, and/or otherwise implement functionality for providing a master application information, by first viewing or experiencing a product/service associated with a company via a magazine (digital or paper, etc.), television, newspaper, and/or other content.

For example, a user viewing a magazine may insert a code displayed in the magazine to initiate a feeder application. In one embodiment, the user may input the code into a website associated with a company, which the user accessed on a mobile device. In another embodiment, the user may insert the code as a text message (e.g. an SMS message, an MMS message, etc.). In one embodiment, in response to the text a link may be provided to download the feeder application. In one embodiment, a number to text the code may be provided along with the code.

In another embodiment, a user may utilize the application stored on the mobile device to capture an image associated with content (e.g. magazine content, television content, etc.). In one embodiment, utilizing information captured in the image, the application stored of the mobile device (or another application associated therewith, etc.) may determine a relevant feeder application, such that the user may access the feeder application, download the feeder application, and/or execute the feeder application, etc. In various embodiments, the information captured in the image may include a product/company name, a product/company logo, a product/company identifier, a bar code (e.g. a QR code, a UPC code, etc.), an alphanumeric or numeric code, and/or a product image, etc. Additionally, in other embodiments, the information may be captured by audio input. For example, in one embodiment, the information captured may include ambient sounds (e.g. within a fast-food location, the ambient sounds would include the names of what is being ordered, etc.), known sounds relating to a site (e.g. Disney songs upon entering Disneyland the site or Disney the Store, etc.), and/or any other type of audio input. In one embodiment, utilizing information captured in the audio, the application stored of the mobile device (or another application associated therewith, etc.) may determine a relevant feeder application, such that the user may access the feeder application, download the feeder application, and/or execute the feeder application, etc.

In another embodiment, one or more machines associated with a user may include feeder applications available for download to the mobile device associated with the user (e.g. via a Bluetooth connection, a wired connection [e.g. USB, etc.], a near field connection (NFC), a Wi-Fi connection, etc.). In various embodiments, the machines may include household appliances (e.g. a washing machine, a dryer, a refrigerator, a heating system, a cooling system, a thermostat, cooking devices [e.g. an oven, a stove, a cooking range, a microwave, a toaster, etc.], etc.), a coffee maker, an alarm clock, a security system, a vehicle, a vehicle computer, an entertainment system, a television, a set-top box, a web-based media set-top box, a computer, and/or various other machines.

In various embodiments, the feeder application stored on the machine may be capable of being downloaded to the mobile device of the user manually and/or automatically upon connection of the mobile device to the machine. In one embodiment, the mobile device operating system may include settings that establish whether automatic download of the feeder application is permitted. For example, in one embodiment, the user may be able to authorize automatic download of feeder application in the mobile device settings, when feeder applications are available. Further, in one embodiment, the user may have the ability to authorize automatic download of certain feeder applications (e.g. feeder applications associated with household appliances/machines, feeder applications associated with vehicles, feeder applications associated with locations, feeder applications associated with wireless networks, feeder applications associated with stores, feeder applications associated with restaurants, feeder associated with trusted contacts [e.g. social contacts, recommended business sites, etc.], etc.).

In a situation where a product and/or service (with an associated feeder application) is purchased with a payment module (e.g. see 404), identified in search results provided by a search module (e.g. see 406), identified in a social network module (e.g. 422), etc.; an option may be given for downloading or otherwise accessing the feeder application. As yet another option, such downloading/access may be initiated automatically in connection with any of the above actions associated with the relevant modules (possibly as a function of download preferences, etc.).

In one embodiment, feeder applications associated with the machines may be able to output information from the mobile device to the machine. For example, in one embodiment, setting preferences may be determined and output from the mobile device of the user to the machine. Of course, in various embodiments, such communication may be implemented in a variety of ways, including a Bluetooth connection, a Wi-Fi connection, a near field connection, and/or a wired connection, etc.

In another embodiment, the operating system of the mobile device may include an interface and/or be associated with a connector application, such that information may be collected from other applications. For example, the interface associated with the operating system (or, in one embodiment, the operating system itself, etc.) may collect information from existing applications (e.g. media applications, email applications, browser applications, any other relevant application, etc.) stored on the mobile device. In one embodiment, the information collected may be utilized by the AD platform 402 (which, in one embodiment, may be part of, or associated with, the operating system, etc.) to determine advertisements and/or content to be presented to the user on the mobile device.

In this way, an operating system of a mobile device, or an application associated therewith (e.g. a master application, etc.) may receive and/or collect information associated with one or more other applications, such that targeted advertisements and/or content may be selected and/or presented to a user on the mobile device. The information received and/or collected by the one or more other applications may include any information capable of being used to determine targeted advertisements and/or content, such as browsing history, social network information, a gender, an age, a birth date, an astrological sign, a nationality, a religion, a political affiliation (e.g. Democrat, Republican, etc.), a height, a weight, a hair color, an eye color, an ethnicity, a living address (e.g. a home address, etc.), a work address, an occupation (e.g. student, engineer, barista, unemployed, etc.), a sexual preference, an education level (e.g. a high school education, a college education, a postgraduate degree, etc.), a birth place, a school attended (e.g. an elementary school attended, a middle school attended, a high school attended, a college attended, etc.), an area once lived (e.g. during adolescence, after high school, during adult years, etc.), a relationship status (e.g. single, married, significant other, etc.), a family status (e.g. living parents, divorced parents, estranged from parents, etc.), a number of siblings, an income, a car (e.g. a car model, a car make, a car year, a car price, etc.), a number of children, hobbies (e.g. reading, running, volunteering, biking, golf, climbing, etc.), exercise habits (e.g. number of hours/minutes a week, number of times a month, type of exercise preferred, etc.), a number of pets owned, a type of pets owned (e.g. dogs, cats, fish, gerbils, etc.), food preferences (e.g. vegetarian, vegan, mainly meat, Chinese cuisine, Mexican cuisine, etc.), drinking habits (e.g. daily, weekly, monthly, etc.), eating habits (e.g. eat in, dine out, snacks, meals, etc.), TV watching preferences (e.g. types of preferred shows, number of hours/minutes per day/week, etc.), movie watching preferences (e.g. types of preferred movies, number of movies per day/week/month, etc.), music preferences (e.g. preferred genre, preferred artist, etc.), sleeping preferences (e.g. the number of hours of sleep preferred, the preferred bed time/rise time, etc.), moods (e.g. generally a good mood, generally a bad mood, etc.), feelings (e.g. generally happy, generally sad, generally angry, etc.), desires (e.g. goals, wishes, etc.), and/or any other personal information.

In various embodiments, the personal information may include permanent personal information (e.g. physical traits, history, etc.), temporal personal information (e.g. what the user is doing/feeling/experiencing now or within a predetermined window of time, etc.), and/or future goal-oriented personal information (e.g. wants, desires, etc.).

In one optional embodiment, the personal information may be received in association with a social networking site that allows users to define themselves in a profile (e.g. which may include any one or more of the personal information parameters disclosed hereinabove and/or herein below, etc.); associate themselves with others (e.g. friends, colleagues, other groups, etc.) by connecting to each other; and/or engage in activities (e.g. using applications such as games, reviewing content, sharing content (e.g. interests, thoughts, questions, media, etc.), etc.).

In such embodiment, the personal information may be received from a social networking profile of the user associated with a social networking site. Further, the personal information may include any entities (e.g. people, groups, institutions, products, etc.) to which the user is associated (e.g. connected, subscribed, linked) during use of the social networking site. Such associations may also be extended to “associations-of-associations” (e.g. friends of friends, etc.). Even still, tracking such associations as personal information may be extended to a threshold number (e.g. 1, 2, 3, 4, 5, etc.) of degrees-of-separation. As a further option, the personal information may be received based on any of the aforementioned activity of the user in connection with the social networking site. In such example, any profiling metadata collected based on the activity of the user may be utilized as the personal information. For example, in one embodiment, the activity of the user may include links clicked (e.g. user history, etc.), friends connected to (e.g. through a social networking site, etc.), content posted (e.g. postings, upload of media, etc.), and/or any other activity associated with the user.

One optional embodiment is contemplated wherein an on-line application associated with the social networking site may collect and/or use the aforementioned social networking site-related personal information in connection with any of the functionality disclosed hereinabove and/or herein below. Of course, such social networking site-related on-line application may do so by itself and/or in connection with other one or more social networking site-related on-line application(s) or separate/independent site-related on-line application(s). To be clear, any of the above on-line application(s) may either be developed and/or purchased so as to be under the complete control of the social networking site, be separate from but hosted or controlled (at least in part via framing or similar technology) by the social networking site, and/or be complete separate from the social networking site, but exchange information therewith (via an interface, protocol, or download/export of information, etc.) to accomplish any one or more capabilities disclosed herein.

To this end, a pre-existing social networking site may be leveraged to accomplish any one or more of the operations disclosed herein. With that said, any site that collects any of the personal information disclosed herein may optionally be used in lieu of or in combination with the aforementioned social networking site. For example, an e-commerce site (e.g. product supply website, etc.) that collects profile information, etc. may be utilized in a similar manner.

More information regarding targeted advertisements and content may be found in U.S. Provisional Patent Application No. 61/563,741, filed Nov. 25, 2011, titled “SYSTEM, METHOD, AND COMPUTER PROGRAM PRODUCT FOR PRESENTING DECISION RELATED INFORMATION;” U.S. Provisional Patent Application No. 61/590,764, filed Jan. 25, 2012, titled “SYSTEM, METHOD, AND COMPUTER PROGRAM PRODUCT FOR PRESENTING INFORMATION TO A USER BASED ON DETERMINED SATISFACTION-RELATED INFORMATION ASSOCIATED WITH THE USER” U.S. Provisional Patent Application No. 61/591,819, filed Jan. 27, 2012, titled “SYSTEM, METHOD, AND COMPUTER PROGRAM PRODUCT FOR ALTERING AT LEAST ONE ASPECT OF AN INTEGRATED E-COMMERCE ON-LINE APPLICATION;” and U.S. Provisional Patent Application No. 61/596,174, filed Feb. 7, 2012, titled “SYSTEM, METHOD, AND COMPUTER PROGRAM PRODUCT FOR ALTERING AT LEAST ONE ASPECT OF AN INTEGRATED E-COMMERCE ON-LINE APPLICATION,” which are incorporated herein by reference in their entirety.

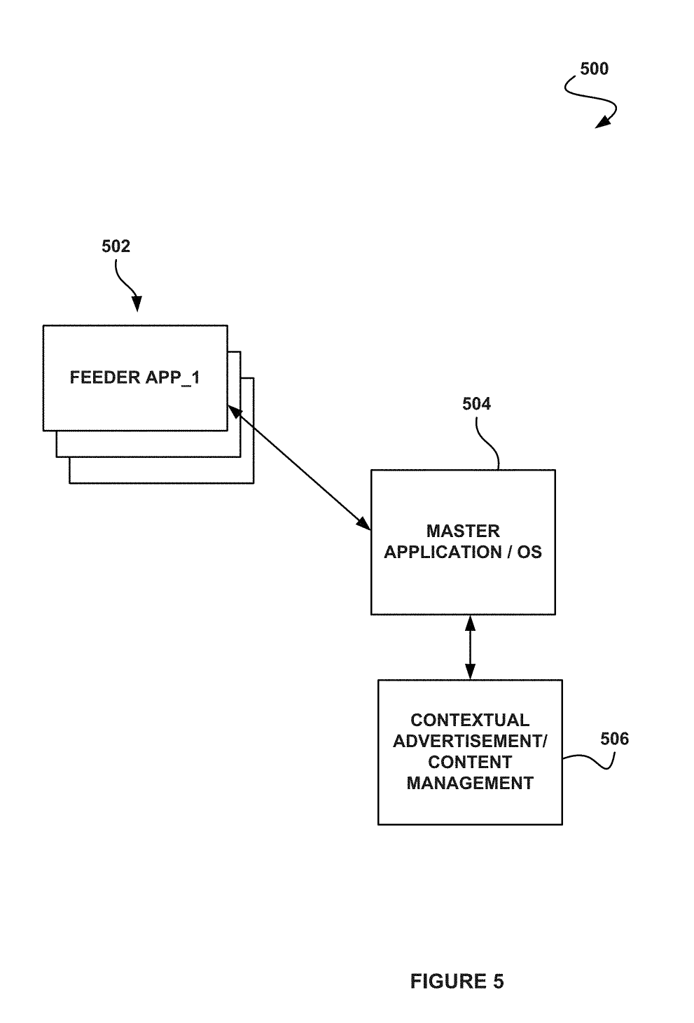

FIG. 5 shows a system 500 for contextual advertisement management in connection with a mobile device, in accordance with another embodiment. As an option, the system 500 may be implemented in the context of the architecture and environment of the previous Figures and/or any subsequent Figure(s). Of course, however, the system 500 may be implemented in the context of any desired environment. It should also be noted that the aforementioned definitions may apply during the present description.

As shown, one or more feeder applications 502 may be in communication with a master application or operating system 504. In one embodiment, the master application or operating system (OS) 504 may be in communication with one or more contextual advertisement/content management system 506, and/or may even be integrated therewith.

In operation, the feeder applications 502 may provide information to the master application/OS 504, such that the advertisements and/or content may be selected (again, or any action initiated), based on the information. In one embodiment, the advertisements and/or content may be displayed on a mobile device that is hosting the master application/OS 504. In one embodiment, the master application/OS 504 may select the advertisements and/or content to be displayed or presented. In another embodiment, the master application/OS 504 may provide information (e.g. the information from the feeder applications 502, additional information, etc.) to the advertisement/content management system 506, and the advertisement/content management system 506 may select the advertisements and/or content to be displayed or presented.

In one embodiment, the mobile device associated with the master application/OS 504 may also include the advertisement/content management system 506. In another embodiment, the advertisement/content management system 506 may be a networked based system (e.g. accessed over a network, etc.). Similarly, in one embodiment, the mobile device associated with the master application/OS 504 may include the feeder applications 502. In another embodiment, the feeder applications 502 may be networked based applications (e.g. accessed over a network, etc.).

In the context of the present description, a feeder application refers to any code capable of being used by an operating system and/or other application to receive and/or obtain information. Of course, such feeder application may be separate and/or integrated with (e.g. part of, etc.) of the operating system. In one embodiment, the information may include any information capable of being utilized to determine and/or select, and/or aid in the determination and/or selection of one or more advertisements and/or content. For example, in various embodiments, the feeder applications may include applications associated with a social network, retailers/service providers, household appliances, vehicles, browsers, cameras, text messages, emails, a mobile wallet, information gathering, GPS, mapping, location determining, products, real estate, music, movies, television, games, venues (e.g. stadiums, bars, restaurants, etc.), specific locations, libraries, business services (e.g. CRM, etc.) and/or various other types of applications.

In one embodiment, the mobile device may be configured such that a master application receives the information from the feeder applications 502. In another embodiment, the mobile device may be configured such that the operating system receives the information from the feeder applications 502. In this case, in various embodiments, the mobile device may or may not include a master application.

The master application may include any application capable of receiving information from the feeder applications 502. In one embodiment, the master application may be associated with the operating system of the mobile device. In another embodiment, the master application may include a social network application. In another embodiment, the master application may include a finance related application (e.g. a mobile wallet application, etc.). In another embodiment, the master application may include a search engine application. In another embodiment, the application may include an advertisement application. In another embodiment, the application may include a decision making platform application. Further, in various embodiments, the master application may be stored on the mobile device and/or may include a networked application.

In one embodiment, the master application/operating system 504 may utilize the information received by the feeder applications 502 to select advertisements. In another embodiment, the master application/operating system 504 may send the information (or selected relevant information, etc.) to the contextual advertisement/context management system 506, such that the contextual advertisement/context management system 506 may select advertisements to be displayed on the mobile device and/or another device. Again, any action may be initiated.

In one embodiment, the contextual advertisement/context management system 506 may be associated with (e.g. part of, etc.) the master application/operating system 504. In another embodiment, the contextual advertisement/context management system 506 may be a system and/or application separate from the master application/operating system 504.

Any of the information provided from the feeder applications 502 may be utilized to determine/select advertisements/content to present to a user of the mobile device. For example, the information provided by the feeder applications 502 may include personal information capable of being used to target advertisements/content to a particular user of the mobile device. As another example, the information provided by the feeder applications 502 may include information corresponding to actions of the user capable of being used to target advertisements/content to a particular user of the mobile device.

As another example, the information provided by the feeder applications 502 may include purchase history information capable of being used to target advertisements/content to a particular user of the mobile device. As another example, the information provided by the feeder applications 502 may include demographic information capable of being used to target advertisements/content to a particular user of the mobile device. As another example, the information provided by the feeder applications 502 may include browsing information capable of being used to target advertisements/content to a particular user, or to a particular group of users (e.g. your “friends,” a group of individuals defined by space, those that “like” the location, etc.) of the mobile device.

As another example, the information provided by the feeder applications 502 may include product/service interest information (e.g. social network “Like” information, etc.) capable of being used to target advertisements/content to a particular user of the mobile device. As another example, the information provided by the feeder applications 502 may include viewed product/service information capable of being used to target advertisements/content to a particular user of the mobile device. Of course, the information may include any information capable of being used to target advertisements/content to the user.

In various embodiments, the feeder applications 502 may be automatically pushed to the mobile device, automatically downloaded by the mobile device, manually downloaded to the mobile device, and/or executed by the mobile device at a remote location, etc. In one embodiment, one or more links to the application may be provided to the mobile device. For example, in one embodiment, the link may be provided to the mobile device in a text message. In another embodiment, the link may be provided to the mobile device in an email.

In another embodiment, the link may be provided by an application on the mobile device (e.g. an application store application, an application availability application, etc.). In one embodiment, if an application (or a link to an application, etc.) is available for execution and/or download, a notice may be provided to the mobile device. Additionally, in another embodiment, if an application (or a link to an application, etc.) is available for execution and/or download, a notice may be sent to friends and/or other contacts near the user's device. In one embodiment, settings may be adjusted by friends, contacts, and the user of the device to determine the ability of notices to be automatically sent.

FIG. 6 shows a system 600 for downloading/executing feeder applications in connection with a mobile device, in accordance with another embodiment. As an option, the system 600 may be implemented in the context of the architecture and environment of the previous Figures and/or any subsequent Figure(s) (e.g. see description of FIG. 4, for example). Of course, however, the system 600 may be implemented in the context of any desired environment. It should also be noted that the aforementioned definitions may apply during the present description.

As shown, a mobile device (or an application associated therewith, an OS associated therewith, etc.) determines whether one or more application links are detected. See determination 602. In one embodiment, the application links may include links, addresses, network locations, etc. associated with one more feeder applications capable of being executed and/or downloaded. In one embodiment, the detection of available application links may be automatic. In another embodiment, the detection of available application links may be manual (e.g. a user queries for available feeder applications, etc.). In another embodiment, an indicator may be displayed on the mobile device when applications are available.

In various embodiments, the links to the applications may include an html link, an indicator with an embedded link, an email including the link, a text message including the link, a link to a website including the application, and/or any other type of link. In various embodiments, the link to the application may include a link to download the application and/or upload the application.

If application links are detected, it is determined whether the mobile device settings permit installation, download, and/or execution of the application. See determination 604. In one embodiment, a user of the mobile device may have the ability to authorize access (e.g. download, execution, installation, etc.) to the application utilizing the mobile device. In another embodiment, the user may have the ability to authorize access (e.g. download, execution, installation, etc.) to specific applications and/or certain types of applications. In one embodiment, applications available for download, etc. may be presented to the user on the mobile device, such that the user may select the applications to download, etc. In another embodiment, the settings may present the user with a list of different types of applications and the user may have the ability to select the types of applications to access. In another embodiment, suspicious applications and/or application links may be flagged, such that the user is required to acknowledge or permit access before access to the application is permitted.

If the settings associated with the mobile device permit download, execution, and/or installation of the application associated with the link, it is determined whether the application is already installed and/or whether auto-install is permitted. See decision 606. In one embodiment, the user may have the ability to authorize automatic installation of feeder applications in the settings associated with the mobile device. In another embodiment, upon automatic installation of feeder applications, the user device may automatic post (or manually prompt the user to post, etc.) a posting relating to the automatic installation of the feeder applications. In other embodiments, upon automatic installation of feeder applications, the application (or a link to the application, etc.) may be sent to friends of the user (e.g. friends within a geographic area, all friends within a social database, etc.). Additionally, in a further embodiment, upon automatic installation of feeder applications, the feeder applications may automatically download relevant content to the user's device (e.g. coupons, discounts, reward card, etc.).

If it is determined that the application is already installed or is to be automatically installed, the application is downloaded if necessary, and the application is executed. See operation 612. In one embodiment, the user may be required to authorize the download and/or installation of the application (e.g. with a one-click option, etc.). Additionally, in one embodiment, the user may be required to select the application (or an icon associated therewith, etc.) to execute the application.

In one embodiment, the application may present to the user a relevant card (e.g. gift card near a store, royalty card, etc.), a relevant ticket (e.g. a ticket to an event which was pre-purchased, a ticket from Fandango, a ticket from StubHub, a pre-purchased ticket to Disneyland, ability to purchase a ticket to Disneyland, etc.), a relevant coupon (e.g. related to the store near the user, etc.), a relevant social interaction (e.g. “like” this store to get a coupon, etc.), a relevant review interaction (e.g. Yelp review after exiting a restaurant, Google customer review, etc.), a check-in interaction (e.g. Foursquare, Twitter, Facebook, etc.), and/or relevant financial interaction (e.g. display possible financial transaction card when user interacts with a store, restaurant, or any location where money is exchanged, etc.). Of course, any application may be presented to the user to facilitate interaction of the user with the content and/or ads. Further, in one embodiment, the application may present the user with a preconfigured card (e.g. pre-purchased ticket, pre-entered card, pre-entered information, etc.). In another embodiment, the application may present the user with the ability to configure a card and/or ticket (e.g. purchase a ticket to an event, fill out form for a royalty card, etc.)
In one embodiment, the application may interact directly with the user. In another embodiment, the application may operate and be managed by a contextual advertisement/content management (for example, see Ad Platform 402). If the application is operated and managed by a contextual advertisement/content management system, the system may automatically retrieve information relating to the application. For example, in one embodiment, information may be retrieved from an email (e.g. purchase receipt, text describing an event/store/interaction, etc.), text sms message (e.g. purchase confirmation, text describing an event/store/interaction, etc.), a social networking posting (e.g. “I'm going to [x] event,” a friend recommendation to interact with an event/store/interaction, etc.), and/or from any other source which may provide information. In one embodiment, when information is detected, the information may be automatically added to the contextual advertisement/content management system. In another embodiment, the information may be added manually (e.g. request to add information to the contextual advertisement/content management system, etc.).

If it is determined that the application is not already installed or automatic installation is not enabled, link(s) to the available application(s) are displayed. See operation 608. In various embodiments, the links to the applications may be displayed as an html link, an indicator (e.g. an image, an icon, an application name, etc.) with an embedded link, an email including the link, a text message including the link, a link to a website including the application, a list, and/or any other type of link.

In one embodiment, a description associated with the application may be provided. In one embodiment, the description of the application may be displayed along with the link (or access to the link, etc.). In another embodiment, the description of the application may be displayed upon a selection by the user (e.g. a selection of a drop-down description icon, etc.).

In another embodiment, if it is determined that the application is not already installed or automatic installation is not enabled, a coupon and/or deal relating to the application may be displayed. In such an embodiment, a coupon and/or deal may permit the user to experience part of the full application, and may help the user desire to download the application. For example, a displayed coupon may indicate that the user may receive 20% off the next purchase at a designated store. The coupon and/or deal may indicate that the downloaded application provides additional coupons and/or deals as well as greater functionality. In one embodiment, the coupons and/or deals may be used without any obligation. In any embodiment, the coupons and/or deals may be viewed, but in order to use them the user must download the application.

Once the links to the available applications are displayed, it is determined whether the user has selected one or more links or whether there is a timeout. See determination 610. In one embodiment, a timeout may not be present. If a selection has been made, the application(s) corresponding to the link(s) are downloaded and/or executed. See operation 612.

FIG. 7 shows a mobile device interface 700 for downloading/executing feeder applications in connection with a mobile device, in accordance with another embodiment. As an option, the interface 700 may be implemented in the context of the architecture and environment of the previous Figures and/or any subsequent Figure(s) (e.g. see description of FIG. 4, for example). Of course, however, the interface 700 may be implemented in the context of any desired environment. It should also be noted that the aforementioned definitions may apply during the present description.

As shown, the interface 700 may be utilized to present a user of a mobile device options to join one or more networks (e.g. wireless networks, etc.). Additionally, the interface 700 may present the user an option to download and/or execute one or more location specific (or location relevant, etc.) feeder applications. For example, in one embodiment, when a mobile device is exposed to a wireless network (e.g. a Wi-Fi network, etc.), feeder applications associated with that network may be presented for download or execution utilizing the interface 700. The networks may be associated with businesses, venues, cities, vehicles, and/or various other entities.

It should be noted that, in various embodiments, the network-related icons and application-related icons may be displayed on the same interface (e.g. simultaneously, etc.) or in sequence. For example, the network-related icons may be displayed first and, after selection thereof, the application-related icons may subsequently be displayed thereafter (if applicable for the network joined), as described earlier. In other embodiments, only the application-related icons may be displayed (e.g. such that joining a network is implied/inherent/combined) without requiring separate joining of a network.

In one embodiment, the mobile device may present an alert when networks and/or applications are available. In various embodiments, the alert may include a pop-up, an audible alert, an indicator, an icon, a message, and/or any other type of alert. In another embodiment, the interface 700 may be presented to the user on the mobile device when new applications and/or networks are available. In still another embodiment, the mobile device may present an alert in response to removing the mobile device from a standby mode. In such embodiment, the alert (and/or any of the icons disclosed hereinabove) may be displayed in a connection with (e.g. simultaneously with, immediately before or after, etc.) the display of a lock/password protection screen (e.g. for example, in the context of the lock/password protection screen display techniques disclosed herein in association with subsequent figures, etc.).

In another embodiment, the alert may be presented in response to a detection of a network. For example, in one embodiment, the mobile device may detect a wireless mesh network system with a request from another device to connect to the user's mobile device. Such a request may also include information relating to an application and/or coupon and/or deal. Of course, the mobile device may detect and interact with any type of network (e.g. WLAN, LAN, Bluetooth, Near Field Communication, etc.). In one embodiment, the detection of a network may occur automatically (e.g. network is automatically detected, etc.) or manually (e.g. request to view possible networks in the area, activate WiFi or Bluetooth or another communication sensor, etc.). In one embodiment, the request to join a network may be sent from another device (e.g. a friend may request the user to join a network, etc.). In a further embodiment, settings relating to received requests may be set to automatic (e.g. accept all network requests from friends or trusted sites, etc.) or to manual (e.g. review all requests individually and accept or deny each request, etc.). Of course, if a request is a first-time request or from a location which is not pre-approved (e.g. trusted site, etc.), then the user may review and accept or deny the request, or the user may preconfigure settings to automatically accept the request.

The applications may include any type of application. For example, in various embodiments, the applications may include applications associated with games, learning, photos, calendar, routing, maps, music, social networking, movies, VOIP, retailers, venues, any application that performs, causes, or facilitates the aforementioned action(s), etc. In one embodiment, the applications may provide information to an OS associated with the mobile device, an application associated with the mobile device, and/or an advertisement/content management system such that targeted advertisements and/or content may be provided to the user.

The applications may provide any type of information, including demographics, psychographics, behavioral variables (e.g. product purchase history, etc.), user preferences, other second-order activities, and/or other information. In one embodiment, the information may be utilized in connection with one or more advertisement selection algorithms. In various embodiments, the advertisement selection algorithms may be implemented by the operating system of the mobile device, an advertisement management system, an application, and/or any other system capable of selecting advertisements based on provided information.

In one embodiment, the advertisements and/or content selected may be automatically presented to a user (e.g. on the mobile device, a vehicle display, etc.). In another embodiment, the user may have the ability to request targeted content and/or advertisements. In one embodiment, an application on the mobile device may operate to present targeted advertisements to the user. As an option, the user may view the targeted advertisements in list format. In another embodiment, the user may view the targeted advertisements in a swipe-down screen (or from any direction), within a widget on a screen (e.g. the widget cycling through advertisements, etc.), in menu format (e.g. display advertisements based on location, genre, preference, recommendations, etc.), or in any manner.

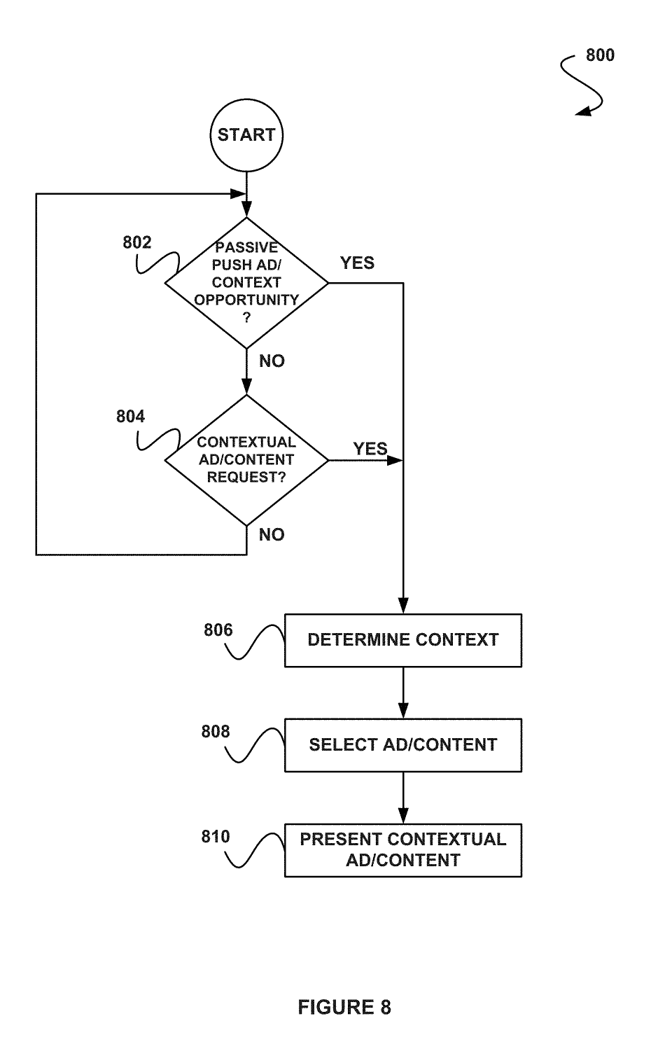

FIG. 8 shows a method 800 for presenting contextual advertisements, in connection with a mobile device, in accordance with another embodiment. As an option, the method 800 may be implemented in the context of the architecture and environment of the previous Figures and/or any subsequent Figure(s). Of course, however, the method 800 may be implemented in the context of any desired environment. It should also be noted that the aforementioned definitions may apply during the present description.

As shown, an advertisement/content management system (or software/a device associated therewith) determines whether an opportunity to passively push a targeted advertisement or targeted content exists. See determination 802. In one embodiment, an operating system or application associated with a mobile device may determine whether an opportunity to passively push a targeted advertisement or targeted content exists. In various embodiments, the determination whether to passively push (e.g. the pushing not based on user action, etc.) the advertisement/content may be based on a current user activity, a current device mode (e.g. standby mode, active mode, etc.), current application usage, current location, a current mobile device screen status, a movement of the mobile device (or lack of movement, etc.), a physical orientation of the mobile device (e.g. vertical, horizontal, etc.), a connection status of the mobile device (e.g. connected via Bluetooth, etc.), whether the user is viewing the mobile device screen (e.g. determined utilizing a camera associated with the mobile device, etc.), interaction with other devices (e.g. using near-field communication, Bluetooth pairing, etc.), time (e.g. integration with the device calendar, etc.), interaction with other applications, interaction with other sensors (e.g. camera, audio, etc.), and/or based on various other criteria.

Furthermore, it may be determined whether a contextual advertisement and/or content request is received. See determination 804. In one embodiment, the user of the mobile device may send the request for the contextual advertisement and/or content request. In one embodiment, the request may be initiated utilizing an application on the mobile device. As an option, a user may initiate the request by launching the application (e.g. by selecting an icon associated with the application, etc.). In another embodiment, a user may initiate the request by selecting a swipe-down menu (or from any direction, etc.), giving a voice command (e.g. “display relevant ads,” etc.), and/or any other user request. In other embodiments, the request may be initiated automatically (e.g. by turning on the device, finishing a phone call, walking out of a building or from a site, etc.) or may be initiated manually (e.g. manual selection and/or request, etc.).

In another embodiment, an application associated with the mobile device may request the advertisement and/or content. For example, an application being utilized by the user and/or by the mobile device may request the advertisement and/or content. If it is determined to present an advertisement and/or content, a context associated with the advertisement is determined. See operation 806.

In one embodiment, the context may be determined based, at least on part, on information provided by one or more feeder applications. In another embodiment, the context may be determined based, at least in part, on current and/or past activities of the user (e.g. as determined by hardware/software associated with the mobile device, etc.). In another embodiment, the context may be determined by current and/or past activities of the mobile device. In another embodiment, the context may be determined based on a location of the user and/or the mobile device. In various embodiments, the context may be determined by software associated with the mobile device, an advertisement/content management platform, an application, an operating system associated with the mobile device, and/or various other systems.

The context may include any circumstances that form the setting for an event (e.g. an advertisement display, a content display, etc.). For example, in various embodiments, information for determining the context may include location information (e.g. GPS location information, a physical address, an IP address, shopping center, movie theatre, stadium, etc.), network information (e.g. information associated with the network currently being utilized or currently being accessed, etc.), applications being utilized (e.g. games, maps, camera, retailer, social networking, etc.) current activities (e.g. shopping, walking, eating, reading, driving, etc.), browsing activity, environment (e.g. environmental audio, weather, temperature, etc.), payment activities (e.g. just purchased coffee, groceries, clothes, etc.), and/or any other type of information.

Once a context is determined, one or more advertisements and/or content are selected based, at least in part, on the determined context. See operation 808. In one embodiment, information associated with the user of the mobile device and/or information associated with the activities of the user may be utilized to select the advertisement(s)/content. In one embodiment, the additional information may be information received by feeder applications. Further, in one embodiment, the information may be received by a social network application (and/or social network system, etc.). In another embodiment, the information may be received by a mobile wallet application. In another embodiment, the information may be received by a retailer application, or managed by a business entity (e.g. for CRM purposes, etc.).

In one embodiment, one or more advertisement/content selection algorithms may be utilized to select the content/advertisements. Once the advertisement (s)/content or content are selected, the contextual advertisement/content is presented. See operation 810. In various embodiments, the advertisement/content may be presented on the mobile device, and/or on another device capable of being viewer by the user. In various embodiments, the other device capable of being viewed by the user may include a television, a store display, a billboard, a vehicle display, a computer display, an e-reader display, and/or various other devices capable of displaying the advertisement/content.

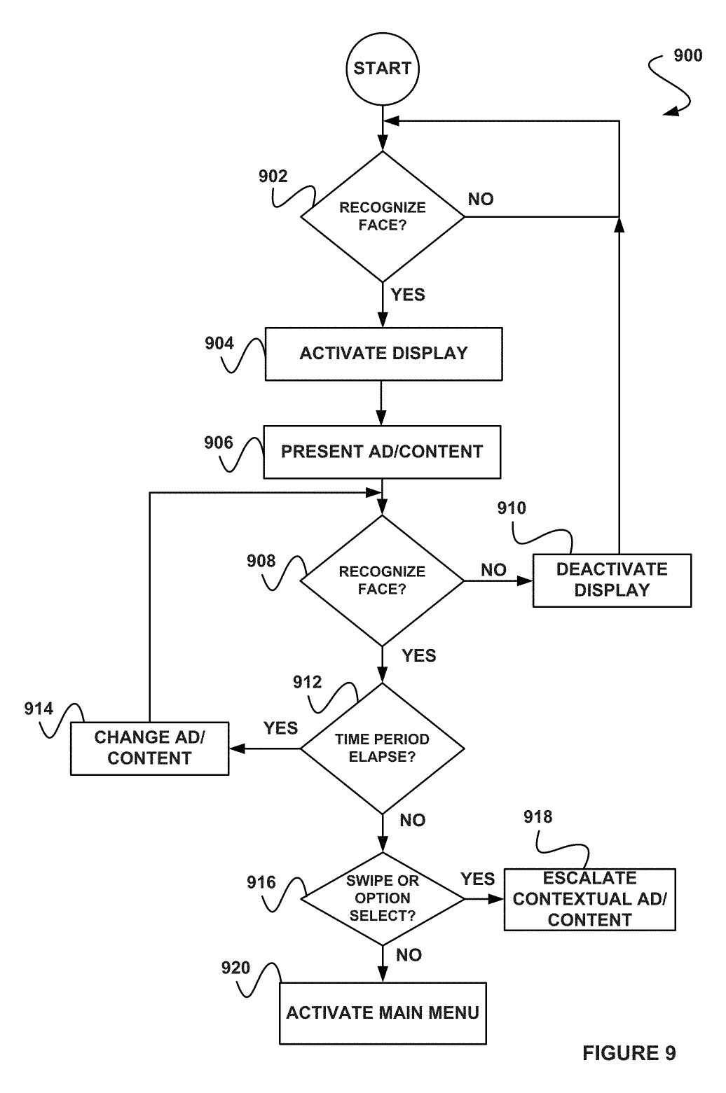

FIG. 9 shows a method 900 for presenting contextual advertisements, in connection with a mobile device, in accordance with another embodiment. As an option, the method 900 may be implemented in the context of the architecture and environment of the previous Figures and/or any subsequent Figure(s). Of course, however, the method 900 may be implemented in the context of any desired environment. It should also be noted that the aforementioned definitions may apply during the present description.

As shown, a mobile device (and/or hardware and/or software associated therewith, etc.) determines whether a face of a user is recognized. See determination 902. For example, in one embodiment, one or more cameras associated with the mobile device may capture one or more images capable of being utilized to perform one or facial recognition techniques to determine whether a face associated with the image(s) is recognized and/or authorized.

More information regarding facial recognition may be found in U.S. Provisional Patent Application No. 61/612,960, filed Mar. 19, 2012, titled “SYSTEM, METHOD, AND COMPUTER PROGRAM PRODUCT FOR ALTERING AT LEAST ONE ASPECT OF AN EXPERIENCE OF A VIEWER IN ASSOCIATION WITH A TELEVISION,” which is incorporated herein by reference in its entirety.

In one embodiment, the camera(s) associated with mobile device may capture the one or more images in response to motion. Additionally, in one embodiment, the camera(s) may capture the one or more images in response to a change in a mode of the mobile device (e.g. a change from standby to on, etc.). In another embodiment, the camera(s) may capture the one or more images in response to an instruction from an application. In another embodiment, the camera(s) may capture the one or more images in response to a user action associated with the mobile device. In various embodiments, the user action may include an audible utterance detected by the mobile device, a motion detected by the mobile device (e.g. a hand motion, a finger motion, etc.), a button press, a touch of a screen of the mobile device, and/or various other actions.

In another embodiment, the camera(s) associated with the mobile device may periodically capture images (e.g. at user adjustable time intervals, etc.). In another embodiment, a sensor may be utilized to detect the presence of a user and the camera may capture images. In another embodiment, the camera may be utilized to sense the presence of a user. In one embodiment, a camera application and/or a facial recognition application may operate in the background. For example, in one embodiment, the camera application and/or the facial recognition application may operate in a standby mode of the mobile device.

In one embodiment, the camera may record images of objects in its field of view. In various embodiments, the camera may be configured to record images periodically (e.g. a fixed rate, etc.), in response to movement within a zone in front of the camera (e.g. in response to a user moving into position in front of the camera, etc.), in response to explicit input from a user (e.g. a user touching a key or screen of the mobile, etc.). In one embodiment, the camera may be configured to record images at a low rate when activity is not detected within a zone in front of the camera and to record images at a higher rate when activity is detected within the zone. This may allow the camera to respond quickly to a user beginning to use the mobile device or to a user who stops using the mobile device, thereby avoiding consuming resources at a high rate. In some implementations, the images recorded may be discarded after a threshold amount of time has elapsed since the images were recorded (e.g. 1 minute, 2 minutes-5 minutes, etc.). Further, in one embodiment, the images recorded may be discarded when the mobile device is shut down or enters a low-power state.

In some embodiments, the camera may use an object recognition algorithm to detect the object being viewed. In one embodiment, the battery of the device may be more efficiently used to first determine whether the object includes two eyes and a nose (or a mouth, or any general feature of the face, etc.). In another embodiment, the object recognition algorithm may operate at more than one power consumption level (e.g. low consumption, high consumption, etc.). For example, in one embodiment, once a general face object has been identified in low power, the object recognition algorithm may switch to high power to match more closely the facial features with an actual user. Of course, the object recognition algorithm may be used for more than security purposes (e.g. unlock the device, etc.). For example, the object recognition algorithm may be used to select a set of preconfigured content (e.g. royalty cards, tickets, personalized ads, etc.), select preconfigured network settings (e.g. accept all network requests, connect to friends nearby, etc.), and/or select any other personalized content.

In one embodiment, the images recorded may be received and analyzed by a user recognizer application (or software, etc.) to determine an identity of the user whose image is recorded. In various embodiments, the user recognizer may perform facial recognition on the images. For example, the user recognizer may compare the facial features of the user, as detected by the camera and analyzed by the user recognizer with the facial features of one or more potential users. The comparison may include a comparison of other facial features that can be used to identify a user. In one embodiment, the advertisements displayed may be based on the identity of the user (e.g. context of the ads may be identity based, etc.). For example, in various embodiments, if it were determined that a child user were using the device, the ads selected may be deemed appropriate and relevant for that child, whereas the ads selected for a known adult user will be targeted for that specific user. As such, the ads may be selected based on the specific user of the device.

Various facial recognition techniques can be used. For example, in one embodiment, techniques may be used that distinguish a face from other features in the field of view of the camera and subsequently measure the various features of the face. Every face has numerous, distinguishable landmarks, and different peaks and valleys that make up facial features. In one embodiment, these landmarks may be used to define a plurality of nodal points on a face, which may include information about the distance between eyes of a user, the width of the nose of the user, the depth of eye sockets of the user, the shape of the cheekbones of the user, and/or the jaw line length of the user, etc. In one embodiment, the nodal points of the face of the user may be determined from one or more images of the face of the user to create a numerical code (i.e. a faceprint, etc.) representing the face of the user.

In another embodiment, facial recognition may be performed based on three-dimensional images of the face of the user or based on a plurality of two-dimensional images which, together, may provide three-dimensional information about the user's face. Three-dimensional facial recognition uses distinctive features of the face, e.g., where rigid tissue and bone is most apparent, such as the curves of the eye socket, nose and chin, to identify the user and to generate a faceprint of the user. The faceprint of a user may include quantifiable data such as a set of numbers that represent the features on a user's face.

In another embodiment, a plurality of two-dimensional images of different points of view relative to the face of the user may be obtained and used to identify the user. This also may foil attempts to fool the facial recognition technology, such as by holding up a photograph of a user who is not actually present in front of the mobile.

After an identity of the user has been determined based on one or more images of the user (e.g. determined through a quantifiable faceprint that is generated of the user's face, etc.), the user recognizer software may compare the identity of the user to one or more predetermined identities. In one embodiment, if a match is found between the determined identity and a predetermined identity, the display of the mobile device may be activated. See operation 904. In one embodiment, the user may be logged into the mobile device if a match is found.

In one embodiment, the predetermined identities may be stored by the mobile device, for example, in one or more memories. In another embodiment, the predetermined identities may be stored on a networked server or database. In various embodiments, the predetermined identities may include one or more images of users, quantifiable face print information of one or more users, or a subset of quantifiable face print information, wherein the subset is insufficient to reconstruct an image of the user.

In one embodiment, the predetermined identities may be stored at the request of a user according to an opt-in process, for a user who wishes to take advantage of the facial recognition technology to log on to the mobile device. For example, in one embodiment, a default login procedure for a user may require the user to enter a first and second alphanumeric string, such as a username and a password. However, once the user has successfully logged in using a default login procedure the user may opt to have the mobile device store a predetermined identity associated with the user, so that during future logins the user make take advantage of a login procedure that is based on facial recognition technology, which may be less time consuming and less obtrusive to the user than entering a username and a password.

More information about facial recognition may be found in U.S. Pat. No. 8,261,090, issued Sep. 4, 2012, titled “Login to a computing device based on facial recognition,” which is incorporated herein by reference in its entirety.

Once the display of the mobile device is activated, a selected advertisement and/or selected content is presented to the user. See operation 906. In one embodiment, the selected advertisement/content may be targeted, as described in the context of the previous figures.

In one embodiment, the advertisement/content may be presented on a display screen associated with mobile device. In one embodiment, the advertisement/content may be presented on a lock screen associated with mobile device. Further, in one embodiment, the advertisement/content may be presented on a home screen associated with mobile device. In another embodiment, the advertisement/content may be presented on a main operating system screen associated with mobile device. In another embodiment, the advertisement/content may be presented by an application associated with mobile device. In another embodiment, the advertisement/content may be presented as a banner. In another embodiment, the advertisement/content may be presented on open space associated with the display (e.g. space not displaying applications icons, etc.). In another embodiment, the advertisement/content may be presented as open a pop-up, a drop-down screen, a swiped screen, and/or any type of display.

Once the advertisement/content is presented, is it further determined whether the face viewing the advertisement is still recognized. See determination 908. If the face is not recognized, or there is not a user viewing the display, the display is deactivated. See operation 910. In one embodiment, the display may be placed in a standby mode. In another embodiment, the display may display an indicator that the current viewer in unauthorized. In another embodiment, the display may not be illuminated.

If the face is recognized, it is determined whether a time period of displaying the advertisement has elapsed. See determination 912. In one embodiment, the time period may include a predefined time period. In one embodiment, the time period may be associated with a screen illumination time period associated with the mobile device. In another embodiment, the time period may be associated with a fee paid by the advertiser. In a further embodiment, the time period may begin in response to a screen timeout functions. For example, in one embodiment, after the device has remained inactive for a set time, the screen may dim and automatically display a possibly relevant ad. In such an embodiment, once the screen dims, the time period relating to displaying the advertisement may begin (e.g. cycle through ads every five second until the screen shuts off, etc.).

If it is determined that the time period has elapsed, the advertisement/content is changed. See operation 914. In one embodiment, the advertisement may include another targeted advertisement/content. In one embodiment, the advertisement/content may be changed by tracking retina movements (e.g. stable retina movements may indicate interest in viewing the ad, etc.). In a further embodiment, retina movements may track the user's preference for ads when displayed with a list or menu of ads (e.g. tracking retina movements may indicate which ads are efficient and effective to the user, etc.).

If the time period has not elapsed, it is determined whether a swipe or option select of the advertisement/content is received. See determination 916. For example, in one embodiment, the user may click on the displayed advertisement to select the advertisement.

In another embodiment, the user may initiate a swipe with a finger across the advertisement/content and/or the screen to select the advertisement. In one embodiment, the user may select the advertisement from a list of advertisements (e.g. a list of ads, coupons, offers, discounts, reward cards, etc.). In another embodiment, the advertisement/content may be selected by the user utilizing an audible utterance. In another embodiment, the advertisement/content may be selected based on a length of time of a gaze of the user. For example, the camera may capture images of the user viewing the advertisement/content. If the user views the advertisement/content for amount of time that exceeds a predefined threshold (e.g. 5 seconds, 10 seconds, 15 seconds, etc.), it may be determined that the advertisement/content has been accepted. Of course, the advertisement/content may be selected utilizing a variety of other techniques.

If it is determined that the advertisement/content has been selected, the contextual advertisement/content is escalated. See operation 918. The contextual advertisement/content may be escalated utilizing a variety of techniques. For example, in one embodiment, an advertisement/content with more detail/information associated with the original advertisement/content may be displayed. In another embodiment, the user may be routed to a website associated with the advertisement/content. In another embodiment, the user may be presented with an opportunity to purchase a product or service associated with the advertisement/content.

In another embodiment, the user may be presented with additional information associated with the advertisement/content. In another embodiment, the user may be presented with directions and/or a map to a location associated with the advertisement/content. In another embodiment, the user may be provided with coupons and/or discounts, on the mobile device. In another embodiment, the user may be offered the opportunity to share the advertisement/content. In various embodiments, the user may be offered the opportunity to share the advertisement/content on a social networking website, via a text message, via an email, via an audio message, by sending the advertisement/content to another mobile device/user, by posting the advertisement/content on a media board (e.g. a web page, etc.).

In still another embodiment, the user may presented with a menu with other available content and/or associated functionality. For example, if the initial ad/content of operation 906 is presented as a function of arriving at a particular location (and possibly at a particular time), such initial ad/content may include an ad/content that has some utilitarian purpose (e.g. boarding pass, entrance ticket, loyalty deal, etc.). Further, at least one possible option/selection made available in connection with such initial ad/content may be a display of a menu of ad/content and/or functionalities/services, etc. that are available via the application (e.g. feeder application, etc.) that prompted the display of the initial ad/content (e.g. via a master application/OS, etc.).

In one embodiment, the advertisement/content may be escalated on a device other than the original mobile device of a user. For example, in various embodiments, the advertisement/content may be escalated on a tablet computer, another mobile device, a third party display, a vehicle display, and/or any other type of display. For example, the user may select the advertisement/content on a mobile phone while shopping in a store (or lounging at a bar, etc.) and the advertisement/content may be escalated to a display in the bar. In one embodiment, communication between the mobile device and the display may be coordinated upon a check-in procedure undertaken by the user.

More information regarding user check-in may be found in U.S. Provisional Patent Application No. 61/590,767, filed Jan. 25, 2012, and titled “SYSTEM, METHOD AND COMPUTER PROGRAM PRODUCT FOR LOCATION-SPECIFIC PRIVACY SETTINGS,” which is incorporated herein by reference in its entirety.

If it is determined that the user did not select the advertisement/content, a main menu or screen associated with the mobile device is activated. See operation 920. In one embodiment, the advertisement/content may be removed when the main menu/screen is activated. Additionally, in one embodiment, activating the screen may require user login (e.g. by entering a pass code, by facial recognition, etc.). The main menu/screen may include any main menu associated with the mobile device.

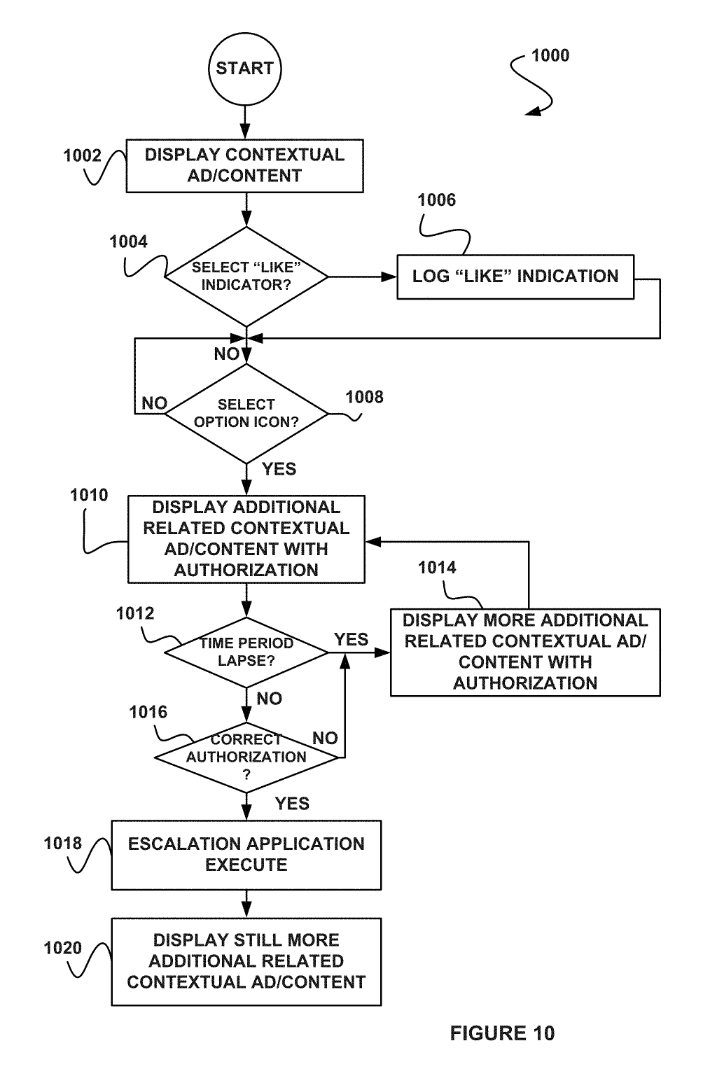

FIG. 10 shows a method 1000 for presenting contextual advertisements, in connection with a mobile device, in accordance with another embodiment. As an option, the method 1000 may be implemented in the context of the architecture and environment of the previous Figures and/or any subsequent Figure(s). Of course, however, the method 1000 may be implemented in the context of any desired environment. It should also be noted that the aforementioned definitions may apply during the present description.

As shown, a contextual advertisement or content is displayed. See operation 1002. In one embodiment, the contextual advertisement/content may be displayed on a screen of a mobile device associated with a user. In another embodiment, the contextual advertisement/content may be displayed on a television. In other embodiments, the contextual advertisement/content may be displayed on any other type of display.

Once the advertisement/content is displayed, it is determined whether the user selects a “Like” indicator associated with the advertisement/content. See determination 1004. In various embodiments, the “Like” indicator may include a graphical indicator (e.g. a thumbs up, a happy face, etc.), a text indicator (e.g. the word “Like,” etc.), a numerical indicator (e.g. a numerical rating, a 1-5 rating, etc.), and/or any other type of indicator. In one embodiment, the “Like” indicator may be presented along with the advertisement/content. In another embodiment, the “Like” indicator may be presented when a menu of options is selected. In a further embodiment, the “Like” indicator may be automatically set based on a length of time the user spends viewing the ad (e.g. more than 20 seconds, etc.). The automatic selection may be based off of settings as predetermined by the user.

If the “Like” indicator is selected, the “Like” indication is logged. See operation 1006. In one embodiment, the mobile device may log the “Like” indication. In another embodiment, a system associated with a social network may log the “Like” indication. In another embodiment, an advertisement system may log the “Like” indication. In one embodiment, the like indication may be logged in a networked database.

Further, it is determined whether an option icon is selected by the user. See determination 1008. In one embodiment, the option icon may include an arrow. In another embodiment, the option icon may include text (e.g. “Options,” “Additional Information,” “More,” etc.). In various embodiments, the option icon may include any type of image, character, and/or object.

If the option icon is selected, additional related contextual advertisements/content is displayed. See operation 1010. In one embodiment, the additional related contextual advertisement/content may only be displayed when authorization is provided. For example, in one embodiment, a password may be required to display the additional related contextual advertisement/content. In another embodiment, facial recognition may be used as authorization to display the additional related contextual advertisement/content. In another embodiment, biometric data (e.g. a finger print, thumb print, etc.) may be utilized as authorization.

The additional related advertisement/content may include any related advertisement/content. For example, in one embodiment, additional related advertisement/content may include additional information associated with the advertisement/content. In another embodiment, the additional related advertisement/content may include different related advertisements and/or content. In another embodiment, the additional related advertisement/content may include discounts associated with the advertisement/content. In another embodiment, the additional related advertisement/content may include barcodes associated with the advertisement/content. In another embodiment, the additional related advertisement/content may include discount codes associated with the advertisement/content.

Further, in one embodiment, the additional related advertisement/content may be selected utilizing user-related information. In another embodiment, the additional related advertisement/content may be selected utilizing user-related information that is different from user-related information utilized to select the original displayed contextual advertisement/content.

Further, it is determined whether a time period for displaying the additional advertisement has lapsed. See determination 1012. If the time period for displaying the advertisement has expired, more additional related contextual advertisements/content may be displayed. See operation 1014. In one embodiment, the more additional related contextual advertisement/content may only be displayed when authorization is provided. For example, in one embodiment, a password may be required to display the additional related contextual advertisement/content. In another embodiment, facial recognition may be used as authorization to display the additional related contextual advertisement/content. In another embodiment, biometric data (e.g. a finger print, thumb print, etc.) may be utilized as authorization. Of course, any additional related and/or unrelated ad/content and/or functionalities/services may be provided (e.g. see, for example, the description provided in connection with operation 918 of FIG. 9, etc.).

In one embodiment, it may be determined whether the authorization provided by the user matches correct authorization credentials. See determination 1016. If it is determined that the authorization is correct, an escalation application is executed. See operation 1018. The escalation application may include any application capable of escalating an advertisement/content. In one embodiment, the escalation may include displaying personalized advertising, content, and/or information. Upon execution of the escalation application, still more additional related contextual advertisement/content is displayed. See operation 1020. Of course, any additional related and/or unrelated ad/content and/or functionalities/services may be provided in connection with operation 1020 (e.g. see, for example, the description provided in connection with operation 918 of FIG. 9, operation 1014 of FIG. 10, etc.). In other embodiments, once an escalation occurs, the escalation may trigger other actions. For example, an advertisement/content which has been escalated may cause the device to display an option to buy, an action to share the ad via social networking platforms, a prompt to share the ad with a friend, and/or any other action.

In one embodiment, prior to the user being authorized on a mobile device, the contextual advertisement/content may be displayed on a main screen associated with a device. In another embodiment, prior to the user being authorized on a mobile device, the contextual advertisement/content may be displayed on a lock screen associated with a device.

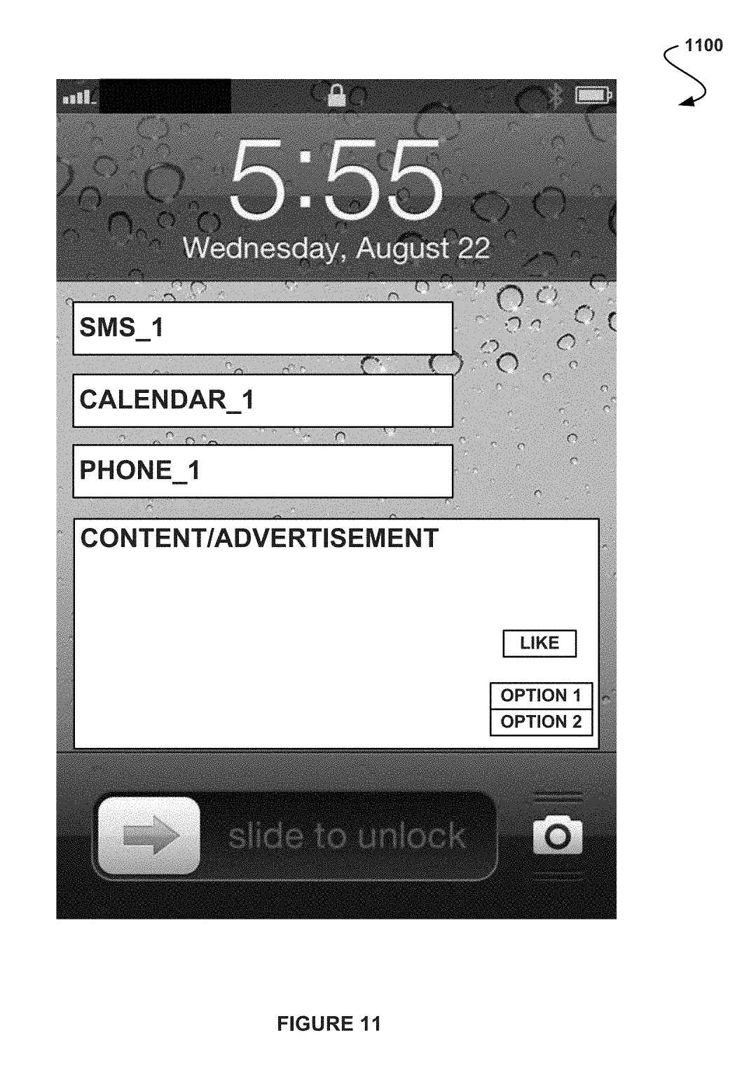

FIG. 11 shows a mobile device interface 1100 for displaying advertisements/content, in accordance with another embodiment. As an option, the interface 1100 may be implemented in the context of the architecture and environment of the previous Figures and/or any subsequent Figure(s). Of course, however, the interface 1100 may be implemented in the context of any desired environment. It should also be noted that the aforementioned definitions may apply during the present description.

As shown, the interface 1100 may be capable of displaying one or more alerts, as well as advertisements/content. In one embodiment, the interface 1100 may include a standby screen associated with the mobile device. In another embodiment, the interface 1100 may include a lock screen associated with the mobile device. In one embodiment, the interface 1100 may include an interface that is displayed prior to the user providing login or verification credentials (e.g. a password, facial verification, biometric verification, etc.).

In one embodiment, the interface 1100 may display a tier one contextual advertisement/content. In one embodiment, the tier one contextual advertisement/content may include an upper level more general targeted advertisement/content. In one embodiment, upon providing proper credentials (e.g. a password, biometrics, etc.), the advertisement may be escalated and a tier two advertisement/content may be displayed. In one embodiment, the tier two advertisement/content may include more targeted information than a tier one advertisement. Additionally, in one embodiment, the tier two advertisement/content may include more personalized information than a tier one advertisement. In a further embodiment, the tier two advertisement/content may be a result of the advertisement/content being escalated, an action taken by a user (e.g. “like” the advertisement, buy a recommended product, etc.), or any action. In other embodiments, the tier two advertisement/content may be designated as such without relying upon action and/or input from other sources (e.g. applications, user, etc.).

In various embodiments, the interface 1100 may display text messages, calendar alerts, missed call alerts, voice message alerts, contextual advertisements/content, application availability alerts, and/or various other alerts. For example, in one embodiment, an advertisement may be selected based on information associated with the user (e.g. current location, current activity, purchase history, social network information, etc.). Upon determination of an optimal time to display the advertisement (e.g. based on current location, current activity, facial recognition, etc.), the advertisement may be displayed utilizing the interface 1100.

In one embodiment, options associated with the advertisement/content may be presented with the advertisement/content. For example, in one embodiment, the content/advertisement may be presented with an option to indicate a “Like” of the content/advertisement. In one embodiment, selecting a “Like” of the advertisement/content may cause an escalation of the content/advertisement. In another embodiment, selecting a “Like” of advertisement/content may cause an indication of the “Like” being stored in a database (e.g. a database associated with an advertiser, a database associated with a social network, etc.). In another embodiment, selecting a “Like” may cause the advertisement/content to be shared with other users. In various embodiments, the advertisement/content may be shared with other users via a post to a social networking site, a text message, an email message, via an application on a device associated with the other users (e.g. mobile phones, tablet computers, etc.), and/or utilizing various other techniques.

Further, in one embodiment, the content/advertisement may be displayed with one or more user selectable options. In one embodiment, the options may include escalating the advertisement/content. In one embodiment, escalating the advertisement/content may include providing more detailed information associated with the content/advertisement. In another embodiment, escalating the advertisement/content may include providing purchase options associated with advertisement content. In another embodiment, escalating the advertisement/content may include providing location information associated with the content/advertisement.

In another embodiment, the options may include displaying similar types of advertisements/content. In another embodiment, the options may include sharing the content/advertisement with one or more other users. In another embodiment, the options may include initiating a purchase of a product/service associated with the advertisement/content. In another embodiment, the options may include requesting additional information associated with the advertisement/content. In another embodiment, the options may include calling a number associated with the advertisement/content.

In another embodiment, the options may include sending a text message or email associated with the advertisement/content (e.g. to a company contact, etc.). In another embodiment, the options may include providing directions and/or a map associated with the advertisement/content. In another embodiment, the options may include removing the display. In another embodiment, the options may include displaying another unrelated advertisement. In one embodiment, upon entering a proper passcode at an initial display/screen, the advertisement/content may be escalated. Additionally, in one embodiment, upon entering an improper passcode at an initial screen, additional content/advertisements may be displayed. In one embodiment, the additional content/advertisements may include related content/advertisements. In a further embodiment, the options may include redeeming the coupon immediately, displaying “content not relevant,” “send to another device,” and/or “more advertisements like” the current advertisement, and/or any other option relating to the advertisement/content.

As an option, the content/advertisement shown may be the first of a plurality of available content/advertisement that is appropriate (e.g. triggered) based on the current context (e.g. location, time, other parameters/criteria disclosed earlier, etc.). Such additional available content/advertisement may, in one embodiment be listed on top or bottom (or otherwise simultaneously) of the illustrated content/advertisement. In other embodiments, an icon may be provided for displaying the additional available content/advertisement upon the selection thereof. In other embodiments, a user may carry out a horizontal (or vertical) swipe gesture for triggering the display of an initially hidden additional available content/advertisement by replacing the current available content/advertisement. Of course, this may be repeated as many times as there are additional available content/advertisement. In another embodiment, a user may display an initially hidden additional available content/advertisement by moving the device in some manner (e.g. a motion to the side displays and cycles through the advertisement/content, a motion downward brings up a separate genre of advertisements/content (e.g. recommended ads, ads near “you,” food ads, etc.). Of course, actions associated with the motions may be preconfigured by the user.

While not shown, any content/advertisement(s) may be initially hidden and then accessed via a pull down screen (which is also initially hidden) until a user initiates a vertical downward swipe gesture that originates at a top of the screen, to virtually cover the graphics of the current graphics display with the pull down screen. As an option, an icon and/or text (e.g. possibly in connection with a virtual pull down screen tab, etc.) may be displayed to prompt a user to initiate the aforementioned vertical downward swipe gesture that originates at a top of the screen (e.g. possibly on the virtual pull down screen tab, etc.). In another embodiment, an icon (like the photo-icon shown and/or a supplement or substitute therefor) may be displayed at a bottom of the screen to prompt a user to initiate a vertical upward swipe gesture that originates at a bottom of the screen (e.g. on the icon, etc.) for virtually uncovering the ad/content by removing the graphics of the current graphics display (e.g. possibly without having to “slide to unlock” the screen, etc.).

While not shown, the above ad/content techniques disclosed in the context of FIG. 11 may be applied in the context of screens other than a lock screen, etc. For instance, the above ad/content techniques disclosed in the context of FIG. 11 may be applied to a phone call interface that is displayed while a phone call is active. In such embodiment, the ad/content and/or related icons/selectors, etc. may be displayed simultaneously with phone options such as a mute icon, conference call icon, merge call icon, etc. In another embodiment, the above ad/content techniques disclosed in the context of FIG. 11 may be applied to a voice mail interface that is displayed before and/or while and/or after a voicemail is being audibly presented. For that matter, such techniques may be displayed in the context of any screen in which the mobile user is not using (or heavily using) an interface. Further, in another embodiment, such techniques may also be displayed in the context of any inactive homescreen (e.g. not default homescreen, etc.).

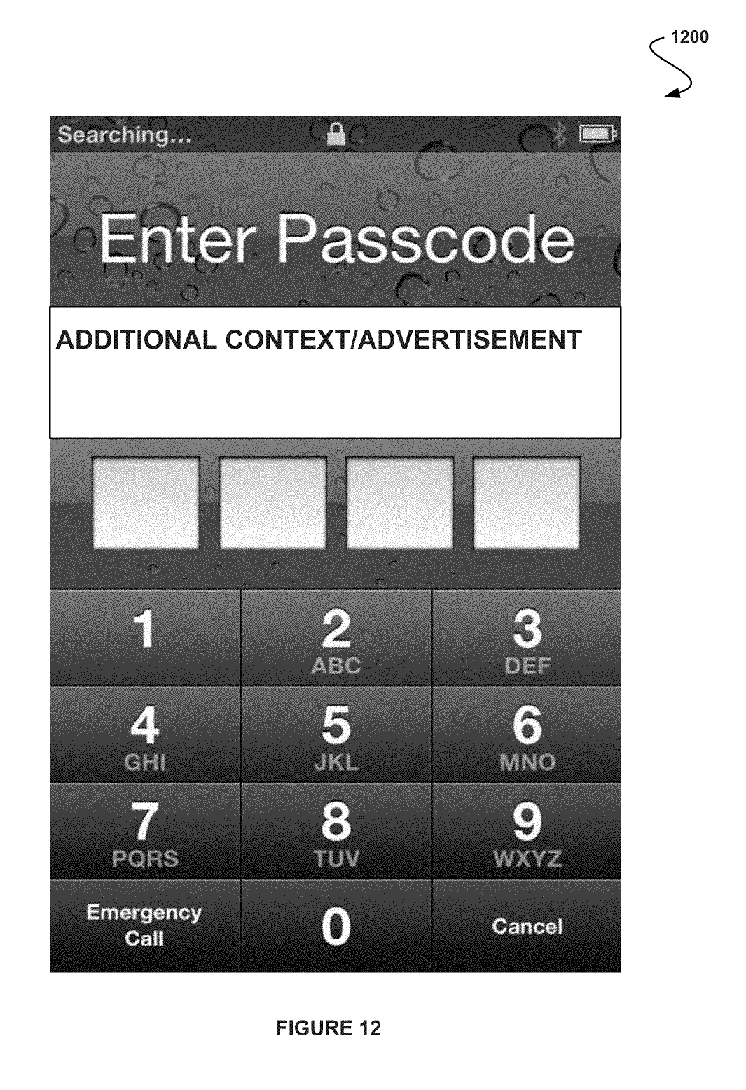

FIG. 12 shows a mobile device interface 1200 for displaying advertisements/content, in accordance with another embodiment. As an option, the interface 1200 may be implemented in the context of the architecture and environment of the previous Figures and/or any subsequent Figure(s). For example, any of the ad/content techniques disclosed in the context of FIG. 11 may be applied in the present interface 1200. Of course, however, the interface 1200 may be implemented in the context of any desired environment. It should also be noted that the aforementioned definitions may apply during the present description.

As shown, the interface 1200 may be capable of displaying additional content/advertisements at a password entry screen. In one embodiment, the additional content/advertisement may include information related to the advertisement/content displayed on an initial screen/display. In another embodiment, the additional content/advertisement may include another advertisement/content, unrelated to the advertisement/content displayed on the initial screen/display. In one embodiment, the additional content/advertisement may be able to be selected by the user such that additional information is displayed. Of course, in various embodiments, any type of information may be displayed as part the additional context/advertisement.

In one embodiment, upon successful entry of the password, the advertisement/content may be escalated. In another embodiment, upon successful entry of the password, a home screen including a plurality of application icons may be displayed. In one embodiment, at least one of the plurality of application icons may include an application icon associated with displaying available context/advertisements.

In another embodiment, the additional context/advertisement may be changed periodically (e.g. every five seconds, etc.) on the initial screen/display. Of course, settings relating to the additional context/advertisement on the initial screen/display may be preconfigured and set by the user. In another embodiment, the selection of additional context/advertisement may be made by a third party (e.g. network carrier, social network provider, advertisement agency, etc.).

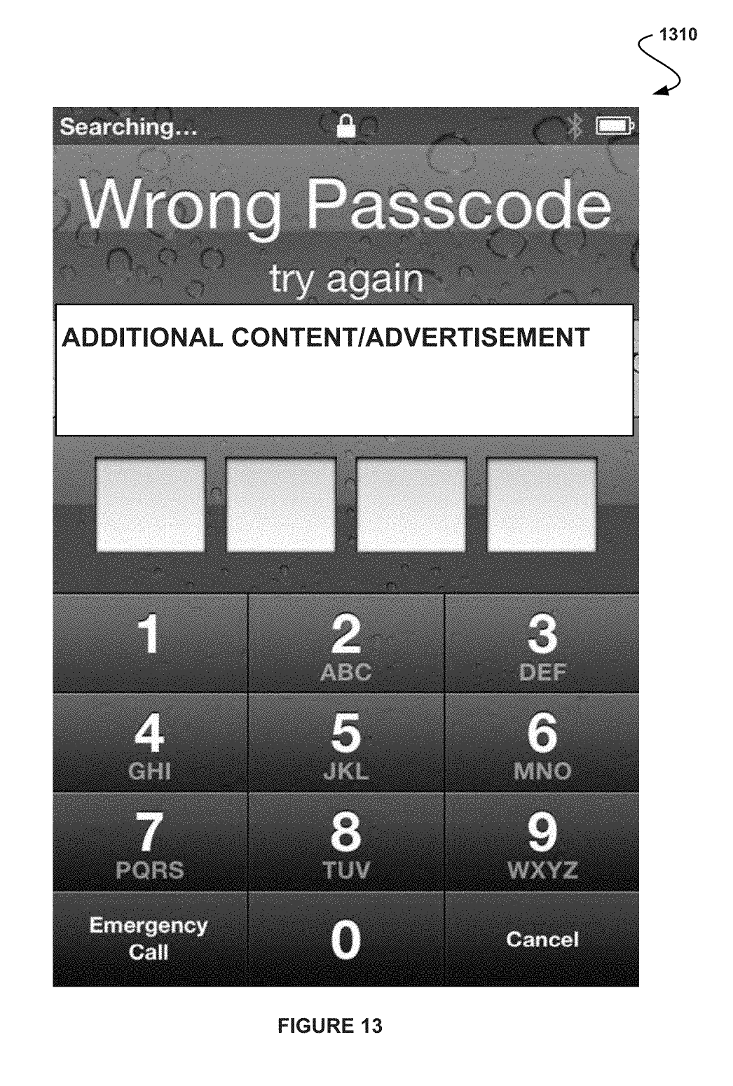

FIG. 13 shows a mobile device interface 1300 for displaying advertisements/content, in accordance with another embodiment. As an option, the interface 1300 may be implemented in the context of the architecture and environment of the previous Figures and/or any subsequent Figure(s). For example, any of the ad/content techniques disclosed in the context of FIG. 11 may be applied in the present interface 1300. Of course, however, the interface 1300 may be implemented in the context of any desired environment. It should also be noted that the aforementioned definitions may apply during the present description.

As shown, the interface 1300 may be capable of displaying additional content/advertisements when an incorrect passcode has been entered. In one embodiment, the additional content/advertisement may include information related to the advertisement/content displayed on the initial screen/display. In another embodiment, the additional content/advertisement may include another advertisement/content, unrelated to the advertisement/content displayed on the initial screen/display. In one embodiment, the additional content/advertisement may be able to be selected by the user such that additional information is displayed. Of course, in various embodiments, any type of information may be displayed as part the additional context/advertisement.

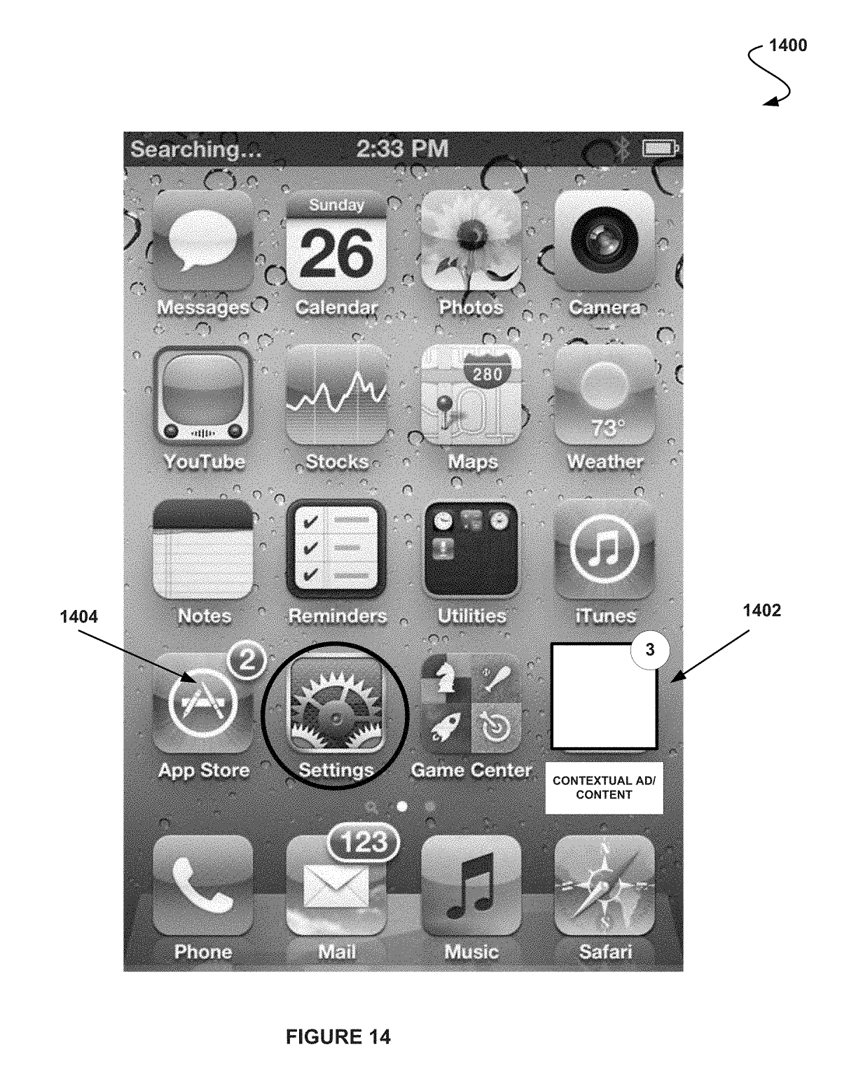

FIG. 14 shows a mobile device interface 1400 for displaying advertisements/content, in accordance with another embodiment. As an option, the interface 1400 may be implemented in the context of the architecture and environment of the previous Figures and/or any subsequent Figure(s). Of course, however, the interface 1400 may be implemented in the context of any desired environment. It should also be noted that the aforementioned definitions may apply during the present description.

As shown, the interface 1400 includes a home screen capable of displaying a plurality of application icons. In one embodiment, at least one of the plurality of application icons may include an application icon associated with displaying available context/advertisements (e.g. application icon 1402). As an option, the application icon associated with displaying available context/advertisements may include an indicator capable of indicating a number of advertisements/content available for viewing. In one embodiment, upon selection of the icon, a list of advertisements/content may be provided. In another embodiment, upon selection of the icon, the advertisements/content may be displayed on the display screen of the mobile device.

Further, in one embodiment, the at least one of the plurality of application icons may include an application icon associated with displaying available feeder applications (e.g. application icon 1404). For example, in one embodiment, when the user enters a location or area associated with a feeder application, the application icon associated with displaying available feeder application may display an indicator (or increment an indicator, etc.) of the application icon associated with displaying available feeder applications. In one embodiment, upon selecting the application icon, a list of advertisements/content and/or available feeder applications may be updated. In another embodiment, upon selecting the application icon, a list of advertisements/content and/or available feeder applications may be displayed which were pre-fetched and/or retrieved. In such an embodiment, the user of the device may control (e.g. in Settings, etc.) the frequency with which the application pre-fetches and/or retrieves the advertisements/content and/or feeder applications. Further, in another embodiment, the indicator (or increment the indicator, etc.) may be automatically updated based on the pre-fetching and/or retrieving.

Additionally, in one embodiment, a “Settings” icon may be utilized to configure contextual advertisement/content alerts, etc. Furthermore, in one embodiment, the “Settings” icon may be utilized to configure feeder application download/execution. In another embodiment, the device may include a graphic in the settings panel (e.g. top bar of device with indications of network connection, volume, etc.) which may be selected. In other embodiments, the graphic may display an ad status (e.g. three unviewed ads, etc.) in the status bar.

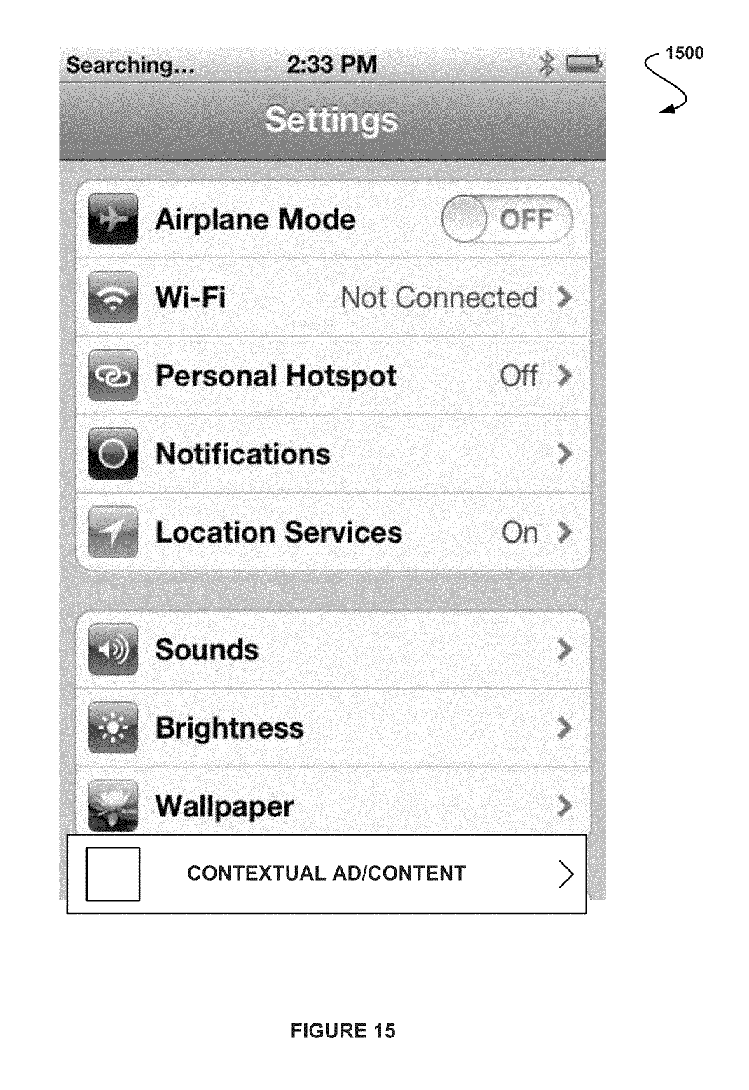

FIG. 15 shows a mobile device interface 1500 for configuring advertisement/content display, in accordance with another embodiment. As an option, the interface 1500 may be implemented in the context of the architecture and environment of the previous Figures and/or any subsequent Figure(s). Of course, however, the interface 1500 may be implemented in the context of any desired environment. It should also be noted that the aforementioned definitions may apply during the present description.

In one embodiment, the interface 1500 may be displayed when a “Settings” icon is selected on a main screen of a mobile device. In one embodiment, the interface 1500 may present a user the option to configure/modify settings associated with contextual advertisements and/or content. In one embodiment, the interface 1500 may present a user the option to configure how/if content is displayed on the mobile device. For example, in various embodiments, by selecting the contextual advertisement/content setting option on the interface 1500, a user may be able to indicate whether advertisements/content are to be displayed, indicate a type of advertisements/content that are to be displayed, indicate whether an advertiser/content provider is allowed to receive personal information for targeted advertisements/content (e.g. utilizing feeder applications, etc.), indicate whether location information associated with the mobile device is to be shared with the advertisement/content provider, configure audio/visual settings associated with advertisement/content display, and/or configure a variety of other settings associated with the advertisement/content.

Further, in one embodiment, the interface 1500 may present a user the option to configure/authorize automatic download/execution of feeder applications. For example, in various embodiments, the settings may include allowing the authorization of the search for feeder applications, authorizing the automatic download of feeder applications, authorizing the automatic execution of feeder applications, authorizing the sharing of information between feeder applications and an advertisement platform, and/or various other settings associated with feeder applications. In another embodiment, the user may configure/authorize the automatic payment for a feeder application. For example, the user may select to automatically buy and download the application based on a set of rules. The rules may include buying and downloading the application if it is determined that the user would save more money (e.g. savings would be greater than the cost of application, etc.), the cost of the application does not exceed a maximum threshold (e.g. no more than $5, etc.), the application is highly rated and/or approved and/or recommended by trusted entities (e.g. friends, family, trusted sites, trusted shops, trusted applications, etc.) and/or any other rule used to determine whether the feeder application should be automatically bought and downloaded. Of course, any rule and/or combination of rules may be used to determine whether to buy and download a feeder application. In another embodiment, the user may manually select to categorize an entity as being trusted (e.g. settings option to select “trusted,” etc.), or the selection may occur automatically based off of interactions with the entity (e.g. more than 50 communications with the entity in the last month, frequent customer with entity, prolonged relationship with entity, etc.).

Still yet, in one embodiment, a notifications option associated with the settings may include an option to configure how advertisements/content are presented. In another embodiment, the notifications option associated with the settings may include an option to configure whether notifications associated with advertisement/content and/or feeder applications are to be presented.

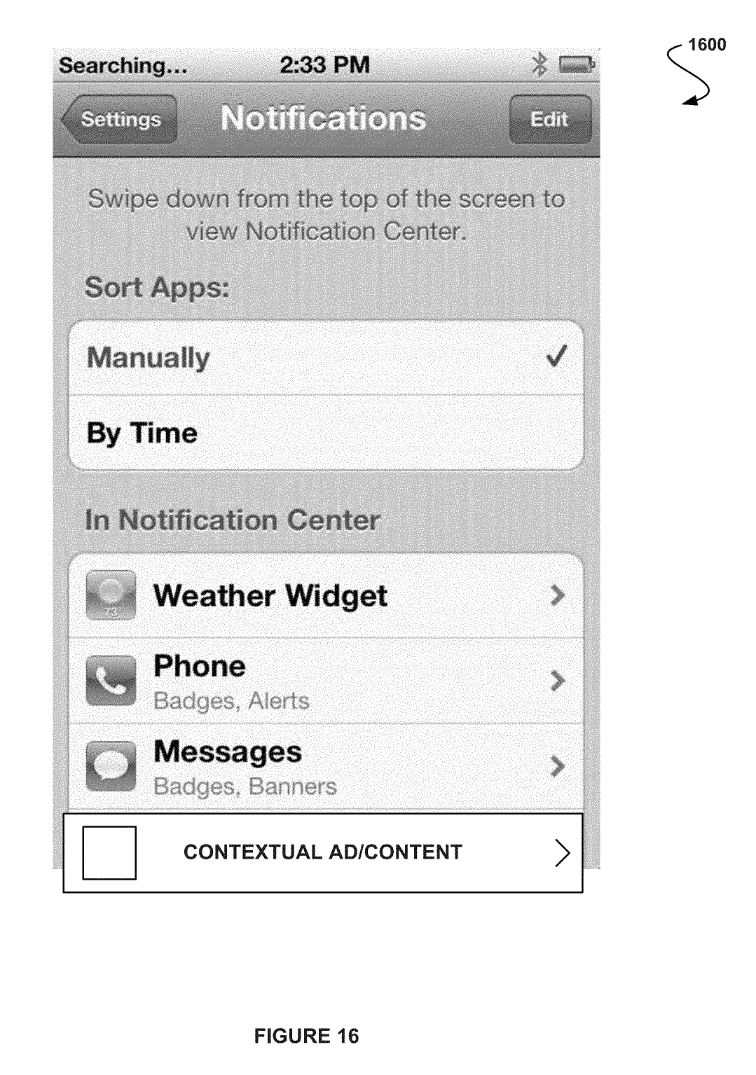

FIG. 16 shows a mobile device interface 1600 for configuring advertisement/content related notifications, in accordance with another embodiment. As an option, the interface 1600 may be implemented in the context of the architecture and environment of the previous Figures and/or any subsequent Figure(s). Of course, however, the interface 1600 may be implemented in the context of any desired environment. It should also be noted that the aforementioned definitions may apply during the present description.

In one embodiment, the interface 1600 may be utilized to select a contextual advertisement/content notification option. In one embodiment, the contextual advertisement/content notification option may be utilized to turn notifications associated with the contextual advertisement/content on and off. In one embodiment, a similar notification option may be available for feeder applications. In this case, in one embodiment, notifications associated with feeder applications (e.g. availability notifications, information sharing notifications, etc.) may be turned on or off. Further, in one embodiment, the settings may function to allow the user to configure a location and/or manner in which the notifications associated with feeder applications, advertisements, and/or content are displayed.

In another embodiment, the user may configure notification settings associated with each of the advertisement/content and/or feeder applications. In one embodiment, the notification may be visual (e.g. text notification on start-up screen, text notification on locked screen, text notification on the application indicator, etc.) and/or may include audio (e.g. play selected ringtone, play audio clip [e.g. “deal available,” etc.], etc.). For example, in one embodiment, a user may have a Walmart application. When the user is within the store, the user's device may display a notification of a coupon and/or deal. Additionally, the device may play an audio clip “Walmart deal available.” Of course, any audio may be played. Further, in one embodiment, the user may create rules for notification. For example, in one embodiment, the user may configure the notifications to be displayed and/or played if the user is within a certain proximity of a store, for a minimum amount of time, and the advertisement/context and/or feeder application involves a coupon and/or deal that includes at least a 50% off discount. Of course, any rules and/or combination of rules may be configured to trigger a notification.

In a separate embodiment, the device may include a graphical user interface to configure triggers associated with advertisement/context and/or feeder application. For example, a sliding bar and/or a rotating dial may indicate a threshold of discount (e.g. 20% off, 50% off, 2 for 1, etc.), a threshold of distance (e.g. within 100 feet of the store and/or location, etc.), a threshold of the number of connected friends present (e.g. with at least one other friend, etc.), a threshold of number of deals (e.g. batch delivery of deals, at least three deals present at the location, etc.), a threshold of time at the location (e.g. five minutes, etc.), a threshold of available time at the location (e.g. thirty minutes before next appointment, twenty minutes before you must leave to arrive at your next location on time, etc.), a threshold of available funds (e.g. at least $500 in checking account, etc.), and/or any other threshold used to trigger advertisement/context and/or feeder applications that must occur before a notification may be displayed and/or played.

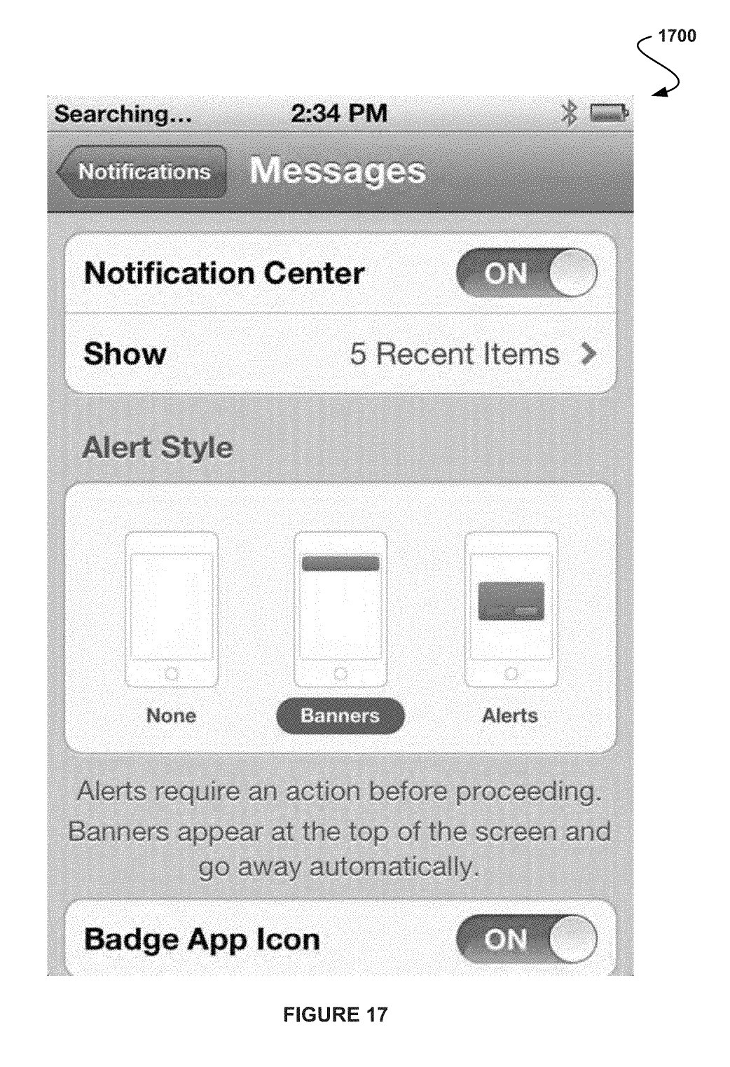

FIG. 17 shows a mobile device interface 1700 for configuring advertisement/content related notifications, in accordance with another embodiment. As an option, the interface 1700 may be implemented in the context of the architecture and environment of the previous Figures and/or any subsequent Figure(s). Of course, however, the interface 1700 may be implemented in the context of any desired environment. It should also be noted that the aforementioned definitions may apply during the present description.

As shown, in one embodiment, the alert style for the advertisements/content may be selected by a user of a mobile device. In various embodiments, the style of the alert, notification, advertisement, and/or content may be selected to be a banner style, an alert style, a scrolling banner style, a flashing alert style, a stationary alert style, and/or various other alert styles. Similarly, in one embodiment, an alert and/or notification style associated with a feeder application notification may be selected. In another embodiment, the alert styles for audible notifications may be configured. For example, the configuration of the audio notifications may include a duration (e.g. play 3 times, play for max of 10 seconds, etc.), an audio level (e.g. loud, soft, etc.), a vibration alert, a ringtone, and/or any various other audible alert settings.

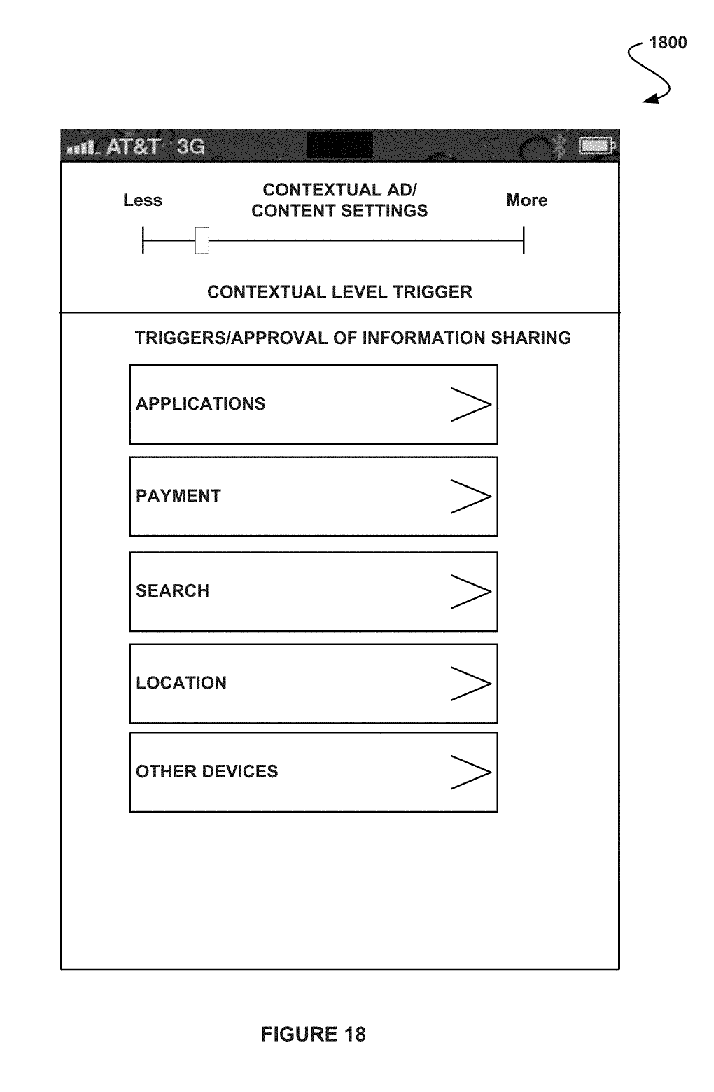

FIG. 18 shows a mobile device interface 1800 for configuring advertisement/content related settings, in accordance with another embodiment. As an option, the interface 1800 may be implemented in the context of the architecture and environment of the previous Figures and/or any subsequent Figure(s). Of course, however, the interface 1800 may be implemented in the context of any desired environment. It should also be noted that the aforementioned definitions may apply during the present description.

In one embodiment, the interface 1800 may be utilized to set a level for an amount of contextual advertisement/content settings to be displayed to a user. In this way, the user may have the ability to control the amount and/or relevancy of advertisements/content displayed to the user. Although, in one embodiment, the amount and/or relevancy of content/advertisements may be controlled utilizing a slide-able scale interface (e.g. as shown in FIG. 18), in various other embodiments, a dial may be utilized, a specific number per day/week may be inputted, and/or various other control techniques may be utilized.

In one embodiment, the selector may relate to a plurality of the previously disclosed criteria (e.g. time, location, etc.). For example, by moving the slider in one particular direction, a distance from a particular location and a time within a predetermined time would have to be less, in order to trigger content/ad. Conversely, by moving the slider in another particular direction, the distance from the particular location and the time within the predetermined time could be more.

Of course, in other embodiments, multiple selectors may be displayed (e.g. one for each of a plurality of the criteria disclosed prior, etc.). For example, by moving the slider in one particular direction, a distance from a particular location would have to be less, in order to trigger content/ad. Conversely, by moving the slider in another particular direction, the distance from the particular location could be more.

Further, in one embodiment, the interface 1800 may be utilized to set one or more preferences associated with sharing. For example, in one embodiment, the interface 1800 may be utilized to set sharing preferences associated with applications (e.g. feeder applications, etc.). In various embodiments, the sharing preferences may include allowing information to be shared between various feeder applications, allowing information to be shared with feeder applications, allowing information to be shared between one or more master applications and one or more feeder applications, allowing information to be shared between an operating system and one or more feeder applications, allowing information to be shared between an operating system and one or more master applications, allowing information to be shared between an advertisement application/platform and one or more feeder applications, allowing information to be shared between an advertisement application/platform and one or more master applications, allowing information to be shared between an advertisement application/platform and one or more operating systems, and/or allowing information to be shared between various other applications.

Further, in one embodiment, the interface 1800 may be utilized to set sharing preferences associated with payment applications and/or activity. For example, in one embodiment, the interface 1800 may be utilized to set sharing preferences associated with a mobile wallet. In another embodiment, the interface 1800 may be utilized to set sharing preferences associated with purchase activity (e.g. online shopping, in-store shopping, etc.).

In yet another embodiment, the interface 1800 may be utilized to set sharing preferences associated with one or more search engines. For example, in various embodiments, the interface 1800 may be utilized to set sharing preferences associated with key word searches, viewed websites, viewed/searched products/services, viewed/searched locations, and/or any other search related information.

In another embodiment, the interface 1800 may be utilized to set sharing preferences associated with location information. For example, in various embodiments, the interface 1800 may be utilized to authorize or de-authorize the sharing of location information with applications, advertisement platforms, social networking systems/applications, and/or various other systems.

Further, in one embodiment, the interface 1800 may be utilized to set sharing preferences associated with other devices. In various embodiments, the other devices may include other devices associated with the user of the mobile device and/or devices controlled by a third party (e.g. another user, a business, etc.). For example, in various embodiments, the other devices may include mobile phones, tablet computers, desktop computers, set-top boxes, televisions, appliances, networked servers, billboards, in-store displays, and/or any other type of device.

In one embodiment, the interface 1800 may include graphical interactions and/or settings. For example, a user may choose to enable a map interface relating to the contextual ad/content so that when a deal is available, a map is displayed showing the contextual ad/content as well as contextual ad/content within a predetermined geographic boundary. In other embodiments, the user may dynamically select the geographic boundaries used by the map (e.g. the user may zoom in and/or out and the map will automatically adjust and repopulate the map with the appropriate contextual ad/content, etc.). The user may interact with the map by selecting a contextual ad/content as displayed on the map. In other embodiments, filters may be applied to the map to refine the displayed contextual ad/content. For example, in various embodiments, price, level of discount, recommendations, time to location, distance to location, rating, and/or any other criteria may be select to filter the displayed contextual ad/content.

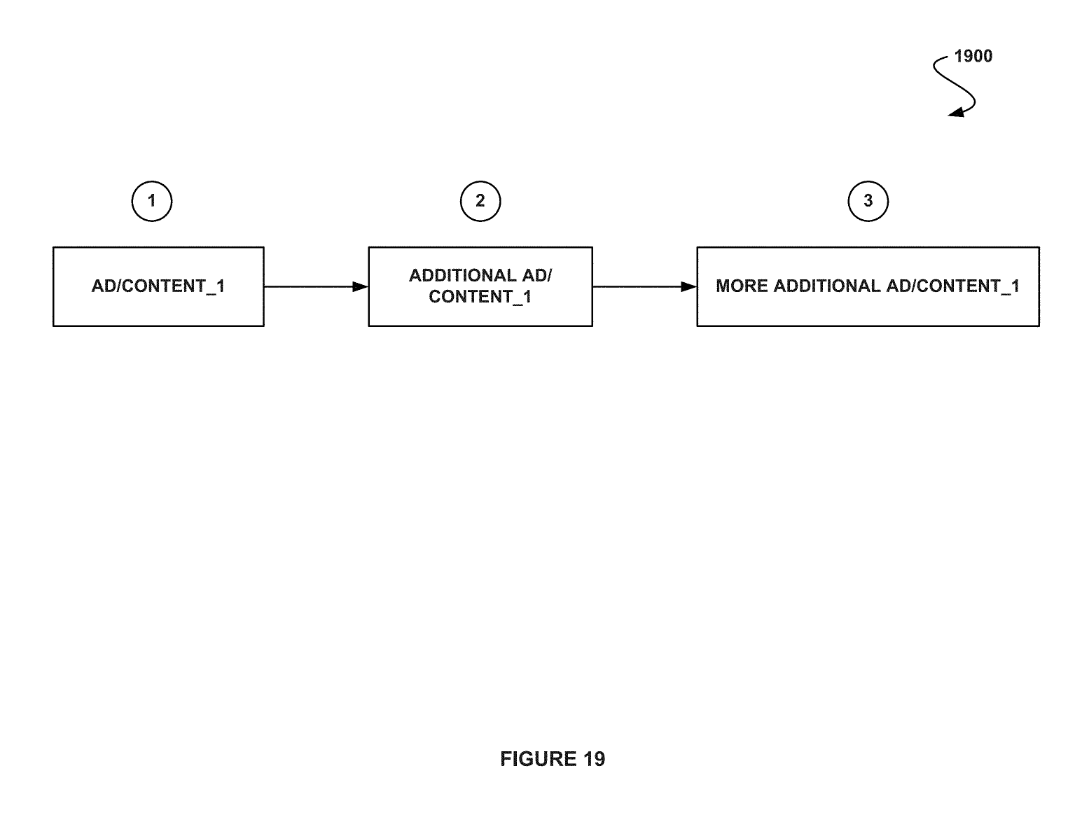

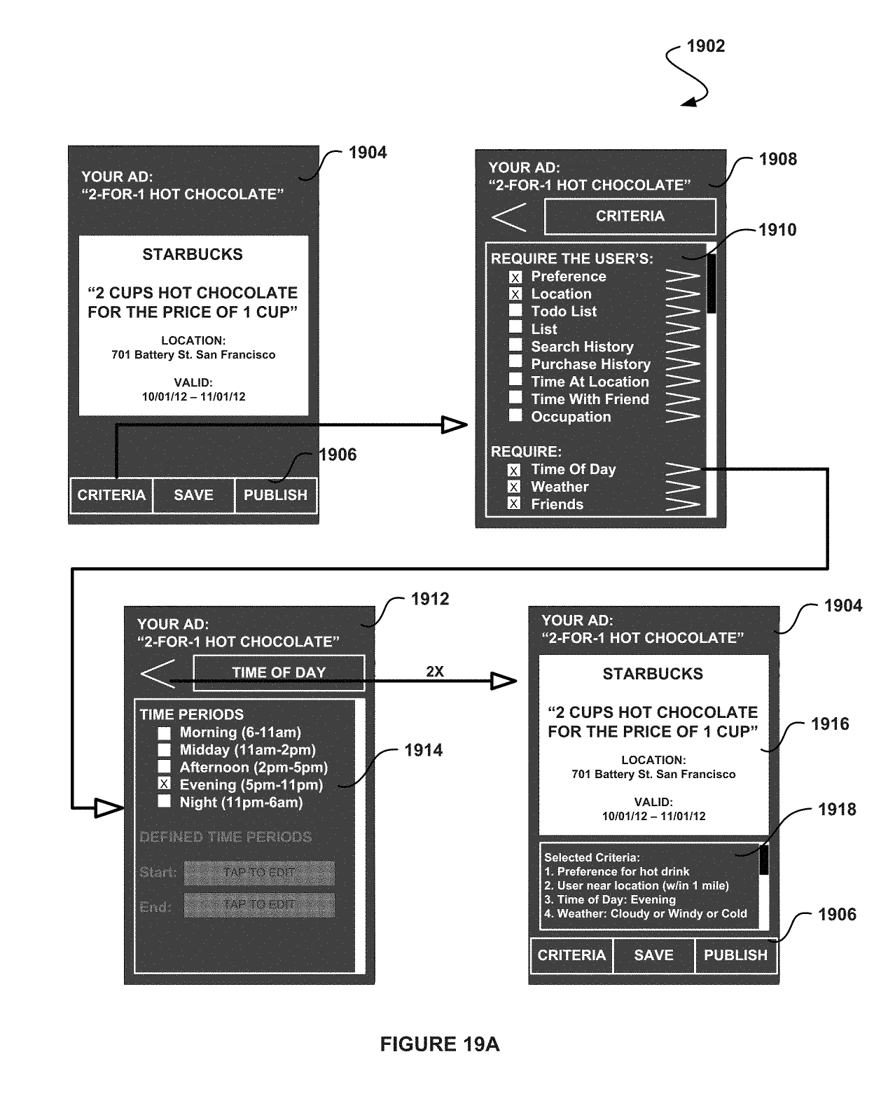

FIG. 19 shows an advertisement interface flow 1900, in accordance with another embodiment. As an option, the flow 1900 may be implemented in the context of the architecture and environment of the previous Figures and/or any subsequent Figure(s). Of course, however, the flow 1900 may be implemented in the context of any desired environment. It should also be noted that the aforementioned definitions may apply during the present description.

As shown, the advertiser interface may display a first contextual advertisement/content initially. Upon interest by a viewer (or escalation based on defined criteria, etc.), additional related advertisements/content may be displayed. Upon further interest by the viewer (or escalation based on defined criteria, etc.), more additional related advertisements/content may be displayed.

In one embodiment, escalation from the contextual advertisement/content of step 1 to the additional related contextual advertisement/content of step 2 (or from step 2 to step 3, etc.), may occur upon an explicit expression of interest from the viewer. In one embodiment, the explicit expression of interest may include a selection of the advertisement/content (e.g. by clicking the advertisement, etc.). In another embodiment, the explicit expression of interest may include an audible utterance indicating interest (e.g. “that advertisement looks interesting,” “show me more,” etc.). In another embodiment, the explicit expression of interest may include the viewer selecting a “Like” icon associated with the advertisement/content. In another embodiment, the explicit expression of interest may include the viewer selecting an option to display an additional related advertisement/content. In another embodiment, the selection of “like” may automatically be selected depending on the amount of time the user views the advertisement/content.

In one embodiment, display of additional related content may require user authentication. In various embodiments, the user authentication may include the user entering a password/passcode, speaking a password/passcode, providing biometric information, and/or providing various other information.

In another embodiment, escalation from the contextual advertisement/content of step 1 to the additional related contextual advertisement/content of step 2 (or from step 2 to step 3, etc.), may occur upon an implied expression of interest from the viewer. In various embodiments, the implied expression of interest may include viewer eye contact with the advertisement/content for a predetermined amount of time (e.g. a detected by a camera associated with the device, etc.), the user scrolling through an advertisement/content (e.g. or illuminating the advertisement/content, etc.) one or more times, the user leaving the content/advertisement on the display without removing or closing the advertisement for a predetermined amount of time, the user sharing the advertisement/content with another user (e.g. utilizing a share option, a text message, an email, etc.), the user capturing a screen shot displaying the advertisement, the user performing a search (e.g. on a browser, etc.) for information associated with the content/advertisement, and/or any other implied expression of interest from the viewer.

In one embodiment, the escalation from the additional contextual advertisement/content of step 2 to the more additional advertisement content of step 3 may be based on the same criteria as the escalation from step 1 to step 2. In another embodiment, the escalation from the additional contextual advertisement/content of step 2 to the more additional advertisement content of step 3 may be based on different criteria than the escalation from step 1 to step 2 (e.g. a password may be required for escalation, survey questions may need to be answered, etc.).

In various embodiments, the escalation sequence from step 1 to step 2, or from step 2 to step 3, or from any step to a following step, may include any contextual advertisement/content or combination of contextual advertisements/content. In further embodiments, the contextual advertisement/content may depend on further criteria. For example, such criteria may include the location of the user, the purchase history of the user (e.g. user purchased a bike, etc.), the time of day (e.g. morning, night, etc.), the weather at the user's location (e.g. sunny, cold, etc.), the amount of time the user spends on the device, the amount of time the user has been with a friend or with a group of friends, the search history of the user on the device (or on another device associated with the user, etc.), the user's preferences (e.g. dining preferences, shopping preferences, travel preferences, etc.), a list associated with the user (e.g. needed feed items, needed household items, etc.), a todo list associated with the user (e.g. need to go to the store, need to pick up dog food, need a new outfit, etc.), a professional occupation of the user, a social posting (e.g. the user posts “I need a bike—any recommendations,” etc.) and/or any other criteria which may be used to give further context for the contextual advertisement/content.

In various embodiments, the advertiser interface may permit a developer to escalate a contextual advertisement/content from one step to a following step based on any of or a combination of the criteria. For example, in one embodiment, the developer may select a contextual advertisement/content of a 2-for-1 hot chocolate deal/coupon to be displayed on the user's device if it is determined that the user has a preference for hot drinks, the user is near a location that sells hot drinks, it is raining outside, it is after 6 pm, and the user is with a friend. In a separate embodiment, the developer may select a contextual advertisement/content of a bike pump when it is determined that the user recently bought a bike, and/or the user has need of a bike pump (e.g. the user indicates it on a todo list, a list associated with the user, a social posting etc.). Of course, the criteria may be selected and/or used in any manner, and in any combination, to form the basis for displaying the contextual advertisement/content on the user's device.

FIG. 19A shows an advertisement interface 1902, in accordance with another embodiment. As an option, the interface 1902 may be implemented in the context of the architecture and environment of the previous Figures and/or any subsequent Figure(s). Of course, however, the interface 1902 may be implemented in the context of any desired environment. It should also be noted that the aforementioned definitions may apply during the present description.

As shown, in one embodiment, the advertisement interface 1902 may be composed of one or more setup screens 1904, 1908, 1912, 1916. In one embodiment, the first setup screen 1904 may display the potential ad as well as ad options 1906. In various embodiments, the ad options may include “criteria,” “save,” “publish,” “menu,” “settings,” and/or any option relating to the ad. In one embodiment, the developer may select the format of the ad (e.g. color, placement, size, font, etc.). In other embodiments, the developer may select preconfigured settings relating to an ad. In one embodiment, the preconfigured settings may relate to a predefined user account, or settings associated with a trusted party (e.g. friend, business, database system, etc.). In various embodiments, the format of the ad may be a full display size, may be limited to a maximum of text characters, and/or may be sized in any manner. In other embodiments, the ad may be interactive. For example, the ad may include links, maps, clickable phone numbers, ability to share, blinking text, real-time updates, and/or any other feature which may cause the ad to be more engaging and interactive.

As shown, if the developer selects “criteria” on the first setup screen 1904, a second setup screen 1908 relating to criteria may be displayed. The second setup screen 1904 may include a list of criteria 1910 associated with the created advertisement. For example, the criteria may include criteria relating to information of the device user, including “preference,” “location,” “todo list,” “list,” “search history,” “purchase history,” “time at location,” “time with friend,” “occupation,” and/or any other criteria which may relate directly to the user. The criteria may also include general information including “time of day,” “weather,” “friends,” and/or any other general information. In some embodiments, the developer may select to apply the criteria and then may select the criteria to define the parameters to be applied.

As shown, if the developer selects a criteria (e.g. “Time of Day,” etc.), a third setup screen 1912 relating to the selected criteria may be displayed. The selected criteria screen may include details specific to the selected criteria. For example, if the “Time of Day” criteria had been selected, information relating to time periods and defined time periods may be displayed. In one embodiment, the time periods may include periods within the day (e.g. morning, midday, afternoon, evening, night, etc.). In some embodiments, more than one time period may be selected. In other embodiments, once a use selects at least one time period, the custom defined time periods may be grayed out so that custom time periods may not be entered. In other embodiments, if a defined time period was selected, the developer may select multiple time periods to customize (e.g. 5-9 am, 12-5 pm, etc.). Of course, in other embodiments, the developer may select both a predefined time period as well as customize a defined time period.

As shown, if the developer selects the back button twice, the developer is brought again to the first setup screen 1904. In one embodiment, if the developer has selected criteria to be applied to the advertisement 1916, the selected criteria 1918 will be displayed below the advertisement. Of course, in other embodiments, the selected criteria may be displayed in any manner. Once the developer approves of the advertisement and the selected criteria, the developer may select to save the ad 1916 and selected criteria 1918 from the ad options 1906. In one embodiment, such saved settings may be retrieved at a later date. In another embodiment, once the developer saves the ad, the ad may be sent to another person or entity for approval (e.g. higher up chain in command for approval of the ad, etc.). In such an embodiment, the developer may not have the option to “publish” the ad but to only “save” the ad. Once the ad has been approved by the appropriate developer, the developer with appropriate permissions (e.g. ability to approve and publish, etc.) may select to “publish” the ad from the ad options 1906.

In some embodiments, once an ad is published, the developer may be presented with additional ad options. For example, in one embodiment, the developer may be presented with an ad duration, an ability to pay a premium (e.g. higher price, etc.) to increase exposure, and/or any other option relating to publishing an ad.

In other embodiments, although the developer may use the advertisement interface to create the ad, the developer is not limited solely to using the advertisement interface to create an ad. For example, in one embodiment, the developer may wish to use proprietary and/or purchased software to create the ad. Of course, the ad may be created in any manner. Additionally, in other embodiments, the ad may be published either directly to the contextual advertisement/content management 402 (ad platform), and/or may be published directly to a feeder application (e.g. application associated with the ad source [e.g. Walmart, Starbucks, etc.], etc.). In one embodiment, in order to publish directly to the contextual advertisement/content management 402 (ad platform), the ad may be submitted first to be approved by the contextual advertisement/content management 402 (ad platform). In some embodiments, the contextual advertisement/content management 402 (ad platform) may impose requirements and/or conditions that must be upheld in order to be approved (e.g. consistent formatting, minimum number of criteria selected for contextual relevancy, etc.).

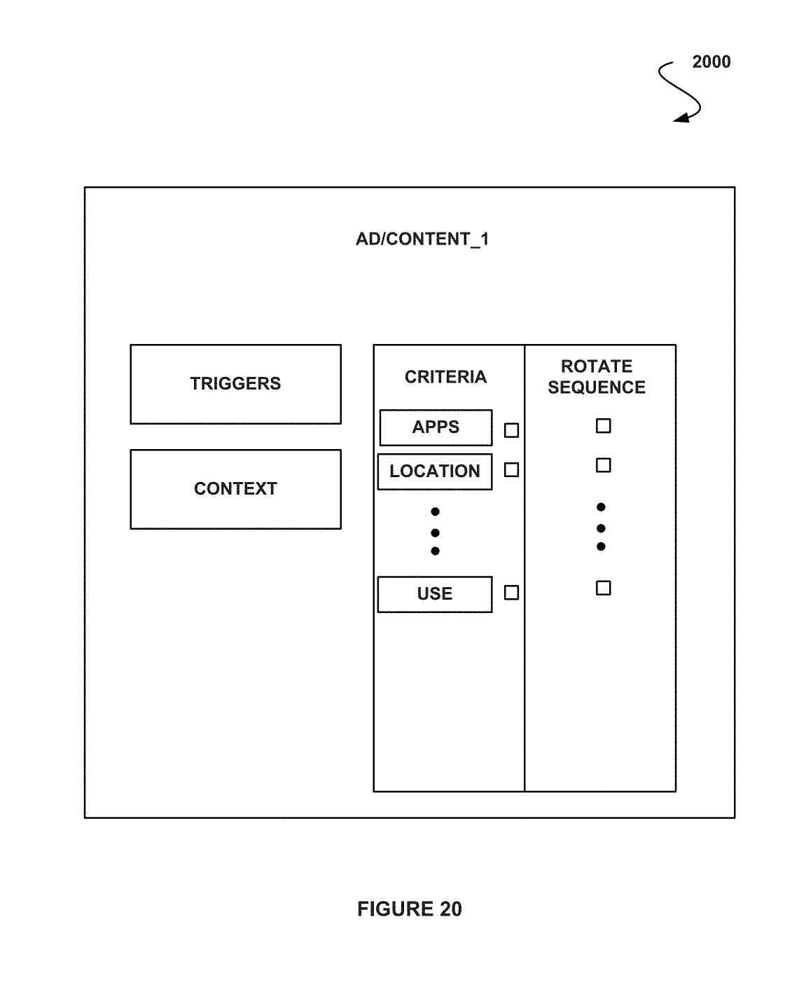

FIG. 20 shows an advertisement interface 2000, in accordance with another embodiment. As an option, the interface 2000 may be implemented in the context of the architecture and environment of the previous Figures and/or any subsequent Figure(s). Of course, however, the interface 2000 may be implemented in the context of any desired environment. It should also be noted that the aforementioned definitions may apply during the present description.

As shown, in one embodiment, the advertisement interface 2000 may be utilized to set triggers for targeted advertisements/content. Further, in one embodiment, the interface 2000 may be utilized to select different criteria for displaying/selecting an advertisement/content. Additionally, in one embodiment, the interface 2000 may be utilized to change/identify a context associated with an advertisement/content.

In one embodiment, the interface 2000 may be utilized by advertisers to set triggers for advertisements/content. In various embodiments, the advertisements/content may be triggered. In one embodiment, the advertisements may be triggered as a sequence. In various embodiments, the advertisement/content may be triggered based on current and/or historic activity. Further, in various embodiments, the triggers may be configured utilizing Boolean operators and or Macros. For example, in one embodiment, a macro may be user to display content on a mobile device instead of utilizing the advertiser interface.

The advertisements/content may be configured to trigger based on a variety of criteria. For example, in one embodiment, the advertisement/content may be configured to trigger on a location associated with the user and/or the mobile device. In various embodiments, the location may include a current or past location. In various embodiments, the location of the mobile device/user may be determined by GPS, a network being utilized, a post by a user (e.g. on a social network website, etc.), a check-in by a user (e.g. utilizing a mobile device, etc.). In other embodiments, the advertisement/content may be configured to trigger based on a movement of a user (e.g. getting out of a car, sitting down for a set time, etc.), an action or event by an application (e.g. take photo, receive social networking update, receive email, add metatag to a document, etc.), an update of a natural condition (e.g. a weather update, etc.), an update relating to a RSS feed (e.g. when a history novel is listed on the New York Times best sellers list, send a text, etc.), an action relating to a check-in (e.g. check-in at the airport, a restaurant, a friend's location, or any other location, etc.), and/or any other action and/or event associated with the user and/or the mobile device.

More information regarding determining a user location, etc. may be found in U.S. Provisional Patent Application No. 61/590,767, filed Jan. 25, 2012, titled “SYSTEM, METHOD AND COMPUTER PROGRAM PRODUCT FOR LOCATION-SPECIFIC PRIVACY SETTINGS;” U.S. Provisional Patent Application No. 61/591,819, filed Jan. 27, 2012, titled “SYSTEM, METHOD, AND COMPUTER PROGRAM PRODUCT FOR ALTERING AT LEAST ONE ASPECT OF AN INTEGRATED E-COMMERCE ON-LINE APPLICATION;” and U.S. Provisional Patent Application No. 61/596,174, filed Feb. 7, 2012, titled “SYSTEM, METHOD, AND COMPUTER PROGRAM PRODUCT FOR ALTERING AT LEAST ONE ASPECT OF AN INTEGRATED E-COMMERCE ON-LINE APPLICATION.”

The location associated with advertisements and/or feeder applications may be determined utilizing a variety of techniques. For example, in various embodiments, the location may include a location determined by an advertiser, business, and/or application provider. In one embodiment, the location may be defined by a perimeter. In one embodiment, the perimeter may be defined utilizing a GUI for drawing a perimeter.

In another embodiment, the location may include a circular area that is a defined radius from a point (e.g. a business, a landmark, etc.). Further, in one embodiment, the radius may be defined by the capacity of a signal strength associated with the network. In another embodiment, the location may include a building. In another embodiment, the location may include a building and a perimeter that is a predefined distance from the building.

More information regarding location definition and determination may be found in U.S. Provisional Patent Application No. 61/511,750, filed Jul. 26, 2011, titled “SYSTEM, METHOD, AND COMPUTER PROGRAM PRODUCT FOR MANAGING A SOCIAL NETWORK BASED ON AT LEAST A TIME OR A LOCATION,” and U.S. patent application Ser. No. 13/557,198, filed Jul. 24, 2012, titled “SYSTEM, METHOD, AND COMPUTER PROGRAM PRODUCT FOR MANAGING A SOCIAL NETWORK BASED ON AT LEAST A TIME OR A LOCATION,” which are incorporated by reference in their entirety.

In one embodiment, the location may be based on a future location associated with the user and/or the mobile device. For example, in one embodiment, the future location may be determined based on user provided information to a social networking site. In another embodiment, the future location may be determined based on a future reservation. For example, a user may have made a reservation utilizing a mobile device and the mobile device (or an application associated therewith, etc.) may log the reservation information to utilize to determine a future location. In another embodiment, a calendar application may be utilized to automatically determine a future location of the user/mobile device. Further, in one embodiment, a message (e.g. email, text, sms, etc.) may be used to determine a future location of the user/mobile device.

In another embodiment, a navigation system and/or mapping application may be utilized to determine the future location of the user/mobile device. For example, in one embodiment, a movement vector associated with the mobile device may be determined. In one embodiment, the movement vector may be determined by utilizing a velocity and a direction associated with the mobile device (e.g. utilizing GPS, etc.). In another embodiment, the movement vector may be determined by utilizing a velocity and a direction associated with a vehicle. In one embodiment, the mobile device and the vehicle may share location/direction related information.

In one embodiment, future location may be determined utilizing a movement vector in combination with one or more road maps, recent route requests, a mapping application, and/or, navigation information from a vehicle, etc. In one embodiment, a determined potential future location may be utilized to present a user with advertisements, content, and/or applications. For example, in one embodiment, it may be determined a potential future location is a theme park. In this case, a user may be presented with discounts/advertisements associated with the theme park. Similarly, in one embodiment, it may be determined that a potential future location is a restaurant. In this case, in one embodiment, an application associated with the restaurant may be presented to the user on the mobile device for download (e.g. a menu application, etc.). In another embodiment, if traffic conditions exist on route to the future destination, the advertisements, content, and/or applications may be modified so that relevant content is presented to the user to more effectively use time spent in the car (e.g. a coupon may be presented to the user to take advantage of the traffic and to get a free drink at a nearby restaurant to more thoroughly enjoy traveling to the future destination, etc.).

In another embodiment, advertisements may be displayed on the mobile device based on a route of the user. For example, if it is determined that a user may be travelling past one or more businesses (e.g. gas stations, retail stores, etc.), advertisements associated with those businesses may be displayed on the mobile device while the user is in route.

In another embodiment, it may be determined whether a mobile device has been at a location previously. For example, in one embodiment, the mobile device and/or a system associated with the location may log if/when the mobile device has been within a zone defined as the location. Further, in one embodiment, activities of the user performed at the location (e.g. purchase activities, application user activity, etc.) may be logged. In one embodiment, the information logged may be utilized to choose content/advertisements to present to the user utilizing the mobile device and/or displays associated with the location.

In one embodiment, if it is determined that the user has never been to the location (e.g. based on the logged data, etc.), advertisements, content, and/or applications may be selected accordingly. For example, in one embodiment, if it is determined that the user has never been to a particular location, it may be determined that the user is a first time visitor (e.g. or tourist, etc.) and information for first time visitors may be provided to the user via the mobile device (e.g. tourist information, maps of a facility, menu options, etc.).

In another embodiment, communications may be utilized as criteria for triggering advertisements. In various embodiments, the communications may include text messages, emails, VOIP calls, spoken dialogue, social network site posts, and/or any other type of communication capable of being captured by a mobile device. In one embodiment, keywords in the communication may be extracted and may be used to select advertisements/content. For example, if the word “doctor” is presented in a communication, advertisements for local physicians may be presented to the user on the mobile device (e.g. utilizing a current location of the user, etc.). Similarly, if the words “new car” are presented in a communication, advertisements for local car dealers may be presented to the user on the mobile device (e.g. utilizing a current location of the user, etc.). In various embodiments, the advertisements/content may be presented based on current and/or past communications.

In another embodiment, the criteria for selecting and/or triggering advertisements, content, and or application suggestions may be based on one or more captured images. For example, in one embodiment, a user may capture one or more images on the mobile device and one or more image/object recognition techniques may be utilized to identify one or more objects/items/people/locations. In one embodiment, based on the identified objects/items/people/locations, advertisement, content, and/or applications may be presented to the user utilizing the mobile device. In various embodiments, the captured image(s) may include one or more stored images, one or more currently captured images, and/or video, etc.

More information associated with image/object recognition techniques may be found in U.S. Provisional Patent Application No. 61/612,960, filed Mar. 19, 2012, titled “SYSTEM, METHOD, AND COMPUTER PROGRAM PRODUCT FOR ALTERING AT LEAST ONE ASPECT OF AN EXPERIENCE OF A VIEWER IN ASSOCIATION WITH A TELEVISION,” which is incorporated herein by reference in its entirety.

Furthermore, in one embodiment, purchases and/or payments made by the user may be utilized as criteria for selecting and/or triggering advertisements. In one embodiment, the purchases and/or payments may include current purchases and/or payments. In another embodiment, the purchases and/or payments may include past purchases and/or payments.

In various embodiments, the purchases and/or payments may be facilitated and/or detected utilizing one or more applications associated with a retailer, a social network, a mobile wallet, a bank, a payment service, a product provider, a service provider, and/or any other type of application capable of facilitating and/or detecting one or more purchases. Further, in one embodiment, the payment/purchase information may be utilized to determine whether the payment/purchase is a reoccurring payment/purchase. In one embodiment, if it is determined that the payment is a reoccurring payment/purchase, then reminders, advertisements, content, discounts, etc., associated with the reoccurring payment/purchase may be selected and/or displayed.

In another embodiment, application use may be used to select and/or trigger advertisements/content. For example, one or more advertisements/content may be triggered and/or selected based on the type of applications being utilized by a user on a mobile device. In one embodiment, the application use may include current application use. In another embodiment, the application use may include past application use. The applications may include any type of application. For example, in various embodiments, the applications may include games, shopping applications, media applications, travel applications, mobile wallet applications, web browsing applications, and/or any other type of application. In one embodiment, a duration of application use may be used to select and/or trigger advertisements/content or other application suggestions.

In another embodiment, big data may be used to select and/or trigger advertisements/content. For example, in one embodiment, data from other mobile devices may be utilized to select and/or trigger advertisements/content on a mobile device associated with the user. In one embodiment, the data may include data from mobile devices within a radius from the mobile device of the user. Additionally, in one embodiment, the data may include data from devices in the same location as the mobile device of the user (e.g. in the same building, at the same stadium, at the same airport, etc.). In various embodiments, the big data may include location data, movement data, weather data, application usage data, purchase data, personal data, and/or any other type of data. In one embodiment, an application on the mobile device of the user may facilitate the polling of data associated with the other mobile devices. Further, in one embodiment, the other devices may send information to a networked server, such that the mobile device associated with the user may access the data (or a summary, etc.). In yet another embodiment, the other devices may send data to the mobile device.

Further, in one embodiment, social data may be used to select and/or trigger advertisements/content (e.g. people/friends with the user, a number of people at a location, etc.). For example, in one embodiment, it may be determined whether a first user is with any other users. In one embodiment, it may be determined that the first user is close to other users based on GPS locations associated with the users. In another embodiment, it may be determined that the first user is close to other users based on social network information associated with the users (e.g. check-in status, posts, etc.). In another embodiment, it may be determined that the first user is close to other users based on a signal associated with the devices of the users (e.g. cell signals, Bluetooth signals, Wi-Fi signals, etc.). In various embodiments, any type of information associated with the users may be utilized, such as gender, age, race, interests, relationship status, and/or any other type of information. In one embodiment, it may be determined that the users are friends utilizing social network information. In one embodiment, utilizing the information obtained from all or some of the users, advertisement/content may be presented to the first user and/or the other users. For example, in one embodiment, if it is determined that the users are friends, one or more of the users may be presented with one or more advertisements for businesses in the area. In one embodiment, discounts may be presented to one or more of the users, based on the number of people in the group. For example, in one embodiment, at least one member of a group of four friends may be presented with an advertisement for a discount if all four people go to a particular establishment. Of course, any number of people may be presented with an advertisement relating to a group of individuals, and the advertisement/content may relate to an establishment, an online forum, a social networking site, and/or any physical and/or digital entity.

More information regarding group incentivized discounts may be found in U.S. Provisional Patent Application No. 61/590,767, filed Jan. 25, 2012, and titled “SYSTEM, METHOD AND COMPUTER PROGRAM PRODUCT FOR LOCATION-SPECIFIC PRIVACY SETTINGS.” In one embodiment, the aforementioned friends may include “temporary” friends that may be “friended” (i.e. an association made, etc.) for a temporary pre-configured and/or user configured time period.

In another embodiment, user interest (e.g. explicit user interest, implicit user interest, etc.) may be used to select and/or trigger advertisements/content. For example, in one embodiment, a user may say (e.g. to the mobile device, to in a manner received by the user device, etc.), “I am interested in cars.” Accordingly, in one embodiment, advertisements/content associated with cars may be presented to the user on the mobile device. In another embodiment, the user may take photos of cars using the mobile device. Accordingly, in one embodiment, an interest in cars may be inferred and advertisements/content associated with cars may be presented to the user on the mobile device. Similarly, in one embodiment, the user may purchase tickets to a car show. In this case, an interest in cars may be inferred and advertisements/content associated with cars may be presented to the user on the mobile device.

More information regarding determining interests/habits of a user may be found in U.S. Provisional Patent Application No. 61/481,722, filed May 2, 2011, titled “SYSTEM, METHOD, AND COMPUTER PROGRAM PRODUCT FOR ALLOCATING TIME TO ACHIEVE OBJECTIVES;” and U.S. patent application Ser. No. 13/462,804, filed May 2, 2012, titled “SYSTEM, METHOD, AND COMPUTER PROGRAM PRODUCT FOR ALLOCATING TIME TO ACHIEVE OBJECTIVES,” which are incorporated herein by reference in their entirety.

In another embodiment, automatically recognizable macros may be used to select and/or trigger advertisements/content. For example, in one embodiment, it may be determined that a user performs a series of actions regularly utilizing a mobile device (e.g. more than 2 times, more than 3 times, periodically, etc.). In various embodiments, one or more advertisements, content, and/or applications may be selected and/or presented, based on the determination.

As one example, a user may have repeated search for a local pizza place on a mobile device, then look up coupons/specials associated with the pizza place, select the coupons, call the pizza place, and submit an order. In one embodiment, an advertisement platform (or an OS, application, etc.) associated with the mobile device may recognize the pattern and automatically select/display advertisements/coupons for the local pizza place. In one embodiment, the advertisement may allow the user to select the advertisement/coupon, such that an order is automatically facilitated (e.g. a web order, an email order, a phone order, etc.). In another embodiment, an advertisement platform (or an OS, application, etc.) associated with the mobile device may recognize the pattern and automatically select/display an application associated with the local pizza place.

In one embodiment, restrictions may be set such that only certain companies may serve advertisements in a location. In another embodiment, there may be restrictions such that certain companies/advertisers (e.g. COKE, etc.) are the only companies/advertisers that may trigger advertisements/content in connection with an application. For example, in one embodiment, COMPANY_1 may be configured to be an exclusive advertiser corresponding to an application associated with COMPANY_1. In another embodiment, COMPANY_1 may be configured to be an exclusive advertiser (or one advertiser of a selected few, etc.) corresponding to an application associated with COMPANY_2. In one embodiment, COMPANY_1 may sell advertising space to COMPANY_2, the advertising space being associated with an application corresponding to COMPANY_1.

In one embodiment, advertisers/companies may have the ability to receive suggestions utilizing the interface 2000. For example, in one embodiment, when advertisers/companies drill down in each criteria, the advertisers may be presented suggestions based on analysis of an advertisement.

In one embodiment, advertisers/companies may perform keyword searches, etc., to receive suggested criteria. Further, in one embodiment, the advertiser may have the ability to perform test runs to see how many people would have received the advertisement based on back-testing. Additionally, in one embodiment, the advertisements may be actually shown the situations/scenarios that would have been triggered.

Still yet, in one embodiment, instead of displaying advertisements/content on the mobile device, the advertisements/content may be displayed on another device (e.g. a vehicular display, a third party display, etc.). For example, in one embodiment, it may be determined that the mobile device is communicatively tethered (e.g. wirelessly, wired, etc.). In this case, in one embodiment, instead of displaying advertisements/content on the mobile device, the advertisement/content may be presented on one or more vehicular displays (e.g. a passenger display, a navigation system display, a heads-up display, etc.). Further, in one embodiment, the advertisements/content may be presented over an audio system of the vehicle (i.e. audibly, etc.).

As another example, the advertisements/content may be presented on a machine associated with the advertiser. For example, if advertiser is a gas station/oil company, and it is determined that the user is at the gas pump payment system (e.g. based on location, a wireless signal, an initiated payment [e.g. by a mobile wallet, a credit card, etc.], facial recognition, etc.), information may be presented on a machine associated with the gas pump.

In one embodiment, information associated with the mobile device, as well as information from third party platforms may be utilized to select/trigger advertisements/content. For example, in one embodiment, discounts at a store may be offered to a user in real time, based on user information (e.g. gender, age, etc.), as well as current store discount information.

In another embodiment, instead of displaying the advertisements/content on the mobile device of the user, the advertisement/content may be displayed on a television near the user. For example, in one embodiment, the advertisement/content may be displayed as a ticker or banner on a television, etc. In various embodiments, the mobile device may be in communication with the television via a wireless connection (e.g. Wi-Fi, Bluetooth, etc.), and/or a wired connection. In one embodiment, the mobile device may be in communication with a set-top box associated with the television.

Of course, in one embodiment, the advertisement/content may be presented on the mobile device display in a non-intrusive manner. For example, in various embodiments, the advertisements/content may be presented on the mobile device display while information/data is downloading/loading, at a main menu, on main menu if there is space not taken by icons, dead space defined by an application, at an unlock screen, during application usage, while the user is looking at the screen but not writing or reading (e.g. as determined by a camera and the eyes of the user, etc.), etc.

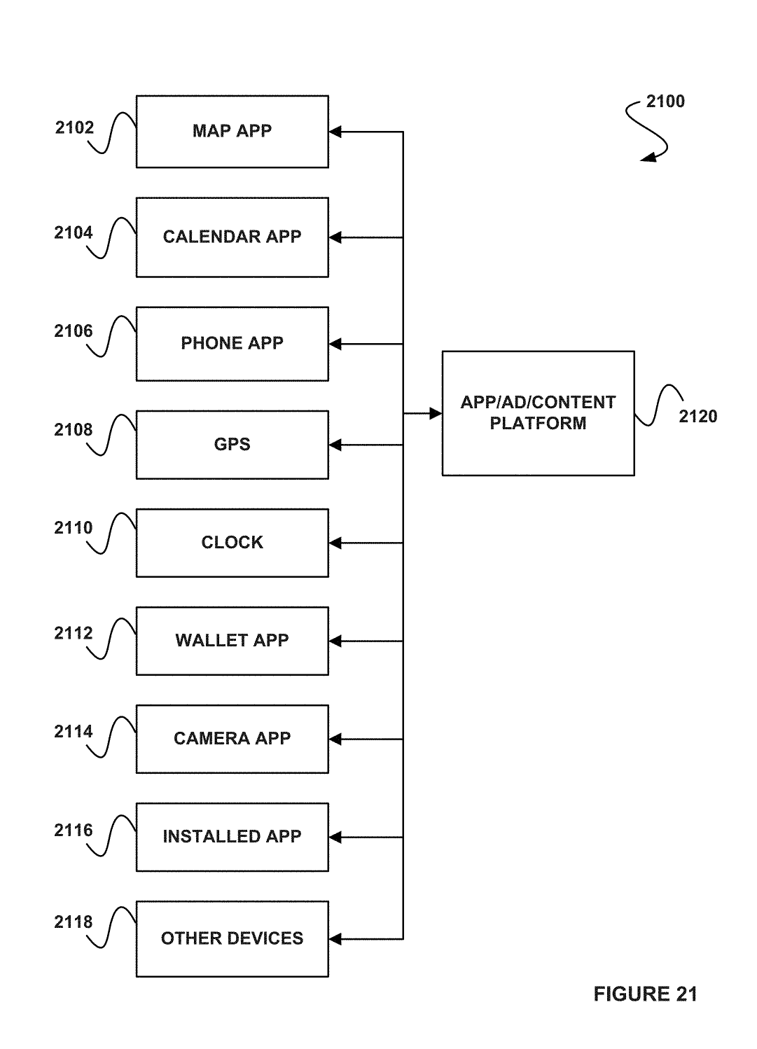

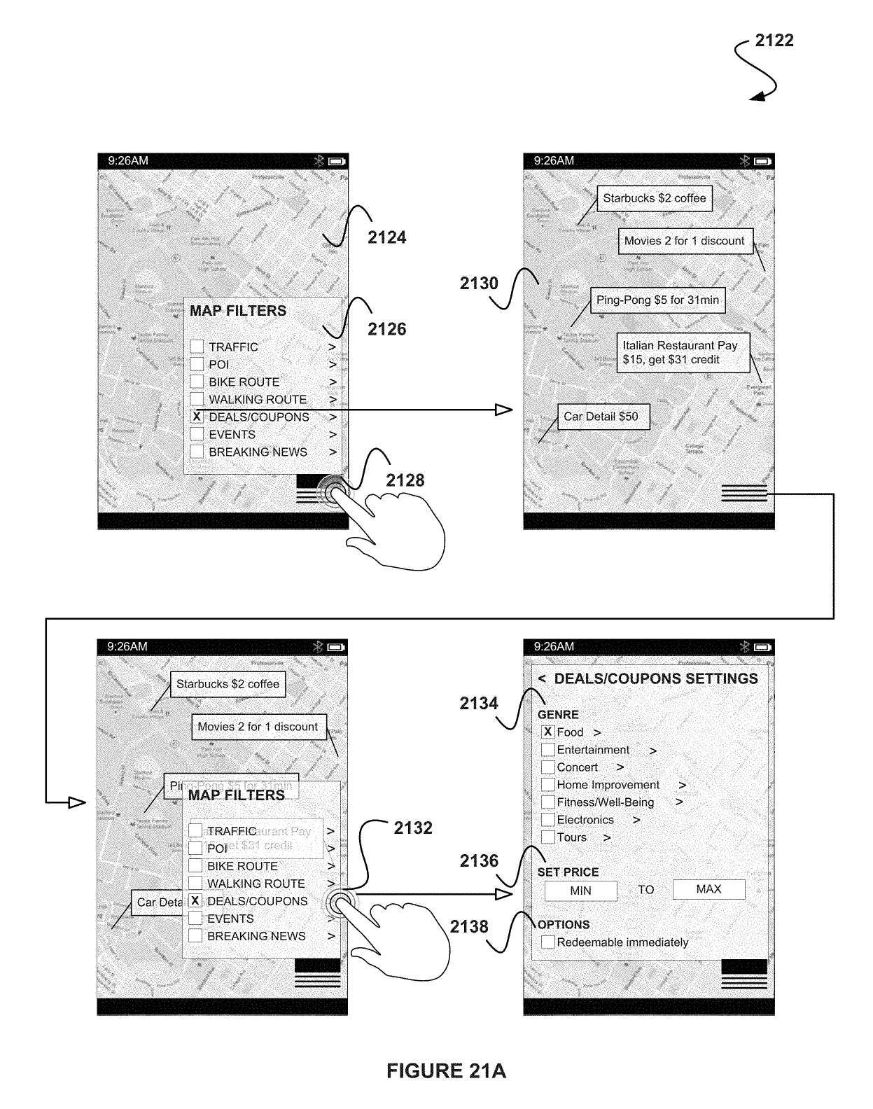

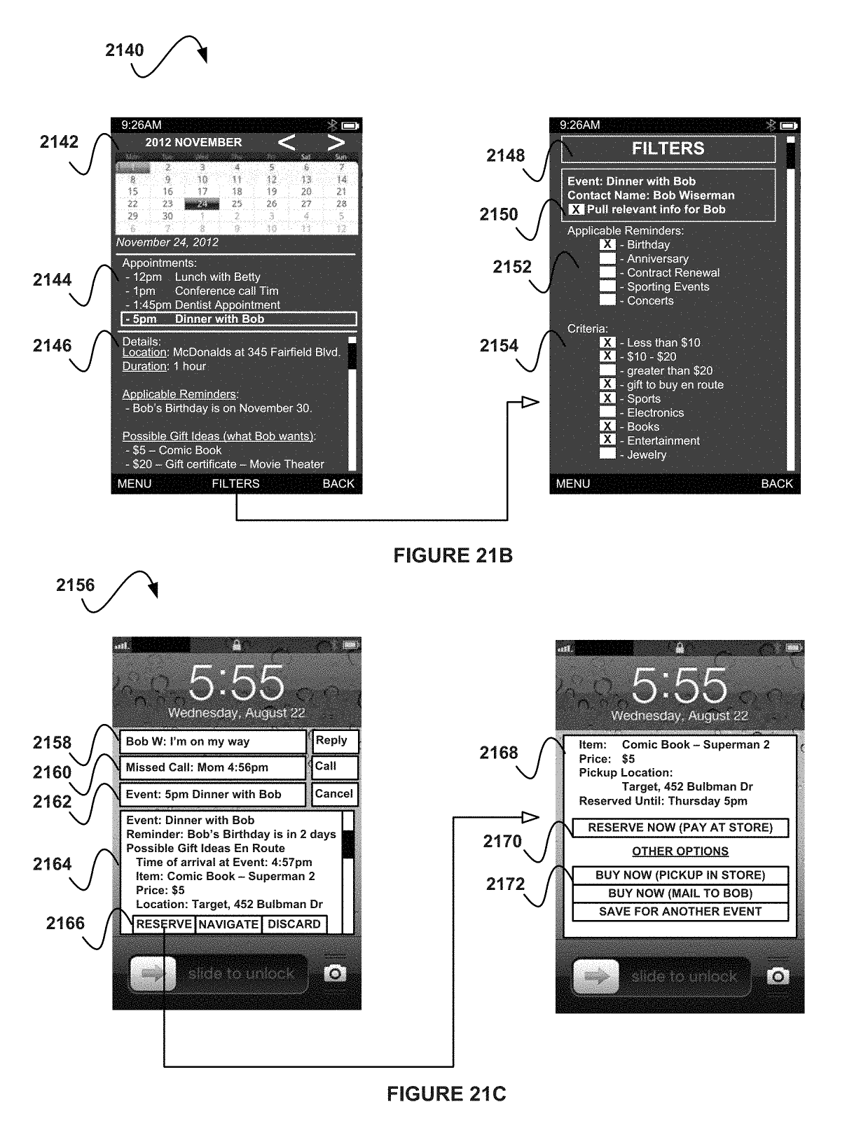

FIG. 21 shows a system 2100 for contextual advertisement management in connection with a mobile device, in accordance with another embodiment. As an option, the system 2100 may be implemented in the context of the architecture and environment of the previous Figures and/or any subsequent Figure(s). Of course, however, the system 2100 may be implemented in the context of any desired environment. It should also be noted that the aforementioned definitions may apply during the present description.

As shown, a map application 2102, a calendar application 2104, a phone application 2106, a GPS 2108, a clock 2110, a wallet application 2112, a camera application 2114, an installed application 2116, and/or other devices 2118 may be in communication with an application/ad/content platform 2120.

In one embodiment, the map application 2102 may communicate with the application/ad/content platform 2120, and in response to the communication, display relevant ads and/or content on the map. In one embodiment, the relevant ads and/or content may be displayed as an overlay on the map (e.g. another layer on the map, etc.), a separate map associated with the map application (e.g. clickable “deals” map, pop-up deal map, etc.), a split screen map (e.g. regular map on one side and map with deals on the other side, etc.), and/or any other configuration whereby the ads and/or content may be displayed. In various embodiments, the relevant ads and/or content may be displayed automatically (e.g. based on location, based on timer, based on appointment, based on message, etc.) and/or may be displayed manually (e.g. clicking on the map application button, giving voice command to display the map, giving voice command to display deals on the map, etc.). Of course, the relevant ads and/or content may be displayed in response to any action by the user and/or by any trigger associated with the mobile device and/or any application(s) on the device.

In another embodiment, the calendar application 2104 may communicate with the application/ad/content platform 2120, and in response to the communication, display relevant ads and/or content. For example, in one embodiment, the calendar application may have an appointment listed to “clean the car.” A relevant ad may be displayed with a coupon for a car wash at a nearby car wash facility. In another embodiment, the calendar application may have an appointment listed to eat lunch with a friend. The calendar application may also include information relating to the friend's birthday. In such an embodiment, a relevant ad may be displayed relating to possible birthday gift ideas that are compiled from relevancy criteria related to the friend's public profile (e.g. social media postings and/or profile, blog posts, email correspondence, purchase history, wish list, etc.).

In various embodiments, the relevant ads and/or content may be displayed prior to an event (e.g. recommendations relating to the event, discounts relating to the event, etc.). In other embodiments, the relevant ads and/or content may be displayed after an event (e.g. after the start of an event, after the end of an event, etc.). For example, in one embodiment, the calendar application may have an appointment listed to “buy bike.” After the event has started, a relevant ad and/or content may be displayed giving a recommendation to buy a lock at a nearby location. Additionally, after the event has ended, a relevant ad and/or content may be displayed giving a recommendation where to bike (e.g. nearby bike trails, etc.), how to join a bike club, how to tune up a bike (e.g. including discounts at nearby repair shops, etc.), and/or any other information which may relate to buying a bike.

In another embodiment, the phone application 2106 may communicate with the application/ad/content platform 2120, and in response to the communication, display relevant ads and/or content. For example, in one embodiment, the phone application may display an incoming call, and in response to the incoming call, display information relating to the caller. For example, the information displayed may include an upcoming birthday, an upcoming appointment, a recent event relating to the caller, a note relating to the last conversation, information relating to a CRM (customer relation management) system, and/or any information relating to the caller. Of course, the information may be displayed as soon as the call is received, after it is accepted, after the call has ended, and/or at any other time determined by the caller. In one embodiment, the information displayed may occur automatically (e.g. in response to a call, etc.). In another embodiment, the information is displayed manually (e.g. user selects a further information button, etc.).

In a further embodiment, after the phone call has ended (or during the phone call if requested by the user, etc.), the phone application may prompt the user to take an action. For example, in one embodiment, after a phone call with friend “Bob Smith,” the phone application may display a reminder to the user that Bob Smith's birthday is coming up, with options to take an action. For example, such actions may include sending an email, mailing a birthday card (or picture postcard, or a personalized card, etc.), selecting a relevant gift to buy and send, schedule an appointment, update a contact profile, and/or any other action which may relate to the caller. Relevant gifts may relate to the caller, and which may be selected based off of a caller's preferences found on a social media site (e.g. Facebook, MySpace, etc.), a communication (e.g. email, SMS message, etc.), a text-to-speech translation (of a phone conversation, etc.), photos taken by the caller, a list of items wanted, items flagged or “liked” on an online portal site (e.g. Amazon, etc.), and/or any other source of information relating to the caller.

In another embodiment, the GPS 2108 may communicate with the application/ad/content platform 2120, and in response to the communication, display relevant ads and/or content. In one embodiment, the GPS may include navigation software. As the user uses the navigation software, the navigation software may display relevant ads and/or content. For example, in one embodiment, while navigating to a location, the GPS may display an ad for “$5 off coupon at Arbys” which is along the predetermined GPS route. In such an embodiment, the user may ignore the ad, click to redeem and use the ad along the route, and/or interact with the ad and/or content in any manner. In various embodiments, the user may communicate with the displayed ad by touching a touchscreen, giving audible voice commands, touching a command button found in the automobile (or the transportation being use) which is connected (e.g. via Bluetooth, etc.) to the GPS, and/or by any interface and/or device which may control the GPS. In some embodiments, the user may select filters to restrict the ads and/or content that are displayed (e.g. display only ads that are $5 or less, along my route, and are within the food genre, etc.), may select whether the ads and/or content are displayed automatically, may select to permit the device to determine whether the user is with friends and/or other users in the vehicle (to determine the number of people to find applicable ads and/or content [e.g. 2 for 1 deal, 3 pay and the 4^{th} eats free, etc.], etc.), and/or may set any settings relating to the ads and/or content on the GPS.

In one embodiment, the GPS may display the ads and/or content in response to a manual request by the user. For example, the user may select a voice activation command button, select a button to search or to find nearby restaurants, and/or any other action which directly activates the ads and/or content. In one embodiment, the user may request an Italian restaurant nearby that has no wait, is highly rated and for which a coupon exists. In such an embodiment, the manual request may directly activate the ads and/or content on the GPS. In a separate embodiment, the GPS may display the ads and/or content automatically. For example, the GPS may display the ads and/or content in response to a destination request, a new ad and/or content which comes available en route, a friend pushing a relevant ad and/or content to the user, and/or in response to any other external input (e.g. another device, a network, etc.) and/or internal input (e.g. an ad from a friend, another application pushing an ad/content, etc.).

In another embodiment, the clock 2110 may communicate with the application/ad/content platform 2120, and in response to the communication, display relevant ads and/or content. In one embodiment, the clock may display ads and/or content in response to an event reminder, an upcoming event, a time dependent notification, and/or in response to any other input dependent upon the clock. In various embodiments, the displayed ads and/or content may be manually inputted by the user. For example, the user may create an event and/or notification and/or a reminder for the user to perform an action (e.g. buy a card, select a gift, accomplish a task, etc.). In response to the creation of the event and/or notification and/or a reminder, the clock may remind the user at the designated date and time. Additionally, at such a moment, the clock may also display pertinent ads and/or content. For example, if a user had created a reminder to “buy a gift for Bob on Friday,” the clock may display a reminder on Friday to “Buy Gift for Bob,” with possible gift selections below the reminder. In various embodiments, the user may select a gift immediately to buy and send, may filter the results to only display gifts which may be purchased locally and within a set geographic range and which are in stock at the indicated locations, and/or may take any action associated with the notification.

In one embodiment, the notification may be displayed on a locked or startup screen. In another embodiment, the notification may be displayed in a drop-down status bar, in a widget, or on any other display associated with the device. Of course, the notification may be displayed in any manner. Additionally, the notification may have audible sounds (e.g. alert sound, voice which says “Buy Bob a gift,” etc.).

In another embodiment, the wallet application 2112 may communicate with the application/ad/content platform 2120, and in response to the communication, display relevant ads and/or content. In one embodiment, the wallet application may record the user's purchases and use such record to tailor ads and/or content. For example, the purchase history associated with the user may reveal that the user regularly purchases pizza from Pizza Hut. The wallet application may be used to reward the user with a free pizza, a discounted price, and/or any other reward. In this manner, the wallet application may be used to associate a user's purchase history with rewards, thereby enabling businesses and/or entities to reward users that are frequent users of the business's products and/or services.

In other embodiments, before a user makes a purchase, the wallet application may prompt the user to apply a publicly available coupon (e.g. 20% storewide sale, etc.). In one embodiment, the wallet application may prompt the user that the product may be obtained for a cheaper price online or at another location. Such a prompting may be displayed in response to the user scanning a product (e.g. UPC code, QR code, etc.), receiving a request to pay for the product (e.g. during checkout, etc.), and/or in response to any event relating to the product. In one embodiment, the wallet application may search for similar products which may be obtained for a cheaper price (online or at a nearby in-store, etc.) or for which coupons and/or deals may be applied.

In one embodiment, the wallet application may be used to pay at a restaurant. For example, when a bill is presented to the user, the wallet application may automatically sense (e.g. push notification from restaurant, text message from restaurant, and/or some communication from the restaurant, etc.) that a bill needs to be paid. In another embodiment, the user may pull a bill to the device (e.g. download bill, fetch bill, etc.), may access a payment screen relating to the restaurant, and/or may request in any manner the bill to be paid. Once the bill has been presented to the user, the user may be presented with an option to add a tip to the bill. In some embodiments, the tip may be manually entered by the user, or may be selected from a preconfigured amount (e.g. 10%, 15%, 20%, etc.). In various embodiments, the user may transfer funds from a personal account (e.g. debit, credit, etc.) to the restaurant to cover the bill and/or tip.

In one embodiment, the wallet application may permit social integration. For example, if a user receives a coupon (e.g. 10% off in-store purchase, etc.), rather than using the coupon, the user may use the wallet application to forward the coupon to a friend and/or contact who may then redeem the coupon and/or discount. In another embodiment, the wallet application may be used to receive coupons and/or deals from friends and/or contacts.

In another embodiment, the wallet application may display content and/or ads associated with digital tickets. For example, in one embodiment, the user may have a digital ticket to a concert event stored in the wallet application. In some embodiments, the wallet application may fetch additional content and/or ads relating to the digital ticket, including a discount and/or coupon on food near the concert event, ability to pay for a parking pass for the event, ability to buy paraphernalia associated with the concert event, and/or any interaction and/or feature associated with the digital ticket.

In various embodiments, the wallet application may interact with other devices. For example, in one embodiment, the wallet application may display relevant ads and/or content on another display (e.g. transaction device, LCD screen, a contact's device, etc.), and/or may permit the user greater functionality associated with the other device and/or displays, including permitting the user to click and purchase immediately a product, redeem a coupon and/or deal, complete a transaction, receive a reward (e.g. credit, discount, etc.) from the store location, complete an action in order to receive a prize and/or coupon and/or discount, and/or further engage in some manner with another device and/or display.

In one embodiment, the wallet application may interact with another device and/or display wirelessly (e.g. NFC, Bluetooth, WIFI, etc.). In situations where security is important (e.g. complete a transaction, etc.), a short range wireless transmission (e.g. NFC, etc.) may be used, and/or a wired connection may be used.

In another embodiment, the camera application 2114 may communicate with the application/ad/content platform 2120, and in response to the communication, display relevant ads and/or content. In one embodiment, the user of the device may take a photo and the camera application may then apply object recognition algorithms to identify the object (e.g. human, building, statue, etc.). In one embodiment, the camera application may contact an online database to help in identifying the object. Once the object has been identified, the camera application may present options to the user, including buying a poster of the object (e.g. professional artwork, print out the digital image through an online printer, etc.), guiding the user on a tour around the object, providing input on the object through an augmented reality overlay (e.g. through the device, through eyeglasses associated with the device, etc.), providing a discount for the object at a nearby store (e.g. picture of spaghetti prompts a discount on spaghetti at a local Italian restaurant, etc.), providing the user with information on the object (e.g. picture of the Eiffel Tower prompts information about the Eiffel Tower, etc.), and/or providing an ability for the user to interact in some manner with the captured image. In such embodiments, the camera application may interact in real time with the user. Of course, in other embodiments, the camera application may provide feedback at a later time after a photo was taken.

In one embodiment, the information displayed on the camera application may appear automatically (e.g. display options near instantaneous after taking the photo, after a set time delay of inactivity after taking the photo, etc.) or may be appear manually (e.g. user selects “options” on menu of camera, applies overlay such as an augmented reality view on camera, selects a more information option on the menu of the camera, etc.). In another embodiment, relevant ads and/or content may be requested at a period of time after taking the photo. For example, a photo may be retrieved which had previously be taken, and additional options may be presented to the user (e.g. buy professional print of image [rather than the user's image], find out additional information (e.g. social network exchanges linked with the photo), receive discounts and/or coupons relating to the image, etc.). In one embodiment, the camera application may interact with multiple devices. For example, if it was determined that the user was with a group of friends, after a photo was taken, the camera application may send (e.g. via Bluetooth, Wifi, etc.) the photo to all of the devices associated with the friends. In other embodiments, when a photo is taken, the camera application may recognize and identify who is in the photo, and in response to the identification, provide promptings to the user, including reminders of upcoming birthdays and/or events relating to a friend in the photo, suggested nearby restaurants that all friends and the user would have a preference to dine at (e.g. based off of characteristics and/or indications in a social media profile, postings, communications, etc.), and/or any action relating to all individuals in the photo. In another embodiment, the camera application may upload photos to one or more accounts associated with a social networking site. For example, after a photo is taken, the camera application may prompt to post the photo to each of the individual's social media account. Of course, the camera application may take any action as predetermined and/or preset by the user, or the camera application may take any non-predetermined action (e.g. manual control by the user, etc.).

In another embodiment, the camera application may determine that an individual in the photo has a preference for vintage-looking photos (e.g. information taken from a social networking site, an email, SMS, etc.). In such an embodiment, the camera application may automatically transform the photo into a vintage-looking forward and upload the photo to a social media account associated with the individual. In other embodiments, the camera application may present photo transformation options to the user, including applying a known scheme (e.g. B&W Ansel-Adams look, vintage look, deep saturation, Polaroid look, etc.), a known setup (e.g. enlargements, glamour shots portfolio, etc.), a known format (e.g. best format to upload to Costco Online Photo Center, etc.), printer profiles associated with indicated printing facility, and/or any options which may transform the image. In many embodiments, the options may include retrieving additional information online (e.g. settings for Ansel-Adams look, printer profile characteristics for Costco Online Photo Center, etc.).

In another embodiment, an installed application 2116 may communicate with the application/ad/content platform 2120, and in response to the communication, display relevant ads and/or content. In various embodiments, the installed application may provide user information to the application/ad/content platform, including usage of application information, type of application, user history on application (e.g. browsing history, activity history, etc.), and/or any other type of information relating to the application which may be applicable to the app/ad/content platform.

In one embodiment, a first installed application may communicate with a second installed application and provide information relating to the second installed application to the application/ad/content platform. For example, in one embodiment, the user may have installed on the mobile device an application associated with a lunch cafe restaurant, and a second application associated with local food deals in the user's area. In such an embodiment, the first and second application may provide information to the application/ad/content platform. In another embodiment, if the first application was not in communication with the application/ad/content platform, the second application associated with local food deals may pull information from the first application (e.g. lunch specials, soup of the day, etc.) and send such information to the application/ad/content platform. As such, information associated with the applications may be sent to the application/ad/content platform in any manner.

Of course, the user may select and determine the level of permission granted to each application, including the ability to share information with the application/ad/content platform, and/or the ability to pull information relating to other applications and share such information with the application/ad/content platform.

In another embodiment, other devices 2118 may communicate with the application/ad/content platform 2120, and in response to the communication, display and/or send relevant ads and/or content. For example, in one embodiment, the mobile device may sense (e.g. via Bluetooth, Wifi, etc.) other devices. In one embodiment, the other devices may provide information to the application/ad/content platform. For example, in one embodiment, the mobile device may be connected to a store surveillance system. The store surveillance system may provide information (e.g. number of people who have entered the store, general demographics of people entering the store, etc.) to the application/ad/content platform. Such information may additionally be used by the store and the application/ad/content platform to send out (e.g. push notification, WiFi enabled application, etc.) relevant ads and/or content. For example, it may be noticed by the store surveillance system that young mothers and children are frequently entering the store. In response, the store may provide a deal (e.g. accessible through the store's WiFi, etc.) relating to a discount off of children's clothes.

In various other embodiments, other devices may receive information from the application/ad/content platform. In one embodiment, the application/ad/content platform may establish communication with another device, including a secondary display, a headset (e.g. Bluetooth audio headset, car infotainment system, etc.), an accessory (e.g. keyboard, mouse, etc.), and in response to the established communication, the application/ad/content platform may send relevant ads and/or content to the other devices. For example, in one embodiment, the mobile device may connect to a Bluetooth audio headset. Based on the connection, the application/ad/content platform may notify the user of possible deals and/or coupons and/or ads and/or content through audible notifications (e.g. “there are 2 possible deals nearby, would you like more information?,” etc.) rather than displayed notifications. For that matter, any of the ad/content presentation examples set forth herein may be audibly communicated in addition to or in lieu of visual presentation. In another embodiment, the application/ad/content platform may be connected to a secondary display (e.g. car display, television display, in-store display, etc.) and may display relevant ads and/or content. Of course, the application/ad/content platform may connect to any device, receive any type of information from the any device, push information to the any device, and/or communicate with the device in any manner.

Additionally, in another embodiment, the user may select preconfigured settings to control the application/ad/content platform's response to other devices that seek to communicate. In one embodiment, the communication may be established automatically. In another embodiment, the communication may be established manually based off of input from the user. In a further embodiment the communication may be established based off of a set of preconfigured criteria (e.g. at a specific location, device is trusted, etc.).

It should be noted that any of the aforementioned applications (e.g. 2102-18, etc.) may provide any of the disclosed (or other) input for using in causing (e.g. selecting, triggering, etc.) presentation of an ad/content utilizing the application/ad/content platform and/or another application. See, for example, the presentation techniques of other figures (e.g. FIG. 8-10, etc.). Further, any of the aforementioned applications (e.g. 2102-18, etc.) may provide a medium for presenting any ad/content utilizing that is caused (e.g. selected, triggered, etc.) by the application/ad/content platform and/or another application. Of course, the aforementioned applications may display ad/content via any mechanism (e.g. lock/password screen, pull-down screen, etc.). See, for example, the presentation techniques of other figures (e.g. FIG. 8-10, etc.).

FIG. 21A shows a mobile device interface 2122 for configuring advertisement/content related notifications, in accordance with another embodiment. As an option, the mobile device interface 2122 may be implemented in the context of the architecture and environment of the previous Figures and/or any subsequent Figure(s). Of course, however, the mobile device interface 2122 may be implemented in the context of any desired environment. It should also be noted that the aforementioned definitions may apply during the present description.

As shown, a map application 2124 is displayed on the device. Additionally, a menu button 2128 may be selected to display map filters 2126.

In one embodiment, the map application may fill the display of the device. In another embodiment, the map application may fill only a portion of the display (e.g. so that the display may also be used for another function, etc.). In various embodiments, the map application may be configured and/or altered by the user. For example, the user may select a menu button to display map filters to be applied to the map, including traffic, points of interest (POI) (e.g. restaurants, museums, event centers, tours, repair services, lodging, etc.), bike route, walking route, deals/coupons, events, breaking news, and/or any other feature of interest that may apply to the map application. In one embodiment, the selected map filter(s) may appear as an overlay on the existing displayed map. In another embodiment, the selected map filter may be displayed as a separate map (e.g. the more filters that are selected, the more individual maps are displayed on the screen in a compartmentalized manner, etc.).

As shown, after the user selects a map filter, the map filter is displayed 2130. For example, in one embodiment, if the user selected the “deals/coupons” map filter, the map would display deals and/or coupons for the selected geographic area. In one embodiment, the map application may respond in a dynamic fashion (e.g. repopulate map with appropriate deals and/or coupons, etc.) whenever the user zooms in and/or out of the map.

As shown, additional settings relating to each map filter may be selected 2132. In one embodiment, in relation to the deals/coupons map filter, such additional settings may include the genre 2134, setting the price 2136, and/or further options 2138.

In one embodiment, the genre settings relating to deals/coupons may include food, entertainment, concert, home improvement, fitness/well-being, electronics, tours, and/or any applicable subcategory filter. Each of the genre settings may have further settings which may apply to the selected genre. For example, if further settings relating to food were selected, the user could filter the results to only show Thai food that is inexpensive to moderate price range, and which has a digital reservation management system. Of course, any filter or plurality of filters may be applied to each of the genres.

In another embodiment, the user may select the price range to be displayed with the map filter. For example, in one embodiment, the deals/coupons map filter may be selected, and the user may select a price range (e.g. $2-$10, etc.) to be applied to each of the entries relating to the deals/coupons map filter. In another embodiment, the user may select a preconfigured category relating to the subcategory setting. For example, in setting the price restriction, the user may select one or more of “cheap” (e.g. $5-$10, etc.), “inexpensive” (e.g. $10-20, etc.), “moderate” (e.g. $20-30, etc.) and/or “expensive” (e.g. $30+, etc.) categories. In another embodiment, the user may preconfigure the price restrictions for each of the categories.

In a further embodiment, the user may select additional options relating to the selected map filter. For example, in one embodiment, if the deals/coupons map filter is selected, the user may select additional options including redeemable immediately, deals/coupons applicable to my friend(s) currently with me, deals/coupons greater than 20% off, and/or any other option relating to filtering deals/coupons.

In a separate embodiment, the map application may be integrated with voice commands. For example, in one embodiment, the user may give a voice command “I'm hungry. Show me restaurants in the area.” The voice command may cause the map application to be displayed with an overlay dealing with restaurants. In some embodiments, the voice command may request additional information from the user. For example, after showing restaurants in the area, the map application may state “Would you like to filter the results?” whereupon the user may give further voice commands like “Yes, display only Thai restaurants,” and/or “Yes, display only cheap restaurants,” and/or any other voice command. Of course, in various embodiments, any of the settings and/or subcategories may be controlled by a voice command or plurality of voice commands.

FIG. 21B shows a mobile device interface 2140 for configuring advertisement/content related notifications, in accordance with another embodiment. As an option, the mobile device interface 2140 may be implemented in the context of the architecture and environment of the previous Figures and/or any subsequent Figure(s). Of course, however, the mobile device interface 2140 may be implemented in the context of any desired environment. It should also be noted that the aforementioned definitions may apply during the present description.

As shown, a calendar application 2142 is displayed on the device. Additionally, listed appointments 2144 and appointment details 2146 may be displayed.

In one embodiment, the calendar application may include a monthly, weekly, daily, and/or list view. In other embodiments, the calendar may be displayed in any manner. In another embodiment, the appointments listed for a selected day may be displayed. A user may select a listed appointment to view additional details relating thereto. For example, in one embodiment, a user may have a dinner with Bob listed on the calendar. Upon selecting the appointment, details relating thereto may be displayed, including the location, duration, applicable reminder, and relevant ads and/or content. For example, in one embodiment, an applicable reminder may be Bob's upcoming birthday. Based off of the applicable reminder, relevant ads and/or content may be displayed which may include possible gift ideas, locations to take Bob, activities that Bob wants to do, and/or any other relevant ad and/or content.

In one embodiment, applicable reminders may be created from one or more sources. For example, in various embodiments, the applicable reminders may be based on contact information stored in the mobile device, on an online database system, with an online social media provider (e.g. Facebook, etc.), a contact management system (e.g. customer relationship management (CRM), etc.), and/or any other source from which information relating to the contact may be obtained.

In one embodiment, possible gift ideas may include a comic book, a gift certificate, etc. Such gift ideas may be compiled based on social media postings (e.g. Facebook, MySpace, etc.), emails, user history, preferences, and/or any information (e.g. purchase history, etc.) relating to the user's friend (e.g. Bob, etc.). In one embodiment, the possible gift ideas may be dependent on the current location of the user and/or the mobile device. For example, the gift ideas may include possible gifts available at the user's current location, the calendar appointment location, a location en route to the calendar appointment location, and/or any other location set by the user. Of course, the gift ideas may include possible gift ideas which may be purchased online and sent to the friend.

As shown, filters 2148 may be applied to the appointment detail, including selecting to pull relevant information associated with the appointment 2150, show applicable reminders 2152, and/or filter criteria 2154. In one embodiment, the user may select a “filters” option on the calendar application and be presented with a user interface relating to the filters 2148.

In one embodiment, the calendar application may pull (e.g. gather, extract, etc.) relevant information for a contact (e.g. Bob, etc.). For example, the relevant information may include a birthday, anniversary, preferences, a list of wanted items, items “liked,” purchased items, and/or any information associated with the contact (e.g. Bob, etc.). In various embodiments, applicable reminders may be set, including a birthday, anniversary, contract renewal, sporting event(s), concert, and/or any event associated with the contact. In one embodiment, the applicable reminders may be set per contact (i.e. for each contact, etc.). In another embodiment, the applicable reminders may be set globally for all contacts and/or appointments.

In another embodiment, criteria may be applied, including less than $10, $10-$20, greater than $20, gift to buy en route, sports, electronics, books, entertainment, jewelry, and/or any other criteria. In one embodiment, the criteria applied may relate directly to the calendar appointment. In another embodiment, the criteria applied may relate globally to all calendar appointments. In a separate embodiment, the criteria may be set globally to all calendar appointments, but may then be refined individually (i.e. changed and/or modified, etc.) for each calendar appointment.

FIG. 21C shows a mobile device interface 2156 for configuring advertisement/content related notifications, in accordance with another embodiment. As an option, the mobile device interface 2156 may be implemented in the context of the architecture and environment of the previous Figures and/or any subsequent Figure(s). Of course, however, the mobile device interface 2156 may be implemented in the context of any desired environment. It should also be noted that the aforementioned definitions may apply during the present description.

As shown, a locked screen may display relevant ads and/or content, including a text message 2158, a missed call 2160, an upcoming event 2162, additional information 2164, and/or options 2166 associated with the additional information.

In one embodiment, the displayed notification may include an ability to take an action. For example, in various embodiments, if a text message was displayed, a reply action may be displayed; if a missed call was displayed, a call back action may be displayed; if a calendar event was displayed, a cancel event action may be displayed. Of course, any notification may have any action associated with it. In one embodiment, the notifications may be displayed on the screen until cancelled by the user. For example, the user may delete all displayed notifications, may cancel each notification individually, and/or may use any action (e.g. swipe away, hold down for predetermined time, etc.) to delete a notification.

In another embodiment, the displayed notifications may be displayed on a separate locked screen. For example, the locked screen of the device may include multiple locked screens (e.g. user may swipe up or down or to the side or in any direction to change the locked screen, etc.). In one embodiment, one of the locked screens may include notifications (e.g. phone, emails, calendar events, etc.). In a separate embodiment, the locked screen may include an option to receive voice commands. For example, the user may state “show me my notifications” upon which the notifications may be displayed. Of course, the user may use any voice command to control the locked screen (e.g. “delete the notifications,” “reply to Bob that I am on my way,” “call back Bob,” etc.).

In one embodiment, additional information associated with a notification may be displayed. For example, in one embodiment, a displayed notification may indicate “5 pm Dinner with Bob,” and additional information may include a reminder of “Bob's Birthday is in 2 days,” and a scrollable list of possible gift ideas for Bob (e.g. Comic Book, movie tickets, etc.). In such an embodiment, the list of possible gift ideas may be compiled from any source associated with the contact (e.g. Facebook, online journal, emails, SMS messaging, blog, etc.). In another embodiment, a displayed notification may indicate “missed call from mom,” and additional information may include a voice-to-text transcription of a voicemail, a reminder that the contact's birthday is in 2 days (or any number of days), a note pertaining to the last conversation with the contact, a contract relating to the contact, a document recently sent by the contact, and/or any other relevant content and/or ads.

In another embodiment, additional options may be presented to the user relating to the additional information. For example, in one embodiment, the additional information may relate to a calendar event and include possible gift ideas. The additional options may include an option to reserve a gift, navigate to a location to buy a gift, and/or discard the additional information. Of course, any further option and/or action may be presented to the user. In a separate embodiment, the additional information may relate to a missed call event. The additional options may include an option to reserve and/or buy a gift, navigate to the contact, obtain ETA from the contact, respond to the contact (e.g. via email, call, SMS, chat, etc.), and/or take an action relating to any relevant content and/or information. In one embodiment, if the user of the mobile device selects “reserve,” the user may be displayed with an additional screen of options relating to the additional options.

As shown, information 2168 relating to the gift may be displayed. In one embodiment, the information may be a condensed form of the additional information presented earlier to the user (e.g. give details relating only to the product, etc.). In other embodiments, the entire additional information may again be presented to the user. Additionally, as shown, the user may be presented with an option to reserve 2170 the product, and/or other options 2172 associated with the product.

In one embodiment, the option to reserve may permit the user to select the product, to have the product set aside at the designated location, and then to permit the user to go by to the designated location and pick up and/or pay for the product. In other embodiments, the user may select to “buy now (pickup in store)” where if selected, an auto payment system (e.g. saved credit card information, etc.) may be applied to complete the transaction automatically. In other embodiments, the user may be presented with a checkout display screen where information may be inputted manually. In various embodiments, the user may select to “buy now (mail to X)” (where X is the contact) and be presented with the same payment screens as indicated above (e.g. auto or manual checkout procedure, etc.), and/or to “save for another event” where the gift information may be saved for a later event relating to that contact. Of course, any option associated with the product may be presented to the user.

In a separate embodiment, the options may be associated and personalized to the additional information displayed to the user. For example, if the additional information relates to a CRM entry, the options may include modifying the CRM contact, sending the CRM contact to another, allocating database resources, reviewing upcoming appointments and/or events with the CRM contact, and/or taking any action relating to the CRM contact. If the additional information relates to an event (e.g. tour, concert, vacation, etc.), the options may include posting a photo, reserving a parking spot, interacting with other contacts (e.g. sharing location, receiving event updates from friends, etc.), buying food to be picked up at a designated location, recording a video and/or audio clip, reserving activities, requesting a taxi/limo, and/or any other request which may relate to the additional information.

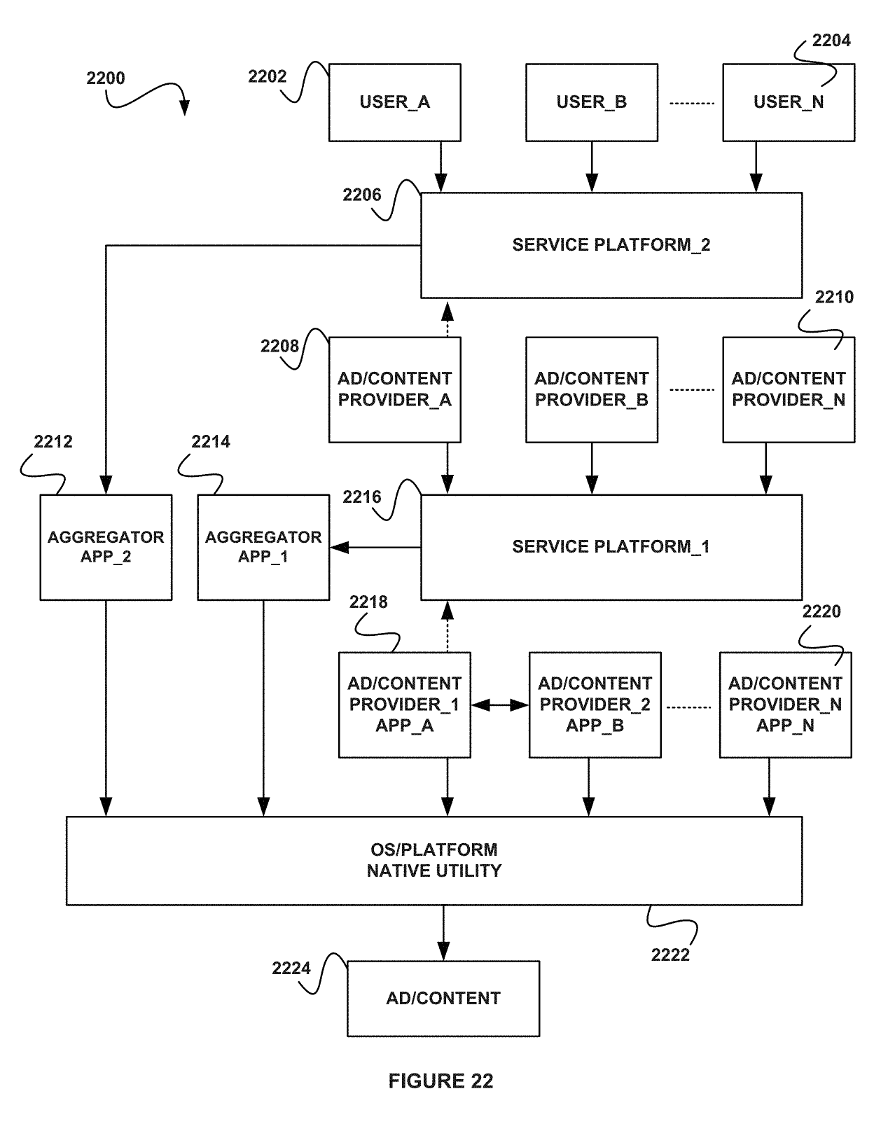

FIG. 22 shows a system 2200 for presenting contextual advertisements, in connection with a mobile device, in accordance with another embodiment. As an option, the system 2200 may be implemented in the context of the architecture and environment of the previous Figures and/or any subsequent Figure(s). Of course, however, the system 2200 may be implemented in the context of any desired environment. It should also be noted that the aforementioned definitions may apply during the present description.

As shown, one or more user(s) 2202 (e.g. USER_A, USER_B, USER_N, etc.) is/are connected to a “Service Platform 2” 2206. In one embodiment, the one or more user(s) may communicate with another one or more user(s). For example, in one embodiment, a USER_A may post information to a profile, page, and/or resource associated with USER_B. In another embodiment, a USER_A may pull information associated with USER_B (e.g. posting, video, photo, multimedia file, document, preference, profile, etc.) and save and/or post and/or send the content to another USER and/or source. Of course, in other embodiments, any user may be connected to any number of users (see 2204).

In one embodiment, the one or more users may be connected by sharing permissions granted to each other (e.g. each user has received and approved of a permission request, etc.). In another embodiment, the sharing permissions may be restricted and/or modified in any manner by the user. For example, in one embodiment, the user may wish to restrict the amount of content another user may view and/or take, whereas with a different another user the user may wish to grant full access to view and/or take the content from the page associated with the user.

In another embodiment, the Service Platform_2 may provide a platform whereby the users may communicate (e.g. send message, post message, chat, instant message, etc.), transfer and/or share content (e.g. videos, documents, photos, music, etc.), interact (e.g. play a game, hold conference call, conduct a whiteboard session, work on a document, etc.), manage a system and/or process (e.g. manufacturing process, delivery system, etc.), and/or engage the one or more users in some other manner. In various embodiments, the Service Platform_2 may provide a notification update of another user, a profile change to an account, a status of a changed and/or updated document, a new email(s) and/or another communication (e.g. digital voicemail, SMS, transcript of meeting, etc.), and/or any other event which has change at least in some manner information and/or content associated with a service platform user. In other embodiments, the Service Platform_2 may track user history and/or action (e.g. for targeted marketing, to deliver more pertinent services, etc.).

In one embodiment, the Service Platform_2 may provide recommendations, including social media connections (e.g. based off of likelihood of social applicability to the user, user history, etc.), business contract opportunities (e.g. business A may provide needed services to business B, etc.), business contact connections (e.g. based off of professional applicability to the user, user history, etc.), promotions (e.g. based off of needs of other users, etc.), new business sectors (e.g. new and/or underdeveloped markets, etc.), and/or any other pertinent information which may relate to the user. Of course, in some embodiments, the user may control the recommendations (e.g. type, number, frequency, etc.) given by the Service Platform_2, and/or the permissions given to the Service Platform_2 to use the user's information (e.g. user history, activity history, connections, etc.) to provide more pertinent recommendations.

As shown, the “Service Platform_2” 2206 provides information to “Aggregator App_2” 2212, which is in communication with the “OS/platform native utility” 2222, which is in communication with the ad/content 2224.

In one embodiment, the Aggregator App_2 may be a downloadable app the user downloads and uses to access and/or connect to and/or receive updates from the Service Platform_2. In a separate embodiment, the Aggregator App_2 may be a downloadable app the user downloads and which runs in the background and which provides communication between the mobile device and the Service Platform_2. In other embodiments, the Aggregator App_2 may be a software component (e.g. plug-in, interface, etc.) provided by in association with the Service Platform_2. Of course, the Aggregator App_2 may function in any manner to enable communication between the Service Platform_2 and the OS/platform native utility.

In one embodiment, communication between the Service Platform 2 and the Aggregator App_2 may be synchronous (e.g. real time updates, continual connection, etc.) or asynchronous (e.g. periodic updates, manual updates, etc.). For example, in one embodiment, the user may set a preference for the Aggregator App_2 to update each time the application is selected by the user. Upon selecting the application, the Aggregator App_2 may pull any updates from the Service Platform_2. In another embodiment, the Aggregator App_2 may continuously in the background of the mobile device (e.g. background processing, etc.) receive updates from the Service Platform_2 and process and/or pass on the updates to the OS/platform native utility.

In one embodiment, the Service Platform_2 may provide CRM resources and/or services. The Aggregator App_2 may receive updates from the Service Platform_2, including changes to a contract, updates to a relevant contact (e.g. an upcoming appointment with a contact, a contact with an active account in your group, etc.), needs and/or troubleshooting problems (e.g. contact assigned to your group has a need of further services and/or resources, contact assigned to your group is having problems logging into an account, etc.), a new contract (e.g. one that was assigned to your group, etc.), and/or any other update relating to the CRM Service Platform_2. In another embodiment, the Aggregator App_2 may receive all updates relating to all relevant users (e.g. circle of friends, designated contacts, etc.) associated with the user of the mobile device. In other embodiments, the Aggregator App_2 may apply one or more actions to the updates, including aggregating the updates (e.g. providing a batch update to the OS/platform native utility rather than continuous notifications, etc.), filtering the updates so that only updates of a specified priority (e.g. low, medium, high, immediate, etc.) are passed onto the OS/platform native utility, formatting the updates (e.g. font, color, position, etc.), and/or modifying and/or taking some action on the updates in any manner.

In another embodiment, the Service Platform_2 may provide social media resources and/or services. The Aggregator App_2 may receive updates from the Service Platform_2, including new postings, change of profile (e.g. status, activity, profile photo, preferences, etc.), a request (e.g. to chat, to comment, to instant message, etc.), new uploads (e.g. documents, videos, pictures, etc.), new activity (e.g. Geotracking, online game, etc.), new status (e.g. online game status and/or achievement, “online” or “offline,” etc.), and/or any other update relating to the Service Platform_2. In another embodiment, the Aggregator App_2 may receive all updates relating to all relevant users (e.g. circle of friends, designated contacts, etc.) associated with the user of the mobile device. In other embodiments, the Aggregator App_2 may apply one or more actions to the updates, including aggregating the updates (e.g. providing a batch update to the OS/platform native utility rather than continuous notifications, etc.), filtering the updates so that only updates of a specified priority (e.g. low, medium, high, immediate, etc.) are passed onto the OS/platform native utility, formatting the updates (e.g. font, color, position, etc.), and/or modifying and/or taking some action on the updates in any manner.

In one embodiment, the OS/Platform may receive updates from the Aggregator App_2. In one embodiment, the Aggregator App_2 may have permission to push updates directly onto the OS/platform native utility. In other embodiments, the OS/platform native utility may pull updates from the Aggregator App_2. For example, the user may select settings (e.g. general mobile device settings, etc.) to control at least in some manner the interaction between the Aggregator App_2 and the OS/platform native utility, including permitting auto discovery of updates (e.g. OS/platform native utility may continually receive updates from the Aggregator App_2, etc.), permitting push updates from applications (e.g. from the Aggregator App_2, etc.), setting a time of discovery (e.g. update only between 8 am-7 pm Monday-Friday, etc.), setting a priority (e.g. immediate action item, requests, general updates, etc.), setting a format (e.g. where updates may be placed, including on the locked screen, within applications [e.g. designated portion of the screen, etc.], within a widget, etc.), and/or setting any other feature relating to the interaction between the Aggregator App_2 and the OS/platform native utility.

In one embodiment, the ad/content may relate to any of the updates and/or information associated with the Service Platform_2. In one embodiment, the ad/content may be displayed as received by the Aggregator App_2 and by the OS/platform native utility (i.e. the Service Platform_2 may control the display of the content, etc.). In another embodiment, the ad/content may be displayed as modified by the Aggregator App_2 and/or the OS/platform native utility. In various embodiments, the ad/content may be displayed on the screen of the mobile device (e.g. locked screen, within applications, home screen, widgets, etc.), displayed on the screen of another nearby device (e.g. projector, secondary display, a friend's mobile device, etc.) projected from the mobile device (e.g. onto a nearby object, etc.), played (e.g. audio recordings, etc.)

In another embodiment, the OS/platform native utility may distinguish between levels of notifications. For example, in one embodiment, the Aggregator App_2 may classify updates based on levels of subscription with the Service Platform_2, including segregating between Service Platform_2 users with a paid or fee subscription. In one embodiment, updates associated with paid users may rank higher and receive a higher priority by the Aggregator App_2, and thus may more frequently be displayed by the OS/platform native utility. In another embodiment, the user may select whether the Aggregator App_2 may segregate incoming notifications and/or updates based off of whether the user has a paid or free subscription with the Service Platform_2.

As shown, one or more ad/content provider(s) 2208 (e.g. AD/CONTENT PROVIDER_A, AD/CONTENT PROVIDER_B, AD/CONTENT PROVIDER_N, etc.) is/are connected to a “Service Platform 1” 2216. In one embodiment, the one or more ad/content provider(s) may communicate with another one or more ad/content provider(s). For example, in one embodiment, an AD/CONTENT PROVIDER_A may collect statistics and/or information relating to an ad (e.g. market success rate, click through rate, ad account, etc.) and provide the statistics and/or information to an AD/CONTENT PROVIDER_B. In a separate embodiment, an AD/CONTENT PROVIDER_A may share resources (e.g. photos, ads, videos, etc.) with an AD/CONTENT PROVIDER_B. Of course, the AD/CONTENT PROVIDER_A and the AD/CONTENT PROVIDER_B may communicate and/or exchange any information in any manner. In one embodiment, the SERVICE PLATFORM_1 may provide a platform on which the AD/CONTENT PROVIDER_A and the AD/CONTENT PROVIDER_B may communicate and/or exchange information. Of course, in other embodiments, any ad/content provider may communicate with any number of ad/content providers (see 2210).

In one embodiment, the ad/content provider may focus on marketing (e.g. ad creator, advertising campaign creator, etc.), entertainment (e.g. gaming, movies, books, etc.), education (e.g. text books, digital education institutions, etc.), food (e.g. catering, restaurants, cafes, coffee shops, grocery stores, specialty food and/or drink stores, etc.), shopping (e.g. department store, specialty shop, etc.), home improvement (e.g. home, garden, tools, etc.), health and/or beauty and/or medical (e.g. makeup, herbs, medicine, etc.), toys (e.g kids, outdoor, etc.), sports and/or outdoors (e.g. basketball, football, camping, biking, etc.), auto (e.g. cars, motorcycles, parts and/or accessories, etc.), etc. Of course, the ad/content provider may be associated with any industry and/or product.

In one embodiment, the ad/content provider may provider information and/or content and/or ads to the SERVICE_PLATFORM_1. For example, in one embodiment, the ad/content provider may have an ad campaign focusing on a clothing discount at a local store. The ad/content provider may provide a targeted ad to the SERVICE PLATFORM_1. In one embodiment, the SERVICE PLATFORM_1 may run the ad campaign on the SERVICE PLATFORM_1 by putting the ad on pages associated with users and/or tenants of the SERVICE PLATFORM_1. Of course, the SERVICE PLATFORM_1 may run and/or display the ad in any manner in association with the SERVICE PLATFORM_1.

In another embodiment, as shown, the SERVICE PLATFORM_1 2216 may provide the ad to an AGGREGATOR APP_1 2214 which delivers the ad to the OS/PLATFORM NATIVE UTILITY 2222 and which is then displayed on the mobile device as AD/CONTENT 2224. Of course, in other embodiments, any content (e.g. other than ads, etc.) may be sent from the SERVICE PLATFORM_1 to the OS/PLATFORM NATIVE UTILITY.

In one embodiment, the SERVICE PLATFORM_1 may specify and/or select the ads and/or content based on the user and/or mobile device associated with the user. For example, in one embodiment, the SERVICE PLATFORM_1 may receive information (e.g. from the OS/PLATFORM NATIVE UTILITY, AGGREGATOR APP, from settings inputted by the user, by another application, etc.) indicating the type of mobile device (e.g. size of screen, pixel density, data plan available, etc.) and/or information relating to the user (e.g. app usage, apps downloaded, preferences, profile information, upcoming events, purchased tickets, etc.). As such, in one embodiment, the SERVICE PLATFORM_1 may provide more relevant ads and/or content to the OS/PLATFORM NATIVE UTILITY relating to the user of the mobile device.

In another embodiment, the SERVICE_PLATFORM_1 may pull relevant information from an ad/content provider. For example, in one embodiment, the SERVICE PLATFORM_1 may recognize that the user of the mobile device will be attending an upcoming concert. In response, the SERVICE PLATFORM_1 may identify relevant ads and/or content from the ad/content providers. For example, the SERVICE PLATFORM_1 may identify a free parking coupon, a discount on drinks, an opportunity to participate in an exclusive event on site, and/or any other relevant ads and/or content. The SERVICE PLATFORM_1 may push the relevant identified content to the AGGREGATOR APP_1 which may aggregate (e.g. compile ads into one batch, etc.), filter (e.g. relevancy tests, personalized filter settings, etc.), modify (e.g. retrieve and/or fetch additional information relating to the ad and/or content, format the ads for the mobile device, etc.), and/or apply any other action to the ad and/or content.

As shown, AD/CONTENT PROVIDER_A may communicate with SERVICE PLATFORM_1 and SERVICE PLATFORM_2. In one embodiment, the SERVICE PLATFORM_1 may relate to businesses and/or ad/content providers and the SERVICE PLATFORM_2 may relate to individual users (or those entities without a pecuniary interest, etc.). Of course, the SERVICE PLATFORM_1 and the SERVICE PLATFORM_2 may relate to any type of entity (e.g. free, paid, business, individual, etc.). In a separate embodiment, the SERVICE PLATFORM_1 and the SERVICE PLATFORM_2 may be the same service platform. In another embodiment, the SERVICE PLATFORM_1 and the SERVICE PLATFORM_2 may be separate and distinct service platforms.

In one embodiment, the AD/CONTENT PROVIDER_A may receive information relating to a user associated with SERVICE PLATFORM_2. Based on such information, the AD/CONTENT PROVIDER_A may provide relevant ads and/or content to the SERVICE PROVIDER_1, which may provide the information to AGGREGATOR APP_1, and which may provide the information to OS/PLATFORM NATIVE UTILITY. For example, in one embodiment, the SERVICE PLATFORM_1 may be aware of the user of the mobile device having a preference for gelateria ice cream shops. The AD/CONTENT PROVIDER_A may provide a discount price ad to the SERVICE PLATFORM_1 for a new gelateria in the geographic area near the user of the mobile device. In one embodiment, the AGGREGATOR APP_1 may prioritize the ad (e.g. apply filtering settings, etc.) from the gelateria because it is a paying customer, and/or the gelateria has paid a premium for higher priority advertising, etc. The AGGREGATOR APP_1 may pass the targeted ad onto the OS/PLATFORM NATIVE UTILITY, which may display the ad on the user's mobile device according to preset filters and/or settings. For example, in one embodiment, if the discount price was 50% off, that may comply with the user's request to only view ads which are at least a 25% discount. Additionally, the OS/PLATFORM NATIVE UTILITY may display the ad the next time the user is within a predetermined geographic distance from the gelateria. Or, in another embodiment, if a friend of the user were to recommend the new gelateria to the user, that may trigger displaying the discount ad.

In a separate embodiment, the AD/CONTENT PROVIDER_A may discover from additional information about the user of the mobile device from a separate service platform (e.g. SERVICE PLATFORM_2, etc.). For example, in one embodiment, a friend of the user may be connected to the SERVICE PLATFORM_2. The AD/CONTENT PROVIDER_A may obtain further information in finding, in one embodiment, that the user likes chocolate gelato (more detail relating to the user, etc.). In one embodiment, the AD/CONTENT PROVIDER_A may now provide an ad focusing not only on the discounted price but also displaying a scoop of chocolate gelato with the ad giving a greater discount off of the chocolate gelato. As such, in this manner, the AD/CONTENT PROVIDER_A may more acutely target and refine ads to be more relevant to the user. Of course, the AD/CONTENT PROVIDER_A may obtain information relating to the user in any manner.

In one embodiment, the AGGREGATOR APP_1 may function in a manner similar to or the same as AGGREGATOR APP_2 (see item 2212 for description concerning AGGREGATOR APP_2). In another embodiment, the AGGREGATOR APP_1 may be a downloadable application the user installs on the mobile device. In one embodiment, the AGGREGATOR APP_1 may be come predownloaded and installed on the mobile device. In another embodiment, the AGGREGATOR APP_1 may be installed with a package. For example, the user may select to download an application associated with the SERVICE PLATFORM_1. As part of the application bundle, the AGGREGATOR APP_1 may be downloaded and installed. In another embodiment, the AGGREGATOR APP_1 may be automatically downloaded and installed based off of an action by the user (e.g. validate request and/or invite from a friend, click on link and/or advertisement online associated with the service platform, etc.).

In one embodiment, the AGGREGATOR APP_1 may receive information from the SERVICE PLATFORM_1. For example, in one embodiment, the AGGREGATOR APP_1 may be configured to receive push notifications from the SERVICE PLATFORM_1. In another embodiment, the AGGREGATOR APP_1 may pull notifications and/or updates from the SERVICE PLATFORM_1 based on a schedule (e.g. periodic polling for updates, etc.) or by a request by the user (e.g. user opens application and requests an update, etc.).

In another embodiment, the OS/PLATFORM NATIVE UTILITY may take information and/or ad and/or content provided by the AGGREGATOR APP_1 and display and/or play it in some manner on the mobile device. For example, in one embodiment, the OS/PLATFORM may display the information and/or ad and/or content on a locked screen, on a homescreen, in a widget, on an advertising pane of an application, and/or display it in any other manner. In other embodiments, the OS/PLATFORM may play the information and/or ad and/or content, including playing an audio file, playing a video file, and/or playing the information and/or ad and/or content in any manner.

In a separate embodiment, the OS/PLATFORM NATIVE UTILITY may use the information and/or ad and/or content in a different manner. For example, in one embodiment, the user may wish to rent and watch a video. The information and/or ad and/or content may be displayed as a trailer before the start of a video, at selected intervals throughout the video, and/or at the conclusion of the video. In such an embodiment, the user may opt to pay a higher rental price to view the video without any ads and/or content. In a separate embodiment, the information and/or ads and/or content may be based on what is being viewed (e.g. if the movie Harry Potter was playing, the ads may relate to the Harry Potter books, or to planning a vacation to Universal Studios' The Wizarding World of Harry Potter, etc.).

In another embodiment, the OS/PLATFORM NATIVE UTILITY may use the information to facilitate the lowering of mobile device prices. For example, in one embodiment, the OS/PLATFORM NATIVE UTILITY may display ads on the device (e.g. locked screen, screensaver, etc.) to lower the total price charged for the mobile device. In such an embodiment, service platforms may work in conjunction with product developers and manufacturers to more effectively lower mobile device prices. Further, in such an embodiment, the user may be presented from controlling and/or altering what is displayed. In various embodiments, however, the user may interact (e.g. purchase and/or buy what is being displayed, go to site associated with the content, indicate “less relevant,” etc.) with the display information and/or ads and/or content.

As shown, Ad/Content Provider App 2218 (e.g. AD/CONTENT PROVIDER_1 APP_A, AD/CONTENT PROVIDER_2 APP_B, AD/CONTENT PROVIDER_N APP_N, etc.) is in communication with the OS/PLATFORM NATIVE UTILITY 2222. Additionally, the Ad/Content Provider App 2218 may be in communication with the SERVICE PLATFORM_1 2216, or may be in communication with any number of Ad/Content Provider Apps 2220.

In one embodiment, the Ad/Content Provider App may be a downloaded program the user downloaded and installed. In another embodiment, the Ad/Content Provider App may be an application predownloaded and installed on the mobile device. In one embodiment, the user may be permitted to alter and/or adjust the settings for each installed application. For example, in one embodiment, the Ad/Content Provider App may relate to coupons and/or discounts. In such an embodiment, the user may be permitted to set permission levels (e.g. ability for the application to track the user, store user history, communicate with other applications on the mobile device, etc.), data polling (e.g. ability to receive push notifications from the app developer, periodic polling for updates, etc.), notifications (e.g. frequency of notifications, type of notifications, etc.), desired discounts and/or coupons (e.g. refined targeting of content, etc.), and/or any further settings relating to the Ad/Content Provider App.

In one embodiment, the settings relating to the app may be preset and/or downloaded from an online database system. For example, if the Ad/Content Provider App related to a digital music streaming service, the user may have already registered through an online portal (e.g. online web account, etc.). In such an embodiment, when the user downloads and installs the Ad/Content Provider App and logs into the app, the settings already set through the online portal may be automatically downloaded and applied to the app. For example, preselected playlists, focus of advertisements, user history, preferences (e.g. display, genre of music, etc.), and any other personalized settings may all be downloaded and applied to the mobile device. In this manner, the user may not have to reenter information, including settings, already entered through an online portal system.

In one embodiment, an Ad/Content Provider App may be in communication with one or more Ad/Content Provider App(s). In such an embodiment, the Ad/Content Provider App may receive information from one or more Ad/Content Provider Apps or may provide information to one or more Ad/Content Provider Apps. For example, in one embodiment, the Ad/Content Provider App may relate to an entertainment application (e.g. movies, concerts, etc.). The Entertainment App may receive information from other Ad/Content Provider Apps information relevant to the user. For example, in various embodiments, from a calendar app, the Entertainment App may discover the user has an upcoming musical event; from a social networking app, the Entertainment App may discover that the user is planning on attending the event with two friends, and that the user recently also broke a foot; from a business management app, the Entertainment App may discover that the user has an appointment until two hours before the event; from a restaurant app, the Entertainment App may discover the user has a preference for hamburgers. In one embodiment, based off of all of the relevant information from the apps on the mobile device, the Entertainment App may display and/or present (e.g. audio, video, etc.) relevant ads and/or content to the user (e.g. display driving directions on how to get to the event on time, the parking lot that is closest to the event center, a reminder that one of the friends who will be attending the event has a birthday coming up, etc.). In this manner, the Entertainment App may provide more relevant ads and/or content to the user of the mobile device. Of course, the Ad/Content Provider App may obtain the information from any source and/or may present the information in any manner.

In another embodiment, the Ad/Content Provider App may receive further information from a service provider. For example, in one embodiment, the Ad/Content Provider App may deal with sports. In such an embodiment, the Sports App may communicate with a service provider, including, for example, a social media provider. The Sports App may post information (e.g. predicted score cards, real time updates of what the user is watching, etc.) directly to the social media provider. The social media provider may also provide the Sports App with relevant information (e.g. user preferences, time of day the user prefers to watch sports, the type of sports the user prefers, etc.). In one embodiment, based off of information received from the social media provider, the Sports App may present more relevant information and/or content to the user (e.g. time of next relevant sports event, tickets to a local sports event, gathering of friends to watch a sports event, etc.). In this manner, the Sports App may be able to present more relevant content and/or ads to the user.

In one embodiment, an aggregator app (e.g. AGGREGATOR APP_1, AGGREGATOR APP_2, etc.) may provide relevant ads and/or content to the user, including recommending downloading an Ad/Content Provider App. For example, in one embodiment, the aggregator app may be associated with a CRM service platform. The aggregator app may recommend (as displayed via the OS/PLATFORM NATIVE UTILITY, etc.) to the user to download a relevant app relating to conducting a multi-user business conference call. After downloading and installing the business conference call app, the business conference call app may remain in communication with the OS/PLATFORM NATIVE UTILITY as well as the CRM service platform. In this manner, the user may more easily expand the set of services which may interact with the CRM service platform. Of course, the business conference call app may receive information from the CRM service platform, which also may be used to present more relevant ads and/or content to the user. In a further embodiment, the user may alter and/or determine the level of permissions granted to each application (e.g. restrict grant of access of the business conference call app to the CRM service platform, etc.). Of course, the permissions and/or settings may be altered in any manner by the user.

In one embodiment, the Ad/Content Provider may be associated with a marketing agency (e.g. management of ad campaigns, etc.). In another embodiment, the Ad/Content Provider may be associated with a smaller entity (e.g. single business, etc.). In one embodiment, the Ad/Content Provider may develop ads to be sent to the Service Platform (e.g. be deployed, etc.). In another embodiment, the Ad/Content Provider may use resources (e.g. self-help ad creation, etc.) associated with the Service Platform to create, deploy, and manage an ad.

In a further embodiment, a service platform (e.g. SERVICE PLATFORM_1, SERVICE PLATFORM_2, etc.), an aggregator app (e.g. AGGREGATOR APP_1, AGGREGATOR APP_2, etc.), an ad/content provider app (e.g. AD/CONTENT PROVIDER_1 APP_A, AD/CONTENT PROVIDER_2 APP_B, etc.), and/or an OS/PLATFORM NATIVE UTILITY may restrict the manner and/or type of ads and/or content which may be displayed. In a separate embodiment, the user may globally restrict (e.g. overarching settings, settings which are replicated for each app and/or platform and/or utility, etc.) the manner and/or type of ads and/or content which may be displayed. In a separate embodiment, the user may grant permission to another user to restrict the manner and/or type of ads and/or content which may be displayed. For example, in one embodiment, the mobile device may belong to a company and the user may be permitted use of the mobile device with ad and/or content restrictions set by the company. In another embodiment, the user of the mobile device may trust a social contact and grant the contact permission to engage with the user in some manner (e.g. push apps to be installed on the user's mobile device, modify settings to permit a specific app, platform, and/or utility to display ads and/or content more easily, etc.). In some embodiments, an indicated level of trust (e.g. as set by the user, etc.) may determine the level of permission another entity (e.g. company, friend, etc.) has to interact with the user's mobile device.

Thus, other service platforms (e.g. social network platforms, Internet search platforms, e-wallet platforms, etc.) may “plug-in” their platform to the OS/platform 2222 such that the ads/content that normally are provided by other/already-established service platform-related ad/content providers, e.g. 2208-2210, etc. and accessible (e.g. pushed/pulled, etc.) via such service platform app(s)/service(s), are now accessible via the OS/platform 2222 using any of the presentation techniques disclosed herein with reference to the other figures. As an option, this may (or may not be) accomplished without necessarily having to generate a dedicated/separate application (e.g. 2218, 2220, etc.) that works directly with the OS/platform 2222. For example, in one optional embodiment, the aggregator applications (e.g. 2212, 2214, etc.) may, in a way, appear to the OS/platform 2222 as a dedicated/separate application (e.g. 2218, 2220, etc.), but actually operate as a conduit between the service platforms and the OS/platform 2222, for presentation of ads/content from service platform-related ad/content providers (e.g. 2208-2210, etc.). To this end, the service platforms may charge for (or otherwise monetize) more ad/content “impressions” directed to the users of their service platforms, by accessing ad/content “impression” opportunities that are available via the OS/platform 2222. Of course, the OS/platform may also charge for (or otherwise monetize) such “impression” opportunities.

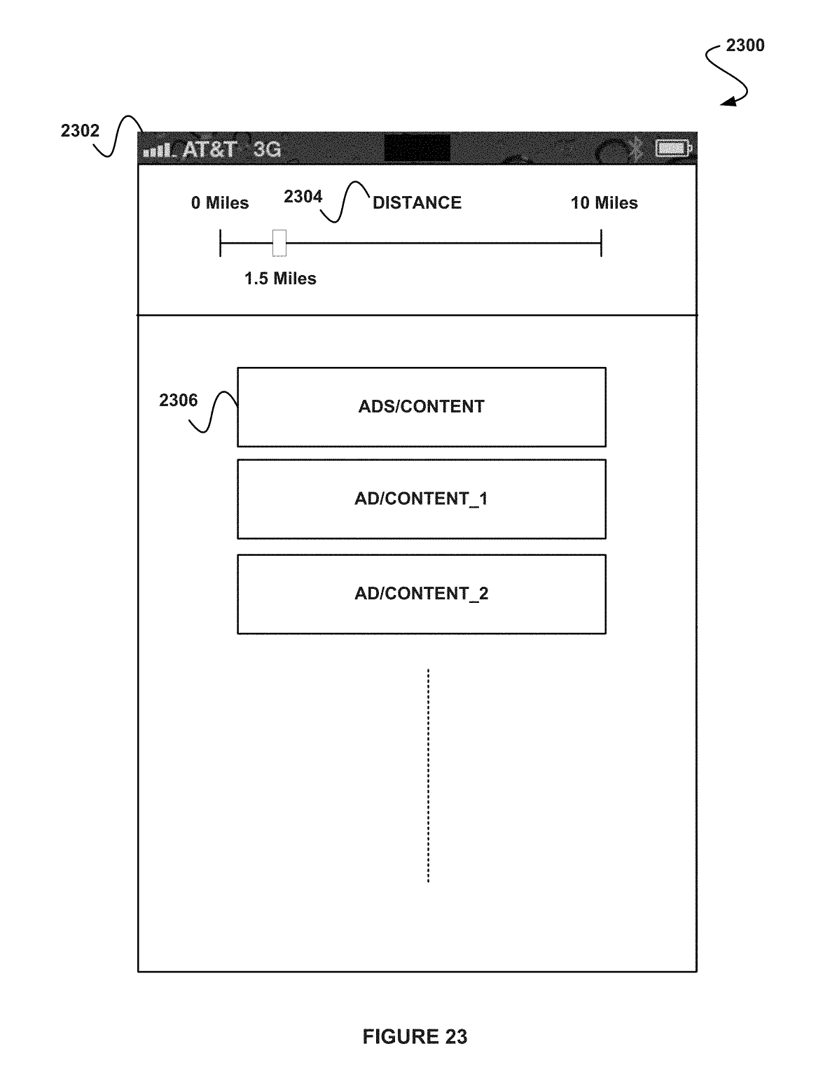

FIG. 23 shows a mobile device interface 2300 for configuring advertisement/content related notifications, in accordance with another embodiment. As an option, the mobile device interface 2300 may be implemented in the context of the architecture and environment of the previous Figures and/or any subsequent Figure(s). Of course, however, the mobile device interface 2300 may be implemented in the context of any desired environment. It should also be noted that the aforementioned definitions may apply during the present description.

As shown, a status bar 2302 is displayed. A sliding bar 2304 alters the distance which may trigger advertisement/content related notifications. Additionally, a number of individual ads/content 2306 may be displayed based on a current setting of the sliding bar 2304.

In one embodiment, the user may modify the sliding bar by sliding the bar to the right (e.g. to increase the distance, etc.) or to the left (e.g. to decrease the distance, etc.). In another embodiment, the distance may relate to the amount of distance from the user of various locations associated with ads and/or content that are available for display on the mobile device. In one embodiment, the distance settings may provide a range from the current GPS location. For example, in one embodiment, a user may set the sliding bar to 1.5 miles distance. In response, the user mobile device may receive ads and/or content associated within 1.5 miles of the user's current position.

In another embodiment, the distance sliding bar may be accomplished utilizing location obfuscation. To accomplish this, an exact location of the user may be approximated by employing a technique to alter, substitute, generalize, and/or modify in any manner a user's location. In some embodiments, the location obfuscation may relate to settings associated with privacy (e.g. user's desire for greater privacy may increasingly obfuscate the GPS location, etc.). Of course, any technique may be employed (e.g. spatial cloaking, invisible cloaking, adding noise, rounding location based off of landmarks, etc.) to obfuscate the location of the user. In one embodiment, the distance sliding bar may control the level of location obfuscation. In another embodiment, the location obfuscation may be controlled by a separate sliding bar (or any other mechanism to set and/or control the location obfuscation). By generalizing/obfuscating the actual exact location, a number/amount of ads/content 2306 may be selectively increased since a larger (more generalized) location set may trigger more of the particular location coordinates (associated with the locations) that corresponding to the ads/content 2306.

Thus, the location resulting from the location obfuscation may be used to falsely trigger ads and/or content. For example, in one embodiment, a user may be in a specific location, but based off of the location obfuscation, may appear to be geographically closer to a location (e.g. store, mall, etc.) than otherwise (e.g. precise location may prevent the ad/content from being triggered, but based off of location obfuscation the user's location may falsely appear to be closer to a location and thereby trigger ad/content, etc.). Of course, this technique may have other ancillary benefits (e.g. privacy, etc.) as well.

In another embodiment, one or more developers of an application may be granted varying permissions to the location of the mobile device. For example, in one embodiment, the user of the mobile device may grant downloaded and installed applications permission to view the exact location of the user. In one embodiment, the user may have downloaded an application relating to Walmart. The user may have also granted permission to the application to use the user's current precise location. Based off of the precise location of the user, the Walmart Application may know when the user is approaching (or within a set proximity of) one or more stores, which may trigger ads and/or relevant content (e.g. deals, coupons, new featured items, etc.) to be displayed on the device.

In other embodiments, the user of the mobile device may grant non-downloaded and non-installed applications permission to view the location of the user based on location obfuscation. For example, based off of the obfuscated location, a nearby business may seek to display a request for the user to download and install an application associated with the business. In another embodiment, based off of the obfuscated location, a nearby restaurant may seek to display a lunch specials menu on the user's mobile device.

In another embodiment, the distance sliding bar may be used to discover ads and/or content that is near the user. In one embodiment, based off of the distance set by the user, a “lite” version of an application may be downloaded and temporarily installed to the mobile device. For example, in one embodiment, based off of the obfuscated location, the user may be geographically near a clothing shop. The clothing shop may display an ad and/or content on the user's device which mimics a full application associated with the clothing shop. For example, the full application associated with the clothing shop may have various sections dealing with new clothing recently received, tips on how to dress, coupons and deals, location and contact info, etc. The lite version of the application may include a display featuring one coupon and/or deal as well as the contact information for the store. The lite version may also indicate that more coupons/deals and/or features may be obtained by downloading a full version of the application. As such, the displayed ad and/or content may function as a “lite” version of the application available for download and installation.

In another embodiment, based off of the obfuscated location, the user may be geographically near a concert hall. The concert hall may display an ad and/or content on the user's device which mimics a full application associated with the concert hall. For example, the full application associated with the concert hall may include sections dealing with upcoming events, ability to purchase tickets, ability to receive real-time updates relating to the event, coupons and/or deals, social media integration, location and contact information, etc. The lite version of the application may include a display featuring an upcoming event, the location and contact information, and/or a link to download the application to have greater functionality. As such, the displayed ad and/or content may function as a “lite” version of the application available for download and installation.

Of course, in various embodiments, the “lite” version of an application may be a static ad and/or content (e.g. an image of the application, etc.), a multimedia file (e.g. video, photo, slideshow, etc.), an executable file (e.g. executed by the mobile device, etc.), and/or any other type of data file relating to the application.

In one embodiment, the user of the mobile device may apply settings relating to testing out an application and/or a “lite” application. For example, in one embodiment, the user may grant a temporary permission to try out a lite app, including permit the lite app to be downloaded and temporarily installed (e.g. temporary cache, etc.) onto the mobile device. In one embodiment, the application and/or lite app may be saved for a predetermined time period (e.g. 30 minutes, etc.) before being automatically deleted from the user's mobile device. Of course, if the user wishes to permanently save the application or lite app, the user may transfer (e.g. user may select “save this app” after trying it out, etc.) the downloaded and installed files to a more permanent file storage location on the mobile device.

In another embodiment, the user of the mobile device may temporarily download and install the application and/or lite app to evaluate the application and/or lite app. In another embodiment, the user of the mobile device may temporarily download and install the application and/or lite app to determine what may be available near to where the user is geographically located. In one embodiment, a lite app may be optimized for viewing (e.g. low data usage, etc.), to encourage the user to download the full application. In another embodiment, the application and/or lite app may have greater functionality unlocked once the user completes a first purchase and/or redemption of a coupon and/or deal. For example, in one embodiment, after downloading and installing an application temporarily, an application may indicate an allocation of a number of redeemable points (e.g. points may be redeemed for value at a store location, etc.). The redeemable points may be unlocked (e.g. used, etc.) after a first purchase and/or coupon and/or deal has been used relating to the application.

In another embodiment, after downloading and installing a restaurant application temporarily, the user may be presented with a first time coupon and/or discount. After redeeming the coupon and/or discount, a frequent flyer tab may be added to the application to track how often the user visits the restaurant, and to reward the user in proportion to the frequency of the visits. In a further embodiment, after downloading and installing a movie theater application temporarily, the user may be presented with information relating to a now playing movie. If the user uses the application in some manner (e.g. buy food with the application, use digital ticket for entry, redeem coupon, etc.), the user may have greater functionality unlocked, including ability to interact (e.g. chat in real time, etc.) with other movie goers at the location, ability to have priority seating (e.g. ability to seat before the general audience seats, etc.), access to a social network page (e.g. account and/or page associated with the movie theater, etc.), ability to give comments and/or ratings, and/or any other further functionality.

In one embodiment, the application and/or lite application may download further enhancements and/or data as needed and/or requested by the user. For example, if the user unlocks the application (e.g. by use, etc.), the application may download additional data for the enhanced functionality.

In another embodiment, the application may be downloaded in batches. For example, in one embodiment, an initial batch of the application may be downloaded which provides basic and/or reduced functionality (e.g. “lite” version of the application, etc.). After using the application for a first time, the application may downloaded an additional batch of data (e.g. to unlock other functionality and/or resources, etc.). Further, as the user continues to use the application, the user may personalize the application by downloading and installing further batches of data (e.g. plugins, personalized settings, etc.). For example, in one embodiment, the mobile device may download and install temporarily an application dealing with household management (e.g. basic ability to connect a smart appliance, ability to redeem a coupon, etc.). After unlocking the additional features of the application (e.g. ability to order up groceries, sync ‘needed’ items list, contact information for local household management stores, etc.) by using the application a first time (e.g. connecting an appliance to the application, redeeming a coupon at a retailer, etc.) a user may wish to download a plugin (i.e. additional batch of data, etc.) relating to remote printing, grocery shopping, energy management, remote light management, remote lock management, remote sound management, repairs, etc. Of course, the plugin may relate to any aspect associated with household management application.

In one embodiment, the ads and/or content may relate to applications already on the phone. For example, in one embodiment, the ads and/or content may relate to a discount (e.g. special offering, last minute savings, incentive for the user to buy something, Happy Hour deal, etc.), new content (e.g. new offerings, new product line, etc.), updates (e.g. new store location, store hours, etc.), member only offers, and/or any feature associated with the application.

In another embodiment, the ads and/or content may relate to a social media site. In one embodiment, the ad and/or content may relate to an application already downloaded and installed on the user's mobile device. For example, in one embodiment, if the user was present at a store, an ad and/or content associated with the store may prompt the user to “like” the store and/or rate the store. In another embodiment, the ad and/or content associated with the store may prompt the user to upload a posting, take a photo, and/or engage with the application and/or store in any manner relating to a social media site. In a further embodiment, if the user was present at a store with several friends, the ad and/or content associated with the store may prompt one or more user(s) to post an event (e.g. activity, friend(s) present, short detail of what occurred, etc.).

In a separate embodiment, a user may be present at the movie theater with some friends. In one embodiment, at the conclusion of the movie, an ad and/or content associated with the movie theater may request the user and/or one or more friend to rate, recommend (e.g. “like,” etc.), and/or interact in some manner with a social media site. Of course, the ad and/or content may be displayed to the user at any time, and in response to any trigger (e.g. time, location, friends, type of movie, ticket, etc.) and/or any event (e.g. movie, concert, athletic event, party, etc.).

In another embodiment, the ad and/or content relating to a social media site may be associated with an application and/or a “lite” application not yet downloaded and/or installed. For example, while within and/or near a store, an ad and/or content associated with the store may prompt the user to give a rating (e.g. “like,” etc.), post a comment, post a photo, share an item (e.g. send a discount/ad with a friend, etc.), and/or interact with a social networking site in any manner, as relating to an ad and/or content associated with the store.

In a further embodiment, the ad and/or content relating to a social media site may be associated with an application and/or a “lite” application temporarily downloaded and/or installed. For example, while within and/or near a store, an ad and/or content associated with the store may prompt the user to give a rating (e.g. “like,” etc.), post a comment, post a photo, share an item (e.g. send a discount/ad with a friend, etc.), and/or interact with a social networking site in any manner, as relating to an ad and/or content and/or an application and/or a “lite” application associated with the store.

In one embodiment, the ad and/or content may be displayed in response to an environment. In various embodiments, an environment may include a WiFi signal, a peer to peer network, a network node (e.g. connection point, etc.), a GPS location, a Bluetooth signal, and/or any type of network and/or interaction of devices. As an example, in one embodiment, a user may enter a Subway or metro, and the user's mobile device may automatically connect to the Internet via an available network node. Based off of the network node, an ad and/or content relating to the geographic area around the network node (e.g. within 5 blocks, etc.) may be pushed to the device. For example, a pizza shop may be located near the network node and may push an ad to the user's mobile device for a lunchtime special, a new location ad, and/or any type of ad and/or content. Upon exiting the Subway or metro, the user's mobile device may automatically switch to another network node, and based off of the new network node, additional ads and/or content may be pushed to the device. Of course, the mobile device may connect to any number of network nodes (e.g. multiple network nodes en route, multiple networks available at a given location, etc.) and/or display any number of ads and/or content based off of the network node.

In another embodiment, the mobile device may connect to any number of networks simultaneously. For example, at a given location, a mobile device may detect multiple network access points. The mobile device may connect simultaneously to each access point, and in response to the connection, receive relevant ads and/or content. In one embodiment, a user may be geographically near multiple stores. Each store may include a separate wireless network and/or access point. The user's mobile device may connect simultaneously to each store and receive relevant ads and/or content.

In one embodiment, the user may request updates and/or pull relevant ads and/or content. For example, when connected to a network node, the user may request to view relevant content and/or ads (e.g. select ad/content native utility app on mobile device, select a refresh ad/content widget and/or window pane, give voice command to view relevant ads and/or content, etc.). In one embodiment, the user may be actively using the mobile device (e.g. read emails, write memo, participate in phone conversation, etc.), and in response, the amount of ads and/or content may be limited and/or restricted in some manner (e.g. ads and/or content may not be displayed while reading/viewing/editing email, ads and/or content may be displayed for a set amount of time, etc.). In response to the limitation and/or restriction in some manner, the ad and/or content may not be displayed immediately, and in some embodiments, may be saved to be displayed at a later opportunity (e.g. time of inactivity on the device, etc.), be displayed at a request by the user (e.g. display missed ads, etc.), be counted (e.g. count of missed ads and/or content, etc.) and displayed on a relevant display (e.g. within the status bar, displayed on the homescreen or locked screen, etc.), and/or may be saved to be displayed on the mobile device in any manner.

In another embodiment, filters may be applied to ads and/or content that are seeking to be displayed (e.g. queue of ads and/or content, batch download of ads and/or content, ads and/or content which are pushed, etc.), to ads and/or content that are requested (e.g. ads and/or content which are pulled by the user, etc.), and/or to any type of ads and/or content designed to be displayed on the mobile device. In such an embodiment, filters may be applied automatically (e.g. preset filters, etc.) or manually (e.g. at the time the ads and/or content are displayed, etc.). In various embodiments, the filters may include dropdown criteria (e.g. genre of ads to be displayed, etc.), a sliding bar criteria (e.g. price, etc.), clickable boxes (e.g. star ratings, etc.), custom fields to be applied, and/or any interaction whereby a user may select a filter criterion.

Further still, in one embodiment, the user may select how to view the ads and/or content. In various embodiments, the ads and/or content may be arranged by genre (e.g. clothing, hotels, food, household, etc.), by the date and/or time received (e.g. most recent is shown first, etc.), in a list format (e.g. hierarchy style folders, etc.), in a stackable tab format (e.g. each tab may represent an ad and/or content and stack on top of another tab, with a small portion of each tab [or the most recent, e.g., 5 ads] displayed, and the most recent tab displayed in greater size, etc.) and/or by any criteria. In one embodiment, the arrangement and/or view of the ads may be determined by the user (e.g. in the settings of the application, in the settings of the OS/platform native utility, etc.). In another embodiment, the arrangement and/or view of the ads may be set and/or maintained by the developer of the application.

In one embodiment, the user may request (e.g. pull ads and/or content, etc.) ads and/or content based on the user's current location (e.g. determined by GPS, network node, other connected devices, surrounding devices and/or landmarks, etc.). The ads and/or content downloaded to the mobile device may then be filtered. The user may select to view only ads within a price range of $0-$10, within a 4 block walking radius, which relate to a source which is open immediately, and which pertain to giving a gift. The ads and/or content which pertain to such a criteria will then be displayed to the user. In one embodiment, the user may flip through the ads and/or content (e.g. side to side, top to bottom, etc.), select an ad and/or content from a group (e.g. all or part of all of the ads and/or content may be displayed in a list, as graphical objects [e.g. bubbles, etc.], as preview thumbnails, as magazine style panes, etc.), view a slideshow (e.g. ads and/or content are displayed each for a set time period, e.g. 2 seconds, etc.), and/or select an ad and/or content in any manner.

In another embodiment, the ad and/or content may provide a prompt based on a trigger. In one embodiment, a prompt may include a text string (e.g. limited to 200 characters, etc.), a graphic (e.g. photo, etc.), and/or an object which may be presented to the user of the mobile device in a more unobtrusive manner. For example, in one embodiment, a user of a mobile device may enter a geographic threshold of a location (e.g. store, restaurant, etc.), which may trigger a text prompt such as “Welcome to Cabelas. Would you like to check-in to this location?” If the user responds “yes” (e.g. by selecting a “yes” option, giving a voice command “yes,” etc.), then the mobile device may automatically post a check-in to a social network site. Additionally, an additional text prompt may be presented to the user, including “Thank you for checking-in. Would you like to preview the Cabelas app? Please note that 1 deal is available in the preview app, and 5 deals are available in the actual app.” Of course, any text and/or graphic may be presented to the user in any order with any type of options and/or commands.

In a separate embodiment, in one embodiment, a user of a mobile device may have an event scheduled, which may trigger a text prompt (given at some time before the event) “You are scheduled to attend the Keith Urban concert. Would you like to post a check-in to this concert as well as indicate your friends which are present?” If the user responds “yes” (e.g. by selecting a “yes please check in” option, giving a voice command “yes please check in,” etc.), then the mobile device may automatically post a check-in to a social network site. Additionally, if the user selects to indicate which friends are present, the user may manually enter and/or select the friends. In another embodiment, the user device may automatically determine which other devices are near the user and identify the users based on the determination, and then post the indication of friends. Of course, any text and/or graphic may be presented to the user in any order with any type of options and/or commands.

In one embodiment, the ad and/or content may relate to deliveries. For example, in one embodiment, the user of the mobile device may receive updates relating to the delivery, including a notification of when the delivery left a facility, when the delivery is near to arriving at a destination, and/or any other notifications relating to the delivery. In one embodiment, the delivery may relate to a pizza delivery. The user may receive a notification of when the pizza delivery arrives at the location. In another embodiment, the user may request real-time updates of the status of the delivery (e.g. location update, etc.). In one embodiment, after the pizza arrives at the intended destination, the user's mobile device may display a payment screen whereby the user may pay for the pizza. Additionally, tip and/or any other extra expenses may be added on to the total bill and paid for using the user's mobile device. In one embodiment, the delivery person's mobile device may come equipped with NFC (or any other type of wireless communication, etc.) to enable transfer of funds from the user's account to the delivery person's account. In another embodiment, the user's mobile device may be used to transfer funds to a central server which then allocates funds to the intended target (e.g. delivery person's company, etc.).

In one embodiment, reoccurring events and/or charges may be automatized. For example, in one embodiment, a user may be a frequent customer of Pizza Hut. The user may have inputted payment and/or billing information at least one time into an application associated with Pizza Hut, and/or into a OS/platform native utility. Based off of saved payment information, the user's mobile device may recognize a reoccurring event (e.g. same restaurant, etc.) and automate payment (e.g. when the pizza is confirmed to have arrived, the application and/or OS/platform native utility may transfer the funds from the user's account to Pizza Hut, etc.). Of course, in one embodiment, the mobile device may recognize and/or identify reoccurring charges and/or events and prompt an action (e.g. approve automatic payment, check-in to location, etc.) in response. In another embodiment, the user may set up (e.g. via settings, via OS/platform native utility, etc.) automatic payments and/or actions (e.g. payments, check-in, etc.). Of course, any action may be automatized by the user.

In one embodiment, the user may input a destination (e.g. location address, etc.) to which to navigate. In one embodiment, the directions may offer alternatives to the user. For example, in various embodiments, the directions may indicate the fastest route, least amount of mileage, least amount of freeways and/or side streets, and/or alternative routes based on relevant content and/or ads such as restaurants and/or food stops, gas prices, notable detours (e.g. tours, etc.), and/or any location which may be relevant to the user. In such an embodiment, the alternative routes may display ads and/or content as predefined by the user (e.g. types and/or genres of ads and/or content, time of notification, preference for detours, etc.). In one embodiment, the user may be presented with approximate time to destination including time for the detour (e.g. fastest time may indicate 32 minutes to destination whereas alternative route 2 may indicate 45 minutes to destination including detour, etc.). In another embodiment, traffic conditions may trigger additional alternatives. For example, if current traffic conditions indicate 45 minutes until arrival at the destination, a detour which would only add an additional 5 minutes may be triggered for a user who has a preference of not increasing the total time more than 15%.

In a further embodiment, alternative routes may also be based on the total number and/or identity of individuals with the user. For example, in one embodiment, the user may set up a trigger so that if the user is in the car at a meal time (e.g. 5:00 pm, etc.), a notification is displayed which takes into account the user's current location, the destination location, the number of individuals in the car (e.g. based off of device discovery, etc.), and the food preference(s) of the user and/or at least one individual (e.g. based off user inputted food preference, food preference as indicated on social networking site, etc.).

In another embodiment, a destination may not be inputted but the mobile device may still determine a likely destination. In various embodiments, the likely destination may be determined by using vector based location (e.g. probable destination based on vector trajectory, etc.), identifying a reoccurring event (e.g. dry cleaners, car wash, bank, concert, etc.) and/or location (e.g. work, home, friend's home, family relative home, etc.), applying information received in a message (e.g. digital ticket sent to email and/or mobile device application, coupon received, etc.), applying information from a calendar application, and/or applying information from any application and/or any other source. In another embodiment, a user may have downloaded and/or received a geotag (e.g. associated with a photo, etc.), and based on the received geotag the mobile device may determine the likely destination of where the user is heading. Of course, the mobile device may use any mechanism to determine the user's destination.

Still yet, in another embodiment, once the mobile device determines a likely destination, the mobile device may prompt the user to confirm the location. For example, in one embodiment, a text prompt may state “Are you traveling to [likely destination]?” The user may confirm by selecting “Yes” and/or giving a voice command “yes.” In another embodiment, if the user does not respond (e.g. by text and/or voice, etc.) within a set amount of time (e.g. 10 seconds, etc.), the mobile device may assume that the address has been confirmed.

In many embodiments, once a likely destination is determined, alternative routes associated with a relevant ad and/or content may also be presented to the user. For example, in one embodiment, a likely location may be determined (e.g. by reoccurring location and/or vector based location, etc.) to be a family relative's house. Based off of the likely location and the accompanying recommended route, the mobile device may also present alternative routes associated with relevant ads and/or content. For example, in one embodiment, it may be determined that the user is traveling to grandma's house. Based off of the confirmed likely destination, a notification may prompt the user that grandma's birthday is coming up, as well as indicate possible gifts (applying filters as set by the user, etc.) that the user may pick up for grandma en route. Of course, the alternative route may be presented to the user in response to any notification (e.g. birthday, etc.), event (e.g. business meeting, etc.), and/or preference set by the user (e.g. preference for 50% deals, etc.).

In one embodiment, a likely destination may be associated with a food truck. For example, in one embodiment, based off of the current location of the food truck (and reoccurring locations, etc.), it may be determined where the food truck will be positioned, along with the approximate time that the food truck will arrive. Users who are interested in the food truck may receive a notification of where and when the food truck will arrive (e.g. based off of user notification settings, etc.). In another embodiment, the driver of the food truck may confirm a location on a mobile device associated with the driver of the food truck.

In one embodiment, time may be used to trigger and/or restrict an event and/or a notification. For example, in one embodiment, a time to a location (e.g. an extra 30 minutes to the destination, etc.) may trigger to display an ad and/or content relative to the user's location and/or intended location. In another embodiment, a time of day may be used to trigger an ad and/or content, including reoccurring events (e.g. tea every day at 3:30 pm, etc.), normal wake up time (e.g. alarm, etc.), break time (e.g. 11 am for 15 minutes, lunch break at 12:30 pm, etc.), and/or any other event relating to time. In other embodiments, time may restrict the display of ads and/or content. For example, if a user was late to an appointment, relevant ads and/or content may not be displayed as the user would not have time to view and/or respond to such ads and/or content. In another embodiment, the time of day may restrict ads and/or content based off of what the user may be expected to be doing (e.g. busy during appointment, nighttime sleeping, etc.). In various embodiments, time may be used to restrict the ads and/or content displayed based on the amount of available free time (e.g. traveling, a break, etc.) the user has.

In some embodiments, time may override location based triggers for ads and/or content. For example, an ad and/or content may be displayed based on a location (e.g. via network node, GPS, etc.). However, a mobile device may recognize that the user is late to an appointment, in which case time may be used to override the location based triggers. Of course, any type of factors (e.g. ETA, traffic conditions, designation in calendar as available or busy, etc.) may be used to restrict the displayed ads and/or content and/or override the location based triggers. In one embodiment, if time overrides the location based triggers, the ads and/or content which were restricted may be saved for a later viewing and/or further filtered. For example, in one embodiment, ads and/or content may be filtered (e.g. removed from the saved files, etc.) based on time-sensitive ads and/or content (e.g. Lunch Specials for the next hour, etc.), off-location viewing preferences (e.g. user may set preferences of what types of ads and/or content to save if it/they cannot be viewed in the pertinent location, etc.), and/or any other type of settings and/or relevancy criteria.

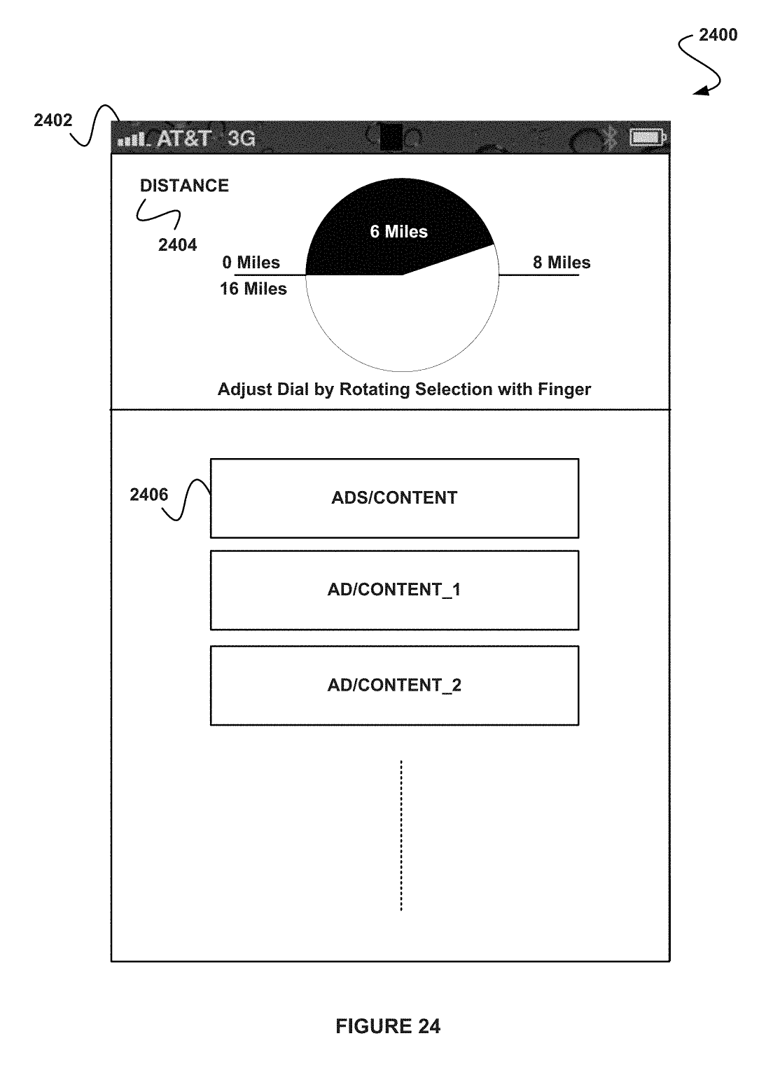

FIG. 24 shows a mobile device interface 2400 for configuring advertisement/content related notifications, in accordance with another embodiment. As an option, the mobile device interface 2400 may be implemented in the context of the architecture and environment of the previous Figures and/or any subsequent Figure(s). Of course, however, the mobile device interface 2400 may be implemented in the context of any desired environment (particularly with respect to FIG. 23). It should also be noted that the aforementioned definitions may apply during the present description.

As shown, a status bar 2402 is displayed. A rotating dial 2404 alters the distance which may trigger advertisement/content related notifications. Additionally, individual ads/content 2406 may be selected to individually modify the distance trigger.

In one embodiment, a rotating dial may be used to alter the distance which may trigger the ads and/or content. In other embodiments, a voice command may be used to alter the distance (e.g. “set distance to 6 miles,” “increase distance,” etc.), a column and/or bar graph may be altered (e.g. pull up or down bar to adjust distance, etc.) where each column represents a different ad and/or content, an input number field for each ad and/or content may be displayed and/or altered (e.g. selecting the field may allow the user to input the distance, etc.), and/or any feature where the distance may be set and/or altered which may trigger advertisement/content related notifications.

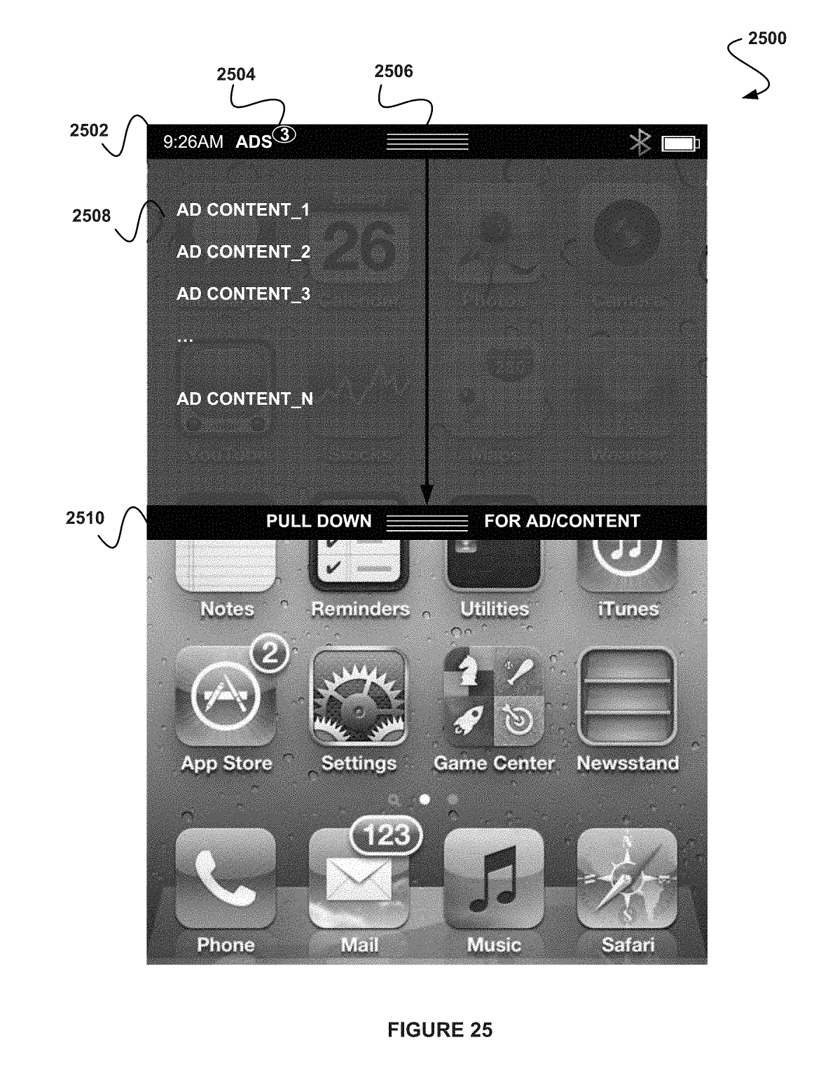

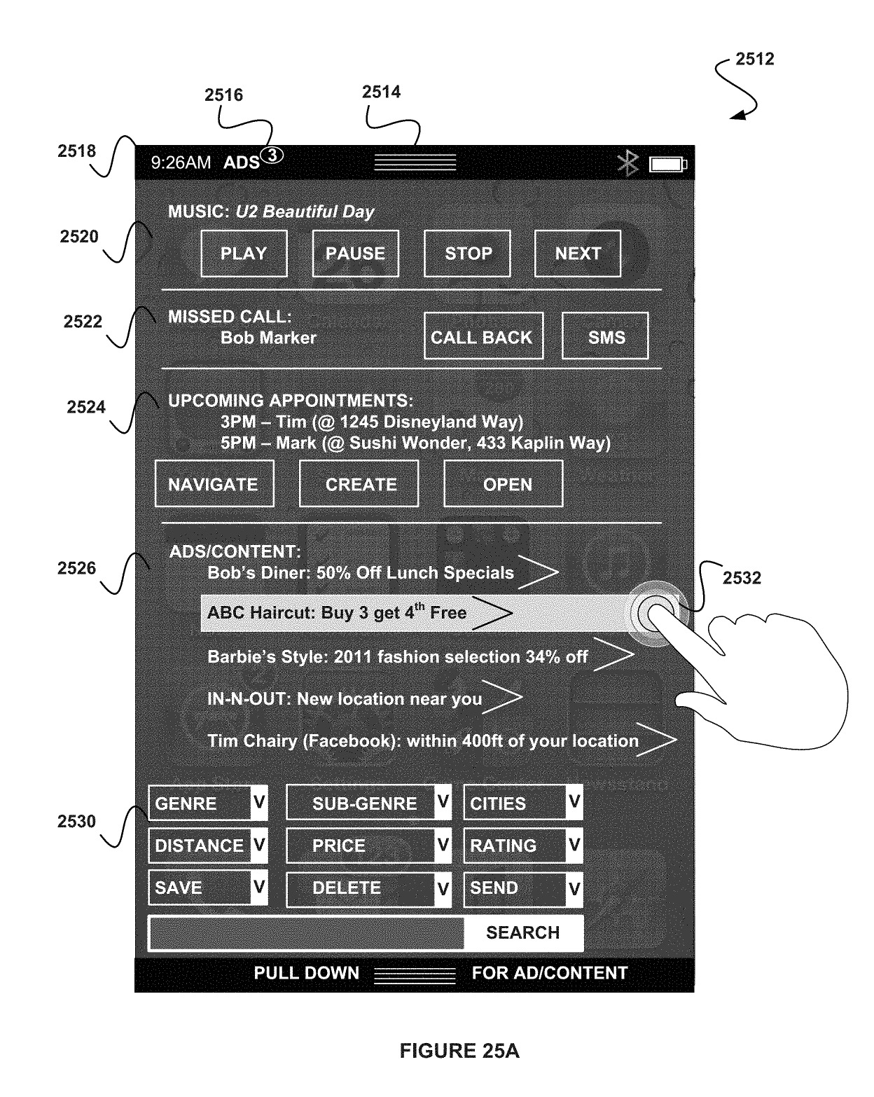

FIG. 25 shows a mobile device interface 2500 for interacting with advertisement/content related notifications, in accordance with another embodiment. As an option, the mobile device interface 2500 may be implemented in the context of the architecture and environment of the previous Figures and/or any subsequent Figure(s). Of course, however, the mobile device interface 2500 may be implemented in the context of any desired environment. It should also be noted that the aforementioned definitions may apply during the present description.

As shown, a status bar 2502, an ad and/or content ticker 2504, a pull down bar 2506, and a pulled-down bar 2510 are displayed. Additionally, individual ads and/or content 2508 may be displayed and/or selected.

In various embodiments, a status bar may be displayed on a locked screen, on a homescreen, on a screen associated with an application, and/or any screen and/or display associated with the mobile device. In one embodiment, the status bar may automatically hide when not in use. In another embodiment, the status bar may be displayed (e.g. from a hiding state, etc.) by swiping down on the screen, and/or performing an action to trigger display of the status bar. In one embodiment, the status bar may display any information (e.g. weather, battery status, network status, mobile carrier status, time, date, etc.), which, in other embodiments, may be customized and/or modified by the user (e.g. via mobile device settings, etc.).

In one embodiment, an ad ticker may be displayed which may indicate a number of new ads and/or content (e.g. act as an alert and/or notification, etc.). In one embodiment, the ad ticker may count a total of new ads and/or content received. In other embodiments, the ad ticker may count a total of filtered new ads and/or content received. For example, in one embodiment, a mobile device may have received 10 new ads and/or content. The mobile device may apply filters (e.g. as set by the user, automatically determined by the user's interests and/or preferences, etc.) to the received new ads and/or content so that only 3 new ads and/or content are passed on to the user. Of course, filters may be applied to the new ads and/or content at any stage, including before they are received by the user device (e.g. managed by a cloud service, etc.), as they are received by the user device, and/or at any time after they are initially sent and/or pushed by the ad/content sender. In one embodiment, if the ads and/or content are requested (e.g. pulled, etc.), the filters may be applied whenever the ads and/or content are requested.

In another embodiment, the ad ticker may be associated with a secondary means of notification. For example, in one embodiment, when a new ad and/or content is received, the mobile device may vibrate and/or buzz, play a ringtone or sound, and/or take any further action to notify the user of a new ad and/or content. In one embodiment, the notification may be associated directly with the incoming new ad and/or content. For example, in one embodiment, a new ad and/or content associated with Walmart may play the sound file “New Walmart Deal,” vibrate in three 2 second intervals (or for whatever length of time as determined by the user, etc.), and/or give any other type of notification and/or alert. In one embodiment, if the new ad and/or content is of a sufficient priority (e.g. based on user settings, etc.), a service (e.g. associated with the sender, associated with the OS/platform native utility, etc.) may call the user's mobile device with a prerecorded message indicating the new ad and/or content. In another embodiment, a SMS message may be sent in response to a receipt of a new ad and/or content. Of course, any type of notification and/or alert may be used to notify the user of a new ad and/or content.

In another embodiment, an ad ticker may count the number of new ads and/or content based on manually entered criteria and/or preferences associated with the user, including settings relating to interest categories, genres, price range, time of applicability (e.g. redeem now, etc.), etc. In other embodiments, the criteria and/or preferences may be based on automatic settings. For example, in one embodiment, the mobile device may determine that the user has a preference (e.g. via email, message, social networking site, postings, user browsing history, etc.) for world food, within a price range of $5-15 and count ads and/or content that relate to these categories.

In another embodiment, more than one ad ticker may be displayed. For example, in various embodiments, a first ad ticker may be associated with priority new ads and/or content (e.g. based off of top manual or automatic preferences associated with the user, etc.). A second ad ticker may be associated with general new ads and/or content (e.g. ads which are classified as non-priority but are also determined to be relevant, etc.).

In one embodiment, the ad ticker may be displayed on the status bar. In various other embodiments, the ad ticker may be displayed as a widget on a display screen (e.g. one or more home screens, etc.), as an overlay screen (e.g. top left hand corner of the display may indicate number of new ads and/or content regardless of the program being used, etc.), as part of an application button (e.g. corner of button displays number of new ads and/or content, etc.) and/or in or as an object on any portion of the display.

In some embodiments, a pull down bar may be displayed in a status bar. In other embodiments, a pull down bar may not need to be displayed. For example, an action (e.g. swipe down on the screen, hold down pre-selected location for set time period, etc.), a voice command (e.g. “show ads and/or content,” etc.), a trigger (e.g. unlocking screen of device, clicking the home button twice, etc.), and/or any action and/or feature may be used to control the pull down bar (or simply display the contents thereof in any context). Additionally, in another embodiment, the pull down bar may be accessed and/or controlled from any application, screen, and/or display associated with the mobile device. In one embodiment, the pulled down bar may be used to display the number of new ads and/or content (e.g. as an alternative to displaying them on the status bar, etc.). In another embodiment, the pulled down bar may be minimally displayed (e.g. when the user pulls down the pull down bar, the pulled down bar may be a simple narrow horizontal line, etc.).

In one embodiment, the ads and/or content may be filtered, including providing buttons to refine and/or select the relevant ads and/or content. For example, in one embodiment, the user may pull the pull down bar to display the ads and/or content. The user may filter and/or refine the displayed ads and/or content by selecting parameters and/or criteria relating to the displayed ads and/or content. In one embodiment, the user may input text into a search field to restrict the ads and/or content to the search text string (e.g. food, Old Navy, etc.).

FIG. 25A shows a mobile device interface 2512 for interacting with advertisement/content related notifications, in accordance with another embodiment. As an option, the mobile device interface 2512 may be implemented in the context of the architecture and environment of the previous Figures and/or any subsequent Figure(s). Of course, however, the mobile device interface 2512 may be implemented in the context of any desired environment. It should also be noted that the aforementioned definitions may apply during the present description.

As shown, a status bar 2518, an ad and/or content ticker 2516, and a pull down bar 2514 are displayed.

In various embodiments, a status bar (and/or any of the content, features, etc. disclosed herein) may be displayed on a locked screen, on a homescreen, on a screen associated with an application, and/or any screen and/or display associated with the mobile device. In one embodiment, the status bar may automatically hide when not in use. In another embodiment, the status bar may be displayed (e.g. from a hiding state, etc.) by swiping down on the screen, and/or performing an action to trigger display of the status bar. In one embodiment, the status bar may display any information (e.g. weather, battery status, network status, mobile carrier status, time, date, etc.), which, in other embodiments, may be customized and/or modified by the user (e.g. via mobile device settings, etc.).

In one embodiment, an ad ticker may be displayed which may indicate a number of new ads and/or content (e.g. act as an alert and/or notification, etc.). In one embodiment, the ad ticker may count a total of new ads and/or content received. In other embodiments, the ad ticker may count a total of filtered new ads and/or content received. For example, in one embodiment, a mobile device may have received/identified 10 new ads and/or content. The mobile device may apply filters (e.g. as set by the user, automatically determined by the user's interests and/or preferences, etc.) to the received new ads and/or content so that only 3 new ads and/or content are passed on to the user. Of course, filters may be applied to the new ads and/or content at any stage, including before they are received by the user device (e.g. managed by a cloud service, etc.), as they are received by the user device, and/or at any time after they are initially sent and/or pushed by the ad/content sender. In one embodiment, if the ads and/or content are requested (e.g. pulled, etc.), the filters may be applied whenever the ads and/or content are requested.

In another embodiment, the ad ticker may be associated with a secondary means of notification. For example, in one embodiment, when a new ad and/or content is received, the mobile device may vibrate and/or buzz, play a ringtone or sound, and/or take any further action to notify the user of a new ad and/or content. In one embodiment, the notification may be associated directly with the incoming new ad and/or content. For example, in one embodiment, a new ad and/or content associated with Walmart may play the sound file “New Walmart Deal,” vibrate in three 2 second intervals (or for whatever length of time as determined by the user, etc.), and/or give any other type of notification and/or alert. In one embodiment, if the new ad and/or content is of a sufficient priority (e.g. based on user settings, etc.), a service (e.g. associated with the sender, associated with the OS/platform native utility, etc.) may call the user's mobile device with a prerecorded message indicating the new ad and/or content. In another embodiment, a SMS message may be sent in response to a receipt of a new ad and/or content. Of course, any type of notification and/or alert may be used to notify the user of a new ad and/or content.

In another embodiment, an ad ticker may count the number of new ads and/or content based on manually entered criteria and/or preferences associated with the user, including settings relating to interest categories, genres, price range, time of applicability (e.g. redeem now, etc.), etc. In other embodiments, the criteria and/or preferences may be based on automatic settings. For example, in one embodiment, the mobile device may determine that the user has a preference (e.g. via email, message, social networking site, postings, user browsing history, etc.) for world food, within a price range of $5-15 and count ads and/or content that relate to these categories.

In another embodiment, more than one ad ticker may be displayed. For example, in various embodiments, a first ad ticker may be associated with priority new ads and/or content (e.g. based off of top manual or automatic preferences associated with the user, etc.). A second ad ticker may be associated with general new ads and/or content (e.g. ads which are classified as non-priority but are also determined to be relevant, etc.).

In one embodiment, the ad ticker may be displayed on the status bar. In various other embodiments, the ad ticker may be displayed as a widget on a display screen (e.g. one or more home screens, etc.), as an overlay screen (e.g. top left hand corner of the display may indicate number of new ads and/or content regardless of the program being used, etc.), as part of an application button (e.g. corner of button displays number of new ads and/or content, etc.) and/or in or as an object on any portion of the display.

In some embodiments, a pull down bar may be displayed in a status bar. In other embodiments, a pull down bar may not need to be displayed. For example, an action (e.g. swipe down on the screen, hold down pre-selected location for set time period, etc.), a voice command (e.g. “show ads and/or content,” etc.), a trigger (e.g. unlocking screen of device, clicking the home button twice, etc.), and/or any action and/or feature may be used to control the pull down bar. Additionally, in another embodiment, the pull down bar may be accessed and/or controlled from any application, screen, and/or display associated with the mobile device. In one embodiment, the pulled down bar may be used to display the number of new ads and/or content (e.g. as an alternative to displaying them on the status bar, etc.). In another embodiment, the pulled down bar may be minimally displayed (e.g. when the user pulls down the pull down bar, the pulled down bar may be a simple narrow horizontal line, etc.).

As shown, a pull down screen includes a section relating to music 2520, missed call(s) 2522, upcoming appointments 2524, ads/content 2526, filters 2530, and a selection 2532.

In one embodiment, a music section may include control buttons to control at least some aspect associated with a music application. For example, the control buttons may include the functions play, pause, stop, next, and/or any control feature associated with the music application. In another embodiment, the pull down display may be accessed from a locked-screen, thereby permitting the user to control at least one aspect of the mobile device (e.g. music playback, etc.). Of course, any function and/or feature may be placed on the pull down display to control and/or interact in some manner with the music application.

In another embodiment, a missed call section may include control buttons to control at least some aspect associated with a phone application. For example, the control buttons may include the functions call back, SMS, note, remind me later, delete, and/or any other feature and/or function which may control at least in part the phone application or any application associated with the phone application (e.g. SMS application, messaging application, etc.). Of course, any function and/or feature may be placed on the pull down display to control and/or interact in some manner with the phone application.

In one embodiment, an upcoming appointments section may include control buttons to control at least some aspect associated with a calendar application. For example, the control buttons may include the functions to navigate (e.g. to a location associated with a scheduled appointment, etc.), create (e.g. a new calendar item, etc.), open (e.g. open the selected calendar item, open the calendar application, etc.), reschedule (e.g. a listed calendar item, etc.), and/or any other function and/or feature which may control at least some aspect of the calendar application. In one embodiment, a user may individually select a calendar item to display features and/or additional features (e.g. modify item, send reminder to participants, etc.).

In another embodiment, an ads/content section may include a list of possible ads and/or content. For example, in one embodiment, the ads and/or content displayed may be pre-filtered based off of preferences, settings, and/or criteria associated with the user (e.g. inputted manually or automatically gathered by the mobile device, etc.). In various embodiments, examples of the ads and/or content may include “Bob's Diner: 50% Off Lunch Specials,” “ABC Haircut: Buy 3 get 4^{th} Free,” “Barbie's Style: 2011 fashion selection 35% off,” “IN-N-OUT: New location near you,” “Tim Chairy (Facebook): within 400 ft of your location,” and/or any type of relevant ad and/or content. Of course, any type of ad and/or content may be displayed to the user.

Still yet, in one embodiment, the ads and/or content may be displayed on a single page (e.g. pull down display, etc.). In other embodiments, the ads and/or content may appear on multiple tabs. For example, within a section designated for ads and/or content, there may be a tab for food related ads and/or content (e.g. restaurants, groceries, etc.), for household related ads and/or content (e.g. toilet paper, toothpaste, furniture, etc.), for entertainment related ads and/or content (e.g. vacations, movies, concerts, etc.), clothing and/or shopping related ads and/or content, for friends related ads and/or content (e.g. list of friends who are near you, gift ideas for a friend, friend anniversary reminder, etc.), and/or for any other type of tab which may be used to segregate the ads and/or content in some manner.

In another embodiment, the ads and/or content may be displayed as drop-down categories. For example, in various embodiments, a drop-down category relating to food, household, entertainment, clothing, shopping, friends, and/or any other ad and/or content category may be selected, whereupon a list of the drop-down category related ads and/or content may be displayed. Of course, the ads and/or content may be displayed and/or arranged in any manner.

In one embodiment, ad and/or content filters may be applied. For example, in various embodiments, the ad and/or content filters may include genre, sub-genre, cities, distance, price, rating, and/or any filter. In another embodiment, the one or more filters may be listed within a drop-down menu (e.g. each item may be checked or unchecked in the dropdown menu, etc.), within a list associated with the filter and/or listed and/or displayed in any manner. Additionally, in some embodiments, options relating to the ads and/or content may include save, delete, send, and/or any action relating to the ad and/or content. In one embodiment, the one or more options may be listed within a drop-down menu (e.g. each item may be checked or unchecked in the dropdown menu, etc.), within a list associated with the option and/or listed and/or displayed in any manner. In another embodiment, a text search field may be provided whereby the user may type in search terms to be applied to ads and/or content.

In one embodiment, the genre filter may relate to the type and/or category of ads and/or content to be displayed. For example, the genre filter may relate to food, household, entertainment, clothing, shopping, friends, and/or any other ad and/or content category. In another embodiment, the sub-genre may further refine the genre selected. For example, in one embodiment, if the food genre was selected, the sub-genre may include a list relating to the type of food, including America, Asian, BBQ, Fast Food, French, Indian, Italian, Korean, Thai, Vietnamese, and/or any other category which may further refine the food genre. The sub-genre for any genre may therefore refine and filter out unwanted categories and/or selections.

In another embodiment, the cities filter may permit the user to select cities near to where the user is located. In many embodiments, the cities filter may permit a custom city to be inputted (e.g. a location where the user is not currently located, etc.), to select/deselect one or more cities, to expand and/or contract the geographic radius (e.g. include all cities within 10 miles, etc.), and/or modify the inclusion or exclusion of cities in any manner. In another embodiment, the distance filter may permit the user to select a distance, including selecting a preset distance (e.g. within 10 miles, etc.) and/or inputting a custom distance (e.g. 5.5 miles, etc.). In one embodiment, the distance may be computed based off of the user's current location. In another embodiment, the distance may be computed based off of another location, including a custom location (e.g. inputted by the user, etc.), a location associated with an appointment, a location associated with a contact, etc.

In one embodiment, the price filter may permit the user to select price parameters, including setting a maximum price (e.g. total price cannot exceed $20, etc.), a minimum price savings (e.g. save at least 20% off of the total price, etc.), and/or any other parameter related to price. In one embodiment, the price filter may incorporate information relating to a budget and/or expense system. For example, in one embodiment, the user may have an account set up to track billings, expenses, income, and/or all financially related affairs. In such an account, the user may set financial goals and/or monitor a budget. A price filter may be associated with such financial goals and/or budget. For example, the price filter may include an option to only display ads and/or content that conform with financials goals and/or the user's budget (e.g. the budget may indicate savings of $50 this month which may permit the user to spend some extra money, the budget may indicate that $300 out of $400 in food budget category has been spent which may permit spending additional money in the food budget category, etc.).

In one embodiment, the association of the financial goals and/or the user's budget with the price filter may take into consideration the amount the user may spend on a daily usage (e.g. $100 remaining in the food budget may be broken down into daily amounts, etc.). In this manner, the amount of money allocated to a budget may reflect a characteristic daily value (e.g. amount normally used in one day, etc.) rather than the ability to spend the entire budget in one day (e.g. $100 left in budget may be spent on one meal, etc.). In one embodiment, the price filter may include a general category “Items I can afford,” and/or any other category whereby the ads and/or content may be filtered according to financial goals and/or a financial budget.

In another embodiment, the user may input financial goals and/or budget criteria into the price filter. In one embodiment, such inputted financial goals and/or budget criteria may be synched with a financial program (e.g. cloud based, client based, etc.) where financial considerations may be more fully managed.

In one embodiment, the rating filter may be used to filter the ads and/or content. For example, in various embodiments, the rating filter may include a five star system (e.g. one star is a low rating, five stars is a high rating, etc.), a numeric rating system (e.g. Zagat numeric system, etc.), and/or any other system. In one embodiment, the ratings may be based on a set of certified analysts (e.g. professional testers, etc.), on a set of consumers (e.g. consumer and/or customer report, etc.), and/or on any set of individuals. In another embodiment, the ratings may be a set and/or known system (e.g. Zagat, five star, etc.), and/or may be a custom set of ratings (e.g. numeric, fingers, symbol, etc.).

In some embodiments, options relating to the ads and/or content may be displayed. For example, in one embodiment, a user may select save, delete, send, and/or any other function associated with the ads and/or content. In one embodiment, each function may have a dropdown menu with a list of options and/or selections, including the ability to apply the function to all of the listed ads and/or content, and/or to apply the function to one (e.g. the selected, etc.) listed ad and/or content. For example, in one embodiment, the user may select to save the displayed ads and/or content, and may do so by selecting the save option and then “save all ads and/or content.” In one embodiment, the ads and/or content may be viewed at a later time when convenient for the user.

In another embodiment, the user may select one ad and/or content. In such an embodiment, the user may select an option to save, delete, and/or send the selected ad and/or content. For example, the user may receive an ad and/or content relating to an “ABC Haircut: Buy 3 get 4^{th} Free.” The user may select the ad and send the ad to a contact and/or friend.

In a further embodiment, a search field may be provided to the user. In one embodiment, the search field may permit the user to enter text to filter the displayed ads and/or content. In another embodiment, the search field may include instant suggestions of search terms (e.g. based on prior search terms, based on popular search terms by other users, etc.). For example, in one embodiment, the user may be interested in ads and/or content relating to Best Buy. As an alternative to navigating through the filters and/or tabs, the user may enter “Best Buy” into the search field to display all ads and/or content relating to the search term. If the user were to begin to type “Bes” at a later date, the search field may prompt the user with a search suggestion of “Best Buy.” Of course, any number of text characters may be inputted before a search suggestion is given.

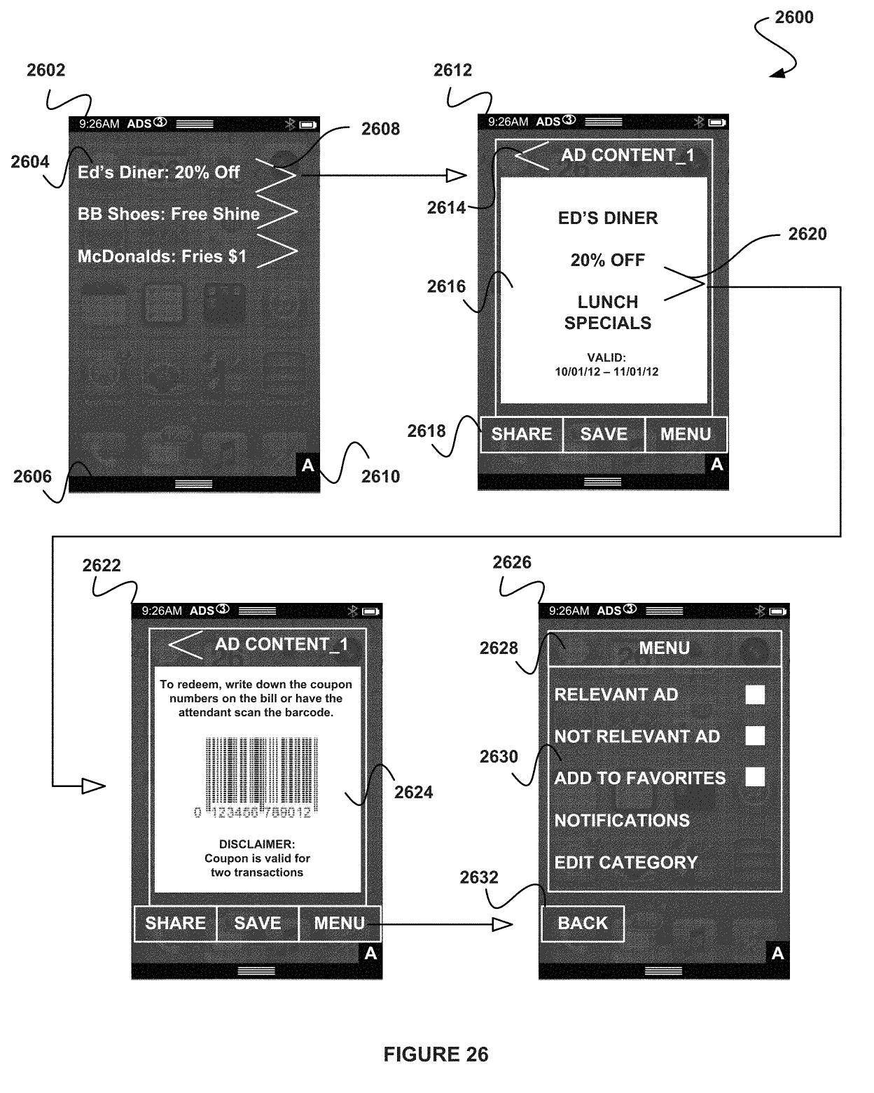

FIG. 26 shows a mobile device interface 2600 for interacting with advertisement/content related notifications, in accordance with another embodiment. As an option, the mobile device interface 2600 may be implemented in the context of the architecture and environment of the previous Figures and/or any subsequent Figure(s). Of course, however, the mobile device interface 2600 may be implemented in the context of any desired environment. It should also be noted that the aforementioned definitions may apply during the present description.

As shown, a status bar 2602, a list of ads and/or content 2604, a pulled down bar 2606, a screen indication 2610, and an ad and/or content selector 2608 are displayed.

In one embodiment, a status bar may be displayed on a locked screen, on a homescreen, on a screen associated with an application, and/or any screen and/or display associated with the mobile device. In one embodiment, the status bar may automatically hide when not in use. In another embodiment, the status bar may be displayed (e.g. from a hiding state, etc.) by swiping down on the screen, and/or performing an action to trigger display of the status bar. In one embodiment, the status bar may display any information (e.g. ad alert, pull down bar, weather, battery status, network status, mobile carrier status, time, date, etc.), which, in other embodiments, may be customized and/or modified by the user (e.g. via mobile device settings, etc.).

In another embodiment, the status bar may provide a function (e.g. pull down bar, etc.) to display an additional screen and/or display. In one embodiment, the user may swipe down on a pull down bar to display another screen and/or secondary display. In another embodiment, the user may press a button selection on the status bar (or on any part of the screen) to display another screen and/or secondary display. Of course, an additional screen and/or display may appear in response to any action (e.g. swipe, motion, shake, etc.) and/or invocation of a function (e.g. button, bar, etc.).

In one embodiment, the ads may be displayed in the ads and/or content may be displayed on a single page (e.g. pull down display, etc.). In other embodiments, the ads and/or content may appear on multiple tabs. For example, within a section designated for ads and/or content, there may be a tab for food related ads and/or content (e.g. restaurants, groceries, etc.), for household related ads and/or content (e.g. toilet paper, toothpaste, furniture, etc.), for entertainment related ads and/or content (e.g. vacations, movies, concerts, etc.), for clothing and/or shopping related ads and/or content, for friends related ads and/or content (e.g. list of friends who are near you, gift ideas for a friend, friend anniversary reminder, etc.), and/or for any other type of tab which may be used to segregate the ads and/or content in some manner.

In another embodiment, the ads and/or content may be displayed as drop-down categories. For example, in various embodiments, a drop-down category relating to food, household, entertainment, clothing, shopping, friends, and/or any other ad and/or content category may be selected, whereupon a list of the drop-down category related ads and/or content may be displayed. Of course, the ads and/or content may be displayed and/or arranged in any manner.

In one embodiment, a pulled down bar may be displayed. In another embodiment, after the additional screen and/or display is active (e.g. being displayed, etc.), the pulled down bar may hide. In one embodiment, the hidden pulled down bar may reappear based on an action (e.g. swipe up, tap once, etc.) and/or a function (e.g. close display, etc.) invoked by the user and/or the system (e.g. period of inactivity, etc.). In a further embodiment, the pulled down bar may include additional information, including a scrolling ticker of the latest deals (or of any information desired by the user, etc.), an alert and/or notification of the total number of new ads and/or content and/or any other relevant information (e.g. upcoming appointment, new email, missed call, etc.).

In another embodiment, the pulled down display and/or screen may permit the display of other additional screens and/or displays. For example, in one embodiment, the pulled down display may include a screen indication, which may indicate (e.g. by number, letter, dots, dashes, color, etc.) which screen currently is being displayed. In one embodiment, once the pulled down display is active (e.g. being displayed, etc.), the user may swipe (e.g. side to side, etc.) between additional screens and/or displays. In such an embodiment, each time the user swipes to an additional screen and/or display, the screen indication may change (e.g. increment to the next number, letter, dot, etc.). For example, in one embodiment, swiping the screen designated as “A” to the side may display an additional screen designated as “B.”

In some embodiments, the user may interact with the listed ads and/or content. For example, in one embodiment, the user may select an ad and/or content, and in response to the selection, have selection options including save the ad, shared the ad, delete the ad, etc. In another embodiment, the user may select the ad and/or content, and in response to the selection, have displayed a preview of the ad and/or content. For example, in one embodiment, the user may select an ad entitled “Ed's Diner: 20% Off,” and in response to the selection, the display may display (e.g. as text below the ad, etc.) details including “valid from 5-7 pm M-F,” “valid from 03/01/12-05/01/12,” “located at 1234 Waldorf St, San Jose, Calif.,” and/or any additional and/or further information. In one embodiment, an ad and/or content selector may be associated with the ad and/or content. For example, in one embodiment, the ad and/or content selector may be a separate button from than the ad and/or content and may display an additional screen associated with the ad and/or content.

As shown, a user may select the ad and/or content selector 2608, which displays the ad and/or content display 2616. Additionally, a status bar 2612, a back button 2614, ad and/or content options 2618, and a forward button 2620 are displayed.

In one embodiment, a status bar may be displayed on a locked screen, on a homescreen, on a screen associated with an application, and/or any screen and/or display associated with the mobile device. In one embodiment, the status bar may automatically hide when not in use. In another embodiment, the status bar may be displayed (e.g. from a hiding state, etc.) by swiping down on the screen, and/or performing an action to trigger display of the status bar. In one embodiment, the status bar may display any information (e.g. ad alert, pull down bar, weather, battery status, network status, mobile carrier status, time, date, etc.), which, in other embodiments, may be customized and/or modified by the user (e.g. via mobile device settings, etc.).

In another embodiment, the status bar may provide a function (e.g. pull down bar, etc.) to display an additional screen and/or display. In one embodiment, the user may swipe down on a pull down bar to display another screen and/or secondary display. In another embodiment, the user may press a button selection on the status bar (or on any part of the screen) to display another screen and/or secondary display. Of course, an additional screen and/or display may appear in response to any action (e.g. swipe, motion, shake, etc.) and/or invocation of a function (e.g. button, bar, etc.).

In one embodiment, a back button may permit the user to return to an initial ad and/or content dropdown screen and/or display. In a separate embodiment, the user may return to a prior screen and/or display by giving an action (e.g. swiping to the left, etc.), selecting a device button (e.g. back button, etc.), and/or by giving any other input to go back. In one embodiment, the user may navigate through voice commands (e.g. “go back to last display and/or screen,” etc.).

In another embodiment, the ad and/or content display may provide ad and/or content details, including, for example, the terms and/or conditions of the ad and/or content, location and/or contact information, valid dates, information relating to the ad and/or content (e.g. selection of content, menu items, etc.), and/or any information desired by the creator of the ad and/or content.

In one embodiment, the ad and/or content display may include interactive elements. For example, in one embodiment, the ad and/or content display may include links (e.g. to a website, etc.), a cost savings tool (e.g. input number of items desired to see potential cost savings, etc.), pop up information (e.g. tiles appear when an ad and/or content item is selected, etc.), moveable elements (e.g. font and/or object moves response to mobile device movement, in response to finger movements, etc.), changing color (e.g. background, text, etc.), and/or any other interactive element.

In a further embodiment, the ad and/or content may include fields. For example, in one embodiment, the user may fill in user information (e.g. name, contact information, etc.), billing payment information (e.g. credit card, payment card, etc.), post the ad and/or content to a site (e.g. social media site, blog, etc.), and/or any information associated with a field of the ad and/or content. In a separate embodiment, the ad and/or content may relate to a notification that a user's friend (e.g. gathered from Facebook, Google+, etc.) was in the general vicinity of the user. Selecting the notification (e.g. relevant content, etc.) may lead to an ad and/or content display which may include a field for sending a message (e.g. SMS, etc.), initiate a chat conversation, and/or interact with the friend in any manner. Of course, any field may be included on the ad and/or content display.

In one embodiment, the ad and/or content display may include multimedia content. For example, in various embodiments, the multimedia content may include a video (e.g. .mp4, .mpv, .flv, .wmv, .3gp, .avi, .ogg, etc.), animation (e.g. full animation, limited animation, rotoscoping, live-action/animation, etc.), audio (e.g. raw audio format, compressed audio file, etc.), an interactive web page (e.g. HTML5, etc.), a multimedia platform (e.g. Adobe Flash, Gnash, Swfdec, etc.), and/or any other type of multimedia content.

In another embodiment, ad and/or content options may include the ability to share (e.g. via email, social networking site, blog, etc.), save (e.g. for later viewing, for later use, etc.), delete, modify (e.g. change ad and/or content location, etc.), remind (e.g. remind the user of the ad and/or content at a later date, etc.), and/or any other option which may relate to the ad and/or content. In one embodiment, a menu button may also be provided, and may provide further options including settings (e.g. relating to the application, relating to the ad and/or content, relating to the OS/platform native utility, etc.), help, feedback, search, sync (and/or refresh, etc.), preferences (e.g. ability to refine what ads and/or content are displayed, etc.), saved ads and/or content, statistics (e.g. how much money the user has saved, how many ads and/or contents the user has participated in, etc.), budget and/or financial goals (e.g. integration of financial software plugin, etc.), account balance (e.g. checking account, savings account, etc.), purchased ads and/or content, etc. Of course, any option and/or feature (e.g. relating to the ad and/or content, relating to the source application of the ad and/or content, relating to the OS/platform native utility, etc.) may be present in the menu.

In one embodiment, a save option may relate to saving the ad and/or content to later use and/or redeem it (e.g. save within source application, save in mobile device cache, etc.). In another embodiment, a save option may relate to saving the ad and/or content to an OS/Platform Nativity Utility (e.g. mobile device ad and/or content manager application, etc.). In another embodiment, a share option may relate to a social networking site. For example, in one embodiment, a user may share an ad and/or content with a friend. In a further embodiment, a social network site (or any site) may reward a user for sharing and/or a greater reward for friends that sign up and/or use the ad and/or content. For example, in one embodiment, the user may receive an ad and/or content relating to a haircut. The user may be aware of a friend who needs a haircut and so may forward on the ad and/or content to the haircutting-needing friend. In one embodiment, the user may be rewarded (e.g. discount card, money, royalty points, etc.) for sharing an ad and/or content with a friend. In another embodiment, if the recipient friend (e.g. haircutting-needing friend, etc.) uses the ad and/or content, the user may additionally receive a reward (e.g. discount card, money, royalty points, etc.). In some embodiments, a user may be proportionally rewarded based on the number of shares sent, and/or proportionally rewarded based on the number of friends who took an action (e.g. download app, use the ad, respond to the content, etc.) after receiving the ad and/or content.

In another embodiment, the user may post an ad and/or content directly to a website (e.g. social media site, blog, etc.). In one embodiment, the user may be rewarded proportionally to the number of followers and/or friends (e.g. Facebook friends, Twitter followers, etc.). In this manner, a user may distribute ads and/or content. Additionally, in other embodiments, a user may receive some reward for accurately distributing an ad and/or content to a relevant recipient.

In a further embodiment, the user may share an ad and/or content with additional information. For example, in one embodiment, after a user selects “share,” a field may appear requesting the destination (e.g. social media site, blog, email, contact, etc.), the ability to add a message (e.g. comment, etc.) to the ad and/or content, and/or add any other additional information (e.g. content, text, etc.). In one embodiment, the user may share an ad and/or content through texting (e.g. SMS, etc.) and/or any other messaging platform. In one embodiment, the mobile device may convert the ad and/or content from a first form (e.g. as received form, etc.) to a second form (e.g. modified form, etc.). In another embodiment, the second form may be optimized for text viewing, low data speeds, and/or any other optimized view.

In one embodiment, a user may redeem and/or use the ad. For example, in one embodiment, a user may select a forward button and/or any button that permits the user to redeem and/or use the ad and/or content (e.g. a “redeem” button, an “accept” button, etc.). In another embodiment, touching the ad may cause the ad and/or content to progress to another display (e.g. redemption display, etc.).

As shown, a user may select a forward button 2620 which may cause a redemption page 2624 to be displayed. Additionally, a status bar 2622 and ad and/or content options may be provided and/or displayed.

In one embodiment, the redemption display may be included on an initial ad and/or content display. In another embodiment, the redemption display may be separate from the initial ad and/or content display. In one embodiment, the redemption display may include a barcode (e.g. UPC, EAN, etc.), a QR code, a Tag code (e.g. Microsoft Tag, etc.), and/or any type of scannable code. In one embodiment, the scannable code may be scanned by the destination (e.g. restaurant, shop, etc.). In another embodiment, the scannable code may include a string of numbers which may be manually entered in by the destination (e.g. restaurant, shop, etc.). In a further embodiment, the redemption display may include a shortened coupon code (e.g. “FreeTuesday,” “2a3b,” etc.) which may be entered at the destination.

In one embodiment, the redemption page may display detail information. For example, in one embodiment, the ad and/or coupon may be valid for two uses. The detail information may indicate that the ad and/or content has been used once and so the ad and/or coupon can be used once more. In another embodiment, the detail information may indicate whether the ad and/or content is still valid, whether the ad and/or content has changed (e.g. new features, etc.) since the last synchronization, a disclaimer, and/or any additional detail associated with the ad and/or content.

In a separate embodiment, the redemption page may include a billing payment section, including fields to input a payment card (e.g. credit card, etc.), apply automatic payment (e.g. stored payment information, etc.), and/or input any payment related information. In one embodiment, the ad and/or content may be paid for in advance of arriving at the intended destination. For example, in one embodiment, the ad and/or coupon may relate to a discount card where you buy the card, pay for 3 meals, and get 2 meals free. In order to use the card, the user may complete the transaction (e.g. pay for the card, etc.) before using the card. In another embodiment, the ad and/or content may be used during the transaction at the destination. For example, an ad and/or content which relates to 20% off of a next meal would be redeemed at the time of the next meal. Of course, the ad and/or content may be redeemed at any time and in any manner.

In one embodiment, the redemption page may be synced to an online service. For example, ads and/or content which have been paid for (e.g. those purchased in advance before use, etc.) may be managed and/or saved at an online database. In another embodiment, the redemption page may be managed by an OS/platform native utility. For example, in one embodiment, all ads and/or content may have an ad and/or content display page created by the ad and/or content developer and/or creator. In such an embodiment, a redemption page may be managed by an OS/platform native utility. Additionally, a redemption page may be standardized (e.g. uniform look, consistent organization, etc.) among all ads and/or content, may provide one source for payment options (e.g. paypal, checking account, credit card, etc.), and/or may be managed in any manner by the OS/platform native utility.

As shown, a user may select a menu option and in response, a list of menu items 2630 may be displayed. Additionally, a status bar 2626, a menu title bar 2628, and a back button 2632 may be displayed.

In one embodiment, a list of menu items may include settings (e.g. relating to the application, relating to the ad and/or content, relating to the OS/platform native utility, etc.), help, feedback, search, sync (and/or refresh, etc.), preferences (e.g. ability to refine what ads and/or content are displayed, etc.), saved ads and/or content, statistics (e.g. how much money the user has saved, how many ads and/or contents the user has participated in, etc.), budget and/or financial goals (e.g. integration of financial software plugin, etc.), account balance (e.g. checking account, savings account, etc.), purchased ads and/or content, “relevant ad,” “not relevant ad,” “Add to Favorites,” and/or any other option and/or setting.

In another embodiment, the list of menu items may include an option to modify notifications. In one embodiment, the notifications may relate to the creator and/or developer of the ad and/or content. In various other embodiments, the notifications may relate to an application associated with the ad and/or content, a mobile device OS/platform native utility (e.g. global application interface for managing all ads and/or content, etc.), and/or any application and/or utility associated with the ad and/or content. In one embodiment, the user may restrict, grant, and/or modify in some manner notifications.

Still yet, in one embodiment, the list of menu items may include an option to edit a category. For example, in one embodiment, an ad and/or content may relate to a deal for 50% of ice cream. The deal may have been categorized as relating to food. The user may edit the category by placing it under a correct sub-category (e.g. dessert, etc.). In one embodiment, if the user edits a category associated with an ad and/or coupon, the feedback may be sent to a central database management system (e.g. online server, etc.). In one embodiment, if enough (e.g. threshold amount, etc.) users reclassify an ad and/or content, then the ad and/or content will be recategorized consistent with the majority of edits from the users. An updated categorization relating to the ad and/or content may be pushed and updated to all participating mobile devices (e.g. those that receive ads and/or content with appropriate notification permissions, etc.).

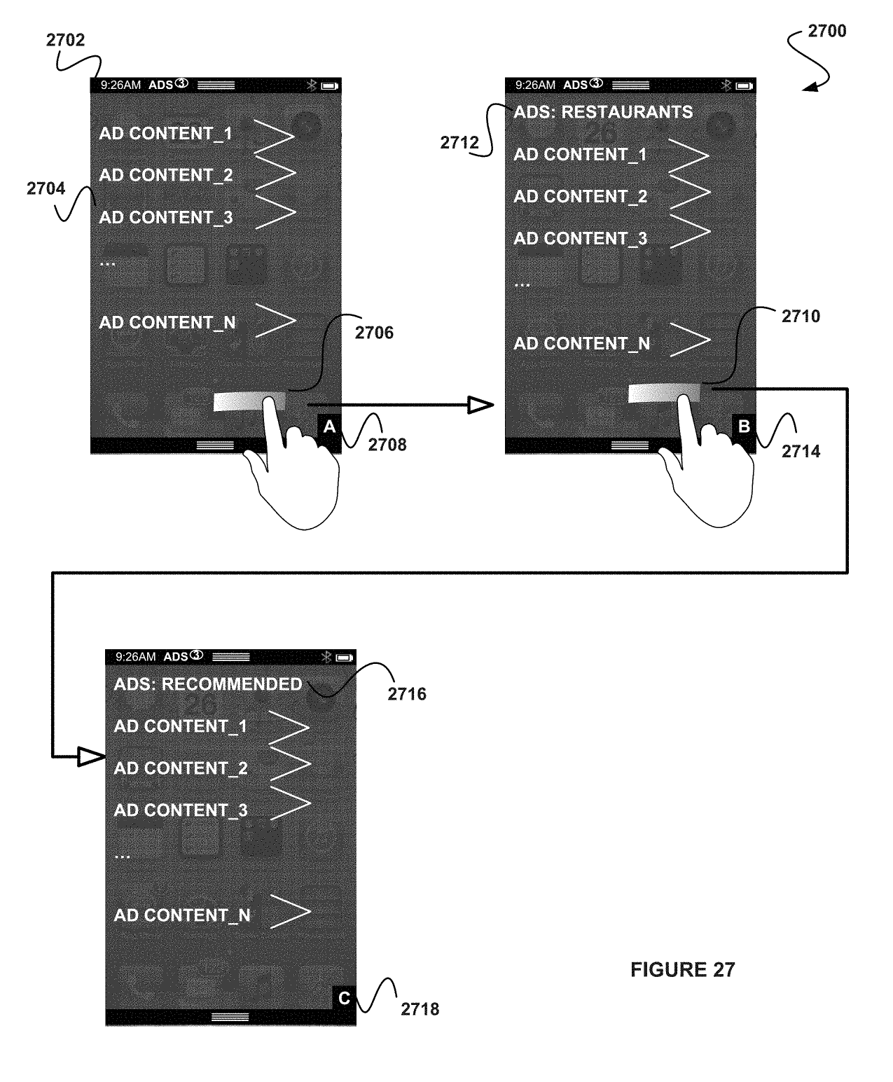

FIG. 27 shows a mobile device interface 2700 for interacting with advertisement/content related notifications, in accordance with another embodiment. As an option, the mobile device interface 2700 may be implemented in the context of the architecture and environment of the previous Figures and/or any subsequent Figure(s). Of course, however, the mobile device interface 2700 may be implemented in the context of any desired environment. It should also be noted that the aforementioned definitions may apply during the present description.

As shown, a status bar 2702, list of ads and/or content 2704, and a screen indication 2708 are displayed. Additionally, a swipe action 2706 is shown.

In one embodiment, a status bar may be displayed on a locked screen, on a homescreen, on a screen associated with an application, and/or any screen and/or display associated with the mobile device. In one embodiment, the status bar may automatically hide when not in use. In another embodiment, the status bar may be displayed (e.g. from a hiding state, etc.) by swiping down on the screen, and/or performing an action to trigger display of the status bar. In one embodiment, the status bar may display any information (e.g. ad alert, pull down bar, weather, battery status, network status, mobile carrier status, time, date, etc.), which, in other embodiments, may be customized and/or modified by the user (e.g. via mobile device settings, etc.).

In another embodiment, the status bar may provide a function (e.g. pull down bar, etc.) to display an additional screen and/or display. In one embodiment, the user may swipe down on a pull down bar to display another screen and/or secondary display. In another embodiment, the user may press a button selection on the status bar (or on any part of the screen) to display another screen and/or secondary display. Of course, an additional screen and/or display may appear in response to any action (e.g. swipe, motion, shake, etc.) and/or invocation of a function (e.g. button, bar, etc.).

In one embodiment, the list of ads and/or content may be displayed on a single page (e.g. pull down display, etc.). In other embodiments, the ads and/or content may appear on multiple tabs. For example, within a section designated for ads and/or content, there may be a tab for food related ads and/or content (e.g. restaurants, groceries, etc.), for household related ads and/or content (e.g. toilet paper, toothpaste, furniture, etc.), for entertainment related ads and/or content (e.g. vacations, movies, concerts, etc.), for clothing and/or shopping related ads and/or content, for friends related ads and/or content (e.g. list of friends who are near you, gift ideas for a friend, friend anniversary reminder, etc.), and/or for any other type of tab which may be used to segregate the ads and/or content in some manner.

In another embodiment, the ads and/or content may be displayed as drop-down categories. For example, in various embodiments, a drop-down category relating to food, household, entertainment, clothing, shopping, friends, and/or any other ad and/or content category may be selected, whereupon a list of the drop-down category related ads and/or content may be displayed. Of course, the ads and/or content may be displayed and/or arranged in any manner.

Further, in another embodiment, the pulled down display and/or screen may permit the display of other additional screens and/or displays. For example, in one embodiment, the pulled down display may include a screen indication, which may indicate (e.g. by number, letter, dots, dashes, color, etc.) which screen currently is being displayed. In one embodiment, once the pulled down display is active (e.g. being displayed, etc.), the user may swipe (e.g. side to side, etc.) between additional screens and/or displays. In such an embodiment, each time the user swipes to an additional screen and/or display, the screen indication may change (e.g. increment to the next number, letter, dot, etc.). For example, in one embodiment, swiping the screen designated as “A” to the side may display an additional screen designated as “B.”

In one embodiment, the screens may be arranged in any manner. For example, in one embodiment, the screens may be arranged horizontally (e.g. switch from screen to screen by sliding the current screen to the left or right, etc.), vertically (e.g. switch from screen to screen by sliding the current screen up or down, etc.), and/or in any manner. For example, in one embodiment, selecting the screen indicator may cause a preview display of all screens (e.g. each screen and/or display in reduced size, etc.). From the preview display, the user may navigate and/or select the desired screen.

In another embodiment, the screens may be arranged in a cube format (e.g. ability to swipe to the left and/or right, as well as to swipe up and/or down, etc.), in a spherical format (e.g. ability to swipe in any direction, etc.), and/or in any geometrical format.

In one embodiment, the arrangement of the screens may be by groups. For example, in one embodiment, to swipe to the left and/or right may remain within a category (e.g. food, etc.) where each of the screen represents a different sub-category, and to swipe up and/or down may switch a category (e.g. from food to clothing, etc.). In a separate embodiment, the grouping of screens may relate to applications on the mobile device. For example, in one embodiment, resources (e.g. email, calendar, phone, messaging, etc.), lunch time specials, games, and/or any combination of applications and/or ads and/or content may each be considered a group.

Further, in another embodiment, a screen may relate individually to weather, emails, business applications, phone, messaging, social media updates, twitter feeds, RSS feeds, and/or any source which may provide an update (e.g. missed call, new email, new story, new weather, etc.) and/or feeds. In some embodiments, a screen may include one or more widgets, interactive elements and/or objects, and/or any object which may provide at least some interactive feature with the user.

In one embodiment, a user may swipe the screen to change the display and/or screen. In another embodiment, the user may physically move the mobile device to switch the screen (e.g. lean the device to the side, flip the device in a predefined direction, etc.), may use a voice command (e.g. “show screen 2,” etc.), and/or may use any other action and/or command to switch the screen of the mobile device.

As shown, a swipe action 2706 may cause a second screen 2712 and second screen indication 2714 to be displayed. Additionally, a status second swipe action 2710 is displayed.

In one embodiment, the second screen may relate to any group of applications and/or ads and/or content. For example, in one embodiment, the second screen may relate to “Ads: Restaurants.” In other embodiments, the second screen may relate to any application, grouping of applications, ad and/or content, and/or grouping of ads and/or content.

In one embodiment, the second screen indication may indicate screen “B.” In other embodiments, the screen indication may be any number, letter, object, symbol, and/or designation as set by the user and/or developer. In one embodiment, the screen indication may remain continuously visible. In another embodiment, the screen indication may be hidden (e.g. after the screen remains constant for a set period, etc.). In such an embodiment, the screen indication may be viewed by tapping the bottom right hand corner of the screen (or at any pre-designated part of the screen), long pressing a corner (e.g. holding down for 2 seconds causes to the screen indication to be displayed, etc.), beginning to swipe a screen (e.g. beginning to swipe from right to left may cause the screen indication to appear, etc.), and/or any action given by the user may cause the screen indication to appear.

As shown, a swipe action 2714 may cause a third screen 2716 and third screen indication 2718 to be displayed.

In one embodiment, the third screen may relate to any group of applications and/or ads and/or content. For example, in one embodiment, the third screen may relate to “Ads: Recommended.” In other embodiments, the third screen may relate to any application, grouping of applications, ad and/or content, and/or grouping of ads and/or content. Of course, in various embodiments, any number of screens may be configured to applications, as well as ads and/or content.

In one embodiment, the third screen indication may indicate screen “C.” In other embodiments, the screen indication may be any number, letter, object, symbol, and/or designation as set by the user and/or developer. In one embodiment, the screen indication may remain continuously visible. In another embodiment, the screen indication may be hidden (e.g. after the screen remains constant for a set period, etc.). In such an embodiment, the screen indication may be viewed by tapping the bottom right hand corner of the screen (or at any pre-designated part of the screen), long pressing a corner (e.g. holding down for 2 seconds causes to the screen indication to be displayed, etc.), beginning to swipe a screen (e.g. beginning to swipe from right to left may cause the screen indication to appear, etc.), and/or any action given by the user may cause the screen indication to appear.

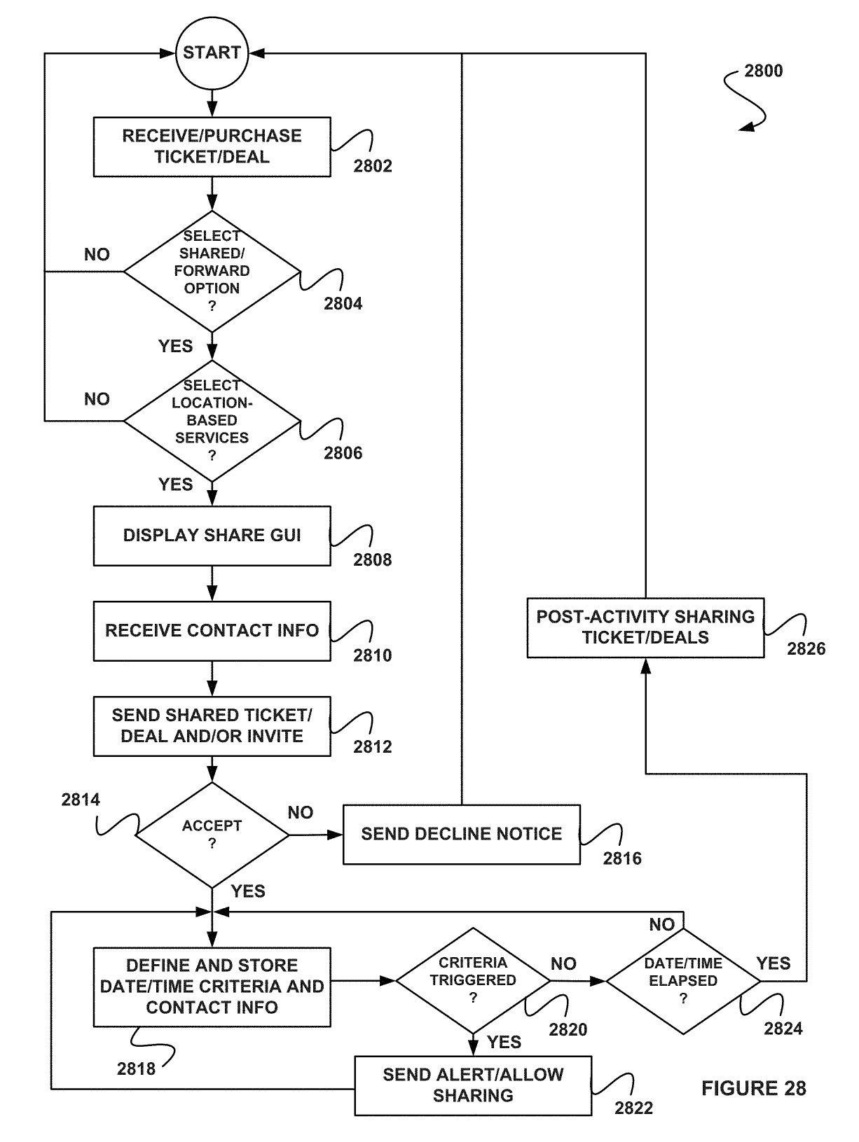

FIG. 28 shows a method 2800 for presenting contextual advertisements, in connection with a mobile device, in accordance with another embodiment. As an option, the mobile device interface 2800 may be implemented in the context of the architecture and environment of the previous Figures and/or any subsequent Figure(s). Of course, however, the mobile device interface 2800 may be implemented in the context of any desired environment. It should also be noted that the aforementioned definitions may apply during the present description.

As shown, a user (or a mobile device associated therewith, an OS associated therewith, etc.) receives and/or purchases a ticket and/or deal. See operation 2802. In various embodiments, the user may purchase a ticket and/or a deal. For example, in one embodiment, the user may purchase a ticket and/or a deal relating to an event (e.g. concert, etc.), entertainment (e.g. scuba, movies, tour, theme park, racing, haunted mansion, etc.), medical (e.g. doctor visit, dental checkup, plastic surgery, etc.), business (e.g. conference, trade show, etc.), home improvement (e.g. car wash, remodel, etc.), beauty (e.g. haircut, manicure, etc.), food (e.g. restaurants, cafes, bars, happy hour, etc.), sports, travel (e.g. airline ticket, hotel tickets, car rental, etc.), and/or any type of event where a ticket and/or deal may be purchased.

In one embodiment, the user may purchase a single ticket for personal use. For example, in one embodiment, the user may have received an ad and/or content (e.g. discount vacation deal, etc.) relating to travel. In response, the user may have purchased one or more ticket (e.g. airfare ticket, hotel deal, etc.) relating to the travel ad and/or content (e.g. discount vacation deal, etc.). In such an embodiment, all purchased items (e.g. airfare ticket, hotel deal, etc.) may be managed (i.e. saved and/or organized in one central location, etc.) by an application and/or an OS/platform native utility. Of course, the user may find an airfare ticket and/or hotel deal not related to an ad and/or content and which may also be managed (e.g. discovered and organized, etc.) by an application and/or an OS/platform native utility.

In another embodiment, the user may purchase at least one ticket to be used by another individual (e.g. friend, family member, etc.). For example, in one embodiment, the user may receive an ad and/or content and in response, purchase a ticket and/or deal. The user may share (e.g. forward on, send, etc.) the purchased ticket and/or deal with another contact (e.g. business contact, family, friend, etc.). In another embodiment, the user may purchase a ticket and/or deal online (e.g. not as a result of an ad and/or content, etc.) and then may share the purchased ticket and/or deal with another contact.

As shown, it may be determined whether the user selects a shared/forward option. See determination 2804. In one embodiment, the user may share the purchased ticket and/or deal as a gift to another contact. For example, in one embodiment, the user may purchase a ticket and/or deal to an entertainment event (e.g. ticket to a motorcycle rally, etc.). The user may send the purchased ticket as a gift to another contact (e.g. a friend who likes motorcycles, etc.). In another embodiment, the user may have initially purchased the ticket for personal use, but at any time, may discover that the user will be unable to attend the event. In such an embodiment, the user may also send the ticket as a gift to another contact. Of course, in various embodiments, the user may share the ticket (e.g. as a gift, to be used by another, etc.) in any manner and for any reason as determined by the user.

Further, in various embodiments, the user may receive (e.g. rather than purchasing, etc.) a ticket and/or deal. In response to the receipt of the ticket and/or deal (e.g. via notification, email, application, OS/platform native utility, etc.), the user may keep the ticket and/or deal for personal use (e.g. save for later, etc.) share the ticket and/or deal (e.g. send as a gift, etc.) with another contact, and/or send information relating to the ticket and/or deal (e.g. date, time, location, where and how to purchase, etc.) to another contact.

In one embodiment, the user may receive and/or purchase one or more tickets and/or deals. In such an embodiment, the user may desire to share at least one extra ticket and/or deal with another contact. For example, in one embodiment, the user may share and/or forward (e.g. via email, via SMS, via social networking site, via postal mail service, via online ticket site such as Ticketmaster, etc.) a ticket and/or deal to another contact. In a separate embodiment, if the user receives and/or purchases one or more tickets and/or deals, the user may keep the extra tickets and/or deals for personal use and/or for any other use as determined by the user.

In one embodiment, the user may share information relating to a ticket and/or deal. For example, in one embodiment, the user may forward on (e.g. via email, social networking site, etc.) the ticket and/or deal, forward on information associated with the ticket and/or deal, and/or share the ticket and/or deal in any manner (e.g. post to blog, post to social networking site, etc.). In response to the receipt of the information relating to a ticket and/or deal, a first contact may be invited to purchase the ticket and/or deal and/or share (e.g. forward on, etc.) the ticket and/or deal to other contacts associated with the first contact.

In another embodiment, the ticket and/or deal may be dynamic and change. For example, in one embodiment, the ticket and/or deal may include early bird pricing, last minute availability, and/or any other type of pricing scenario. In such an embodiment, tickets, seats, pricing, and/or any other element may change in response to availability and/or demand.

In one embodiment, the ticket and/or deal may be associated with the user of the mobile device. For example, in one embodiment, the user may forward on and/or share the ticket and/or deal with contacts. In response, some of the contacts may purchase the ticket and/or deal. The ticket and/or deal associated with the user (i.e. as displayed on the user's mobile device, etc.) may change in response to action(s) (e.g. purchase, relevant sharing, etc.) taken from those with whom the ticket and/or deal was shared. For example, in one embodiment, the user may share a 50% Off Lunch Special Deal at Bob's Diner with relevant friends in the geographic area. Some of the friends may use the 50% Off deal that the user sent them. In response, the original 50% Off deal as displayed on the user's mobile device may now show 60% Off. In such an embodiment, the more the user shares the ticket and/or deal, and the more contacts that respond and use the ticket and/or deal, the more the user's deal and/or coupon may potentially change (e.g. amount off may increase as other contacts take an action, etc.).

In one embodiment, if the user's ticket and/or deal changes, the ticket and/or deal that may be shared may be different than the ticket and/or deal which may be associated with the user. For example, in one embodiment, the user may have initially received a ticket and/or deal for 50% off. In such an embodiment, the ticket and/or deal may have increased to 60% due to sharing it and subsequent action(s) taken by contacts. In one embodiment, the user may share the original ticket and/or deal even after the ticket and/or deal has been modified (e.g. updated, etc.). In another embodiment, the user may share the modified (e.g. updated, etc.) ticket and/or deal by sending the particular ticket and/or deal to a specific contact. For example, in one embodiment, rather than redeem the modified 60% Off deal, the user may send the modified deal to a friend who may redeem the 60% Off deal. In another embodiment, if the user wishes to keep the 60% Off deal for personal use, the user may still share the original deal (e.g. 50% Off, etc.) with as many contacts as desired.

In various embodiments, a ticket and/or deal may be shared by a messaging platform (e.g. email, SMS, chat, etc.), a social networking platform (e.g. Facebook, etc.), a blog platform (e.g. Blogger, Wordpress, etc.), a map interface, a CRM platform (e.g. Microsoft CRM, SAP AG, etc.), a camera interface, and/or any other platform and/or interface whereby a ticket and/or deal may be shared. In one embodiment, the application (e.g. app downloaded on phone, OS/platform native utility, etc.) displaying the ticket and/or deal may include an option to share (e.g. “share” button, “send” option, etc.). Selecting the share option may include a further option to share by camera, by map, by email, by social media. Selecting the map option may display a map interface. In one embodiment, contacts of the user may be displayed on the map (e.g. graphic and/or text and/or object which represents a user, etc.). The user may individually select a contact with whom the ticket and/or deal may be shared, and/or may select multiple contacts simultaneously (e.g. selecting each contact to be included, draw circle and/or a perimeter around the contacts, etc.).

In another embodiment, the user may use an object (e.g. circle, etc.) to define the perimeter within which contacts may receive the ticket and/or deal. In one embodiment, the home location of each contact may be displayed. In another embodiment, the real time location of each contact may be displayed (e.g. display contacts nearest the user, etc.). For example, the user may use the map interface to select a circumference within which the home location of the user's contacts will be included. The user may restrict the circumference of the circle, and/or broaden the circumference to include more contacts. After selecting the perimeter of the geographic area to be included, the user may finalize the selection (e.g. send all contacts contained within the selected area the ticket and/or deal, etc.).

In one embodiment, the user may select to share the ticket and/or deal by camera. For example, in one embodiment, after receiving a ticket and/or deal, the user may select to share via the camera option. The camera application may be displayed. The user may take a photo of a contact. In such an embodiment, the mobile device may include facial recognition software to determine the identity of the contact. In one embodiment, the user may take a photo including more than one contact. In such an embodiment, the mobile device may determine the identity of each of the contacts. For example, the user may take a photo of 6 friends. The mobile device may determine automatically (e.g. based off of facial recognition on the mobile device, based off of facial recognition associated with a social networking site and/or online site, etc.) the identity of each contact. After determining the identity of the contact, the application and/or OS/platform native utility may send the ticket and/or deal to the identified contact(s) from the photo. In one embodiment, the user may take multiple photos, with each photo indicating a separate contact (i.e. recipient, etc.) of the ticket and/or deal.

In one embodiment, the user may take a photo of a location and/or object. Based off of the object and/or location, the mobile device may determine an identity of a contact associated with the object and/or location. For example, in one embodiment, the user may take a photo of Yahoo, and all of the user's contacts associated with Yahoo may receive the ticket and/or deal. In another embodiment, the user may take a photo of an instrument (e.g. piano, violin, guitar, etc.), and all of the user's contacts associated with the instrument (or a more general class of music, etc.) may be sent the ticket and/or deal. Of course, the user may control the settings applied to groupings of people and/or association of people to objects, locations, and/or images.

In another embodiment, the user may take an audio recording, and based on the audio recording, the mobile device may determine a relevant identity of an intended recipient. For example, in one embodiment, the user may state “male contact with dark hair and green eyes,” and a result fitting the parameter may be returned. In another embodiment, the user may record an audio clip of a song (e.g. music, etc.), an event (e.g. the circus, fair, etc.), and/or any other object, location, and/or person which may be associated with a sound. As a further example, in one embodiment, the user may record the busy sounds of a house, an office, and/or any other location. A mobile device, online site, social networking site, and/or any other source may determine the location based off of the sound (e.g. Disneyland theme song, voices of each family member, etc.). Based off of the recording, a relevant identify of a contact may be determined.

In one embodiment, a GPS signal may be used to determine an identity of contacts to whom the ticket and/or deal should be sent. For example, in one example, the user may select to share the ticket and/or deal via GPS. The GPS application may be activated and determine the location of the user. The user may input a numerical radius (e.g. within 1 mile, etc.) to determine the range within which contacts should be found. The results may be displayed in a list format, by thumbnails, and/or in any other manner. After viewing the results, the user may expand, restrict, and/or modify the applicable range in any manner. The user may then accept the results and finalize the sending (e.g. sending the ticket and/or deal to the displayed and/or listed contacts, etc.). As an example, a user may receive a deal for “60% off of Today's Lunch Specials for parties greater than 4 individuals.” The user may choose to share the deal with contacts via GPS. The user may select to view individuals within 5 blocks of the user. After viewing the results, the user may send the ticket and/or deal to the contacts listed.

In another embodiment, the user may personalize the ticket and/or deal. For example, in one embodiment, the user may add a comment and/or message to the ticket and/or deal. In another embodiment, the user may add a photo, multimedia (e.g. video, etc.) and/or any other object and/or personalization. In a further embodiment, the user may add a priority tag to the ticket and/or deal. For example, in one embodiment, the user may receive a time sensitive deal, such as “50% off sale for the next 2 hours.” The user may attach a time sensitive tag (e.g. display to recipients for the next 2 hours, display high priority for recipient, etc.), and/or any tag to indicate time sensitivity.

As shown, it is determined whether the user selects location-based services. See determination 2806. In one embodiment, the location-based services may include real-time contact location, notifications (e.g. location may trigger notifications, etc.), navigation (e.g. road navigation to an address location, navigate contacts to a specific meet-up spot for example within a building, etc.), geo-tag photos taken at the location relating to the ticket and/or deal, update social networking site (e.g. LinkedIn, Facebook, etc.) with user's location, estimated time of arrival (ETA) map of all individuals participating in the ticket and/or deal, real-time feeds from the location (e.g. parking lot is full, 30 minute wait in line, etc.), social networking integration (e.g. upload and/or posting of location and message relating to the ticket and/or deal, etc.), geo-tracking (e.g. record track and/or path taken by each participant, etc.), tagging any data file (e.g. voice recording, video, SMS, email with location metatag information during the time relating to the ticket and/or deal, etc.), recommending additional social events (e.g. you may enjoying interacting with individual A, etc.), asset tracking (e.g. GPS tracking device within a container and/or object, product tracking, etc.), check-ins (e.g. Foursquare, etc.), calling a vehicle (e.g. taxi, ambulance, etc.), identifying objects or persons or buildings (e.g. recognition and identification of surroundings, etc.), managing traffic (e.g. best route, etc.), billing (e.g. automatic billing for road tolls, etc.), scheduling (e.g. fleet management, etc.), accessing news (e.g. news relating to the location, etc.), tour guides (e.g. relating to the location, etc.), ability to play a game (e.g. hide and seek, etc.), directory services (e.g. Yellow Pages, Google, etc.), weather reports, points of interest (e.g. gas stations, restaurants, etc.), and/or any other service which may be relevant to location.

In one embodiment, for example, after the user has selected to share a ticket and/or deal (e.g. attend a concert, etc.) with a contact (e.g. friend, business contact, etc.), the user may select to enable location based services. If the contact accepts to attend the concert, the location based services may permit the users to interact before, during, and after the event. For example, in one embodiment, the location based services may help navigate each individual to the intended destination. Once at the destination, the location based services may help the individuals meet up at a prearranged location. At all times, the location based services may provide an ETA for each individual coming to the event. During the event, an individual may take a photo which may be then automatically uploaded to a social media site with appropriate metatags (e.g. location, event information, etc.). After the event, the location services may recommend additional social events and/or interests to the individuals.

In another embodiment, the ability to select location based services may provide for temporary location sharing. For example, in one embodiment, the user's location may be shared with other participants for a set amount of time. In one embodiment, the user may determine the start and end times of when the location based services may be in effect (e.g. remain active, etc.). In another embodiment, each participating individual may further restrict the time of applicability relating to the location based services. In a further embodiment, a participant may choose to hide his or her location but may receive location updates from other participants. In another embodiment, the user may require, as a condition of acceptance, the activation of location based services. Further yet, the developer and/or creator of the ticket and/or deal may set the conditions and/or requirements for temporary location sharing.

In one embodiment, the user may manually configure the location. For example, in some embodiments, the location of the user may not be precise (e.g. reliance on carrier triangulation rather than GPS, etc.), and so may be corrected and/or refined by the user. In one embodiment, the user may input custom location labels (e.g. Bob's favorite restaurant, etc.) relating to buildings, objects, and/or locations. Additionally, in another embodiment, a maximum distance calculated to a contact's location may be set by the user (e.g. 100 miles, 5 blocks, etc.).

As shown, a share GUI may be displayed. See operation 2808. In one embodiment, the share GUI may be an interface of an application, a separate stand-alone application (e.g. a shared GUI application, etc.), a feature associated with the ticket and/or deal interface, associated with the OS/platform native utility, and/or associated with a mobile device in any manner. In one embodiment, a share GUI may be viewed through a locked screen (e.g. pull down display, notification, etc.), a widget, an online portal, an online application (e.g. HTML5 app, etc.), and/or through any interface associated with the mobile device. In another embodiment, the share GUI may be viewed on a separate computing device (e.g. desktop computer, laptop, etc.) and/or on any other device. Of course, in other embodiments, the share GUI may be capable of being viewed utilizing a browser.

In one embodiment, the share GUI may include the tickets and/or deals purchased, any communication (e.g. chats, emails, SMS, tec.) associated with the event, an ETA of the participants (e.g. on a map, in a list, by thumbnails, on a time graph, etc.), a map including the location of the participants, photos taken by any of the participants (e.g. photos shared to all participants, etc.), voicemails (e.g. including voice to text transcription, etc.), notes (e.g. comments, blog posts, social media posts, etc.), data files (e.g. documents, presentations, etc.), lists (e.g. to-do lists, etc.), multimedia files (e.g. video, audio recording, etc.), reservations (e.g. hotel, flights, car, etc.), expenses (e.g. billing log, expense log, etc.), password management (e.g. allocation of temporary password for onsite access, etc.), whiteboard integration (e.g. corroboration notebook, etc.), lost device management (e.g. ability to track down a device associated with another participant, etc.), itinerary (e.g. of event, of planned meetings, etc.), and/or any information and/or data which may be associated with the ticket and/or deal in some manner.

As shown, contact information is received. See operation 2810. In one embodiment, the contact information may be selected (e.g. via map, camera, gallery, contact database, social media database, etc.) and/or may be manually inputted (e.g. type in email address, name, address, etc.), utilizing the share GUI of operation 2808. Of course, the contact information may be inputted in any manner. In a further embodiment, the contact information may be inputted by voice commands (e.g. speak and/or spell name, etc.) and/or by any other inputting mechanism.

In another embodiment, contact information may be received by a contact request. For example, in one embodiment, a contact may request a ticket and/or deal from the user, including sending the user a message (e.g. application request, chat, SMS message, email, etc.), a social media communication (e.g. posting, response, etc.), and/or any other communication which may include a request. In one embodiment, a request may be associated with a specific ticket and/or deal (e.g. “I heard you have an extra ticket. Could I have one?,” etc.). In another embodiment, a request may not be associated with a specific ticket and/or deal (e.g. “Do you know of any good food deals?,” etc.). As such, contact information may be received either by a request by the user (e.g. search in database, manual input, etc.), as the result of a request by a contact, and/or as the result of any other manner of obtain contact information.

In one embodiment, contact information may remain hidden from the user. For example, in one embodiment, a user may select a contact (e.g. based on their name, id, etc.) but additional information (e.g. location, email address, place of work, telephone numbers, etc.) may remain hidden from the user. In one embodiment, the level of access to a contact's information (e.g. address, telephone, etc.) may be dependent on a level of trust (e.g. designation as “friend,” acceptance into a circle of digital connections, etc.) established between the user and the contact.

In another embodiment, contact information may be received relating to an online dating site. For example, in one embodiment, a user may receive and/or purchase two or more tickets and/or deals. The user may apply filters through the online dating site to refine a potential applicable recipient to the ticket and/or deal. After selecting the intended recipient, the user may send a guest copy version of the ticket/deal and/or invite. In such an embodiment, the user may remain the owner (e.g. ability to control, etc.) of all purchased tickets/deals and/or invites, but may share a guest version (e.g. ability to see event, seat assignment, etc.) with a recipient. The recipient may accept the guest version of the ticket/deal and/or invite, and may establish a connection (e.g. level of trust, etc.) associated with the user.

In another embodiment, the contact information may be gleaned from the ticket/deal. For example, if the user included such contact information (e.g. name, phone number, e-mail address, or portion thereof, etc.) in purchasing a ticket, such contact information may itself be used to perform operation 2810, or part of it (e.g. phone number, name, etc.) be used as a key/look-up term in a contact database to identify a desired portion (e.g. e-mail address, etc.) in operation 2810, to allow for subsequent sharing.

As shown, a user may send shared ticket/deal and/or invite. See operation 2812. In one embodiment, a user may send a shared ticket/deal and/or invite through a messaging interface and/or platform (e.g. chat, email, SMS, etc.). In another embodiment, the user may send a shared ticket/deal and/or invite through a postal service (e.g. mail ticket/deal and/or deal through FedEx, UPS, USPS, etc.). In one embodiment, the user may send shared ticket/deal and/or invite to a central database management system. For example, in various embodiments, a central database management system may include a CRM system, a social media site, a contact database system, and/or any other type of system whereby the user may send shared ticket/deal and/or invite.

As shown, it is determined whether the shared ticket/deal and/or invite is accepted. See determination 2814. If the shared ticket/deal and/or invite is accepted, the date/time criteria and contact info is defined and stored. See operation 2818. If the shared ticket/deal and/or invite is not accepted, a decline notice is sent. See operation 2816.

In one embodiment, the shared ticket/deal and/or invite may be accepted by sending a return message (e.g. return confirmation, social media posting, email, SMS, chat, etc.), taking an action (e.g. click “confirm” in the sent shared ticket/deal and/or ticket, click link to confirm, fill in and submit billing and/or payment information, telephone the user, etc.), and/or act in some manner to confirm acceptance of a ticket/deal and/or invite. In another embodiment, the shared ticket/deal and/or invite may be declined by sending a return message (e.g. social media posting, email, SMS, chat, etc.), taking an action (e.g. click “decline” in the sent shared ticket/deal and/or ticket, click link to decline, etc.), and/or act in some manner to decline acceptance of a ticket/deal and/or invite. In one embodiment, a lack of response and/or of action taken by the recipient may trigger an automatic decline notice (e.g. reply, etc.). In another embodiment, the shared ticket/deal and/or invite may have a predefined period (e.g. within the next 5 days, etc.) where the recipient may choose to accept, and if acceptance is not given within the predefined period, then the shared ticket/deal and/or invite may be presumed to be declined and a decline notice may be sent.

In other embodiments, the user may choose automatic settings relating to a sent shared ticket/deal and/or invite (e.g. read receipt confirmation, time constraint(s), password confirmation, etc.) In one embodiment, the user may require a password as a condition to accepting (e.g. as given by central department, as given through a confirmation and/or separate email, as given through an online portal, etc.). In a further embodiment, as a condition to accepting, the recipient may input additional information (e.g. name, address, telephone, driver's license, passport number, credit card, etc.). Of course any information and/or action may be requested of the user as a condition to acceptance.

In another embodiment, the acceptance may be associated with a security measure. For example, in various embodiments, security verification may be applied as a condition to acceptance by the user, including fingerprint verification, image verification (e.g. photo taken by the camera, etc.), audio verification, retina verification, and/or any type of security feature. In a separate embodiment, security verification may be associated with safety, including passing a breath analyzer (e.g. breathalyzer, etc.), verifying a location (e.g. acceptance based on location, etc.), passing an identity verification test (e.g. using fingerprint, photo image, audio, retina, etc.), and/or implementing and/or using any test associated with safety. In a further embodiment, the security verification may relate to travel, including passing through security check-points, checking in and/or retrieving baggage, passing through international customs, and/or any other action and/or location relating to travel.

In one embodiment, if a decline notice is given, an action may be taken. For example, in one embodiment, a user may select another contact to send the shared ticket/deal and/or invite. In another embodiment, the OS/platform native utility and/or application may automatically select another contact and send a shared ticket/deal and/or invite. In one embodiment, the user may preselect a hierarchy of many potential recipients. In such an embodiment, if one recipient sends a decline notice, the next recipient (in the hierarchy) may be sent the shared ticket/deal and/or invite. In another embodiment, based off of the parameters the user used to select the initial contact recipient, the OS/platform native utility and/or any application may apply the same filters to determine another potential recipient. In one embodiment, the OS/platform native utility may verify the automatic selection with the user before sending the shared ticket/deal and/or invite.

In a separate embodiment, a recipient may initially accept the shared ticket/deal and/or invite. At a later time, however, the recipient may cancel the accepted shared ticket/deal and/or invite. The cancellation may cause a decline notice to be sent to the user.

In one embodiment, the acceptance of the shared ticket/deal and/or invite may be automatized through an application. For example, in one embodiment, an email application may be associated with a calendar application, which may identify that the shared ticket/deal and/or invite is associated with a date. The calendar application may verify if the recipient is available on the requested date and time, and take an additional action, including sending a decline notice, accepting the shared ticket/deal and/or invite, and/or taking any other action. In one embodiment, the user may predefine availability times. In another embodiment, the calendar application may consider expected reoccurring and/or expected events. In a further embodiment, if a shared ticket/deal and/or invite occurs predominately (e.g. a majority of the time, tec.) during an availability time, the calendar application may request input from the user (e.g. acceptance, decline, etc.).

In a further embodiment, a shared ticket/deal and/or invite may be sent to many parties simultaneously (e.g. when the user has acquired many tickets to share, etc.). In such an embodiment, the OS/platform native utility and/or any application used may send shared ticket/deal and/or invite, manage notices and/or acceptances and/or replies (e.g. collect responses, etc.), and/or apply automatic actions, including sending shared tickets/deals and/or invites when a decline notice is given and/or when a cancellation notice is given. In a further embodiment, the shared tickets/deals and/or invites may be associated with a CRM system, including sending tickets/deals and/or invites to many individuals, groups, classes and/or classifications of recipients, and managing the responses (e.g. acceptances, declines, etc.) from all recipients.

In one embodiment, date/time criteria and contact info may be stored in the OS/platform native utility, and/or an application (e.g. calendar, email, etc.), and/or in any location associated with the user's mobile device. In one embodiment, the date/time criteria and contact info may be stored in an online database system (e.g. social media site, etc.). In another embodiment, the online database system may provide a mobile device portal (e.g. web portal, application, etc.) to access the information managed by the online database system. In a further embodiment, the online database system may sync information between the mobile device and an online storage system.

In various embodiments, date/time criteria and contact info may be defined, including, for example, the manner in which it is displayed (e.g. on the application, on a locked screen, within a widget, etc.), associated with notifications (e.g. time of reminder, triggers associated with notifications, etc.), associated with applications (e.g. inputted into calendar, telephone contact information inputted into phone contacts, etc.), and/or associated with the mobile device in any manner. In another embodiment, the notification(s) associated with the ticket/deal and/or invite may be associated with a trigger, including being based off of location, time, device proximity (e.g. distance between the user mobile device and another device, etc.), friend proximity (e.g. distance between the user and associated friends and/or contacts, etc.), signal strength, battery life, and/or any other factor which may be associated with a notification trigger.

In one embodiment, the date/time criteria and contact info may be inputted manually by the user. In various other embodiments, the date/time criteria and contact info may be collected from another source, including extracting the information from a digital ticket, a message (e.g. email, text, SMS, etc.), an application (e.g. containing information relating to a ticket and/or deal, etc.), an image (e.g. photo of event information, rasterized image, text-searchable pdf, etc.), and/or obtaining the information in some manner from any source associated with the ticket/deal and/or invite.

As shown, it is determined whether criteria is triggered. See determination 2820. If criteria is triggered, alert/allow sharing is sent, and date/time criteria and contact info is defined and stored. See operation 2822 and 2818. If criteria is not triggered, it is determined whether date/time has elapsed. See determination 2824. If date/time has elapsed, post-activity sharing ticket/deals occurs. See operation 2826. If date/time has not elapsed, date/time criteria and contact info is defined and stored. See determination 2824 and operation 2818.

In one embodiment, a criteria may be triggered by a location, time, device proximity (e.g. distance between the user mobile device and another device, etc.), friend proximity (e.g. distance between the user and associated friends and/or contacts, etc.), signal strength, battery life, and/or any other factor which may cause the criteria to be triggered. In another embodiment, a criteria may be associated with a notification (e.g. a reminder, alert, etc.), a scheduled event (e.g. time, etc.), a sensor (e.g. light sensor, proximity sensor, GPS, etc.), and/or with any other sensor and/or feature which may relate to triggering a criteria. In various embodiments, the criteria may be stored with an application (e.g. business-specific application, app associated with Ticketmaster, etc.), an OS/platform native utility (e.g. management of all applications, device settings, etc.), may be pushed from an application (or any source) to the OS/platform native utility, may be pulled from any source by the OS/platform native utility and/or any other application, may be stored on a user mobile device, on another device, and/or on a cloud computing device (e.g. online server, central site, etc.), and/or may be stored in association with any software code (e.g. application, etc.) and/or hardware feature (e.g. device memory, etc.).

In another embodiment, all criteria associated with a shared ticket/deal and/or invite may be sent to an application and/or OS/platform native utility. In one embodiment, criteria may be sent (e.g. pushed, etc.) at any time up until the shared ticket/deal and/or invite begins. In another embodiment, criteria may be sent (e.g. pushed, etc.) at any time until the shared ticket/deal and/or invite ends.

In one embodiment, if a criteria is triggered, an alert/allow sharing may be sent. In another embodiment, the alert/allow sharing may be associated with associated with accepting the shared ticket/deal and/or invite. For example, in one embodiment, the alert/allow sharing may be a prerequisite to accepting the shared ticket/deal and/or invite. In another embodiment, the user controls the sending of alerts and/or allowing sharing. For example, in one embodiment, the user may wish to receive alerts (e.g. notifications, reminders, updates, etc.) but to not share the user's location with other participants. In such an embodiment, the user may remain in control of the sharing settings and/or alerts associated with the shared ticket/deal and/or invite. In a separate embodiment, the user (i.e. source of the shared ticket/deal and/or invite, etc.) may retain control of the sharing settings and/or alerts associated with the shared ticket/deal and/or invite.

In another embodiment, the allow sharing may be associated with a location (e.g. user's location, location of mobile device, location of intended destination, etc.), an update (e.g. sharing of information by posting to a blog, social media site, etc.), people (e.g. exchange of digital business cards, update list of friends at event, etc.), and/or any other feature and/or object and/or person which may be associated with the shared ticket/deal and/or invite.

In one embodiment, if criteria is not triggered, it is determined whether date/time has elapsed. For example, in one embodiment, a threshold amount of time (e.g. 1 hour, etc.) may have passed since a criteria was last triggered. In such an embodiment, the threshold amount of time may be set by the user, by an application, by an OS/platform native utility, and/or by any other application and/or user (e.g. developer, creator, etc.). In another embodiment, the date/time elapsed may be associated with information stored associated with the date/time criteria and contact info. For example, in one embodiment, the date/time criteria and contact info may include information indicating the end of the event (e.g. date and time of the end of the event, etc.).

In another embodiment, the date/time elapsed may be dependent on the criteria triggered. For example, in one embodiment, criteria triggered may continue even after an event has ended (e.g. parking conditions to exit the event, updates to emergency situation, safety guidelines when exiting, ability to purchase post concert memorabilia, etc.). In such an embodiment, even though the indicated time of the end of the event may have passed, the date/time elapsed will not occur until the criteria triggered no longer occurs.

In one embodiment, if the date/time has elapsed, then post-activity sharing ticket/deals may occur, including sharing (e.g. posting to central server, posting to online server, posting to social media site, emailing, etc.) data items (e.g. photos, videos, documents, voice recordings, videos, SMS, etc.), applying metadata to data items (e.g. tag photos with metadata obtained from digital ticket, embed metadata into object based on defined and stored date/time criteria and contact info and/or shared ticket/deal and/or invite, etc.), geotag data item (e.g. apply coordinates to photo and/or any data item, etc.), organize and/or collect information (e.g. emails, tickets, deals, invite, SMS, voice recordings, text-to-speech transcriptions, etc.) associated with shared ticket/deal and/or invite, and/or providing any additional information and/or feature after the shared ticket/deal and/or invite has ended. In one embodiment, the post-activity sharing ticket/deals may provide a search function, including permitting the user to search for any item (e.g. contact list, data item, location, time, notes, comments, etc.) associated with the shared ticket/deal and/or invite.

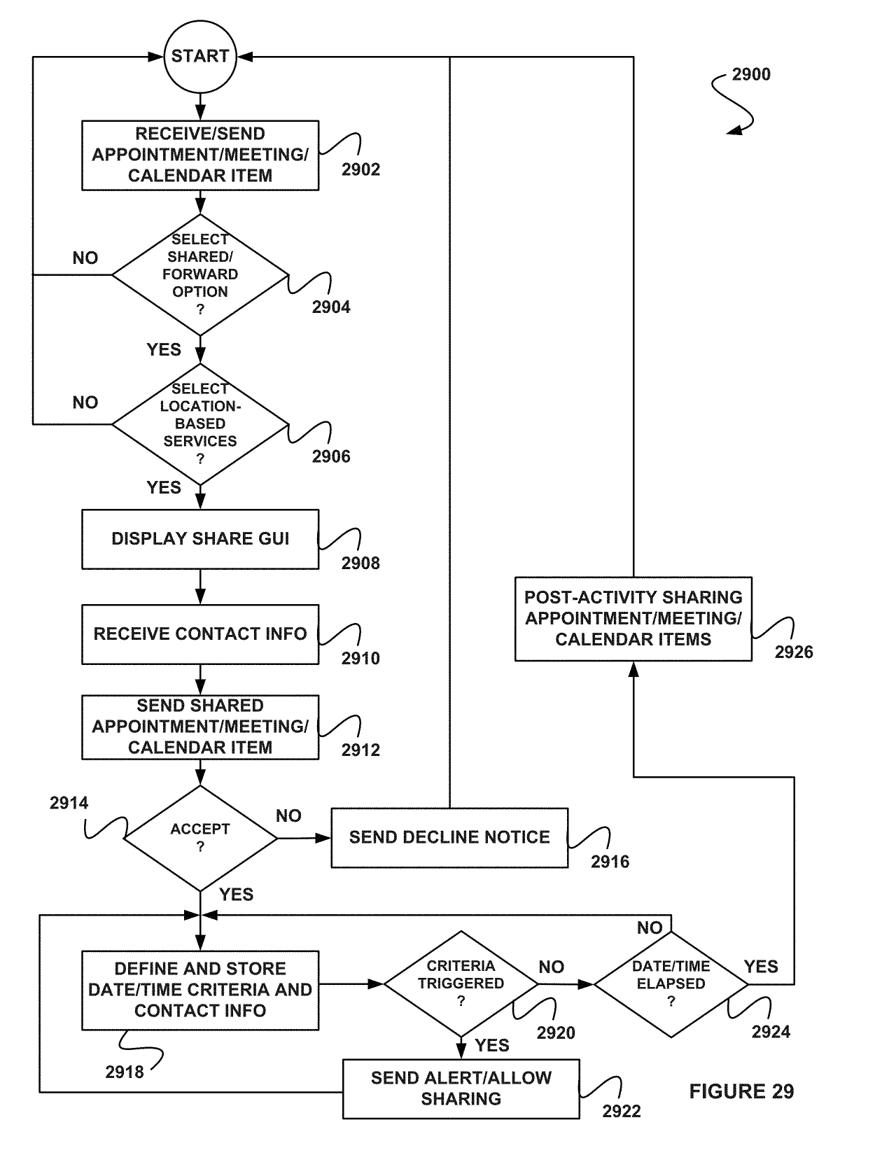

FIG. 29 shows a method 2900 for presenting contextual advertisements, in connection with a mobile device, in accordance with another embodiment. As an option, the mobile device interface 2900 may be implemented in the context of the architecture and environment of the previous Figures and/or any subsequent Figure(s). Of course, however, the mobile device interface 2900 may be implemented in the context of any desired environment. It should also be noted that the aforementioned definitions may apply during the present description.

As shown, a user (or a mobile device associated therewith, an OS associated therewith, etc.) receives and/or sends an appointment/meeting/calendar item. See operation 2902. In various embodiments, the user may create an appointment/meeting/calendar item, including creating a business meeting (or any meeting), creating an appointment (e.g. with client, with a doctor, etc.), creating a calendar item (e.g. concert event, entertainment event, travel event, etc.). In various other embodiments, the user may receive an appointment/meeting/calendar item, including from an entity associated with an event (e.g. concert, etc.), entertainment (e.g. scuba, movies, tour, theme park, racing, haunted mansion, etc.), medical (e.g. doctor visit, dental checkup, plastic surgery, etc.), business (e.g. conference, trade show, etc.), home improvement (e.g. car wash, remodel, etc.), beauty (e.g. haircut, manicure, etc.), food (e.g. restaurants, cafes, bars, happy hour, etc.), sports, travel (e.g. airline ticket, hotel tickets, car rental, etc.), and/or any type of event with which an appointment/meeting/calendar item may be associated.

In one embodiment, the user may create an appointment/meeting/calendar item for personal use. For example, in one embodiment, the user may have received an ad and/or content (e.g. discount vacation deal, etc.) relating to travel. In response, the user may create a calendar item (e.g. travel dates) relating to the travel ad and/or content (e.g. discount vacation deal, etc.). In such an embodiment, all items (e.g. airfare ticket, hotel deal, etc.) may be managed (i.e. saved and/or organized in one central location, etc.) by an application and/or an OS/platform native utility. Of course, the user may find an airfare ticket and/or hotel deal not related to an ad and/or content and which may also be managed (e.g. discovered and organized, etc.) by an application and/or an OS/platform native utility.

In another embodiment, the user may create an appointment/meeting/calendar item for use by another individual (e.g. friend, family member, etc.). For example, in one embodiment, the user may receive an ad and/or content and in response, create an appointment/meeting/calendar item (e.g. concert event details including time and location, etc.). The user may share (e.g. forward on, send, etc.) the created appointment/meeting/calendar item with another contact (e.g. business contact, family, friend, etc.). In another embodiment, the user may create an appointment/meeting/calendar item through an online portal (e.g. online calendar system, etc.) and then may share the created appointment/meeting/calendar item with another contact. In such an embodiment, the created appointment/meeting/calendar item may be synced to the user mobile device (e.g. via application, OS/platform native utility, etc.) and/or managed by the mobile device (e.g. information related to the created item may be compiled and/or collected, etc.).

As shown, it may be determined whether the user selects a shared/forward option. See determination 2904. In one embodiment, the user may share the created appointment/meeting/calendar item as an invite to another contact. For example, in one embodiment, the user may create an appointment/meeting/calendar item to an entertainment event (e.g. ticket to a motorcycle rally, etc.). The user may send the created appointment/meeting/calendar item as an invite to another contact (e.g. a friend who likes motorcycles, etc.). In another embodiment, the user may have initially created the appointment/meeting/calendar item for personal use, but at any time, may discover that the user will be unable to attend the event. In such an embodiment, the user may retain control (e.g. delete, modify, etc.) of the appointment/meeting/calendar item, transfer ownership of the appointment/meeting/calendar item to another (e.g. friend, contact, etc.), and/or otherwise manipulate the appointment/meeting/calendar item in any manner.

Further, in various embodiments, the user may receive (e.g. rather than creating and/or sending, etc.) an appointment/meeting/calendar item. In response to the receipt of the appointment/meeting/calendar item (e.g. via notification, email, application, OS/platform native utility, etc.), the user may keep the appointment/meeting/calendar item for personal use (e.g. save, create calendar entry, etc.), share the appointment/meeting/calendar item (e.g. send as a gift, etc.) with another contact, and/or send information relating to the appointment/meeting/calendar item (e.g. date, time, location, where and how to purchase, etc.) to another contact.

In one embodiment, the user may create and/or receive one or more appointment/meeting/calendar items (e.g. multiple appointments, etc.). In such an embodiment, the user may share and/or delegate an appointment/meeting/calendar item another contact. For example, in one embodiment, the user may share and/or forward (e.g. via email, via SMS, via social networking site, via postal mail service, via online ticket site such as Ticketmaster, etc.) an appointment/meeting/calendar item to another contact. In one embodiment, the user may remain the owner of the appointment/meeting/calendar item. In another embodiment, the recipient may become the new owner of the appointment/meeting/calendar item.

In a further embodiment, the user may receive one or more appointment/meeting/calendar items with a time conflict (e.g. multiple meetings scheduled for the same time, etc.). In such an embodiment, the OS/platform native utility may automatically adjust the request for multiple meetings (e.g. move one or more meetings to another available time slot, email participants to schedule another time slot, cancel meeting, etc.). In one embodiment, the user may set levels of priority (e.g. based on incoming event priority designation, based on meeting type, based on participants, etc.) and/or actions (e.g. schedule meeting, move meeting to another time, email participants, etc.) associated with the appointment/meeting/calendar item.

In one embodiment, the user may share information relating to an appointment/meeting/calendar item. For example, in one embodiment, the user may forward on (e.g. via email, social networking site, etc.) the appointment/meeting/calendar item, forward on information associated with the appointment/meeting/calendar item, and/or share the appointment/meeting/calendar item in any manner (e.g. post to blog, post to social networking site, etc.). In response to the receipt of the information relating to a appointment/meeting/calendar item, a first contact may be invited to participate in the appointment/meeting/calendar item and/or share (e.g. forward on, etc.) the appointment/meeting/calendar item to other contacts associated with the first contact.

In another embodiment, the appointment/meeting/calendar item may be dynamic and change. For example, in one embodiment, the appointment/meeting/calendar items may include early bird pricing, last minute availability, and/or any other type of pricing scenario. In such an embodiment, tickets, seats, pricing, and/or any other element may change in response to availability and/or demand as associated with the appointment/meeting/calendar item.

In one embodiment, the appointment/meeting/calendar item may be associated with the user of the mobile device. For example, in one embodiment, the user may forward on and/or share the appointment/meeting/calendar item with contacts. In response, some of the contacts may purchase the ticket and/or deal. The appointment/meeting/calendar item associated with the user (i.e. as displayed on the user's mobile device, etc.) may change in response to action(s) (e.g. purchase, relevant sharing, etc.) taken from those with whom the appointment/meeting/calendar item was shared. For example, in one embodiment, the user may share an invite to attend a special lunch at Bob's Diner with relevant friends in the geographic area. In one embodiment, the more invites a user sends out, the more reward (e.g. coupons, discounts, etc.) Bob's Diner may give to the user. In such an embodiment, the more the user shares the appointment/meeting/calendar item, the more the user may potentially be rewarded as associated with the appointment/meeting/calendar item.

In various embodiments, an appointment/meeting/calendar item may be shared by a messaging platform (e.g. email, SMS, chat, etc.), a social networking platform (e.g. Facebook, etc.), a blog platform (e.g. Blogger, Wordpress, etc.), a map interface, a CRM platform (e.g. Microsoft CRM, SAP AG, etc.), a camera interface, and/or any other platform and/or interface whereby an appointment/meeting/calendar item may be shared. In one embodiment, the application (e.g. app downloaded on phone, OS/platform native utility, etc.) displaying the appointment/meeting/calendar item may include an option to share (e.g. “share” button, “send” option, etc.). Selecting the share option may include a further option to share by camera, by map, by email, by social media. Selecting the map option may display a map interface. In one embodiment, contacts of the user may be displayed on the map (e.g. graphic and/or text and/or object which represents a user, etc.). The user may individually select a contact with whom the appointment/meeting/calendar item may be shared, and/or may select multiple contacts simultaneously (e.g. selecting each contact to be included, draw circle and/or a perimeter around the contacts, etc.).

In another embodiment, the user may use an object (e.g. circle, etc.) to define the perimeter within which contacts may receive the appointment/meeting/calendar item. In one embodiment, the home location of each contact may be displayed. In another embodiment, the real time location of each contact may be displayed (e.g. display contacts nearest the user, etc.). For example, the user may use the map interface to select a circumference within which the home location of the user's contacts will be included. The user may restrict the circumference of the circle, and/or broaden the circumference to include more contacts. After selecting the perimeter of the geographic area to be included, the user may finalize the selection (e.g. send all contacts contained within the selected area the ticket and/or deal, etc.).

In one embodiment, the user may select to share the appointment/meeting/calendar item by camera. For example, in one embodiment, after receiving an appointment/meeting/calendar item, the user may select to share via the camera option. The camera application may be displayed. The user may take a photo of a contact. In such an embodiment, the mobile device may include facial recognition software to determine the identity of the contact. In one embodiment, the user may take a photo including more than one contact. In such an embodiment, the mobile device may determine the identity of each of the contacts. For example, the user may take a photo of 6 friends. The mobile device may determine automatically (e.g. based off of facial recognition on the mobile device, based off of facial recognition associated with a social networking site and/or online site, etc.) the identity of each contact. After determining the identity of the contact, the application and/or OS/platform native utility may send the appointment/meeting/calendar item to the identified contact(s) from the photo. In one embodiment, the user may take multiple photos, with each photo indicating a separate contact (i.e. recipient, etc.) of the ticket and/or deal.

In one embodiment, the user may take a photo of a location and/or object. Based off of the object and/or location, the mobile device may determine an identity of a contact associated with the object and/or location. For example, in one embodiment, the user may take a photo of Yahoo, and all of the user's contacts associated with Yahoo may receive the appointment/meeting/calendar item. In another embodiment, the user may take a photo of an instrument (e.g. piano, violin, guitar, etc.), and all of the user's contacts associated with the instrument (or a more general class of music, etc.) may be sent the appointment/meeting/calendar item. Of course, the user may control the settings applied to groupings of people and/or association of people to objects, locations, and/or images.

In another embodiment, the user may take an audio recording, and based on the audio recording, the mobile device may determine a relevant identity of an intended recipient. For example, in one embodiment, the user may state “male contact with dark hair and green eyes,” and a result fitting the parameter may be returned. In another embodiment, the user may record an audio clip of a song (e.g. music, etc.), an event (e.g. the circus, fair, etc.), and/or any other object, location, and/or person which may be associated with a sound. As a further example, in one embodiment, the user may record the busy sounds of a house, an office, and/or any other location. A mobile device, online site, social networking site, and/or any other source may determine the location based off of the sound (e.g. Disneyland theme song, voices of each family member, etc.). Based off of the recording, a relevant identify of a contact may be determined.

In one embodiment, a GPS signal may be used to determine an identity of contacts to whom the appointment/meeting/calendar item should be sent. For example, in one example, the user may select to share the appointment/meeting/calendar item via GPS. The GPS application may be activated and determine the location of the user. The user may input a numerical radius (e.g. within 1 mile, etc.) to determine the range within which contacts should be found. The results may be displayed in a list format, by thumbnails, and/or in any other manner. After viewing the results, the user may expand, restrict, and/or modify the applicable range in any manner. The user may then accept the results and finalize the sending (e.g. sending the appointment/meeting/calendar item to the displayed and/or listed contacts, etc.). As an example, a user may create a lunch calendar item (e.g. meet up at lunch location, etc.). The user may choose to share the deal with contacts via GPS. The user may select to view individuals within 5 blocks of the user. After viewing the results, the user may send the appointment/meeting/calendar item to the contacts listed.

In another embodiment, the user may personalize the appointment/meeting/calendar item. For example, in one embodiment, the user may add a comment and/or message to the appointment/meeting/calendar item. In another embodiment, the user may add a photo, multimedia (e.g. video, etc.) and/or any other object and/or personalization. In a further embodiment, the user may add a priority tag to the appointment/meeting/calendar item. For example, in one embodiment, the user may receive a time sensitive calendar item, such as a new meeting scheduled in 2 hours. The user may attach a time sensitive tag (e.g. send to participants with high priority, etc.), and/or any tag to indicate time sensitivity.

As shown, it is determined whether the user selects location-based services. See determination 2906. In one embodiment, the location-based services may include real-time contact location, notifications (e.g. location may trigger notifications, etc.), navigation (e.g. road navigation to an address location, navigate contacts to a specific meet-up spot for example within a building, etc.), geo-tag photos taken at the location relating to the ticket and/or deal, update social networking site (e.g. LinkedIn, Facebook, etc.) with user's location, estimated time of arrival (ETA) map of all individuals participating in the ticket and/or deal, real-time feeds from the location (e.g. parking lot is full, 30 minute wait in line, etc.), social networking integration (e.g. upload and/or posting of location and message relating to the ticket and/or deal, etc.), geo-tracking (e.g. record track and/or path taken by each participant, etc.), tagging any data file (e.g. voice recording, video, SMS, email with location metatag information during the time relating to the ticket and/or deal, etc.), recommending additional social events (e.g. you may enjoying interacting with individual A, etc.), asset tracking (e.g. GPS tracking device within a container and/or object, product tracking, etc.), check-ins (e.g. Foursquare, etc.), calling a vehicle (e.g. taxi, ambulance, etc.), identifying objects or persons or buildings (e.g. recognition and identification of surroundings, etc.), managing traffic (e.g. best route, etc.), billing (e.g. automatic billing for road tolls, etc.), scheduling (e.g. fleet management, etc.), accessing news (e.g. news relating to the location, etc.), tour guides (e.g. relating to the location, etc.), ability to play a game (e.g. hide and seek, etc.), directory services (e.g. Yellow Pages, Google, etc.), weather reports, points of interest (e.g. gas stations, restaurants, etc.), and/or any other service which may be relevant to location.

In one embodiment, for example, after the user has selected to share an appointment/meeting/calendar item (e.g. business meeting, etc.) with a contact (e.g. client, business contact, etc.), the user may select to enable location based services. If the contact accepts to attend the concert, the location based services may permit the users to interact before, during, and after the event. For example, in one embodiment, the location based services may help navigate each individual to the intended destination. Once at the destination, the location based services may help the individuals meet up at a prearranged location. At all times, the location based services may provide an ETA for each individual coming to the event. During the event, an individual may take a photo which may be then automatically uploaded to a social media site with appropriate metatags (e.g. location, event information, etc.). After the event, the location services may recommend additional social events and/or interests to the individuals.

In another embodiment, the ability to select location based services may provide for temporary location sharing. For example, in one embodiment, the user's location may be shared with other participants for a set amount of time. In one embodiment, the user may determine the start and end times of when the location based services may be in effect (e.g. remain active, etc.). In another embodiment, each participating individual may further restrict the time of applicability relating to the location based services. In a further embodiment, a participant may choose to hide his or her location but may receive location updates from other participants. In another embodiment, the user may require, as a condition of acceptance, the activation of location based services. Further yet, the developer and/or creator of the ticket and/or deal may set the conditions and/or requirements for temporary location sharing.

In one embodiment, the user may manually configure the location. For example, in some embodiments, the location of the user may not be precise (e.g. reliance on carrier triangulation rather than GPS, etc.), and so may be corrected and/or refined by the user. In one embodiment, the user may input custom location labels (e.g. Bob's favorite restaurant, etc.) relating to buildings, objects, and/or locations. Additionally, in another embodiment, a maximum distance calculated to a contact's location may be set by the user (e.g. 100 miles, 5 blocks, etc.).

As shown, a share GUI may be displayed. See operation 2908. In one embodiment, the share GUI may be an interface of an application, a separate stand-alone application (e.g. a shared GUI application, etc.), a feature associated with the appointment/meeting/calendar item interface, associated with the OS/platform native utility, and/or associated with a mobile device in any manner. In one embodiment, a share GUI may be viewed through a locked screen (e.g. pull down display, notification, etc.), a widget, an online portal, an online application (e.g. HTML5 app, etc.), and/or through any interface associated with the mobile device. In another embodiment, the share GUI may be viewed on a separate computing device (e.g. desktop computer, laptop, etc.) and/or on any other device.

In one embodiment, the share GUI may include the appointment/meeting/calendar item created, any communication (e.g. chats, emails, SMS, tec.) associated with the event, an ETA of the participants (e.g. on a map, in a list, by thumbnails, on a time graph, etc.), a map including the location of the participants, photos taken by any of the participants (e.g. photos shared to all participants, etc.), voicemails (e.g. including voice to text transcription, etc.), notes (e.g. comments, blog posts, social media posts, etc.), data files (e.g. documents, presentations, etc.), lists (e.g. to-do lists, etc.), multimedia files (e.g. video, audio recording, etc.), reservations (e.g. hotel, flights, car, etc.), expenses (e.g. billing log, expense log, etc.), password management (e.g. allocation of temporary password for onsite access, etc.), whiteboard integration (e.g. corroboration notebook, etc.), lost device management (e.g. ability to track down a device associated with another participant, etc.), itinerary (e.g. of event, of planned meetings, etc.), and/or any information and/or data which may be associated with the appointment/meeting/calendar item in some manner.

As shown, contact information is received. See operation 2910. In one embodiment, the contact information may be selected (e.g. via map, camera, gallery, contact database, social media database, etc.) and/or may be manually inputted (e.g. type in email address, name, address, etc.). Of course, the contact information may be inputted in any manner. In a further embodiment, the contact information may be inputted by voice commands (e.g. speak and/or spell name, etc.) and/or by any other inputting mechanism.

In another embodiment, contact information may be received by a contact request. For example, in one embodiment, a contact may request an appointment/meeting/calendar item from the user, including sending the user a message (e.g. application request, chat, SMS message, email, etc.), a social media communication (e.g. posting, response, etc.), and/or any other communication which may include a request. In one embodiment, a request may be associated with a specific appointment/meeting/calendar item (e.g. “I heard you have a have an appointment to see the President. Can I come along?,” etc.). In another embodiment, a request may not be associated with a specific appointment/meeting/calendar item (e.g. “Can I see the President sometime?,” etc.). In such an embodiment, the request may be handled by another individual other than the user (e.g. a secretary, etc.). As such, contact information may be received either by a request by the user (e.g. search in database, manual input, etc.), as the result of a request by a contact, and/or as the result of any other manner of obtain contact information.

In one embodiment, contact information may remain hidden from the user. For example, in one embodiment, a user may select a contact (e.g. based on their name, id, etc.) but additional information (e.g. location, email address, place of work, telephone numbers, etc.) may remain hidden from the user. In one embodiment, the level of access to a contact's information (e.g. address, telephone, etc.) may be dependent on a level of trust (e.g. designation as “friend,” acceptance into a circle of digital connections, etc.) established between the user and the contact. In a separate embodiment, the creation of appointment/meeting/calendar item may relate to social online dating and the ability to set up appointments and/or event items between one or more individuals.

As shown, a user may send shared appointment/meeting/calendar item. See operation 2912. In one embodiment, a user may send a shared appointment/meeting/calendar item through a messaging interface and/or platform (e.g. chat, email, SMS, etc.). In another embodiment, the user may send a shared appointment/meeting/calendar item through a postal service (e.g. mail invite through FedEx, UPS, USPS, etc.). In one embodiment, the user may send shared appointment/meeting/calendar item to a central database management system. For example, in various embodiments, a central database management system may include a CRM system, a social media site, a contact database system, and/or any other type of system whereby the user may send shared appointment/meeting/calendar item.

As shown, it is determined whether the shared appointment/meeting/calendar item is accepted. See determination 2914. If the shared appointment/meeting/calendar item is accepted, the date/time criteria and contact info is defined and stored. See operation 2918. If the shared appointment/meeting/calendar item is not accepted, a decline notice is sent. See operation 2916.

In one embodiment, the shared appointment/meeting/calendar item may be accepted by sending a return message (e.g. return confirmation, social media posting, email, SMS, chat, etc.), taking an action (e.g. click “confirm” in the sent appointment/meeting/calendar item, click link to confirm, fill in and submit billing and/or payment information, telephone the user, etc.), and/or act in some manner to confirm acceptance of an appointment/meeting/calendar item. In another embodiment, the shared appointment/meeting/calendar item may be declined by sending a return message (e.g. social media posting, email, SMS, chat, etc.), taking an action (e.g. click “decline” in the sent shared appointment/meeting/calendar item, click link to decline, etc.), and/or act in some manner to decline acceptance of a appointment/meeting/calendar item. In one embodiment, a lack of response and/or of action taken by the recipient may trigger an automatic decline notice (e.g. reply, etc.). In another embodiment, the shared appointment/meeting/calendar item may have a predefined period (e.g. within the next 5 days, etc.) where the recipient may choose to accept, and if acceptance is not given within the predefined period, then the shared appointment/meeting/calendar item may be presumed to be declined and a decline notice may be sent.

In other embodiments, the user may choose automatic settings relating to a sent shared appointment/meeting/calendar item (e.g. read receipt confirmation, time constraint(s), password confirmation, etc.). In one embodiment, the user may require a password as a condition to accepting (e.g. as given by central department, as given through a confirmation and/or separate email, as given through an online portal, etc.). In a further embodiment, as a condition to accepting, the recipient may input additional information (e.g. name, address, telephone, driver's license, passport number, credit card, etc.). Of course any information and/or action may be requested of the user as a condition to acceptance.

In another embodiment, the acceptance may be associated to a security measure. For example, in various embodiments, security verification may be applied as a condition to acceptance by the user, including fingerprint verification, image verification (e.g. photo taken by the camera, etc.), audio verification, retina verification, and/or any type of security feature. In a separate embodiment, security verification may be associated with safety, including passing a breath analyzer (e.g. breathalyzer, etc.), verifying a location (e.g. acceptance based on location, etc.), passing an identity verification test (e.g. using fingerprint, photo image, audio, retina, etc.), and/or implementing and/or using any test associated with safety. In a further embodiment, the security verification may relate to travel, including passing through security check-points, checking in and/or retrieving baggage, passing through international customs, and/or any other action and/or location relating to travel.

In one embodiment, if a decline notice is given, an action may be taken. For example, in one embodiment, a user may select another contact to send the appointment/meeting/calendar item. In another embodiment, the OS/platform native utility and/or application may automatically select another contact and send a shared appointment/meeting/calendar item. In one embodiment, the user may preselect a hierarchy of many potential recipients. In such an embodiment, if one recipient sends a decline notice, the next recipient (in the hierarchy) may be sent the shared appointment/meeting/calendar item. In another embodiment, based off of the parameters the user used to select the initial contact recipient, the OS/platform native utility and/or any application may apply the same filters to determine another potential recipient. In one embodiment, the OS/platform native utility may verify the automatic selection with the user before sending the shared appointment/meeting/calendar item.

In a separate embodiment, a recipient may initially accept the shared appointment/meeting/calendar item. At a later time, however, the recipient may cancel the accepted shared appointment/meeting/calendar item. The cancellation may cause a decline notice to be sent to the user.

In one embodiment, the acceptance of the shared appointment/meeting/calendar item may be automatized through an application. For example, in one embodiment, an email application may be associated with a calendar application, which may identify that the shared appointment/meeting/calendar item is associated with a date. The calendar application may verify if the recipient is available on the requested date and time, and take an additional action, including sending a decline notice, accepting the shared appointment/meeting/calendar item, and/or taking any other action. In one embodiment, the user may predefine availability times. In another embodiment, the calendar application may consider expected reoccurring and/or expected events. In a further embodiment, if a shared appointment/meeting/calendar item occurs predominately (e.g. a majority of the time, tec.) during an availability time, the calendar application may request input from the user (e.g. acceptance, decline, etc.).

In a further embodiment, a shared appointment/meeting/calendar item may be sent to many parties simultaneously (e.g. when the event involves many participants, etc.). In such an embodiment, the OS/platform native utility and/or any application used may send shared appointment/meeting/calendar item, manage notices and/or acceptances and/or replies (e.g. collect responses, etc.), and/or apply automatic actions, including sending shared appointment/meeting/calendar items when a decline notice is given and/or when a cancellation notice is given. In a further embodiment, the shared appointment/meeting/calendar item may be associated with a CRM system, including sending appointment/meeting/calendar item to many individuals, groups, classes and/or classifications of recipients, and managing the responses (e.g. acceptances, declines, etc.) from all recipients.

In one embodiment, date/time criteria and contact info may be stored in the OS/platform native utility, and/or an application (e.g. calendar, email, etc.), and/or in any location associated with the user's mobile device. In one embodiment, the date/time criteria and contact info may be stored in an online database system (e.g. social media site, etc.). In another embodiment, the online database system may provide a mobile device portal (e.g. web portal, application, etc.) to access the information managed by the online database system. In a further embodiment, the online database system may sync information between the mobile device and an online storage system.

In various embodiments, date/time criteria and contact info may be defined, including, for example, the manner in which it is displayed (e.g. on the application, on a locked screen, within a widget, etc.), associated with notifications (e.g. time of reminder, triggers associated with notifications, etc.), associated with applications (e.g. inputted into calendar, telephone contact information inputted into phone contacts, etc.), and/or associated with the mobile device in any manner. In another embodiment, the notification(s) associated with the appointment/meeting/calendar item may be associated with a trigger, including being based off of location, time, device proximity (e.g. distance between the user mobile device and another device, etc.), friend proximity (e.g. distance between the user and associated friends and/or contacts, etc.), signal strength, battery life, and/or any other factor which may be associated with a notification trigger.

In one embodiment, the date/time criteria and contact info may be inputted manually by the user. In various other embodiments, the date/time criteria and contact info may be collected from another source, including extracting the information from a digital ticket, a message (e.g. email, text, SMS, etc.), an application (e.g. containing information relating to an appointment/meeting/calendar item, etc.), an image (e.g. photo of event information, rasterized image, text-searchable pdf, etc.), and/or obtaining the information in some manner from any source associated with the appointment/meeting/calendar item.

As shown, it is determined whether criteria is triggered. See determination 2920. If criteria is triggered, alert/allow sharing is sent, and date/time criteria and contact info is defined and stored. See operation 2922 and 2918. If criteria is not triggered, it is determined whether date/time has elapsed. See determination 2924. If date/time has elapsed, post-activity sharing appointment/meeting/calendar items occurs. See operation 2926. If date/time has not elapsed, date/time criteria and contact info is defined and stored. See determination 2924 and operation 2918.

In one embodiment, a criteria may be triggered by a location, time, device proximity (e.g. distance between the user mobile device and another device, etc.), friend proximity (e.g. distance between the user and associated friends and/or contacts, etc.), signal strength, battery life, and/or any other factor which may cause the criteria to be triggered. In another embodiment, a criteria may be associated with a notification (e.g. a reminder, alert, etc.), a scheduled event (e.g. time, etc.), a sensor (e.g. light sensor, proximity sensor, GPS, etc.), and/or with any other sensor and/or feature which may relate to triggering a criteria. In various embodiments, the criteria may be stored with an application (e.g. business-specific application, app associated with Ticketmaster, etc.), an OS/platform native utility (e.g. management of all applications, device settings, etc.), may be pushed from an application (or any source) to the OS/platform native utility, may be pulled from any source by the OS/platform native utility and/or any other application, may be stored on a user mobile device, on another device, and/or on a cloud computing device (e.g. online server, central site, etc.), and/or may be stored in association with any software code (e.g. application, etc.) and/or hardware feature (e.g. device memory, etc.).

In another embodiment, all criteria associated with an appointment/meeting/calendar item may be sent to an application and/or OS/platform native utility. In one embodiment, criteria may be sent (e.g. pushed, etc.) at any time up until the shared appointment/meeting/calendar item begins. In another embodiment, criteria may be sent (e.g. pushed, etc.) at any time until the shared appointment/meeting/calendar item ends.

In one embodiment, if a criteria is triggered, an alert/allow sharing may be sent. In another embodiment, the alert/allow sharing may be associated with associated with accepting the shared appointment/meeting/calendar item. For example, in one embodiment, the alert/allow sharing may be a prerequisite to accepting the shared appointment/meeting/calendar item. In another embodiment, the user controls the sending of alerts and/or allowing sharing. For example, in one embodiment, the user may wish to receive alerts (e.g. notifications, reminders, updates, etc.) but to not share the user's location with other participants. In such an embodiment, the user may remain in control of the sharing settings and/or alerts associated with the shared appointment/meeting/calendar item. In a separate embodiment, the user (i.e. source of the shared appointment/meeting/calendar item, etc.) may retain control of the sharing settings and/or alerts associated with the shared appointment/meeting/calendar item.

In another embodiment, the allow sharing may be associated with a location (e.g. user's location, location of mobile device, location of intended destination, etc.), an update (e.g. sharing of information by posting to a blog, social media site, etc.), people (e.g. exchange of digital business cards, update list of friends at event, etc.), and/or any other feature and/or object and/or person which may be associated with the shared appointment/meeting/calendar item.

In one embodiment, if criteria is not triggered, it is determined whether date/time has elapsed. For example, in one embodiment, a threshold amount of time (e.g. 1 hour, etc.) may have passed since a criteria was last triggered. In such an embodiment, the threshold amount of time may be set by the user, by an application, by an OS/platform native utility, and/or by any other application and/or user (e.g. developer, creator, etc.). In another embodiment, the date/time elapsed may be associated with information stored associated with the date/time criteria and contact info. For example, in one embodiment, the date/time criteria and contact info may include information indicating the end of the event (e.g. date and time of the end of the event, etc.).

In another embodiment, the date/time elapsed may be dependent on the criteria triggered. For example, in one embodiment, criteria triggered may continue even after an event has ended (e.g. parking conditions to exit the event, updates to emergency situation, safety guidelines when exiting, ability to purchase post concert memorabilia, etc.). In such an embodiment, even though the indicated time of the end of the event may have passed, the date/time elapsed will not occur until the criteria triggered no longer occurs.

In one embodiment, if the date/time has elapsed, then post-activity sharing appointment/meeting/calendar items may occur, including sharing (e.g. posting to central server, posting to online server, posting to social media site, emailing, etc.) data items (e.g. photos, videos, documents, voice recordings, videos, SMS, etc.), applying metadata to data items (e.g. tag photos with metadata obtained from digital ticket, embed metadata into object based on defined and stored date/time criteria and contact info and/or shared appointment/meeting/calendar item, etc.), geotag data item (e.g. apply coordinates to photo and/or any data item, etc.), organize and/or collect information (e.g. emails, tickets, deals, invite, SMS, voice recordings, text-to-speech transcriptions, etc.) associated with shared appointment/meeting/calendar item, and/or providing any additional information and/or feature after the appointment/meeting/calendar item has ended. In one embodiment, the post-activity sharing appointment/meeting/calendar items may provide a search function, including permitting the user to search for any item (e.g. contact list, data item, location, time, notes, comments, etc.) associated with the shared appointment/meeting/calendar item.

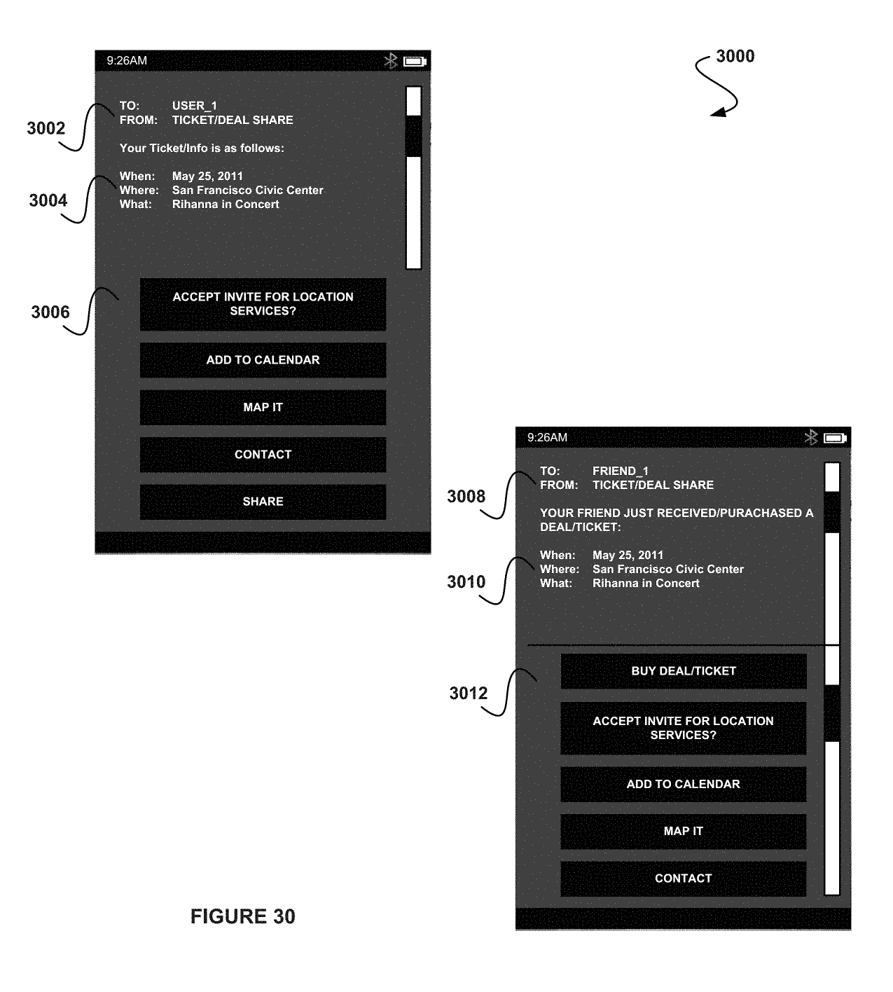

FIG. 30 shows a mobile device interface 3000 for receiving advertisement/content related notifications, in accordance with another embodiment. As an option, the mobile device interface 3000 may be implemented in the context of the architecture and environment of the previous Figures and/or any subsequent Figure(s). Of course, however, the mobile device interface 3000 may be implemented in the context of any desired environment. It should also be noted that the aforementioned definitions may apply during the present description.

As shown, sender and receiver information 3002, ticket/info details 3004, and ticket/info options 3006 are displayed. In one embodiment, the user may purchase a ticket and receive confirmation of the purchase. For example, in one embodiment, the user may have used a mobile device app, an online site and/or portal, a telephone ordering phone line, an in-person live purchase, and/or any other means to purchase a ticket, and in response to the purchase, a confirmation and/or receipt may be sent to the user. In various embodiments, the confirmation and/or receipt may be received by an application (e.g. associated with the purchase site and/or event, etc.), an OS/platform native utility, a communication platform (e.g. SMS, email, chat, etc.), a social media platform (e.g. Facebook app, etc.), and/or by any source which may receive a confirmation and/or receipt of the purchase. In a separate embodiment, the user may receive confirmation (e.g. confirmation code, etc.) on the telephone, which may be subsequently translated from text-to-speech and associated with the OS/platform native utility and/or any other application associated with the contents of the text-to-speech conversation (e.g. if a ticket was purchased relating to Ticketmaster, the Ticketmaster app may receive a text-to-speech copy of the oral conversation and/or the confirmation code, etc.).

In another embodiment, the ticket/info details may include details such as when the event is scheduled (e.g. date and time, etc.), where it is scheduled (e.g. location, etc.), what is scheduled (e.g. the event, concert, etc.), how to get to the event (e.g. navigation, directions, etc.), an overview (e.g. details regarding the event including a summary or synopsis of the event, etc.), a list of contacts participating (e.g. friends who will have signed up also, etc.), expected weather (e.g. enable the user to know what to wear, etc.), parking (e.g. current conditions, nearby parking lots, etc.), restaurants and/or food options (e.g. restaurants at or near the event, etc.), hotels (e.g. nearby hotels, etc.), recommendations (e.g. based on past attendees and/or reviews, etc.), and/or any other information which may be pertinent to the ticket/info details. Of course, any details and/or information relating to the ticket/info may be included. Additionally, in other embodiments, the ticket/info details may be presented in any manner, including in list format, in sections (e.g. distinguishable panes, etc.), in magazine style thumbnails (e.g. each section has small photo and text, tec.), and/or in any format whereby the ticket/info details may be presented.

In one embodiment, the ticket/info options may include an option to accept invite for location services, add to calendar (e.g. calendar associated with the mobile device, calendar app downloaded and used on the device, HTML5 calendar app, etc.), map it (e.g. ability to navigate to the location, ability to view maps of the location and/or surrounding areas, ability to view within the location, etc.), contact (e.g. contact information for the seller, contact information for the event center, etc.), share (e.g. send to contacts, send to friends, upload to social media site, upload to blog, etc.), review (e.g. rate the event, rate the seller, etc.), input comments and/or notes, capture (e.g. photos, video recordings, audio recordings, etc.), and/or any other option which may relate at least in part to the ticket/info options.

In another embodiment, location services may include real-time contact location, notifications (e.g. location may trigger notifications, etc.), navigation (e.g. road navigation to an address location, navigate contacts to a specific meet-up spot for example within a building, etc.), geo-tag photos taken at the location relating to the ticket and/or deal, update social networking site (e.g. LinkedIn, Facebook, etc.) with user's location, estimated time of arrival (ETA) map of all individuals participating in the ticket and/or deal, real-time feeds from the location (e.g. parking lot is full, 30 minute wait in line, etc.), social networking integration (e.g. upload and/or posting of location and message relating to the ticket and/or deal, etc.), geo-tracking (e.g. record track and/or path taken by each participant, etc.), tagging any data file (e.g. voice recording, video, SMS, email with location metatag information during the time relating to the ticket and/or deal, etc.), recommending additional social events (e.g. you may enjoying interacting with individual A, etc.), asset tracking (e.g. GPS tracking device within a container and/or object, product tracking, etc.), check-ins (e.g. Foursquare, etc.), calling a vehicle (e.g. taxi, ambulance, etc.), identifying objects or persons or buildings (e.g. recognition and identification of surroundings, etc.), managing traffic (e.g. best route, etc.), billing (e.g. automatic billing for road tolls, etc.), scheduling (e.g. fleet management, etc.), accessing news (e.g. news relating to the location, etc.), tour guides (e.g. relating to the location, etc.), ability to play a game (e.g. hide and seek, etc.), directory services (e.g. Yellow Pages, Google, etc.), weather reports, points of interest (e.g. gas stations, restaurants, etc.), and/or any other service which may be relevant to location.

As shown, sender and receiver information 3008, ticket/info details 3010, and ticket/info options 3012 are displayed. In one embodiment, the user may receive a deal/ticket invite, and/or notification of a contact (e.g. friend, etc.) purchasing and/or receiving a ticket which may be relevant to the user. For example, in one embodiment, a contact (e.g. friend, etc.) of the user may have used a mobile device app, an online site and/or portal, a telephone ordering phone line, an in-person live purchase, and/or any other means to purchase a ticket, and in response to the purchase, a confirmation and/or receipt may be sent to the user. In one embodiment, in response to the purchase and/or the confirmation and/or the receipt and/or any item related to the purchase, the user may be sent a communication (e.g. an invite, notification of event, etc.).

In various embodiments, the communication from the friend may be received by an application (e.g. associated with the purchase site and/or event, etc.), an OS/platform native utility, a communication platform (e.g. SMS, email, chat, etc.), a social media platform (e.g. Facebook app, etc.), and/or by any source which may receive a communication associated with the confirmation and/or receipt of the friend's purchase. In a separate embodiment, the user may receive a communication relating to a friend's confirmation (e.g. confirmation code, etc.) on the telephone, which may be subsequently translated from text-to-speech and associated with the OS/platform native utility and/or any other application associated with the contents of the text-to-speech conversation (e.g. if a ticket was purchased relating to Ticketmaster, the Ticketmaster app may receive a text-to-speech copy of the oral conversation and/or the confirmation code, etc.).

In one embodiment, the friend may receive a ticket and/or deal (e.g. by email, by social networking site, by an application, through an online portal and/or site, etc.). In response to the receipt of the ticket and/or deal, a user may be notified and/or sent the ticket and/or deal. In one embodiment, the friend may choose to send the ticket and/or deal to the user (e.g. push the ticket and/or deal to another, etc.). In another embodiment, the friend's mobile device (e.g. through the OS/platform native utility, through an application, etc.) may identify that the received ticket and/or deal may be relevant to the user. In one embodiment, the user may select relevancy criteria (e.g. through settings, preferences, etc.). In other embodiments, relevancy criteria may be automatically determined based on information associated with the user (e.g. social media site profile, social media postings, blog postings, user history, user preferences, etc.). Of course, any determination may be based on any type of data and/or information associated with the user, obtained from any source associated with the user, and/or obtained in any manner.

In another embodiment, the ticket/info details may include details such as when the event is scheduled (e.g. date and time, etc.), where it is scheduled (e.g. location, etc.), what is scheduled (e.g. the event, concert, etc.), how to get to the event (e.g. navigation, directions, etc.), an overview (e.g. details regarding the event including a summary or synopsis of the event, etc.), a list of contacts participating (e.g. friends who will have signed up also, etc.), expected weather (e.g. enable the user to know what to wear, etc.), parking (e.g. current conditions, nearby parking lots, etc.), restaurants and/or food options (e.g. restaurants at or near the event, etc.), hotels (e.g. nearby hotels, etc.), recommendations (e.g. based on past attendees and/or reviews, etc.), and/or any other information which may be pertinent to the ticket/info details. Of course, any details and/or information relating to the ticket/info may be included. Additionally, in other embodiments, the ticket/info details may be presented in any manner, including in list format, in sections (e.g. distinguishable panes, etc.), in magazine style thumbnails (e.g. each section has small photo and text, tec.), and/or in any format whereby the ticket/info details may be presented.

In one embodiment, the ticket/info options may include an option to buy deal/ticket (e.g. purchase through app, purchase through online portal, etc.), accept invite for location services, add to calendar (e.g. calendar associated with the mobile device, calendar app downloaded and used on the device, HTML5 calendar app, etc.), map it (e.g. ability to navigate to the location, ability to view maps of the location and/or surrounding areas, ability to view within the location, etc.), contact (e.g. contact information for the seller, contact information for the event center, etc.), share (e.g. send to contacts, send to friends, upload to social media site, upload to blog, etc.), review (e.g. rate the event, rate the seller, etc.), input comments and/or notes, capture (e.g. photos, video recordings, audio recordings, etc.), and/or any other option which may relate at least in part to the ticket/info options.

In another embodiment, location services may include real-time contact location, notifications (e.g. location may trigger notifications, etc.), navigation (e.g. road navigation to an address location, navigate contacts to a specific meet-up spot for example within a building, etc.), geo-tag photos taken at the location relating to the ticket and/or deal, update social networking site (e.g. LinkedIn, Facebook, etc.) with user's location, estimated time of arrival (ETA) map of all individuals participating in the ticket and/or deal, real-time feeds from the location (e.g. parking lot is full, 30 minute wait in line, etc.), social networking integration (e.g. upload and/or posting of location and message relating to the ticket and/or deal, etc.), geo-tracking (e.g. record track and/or path taken by each participant, etc.), tagging any data file (e.g. voice recording, video, SMS, email with location metatag information during the time relating to the ticket and/or deal, etc.), recommending additional social events (e.g. you may enjoying interacting with individual A, etc.), asset tracking (e.g. GPS tracking device within a container and/or object, product tracking, etc.), check-ins (e.g. Foursquare, etc.), calling a vehicle (e.g. taxi, ambulance, etc.), identifying objects or persons or buildings (e.g. recognition and identification of surroundings, etc.), managing traffic (e.g. best route, etc.), billing (e.g. automatic billing for road tolls, etc.), scheduling (e.g. fleet management, etc.), accessing news (e.g. news relating to the location, etc.), tour guides (e.g. relating to the location, etc.), ability to play a game (e.g. hide and seek, etc.), directory services (e.g. Yellow Pages, Google, etc.), weather reports, points of interest (e.g. gas stations, restaurants, etc.), and/or any other service which may be relevant to location.

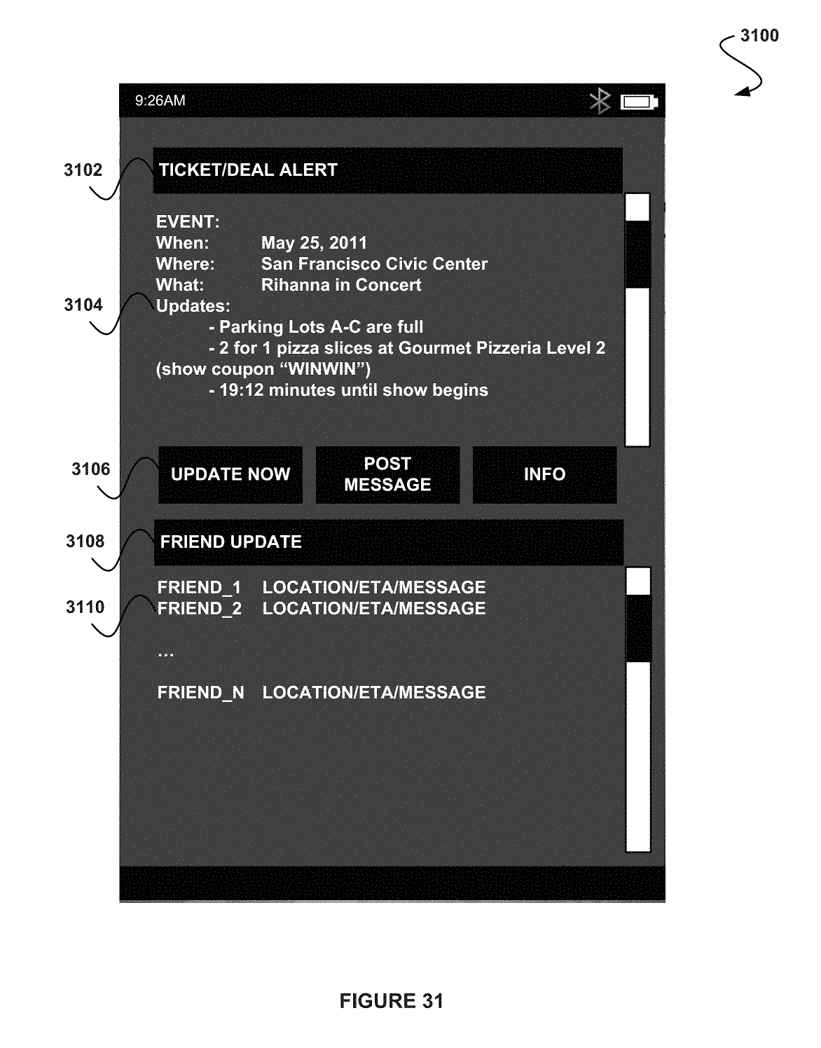

FIG. 31 shows a mobile device interface 3100 associated with a ticket/deal, in accordance with another embodiment. As an option, the mobile device interface 3100 may be implemented in the context of the architecture and environment of the previous Figures and/or any subsequent Figure(s). Of course, however, the mobile device interface 3100 may be implemented in the context of any desired environment. It should also be noted that the aforementioned definitions may apply during the present description.

As shown, a ticket/deal alert 3102, details 3104 relating to the event and/or ticket/deal, options 3106 relating to the event and/or ticket/deal, social media title bar 3108, and social media updates 3110 are displayed.

In various embodiments, the ticket/deal alert may display the most recent up-to-date alert (e.g. breaking alert, etc.), a standard title (e.g. title associated with the ticket/deal, etc.), and/or any other information as determined by the developer and/or the user of the mobile device. In one embodiment, the ticket/deal alert text may be stationary (e.g. not moving, etc.). In other embodiments, the ticket/deal text may be scrolling (e.g. scrolling ticker, etc.), and/or moving in any direction and/or manner.

In one embodiment, the ticket/deal alert may include text, one or more images (e.g. photo, screenshot, photo feed, etc.), one or more videos (e.g. video, webcam, video feed, etc.), ability to play one or more audio clips (e.g. live webcast, stored audio clip, etc.), interactive elements (e.g. links, real-time updates, user input field(s), etc.), and/or any other element and/or feature.

In another embodiment, details relating to the event and/or ticket/deal may be displayed. For example, in one embodiment, the details may include when the event is scheduled (e.g. date and time, etc.), where it is scheduled (e.g. location, etc.), what is scheduled (e.g. the event, concert, etc.), how to get to the event (e.g. navigation, directions, etc.), an overview (e.g. details regarding the event including a summary or synopsis of the event, etc.), a list of contacts participating (e.g. friends who will have signed up also, etc.), expected weather (e.g. enable the user to know what to wear, etc.), parking (e.g. current conditions, nearby parking lots, etc.), restaurants and/or food options (e.g. restaurants at or near the event, etc.), hotels (e.g. nearby hotels, etc.), recommendations (e.g. based on past attendees and/or reviews, etc.), and/or any other information which may be pertinent to the ticket/info details. Of course, any details and/or information relating to the ticket/info may be included. Additionally, in other embodiments, the ticket/info details may be presented in any manner, including in list format, in sections (e.g. distinguishable panes, etc.), in magazine style thumbnails (e.g. each section has small photo and text, tec.), and/or in any format whereby the ticket/info details may be presented.

In a further embodiment, the details relating to the event and/or ticket/deal may include one or more maps and/or directions (e.g. navigation to and/or from a location, map of the destination and/or of the departure, interior map of building, how to navigate to saved seats, etc.), contact information (e.g. event center contact information, ticket vender contact information, etc.), updates (e.g. real-time status update regarding the number of tickets sold, number of available seats, etc.), and/or any other information which may be associated with the ticket/deal and/or event.

In one embodiment, options relating to an event and/or ticket/deal may be displayed, including ability to update now (e.g. refresh alerts, update latest news, connect to real-time feeds, etc.), to post message (e.g. to a blog, to a feed, to a social media site, etc.), to display info (e.g. of the event, of the location, of the neighborhood, of the individuals participating, of further details relating of the event, etc.), to send a message (e.g. SMS, email, chat, etc.) to another participant and/or to any individual, to give a rating (e.g. of the event, of the ticket seller, of the event center, etc.), to give an update (e.g. report on traffic conditions, etc.), to view status of friend(s) (e.g. ETA, current location, etc.), to record a multimedia file (e.g. photo, video, audio, etc.), to engage in real time video chats and/or conferencing (e.g. video chat, video conference, etc.), and/or any other option which may relate to an event and/or ticket/deal. In various other embodiments, the options relating to an event and/or ticket/deal may be displayed as buttons, in a list (e.g. hierarchal folder format, drop-down list, etc.), and/or in any manner.

In one embodiment, a social media title bar may be displayed. In various embodiments, the social media site title (e.g. Facebook, Twitter, etc.), the latest social media update (e.g. Parking Lot Updates, Friend Updates,” etc.) and/or any social media update, and/or any text and/or graphic relating to the social media site may be displayed. In one embodiment, the social media site title may relate to a specific social media site (e.g. Facebook, Twitter, etc.). In another embodiment, the social media site title may relate to a grouping and/or collection of social media feeds (e.g. Friends Cross Site Updates, Event Cross Site Updates, etc.).

In another embodiment, social media updates details may be displayed. In various embodiments, the social media updates details may include information relating to a specific contact (e.g. friend, etc.) and/or a grouping of contacts (e.g. friends, circles, etc.), the latest social media update (e.g. “parking lot 32 is closed,” “Betty just arrived,” etc.) a multimedia file (e.g. photo, graphic, video, audio file, etc.), and/or any social media update relating to the social media site. In one embodiment, the social media updates details may relate to a specific social media site (e.g. Facebook, Twitter, etc.). In another embodiment, the social media updates details may relate to a grouping and/or collection of social media feeds (e.g. all feeds relating to all friends across all social media sites, all feeds relating to an event across all social media sites, etc.). Of course, the social media updates details may relate to any information and/or update.

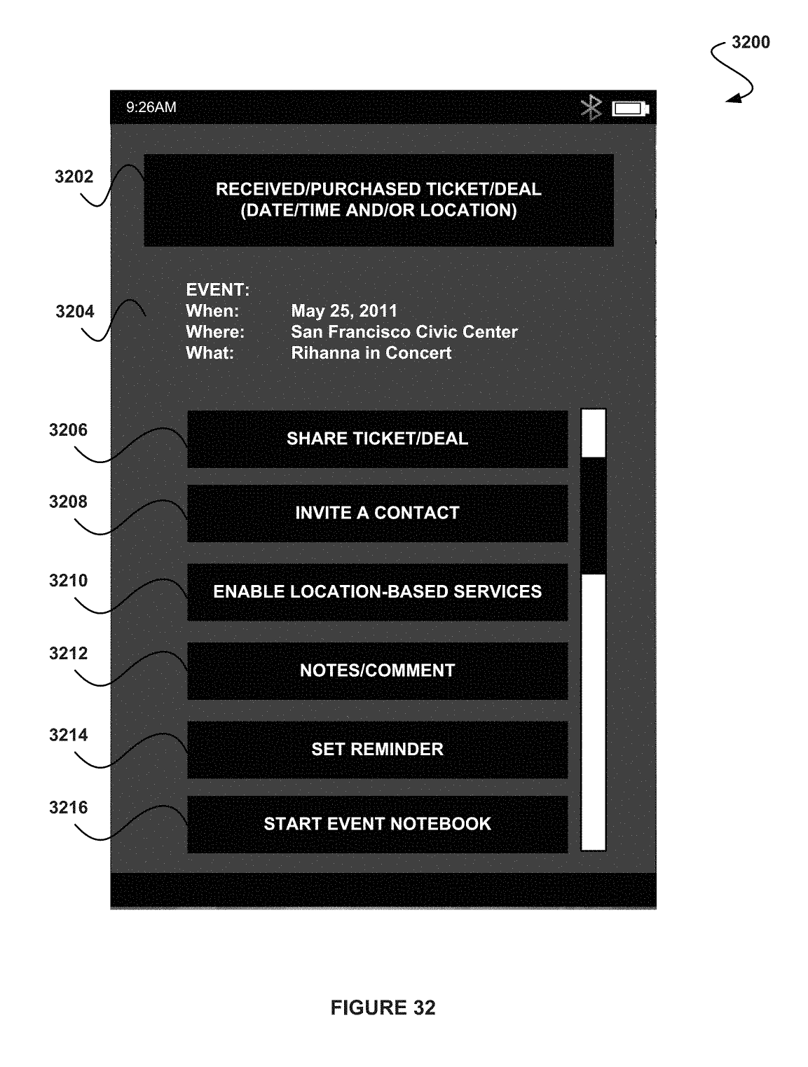

FIG. 32 shows a mobile device interface 3200 associated with a ticket/deal, in accordance with another embodiment. As an option, the mobile device interface 3200 may be implemented in the context of the architecture and environment of the previous Figures and/or any subsequent Figure(s). Of course, however, the mobile device interface 3200 may be implemented in the context of any desired environment. It should also be noted that the aforementioned definitions may apply during the present description.

As shown, a received/purchased ticket/deal 3202 may be displayed. In one embodiment, the received/purchased ticket/deal may include a date, time, and/or location. In other embodiments, the received/purchased ticket/deal may include a graphic (e.g. associated with the ticket/deal, etc.), an interactive object (e.g. link, input field, real-time updates, etc.), a dynamic object (e.g. changes in response to weather, changes throughout the day, etc.), and/or any other type of object and/or feature which may relate at least in part to the received/purchased ticket/deal. Of course, any text and/or any graphic may be displayed which may relate at least in part to the received/purchased ticket/deal.

As shown, details 3204 relating to the received/purchased ticket/deal are displayed. For example, in one embodiment, the details may include when the event is scheduled (e.g. date and time, etc.), where it is scheduled (e.g. location, etc.), what is scheduled (e.g. the event, concert, etc.), how to get to the event (e.g. navigation, directions, etc.), an overview (e.g. details regarding the event including a summary or synopsis of the event, etc.), a list of contacts participating (e.g. friends who will have signed up also, etc.), expected weather (e.g. enable the user to know what to wear, etc.), parking (e.g. current conditions, nearby parking lots, etc.), restaurants and/or food options (e.g. restaurants at or near the event, etc.), hotels (e.g. nearby hotels, etc.), recommendations (e.g. based on past attendees and/or reviews, etc.), and/or any other information which may be pertinent to the ticket/deal details. Of course, any details and/or information relating to the ticket/deal may be included. Additionally, in other embodiments, the received/purchased ticket/deal details may be presented in any manner, including in list format, in sections (e.g. distinguishable panes, etc.), in magazine style thumbnails (e.g. each section has small photo and text, tec.), and/or in any format whereby the received/purchased ticket/deal details may be presented.

In a further embodiment, the details relating to the event and/or received/purchased ticket/deal may include one or more maps and/or directions (e.g. navigation to and/or from a location, map of the destination and/or of the departure, interior map of building, how to navigate to saved seats, etc.), contact information (e.g. event center contact information, ticket vender contact information, etc.), updates (e.g. real-time status update regarding the number of tickets sold, number of available seats, etc.), and/or any other information which may be associated with the ticket/deal and/or event.

As shown, a share ticket/deal button 3206 is displayed. In one embodiment, the share ticket/deal may permit the user to send a message (e.g. email, SMS, chat, etc.), post to a social media site (e.g. an update, an invite, a review, etc.), send the ticket/deal to a contact (e.g. transfer ownership of the ticket/deal to a friend, send extra ticket/deal to a friend, etc.), and/or share the ticket/deal in any manner.

Additionally, an invite a contact button 3208 is displayed. In one embodiment, a user may invite a contact to participate in some manner with the ticket/deal. For example, in various embodiments, the invite a contact may include sending a contact (e.g. friend) information relating to the ticket/deal, inviting a contact to purchase the ticket/deal, inviting a contact to receive a purchased ticket/deal, inviting a contact to invite other contacts, and/or inviting a contact to interact in any manner with the ticket/deal.

Furthermore, an enable location-based services button 3210 is displayed. In one embodiment, the location-based services may include real-time contact location, notifications (e.g. location may trigger notifications, etc.), navigation (e.g. road navigation to an address location, navigate contacts to a specific meet-up spot for example within a building, etc.), geo-tag photos taken at the location relating to the ticket and/or deal, update social networking site (e.g. LinkedIn, Facebook, etc.) with user's location, estimated time of arrival (ETA) map of all individuals participating in the ticket and/or deal, real-time feeds from the location (e.g. parking lot is full, 30 minute wait in line, etc.), social networking integration (e.g. upload and/or posting of location and message relating to the ticket and/or deal, etc.), geo-tracking (e.g. record track and/or path taken by each participant, etc.), tagging any data file (e.g. voice recording, video, SMS, email with location metatag information during the time relating to the ticket and/or deal, etc.), recommending additional social events (e.g. you may enjoying interacting with individual A, etc.), asset tracking (e.g. GPS tracking device within a container and/or object, product tracking, etc.), check-ins (e.g. Foursquare, etc.), calling a vehicle (e.g. taxi, ambulance, etc.), identifying objects or persons or buildings (e.g. recognition and identification of surroundings, etc.), managing traffic (e.g. best route, etc.), billing (e.g. automatic billing for road tolls, etc.), scheduling (e.g. fleet management, etc.), accessing news (e.g. news relating to the location, etc.), tour guides (e.g. relating to the location, etc.), ability to play a game (e.g. hide and seek, etc.), directory services (e.g. Yellow Pages, Google, etc.), weather reports, points of interest (e.g. gas stations, restaurants, etc.), and/or any other service which may be relevant to location.

As shown, a notes/comment button 3212 is displayed. In some embodiments, the notes/comment may include inputted text (e.g. notes taken by the user, etc.), reminders (e.g. alarms, etc.), social media postings (e.g. posting on a social media site, etc.), a review (e.g. of the event, of the ticket dealer, of the event center, of a speaker, etc.), a feed update (e.g. Twitter update, etc.), and/or any other note and/or comment which may relate to the ticket/deal. In one embodiment, the notes/comment may permit input by digital means (e.g. keyboard, etc.), by hand (e.g. hand written notes, etc.), by voice (e.g. speech-to-text functionality, etc.) and/or by any other way. In a further embodiment, the hand-written notes may be transcribed (e.g. optical character recognition algorithms applied, etc.).

Additionally, a set reminder button 3214 is displayed. In one embodiment, a reminder may be associated with a contact (e.g. when you are next near the contact a reminder will go off, etc.), a location, a time (e.g. remind me 10 minutes before the event, etc.), one or more triggers (e.g. one or a combination of time, place, contacts, activity, calendar items, etc.), and/or any other object.

Moreover, a start event notebook button 3216 is displayed. In one embodiment, a start event notebook (e.g. digital notebook, collection of data files, digital folder, etc.), inputted information (e.g. reviews, notes/comments, directions, etc.), uploaded file (e.g. photo, video, audio recording, etc.), a list of who is participating in the event (e.g. friends who have accepted, etc.), a ticket stub (or digital ticket and/or confirmation and/or receipt, etc.) and/or any other information and/or item which may be relevant to the ticket/deal.

In one embodiment, a start event notebook may collect information relating to an event after an event has started (e.g. photos, videos, audio files, record of who is attending, etc.). In other embodiments, an event notebook may collect information relating to an event before it has started (e.g. collect and/or organize information prior to the start of an event, etc.). Of course, an event notebook may collect and/or organize information at any time and/or combination of times.

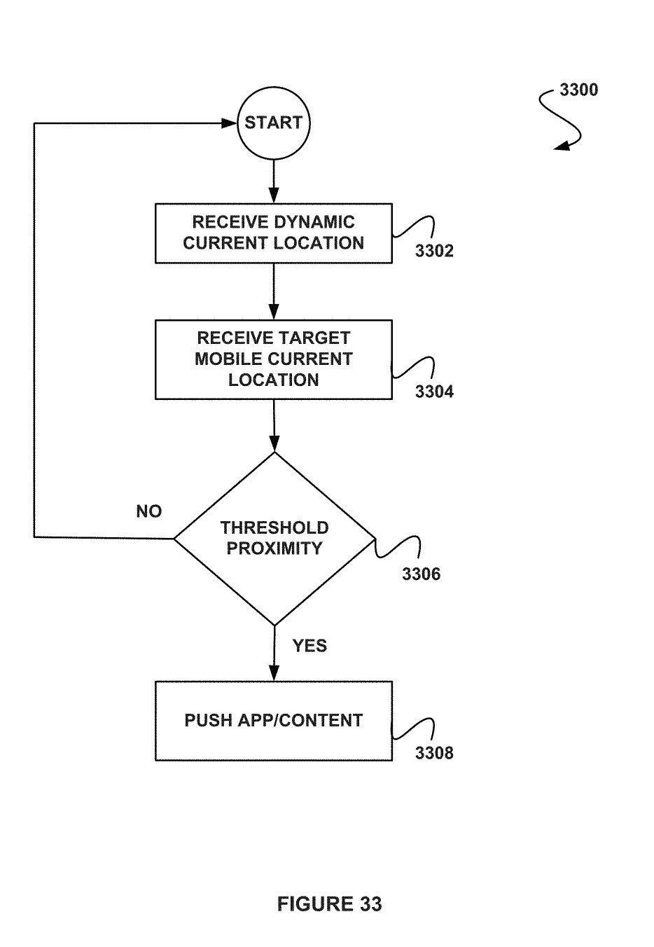

FIG. 33 shows a method 3300 for presenting contextual advertisements, in connection with a mobile device, in accordance with another embodiment. As an option, the method 3300 may be implemented in the context of the architecture and environment of the previous Figures and/or any subsequent Figure(s). Of course, however, the method 3300 may be implemented in the context of any desired environment. It should also be noted that the aforementioned definitions may apply during the present description.

As shown, dynamic current location is received. See operation 3302. For example, in various embodiments, the dynamic current location may include a location associated with the user, a location associated with the user's mobile device, a predefined dynamic location (e.g. a car, trailer home, food truck, etc.), and/or any dynamic location. In one embodiment, the dynamic location may be updated periodically (e.g. once an hour, etc.). In other embodiments, the dynamic location may be updated in real-time (e.g. constantly updating, etc.), in response to a trigger (e.g. location, time, devices near the user's mobile device, friends near the user, etc.), and/or in response to any condition and/or object.

Additionally, target mobile current location is received. See operation 3304. For example, in various embodiments, the target mobile current location may include a location associated with another entity (e.g. contact, friend, random third party, etc.), allocation associated with another entity's mobile device, a predefined dynamic location (e.g. a car, trailer home, food truck, etc.), and/or any dynamic location. In one embodiment, the dynamic location may be updated periodically (e.g. once an hour, etc.). In other embodiments, the dynamic location may be updated in real-time (e.g. constantly updating, etc.), in response to a trigger (e.g. location, time, devices near the target mobile, friends near the entity, etc.), and/or in response to any condition and/or object.

Furthermore, it is determined whether a threshold proximity occurs. See determination 3306. In one embodiment, the threshold proximity may be associated with the distance between the dynamic current location and the target mobile current location. In another embodiment, the user may control the threshold proximity, including setting a maximum distance (e.g. if distance is below the maximum distance, the threshold proximity occurs, etc.), selecting an object and/or entity associated with the dynamic current location (e.g. of the user, of the mobile device, of a vehicle, etc.), selecting an object and/or entity associated with the target mobile current location (e.g. device, entity, vehicle, etc.), and/or selecting any settings relating to the threshold proximity. In one embodiment, the threshold proximity may relate to distance. In other embodiments, the threshold proximity may relate to time (e.g. distance=velocity*time, etc.), speed (or velocity), and/or any other calculation which may relate to a threshold proximity.

If it is determined that the threshold proximity occurs, then app/content is pushed. See operation 3308. In one embodiment, the app/content may be associated with the user, the location, the target mobile (or a device associated with the target mobile, etc.), an app associated with the user and/or the target mobile, and/or any other object and/or source.

As an example, in one embodiment, a dynamic current location may be associated with a user's mobile device and a target mobile current location may be associated with a pizza delivery service. In such an embodiment, the user may have selected settings so that when the target mobile (e.g. pizza delivery vehicle, etc.) current location is 20 seconds away from the user's mobile device, the user is notified with an alert (e.g. ALERT: pizza is 20 seconds away, etc.). In another embodiment, after a dynamic threshold proximity occurs (e.g. pizza delivery is within a set distance, etc.), an invite to download an app may be pushed to the user's mobile device. For example, the app may relate to and provide ability to pay (e.g. for the delivered pizza, etc.), to receive coupons and/or discounts, and/or any other functionality associated with the delivery service.

In another embodiment, a dynamic current location may be associated with a user's mobile device and a target mobile current location may be associated with a package delivery service. In such an embodiment, the user may have selected settings so that alerts are sent every hour giving an update of the target mobile (e.g. package delivery truck, etc.) current location. In another embodiment, when the target mobile current location is within a proximity threshold of the intended destination (e.g. user's location, the user's house, etc.), the user may push instructions for delivery to the target mobile (e.g. leave package on the back door, etc.). In another embodiment, the target mobile may push instructions to the user (e.g. “please sign here to account for delivery,” etc.).

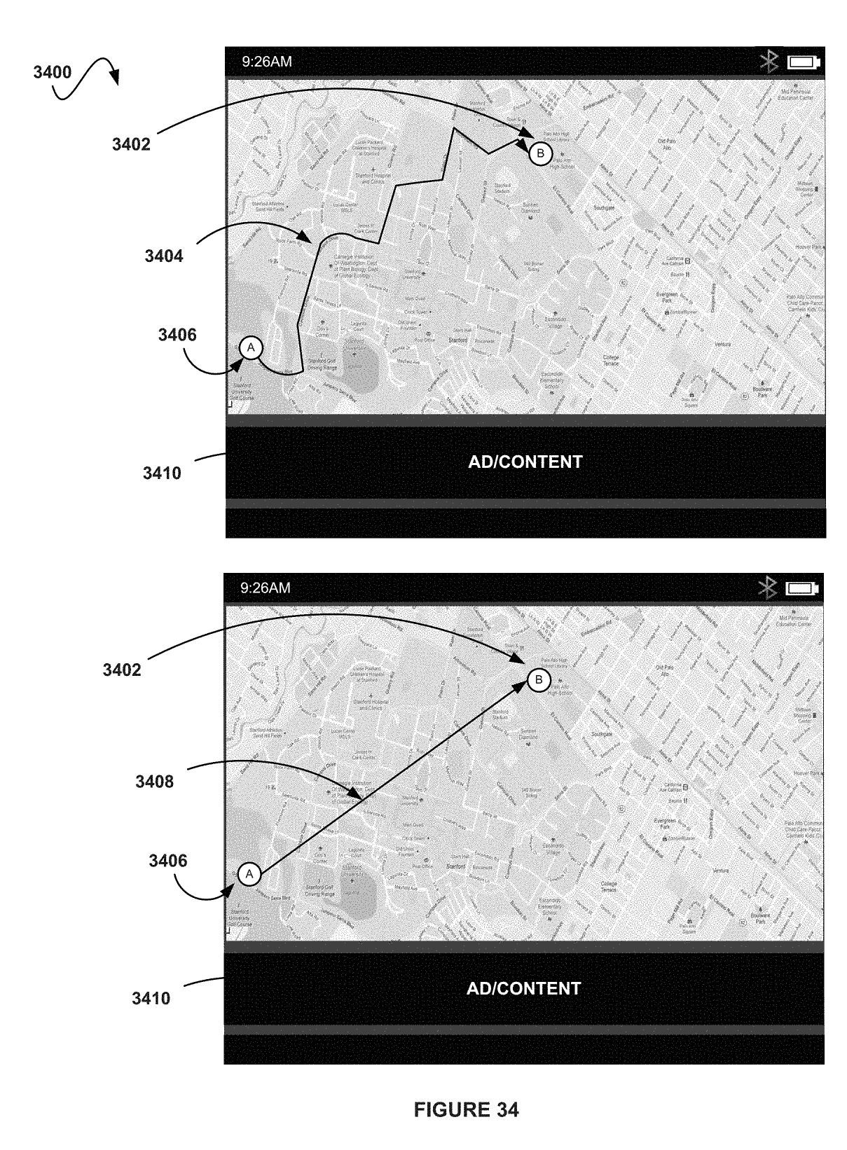

FIG. 34 shows a mobile device interface 3400 for interacting with advertisement/content related notifications, in accordance with another embodiment. As an option, the mobile device interface 3400 may be implemented in the context of the architecture and environment of the previous Figures and/or any subsequent Figure(s). Of course, however, the mobile device interface 3400 may be implemented in the context of any desired environment. It should also be noted that the aforementioned definitions may apply during the present description.

As shown, a first location 3406, a turn-by-turn route 3404, a vector based route 3408, a second location 3402, and ad/content 3410 are displayed. In one embodiment, first and second locations, and the route may be displayed on a map (or an interactive map). For example, in one embodiment, the user interface relating to the route may be vector-based (e.g. ability to zoom in and out, rotate, 3-D navigation, 3-D display of buildings, etc.), rasterized (e.g. 2-D image, layers of 2-D images to form 3-D images, etc.), and/or created in any manner to enable display of a map and/or navigating of directions.

In various embodiments, the first location may include a fixed location (e.g. a house, a business, a set address, etc.), a predetermined location (e.g. one which was previously inputted by the user, etc.), a moving location (e.g. a food truck, a vehicle, a barge, a plane, any vehicle, etc.), and/or any other object and/or place where a location may be determined. In another embodiment, the second location may include a fixed location (e.g. a house, a business, a set address, etc.), a predetermined location (e.g. one which was previously inputted by the user, etc.), a moving location (e.g. a food truck, a vehicle, a barge, a plane, any vehicle, etc.), and/or any other object and/or place where a location may be determined.

In one embodiment, a route may be selected from the first location to the second location. For example, in one embodiment, the route may be displayed in a turn-by-turn manner, a vector based manner (or multiple vectors), and/or in any other manner. In various embodiments, the route may include turn-by-turn directions, vector-based or multiple vector-based navigation (e.g. directions are based off of vector approximation of the user's current location and the intended destination, etc.), and/or any other feature and/or ability to determine a route. In one embodiment, the route may take into consideration live traffic conditions, and in other embodiments, give one or more recommendations to change the pre-selected route to one that would enable the user to arrive at the destination more expeditiously.

In one embodiment, ad/content may be displayed below the map interface. Of course, the ad/content may be displayed in any manner, including on a side around the map, as an overlay (e.g. partial overlay, complete overlay, etc.), as a tab and/or page associated with the map, as a pull-down bar and/or menu, and/or in any other manner. In one embodiment, the ad/content may be static (e.g. not changing after the app has been selected, etc.), dynamic (e.g. updated continuously or periodically, refreshed periodically with a new ad/content, etc.), and/or may function in any manner. In one embodiment, the ad/content may be directly relevant and associated with the directions and/or map interface, including being context aware, current location aware, destination location aware, route aware, and/or aware of any potentially relevant destination en route. Of course, the ad/content may relate to anything and/or may be displayed in any manner.

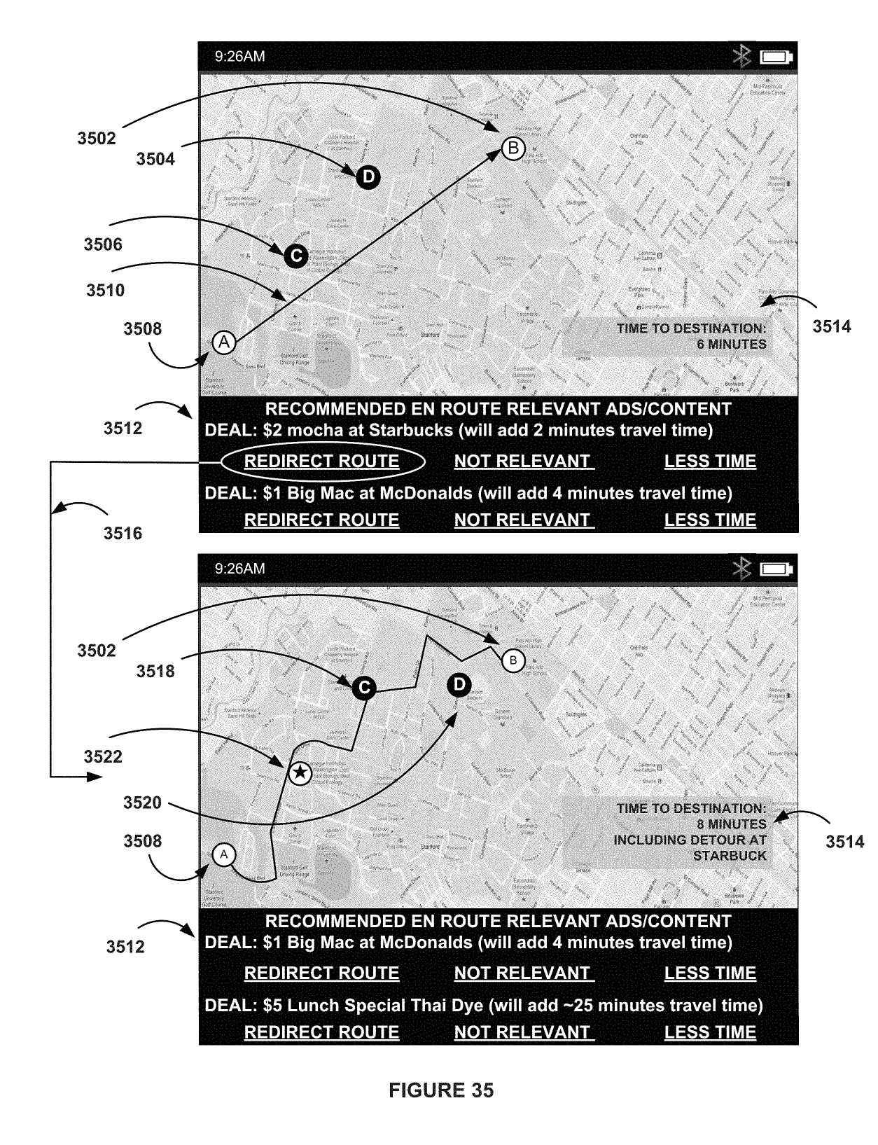

FIG. 35 shows a mobile device interface 3500 for interacting with advertisement/content related notifications, in accordance with another embodiment. As an option, the mobile device interface 3500 may be implemented in the context of the architecture and environment of the previous Figures and/or any subsequent Figure(s). Of course, however, the mobile device interface 3500 may be implemented in the context of any desired environment. It should also be noted that the aforementioned definitions may apply during the present description.

As shown, a first location 3508, a vector based route 3510, a second location 3502, ad/content 3512, a first relevant location 3506, a second relevant location 3504, and a content overlay display 3514 are displayed. In one embodiment, the first location, the second location, and the route may be displayed on a map (or an interactive map). For example, in one embodiment, the user interface relating to the route may be vector-based (e.g. ability to zoom in and out, rotate, 3-D navigation, 3-D display of buildings, etc.), rasterized (e.g. 2-D image, layers of 2-D images to form 3-D images, etc.), and/or created in any manner to enable display of a map and/or navigating of directions.

In various embodiments, the first location may include a fixed location (e.g. a house, a business, a set address, etc.), a predetermined location (e.g. one which was previously inputted by the user, etc.), a moving location (e.g. a food truck, a vehicle, a barge, a plane, any vehicle, etc.), and/or any other object and/or place where a location may be determined. In another embodiment, the second location may include a fixed location (e.g. a house, a business, a set address, etc.), a predetermined location (e.g. one which was previously inputted by the user, etc.), a moving location (e.g. a food truck, a vehicle, a barge, a plane, any vehicle, etc.), and/or any other object and/or place where a location may be determined.

In one embodiment, a route may be selected from the first location to the second location. For example, in one embodiment, the route may be displayed in a turn-by-turn manner, a vector based manner (or multiple vectors), and/or in any other manner. In various embodiments, the route may include turn-by-turn directions, vector-based or multiple vector-based navigation (e.g. directions are based off of vector approximation of the user's current location and the intended destination, etc.), and/or any other feature and/or ability to determine a route. In one embodiment, the route may take into consideration live traffic conditions, and in other embodiments, give one or more recommendations to change the pre-selected route to one that would enable the user to arrive at the destination more expeditiously.

In one embodiment, ad/content may be displayed below the map interface. Of course, the ad/content may be displayed in any manner, including on a side around the map, as an overlay (e.g. partial overlay, complete overlay, etc.), as a tab and/or page associated with the map, as a pull-down bar and/or menu, and/or in any other manner. In one embodiment, the ad/content may be static (e.g. not changing after the app has been selected, etc.), dynamic (e.g. updated continuously or periodically, refreshed periodically with a new ad/content, etc.), and/or may function in any manner. In one embodiment, the ad/content may be directly relevant and associated with the directions and/or map interface, including being context aware, current location aware, destination location aware, route aware, and/or aware of any potentially relevant destination en route. Of course, the ad/content may relate to anything and/or may be displayed in any manner.

In a further embodiment, the ad/content may relate to a relevant destination with a high probability that the user would be interested (e.g. user has indicated preference for museums, etc.), to a destination with a coupon and/or deal which would interest the user (e.g. $2 mocha, 2-for-1 miniature golf, etc.), and/or to a destination with any type of relevancy associated with the user.

In another embodiment, the ad/content may include ability to select an action. For example, in various embodiments, an action may include “redirect route,” “not relevant,” “less time,” “not hungry,” “display more info,” and/or any other action which may relate in some manner to the ad/content. In a further embodiment, an action may include the ability to filter (e.g. refine ad/content, etc.), and/or display a menu option (e.g. forward to contact, settings, delete, block ad provider, mark as spam, etc.).

In one embodiment, the user may interact with the action. For example, in one embodiment, the user may select the ad/content which may cause the ad/content to be displayed full screen, to redirect the navigation to the new location, and/or interact with the ad/content in any manner. In another embodiment, the user may swipe the ad to delete it from the list of relevant ads/content. In a further embodiment, the user may give a long press (e.g. on the ad/content, etc.) for menu options (e.g. forward to contact, settings, delete, block ad provider, mark as spam, etc.).

In various embodiments, the user may define the settings and/or filters that are associated with the ads/content, including the genre (e.g. food, clothing, etc.), the proximity (e.g. distance threshold of the range that will be included, etc.), the location (e.g. a specific city, etc.), the amount of permissible time for a detour (e.g. do not add more than 4 minutes to total traveling time, etc.), and/or any other filter and/or setting associated with the ad/content.

In one embodiment, a first, second, and/or any number of relevant locations may be displayed. In various embodiments, the relevant location may relate to the ad/content, to friends and/or contacts (e.g. addresses stored in contact database, etc.), to any parameter associated with the user (e.g. preference that all McDonalds' locations be displayed, etc.), and/or to any relevancy criteria associated with the user.

In another embodiment, the content overlay display may include various indications, including a time to destination, the address of the intended destination, selected detour destination(s), the address of the original location, the speed of the vehicle, and/or any other parameter. Of course, the user may control what parameters and/or indications are displayed (e.g. in settings, etc.).

As shown, a user selects an action 3516 associated with an ad/content. In one embodiment, the user may select to “redirect route” associated with a particular ad/content. In response, the route may be redirected, with a detour associated with the selected destination (e.g. Starbucks, etc.). As shown, a selected destination 3522, a first relevant location 3518, and a second relevant location 3520 are displayed.

In one embodiment, after a detour destination (e.g. Starbucks, etc.) has been selected, the ad/content and relevant locations may change (e.g. be updated with new relevant locations, etc.). In other embodiments, the ad/content and relevant locations may change as the position and/or location of the vehicle changes. For example, in one embodiment, as the vehicle progresses towards the intended destination, the ad/content and/or relevancy location may change based off of any parameter (e.g. proximity threshold, etc.). In one embodiment, the ad/content and relevancy location(s) may be associated together. For example, in one embodiment, the first listed ad/content may correspond with a first relevancy location on the map. In another embodiment, the ad/content and relevancy location(s) may not be associated together. For example, in one embodiment, the ad/content may relate to a specific genre (e.g. clothing shops, etc.) and the relevancy location(s) may relate to the user's contacts. Of course, the relevancy location(s) and the ad/content may be configured in any manner by the user.

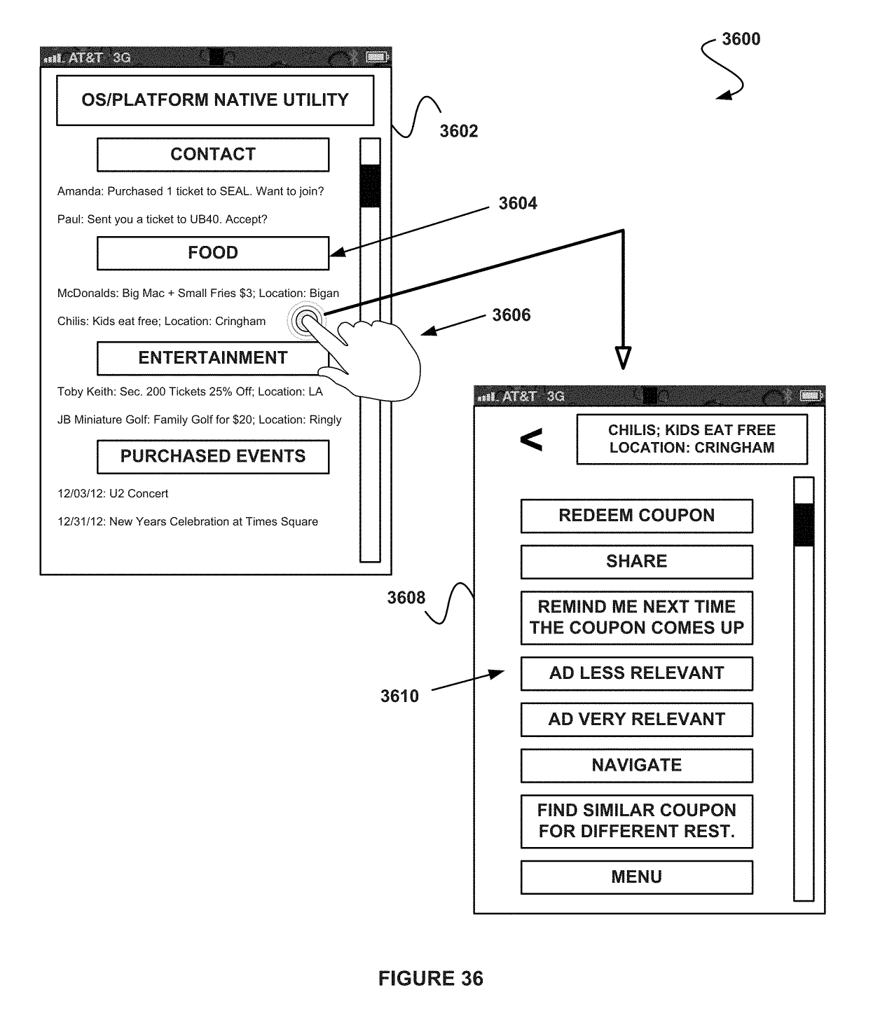

FIG. 36 shows a mobile device interface 3600 for interacting with advertisement/content related notifications, in accordance with another embodiment. As an option, the mobile device interface 3600 may be implemented in the context of the architecture and environment of the previous Figures and/or any subsequent Figure(s). Of course, however, the mobile device interface 3600 may be implemented in the context of any desired environment. It should also be noted that the aforementioned definitions may apply during the present description.

As shown, an OS/platform native utility App 3602 is displayed. Additionally, ad/content categories 3604 is displayed. In one embodiment, the OS/platform native utility App may display the ad/content categories in partitioned panes on the display (e.g. a section for each category, etc.). In other embodiments, the ad/content categories may be displayed by thumbnails, drop-down menus (e.g. drop down menu displays updates relating to the category, etc.), list format, and/or in any format.

In one embodiment, the updates associated with the ad/content categories may relate filtered. For example, in one embodiment, the user may set parameters and/or settings (e.g. preferences, etc.) to restrict the updates that are displayed. In other embodiments, the OS/platform native utility may gather information (e.g. from emails, blog posts, social media posts, user history, etc.) to determine the relevancy of updates. Of course, the user may set the manner of display (e.g. placement, number of updates, etc.) in any manner. In a further embodiment, the updates may be displayed in any manner, including static updates (e.g. non changing, etc.), dynamic updates (e.g. real time updates, etc.), and/or integrate any text, graphics, and/or any multimedia content.

In another embodiment, each update associated with the ad/content categories may be selected and/or modified. In one embodiment, the user may select the ad/content category to display a more complete list of relevant updates. For example, in one embodiment, the user may desire to view all purchased tickets. By selecting the “purchased events” (or whatever category pertains to purchased items), the user may view all concerts and/or events to which a ticket has been purchased. In another embodiment, the “purchased events” category may include tickets that have been sent from another contact and accepted by the user. In a further embodiment, the “purchased events” category may include requests and/or invites from a contact.

In one embodiment, the ad/content categories may include contact, food, entertainment, clothing, purchased events, and/or any category which may filter the updates in some manner. In another embodiment, after selecting a category, the user may be presented with additional subcategories (e.g. within food, the subcategories may include the type of food, etc.).

Although many of the examples given have related to advertisements and/or coupons and/or deals, it is recognized that the ad/content may relate to any type of content. For example, in various embodiments, the ad/content may relate to tours, information, lessons, contact updates, contact requests and/or invites, business related affairs, and/or any source from which information and/or updates may be gathered.

As shown, a user may select an update 3606 associated with an ad/content category which may lead to a detailed display 3608 relating to the update. Options 3610 associated with the update are also presented.

In one embodiment, further information associated with the update may be presented to the user. For example, in various embodiments, the further information may include valid dates, usage information (e.g. age restrictions, etc.), disclaimers, information on how to redeem, information relating to the update (e.g. source, full text, etc.), and/or any other information which may be relevant to the update.

In various embodiments, options associated with the update may include ability to “redeem the coupon,” “share,” “remind me next time the coupon comes up,” ability to designate “ad less relevant,” “ad very relevant,” ability to “navigate,” “find similar coupon for different restaurant,” ability to view the “menu,” and/or any other option which may provide further functionality associated with the update. In one embodiment, the ability to designate an ad/content as being relevant or not relevant may enable the OS/platform native utility (or a server associated therewith) to more accurately determine the relevancy of ads/content delivered to the user.

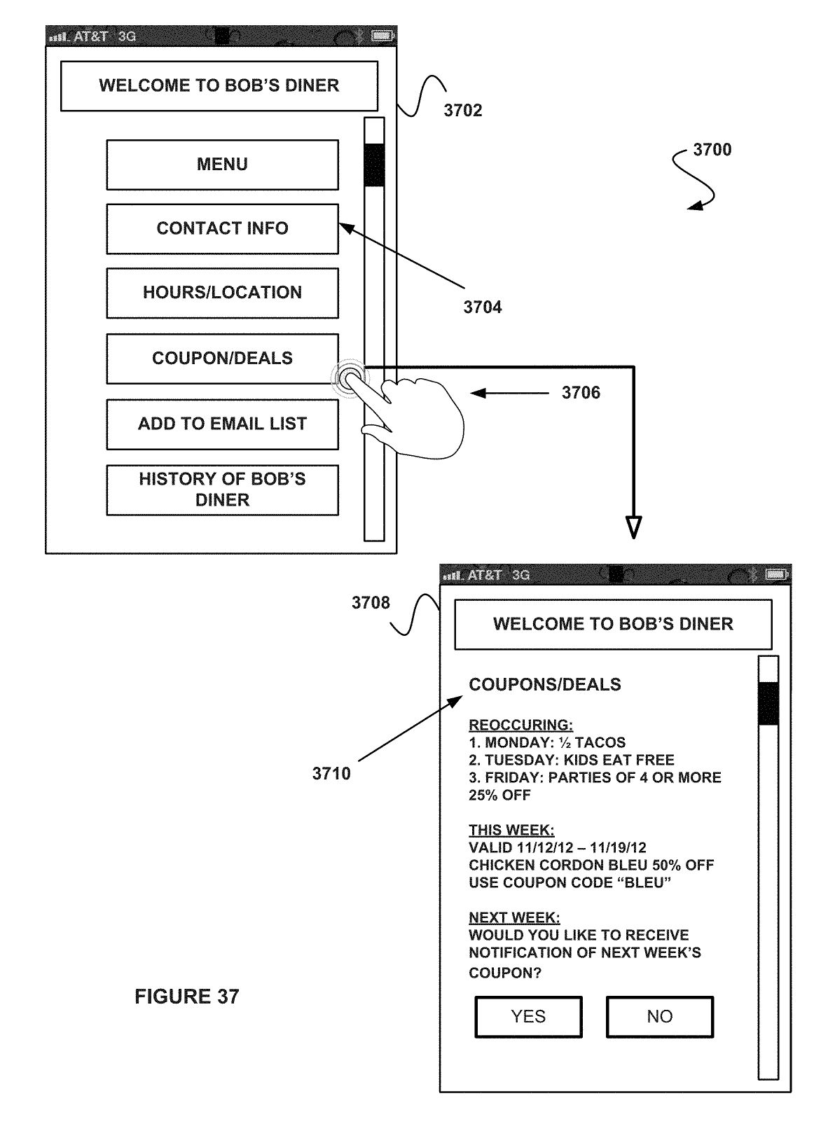

FIG. 37 shows a mobile device interface 3700 for interacting with advertisement/content related notifications, in accordance with another embodiment. As an option, the mobile device interface 3700 may be implemented in the context of the architecture and environment of the previous Figures and/or any subsequent Figure(s). Of course, however, the mobile device interface 3700 may be implemented in the context of any desired environment. It should also be noted that the aforementioned definitions may apply during the present description.

As shown, an application 3702 is shown. Additionally, ad/content categories 3604 is displayed. In one embodiment, the application may be designed in any manner. In various embodiments, a restaurant application may include ad/content categories such as menu, contact info, hours/location, coupon/deals, ability to add to email list, history of the restaurant, and/or any other category which may relate to the application. Of course, the application may function in any manner, and/or provide any category and/or option. In one embodiment, the application may be designed to work with an OS/platform native utility (e.g. push notifications to the OS/platform native utility, push ticket information, etc.). In other embodiments, the OS/platform native utility may discover relevant information (e.g. ticket information, etc.) associated with an application and extract such information from the application.

In one embodiment, the ad/content categories may relate to coupons/deals and/or relevant content and/or any dynamic (changing, etc.) content. For example, in one embodiment, the app may include an ability to engage with the entity more fully, including receiving coupons and/or deals, updates on new items in a store, week specials, line conditions, ability to reserve a table (or anything), and/or engaging with the application in any manner.

As shown, a user may select 3706 an ad/content category. Additionally, a second page 3708 associated with the app, and second page details 3710 are displayed.

In one embodiment, a second page may relate to any content and/or feature. For example, in various embodiments, a second page may relate to further details relating to the ad/content category (e.g. full text, etc.), an ability to further interact with the user (e.g. input fields, interactive content, web cams, etc.), and/or any engage more fully with the user in any manner. In another embodiment, second page details may permit user feedback. For example, in one embodiment, a coupon/deal second page may display coupons and/or deals relating to the app (e.g. Bob's Diner, etc.). User feedback may be obtained by requesting the user to input desired coupons, an indication of whether the user wants to be notified of future coupons, and/or any other feedback which may provide more useful information to the source (e.g. developer, creating entity, etc.) and/or which may more fully tailor the application to the user (e.g. notification settings, etc.).

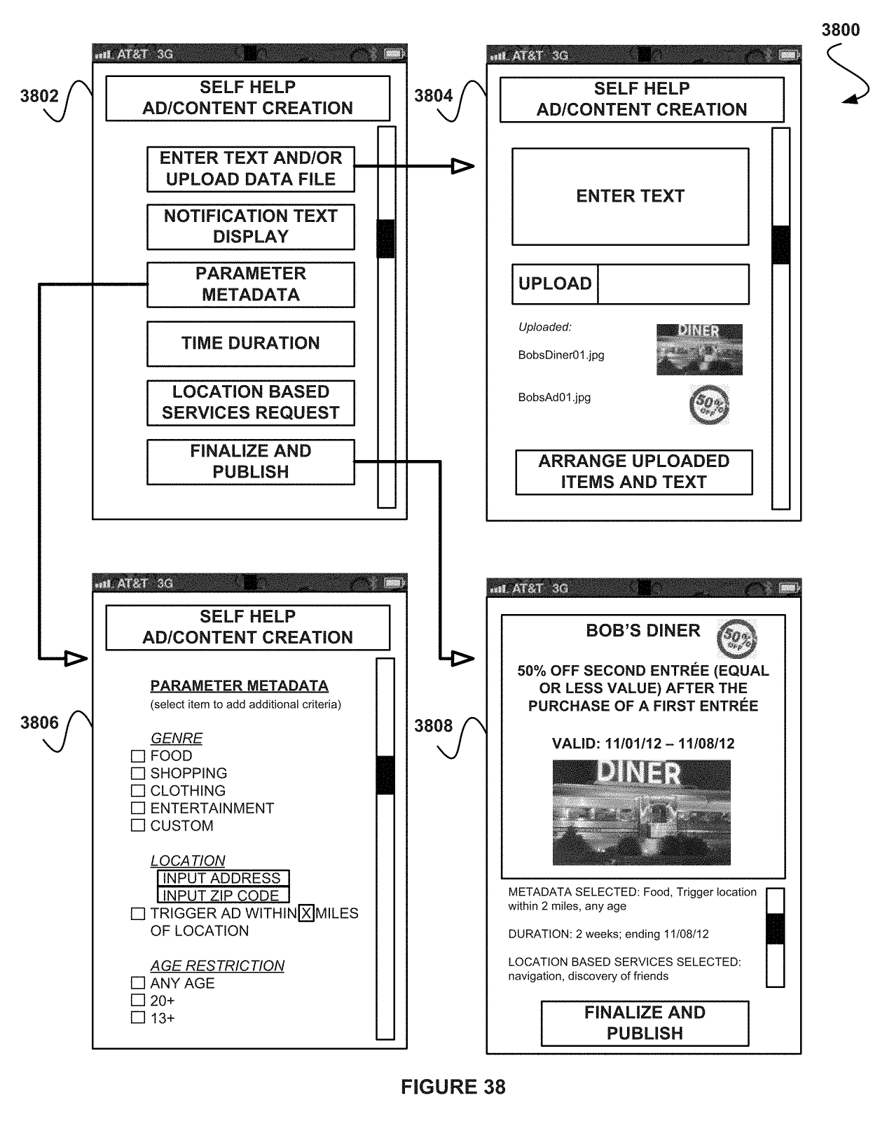

FIG. 38 shows a mobile device interface 3800 for creating an advertisement/content, in accordance with another embodiment. As an option, the mobile device interface 3800 may be implemented in the context of the architecture and environment of the previous Figures and/or any subsequent Figure(s). Of course, however, the mobile device interface 3800 may be implemented in the context of any desired environment. It should also be noted that the aforementioned definitions may apply during the present description.

As shown, a self-help ad/content creation app 3802 is displayed. In various embodiments, the self-help ad/content creation app may be utilized using a mobile device, on a web portal (e.g. website, etc.), and/or using any computing device. In one embodiment, the self-help ad/content creation app may enable the creator to engage with a user's OS/platform native utility. For example, in one embodiment, the creator may designate the conditions and/or triggers associated with an ad/content so that the user is notified. In one embodiment, the self-help ad/content creation may relate to creating an ad and/or content. In another embodiment, the self-help ad/content creation may enable the user to upload an already prepared application for distribution, including, for example, inviting users to download the app when one or more triggers have occurred. Of course, the creator may control the actions taken by the OS/platform native utility in any manner (e.g. invite to download, give limited sample of app, display ad/content, display notification, etc.) consistent with the settings and/or parameters set by the user.

In one embodiment, the self-help ad/content creation may include options, such as ability to “enter text and/or upload data file,” “notification text display,” “parameter metadata,” “time duration,” “location based services request,” “finalize and publish,” and/or any other option which may permit the creator to more fully create and/or modify the app.

As shown, a user may select the “enter text and/or upload data file” and be presented with an page 3804 associated with the command. In one embodiment, the “enter text and/or upload data file” page may permit the creator to enter text (e.g. to describe the ad/content, etc.), upload a data file (e.g. photo, video, multimedia graphic, interactive graphic, etc.), and/or arrange the uploaded items and/or text.

In one embodiment, the uploaded data files may be associated with a creator. In other embodiments, the uploaded data files may be taken from an online source (e.g. online photo source, online data source, etc.), another device (e.g. secondary device, camera, video, web cam, etc.) and/or any other source which may be associated with a data file. In another embodiment, the user may arrange the uploaded items and text by dragging and dropping items (e.g. drag an item from location to another, etc.), associating each item with a pre-designated source id (e.g. “1” indicates top left hand corner of page, etc.), and/or in any manner. In some embodiments, the items may be arranged via voice commands (e.g. place text at top of screen; pictures are below text and centered, etc.).

As shown, a user may select “parameter metadata” and be presented with a page 3806 associated with the command. In one embodiment, the parameter metadata may permit the user to define the parameters, criteria, and/or triggers which may be associated with the ad/content and which may be used to define the manner (e.g. when, where, how, etc.) in which the ad/content is displayed on the user's mobile device. In various embodiments, the parameter metadata may include genre (e.g. food, shopping, clothing, entertainment, custom field, etc.), location (e.g. input field for address and/or zip code, input field for number of miles from the source to trigger the ad/content, etc.), age restriction (e.g. any age, 20+, 13+, etc.), time (e.g. display only at night, display at all hours, etc.), context (e.g. display when the user is with at least 3 other friends, etc.), conditions (e.g. 49s win the SuperBowl, raining, etc.), and/or any other parameter and/or metadata which may be relevant to the ad/content and which may be used to more accurately trigger the content/ad.

As shown, a user may select “finalize and publish” and be presented with a page 3808 associated with the command. In various embodiments, the finalize and publish page may include the ad/content to be displayed (e.g. prepared ad, prepared page, etc.), the parameter metadata selected (e.g. triggers associated with the ad/content, etc.), the duration of the ad/content (e.g. length of time it will run, etc.), the location based services selected (e.g. automatic navigation, discovery of friends, discovery of devices, etc.), and/or any other item and/or service which may relate to the ad/content.

In one embodiment, the self-help ad/content creation app may be associated with a service platform, an application, and/or any other source which may facilitate the creation and management of ad/content. In one embodiment, the OS/platform native utility on the user's mobile device may provide a self-help ad/content creation service (e.g. application) which may be managed by an online server associated with the OS/platform native utility. In a separate embodiment, the OS/platform native utility may permit the user to create (e.g. self-help ad/content creation app, etc.) an ad/content which may then be transferred to a service platform for dissemination to other OS/Platform Native Utilities. In this manner, the creator of the ad/content may create one or more ads/content (e.g. including ad campaigns, etc.), manage the one or more ad/content, and/or interact with the published ad/content in any manner (e.g. discontinue, increase coupon, etc.).

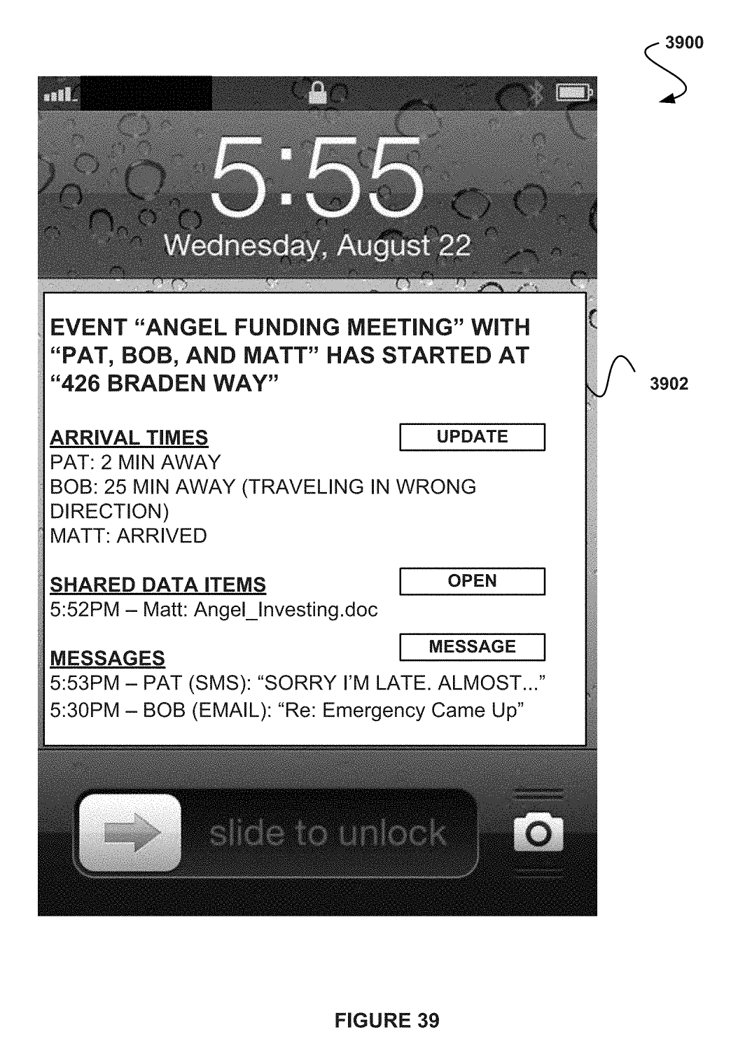

FIG. 39 shows a mobile device interface 3900 for interacting with advertisement/content related notifications, in accordance with another embodiment. As an option, the mobile device interface 3900 may be implemented in the context of the architecture and environment of the previous Figures and/or any subsequent Figure(s). Of course, however, the mobile device interface 3900 may be implemented in the context of any desired environment. It should also be noted that the aforementioned definitions may apply during the present description.

As shown, a shared GUI 3902 is displayed. In various embodiments, the shared GUI may include a title of the shared event, the arrival times (e.g. ETA, etc.) of the participants, any shared data items (e.g. photos, data file, any file, etc.), communication (e.g. emails, SMS, voice-to-text voicemail transcription, chats, etc.), and/or any other information which may be relevant to the shared event.

In one embodiment, the shared GUI may be displayed on a locked screen of a mobile device, on a drop-down display on a homepage, in a widget, in an app (e.g. OS/platform native utility, etc.) and/or in any manner on the device. In various embodiments, the shared GUI may include interactive features such as the ability to update real-time information (e.g. arrival times), open data items, message participants, and/or any other feature which may permit the user to interact more fully with the shared GUI.

As an example, in one embodiment, the shared GUI may relate to an “angel funding meeting” with the participants “Pat, Bob, and Matt,” at the location “426 Braden Way.” In such an embodiment, the arrival times of the participants may be displayed. Location-based services was accepted by each displayed participant which may enable the status update to extract the location of the participant near to the time of the meeting (e.g. beginning 15-20 minutes before the start of the meeting, etc.). In the case of participant Bob, it may be observed that Bob is heading in the wrong direction. Another participant in response may send Bob a message. It may also be observed that Matt shared a document, that Pat sent a text SMS message at 5:53 PM, and that Bob emailed all participants at 5:30 PM informing them that an emergency came up. Of course, the user may select any message, data item, and/or any item on the shared GUI to receive further options and/or functionality (e.g. ability to email, ability to open a document, etc.). In a separate embodiment, any functionality associated with the shared GUI may be locked until the user disables a locked screen (e.g. to prevent unintended selections, etc.).

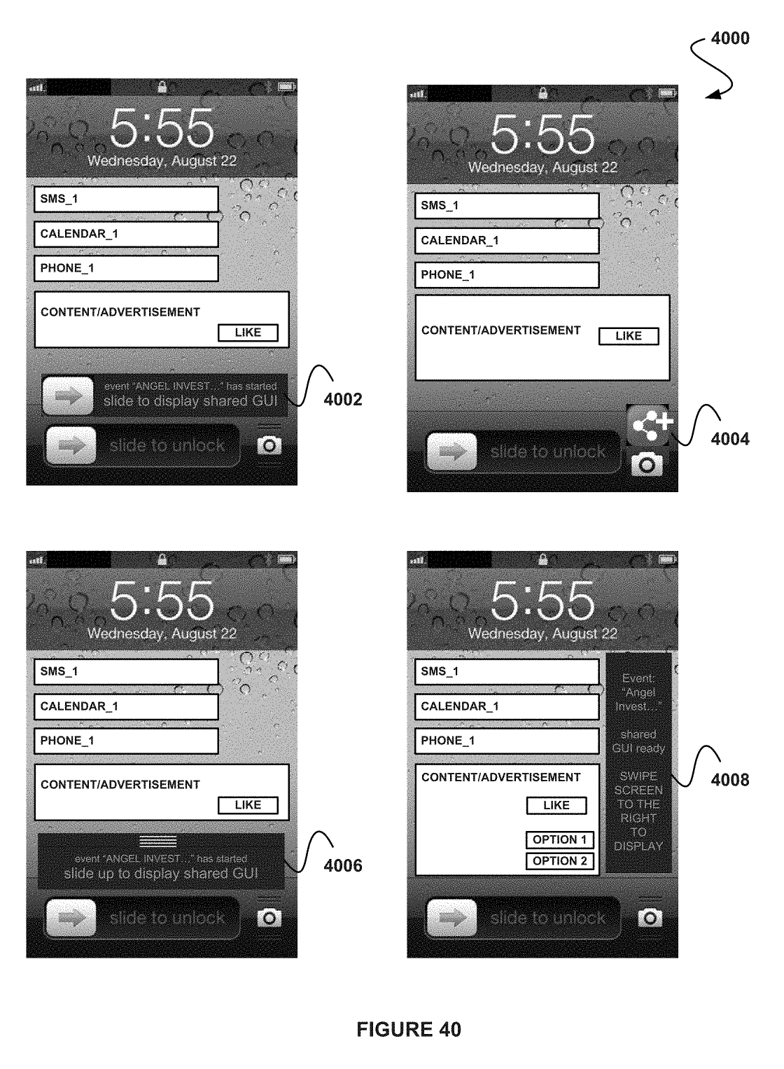

FIG. 40 shows a mobile device interface 4000 for interacting with advertisement/content related notifications, in accordance with another embodiment. As an option, the mobile device interface 4000 may be implemented in the context of the architecture and environment of the previous Figures and/or any subsequent Figure(s). Of course, however, the mobile device interface 4000 may be implemented in the context of any desired environment. It should also be noted that the aforementioned definitions may apply during the present description.

As shown, a shared GUI prompt may be displayed by a slide bar 4002, a button 4004, a pull up menu 4006, and/or a swipe screen 4008. In various embodiments, a shared GUI prompt may be displayed in any manner on the user's mobile device.

In one embodiment, the shared GUI prompt button may always be displayed on the locked screen of the device. When a new item arrives (e.g. new event has started, etc.), the button may display a “+” to indicate that new information has been received and may be relevant to the user. In another embodiments, the shared GUI prompt slide bar, button, pull up menu, and/or swipe screen may be displayed only when an event and/or shared event begins (or is near to begin). In a further embodiment, the shared GUI prompt slide bar, button, pull up menu, and/or swipe screen may be displayed in response to a trigger (e.g. meet up with another user, location based trigger, time reminders and/or notification, etc.).

In a separate embodiment, a shared GUI may be displayed in response to a voice command. For example, in various embodiments, the user may speak “display shared GUI,” “do I have any shared events coming up?,” and/or speak any phrase which may prompt in some manner the display of the shared GUI.

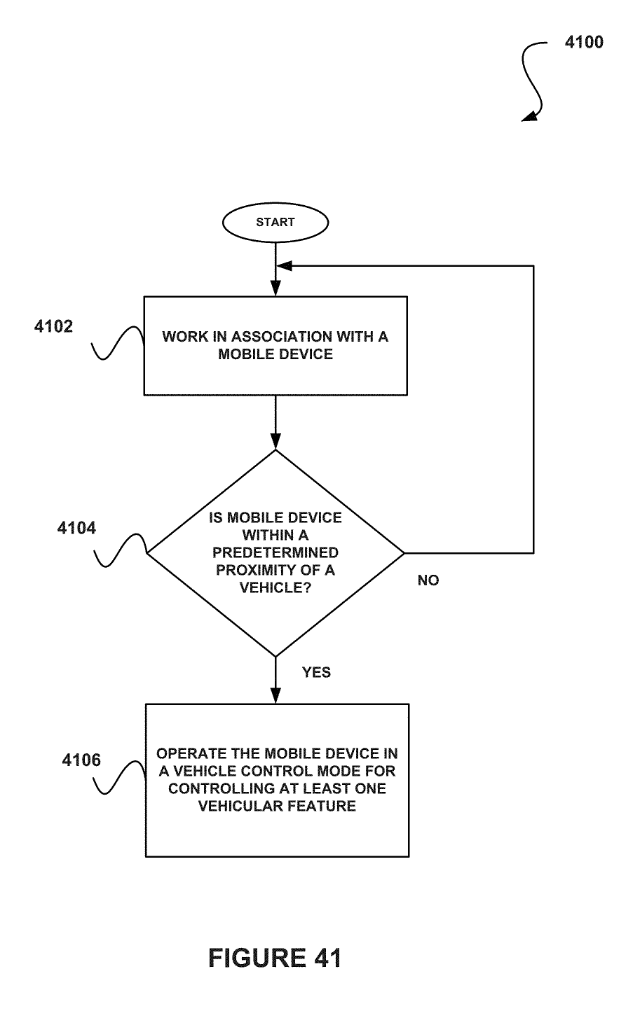

FIG. 41 shows a method 4100 for operating a mobile device in a vehicle control mode for controlling at least one vehicular feature, in accordance with one possible embodiment. As an option, the method 4100 may be implemented in the context of the architecture and environment of any subsequent Figure(s). Of course, however, the method 4100 may be carried out in any desired environment.

As shown, a computer readable medium works in association with a mobile device. See operation 4102. In one embodiment, the mobile device may include a device with cellular phone capabilities. In another embodiment, the mobile device may include a short-range wireless communication protocol headset, including Wireless USB, Bluetooth, Wi-Fi, or any other wireless protocol which may function at a short-range.

As shown, a computer readable medium determines whether the mobile device is within a predetermined proximity of a vehicle. See operation 4104. In one embodiment, the mobile device may detect the presence of a particular device (e.g. the vehicular system, etc.) by receiving a transmitted signal (e.g. RFID, NFC, WiFi, ZigBee, Bluetooth, etc.). In another embodiment, the vehicular system may detect the presence of the mobile device.

In some embodiments, the proximity may be set to a specific threshold. For example, the signal strength may be set at a predetermined quality (e.g. HIGH, etc.) before connection is established. In other embodiments, the transmitted signal may only be accessible within a set threshold range (e.g. 3 feet, etc.) around the vehicle.

In one embodiment, the determination of whether the mobile device is within a predetermined proximity of a vehicle may be automatic (e.g. an automatic connection established between the car system and the mobile device, etc.). In other embodiments, the determination may occur manually (e.g. mobile device must be placed in a mount, a mobile device must receive a wired connection, an “accept connection” screen must be accepted, etc.).

In some embodiments, the determination may include an authentication step. For example, in one embodiment, the mobile device may exchange security tokens with the vehicle system as part of determining whether the mobile device is within a predetermined proximity of a vehicle. Of course, any cryptography and/or security features may be implemented in determining whether the mobile device is within a predetermined proximity of a vehicle.

In various embodiment, the determination as to whether the mobile device is within the predetermined proximity of the vehicle may be accomplished by determining whether the mobile device is in communication with the vehicle via a short range wireless communication protocol, by determining whether the mobile device has been manually put in a vehicular control mode, by determining whether the mobile device has been physically coupled to the vehicle, and/or by any other method whereby the mobile device is determined to be within a predetermined proximity of the vehicle.

As shown, if the mobile device is within a predetermined proximity of a vehicle, the mobile device is operated in a vehicle control mode for controlling at least one vehicular feature. See operation 4106. In one embodiment, vehicle control mode may include a collection of properties in association with at least one vehicle feature. For example, in various embodiments, the properties may include, but are not limited to, user preferences, input options, output options, power conservation policies, processing capacity, access permissions, and/or any other type of setting that may be attributable to a tablet computer or a phone device.

In one embodiment, the vehicle control mode may include static settings. In other embodiments, the vehicle control mode may include dynamic features (e.g. settings based on devices in a predetermined proximity, etc.). In a further embodiment, the vehicle control mode may include more than one sub-mode (e.g. season mode, time of day mode, etc.). For example, switching between modes may be done automatically (e.g. environmental, spatial, temporal, and/or situational triggers, etc.) or manually (e.g. triggered by user input, etc.). In this way, the properties can be tailored to specific use environments and situations, maximizing the functionality and interaction of the tablet computer or phone device and the vehicle. Further, in another embodiment, a vehicular feature may include any feature associated with a vehicle. For example, in various embodiments, the vehicular feature may include an audio feature, a video feature, a navigation feature, an augmented reality feature, a social networking feature, a vehicle control feature (e.g. heated seats, air conditioning, etc.), and/or any other feature which may be associated with a vehicle.

In one embodiment, the vehicle control mode may be activated automatically. For example, in one embodiment, when the mobile device is within a predetermined proximity of the vehicle, an application on the device may be activated to control at least some aspect of the vehicular system (e.g. music selection, volume, directions, lighting, heated seats, emergency services etc.).

In other embodiments, the vehicle control mode may be activated manually. For example, in one embodiment, the mobile device may be placed on a mount within the vehicle, and thereby, activate an application on the device to control at least some aspect of the vehicular system (e.g. music selection, volume, directions, lighting, heated seats, emergency services etc.).

Of course, the mobile device may be connected in any manner (e.g. wired or wirelessly, etc.) to the vehicle assembly. Additionally, any number of devices may be connected to the vehicular system and control at least one vehicular feature.

In another embodiment, operating the mobile device in a vehicle control mode for controlling at least one vehicular feature may be based upon user input (e.g. hardware switch, GUI input, etc.). In another embodiment, the determination may be based on peripherals geographically near the device. For example, in one embodiment, a car display arrangement (e.g. vehicle system, etc.) may include a wireless microphone, a wireless database (e.g. to store contacts, directions, pushed notifications, etc.), and/or any other type of peripheral which may be used within a vehicle. Upon being brought near any of these peripherals, the mobile device may recognize the peripherals, and based off of the recognition, automatically operate the table computer or phone device in a vehicle control mode.

Further, in another embodiment, the user's mobile device may communicate ads and/or content to the vehicle. For example, in one embodiment, the mobile device may receive an ad and/or content. Based off of settings as specified by the user (or by automatic discovery of the user's preferences, etc.), the ad and/or content may be pushed to the vehicle and be used to control a vehicle feature. For example, in one embodiment, when an ad and/or content is received, the mobile device may decrease the vehicle audio level, give an alert (e.g. “new ad and/or content received,” etc.), and permit the user to give additional feedback. For example, the additional feedback may include a voice command (e.g. “state new ad/content,” etc.), a question (e.g. “what does the new ad/content relate to,” etc.), a physical movement (e.g. push a button, etc.), and/or any other action associated with the user.

As an example, in one embodiment, the user may be en route to a meeting. While en route, the mobile device may receive an ad/content relating to the meeting, including a notification that the meeting location has been changed. In response, the mobile device may orally notify the user of the change of venue (e.g. “your meeting location was changed by CONTACT_2,” etc.), reconfigure the navigation and/or direction (e.g. navigation software may be associated with the mobile device, with the vehicle and controlled by the mobile device, and/or with another device and controlled by the mobile device, etc.), and/or send a SMS notification to all participants that based off of the new location and current traffic conditions, the user will be 7 minutes late to the meeting. Of course, the mobile device and the vehicle may interact in any manner.

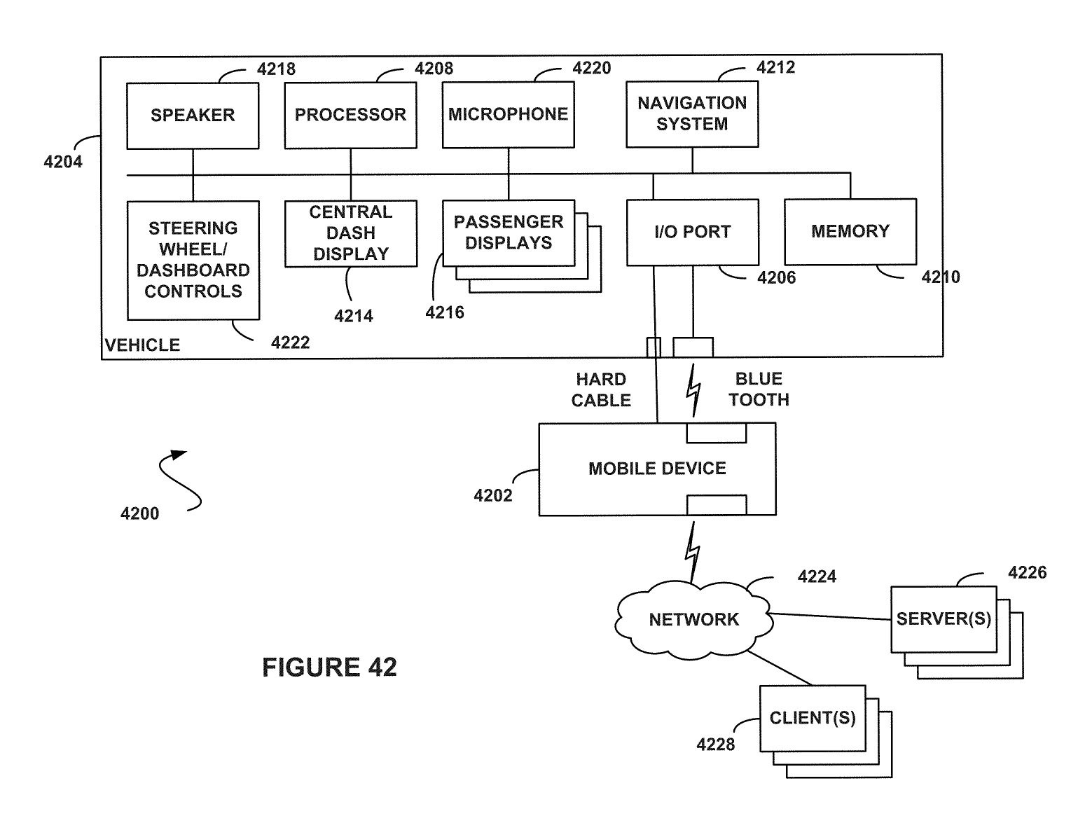

FIG. 42 illustrates a communication system 4200, in accordance with one possible embodiment. As an option, the system 4200 may be implemented in the context of the architecture and environment of the previous Figures or any subsequent Figure(s). Of course, however, the system 4200 may be carried out in any desired environment. It should also be noted that the aforementioned definitions may apply during the present description.

As shown, a mobile device 4202 is capable of interfacing with a vehicle 4204 including various components of the vehicle 4204. The phone device or tablet computer 4202 may include any mobile device capable of interfacing with a vehicle 4204 including a lap-top computer, hand-held computer, mobile phone, personal digital assistant (PDA), a music player (e.g. a digital music player, etc.), a GPS device, etc.

In various embodiments, the mobile device 4202 may communicate with a vehicular assembly system (e.g. a communication and entertainment system, etc.) corresponding to the vehicle 4204 via a wireless connection (e.g. Bluetooth, etc.), or via a cable connection (e.g. a USB cable, a serial cable, etc.). As an option, the mobile device 4202 may interface with the communication and entertainment system vehicle utilizing an I/O port 42106 of the vehicle 4204. In various embodiments, the I/O port 4206 may include a serial port, a USB port, FireWire/i.LINK ports, etc. In one embodiment, the I/O port 4206 may include a wireless communication port.

Using this interface, the mobile device 4202 may interface with various components and functionality of the vehicle, such as an onboard computer system including a processor 4208, memory 4210 (e.g. DRAM, flash memory, etc.), an onboard navigation system 4212, displays (e.g. a central display 4214, and one or more passenger displays 4216, etc.), audio communication devices (e.g. speakers 4218, a microphone 4220, etc.), and various other components and functionality of the vehicle included in the vehicular assembly system. The interface may also allow a user of the vehicle 4204 to access and/or control the phone device or tablet computer 4202 utilizing controls associated with the vehicle 4204, such as steering wheel, and dashboard radio controls 4222. Additionally, the user may access and/or control the mobile device utilizing the microphone 4220 through voice commands.

Using these components and controls, a user may access and utilize one or more wireless networks 4224 associated with the mobile device 4202. Coupled to the networks 4224 may be servers 4226 which are capable of communicating over the networks 4224. Also coupled to the networks 4224 and the servers 4226 is a plurality of clients 4228.

Such servers 4226 and/or clients 4228 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 4224, at least one gateway is optionally coupled therebetween.

It should be noted that the computer system of the vehicle 4204 may include various software and applications for facilitating communication between the vehicle 4204 and the mobile device 4202. For example, in various embodiments, the vehicle computer system may include an operating system (e.g. Windows Mobile, Linux, etc.), embedded speech recognition software, telephone call steering systems, automated telephone directory services, character recognition software, and imaging software.

In one embodiment, the user's mobile device may be used to control in some manner an aspect of the vehicle (e.g. in response to an ad/content, etc.). In a further embodiment, the mobile device may identify additional peripherals and/or devices associated with the vehicle, and based off of the identification, use such peripherals and/or devices to interact more fully with the user. For example, an ad and/or content may be received by the mobile device and displayed on a display associated with the vehicle. In this manner, the ads and/or content may be used to not only interact with the user but to also interact with other users in the car.

In another embodiment, each of the passenger displays in the vehicle may permit the passenger to login (e.g. via saved username, guest mode, etc.). Based off of the login, the user's mobile device may receive relevant ads and/or content specifically for that passenger. In another embodiment, the mobile device may identify a device associated with a contact (e.g. another passenger, etc.). Based off of the identification, the mobile device may display an ad and/or content on the display nearest the contact in the vehicle. For example, in one embodiment, a passenger may have been given the responsibility to find good eating locations on a trip. The passenger may have previously researched out good eating locations. Based off of the passenger's search history, the passenger may be given recommended eating locations on a display nearest to the user. Of course, the interaction between the passenger(s) and the user and between the user's mobile device and the vehicle (or between any device) may be preconfigured to function in any manner.

In one embodiment, a vehicle may be a trigger for an ad and/or content. For example, in one embodiment, the identification of a vehicle may limit the number of ads and/or content that are received. In another embodiment, the vehicle may trigger ads and/or content relating to possible destinations and/or relevant content en route. In one embodiment, the mobile device may determine that the user is in a vehicle, that it is near lunch time, and that the user's next appointment is in one hour. Based off of these triggers, the mobile device may recommend (e.g. through the vehicle's audio, etc.) a lunch destination to the user. If the user agrees (e.g. voice command of “yes,” etc.), the mobile device may update the navigation system with the new lunch destination.

In another embodiment, a user may be in a new city. Traveling through the city, the mobile device may recognize that the user has not been to the city before and is currently in a vehicle. Based off of relevancy criteria (e.g. preferences associated with the user, etc.), the mobile device may feed tour audio streams to the vehicle (e.g. “On your left is the oldest Bank Building in the area. Built in 1864, it survived the fire of 1880 and the earthquake of 1910,” etc.). Of course, anything may be presented to the user.

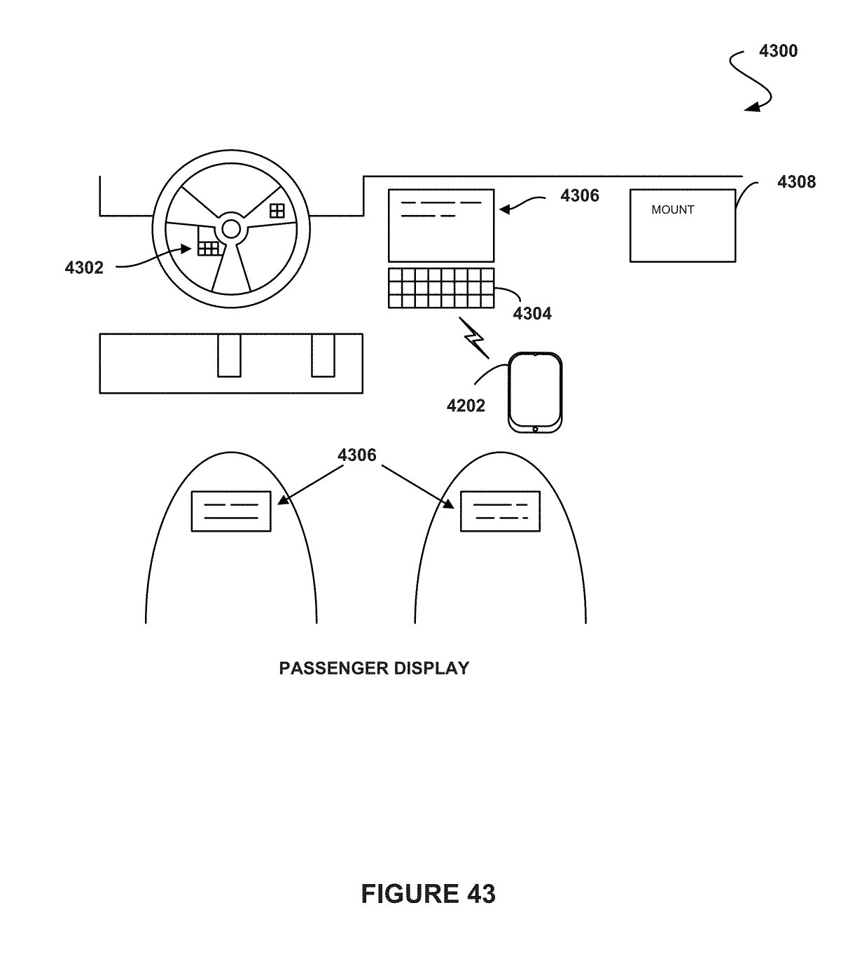

FIG. 43 shows a configuration 4300 for an automobile capable of interfacing with the mobile device of FIG. 42, in accordance with one possible embodiment. As an option, the configuration 4300 may be implemented in the context of the architecture and environment of the previous Figures or any subsequent Figure(s). Of course, however, the configuration 4300 may be carried out in any desired environment. It should also be noted that the aforementioned definitions may apply during the present description.

As shown, the mobile device 4202 may be coupled to the automobile utilizing a wired connection (e.g. a USB connection, etc.), or a wireless connection (e.g. Bluetooth, etc.). In one embodiment, the mobile device 4202 may be placed on a mount 4308. The mount may provide a wired or wireless connection to the automobile system.

Using this connection, a user (e.g. a driver or passenger, etc.) may operate the mobile device 4202, via the automobile, using voice commands, steering wheel controls 4302, radio controls 4304, and/or dashboard controls. Furthermore, the mobile device may communicate with vehicle displays (e.g. main displays, passenger displays 4306, etc.) such that content associated with the mobile device (e.g. stored content, streaming content, etc.) may be displayed. For example, the mobile device may communicate stored video to at least one of the passenger displays 4306. Additionally, the mobile device may communicate streaming (e.g. new ad/content, etc.) or stored audio (e.g. saved past ad/content, etc.) such that the audio may be transmitted utilizing an audio system of the automobile.

By interfacing the mobile device 4202 with the automobile, voice-activated, hands-free calling may also be implanted. For example, a “Push to Talk” button on the steering wheel may allow the user to access contacts stored in a contact list of the mobile device 4202 by voice command. Furthermore, the user may be able to switch use from the mobile device 4202 to the vehicle control system transparently. For example, a user may push a “Telephone” button on the steering wheel to automatically transfer a current telephone call to the automobile communication system of the automobile without having to hang up and call again.

As an option, the text messages received by the mobile device 4202 may be converted to audio utilizing a vehicle on-board processor and associated voice-to-text software. The communication system of automobile may then output the converted text in an audio stream via speakers. In one embodiment, the communication system associated with the automobile may include a main display 4306 for displaying activities associated with the mobile device 4202, along with other functionality (e.g. navigational functionality, etc.).

For example, the communication system may display any feature that is capable of being displayed using the mobile device 4202. In various embodiments, such features may include an ad and/or content notification, caller ID, call waiting, conference calling, a caller log, a list of contacts, a signal strength icon, and a phone battery charge icon, a music list, a content list, etc. Additionally, voice-activated music may also be implemented. For example, the on-board communication and entertainment system may allow a user to browse through music collections by genre, album, artist, and song title using simple voice commands.

In one embodiment, the passenger displays 4306 may all display the same material (e.g. video, music, ad, content, etc.). In another embodiment, the passenger displays may be independently operated (e.g. each displaying a different video stream, personalized ads and/or content, etc.) and/or operated independently by the mobile device 4202. In a further embodiment, the passenger displays 4306 may include permanent displays. For example, the passenger displays may be installed into the automobile architecture (e.g. installed into the dashboard, the backs of seats, etc.). In another embodiment, the passenger displays 4306 may include transportable displays. For example, the passenger displays may include a tablet computer or mobile device and each may be placed in an installed mount on the automobile (e.g. on the dashboard, in the backs of seats, in a roof mount, etc.).

In various embodiments, the mobile device 4202 may be set up to operate in a master-slave relationship with the passenger displays on the automobile. In one embodiment, the mobile device may automatically configure the passenger displays based on predetermined settings (e.g. the screen most in the front of the automobile displays navigation details, screens in the back of the automobile display videos and/or relevant ads and/or content, etc.). Of course, the screens may be configured in any manner based on input from the phone device or tablet computer.

In a further embodiment, if multiple mobile devices or tablet computers are present in an automobile, the mobile devices or tablet computers may apply preconfigured settings wherein only one mobile device may control the automobile system features, and the other mobile devices or tablet computers may remain as slave devices to the one master mobile device. For example, in one embodiment, a parent passenger may wish to control automobile features (e.g. navigation, music, etc.) as well as control what is displayed (e.g. ad and/or content, etc.) on each of the child passenger's display (e.g. on the passenger displays, on another phone device or tablet computer, etc.). The parent passenger's mobile device may be used to control at least some vehicular feature, as well as control other devices and/or displays within a preconfigured proximity range.

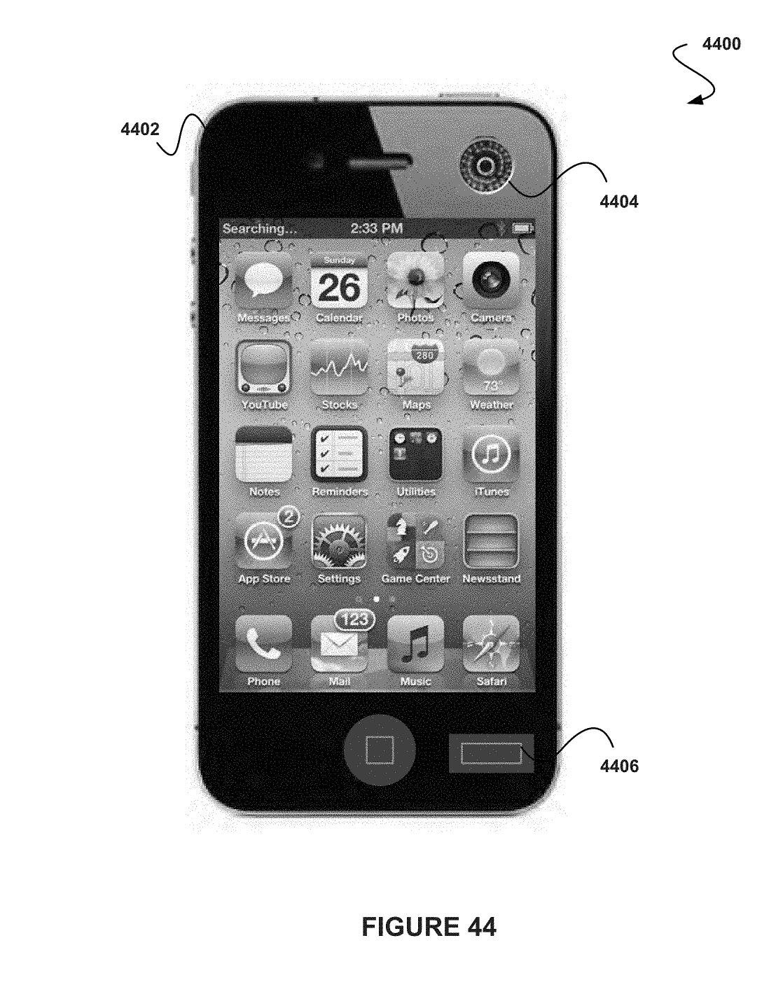

FIG. 44 shows a mobile device system 4400 for interacting with advertisement/content, in accordance with another embodiment. As an option, the mobile device system 4400 may be implemented in the context of the architecture and environment of the previous Figures and/or any subsequent Figure(s). Of course, however, the mobile device system 4400 may be implemented in the context of any desired environment. It should also be noted that the aforementioned definitions may apply during the present description.

As shown, a mobile device 4402 is displayed. Additionally, an iris scanning sensor 4404, and a fingerprint scanner 4406 are displayed. In one embodiment, the iris scanning sensor, the fingerprint scanner, and/or any other sensor (or combination of sensors) may be used to verify the identity of the user.

In various embodiments, verification of the identity of the user of the mobile may relate to security, including security clearance (e.g. government clearance, hazardous materials, etc.), traveling (e.g. security check-points, etc.), and/or any other location and/or function which may require security verification.

In one embodiment, the fingerprint sensor may take a fingerprint of a finger (e.g. thumb, etc.). In various embodiments, the fingerprint may be obtained by optical readings (e.g. thumb scan, etc.), solid-state reader, non-contact and/or touchless 3D scanner (e.g. 3D imaging, etc.), and/or by any other input device. The iris scanning sensor may take an image of the eye (e.g. photograph, etc.) and use such information to identify the user (e.g. based off of patterns associated with the iris, etc.). Of course, any information associated with the user (e.g. biometric sensors, etc.) may be used to further validate an identity of the user.

In a further embodiment, the mobile device may include an ability to bump (e.g. via NFC, etc.) with another device. In one embodiment, the bump may include an exchange of a temporary verification code (e.g. associated with a digital ticket, etc.) and/or any other information to further validate the identity of the user. In another embodiment, the ability to bump may permit another device to verify that it is communicating with a legitimate app (or OS/platform native utility, etc.) as opposed to a fraudulent application.

As an example, in one embodiment, the mobile device may be used while traveling. At the airport, an identification may be presented to the user (e.g. via the mobile device, etc.). An airport attendant may request further verification and/or validation, whereupon the mobile device may used to take the fingerprint, iris can, or any other information from the user. Further, the user may bump (e.g. via NFC or any short range wireless protocol, etc.) the mobile device with another device (e.g. associated with the airport attendant, etc.) to transfer a verification code (or any information, etc.) whereby the user's identity and the application's authenticity (e.g. non fraudulent, etc.0 may be confirmed. Of course, any number of steps and/or validation stages may be enforced to verify the identity of the user and/or the authenticity of the mobile device app.

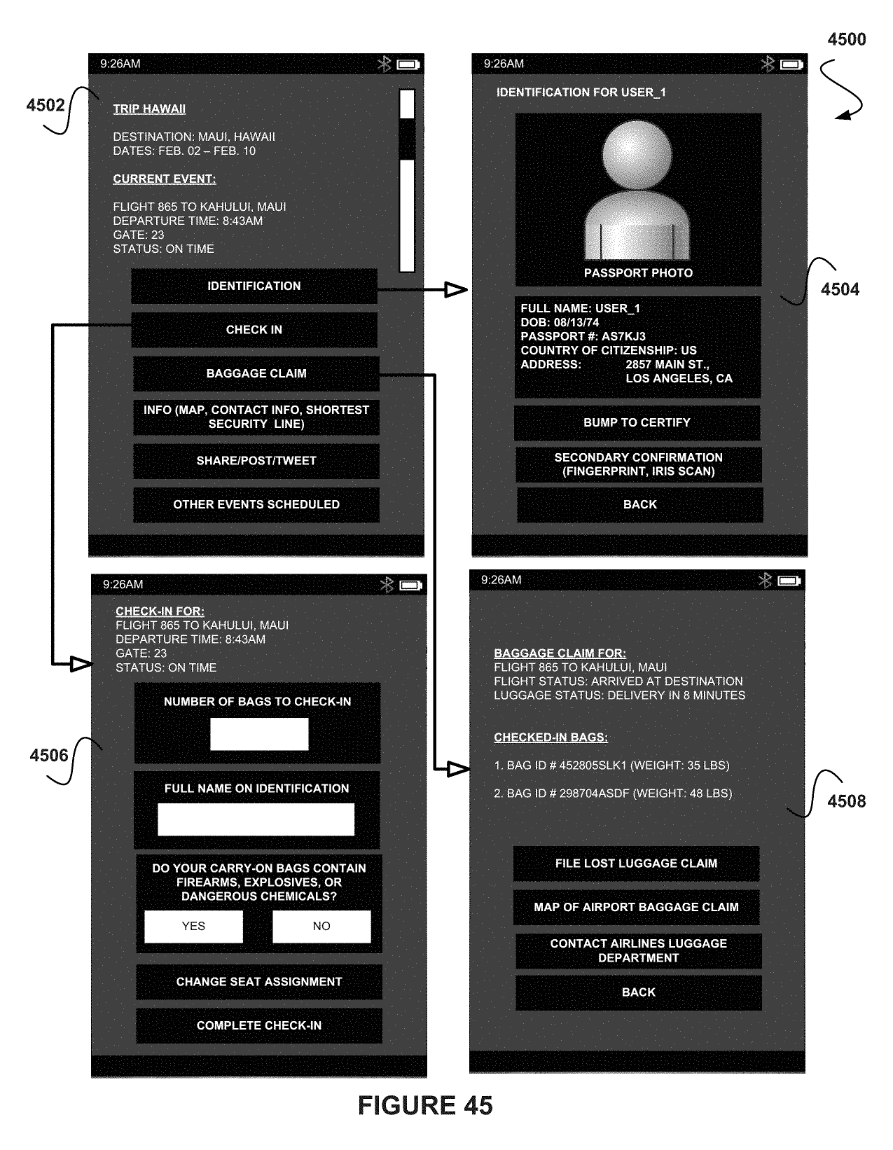

FIG. 45 shows a mobile device interface 4500 for interacting with advertisement/content related notifications, in accordance with another embodiment. As an option, the mobile device interface 4500 may be implemented in the context of the architecture and environment of the previous Figures and/or any subsequent Figure(s). Of course, however, the mobile device interface 4500 may be implemented in the context of any desired environment. It should also be noted that the aforementioned definitions may apply during the present description.

As shown, trip page 4502 is displayed. In various embodiments, the trip page may be associated with the OS/platform native utility, an application on the mobile device, an online portal, and/or any other system and/or software code. In one embodiment, the OS/platform native utility may include a section and/or pane relating to trips (e.g. as a separate category, as a subcategory under the “purchased events” category, etc.). In another embodiment, the trip page may be associated with a shared GUI (e.g. accessible through the OS/platform native utility and/or an application, etc.) associated with other participants.

In one embodiment, the trip page may include options, including identification, check in, baggage claim, info (e.g. map, contact info, shortest security line, etc.), share/post/tweet, other events scheduled, and/or any other option associated with a trip. In various embodiments the mobile device may enable the user to pass security verification points, pay for travel related expenses (e.g. food, airline charges, etc.), recover lost baggage, track assets (e.g. luggage, etc.), identity participants (e.g. family members, etc.), and/or facilitate any aspect associated with the trip.

In another embodiment, details relating to the trip may be displayed on the trip page. For example, in one embodiment, the trip destination and dates may be displayed. Additionally, a current event relating to the trip may be displayed which may be selected according to a schedule (e.g. next event on the calendar agenda, etc.), based on the context (e.g. located at an airport, located at a hula show, surrounded by friends, time triggers, etc.), and/or based on any parameter. Additionally, further information relating to the current event may be retrieved. For example, in one embodiment, if the current event was a scheduled flight, further information may include the current gate number assigned to the flight as well as the status of the flight (e.g. on time, delayed, etc.).

As shown, a user may select the “identification” button and a page 4504 associated with the command may be displayed. In one embodiment, the identification page may be associated with security, including verification of identity for security check points and/or for any other security related activity. In various embodiments, the identification page may include a passport photo, identification details (e.g. full name, date of birth, passport #, country of citizenship, address, etc.), the ability to bump to certify, ability to obtain secondary confirmation (e.g. fingerprint, iris scan, etc.), and/or any other further functionality which may relate to verifying the identification of the user.

In one embodiment, the identification page may be protected, including password protection, hash validation, secondary device validation (e.g. near another member, etc.), temporary password verification (e.g. sent temporarily to keychain password manager, etc.), sensor validation (e.g. verification of fingerprint and/or iris, etc.), and/or any other function which may be used to protect the identification page.

Further, in various embodiments, the identification page may be automatically presented to the user based on a trigger, including a predefined action (e.g. swipe of fingerprint, voice command “Display Identification—Verification Iris Scan,” etc.), the context and/or surroundings of the mobile device (e.g. in line at security checkpoint at airport, etc.), and/or may be presented in response to any predefined trigger.

In one embodiment, the user may request to bump (e.g. to validate authenticity of the application, etc.) another device (e.g. associated with a security personnel, etc.). In another embodiment, the user may receive a requested bump from another device. In one embodiment, if the bump authenticates the user's app (and/or the app associated with the other device, etc.), the identification page (or any page) may be displayed.

As shown, the user may select the “check in” button and a page 4506 associated with the command may be displayed. In various embodiments, the check in page may include input fields and/or information, including information relating to the item to be checked-in to (e.g. an airline flight, etc.), the number of bags to be checked in, the full name of the user's identification, the determination as to whether the user's carry-on bags contain firearms, explosives, or dangerous chemicals (e.g. displayed with a yes and/or no selection buttons, etc.), ability to change seat assignment, ability to complete check-in, and/or any other functionality and/or information which may relate in some manner to the check-in page.

In one embodiment, the check-in page may be associated with a payment page (e.g. for airline fees and/or charges, etc.). In one embodiment, the payment page may be managed by the OS/platform native utility and may be used by any application (including the check-in page, etc.) to complete payment transactions.

As shown, the user may select the “baggage claim” button and a page 4508 associated with the command may be displayed. In various embodiments, the baggage claim page may include information relating to the flight (e.g. flight number, flight status, luggage status, etc.), information relating to the checked baggage (e.g. bag ID, weight, etc.), and options relating to the baggage claim (e.g. file lost luggage claim, display map of airport baggage claim, contact airlines luggage department, etc.), and/or any other option and/or information relating to baggage claim.

In other embodiments, the trip page may be used to make and/or modify a reservation. For example, in one embodiment, the user may receive and ad and/or content notification relating to a travel deal. After opening the notification and choosing to use the deal, the trip page may be presented to the user with the option to purchase and/or organize all trip related items. In another embodiment, the user may use another app and/or process to buy trip related purchases (e.g. tickets, reservations, etc.). In such an embodiment, the OS/platform native utility may extract such trip related purchase information and input the information into a trip page. As such, information relating to a trip may be inputted to a trip page.

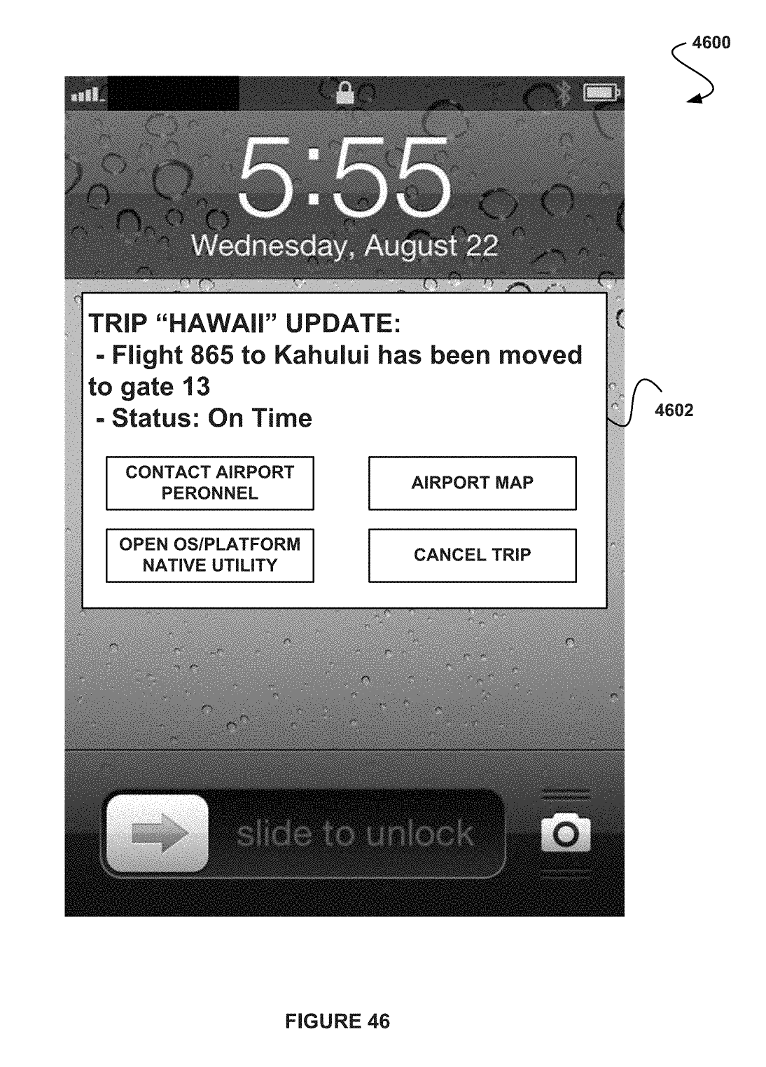

FIG. 46 shows a mobile device interface 4600 for interacting with advertisement/content related notifications, in accordance with another embodiment. As an option, the mobile device interface 4600 may be implemented in the context of the architecture and environment of the previous Figures and/or any subsequent Figure(s). Of course, however, the mobile device interface 4600 may be implemented in the context of any desired environment. It should also be noted that the aforementioned definitions may apply during the present description.

As shown, a trip update 4602 is displayed. In one embodiment, the trip update may be displayed on a locked screen, a drop down menu, a widget, on an app (e.g. including OS/platform native utility, etc.), and/or on any page of the mobile device. In one embodiment, the trip update may provide real-time feeds relating to an event. For example, in one embodiment, the update may relate to a flight, and the real-time feeds may relate to a change of gate (e.g. “Flight 865 to Kahului has been moved to gate 13,” etc.), a status of the flight (e.g. on time, etc.), and/or any other information associated with the event.

In other embodiments, the trip update may display feedback buttons, including, for example, buttons relating to “contact airport personnel,” “airport map,” “open OS/platform native utility,” “cancel trip,” and/or any other function which may relate in some manner to the trip update. Of course, any update associated with any event (e.g. a trip, a concert, a shared GUI, etc.) may be displayed with associated feedback buttons.

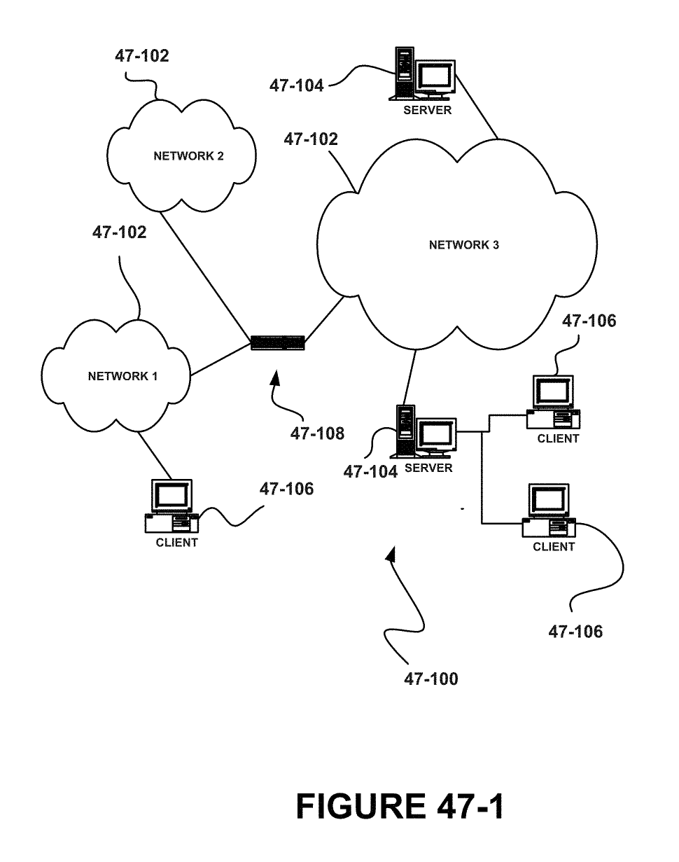

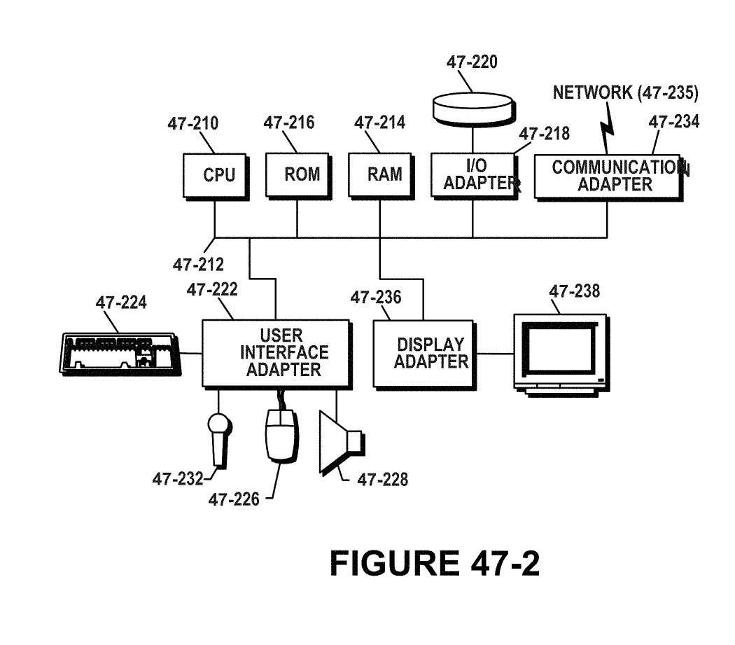

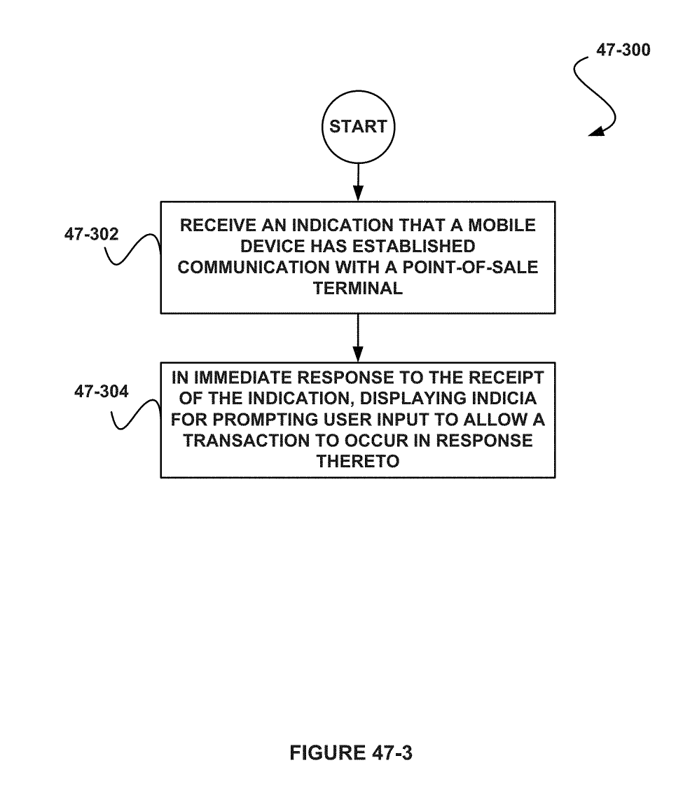

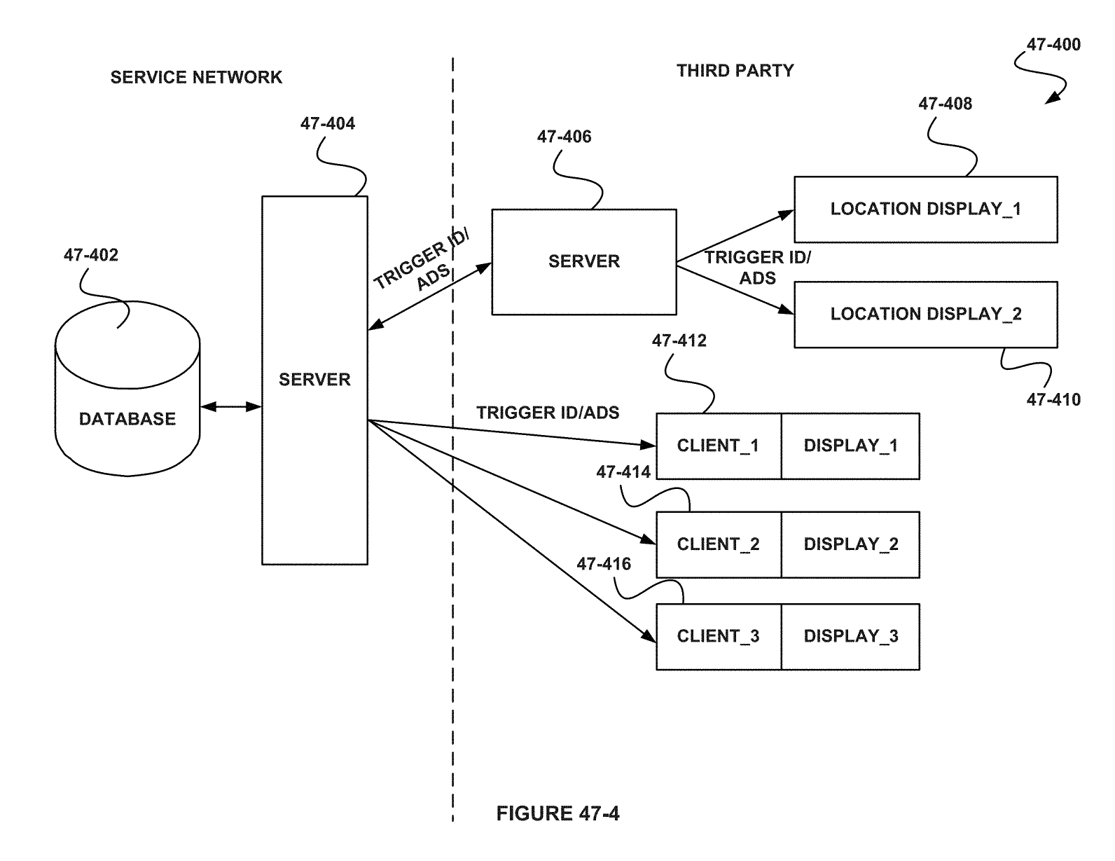

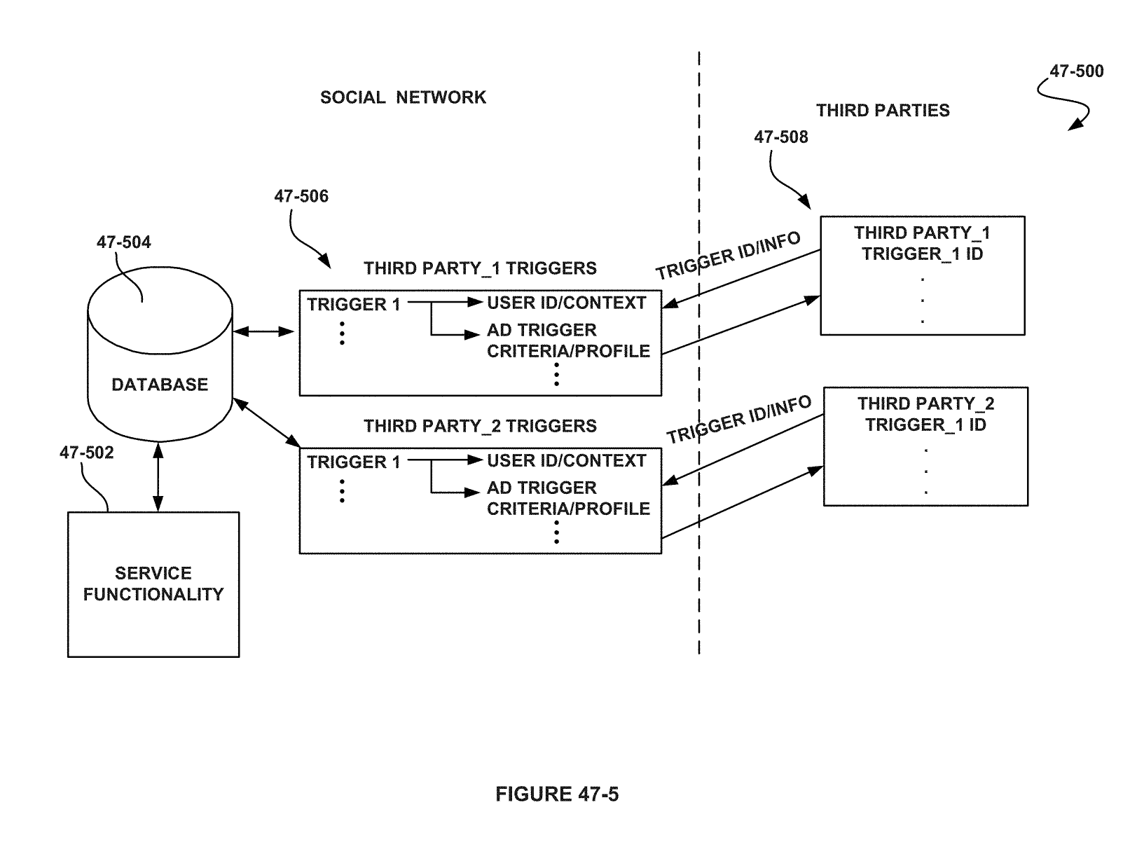

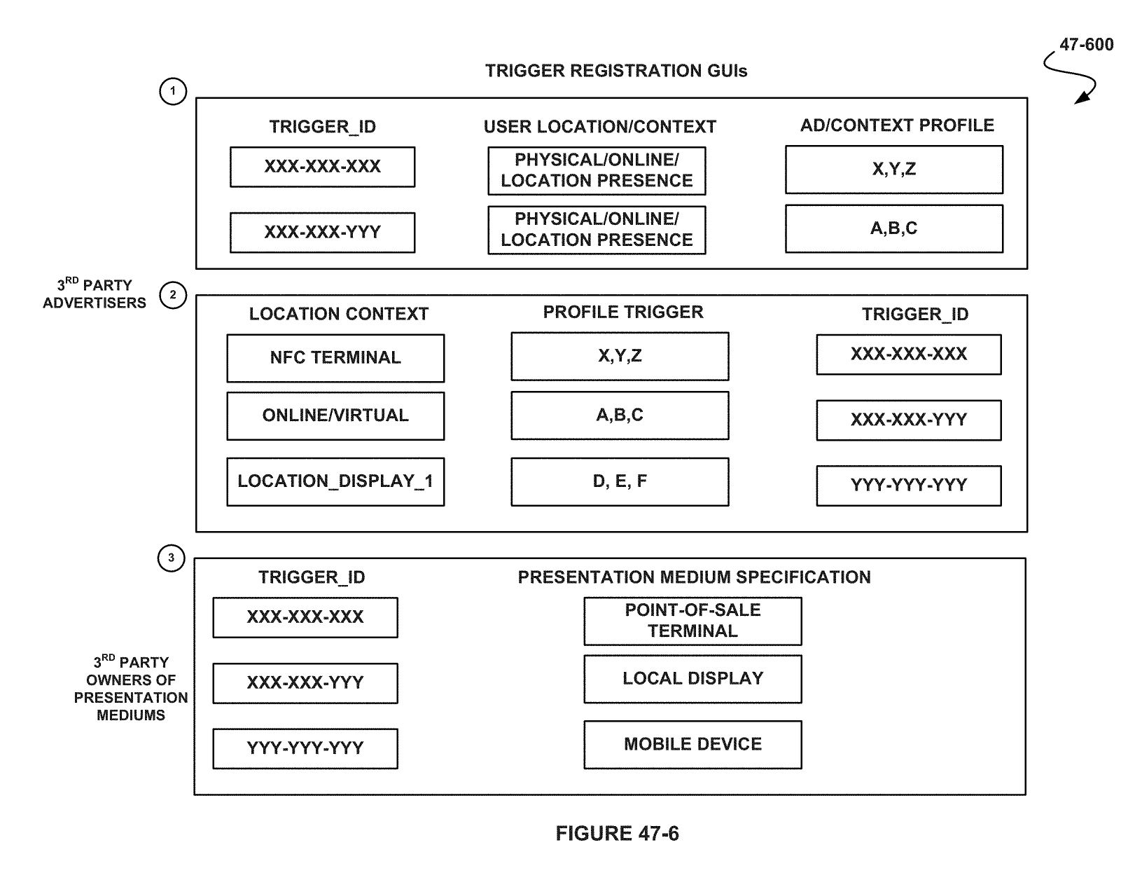

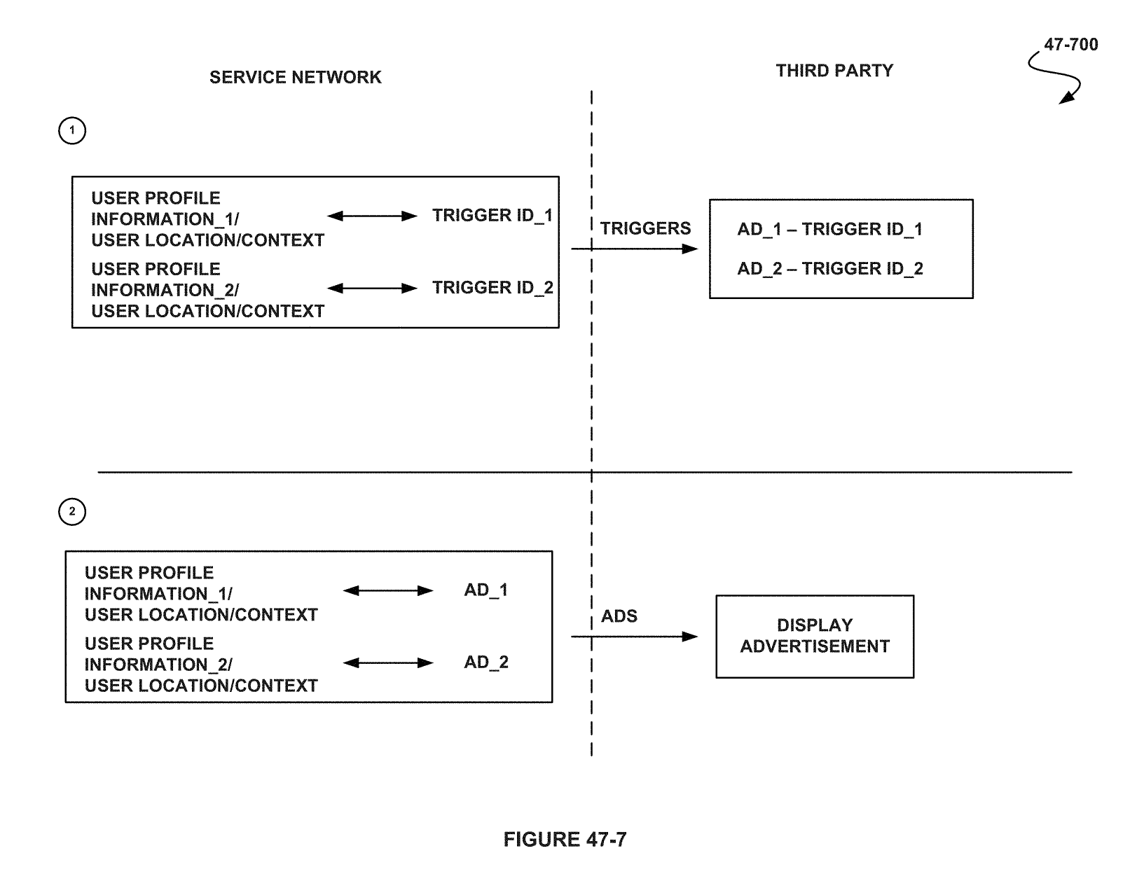

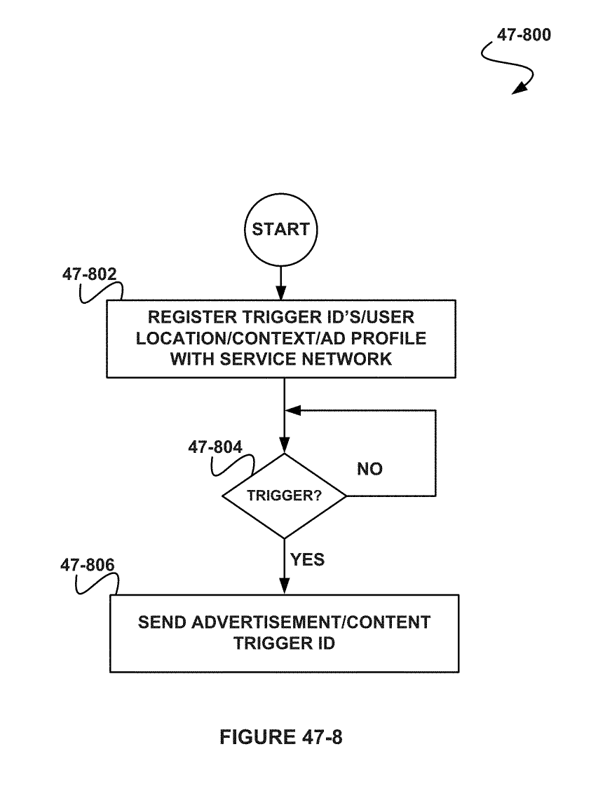

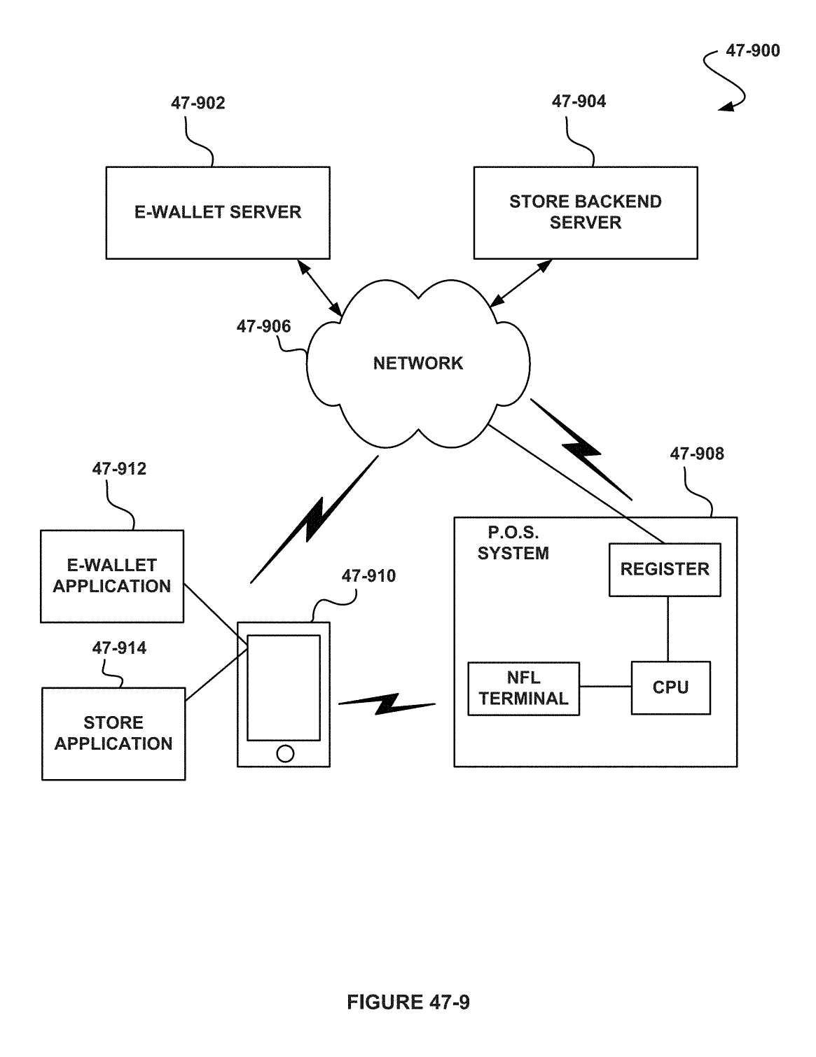

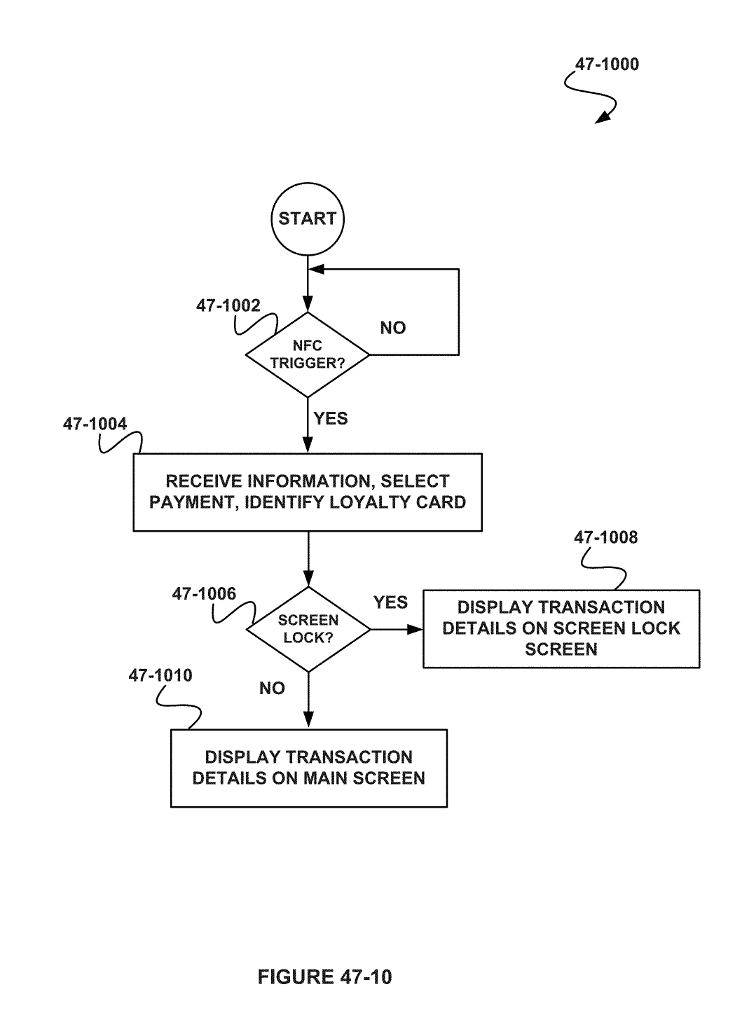

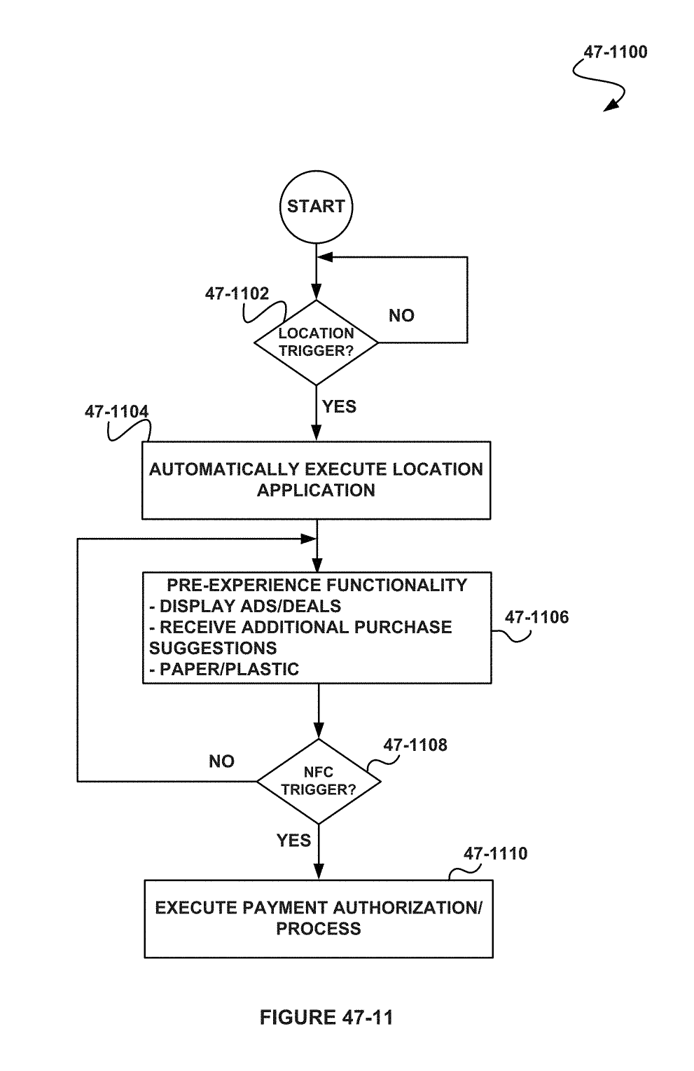

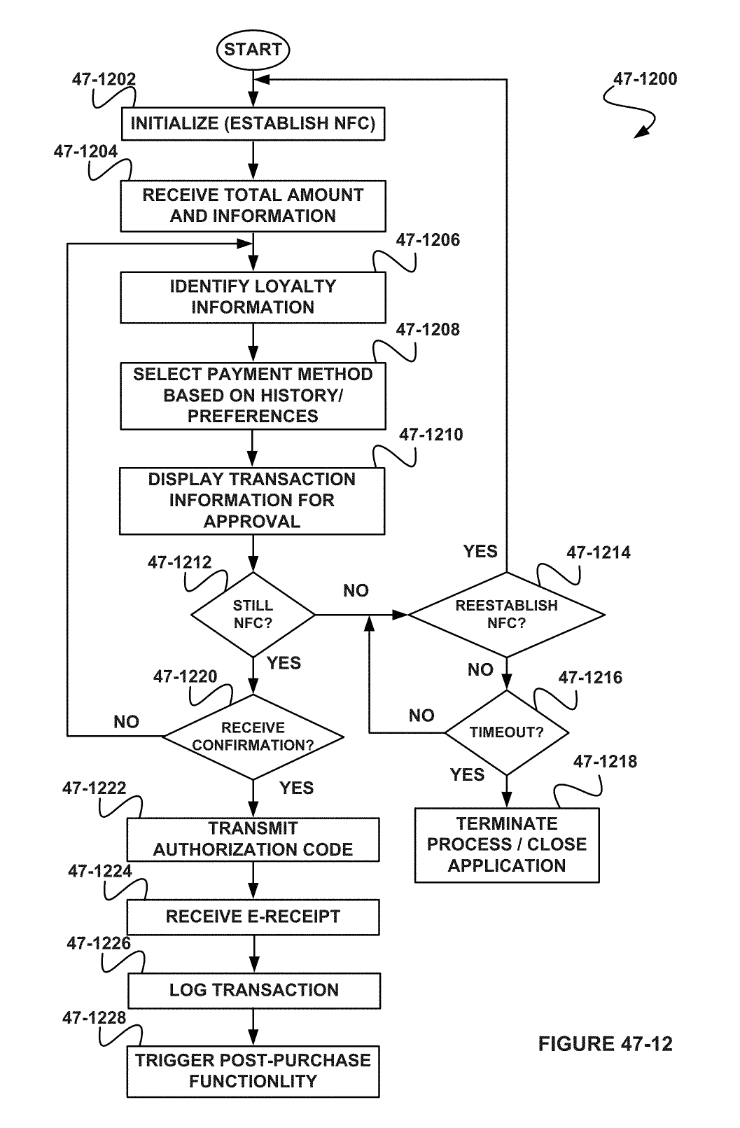

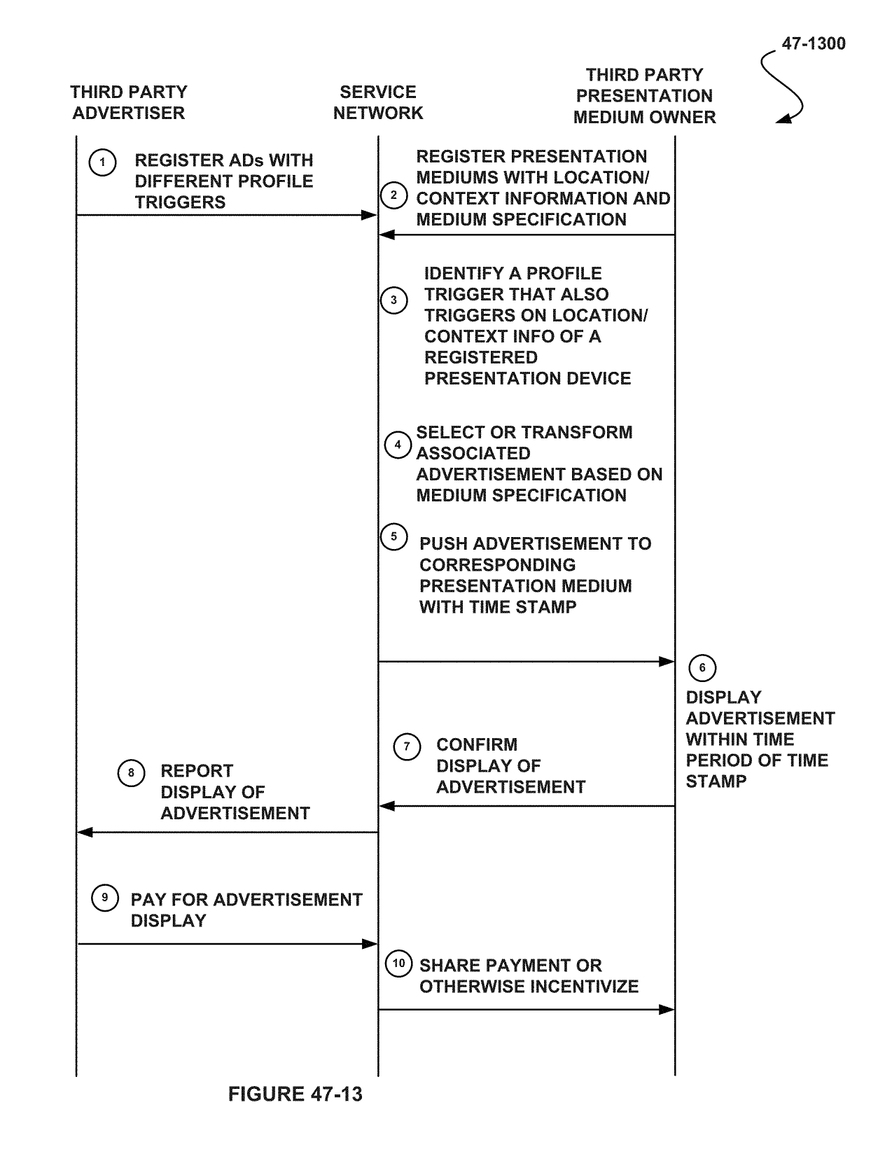

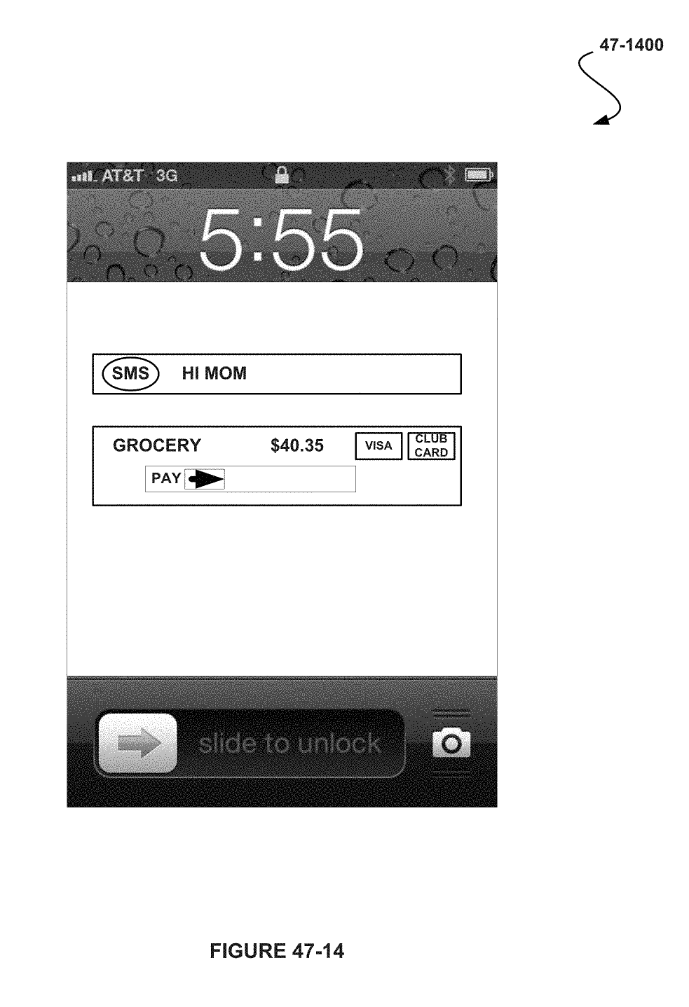

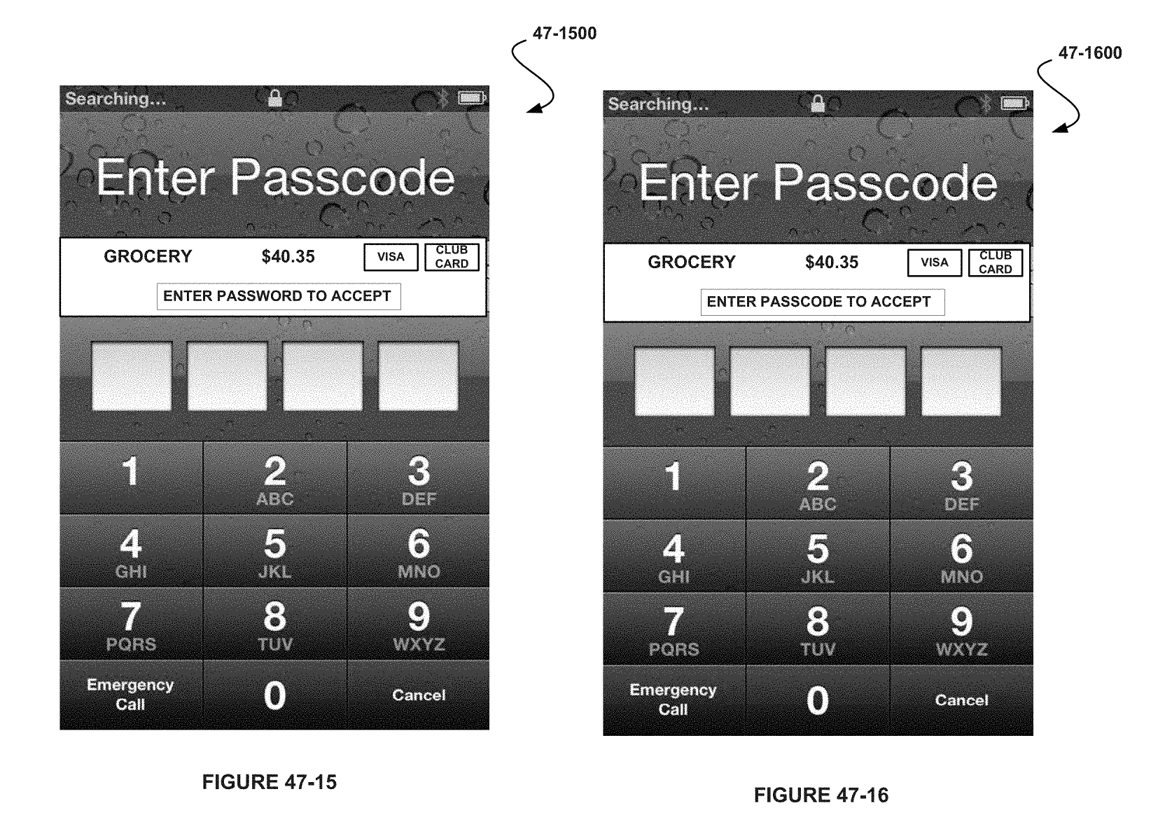

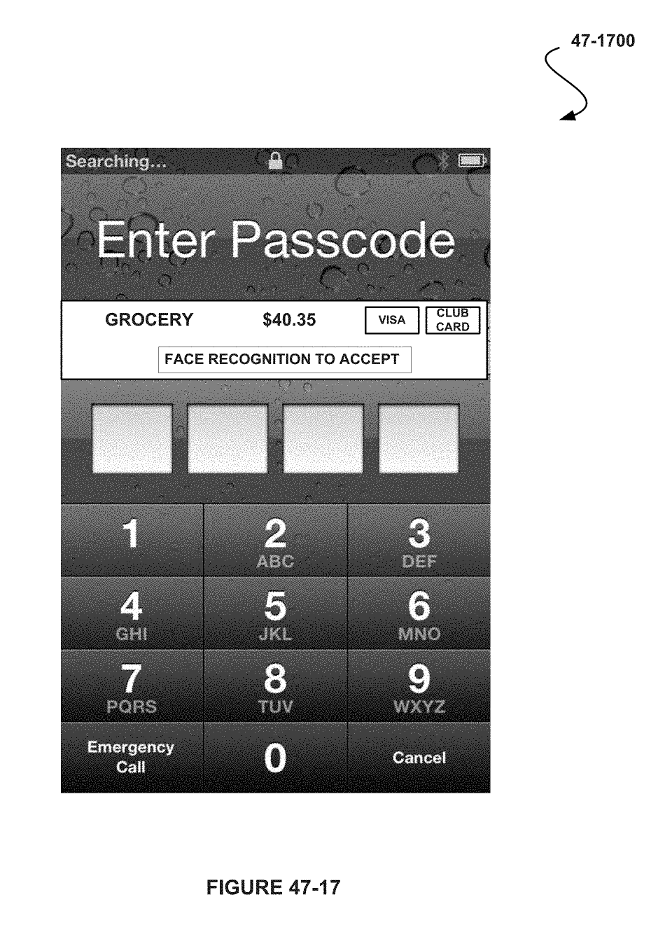

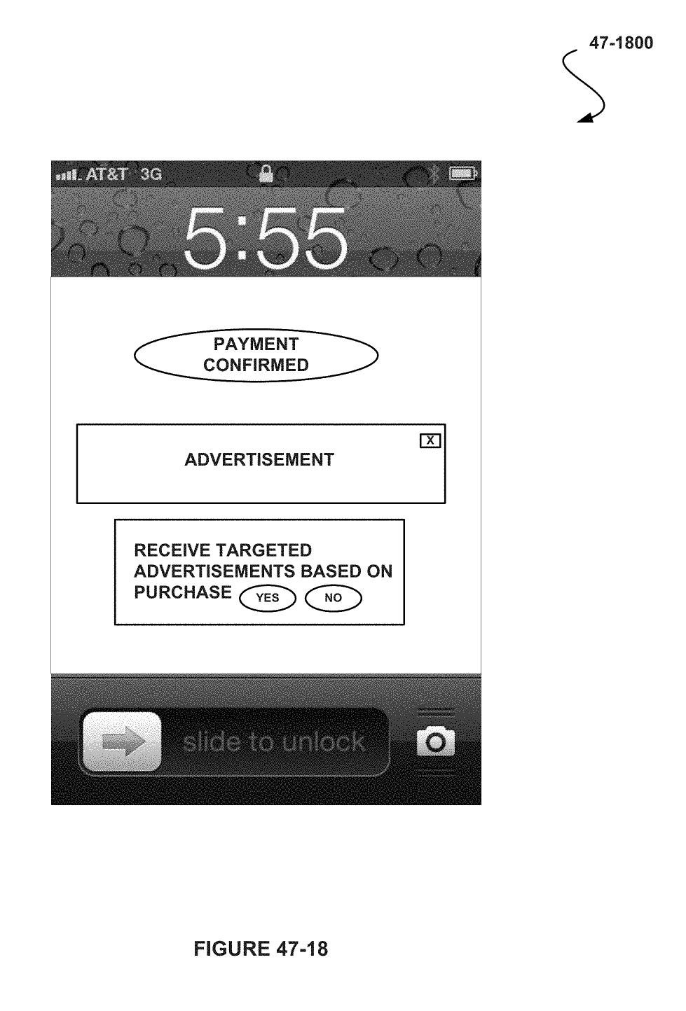

FIG. 47-1 illustrates a network architecture 47-100, in accordance with one embodiment. As shown, a plurality of networks 47-102 is provided. In the context of the present network architecture 47-100, the networks 47-102 may each take any form including, but not limited to a local area network (LAN), a wireless network, a wide area network (WAN) such as the Internet, peer-to-peer network, etc.

Coupled to the networks 47-102 are servers 47-104 which are capable of communicating over the networks 47-102. Also coupled to the networks 47-102 and the servers 47-104 is a plurality of clients 47-106. Such servers 47-104 and/or clients 47-106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 47-102, at least one gateway 47-108 is optionally coupled therebetween.

FIG. 47-2 shows a representative hardware environment that may be associated with the servers 47-104 and/or clients 47-106 of FIG. 47-1, in accordance with one embodiment. Such figure illustrates a typical hardware configuration of a workstation in accordance with one embodiment having a central processing unit 47-210, such as a microprocessor, and a number of other units interconnected via a system bus 47-212.

The workstation shown in FIG. 47-2 includes a Random Access Memory (RAM) 47-214, Read Only Memory (ROM) 47-216, an I/O adapter 47-218 for connecting peripheral devices such as disk storage units 47-220 to the bus 212, a user interface adapter 47-222 for connecting a keyboard 47-224, a mouse 47-226, a speaker 47-228, a microphone 47-232, and/or other user interface devices such as a touch screen (not shown) to the bus 47-212, communication adapter 47-234 for connecting the workstation to a communication network 47-235 (e.g., a data processing network) and a display adapter 47-236 for connecting the bus 47-212 to a display device 47-238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

FIG. 47-3 shows a method 47-300 for a mobile device transaction, in accordance with one embodiment. As an option, the method 47-300 may be implemented in the context of the architecture and environment of the previous Figures and/or any subsequent Figure(s). Of course, however, the method 47-300 may be carried out in any desired environment.

As shown, an indication is received that a mobile device has established communication with a point-of-sale terminal. See operation 47-302. Further, in immediate response to the receipt of the indication, indicia is displayed for prompting user input to allow a transaction to occur in response thereto. See operation 47-304.

In the context of the present description, a point-of-sale terminal refers to any terminal capable of facilitating a sale between entities. For example, in one embodiment, the point-of-sale terminal may include a point-of-sale terminal located a retailer location (e.g. a department store, a grocery store, a restaurant, a service center, a fueling station, etc.). As an option, the point-of-sale terminal may or may not be equipped with a cash register, inventory management system, etc.

The mobile device may include any type of mobile device. For example, in various embodiments, the mobile device may include a mobile phone, a tablet computer, an e-reader, a PDA, a handheld computer, a media device (e.g. a digital music player, a digital video player, etc.), and/or any other type of device that is mobile, for that matter.

The communication between the mobile device and the point-of-sale terminal may include various types of communication. For example, in one embodiment, the communication may be established utilizing near field communication (NFC). In another embodiment, the communication may be established utilizing Wi-Fi functionality (e.g. Wi-Fi direct, etc.). In another embodiment, the communication may be established utilizing Bluetooth functionality. In another embodiment, the communication may be established utilizing bump technology (e.g. direct contact, etc.). For example, in one embodiment, such bump technology may or may not include one or more of the features set forth in U.S. Application Publication No.: US2011/0191823A1 filed Feb. 3, 2010, which is incorporated herein by reference for all purposes. In still yet another embodiment, the communication may be established via the Internet (e.g. via a cellular network, Wi-Fi network, etc.).

The indication may be received in a various ways. For example, in one embodiment, the indication may be received based on a physical contact between the mobile device and the point-of-sale terminal. In this case, in one embodiment, the physical contact may be detected utilizing bump technology. In another embodiment, the indication may be received in response to an exchange of information via any of the aforementioned communication techniques (e.g. Wi-Fi, cellular, Internet, etc.).

For instance, in one possible embodiment, a service (administered, for example, by an application on the mobile phone and software at the point-of-sale) may determine that a first dynamic location of the mobile device being determined to be the same (or within a predetermined distance) as a second predetermined location of the point-of-sale terminal. Upon such determination, the service may send an indication signal to the mobile device (e.g. via the application).

In one embodiment, in connection with the indication, transaction information may or may not be received by the mobile device from the point-of-sale terminal. Additionally, in one embodiment, such transaction information may be displayed simultaneously with the indicia. The transaction information may include any information associated with a transaction. For example, in various embodiments, the transaction information may include a price, credit card information, loyalty information, product information, store information, time information, location information, discount information, method of purchase information, and/or any other type of transaction-related information.

Further, the indicia displayed for prompting user input to allow the transaction to occur may include any type of indicia capable of prompting the aforementioned user input. For example, in one embodiment, the indicia may include an accept icon. The accept icon may include any icon indicating acceptance of the transaction. For example, in one embodiment, the accept icon may include an icon with the word “Accept.” In another embodiment, the accept icon may include a thumbs-up icon. In another embodiment, the accept icon may include an “OK” indicator. In another embodiment, the accept icon may include a “YES” indicator. In another embodiment, the accept icon may include a “Purchase” indicator. In another embodiment, the accept icon may include a transaction price indicator, capable of being selected to indicate acceptance. In another embodiment, the accept icon may include a button. In another embodiment, the accept icon may include a slider.

Additionally, in one embodiment, the indicia may include a password entry menu. For example, a keyboard may be presented to a user of the mobile device, along with an entry portion. As an option, the password entry may be displayed in response to a slide gesture in connection with a slider icon.

In another embodiment, the indicia may include fingerprint scanner indicia. For example, in one embodiment, an indicator (and/or text) to scan a fingerprint may be displayed on the screen of the mobile device. In another embodiment, an area to scan a fingerprint may be displayed on at least a portion of a screen of the mobile device. In one embodiment, the user may be prompted to capture an image of a fingerprint, for analysis.

In another embodiment, the indicia may include facial recognition indicia. For example, in one embodiment, an indicator (and/or text) to scan or present a face may be displayed on the screen of the mobile device. In another embodiment, a button or icon to capture a face may be displayed on at least a portion of a screen of the mobile device.

In another embodiment, the indication may be capable of being received while a screen-lock graphical user interface is being displayed by the mobile device. For example, in one embodiment, the user may be required to enter a password/passcode to access some or most functionally associated with the mobile device. In this case, in one embodiment, the screen-lock graphical user interface may be displayed, and the indication may be capable of being received and/or the indicia may be capable of displayed on the screen-lock graphical user interface. In one embodiment, the indicia may be capable of being displayed on a portion of the screen-lock graphical user interface (e.g. between an upper time and/or date indicia and lower screen-lock graphical user interface functionality in the form of a slider bar and/or password entry interface, etc.).

In another embodiment, the indication may be capable of being received while the mobile device is in a standby mode. In one embodiment, the standby mode may include displaying a standby screen on the mobile device. In another embodiment, the standby mode may include the display (e.g. backlight, etc.) of the mobile device being powered off. In this case, in one embodiment, the indication may cause the automatic powering of the display screen (e.g. backlight, etc.), in addition to the display of the indication. In such embodiment, after the display screen is powered on, the indication may or may not be displayed in connection with a screen-lock graphical user interface (as set forth in the previous embodiment).

In yet another embodiment, the indicia may be displayed utilizing a transaction application installed on the mobile device. For example, in one embodiment, a mobile wallet application may be installed on the mobile device. In this case, in one embodiment, the mobile wallet application or an application associated therewith may be utilized to display the indicia.

In another embodiment, the indicia may be displayed utilizing a transaction application installed on the mobile device, that is automatically executed in immediate response to the receipt of an indication that the mobile device has established a first communication with the point-of-sale terminal via a first communication protocol other than a second communication protocol associated with the established communication that allows the transaction to occur. The communication protocols may include any type of protocol. For example, in one embodiment, the first communication protocol may include a Wi-Fi or Bluetooth communication protocol and the second communication protocol may include a near field communication protocol. In another embodiment, the first communication protocol and/or the second communication protocol may include a cellular, Internet, Wi-Fi, Bluetooth, and/or a near field communication protocol.

In another embodiment, pre-transaction functionality may be provided by the transaction application. In various embodiments, the pre-transaction functionality may include advertising, suggestion-related functionality, location-related functionality (e.g. store location related functionality, product-related functionality, etc.), point-of-sale terminal-related functionality, and/or loyalty-related functionality, etc. In one embodiment, the pre-transaction functionality may be utilized to initiate a transaction.

In one embodiment, it may be desired that the pre-transaction functionality occur before reaching a point-of-sale termination. Thus, in one possible embodiment, a service (administered, for example, by an application on the mobile phone and software at the point-of-sale terminal) may determine that a first dynamic location of the mobile device being within a predetermined distance (e.g. a few feet, yards, within a radius, within a building/retail location perimeter, etc.) of a second predetermined location of the point-of-sale terminal. Upon such determination, the service may send an indication signal to the mobile device (e.g. via the application) to initiate or otherwise cause the pre-transaction functionality.

Additionally, in one embodiment, the indication may be received based on a physical contact between the mobile device and the point-of-sale terminal. In one embodiment, the physical contact may include physical contact with a designated portion of the mobile device and/or the point-of-sale terminal. In another embodiment, the indication may be received based on close physical proximity between the mobile device and the point-of-sale terminal. Further, in one embodiment, the physical contact may be detected utilizing bump technology.

The transaction information may be received from a variety of devices. For example, in one embodiment, the transaction information may be received by the mobile device from the point-of-sale terminal. In another embodiment, the transaction information may be received by the mobile device from a network server. In another embodiment, the transaction information may be received by the mobile device from a payment provider service or server.

In one embodiment, the transaction information may be displayed simultaneously with the indicia. For example, in various embodiments, a price, credit card information, and/or loyalty information may be displayed simultaneously with an accept icon, a password entry menu, a fingerprint scanner indicia, and/or a facial recognition indicia. Further, in one embodiment, the indicia may be displayed utilizing a transaction application installed on the mobile device, which may be automatically executed in immediate response to the receipt of the indication. In various embodiments, the transaction application may include a mobile payment application, a mobile wallet application, a credit card application, and/or various other transaction-related applications.

In another embodiment, the indicia may be displayed utilizing a transaction application installed on the mobile device that provides post-transaction functionality. In various embodiments, the post-transaction functionality may include at least of advertising, loyalty-related functionality, return visit-related functionality, and/or suggestion-related information. Of course, embodiments are contemplated whereby the post-transaction functionality is provided without a transaction application (e.g. via a web-service, browser, etc.).

The user input prompted by the indicia may include various user input. For example, in various embodiments, the user input that is prompted may be in direct connection with the indicia (e.g. touch the icon displayed with a touchscreen, etc.) and/or may be indirectly connected (e.g. indicia prompting user input via a mechanical button, voice input, etc. and/or other input not based on the touch screen, etc.). In one embodiment, the indicia may instruct the user to provide a specific input. For example, in one embodiment, the indicia may include text instructions. Further, in various embodiments, the user input may include a finger swipe, a finger depression, an image of the user (e.g. for the purposes of facial recognition, etc.), voice input, text input, and/or various other user input.

In one embodiment, the indicia may be displayed in immediate response to the receipt of the indication, by displaying the indicia without any intermediate graphical user interfaces. For example, in one embodiment, upon a mobile device establishing communication with the point-of-sale terminal, the indicia for prompting the user input may be automatically and immediately displayed on a screen of the mobile device. In one embodiment, the indicia for prompting the user input may be automatically and immediately displayed on a screen of the mobile device only if a potential transaction is available (e.g. if there are item in a digital shopping cart, if there are items in a physical shopping cart, etc.).

Further, in one embodiment, the transaction may be immediately allowed to occur in response to the receipt of the user input. In one embodiment, the transaction may be immediately allowed to occur in response to the receipt of the user input, by allowing the transaction to occur without any additional graphical user interfaces.

In one embodiment, the mobile device and/or the point-of-sale terminal may include transaction-related functionality. In various embodiments, the transaction-related functionality may include pre-transaction functionality, a transaction, and/or post-transaction functionality. It should be noted that the aforementioned pre-transaction, transaction, and/or post-transaction functionality may or may not include any of the techniques disclosed during the description of any of the figures herein. Further, in one embodiment, the transaction-related functionality may be provided by a transaction application installed on the mobile device.

Still yet, in one embodiment, the point-of-sale terminal may be associated with (e.g. in communication with, etc.) one or more service providers (e.g. advertisers, social network systems, retailers, etc.). Additionally, in one embodiment, the point-of-sale terminal and/or the mobile device may be in communication with a system capable of storing profile information associated with members of a service network, storing advertisement trigger information associated with advertisements of an advertiser, and/or for causing presentation of at least one of the advertisements outside of the service network, based on the profile information and the advertisement trigger information. Of course, any description herein of such presentation of one or more advertisements outside of the service network (and any related functionality disclosed herein) may be implemented without involving a point-of-sale terminal.

In various embodiments, the service network may include at least one of a social network, an e-commerce network, an e-wallet network, or a search network, etc. Further, the profile information may include any type of profile information. For example, in one embodiment, the profile information may include interest information and/or demographic information.

Of course, in various embodiments, the profile information may include any type of information, such as browsing history, social network information, a gender, an age, a birth date, an astrological sign, a nationality, a religion, a political affiliation (e.g. Democrat, Republican, etc.), a height, a weight, a hair color, an eye color, an ethnicity, a living address (e.g. a home address, etc.), a work address, an occupation (e.g. student, engineer, barista, unemployed, etc.), a sexual preference, an education level (e.g. a high school education, a college education, a postgraduate degree, etc.), a birth place, a school attended (e.g. an elementary school attended, a middle school attended, a high school attended, a college attended, etc.), an area once lived (e.g. during adolescence, after high school, during adult years, etc.), a relationship status (e.g. single, married, significant other, etc.), a family status (e.g. living parents, divorced parents, estranged from parents, etc.), a number of siblings, an income level, a car status (e.g. a car model, a car make, a car year, a car price, etc.), a number of children, hobbies (e.g. reading, running, volunteering, biking, golf, climbing, etc.), exercise habits (e.g. number of hours/minutes a week, number of times a month, type of exercise preferred, etc.), a number of pets owned, a type of pets owned (e.g. dogs, cats, fish, gerbils, etc.), food preferences (e.g. vegetarian, vegan, mainly meat, Chinese cuisine, Mexican cuisine, etc.), drinking habits (e.g. daily, weekly, monthly, etc.), eating habits (e.g. eat in, dine out, snacks, meals, etc.), TV watching preferences (e.g. types of preferred shows, number of hours/minutes per day/week, etc.), movie watching preferences (e.g. types of preferred movies, number of movies per day/week/month, etc.), music preferences (e.g. preferred genre, preferred artist, etc.), sleeping preferences (e.g. the number of hours of sleep preferred, the preferred bed time/rise time, etc.), moods (e.g. generally a good mood, generally a bad mood, etc.), feelings (e.g. generally happy, generally sad, generally angry, etc.), desires (e.g. goals, wishes, etc.), and/or any other personal information.

In various embodiments, the personal information may include permanent personal information (e.g. physical traits, history, etc.), temporal personal information (e.g. what the user is doing/feeling/experiencing now or within a predetermined window of time, etc.), and/or future goal-oriented personal information (e.g. wants, desires, etc.).

In one optional embodiment, the personal information may be received in association with a social networking site that allows users to define themselves in a profile (e.g. which may include any one or more of the personal information parameters disclosed hereinabove and/or herein below, etc.); associate themselves with others (e.g. friends, colleagues, other groups, etc.) by connecting to each other; and/or engage in activities (e.g. using applications such as games, reviewing content, sharing content (e.g. interests, thoughts, questions, media, etc.), etc.

In such embodiment, the personal information may be received from a social networking profile of the user associated with a social networking site. Further, the personal information may include any entities (e.g. people, groups, institutions, products, etc.) to which the user is associated (e.g. connected, subscribed, linked) during use of the social networking site. Such associations may also be extended to “associations-of-associations” (e.g. friends of friends, etc.). Even still, tracking such associations as personal information may be extended to a threshold number (e.g. 1, 2, 3, 4, 5, etc.) of degrees-of-separation. As a further option, the personal information may be received based on any of the aforementioned activity of the user in connection with the social networking site. In such example, any profiling metadata collected based on the activity of the user may be utilized as the personal information.

One optional embodiment is contemplated wherein an on-line application associated with the social networking site may collect and/or use the aforementioned social networking site-related personal information in connection with any of the functionality disclosed hereinabove and/or herein below. Of course, such social networking site-related on-line application may do so by itself and/or in connection with other one or more social networking site-related on-line application(s) or separate/independent site-related on-line application(s).

In one embodiment, a pre-existing social networking site may be leveraged to accomplish any one or more of the operations disclosed herein. With that said, any site that collects any of the personal information disclosed herein may optionally be used in lieu of or in combination with the aforementioned social networking site. For example, an e-commerce site (e.g. product supply website, etc.) that collects profile information, etc. may be utilized in a similar manner.

More information regarding leveraging service providers to collect information may be found in U.S. Provisional Patent Application No. 61/563,741, filed Nov. 25, 2011, titled “SYSTEM, METHOD, AND COMPUTER PROGRAM PRODUCT FOR PRESENTING DECISION RELATED INFORMATION;” and U.S. Provisional Patent Application No. 61/590,764, filed Jan. 25, 2012, titled “SYSTEM, METHOD, AND COMPUTER PROGRAM PRODUCT FOR PRESENTING INFORMATION TO A USER BASED ON DETERMINED SATISFACTION-RELATED INFORMATION ASSOCIATED WITH THE USER,” which are incorporated herein by reference in their entirety.

Further, in one embodiment, targeted advertisements may be presented to the user on the mobile device, based on any user information. In one embodiment, the advertisement may be presented outside of the service network. In this case, in one embodiment, the presentation of the advertisement outside of the service network may be accomplished by the service network transmitting a signal outside the service network.

Further, in one embodiment, the signal may be time-stamped. Additionally, in one embodiment, the presentation of the at least one advertisement outside of the service network may be accomplished by the service network transmitting the advertisement outside the service network. In one embodiment, a format of the advertisement may be based on presentation medium specification information. For example, in one embodiment, the advertisement may be formatted to present on the mobile device. In another embodiment, the advertisement may be formatted to be presented on a display associated with the point-of-sale terminal. In another embodiment, the advertisement may be formatted to be displayed on a billboard and/or an in store display. In still another embodiment, the advertisement may be displayed via a television.

Additionally, in one embodiment, the at least one advertisement may be time-stamped. In one embodiment, the time stamp me be utilized to determine a duration in which the advertisement is to be displayed. In another embodiment, the time stamp may be utilized to determine a time in which the advertisement is to expire.

Further, in one embodiment, the advertisement may be presented via a server in communication with a plurality of presentation mediums, where the server is operable to cooperate with the server network. In another embodiment, the advertisement may be presented via at least one of a plurality of presentation mediums each with client code operable to cooperate with the server network. In various embodiments, the advertisement may be presented by the advertiser or a party separate from the service network and the advertiser.

Additionally, in one embodiment, the advertisement may be presented based on location information associated with members of the service network. In one embodiment, the location information may be determined by the service network. In various embodiments, the location information may be determined utilizing GPS, Wi-Fi, an IP address, and/or various other techniques (e.g. manual indication by the member(s), etc.). Furthermore, in various embodiments, the service network may include any number of service networks, such as a social network, an e-commerce network, an e-wallet network, and/or a search network, etc.

More illustrative information will now be set forth regarding various optional architectures and features with which the foregoing techniques discussed in the context of any of the present or previous figure(s) may or may not be implemented, per the desires of the user. For instance, various optional examples and/or options associated with the communication/indication of operation 47-302, the transaction/indicia of operation 47-304, and/or other optional features have been and will be set forth in the context of a variety of possible embodiments. It should be strongly noted, however, that such information is set forth for illustrative purposes and should not be construed as limiting in any manner. Any of such features may be optionally incorporated with or without the inclusion of other features described.

FIG. 47-4 shows a system 47-400 for mobile device transactions, in accordance with another embodiment. As an option, the system 47-400 may be implemented in the context of the architecture and environment of the previous Figures and/or any subsequent Figure(s). Of course, however, the system 47-400 may be implemented in the context of any desired environment. It should also be noted that the aforementioned definitions may apply during the present description.

As shown, a service network system may include a database 47-402 and server 47-404. The service network system may be associated with a variety of service networks, including a social network, a retailer, a payment provider, payment facilitator, an advertiser, a search engine system, a mobile wallet system, a media provider, and/or any other service network system that provides one or more services to its members.

The service network system may be in communication with one or more third party systems. For example, in one embodiment, the service network system may be in communication with a third party retailer, advertiser, and/or payment system that each include one or more third party server(s) 47-406. Additionally, in one embodiment, the service network system may be in communication with one or more third party client devices 47-412-47-416. In various embodiments, the client devices may include mobile phones, computers, media devices, displays, payment systems, point-of-sale terminals, and/or various other devices.

In another embodiment, the devices 47-408-47-418 may include a vehicular head-unit display associated with a vehicular assembly. One example of such a vehicular assembly may include that which is disclosed in U.S. Pat. No. 8,131,458 issued Mar. 6, 2012 and entitled “SYSTEM, METHOD, AND COMPUTER PROGRAM PRODUCT FOR INSTANT MESSAGING UTILIZING A VEHICULAR ASSEMBLY,” which is incorporated herein by reference in its entirety. In the present embodiment, such head-unit display may communicate with the servers 47-404 and/or 47-406 via a communication channel of a mobile device (as taught in U.S. Pat. No. 8,131,458). Of course, in other embodiments, the vehicle (and thus the head-unit display) may be equipped with its own modem for communicating directly with the servers 47-404 and/or 406.

In different embodiments, the displays 47-408-47-416 may or may not be equipped with software (e.g. a plug-in and/or an application program, etc.) for providing an interface to receive/send signals with respect to the server 47-406 and/or 47-404. Such software may also include interface code (e.g. driver, etc.) for accommodating the specific protocol/format, etc. of the displays 47-408-47-416 and otherwise controlling the same (and content displayed). In other embodiments, of course, the signals/control administered by the server 47-406 and/or 47-404 may be standardized such that communications may be directed at the displays 47-408-47-416 without the need for additional software.

Furthermore, in one embodiment, the service network system may be in communication with systems/displays dedicated (at least in part) to displaying advertisements, deals, and/or for facilitating payment of products and/or services. For example, in one embodiment, the service network system may be in communication with a third party server 47-406 and/or one or more location specific displays 47-408-47-410.

In the context of the present description, a location specific display refers to a display associated with a location. For example, in various embodiments, the location specific display may include a display at a business location (e.g. a monitor, a television, a computer display, etc.), a billboard, a display associated with a point-of-sale terminal, a display associated with a product/service (e.g. a display at a gas pump, etc.), and/or any other type of display.

The communication between the service network system and the third party system may be facilitated utilizing a variety of techniques. For example, in one embodiment, the communication between the service network system and the third party system may include direct communication (e.g. a wireless direct connection, a wired direct connection, etc.). In another embodiment, the communication between the service network system and the third party system may include indirect communication (e.g. communication via a server, communication via a cloud, communication via one or more other systems, etc.).

In operation, in one embodiment, the service network may be operable to cause the display of targeted advertisements and/or targeted content on the location specific displays 47-408-47-410 and/or the client devices 47-412-47-416. In one embodiment, the service network system may push the advertisements (e.g. including advertisement content, etc.) to the location specific displays 47-408-47-410 and/or the client devices 47-412-47-416. In another embodiment, the service network system may push an advertisement trigger ID to another system (e.g. the server 47-406, etc.) such that the advertisements are displayed on the location specific displays 47-408-47-410 and/or the client devices 47-412-47-416. Of course, in some embodiments, the aforementioned advertisement trigger ID may be sent directly to the location specific displays 47-408-47-410 and/or the client devices 47-412-47-416, for using the same to access appropriate advertisements locally and/or remotely.

For example, in one embodiment, it may be determined that a user is in the vicinity of the one or more location specific displays 47-408-47-410. Accordingly, in one embodiment, targeted content and/or advertisements may be presented to the user on the one or more location specific displays 47-408-47-410. In one embodiment, the targeted content and/or advertisements presented to the user on the one or more location specific displays 47-408-47-410 may include targeted content and/or advertisements associated with the location.

The location of the user may be determined utilizing a variety of techniques. For example, in one embodiment, the user may digitally check in to a location. In various embodiments, the user may check-in to the location utilizing a mobile device associated with the user, a system associated with the location, and/or another device. In one embodiment, the user may check in to a location utilizing an application stored on the mobile device of the user. In various embodiments, the application may include a social network application, an application associated with the location, a mapping application, a geo-caching application, a mobile payment application, and/or various other applications. In another embodiment, the user may check in to a location utilizing a check-in system associated with the location.

In another embodiment, a mobile device of the user may be utilized to automatically check in to a location. For example, in one embodiment, an application stored on the mobile device may be utilized to automatically check in to a location (e.g. based on a wireless signal, based on a wireless network availability, based on GPS, a bump signal, an NFC signal, etc.).

More information regarding checking in to a location, etc. may be found in U.S. Provisional Patent Application No. 61/590,767, filed Jan. 25, 2012, titled “SYSTEM, METHOD AND COMPUTER PROGRAM PRODUCT FOR LOCATION-SPECIFIC PRIVACY SETTINGS;” U.S. Provisional Patent Application No. 61/591,819, filed Jan. 27, 2012, titled “SYSTEM, METHOD, AND COMPUTER PROGRAM PRODUCT FOR ALTERING AT LEAST ONE ASPECT OF AN INTEGRATED E-COMMERCE ON-LINE APPLICATION;” and U.S. Provisional Patent Application No. 61/596,174, filed Feb. 7, 2012, titled “SYSTEM, METHOD, AND COMPUTER PROGRAM PRODUCT FOR ALTERING AT LEAST ONE ASPECT OF AN INTEGRATED E-COMMERCE ON-LINE APPLICATION,” which are each incorporated herein by reference in their entirety.

Further, in one embodiment, the location of the user may be determined based on GPS. For example, the mobile device (and/or an application/OS associated therewith) may share GPS data associated with the mobile device, such that the location of the mobile device/user is determined. In one embodiment, the GPS data may be shared with the service network system. In another embodiment, the GPS data may be shared with one or more third party systems.

In another embodiment, the location of the user may be determined based on a signal provided by the mobile device of the user. For example, in one embodiment, the mobile device of the user may provide a Bluetooth signal that is capable of being received by a device associated with the location (e.g. a display, a computer, a location detection device, a point-of-sale device, etc.), such that location may be determined. In another embodiment, the mobile device of the user may provide a NFC signal that is capable of being received by a device associated with the location (e.g. a display, a computer, a location detection device, a point-of-sale device, etc.), such that location may be determined.

In another embodiment, the mobile device of the user may provide a Wi-Fi signal that is capable of being received by a device associated with the location (e.g. a router, a display, a computer, a location detection device, a point-of-sale device, etc.), such that location may be determined. In another embodiment, the mobile device of the user may provide a chirp signal that is capable of being received by a device associated with the location, such that location may be determined. In one embodiment, the chirp signal may include information associated with the location (e.g. GPS coordinates, etc.). In one embodiment, a signal strength associated with the chirp may be used to associate the user with a location.

In another embodiment, the mobile device may be connected to a wireless network associated with the location automatically (or manually), such that a location may be determined. In still another embodiment, the location of the user may be determined utilizing facial recognition techniques. For example, in one embodiment, a system associated with the location may be utilized to determine the user is present based on facial recognition.

More information regarding facial recognition and other features that may or may not be incorporated into any of the embodiments disclosed herein, may be found in U.S. patent application Ser. No. 13/652,458, filed Oct. 15, 2012, titled “MOBILE DEVICE SYSTEM, METHOD, AND COMPUTER PROGRAM PRODUCT,” which is incorporated herein by reference in its entirety.

In another embodiment, the location of the user may be determined utilizing social network status associated with the user. Optionally, such social network status may be set by another person (e.g. friend, etc. of the user, etc.). This may be accomplished by “tagging” the user in association with a particular location (e.g. by naming the location or tagging the user in association with a location associated with the friend, etc.).

In another embodiment, the location of the user may be determined based on an action of the user. For example, in one embodiment, the user may utilize the mobile device to scan a bar code of an item (e.g. a product, a poster, a billboard, etc.), such that the location of the user may be determined. In another embodiment, the user may utilize the mobile device to capture an image of an item (e.g. a building, a sign, a product, a poster, a billboard, etc.), such that the location of the user may be determined.

In another embodiment, the location of the user may be determined and/or the aforementioned/following determination techniques may be confirmed by an interaction of the user with the display. As an option, such interaction may include detecting a touch or gesture (or other input) by the user of a touchscreen associated with the display (47-408-47-416) and/or a separate control display/controller associated with the display (47-408-47-416).

In another embodiment, the user may utilize the mobile device to facilitate a purchase at a location (e.g. utilizing an e-wallet application, utilizing a digital credit card, utilizing a digital debit card etc.), such that the location of the user may be determined. In another embodiment, the user may utilize a payment technique attributable to the user to facilitate a purchase at a location (e.g. utilizing gift card, utilizing a credit card, utilizing a debit card etc.), such that the location of the user may be determined. In another embodiment, the user may scan a loyalty card at a location, such that the location of the user may be determined. Of course, any technique may be utilized to determine a location associated with the user.

Once the location of the user is determined, in one embodiment, it may or may not be determined whether the user is in the vicinity of a display capable of displaying targeted advertisements/content. In one embodiment, the location specific display (or a system associated therewith) may determine the user is in the vicinity (e.g. utilizing one of the various location determination techniques described, etc.). In another embodiment, the location of the location specific displays may be known. For example, in one embodiment, the location specific displays may be registered and the location may be logged (e.g. utilizing the database 47-402, the server 47-404, another database or server, etc.).

If the location of the location specific display is known, and the location of the user is known (at least to within a threshold distance, etc.), targeted advertisements/content may be displayed to the user on the location specific displays 47-408-47-410 and/or on the client devices 47-412-47-416, based on the location of the user. As an example, the user may utilize the client device 47-412 (e.g. a point-of-sale terminal, etc.) to initiate a purchase of products. Accordingly, the location of the user and the client device 47-412 are determined and targeted advertisements/content may be presented to the user on a display associated with the client device 47-412.

As another example, the location of the user may be determined (e.g. utilizing one or more of the location determination techniques described above, etc.) and it may be determined that the user is in the vicinity of a known location specific display 47-408. Accordingly, targeted advertisements/content may be presented to the user on the location specific display 47-408.

As yet another example, the location specific display may determine that the user is in the vicinity (e.g. utilizing one or more of the location determination techniques described above, etc.). Accordingly, targeted advertisements/content may be presented to the user on the location specific display 47-408. In one embodiment, the targeted advertisements/content may be pushed from the service network system server 47-404 (e.g. to the location specific displays 47-408-47-410 and/or the client devices 47-412-47-416, etc.). In another embodiment, the targeted advertisements/content may be pushed from the third party system server 47-406 (e.g. to the location specific displays 47-408-47-410 and/or the client devices 47-412-47-416, etc.).

The targeted advertisements/content may be determined utilizing a variety of criteria associated with the user and/or the location. For example, in one embodiment, social network information may be utilized to determine targeted advertisements/content. In another embodiment, online retailer information may be utilized to determine targeted advertisements/content.

In another embodiment, previous purchase information may be utilized to determine targeted advertisements/content. In another embodiment, mobile wallet application information may be utilized determine targeted advertisements/content. In another embodiment, loyalty information may be utilized determine targeted advertisements/content. In another embodiment, personal information may be utilized determine targeted advertisements/content.

More information regarding targeted advertisements/content and the information utilized to determine such advertisements/content may be found in U.S. Provisional Patent Application No. 61/563,741, filed Nov. 25, 2011, titled “SYSTEM, METHOD, AND COMPUTER PROGRAM PRODUCT FOR PRESENTING DECISION RELATED INFORMATION;” and U.S. Provisional Patent Application No. 61/590,764, filed Jan. 25, 2012, titled “SYSTEM, METHOD, AND COMPUTER PROGRAM PRODUCT FOR PRESENTING INFORMATION TO A USER BASED ON DETERMINED SATISFACTION-RELATED INFORMATION ASSOCIATED WITH THE USER,” which are incorporated herein by reference in their entirety.

In various embodiments, the personal information may include any type of information, such as browsing history, social network information, a gender, an age, a birth date, an astrological sign, a nationality, a religion, a political affiliation (e.g. Democrat, Republican, etc.), a height, a weight, a hair color, an eye color, an ethnicity, a living address (e.g. a home address, etc.), a work address, an occupation (e.g. student, engineer, barista, unemployed, etc.), a sexual preference, an education level (e.g. a high school education, a college education, a postgraduate degree, etc.), a birth place, a school attended (e.g. an elementary school attended, a middle school attended, a high school attended, a college attended, etc.), an area once lived (e.g. during adolescence, after high school, during adult years, etc.), a relationship status (e.g. single, married, significant other, etc.), a family status (e.g. living parents, divorced parents, estranged from parents, etc.), a number of siblings, an income level, a car status (e.g. a car model, a car make, a car year, a car price, etc.), a number of children, hobbies (e.g. reading, running, volunteering, biking, golf, climbing, etc.), exercise habits (e.g. number of hours/minutes a week, number of times a month, type of exercise preferred, etc.), a number of pets owned, a type of pets owned (e.g. dogs, cats, fish, gerbils, etc.), food preferences (e.g. vegetarian, vegan, mainly meat, Chinese cuisine, Mexican cuisine, etc.), drinking habits (e.g. daily, weekly, monthly, etc.), eating habits (e.g. eat in, dine out, snacks, meals, etc.), TV watching preferences (e.g. types of preferred shows, number of hours/minutes per day/week, etc.), movie watching preferences (e.g. types of preferred movies, number of movies per day/week/month, etc.), music preferences (e.g. preferred genre, preferred artist, etc.), sleeping preferences (e.g. the number of hours of sleep preferred, the preferred bed time/rise time, etc.), moods (e.g. generally a good mood, generally a bad mood, etc.), feelings (e.g. generally happy, generally sad, generally angry, etc.), desires (e.g. goals, wishes, etc.), and/or any other personal information.

In various embodiments, the personal information may include permanent personal information (e.g. physical traits, history, etc.), temporal personal information (e.g. what the user is doing/feeling/experiencing now or within a predetermined window of time, etc.), and/or future goal-oriented personal information (e.g. wants, desires, etc.).

Further, in one embodiment, the personal information may be received in association with a social networking site that allows users to define themselves in a profile (e.g. which may include any one or more of the personal information parameters disclosed hereinabove and/or herein below, etc.); associate themselves with others (e.g. friends, colleagues, other groups, etc.) by connecting to each other; and/or engage in activities (e.g. using applications such as games, reviewing content, sharing content (e.g. interests, thoughts, questions, media, etc.), etc. In such embodiment, the personal information may be received from a social networking profile of the user associated with a social networking site. Further, the personal information may include any entities (e.g. people, groups, institutions, products, etc.) to which the user is associated (e.g. connected, subscribed, linked) during use of the social networking site. Such associations may also be extended to “associations-of-associations” (e.g. friends of friends, etc.). Even still, tracking such associations as personal information may be extended to a threshold number (e.g. 1, 2, 3, 4, 5, etc.) of degrees-of-separation. As a further option, the personal information may be received based on any of the aforementioned activity of the user in connection with the social networking site. In such example, any profiling metadata collected based on the activity of the user may be utilized as the personal information.

One optional embodiment is contemplated wherein an on-line application associated with the social networking site may collect and/or use the aforementioned social networking site-related personal information in connection with any of the functionality disclosed hereinabove and/or herein below. Of course, such social networking site-related on-line application may do so by itself and/or in connection with other one or more social networking site-related on-line application(s) or separate/independent site-related on-line application(s).

Still yet, in one embodiment, the database 47-402 may include loyalty card information. In various embodiments, such loyalty card information may include types of products purchased, frequency that products are purchased, brands of products purchased, number of days/hours shopping per week/month, amount of money spent (e.g. average amount per outing, average amount per month, average amount per week, least amount per outing, etc.), discount amount (e.g. average amount per outing, average amount per month, average amount per week, least amount per outing, etc.), awards points, and/or various other information.

Furthermore, in one embodiment, the database 47-402 may store location based information. For example, in various embodiments, the database 402 may store information associated with product offerings associated with a location, store options associated with a location, service options associated with a location, advertisements associated with a location, maps associated with the location, and/or various other information.

Further, in one embodiment, the database 47-402 may store business related information. For example, in various embodiments, the business related information may include business location information, business operation information, business hours, business specials, business offerings, business deals, and/or various other business related information. Additionally, in one embodiment, the database 47-402 may include targeted content/advertisement information (e.g. advertisement IDs, advertisements, advertisement trigger IDs, etc.).

In various embodiments, any information stored in the database 47-402 (or any other accessible database, etc.) may be utilized to determine advertisements/content to present to a user. Of course, in one embodiment, the information stored in the database 47-402 (or any other accessible database, etc.) may be associated with individual users and/or groups of users.

As one exemplary implementation associated with one embodiment, a user may be shopping in a market. Utilizing one or more location determination techniques discussed above, the location of the user may be determined and a display that is capable of being viewed by the user may be determined. In one embodiment, information associated with the user may be utilized to determine an advertisement/content to be presented to the user on the display. In one embodiment, the server 47-404 may determine the advertisement/content to display, based on the information. In another embodiment, the server 47-406 may determine the advertisement/content to display, based on the information. In another embodiment, at least one of the client devices 47-412-47-416 may determine the advertisement/content to display.

Further, in various embodiments, the server 47-404 and/or the server 47-406 may send the targeted advertisements/content and/or advertisement/content trigger IDs. In the case that the server 47-404 and/or the server 47-406 sends advertisement/content trigger IDs, the receiving apparatus or system (e.g. the client devices 47-412-47-416, the server 47-406, the location specific displays 47-408-47-410, etc.) may utilize the advertisement/content trigger IDs to select and display the advertisement/content. In one embodiment, each advertisement/content or group of advertisements/content may be associated with at least one advertisement/content trigger ID, such that the advertisement/content trigger ID may be utilized to look up associated advertisement/content. In various embodiments, the advertisement/content trigger IDs may include numerical IDs, alpha-numeric IDs, key word IDs, and/or various other IDs. In one embodiment, the third party system may include its own advertisement/content database, where advertisements/content may be accessed.

As another exemplary implementation, a user may be shopping and initiate a checkout/payment utilizing a point-of-sale terminal (e.g. one or more of the client devices 47-412-47-416, etc.). In various embodiments, the user may initiate payment utilizing a mobile phone (e.g. in association with an e-wallet application, a credit card application, etc.), a credit card, a loyalty card, a loyalty card and cash, a check, and/or various other techniques. Utilizing loyalty card information, mobile device information, payment information, and/or various other information, the user identification may be determined (and/or information associated with the user, which is capable of being utilized to determined targeted advertisements/content may be determined, etc.). Because the user is checking out at a known location, advertisements/content may be selected for the user (based on known or determined information about the user, etc.) and one or more advertisements/content may be displayed on a display associated with the point-of-sale terminal (and/or a display in proximity to the point-of-sale terminal, on a mobile device of the user, etc.).

The content/advertisements may include any type of content and/or advertisements. For example, in various embodiments, the content/advertisements may include product/service suggestions based on user purchase history, product/service suggestions based on items omitted during checkout, product/service suggestions based on items purchased, product/service suggestions based on location, product/service suggestions based on amount of money spent on particular products/services (e.g. per week, per month, per shopping experience, etc.), product/service suggestions based on a demographic category associated with the user, product/service suggestions based on user personal information, and/or any other type of content/advertisement.

Furthermore, the advertisement/content presentation may be triggered in a variety of ways. For example, in one embodiment, the advertisement/content presentation may be triggered upon initiation of check-out (e.g. upon scanning a loyalty card, upon scanning a first item, etc.). In another embodiment, the advertisement/content presentation may be triggered upon initiation of payment. In another embodiment, the advertisement/content presentation may be triggered upon approval of payment. In another embodiment, the advertisement/content presentation may be triggered upon a determination of a location of the user.

In another embodiment, the advertisement/content presentation may be triggered utilizing a signal associated with the mobile device (e.g. an NFC signal, a Bluetooth signal, a Wi-Fi direct signal, etc.). In another embodiment, the advertisement/content presentation may be triggered based on a facial recognition program identifying the user. In another embodiment, the advertisement/content presentation may be triggered upon a user check-in (e.g. a manual check-in, an automatic check-in, etc.).

In another embodiment, the advertisement/content presentation may be triggered when a user scans an item utilizing the mobile device. For example, in one embodiment, the user may scan a barcode of an item utilizing the mobile device and an advertisement/content may be presented to the user on a display of the mobile device and/or on another display (e.g. a display determined to be in the vicinity of the user, etc.). In another embodiment, the user may capture an image of an item and an advertisement/content may be presented to the user on a display of the mobile device and/or on another display (e.g. a display determined to be in the vicinity of the user, etc.).

In another embodiment, the advertisement/content presentation may be triggered in response to a user request. For example, in one embodiment, a user may utilize an associated mobile device to view available advertisements/content and/or to request targeted advertisements/content. In this case, in various embodiments, the advertisements/content may be displayed on a display associated with the mobile device and/or another display.

In one embodiment, the advertisement/content may be displayed in a non-intrusive manner on the mobile device display. For example, in one embodiment, the advertisement/content may be displayed on a lock screen of the mobile device. In another embodiment, the advertisement/content may be displayed utilizing a specific advertisement/content display application.

More information about non-intrusively displaying advertisements on a mobile device may be found in U.S. Provisional Patent Application No. 61/711,727, filed Oct. 9, 2012, titled “SYSTEM, METHOD, AND COMPUTER PROGRAM PRODUCT FOR DETERMINING WHETHER TO PROMPT AN ACTION BY A PLATFORM IN CONNECTION WITH A MOBILE DEVICE,” which is incorporated herein by reference in its entirety.

Further, in one embodiment, an advertisement/content may be displayed on a display separate from a mobile device and the user may have the option to transfer display of the advertisement/content to the mobile device, or to receive the advertisement/content on the mobile device. For example, in one embodiment, an application on the mobile device may present the user an option to display an advertisement/content on the mobile device, which is currently being displayed on a third party display. In another embodiment, bump technology may be utilized to transfer an advertisement/content to the mobile device. For example, in one embodiment, advertisement/content may be displayed on a third party display and a user may touch the display (or an interface associated with the display, etc.) such that the advertisement/content is transferred to the mobile device for display. Of course, in various embodiments, various techniques may be utilized to transfer the advertisement/content to the mobile device.

It should be noted that, although the apparatuses/systems/devices illustrated in FIG. 47-4 are described in the context of individual devices, in other embodiments, such apparatuses/systems/devices may be combined or implemented across multiple devices. For example, in one embodiment, the database 47-402 may include a plurality of databases (e.g. controlled by different entities, etc.). In another embodiment, the server 47-404 may represent a plurality of servers (e.g. controlled by different entities, etc.). Furthermore, in one embodiment, multiple service network systems and/or multiple third party systems may communicate with one another. For example, in one embodiment, a social network system and a mobile wallet system may be in communication and both systems may be capable of communicating with one or more retailers and/or one or more service providers, etc.

To this end, in some embodiments, advertisements (and/or other content) may be displayed to a user in an intelligent manner; without having to necessarily utilize precious interface “real-estate” (i.e. area, etc.) of the mobile device and/or of one particular application (e.g. associated with the service network, etc.,) on a mobile device; and/or when the mobile device and/or application is not even being utilized (e.g. viewed, etc.) during a relevant time for the advertisement/content to be displayed, etc. Further, as an option, this may be accomplished by going beyond allowing third parties to associate advertisements with certain profile criteria, for triggering the display of such advertisements in connection with service network content on a service network interface (via a service network application, etc.). Specifically, advertisements/triggers may be associated with certain profile criteria (which may or may not be the same used above), so that, instead of the aforementioned display of the advertisements in connection with service network content, triggers and/or the advertisements are ultimately pushed to a separate display (e.g. 47-408-47-416, etc.) or a separate context (e.g. different application, etc.) on the same display/device, for presentation.

Further, the various features disclosed herein may, in some optional embodiments, be accomplished by both the service network and advertiser tracking, storing, sharing, etc. at least one aspect of the user for uniquely or non-uniquely identifying the same, which may be done in an anonymous or non-anonymous manner. In various embodiments, such user identifying aspect may take the form of data that includes and/or is based, at least in part, on service network and/or advertiser username and/or password, a name, an alias, a user ID, a user email address, a user residence or business physical address, a user phone (e.g. cell) number, an application identifier, a user context identifier, a cookie, a session identifier, a purchase receipt reflecting a purchase by the user, a credit card/bank account number and/or alias, a randomly generated identifier, a comment/posting, text/e-mail content, a facial recognition result, a fingerprint scan result, an Internet search query, a photo taken by and/or including the user, a scan of a code (Quick Response Code), an automatically (GPS, WiFi, etc.) generated location, a manual or automatically generated check-in status (e.g. with precise time-stamped location), a bump technology transaction/signal, any unique or semi-unique identifier, etc.). In one embodiment, the user identifying aspect(s) may include any of the location triggers set forth in the context of the description of operation 47-1102 of FIG. 47-11, to be set forth hereinafter in greater detail. In various embodiments, the above user identifying aspect(s) may be sourced from the service network (and/or related application), the advertiser, an operating system of the mobile device and/or any other source.

In use, in accordance with one possible embodiment, the aforementioned user identifying aspect may be submitted with, linked to, and/or otherwise associated with a profile-related query that is defined by the advertiser. To this end, the profile criteria associated with various preconfigured advertisements of the advertiser may be compared against the appropriate profile (and content) of the correct/relevant user in the service network database (that is identified by the identifying aspect), to be the subject of presentation of the advertisement.

In various embodiments, the aforementioned user identifying aspect may be encrypted for ensuring anonymity of the user. More information regarding various possible features and/or utilization of the aforementioned user identifying aspect may be found in U.S. Provisional Patent Application No. 61/563,741, filed Nov. 25, 2011, titled “SYSTEM, METHOD, AND COMPUTER PROGRAM PRODUCT FOR PRESENTING DECISION RELATED INFORMATION;” and U.S. Provisional Patent Application No. 61/590,764, filed Jan. 25, 2012, titled “SYSTEM, METHOD, AND COMPUTER PROGRAM PRODUCT FOR PRESENTING INFORMATION TO A USER BASED ON DETERMINED SATISFACTION-RELATED INFORMATION ASSOCIATED WITH THE USER,” which are incorporated herein by reference in their entirety.

Of course, embodiments are contemplated where the advertisements may also be triggered for display in a manner that utilizes the service network interface(s) and is integrated with service network content (e.g. “on-platform”) vs. the aforementioned “off-platform” advertising. In such other embodiments, the on- and off-platform advertising may be coordinated for increased effectiveness. For example, after the display of an off-platform advertisement and in response to user input received in connection with such off-platform advertisement, an additional escalation of advertising may be accomplished by displaying a related/follow-up/supplemental on-platform advertisement. Of course, pricing of the related/follow-up/supplemental on-platform advertisement may be varied (e.g. increased, etc.) to reflect the effectiveness of such sequential targeted advertisements across multiple platforms. Still yet, off-platform advertisements may be bid upon, since there often is a single advertisement impression opportunity in connection with the user as he/she passes from location/context to location/context.

Even still, the service network may also establish policies to regulate the issues that may arise when providing on- and off-platform advertisements. Just by way of example, the service network may preclude the triggering of both an on- and off-platform advertisement to the same person at the same time.

In still other embodiments, the off-service network platform advertisements may be displayed in connection with an application that is initiated, accessible, etc. via an application associated with the service network. As an option, any enabling off-platform advertisement techniques (e.g. sharing of user information) and/or the display of off-platform advertisements themselves may be conditioned on the user authorizing the same. For that matter, any technique disclosed herein may be subject to such user authorization.

FIG. 47-5 shows a system 47-500 for presenting advertisements/content, in accordance with another embodiment. As an option, the system 47-500 may be implemented in the context of the architecture and environment of the previous Figures and/or any subsequent Figure(s). Of course, however, the system 47-500 may be implemented in the context of any desired environment. It should also be noted that the aforementioned definitions may apply during the present description.

As shown, a social network system may be in communication with one or more third party systems. In one embodiment, the social network system may include service functionality 47-502 that is in communication with one or more databases 504. It should be strongly noted that, while a social network system is provided in the present embodiment, any service network system may be substituted therewith.

The social networking service functionality may include any online service, platform, or site the helps facilitate the building of social networks or social relations among people, groups, and/or businesses, etc., who, for example, share interests, activities, backgrounds, or real-life connections. In various embodiments, the social network service may include a representation of each user (e.g. a profile, etc.), social link information, and a variety of additional services. In one embodiment, the social network service may be web-based and may allow for users to interact over the Internet, such as e-mail and instant messaging.

In one embodiment, the social network service functionality may allow a profile to be generated from a user answering to questions, such as age, location, interests, etc. In one embodiment, the social networking service functionality may allow the upload of pictures, multimedia content, and/or modification of the look and feel of the profile. Further, in one embodiment, the social network service functionality may allow users to enhance their profile by adding modules or applications.

In one embodiment, the social network service functionality may allow users to post blog entries, search for others with similar interests, and compile and share lists of contacts. Additionally, in one embodiment, the user profiles may have a section dedicated to comments from friends and other users. Further, in one embodiment, to protect user privacy, the social network service functionality may offer controls that allow users to choose who can view their profile, contact them, add them to their list of contacts, etc.

In another embodiment, the social network service functionality may allow the user to create groups that share common interests or affiliations, upload or stream live videos, and/or hold discussions in forums. Further, in one embodiment, the social network service may implement geo-social networking that co-opts Internet mapping services to organize user participation around geographic features and their attributes.

In one embodiment, the social networking service may include a time and/or a location based social network. More information regarding location based applications may be found in U.S. Provisional Patent Application No. 61/511,750, filed Jul. 26, 2011, titled “SYSTEM, METHOD, AND COMPUTER PROGRAM PRODUCT FOR MANAGING A SOCIAL NETWORK BASED ON AT LEAST A TIME OR A LOCATION,” and U.S. patent application Ser. No. 13/557,198, filed Jul. 24, 2012, titled “SYSTEM, METHOD, AND COMPUTER PROGRAM PRODUCT FOR MANAGING A SOCIAL NETWORK BASED ON AT LEAST A TIME OR A LOCATION,” which are incorporated herein by reference in their entirety.

In one embodiment, the social network system (or, again, any service network) may utilize information known about users of the social network to generate advertisement/content suggestions and/or trigger IDs. In another embodiment, another system may utilize information known about users of the social network to generate advertisement/content suggestions and/or trigger IDs (e.g. the social network system may share the information, etc.). For example, social network information about a first user of the social network system may be utilized to determine one of more advertisements/content to display to the first user. In one embodiment, information in addition to the social network information may be utilized (e.g. user information provided by a retailer, etc.).

In another embodiment, the social network system may associate users with advertisement/content trigger IDs. For example, based on user information associated with the social network, the user may be associated with one or more third party advertisement/content trigger IDs 47-506. In one embodiment, users with similar information may be associated with one or more of the same trigger IDs.

In one embodiment, the trigger IDs may be sent to one or my third party systems 47-508 in real-time. Further, in one embodiment, the third party system may utilize the trigger IDs (and/or information associated therewith, etc.) to select one or more advertisements/content to be presented to one or more users associated with the trigger IDs. To accomplish this, a data structure may be utilized to link the trigger IDs and the associated with specific advertisements/content (e.g. advertisement content, etc.) such that the latter may be looked up utilizing the former.

For example, in one embodiment, the first user of the social networking site may log onto an online retailer. In this case, in one embodiment, the social network system may send advertisement/content trigger IDs associated with the first user to the online retailer (or an advertiser, etc. associated with the online retailer, etc.), such that the online retailer (or an advertiser, etc. associated with the online retailer, etc.) may select one or more advertisements/content to display to the first user (e.g. on a portion of a web page associated with the online retailer, etc.).

While, in the foregoing embodiment, the advertisements/content may be displayed to the first user via a web page, it should be noted that the trigger IDs may be used to display the advertisement/content in connection with any application, display, device, etc. separate from the service network interface. Further, in any embodiment disclosed herein, the advertisement(s) itself may be sent in lieu of (or in addition to) the trigger ID(s).

In one embodiment, the third party may have one or more advertisements/content associated with the trigger IDs. In this way, in one embodiment, the third party may identify an advertisement opportunity (e.g. by ascertaining one of the aforementioned user identifying aspects which correlates to a user, etc.), query the social network system for a trigger ID (e.g. that is determined by the service network by matching profile criteria known about the user (as identified by the user identifying aspect) with profile criteria associated with one of the trigger IDs/associated advertisements), receive the trigger ID, and display one or more advertisements associated with the trigger ID.

As mentioned above, in one embodiment, the third party may query the social network system with user information (e.g. a username, a name, an alias, a user ID, a user email address, an application/location identifier, unique user context identifier, cookie, and/or any of the aforementioned user identifying aspects, etc.). Specifically, the service network may track any identifying aspect of the user (e.g. anonymously or otherwise, etc.) so that such identifying aspect can be included with a profile-related query (e.g. to determine an appropriate advertisement/content, if any) for display in connection with the user.

In another embodiment, the social network system may send information associated with one or more social network users to the third party system, such that the third party system may select targeted advertisements to display to the user. In one embodiment, the user of the social network system may have an option to allow sharing of information between the third party system and the social network system. Further, in one embodiment, the user may be incentivized to allow sharing between the third party system and the social network system. In various embodiments, the user may be incentivized by receiving discounts, receiving credits (e.g. store credit, etc.), receiving free items, receiving money, and/or utilizing various other incentives.

More information regarding sharing information between a social networking system and a third party system, etc. may be found in U.S. Provisional Patent Application No. 61/591,819, filed Jan. 27, 2012, titled “SYSTEM, METHOD, AND COMPUTER PROGRAM PRODUCT FOR ALTERING AT LEAST ONE ASPECT OF AN INTEGRATED E-COMMERCE ON-LINE APPLICATION;” and U.S. Provisional Patent Application No. 61/596,174, filed Feb. 7, 2012, titled “SYSTEM, METHOD, AND COMPUTER PROGRAM PRODUCT FOR ALTERING AT LEAST ONE ASPECT OF AN INTEGRATED E-COMMERCE ON-LINE APPLICATION.”

Further, in one embodiment, the third party system may select advertisements to be displayed on a website associated with the social network system. For example, in one embodiment, information associated with the third party may be shared with the social network system, such that advertisements are presented to the user while the user is utilizing a social networking site. Additionally, in one embodiment, the advertisements/content selected may be presented on a third party display (e.g. at a business, on a billboard, etc.).

Still yet, in one embodiment, the social networking system may provide information (e.g. user information, trigger IDs, etc.) to company advertisers and/or other related-third party advertisers to trigger advertisements. More information about providing dynamic advertisements may be found in U.S. Provisional Patent Application No. 61/590,764, filed Jan. 25, 2012, titled “SYSTEM, METHOD, AND COMPUTER PROGRAM PRODUCT FOR PRESENTING INFORMATION TO A USER BASED ON DETERMINED SATISFACTION-RELATED INFORMATION ASSOCIATED WITH THE USER,” which is incorporated herein by reference in its entirety.

In one embodiment, administrators associated with the third party systems may be capable of configuring and/or registering advertisement/content triggers and/or associated content/trigger IDs. In one embodiment, the social network system may provide a GUI for configuring such triggers and/or advertisements. In another embodiment, an advertisement system may provide a GUI for configuring such triggers. In yet another embodiment, the third party system owner may have control over a GUI for configuring advertisement/content triggers.

FIG. 47-6 shows exemplary interfaces 47-600 for configuring and/or registering advertisement/content triggers, in accordance with another embodiment. As an option, the interfaces 47-600 may be implemented in the context of the architecture and environment of the previous Figures and/or any subsequent Figure(s). Of course, however, the interfaces 47-600 may be implemented in the context of any desired environment. It should also be noted that the aforementioned definitions may apply during the present description.

As shown, an advertiser may utilize one or more of the interfaces 47-600 to configure various aspects associated with triggering and/or displaying targeted advertisements/content. In the context of the present description, an advertiser refers to any entity aspiring to present a product, service, and/or incentive to one or more other entities (e.g. people, businesses, etc.).

As shown in interface 1, the advertiser may have the ability to associate a trigger ID with one or more advertisement/context profiles. In one embodiment, the one or more advertisement/context profiles may be associated with one or more advertisements/content that has been designed to target (or is logically attributable) to a particular demographic or desired audience (e.g. males in their 30s, female homemakers, children, parents, dog owners, etc.). Accordingly, in one embodiment, a trigger ID may be associated with profile criteria that is, in turn, associated with one or more of the advertisements targeted towards a specific demographic. In this way, in one embodiment, social network systems (and/or other service systems) may utilize user information to associate trigger IDs with users, such that when a specific user is available for a third party advertisement opportunity, the associated trigger ID may be sent to the third party service, and an appropriate advertisement/content profile may be selected and presented, based on the trigger ID.

Further, in one embodiment, a location and/or context in which the advertisement is to be presented may be specified. For example, in various embodiments, an advertiser may have the ability to specify that the advertisements/content associated with the advertisement/content profile are presented at a physical display (e.g. a specific physical display, a display determined to be in proximity to the user, etc.), online (e.g. on a portion of a web page being viewed by the user, on a portion of a web page associated with the third party, on a portion of a web page associated with a social networking site, etc.), on a mobile device associated with the user (e.g. via a specific screen, via a specific application, etc.), any of the device(s) disclosed in the description of FIG. 47-4, and/or based on a location of the user.

In the case that the advertiser desires to present the advertisement/content based on a location of the user, in one embodiment, the advertisement/content may be presented on available displays, which are determined to be in the proximity of the user (e.g. a store display, a point-of-sale terminal, etc.). In one embodiment, if the advertiser desires to present the advertisement/content based on a location of the user, in one embodiment, the display in which to present the advertisement will be selected upon determination that the specific user is a specific location (e.g. and/or upon another triggering event, etc.).

As shown in interfaces 2 and 3, in one embodiment, the advertiser may be presented with specific location context options for advertisement/content presentation. For example, in various embodiments, the advertiser may specify that the advertisement be presented at an NFC terminal, online, a mobile device associated with the user, a specific location display, a general area location display, a point-of-sale terminal, a specific website, a general website, and/or various other displays. Furthermore, in one embodiment, the location presentation options may be configurable such that they are different for each trigger ID.

Specifically, in one embodiment in connection with interfaces 2 and 3, a specific display may be specifically identified (e.g. utilizing an IP, GPS, or other destination address, etc.) and even given an alias (e.g. “Discount Store Sports Department Display #1,” etc.) such that a plurality of triggering profile criteria sets (each with a plurality of correlating trigger IDs) may be defined and associated with such specific display. Further, in the event that multiple displays are being enabled, the same or different triggering profile criteria sets/trigger IDs may be easily replicated (and possibly modified) for each of the different displays. To this end, the system may be configured such that, in connection with each display, a user identifying aspect may be sent to the service network (in connection with the specific display), such that the user profile criteria and advertisement target profile criteria can be used to cause display of the most relevant advertisement/content to the user via the specific display where he/she has been identified. Yet again, while physical displays are exemplified in the current embodiment, it should be noted that the display may be the same display with which the service network is accessed, but possibly in a different context (e.g. during use of a separate application, during downtime, etc.).

FIG. 47-7 shows a system flow 47-700 for presenting advertisements, in accordance with another embodiment. As an option, the system flow 47-700 may be implemented in the context of the architecture and environment of the previous Figures and/or any subsequent Figure(s). Of course, however, the system flow 47-700 may be implemented in the context of any desired environment. It should also be noted that the aforementioned definitions may apply during the present description.

As shown, a service network system may associate user profile information, user location information, and/or contextual information with one or more advertisement/content trigger IDs. For example, in one embodiment, the service network system may utilize relevant information associated with a user to characterize the user such that advertisements/content may be targeted towards that user, based on the characterization. In this way, the service network system may utilize a vast amount of information the system has compiled about the user to more accurately characterize and/or categorize the user, for the purposes of more appropriately targeting advertisements/content. In one embodiment, the relevant profile information may be utilized to associate a trigger ID with the user. In one embodiment, the trigger ID may be associated with one or more advertisements/content that are considered to be relevant to the user.

Further, in one embodiment, user location information may be included and/or linked to the trigger ID. In one embodiment, the user location information may include current user location information. For example, in various embodiments, the current user location may be determined based on a user check-in, a mobile phone signal, a user communication (e.g. a user post, etc.), GPS coordinates, a network signal, a Bluetooth signal, and/or by utilizing various other techniques.

In another embodiment, the location information may include a residence location associated with the user. In another embodiment, the location information may include a business location associated with the user. In another embodiment, the location information may include a shopping location associated with the user. In another embodiment, the location information may include a virtual location associated with the user (e.g. a website, etc.).

Further, in one embodiment, the trigger ID may be associated with a context. In various embodiments, the context may include situations in which the advertisement/content is to be displayed, a time period in which the advertisement/content is to be displayed (or an expiration time, etc.), an event that is to occur before advertisement/content is to be displayed, and/or any other context in which the advertisement is to be displayed.

In one embodiment, the advertiser (and/or the service network, etc.) may have the ability to configure rules associated with the context. In one embodiment, the advertiser (and/or the service network, etc.) may have the ability to configure rules associated with the context utilizing one or more interfaces (e.g. the interfaces of FIG. 47-6, etc.). In various embodiments, the configurable rules may include configuring a number of times an advertisement/content is displayed to a particular user, a number of times an advertisement/content is displayed to all users, a time of day the advertisement/content is capable of being displayed, a location in which the advertisement/content is permitted to be displayed (e.g. a geographic location, a specific display location, a business location, etc.), a demographic that is capable of viewing the content/advertisement, criteria that must be true for the advertisement/content to be presented, events that must occur before the advertisement/content is presented (e.g. the user must purchase a specific item, the user must check-out at a store, etc.), and/or any other rule that may be utilized to establish a context.

Furthermore, in one embodiment, the triggers IDs, which are associated with the information, may be associated with one or more advertisements. In one embodiment, the service network system may associate the trigger ID with the advertisement(s). In another embodiment, the third party system may associate the trigger ID with the advertisement(s). For example, knowing what demographic, users, groups, and/or types of users in which the trigger IDs are associated, the advertisements/content that should be directed to those users (e.g. based on market research, etc.) may be selected and associated with the trigger IDs.

Accordingly, in one embodiment, when an apparatus associated with the third party determines that a user is present (e.g. at a point-of-sale terminal at check-out, etc.), information associated with the user may be sent from the third party (e.g. a name, an ID, a captured image, a username, etc.) such the service network may identify an associated trigger ID (or associate the user with a trigger ID, etc.). In one embodiment, the identified (or determined) trigger ID associated with the user may be communicated to the third party system (along with any other information, such as context, etc.). In response, in one embodiment, the third party system may utilize the trigger ID (as well as any other information accompanying the trigger ID, such as context, etc.) to select one or more advertisements to display to the user.

In another embodiment, the service network system may identify the location of the user (e.g. based on GPS coordinates, based on a user check-in, based on a check-out, etc.) and send a trigger ID to the third party system such that the advertisement/content may be selected and displayed. In still another embodiment, the service network may send advertisements/content to the third party system. For example, in one embodiment, the user may be identified and one or more advertisements may be selected by the service network system and sent to the third party system. In this case, in one embodiment, the third party system may display the advertisement received from the service network system. In one embodiment, the service network system may access an advertisement database to select an advertisement to send to the third party system.

FIG. 47-8 shows a method 47-800 for communicating advertisement/content trigger IDs, in accordance with one embodiment. As an option, the method 47-800 may be implemented in the context of the architecture and environment of the previous Figures and/or any subsequent Figure(s). Of course, however, the method 47-800 may be carried out in any desired environment. It should also be noted that the aforementioned definitions may apply during the present description.

As shown, trigger IDs are registered with a service network. See operation 47-802. In one embodiment, a context, user location information, and advertisement profiles may also be registered with the service network and may be associated with a trigger ID. Of course, any of the trigger IDs and associated advertisement profile criteria and/or user profile criteria (as disclosed herein) may be registered in operation 47-802.

Further, it is determined whether a trigger event has occurred. See decision 47-804. In one embodiment, the service network may determine whether the trigger event has occurred. In another embodiment, a third party system may determine whether the trigger event has occurred. In one embodiment, the third party system may determine that the trigger event has occurred and may notify the service network system (e.g. by requesting an advertisement, by requesting a trigger ID, by sending user information, etc.).

The trigger event may include any type of trigger event. For example, in one embodiment, the trigger event may include a device recognizing the face of the user. In another embodiment, the trigger event may include the user scanning a loyalty card. In another embodiment, the trigger event may include the user swiping a credit card. In another embodiment, the trigger event may include the user initiating a mobile wallet payment. In another embodiment, the trigger event may include the user scanning an item.

In another embodiment, the trigger event may include the user checking in to a location. In another embodiment, the trigger event may include the user checking out at a store. In another embodiment, the trigger event may include the user requesting an advertisement/content. In another embodiment, the trigger event may include the user visiting a website (e.g. a particular website, etc.).

In another embodiment, the trigger event may include the user selecting an item on a web page. In another embodiment, the trigger event may include the user purchasing a particular item (or any item, etc.). In another embodiment, the trigger event may include the user performing a designated action on a point-of-sale terminal (e.g. selecting a particular button, etc.). In another embodiment, the trigger event may include the user performing a specific action on a mobile device (e.g. accessing a particular application, utilizing mobile payment functionality, etc.).

In another embodiment, the trigger event may include receiving a signal from a mobile device of the user. In another embodiment, the trigger event may include a determination that the user is in or near a particular location. In another embodiment, the trigger event may include the user accessing a particular network (e.g. a particular wireless network, etc.). In another embodiment, the trigger event may include receiving a text including keywords. In another embodiment, the trigger event may include receiving an e-mail including keywords.

In another embodiment, the trigger event may include receiving a voicemail including keywords. In another embodiment, the trigger event may include a calendar event. In another embodiment, the trigger event may include a media event. In still other embodiments, the trigger event may occur as a function of the identification of any of the user identifying aspect(s) disclosed hereinabove. Of course, in various embodiments, the trigger event may include any type of event.

If it is determined that a trigger event has occurred, the advertisement/content trigger ID is sent to the third party system. See operation 47-806. In one embodiment, the advertisement may be sent to the third party system in response to the trigger event.

As noted, in one embodiment, the trigger event may include a user implementing a transaction utilizing a mobile device.

FIG. 47-9 shows a system 47-900 for mobile device transactions, in accordance with another embodiment. As an option, the system 47-900 may be implemented in the context of the architecture and environment of the previous Figures and/or any subsequent Figure(s). Of course, however, the system 47-900 may be implemented in the context of any desired environment. It should also be noted that the aforementioned definitions may apply during the present description.

As shown, an e-wallet server 47-902 may be in communication with one or more mobile devices 47-910 and one or more point-of-sale systems 47-908 over one or more networks 47-906. Furthermore, in one embodiment, one or more store backend servers 47-904 may be in communications with the e-wallet server 47-902, the mobile device 47-910, and/or the point-of-sale terminal 47-908.

In operation, a user of the mobile device 47-910 may initiate a transaction utilizing the mobile device 47-910 and the point-of-sale terminal 47-908. In one embodiment, an NFC connection between the mobile device 47-910 and the point-of-sale terminal 47-908 may be utilized to facilitate the transaction. In another embodiment, a Wi-Fi direct connection between the mobile device 47-910 and the point-of-sale terminal 47-908 may be utilized to facilitate the transaction.

In another embodiment, an IR connection between the mobile device 47-910 and the point-of-sale terminal 47-908 may be utilized to facilitate the transaction. In another embodiment, a Bluetooth connection between the mobile device 47-910 and the point-of-sale terminal 47-908 may be utilized to facilitate the transaction. In another embodiment, bump technology implemented between the mobile device 47-910 and the point-of-sale terminal 47-908 may be utilized to facilitate the transaction.

In another embodiment, the transaction between the mobile device 47-910 and the point-of-sale terminal 47-908 may be facilitated over the network 47-906 (or another network, the Internet, etc.). In another embodiment, information displayed on the mobile device 47-910 may be scanned by the point-of-sale terminal 47-908 to facilitate the transaction. Of course, in various embodiments, any suitable technology may be utilized to facilitate the transaction.

In operation, in one embodiment, the user may utilize an e-wallet application 47-912, which is stored on the mobile device 47-910 to facilitate payment of goods and/or services. In one embodiment, the e-wallet application 47-912 may enable communication between the mobile device 47-910 and the e-wallet server 47-902. In one embodiment, the e-wallet server 47-902 may include service functionality for enabling a transaction to occur between the user of the mobile device 47-910 and a store associated with the point-of-sale terminal and/or the store backend server 47-904.

For example, a user may proceed to checkout at a point-of-sale terminal at a grocery store. In one embodiment, the mobile device 47-910 may be utilized to communicate store loyalty card information to the point-of-sale terminal 47-908. In one embodiment, a store application 47-914, which may be stored on the mobile device 47-910, may be utilized to facilitate the transfer of the store loyalty card information. In another embodiment, the e-wallet application 47-912 may be utilized to facilitate the transfer of the store loyalty card information.

Further, in one embodiment, the user may utilize the e-wallet application 47-912 stored on the mobile device 47-910 to pay for items. In one embodiment, the e-wallet application 47-912 may include credit card information associated with the user, such that the credit card may be utilized automatically to pay for the items. In another embodiment, the e-wallet application 47-912 may include pre-paid card information associated with the user, such that the pre-paid card may be utilized automatically to pay for the items. In another embodiment, the e-wallet application 47-912 may include bank card information associated with the user, such that the bank card may be utilized automatically to pay for the items. In another embodiment, the e-wallet application 47-912 may include bank account information associated with the user, such that the bank account information may be utilized automatically to pay for the items. In one embodiment, a user may have the ability to choose a default payment method from a list of available payment methods.

In one embodiment, transaction details may be displayed on the mobile device 47-910 and/or on a display associated with the point-of-sale system 47-908. For example, in one embodiment, upon finalization of the transaction, transaction information may be displayed on the mobile device. In one embodiment, the transaction information may be displayed utilizing the e-wallet application 47-912.

In another embodiment, the transaction information may be displayed utilizing the store application 47-914. In another embodiment, the transaction information may be displayed utilizing another application stored on the mobile device 47-910. Further, in one embodiment, the transaction information may be displayed on a lock screen of the mobile device 47-910. In one embodiment, such transaction information may be displayed in a non-intrusive manner. In various embodiments, the transaction information may include a cost (e.g. a total cost, a cost per item, a cost of sales tax, an itemized price list, etc.), a list of purchased items/services, a time of purchase, product names, product codes, a method of payment, one or more of the transaction parties, and/or any other transaction related information.

Still yet, in one embodiment, the transaction may serve as trigger event for displaying advertisements on the point-of-sale terminal 47-908 and/or the mobile device, as described in the context of the previous figures and subsequent figures (such as FIG. 47-13), etc. In one embodiment, the advertisements may be displayed on the mobile device 47-910 and/or the point-of-sale terminal 47-908 in a non-intrusive manner.

More information about non-intrusively displaying advertisements on a mobile device may be found in U.S. Provisional Patent Application No. 61/711,727, filed Oct. 9, 2012, titled “SYSTEM, METHOD, AND COMPUTER PROGRAM PRODUCT FOR DETERMINING WHETHER TO PROMPT AN ACTION BY A PLATFORM IN CONNECTION WITH A MOBILE DEVICE,” which is incorporated herein by reference in its entirety.

FIG. 47-10 shows a method 47-1000 for a mobile device transaction, in accordance with another embodiment. As an option, the method 47-1000 may be implemented in the context of the architecture and environment of the previous Figures and/or any subsequent Figure(s). Of course, however, the method 47-1000 may be carried out in any desired environment. It should also be noted that the aforementioned definitions may apply during the present description.

As shown, it is determined whether an NFC trigger is received by a mobile device (or an application associated therewith). See determination 47-1002. While a NFC trigger is disclosed in the context of operation 47-1002, it should be noted that any connection mechanism (e.g. see those, for example, disclosed during the description of FIG. 47-9, etc.) may be used in lieu of NFC.

If a trigger is received in operation 47-1002, information associated with the transaction is received, a payment method is selected (e.g. a card is selected, etc.), and a loyalty card is identified. See operation 47-1004.

In one embodiment, the information received may include transaction information. In various embodiments, the transaction information may include a price, credit card information, loyalty information, product information, store information, time information, location information, discount information, method of purchase information, and/or any other type of transaction-related information.

In various embodiments, the payment method may include a credit card (or a credit card number), a debit card, a prepaid card, bank account information, and/or any other payment type. In one embodiment, the payment method may be manually selected by the user at the time of completing the transaction. Further, in another embodiment, the payment method may be automatically selected (or at least suggested) based on any criteria. Such criteria may include or be based, at least in part, on a current location (e.g. based on a GPS location, etc.), a point-of-sale terminal used, on a signal received (e.g. that indicates which payment method types are acceptable), the type of payment method last used (in general, or at the current location), a balance of an account associated with the payment method (that is sufficient to cover the cost of the transaction), etc.

Still yet, in operation 47-1004, a loyalty card may be identified. For example, such loyalty card may be automatically selected. In various embodiments, the loyalty card may be selected based on a current location (e.g. based on a GPS location, etc.), based on a point-of-sale terminal used, based on a signal received, and/or utilizing various other techniques. In another embodiment, the loyalty card may be manually selected by the user of the mobile device.

Further, it is determined whether a screen of the mobile device is locked. See determination 47-1006. If it is determined that the screen is locked, the transaction details are displayed on the screen lock screen of the mobile device. See operation 47-1008. If it is determined that the screen is not locked, the transaction details are displayed on the main screen of the mobile device. See operation 47-1010.

While not necessarily illustrated, it may or may not be determined whether the mobile device is in a standby mode in determination 47-1006. If it is determined that the mobile device is in a standby mode, the mobile device may be powered up and/or taken out of the standby mode before the transaction details are displayed on the screen lock screen of the mobile device in operation 47-1008.

In the event that the transaction details are displayed on the main screen of the mobile device per operation 47-1010, an application (e.g. e-wallet, etc.) installed on the mobile device (that is capable of facilitating the transaction) may be automatically executed and opened, such that the main screen is populated (possibly entirely or substantially so) by an interface of the aforementioned application.

While not shown, in the event that a transaction is completed via the lock screen in operation 47-1008, an option may be given thereafter to execute and open a relevant interface (e.g. post-transaction interface) of the foregoing application for engaging in post-transaction functionality (e.g. examples of which will be set forth hereinafter in greater detail). Further, absent electing such option, the mobile device may either stay in lock screen mode for a predetermined period and thereafter return to the power standby mode, or immediately return to the power standby mode.

In one embodiment, one or more advertisements may be displayed on the lock screen of the mobile device (and/or the main screen, as well). Further, in one embodiment, advertisements may be displayed on the mobile device based on a location of the mobile device.

Again, it should be noted that, although the method 47-1000 refers to an NFC trigger, any communication protocol connection may be utilized as a trigger in another embodiment.

FIG. 47-11 shows a method 47-1100 for a mobile device transaction, in accordance with another embodiment. As an option, the method 47-1100 may be implemented in the context of the architecture and environment of the previous Figures and/or any subsequent Figure(s). Of course, however, the method 47-1100 may be carried out in any desired environment. It should also be noted that the aforementioned definitions may apply during the present description.

As shown, it is determined whether a location trigger is received by a mobile device. See determination 47-1102. In one embodiment, the location trigger may include any of the user identifying aspects set forth hereinabove during the description of FIG. 47-4. In other embodiments, the location trigger may include any trigger associated with location determination. Further, the location of the user and/or the mobile device may be determined utilizing a variety of techniques.

For example, in one embodiment, the user may digitally check-in to a location and the location may be determined. In various embodiments, the user may check-in to the location utilizing the mobile device associated with the user, a system associated with the location, and/or another device. In one embodiment, the user may check in to a location utilizing an application stored on the mobile device of the user. In various embodiments, the application may include a social network application, an application associated with the location, a mapping application, a geo-caching application, and/or various other applications. In another embodiment, the user may check in to a location utilizing a check-in system associated with the location.

In another embodiment, the mobile device of the user may be utilized to automatically check in to a location. For example, in one embodiment, an application stored on the mobile device may be utilized to automatically check in to a location (e.g. based on a wireless signal, based on wireless network availability, based on GPS, a bump signal, an NFC signal, a Wi-Fi signal, etc.).

Further, in one embodiment, the location of the user and/or mobile may be determined based on GPS. For example, the mobile device (and/or an application/OS associated therewith) may share GPS data associated with the mobile device, such that the location of the mobile device/user is determined. In one embodiment, the GPS data may be shared with the service network system. In another embodiment, the GPS data may be shared with one or more third party systems.

In another embodiment, the location of the user and/or the mobile device may be determined based on a signal provided by the mobile device of the user. For example, in one embodiment, the mobile device of the user may provide a Bluetooth signal that is capable of being received by a device associated with the location (e.g. a display, a computer, a location detection device, a point-of-sale device, etc.), such that location may be determined. In another embodiment, the mobile device of the user may provide a NFC signal that is capable of being received by a device associated with the location (e.g. a display, a computer, a location detection device, a point-of-sale device, etc.), such that location may be determined. In another embodiment, the mobile device of the user may provide a Wi-Fi signal that is capable of being received by a device associated with the location (e.g. a router, a display, a computer, a location detection device, a point-of-sale device, etc.), such that location may be determined. In another embodiment, the mobile device of the user may provide a chirp signal that is capable of being received by a device associated with the location, such that location may be determined. In one embodiment, the chirp signal may include information associated with the location (e.g. GPS coordinates, etc.). In one embodiment, a signal strength associated with the chirp may be used to associate the user with a location.

In another embodiment, the mobile device may be connected to a wireless network associated with the location automatically (or manually), such that a location may be determined. In still another embodiment, the location of the user may be determined utilizing facial recognition techniques. For example, in one embodiment, a system associated with the location may be utilized to determine the user is present based on facial recognition.

In another embodiment, the location of the user may be determined utilizing social network status associated with the user. In another embodiment, the location of the user may be determined based on an action of the user. For example, in one embodiment, the user may utilize the mobile device to scan a bar code of an item (e.g. a product, a poster, a billboard, etc.), such that the location of the user may be determined. In another embodiment, the user may utilize the mobile device to capture an image of an item (e.g. a building, a sign, a product, a poster, a billboard, etc.), such that the location of the user may be determined.

In another embodiment, the user may utilize the mobile device to facilitate a purchase at a location (e.g. utilizing an e-wallet application, utilizing a digital credit card, utilizing a digital debit card etc.), such that the location of the user may be determined. In another embodiment, the user may utilize a payment technique attributable to the user to facilitate a purchase at a location (e.g. utilizing gift card, utilizing a credit card, utilizing a debit card etc.), such that the location of the user may be determined. In another embodiment, the user may scan a loyalty card at a location, such that the location of the user may be determined. Of course, any technique may be utilized to determine a location associated with the user. Furthermore, in various embodiments, any location determination event may include receiving a location trigger.

If it is determined that a location trigger is received, a location application is automatically executed on the mobile device. See operation 47-1104. In one embodiment, the location application may include an application associated with a business (e.g. a business at the location, etc.). In another embodiment, the location application may include an application associated with an advertiser. In another embodiment, the location application may include an application associated with a mobile e-wallet application.

Once the location application is executed, in one embodiment, pre-experience functionality is implemented. See operation 47-1106. While the functionality of operation 47-1106 is set forth in the context of a location application that is triggered by a location trigger event, it should be noted that it is contemplated that operation 47-1106 may occur independent of location, as well, in other embodiments.

In one embodiment, the pre-experience functionality may include receiving advertisements/deals/coupons on the mobile device, a point-of-sale terminal display, and/or a display associated with the location. In one embodiment, the advertisements may include advertisements specifically targeted towards the user of the mobile device (e.g. as described in the context of the previous figures, etc.). Further, in one embodiment, the advertisements may include advertisements that are associated with the location (e.g. store advertisements associated with the location, product advertisements associated with the location, service advertisements associated with the location, etc.). Still yet, the aforementioned advertisements/deals/coupons may be specifically targeted as to the specific location of the user. For example, a user may receive a first advertisement for a first product in a first aisle if it is determined that the user is in the first aisle, a second advertisement for a second product in a second aisle if it is determined that the user is in the second aisle, and/or a third advertisement for a third product in a checkout line if it is determined that the user is in the checkout line.

Still yet, in one embodiment, deals and/or incentivized group discounts may be presented to the user. More information regarding group incentivized discounts may be found in U.S. Provisional Patent Application No. 61/590,767, filed Jan. 25, 2012, and titled “SYSTEM, METHOD AND COMPUTER PROGRAM PRODUCT FOR LOCATION-SPECIFIC PRIVACY SETTINGS.”

Further, in one embodiment, the pre-experience functionality may include receiving additional purchase suggestions. For example, in one embodiment, a user may scan one or more items at a point-of-sale terminal, and initiate a payment utilizing the mobile device, such that the location is determined, the location trigger is received, and the location application is executed. In this case, in one embodiment, additional item suggestions may be made to the user for purchase, based on scanned items. In another embodiment, items may be suggested to the user based on previous purchases. In addition to basing suggestions on the foregoing, such suggestions may be made as a function of an accessibility of the product. For example, if the user is already in a check-out line, the suggestion product may be accessible from the check-out line. Of course, in various embodiments, items may be suggested to the user based on any techniques discussed herein. Additionally, in one embodiment, items may be suggested to the user based on determined interests. In one embodiment, the interests may be determined utilizing user information gleaned from service networks (e.g. a social media network, etc., as described herein, etc.).

More information regarding determining interests/habits of a user may be found in U.S. Provisional Patent Application No. 61/481,722, filed May 2, 2011, titled “SYSTEM, METHOD, AND COMPUTER PROGRAM PRODUCT FOR ALLOCATING TIME TO ACHIEVE OBJECTIVES;” and U.S. patent application Ser. No. 13/462,804, filed May 2, 2012, titled “SYSTEM, METHOD, AND COMPUTER PROGRAM PRODUCT FOR ALLOCATING TIME TO ACHIEVE OBJECTIVES,” which are incorporated herein by reference in their entirety.

Further, in one embodiment, the pre-experience functionality may include determining whether the user desires to use paper or plastic bags. For example, in one embodiment, the user may be presented with the option to user paper or plastic bags on the mobile device. In one embodiment, selection of paper or plastic may cause the appropriate bag to be dispensed for use (e.g. utilizing an automatic dispenser, etc.). In one embodiment, the user may have the option to select a number of bags. In one embodiment, the user may be automatically charged for the bags, upon selection of the number of bags. In one embodiment, the user may be presented with the option to confirm the desire to purchase bags, on the mobile device.

In still another embodiment, the pre-experience functionality may include loyalty building by presenting the user with information regarding the relevant business, store, establishment, etc. For example, such functionality may provide access to an order menu for communicating a real-time order for a product (e.g. sandwich order, coffee order, etc.), current gift/store card balance, rewards, nutritional information, links to product websites, past purchase history, upcoming events, registration form for joining a loyalty program, product refill/replenishment suggestions that are a function of time/date-stamped past purchases and estimated/predetermined time-based (or other) thresholds that indicate when a refill/replenishment would likely be necessary, wish lists that allow a user to track their desired products and/or products that are desired by friends/family/colleagues of the user (as possibly indicated by links, information, etc. shared with the user), notes, etc.

As an option, in one possible embodiment, any of the pre-transaction experience functionality may be facilitated by way of the automatic execution of a business-specific application. In such embodiment, the business-specific application may be utilized to provide any of the pre-experience functionality set forth herein.

In one embodiment, the purchase may be capable of being facilitated utilizing NFC functionality between the mobile device and a point-of-sale terminal. In this case, it is determined whether an NFC trigger is received. See decision 47-1108. Of course, in other embodiments, any suitable technology may be utilized to facilitate the transaction (e.g. bump technology, Wi-Fi direct, Bluetooth, location, any of those mentioned hereinabove, etc.).

If it is determined that the NFC trigger is received, a payment authorization or process is executed. See operation 47-1110. In various embodiments, the payment authorization/process may include credit card authorization, payment authorization, user verification/authentication, a user confirmation prompt, and/or various other processes. Further, as an option, such trigger automatically cease the pre-transaction experience and immediately present transaction information using any of the techniques disclosed herein. As a further option, in the event a user has engaged in any of the aforementioned pre-transaction experience, such user may be given the option to escalate to the payment authorization or process in response to the selection of an icon (e.g. after the user has deemed that he/she has completed the pre-transaction experience.

FIG. 47-12 shows a method 47-1200 for a mobile device transaction, in accordance with another embodiment. As an option, the method 47-1200 may be implemented in the context of the architecture and environment of the previous Figures and/or any subsequent Figure(s). Of course, however, the method 47-1200 may be carried out in any desired environment. It should also be noted that the aforementioned definitions may apply during the present description.

As shown, a mobile device is initialized. See operation 47-1202. In one embodiment, the mobile device may be initialized based on a proximity to another device (e.g. a point-of-sale device, etc.). In another embodiment, the mobile device may be initialized based on the depression of a home key.

In another embodiment, the mobile device may be initialized upon a change from a sleep mode to a standby mode. In another embodiment, the mobile device may be initialized upon a change from a standby mode to an on mode (e.g. power up mode). In another embodiment, the mobile device may be initialized upon receiving a signal from the user.

In another embodiment, the mobile device may be initialized upon receiving a signal from an application. In another embodiment, the mobile device may be initialized upon establishment of an NFC connection (e.g. with a point-of-sale terminal, etc.). Of course, in various embodiments, the mobile device may be initialized in a variety of ways. By way of further example, initialization may be prompted with any of the aforementioned user identifying aspects described during reference to FIGS. 47-3-47-8, any of the techniques described in connection with operation 47-1002 of FIG. 47-10, and/or anything else that is capable of triggering initialization, for that matter.

Once the mobile device is initialized, information associated with the transaction, including a total amount, is received. See operation 47-1204. The information associated with the transaction may include any transaction related information.

Further, loyalty information is identified. See operation 47-1206. In one embodiment, the loyalty information may be identified automatically. In another embodiment, the loyalty information may be identified manually (e.g. upon selection of a card, etc.). Of course, the loyalty information may be identified in any desired manner (e.g. see, for example, the description of operation 47-1004 of FIG. 47-10, etc.).

Additionally, a payment method is selected based on user history or preferences. See operation 47-1208. For example, in one embodiment, the user may have selected a particular payment method to be a default payment method. In another embodiment, the user may have utilized a particular payment method on one or more previous occasions, such that the payment method it determined to be used based on history.

In various embodiments, the payment method may include a credit card (or a credit card number), a debit card, a prepaid card, bank account information, and/or any other payment type. In one embodiment, the payment method may be manually selected by the user at the time of completing the transaction. Further, in another embodiment, the payment method may be automatically selected (or at least suggested) based on any criteria. Such criteria may include or be based, at least in part, on a current location (e.g. based on a GPS location, etc.), a point-of-sale terminal used, on a signal received (e.g. that indicates which payment method types are acceptable), the type of payment method last used (in general, or at the current location), a balance of an account associated with the payment method (that is sufficient to cover the cost of the transaction), etc.

Still yet, transaction information is displayed for approval. See operation 47-1210. In one embodiment, the transaction information may be displayed on the mobile device. In another embodiment, the transaction information may be displayed on a point-of-sale terminal (in addition to or in lieu of display on the mobile device). In one embodiment, the transaction information may be displayed along with a selection option to approve and/or confirm the transaction. In another embodiment, the transaction information may be displayed along with a selection option to go back to a previous step in the transaction process (e.g. to enter loyalty information, etc.). More information regarding various optional techniques with which the transaction information may be displayed on the mobile device will be set forth hereinafter in greater detail during reference to subsequent figures.

Further, it is determined whether an NFC connection (or any session that was triggered by the initialization of operation 47-1202) is still available. See determination 47-1212. If a connection is not still available, it is determined whether a connection can be reestablished. See operation 47-1214. If a connection cannot be reestablished, the mobile device (or an application associated therewith) determines whether there is a timeout. See decision 47-1216. If it is determined that there is a timeout, the transaction process is terminated on the mobile device and the application is closed. See operation 47-1218.

If a connection is still available, it is determined whether purchase confirmation is received from the user. See determination 47-1220. In one embodiment, the purchase confirmation may include the user selecting a confirmation icon presented on the mobile device, sliding a slider, performing a predetermined gesture, entering a pass code, scanning a fingerprint/face, and/or any other desired user input. In another embodiment, the user may have an option to confirm the purchase utilizing a point-of-sale terminal associated with the transaction.

If it is determined that confirmation is received, an authorization code is transferred. See operation 47-1222. In one embodiment, the authorization code may be transmitted from the mobile device to the point-of-sale terminal. In another embodiment, the authorization code may be transmitted from the mobile device to a store backend server. In another embodiment, the authorization code may be transmitted from the mobile device to a payment server.

Once the transaction is complete, an electronic receipt may be received. See operation 47-1224. In one embodiment, the electronic receipt may be received over the connection between the point-of-sale terminal and the mobile device (e.g. the NFC connection, etc.). In another embodiment, the electronic receipt may be received via a text message (e.g. an MMS, an SMS, etc.).

In another embodiment, the electronic receipt may be received via an email. In another embodiment, the electronic receipt may be received over a network (e.g. accessed by a website, etc.). In another embodiment, the electronic receipt may be received by an application stored on the mobile device (e.g. an e-wallet application, a store application, etc.). In another embodiment, the electronic receipt may be stored on a network server (e.g. in a network cloud, etc.).

Furthermore, in one embodiment, the transaction may be logged. See operation 47-1226. In one embodiment, the transaction may be logged on the mobile device. In another embodiment, the transaction may be logged in a database associated with the store. In another embodiment, the transaction may be logged in a database associated with the payment facilitator. In another embodiment, the transaction may be logged in a database associated with a service provider (e.g. an advertiser, a social network, etc.).

In one embodiment, post-purchase functionality is triggered. See operation 47-1228. While operation 47-1128 is shown to occur after operation 47-1126, it should be noted that operation 47-1128 may occur immediately (or shortly) after determination 47-1220. For that matter, any of the operations disclosed herein (in any of the Figures) may be re-ordered as desired, as well as removed and/or subject to additional intermediate operations.

In various embodiments, the post-purchase functionality may include displaying advertisements, displaying shopping suggestions, displaying discounts, displaying options for products not purchased, displaying contact information associated with the transaction or a potential future transaction, displaying a survey and/or satisfaction related questions, and/or various other post-purchase functionality.

As an option, in one possible embodiment, any of the post-transaction experience functionality may be facilitated by way of the automatic execution of a business-specific application. In such embodiment, the business-specific application may be utilized to provide any of the post-experience functionality set forth herein. Further, such business-specific application may interface with an e-wallet application for sharing information (e.g. transaction information, purchase statistics, profile information, etc.) for providing and/or supporting the post-experience functionality.

In one embodiment, advertisers may utilize the completion of the transaction as a target advertisement trigger event. For example, in one embodiment, the owner of a presentation medium (e.g. a store, etc.) may be in communication with one or more service networks, such that advertisements may be presented at a time of sale.

FIG. 47-13 shows a system flow 47-1300 for presenting advertisements, in accordance with another embodiment. As an option, the system flow 47-1300 may be implemented in the context of the architecture and environment of the previous Figures and/or any subsequent Figure(s). Of course, however, the system flow 47-1300 may be implemented in any desired environment. It should also be noted that the aforementioned definitions may apply during the present description.

As shown, a third party advertiser registers one or more advertisements, which are associated with one or more profile triggers, with a service network. See step 1. This may or may not, for example, encompass any of the trigger IDs and related information described hereinabove in connection with FIGS. 47-1-47-9, in one embodiment.

Further, a third party owner of a presentation medium registers one or more presentation mediums, including location/context information and a context medium specification, with the service network. See step 2. The location/context information may include any IP or destination address and/or any other identifier capable of being used to direct advertisements (or trigger IDs) thereto. Further, the context medium specification may identify any formatting/protocol/etc. that is capable of being used to ensure that the advertisements selected for and/or directed to the presentation medium are formatted for proper delivery and/or presentation.

The service network then identifies a profile trigger that also may trigger on location/context information of a registered presentation device. See step 3. In one embodiment, this may or may not be accomplished in a manner similar to that set forth during the description of FIGS. 1-9. For instance, a user identifying aspect may be received in connection the registered presentation device. Further, in response to such user identifying aspect, an advertisement/content may be identified by matching advertisement/content profile criteria with user profile criteria. See step 4.

Further, the service network transforms the selected advertisement, based on a medium specification. Again, see step 4.

Additionally, the service network pushes one or more advertisements to a corresponding presentation medium with a time stamp. See step 5. Subsequently, the advertisement is displayed within the time period of the time stamp. See step 6. Furthermore, in one embodiment, the service network may confirm display of the advertisement. See step 7.

Still yet, the display of the advertisement is reported to the third party advertiser. See step 8. As a result, the third party advertiser may pay for the advertisement display. See step 9. Moreover, in one embodiment, the service network may share payment with and/or otherwise incentivize the third party presentation medium owner. See step 10.

In one embodiment, the advertisement may be presented on a mobile device of the user. Further, in one embodiment, the advertisement may be presented on the mobile device screen, along with transaction details associated with a sale. Still yet, in one embodiment, the mobile device may be utilized to facilitate the transaction and/or trigger advertising events.

FIG. 47-14 shows a mobile device interface 47-1400 for facilitating a payment, in accordance with another embodiment. As an option, the system interface 47-1400 may be implemented in the context of the architecture and environment of the previous Figures and/or any subsequent Figure(s). Of course, however, the interface 47-1400 may be implemented in any desired environment. It should also be noted that the aforementioned definitions may apply during the present description.

As shown, upon initialization of a payment process, in one embodiment, transaction information may be shown on a lock screen of a mobile device screen.

Further, in one embodiment, additional alerts may be capable of being displayed on the screen (e.g. text message alerts, calendar alerts, incoming call alerts, voicemail alerts, etc.).

In one embodiment, the transaction details displayed on the screen may include a total amount, a preferred or selected method of payment (e.g. the Visa Card ending in *3232, etc.), loyalty card information, and/or various other information. Further, in one embodiment, the user may be presented with an option to accept payment. In one embodiment, the option to select payment may include a button. In another embodiment, the option to select payment may include a slider. In another embodiment, the option to select the payment may include a passcode entry. In another embodiment, the option to select the payment may include a biometric data entry portion.

FIG. 47-15 shows a mobile device interface 47-1500 for facilitating a payment, in accordance with another embodiment. As an option, the system interface 47-1500 may be implemented in the context of the architecture and environment of the previous Figures and/or any subsequent Figure(s). Of course, however, the interface 47-1500 may be implemented in any desired environment. It should also be noted that the aforementioned definitions may apply during the present description.

As shown, upon initialization of a payment process, in one embodiment, transaction information may be shown on a password entry screen of a mobile device. Further, in one embodiment, additional alerts may be capable of being displayed on the screen (e.g. text message alerts, calendar alerts, incoming call alerts, voicemail alerts, etc.). In one embodiment, the user may have the ability to enter an alpha-numeric password to authorize the transaction. As an option, such alpha-numeric password may be the same or different from the alpha-numeric password used to unlock the screen lock screen (to access the menu, etc.).

FIG. 47-16 shows a mobile device interface 47-1600 for facilitating a payment, in accordance with another embodiment. As an option, the system interface 47-1600 may be implemented in the context of the architecture and environment of the previous Figures and/or any subsequent Figure(s). Of course, however, the interface 47-1600 may be implemented in any desired environment. It should also be noted that the aforementioned definitions may apply during the present description.

As shown, upon initialization of a payment process, in one embodiment, transaction information may be shown on a passcode entry screen of a mobile device. Further, in one embodiment, additional alerts may be capable of being displayed on the screen (e.g. text message alerts, calendar alerts, incoming call alerts, voicemail alerts, etc.). In one embodiment, the user may have the ability to enter a numeric passcode to authorize the transaction. In one embodiment, the numeric passcode may include the same passcode for accessing additional phone/e-mail/mobile device menu functionality.

FIG. 47-17 shows a mobile device interface 47-1700 for facilitating a payment, in accordance with another embodiment. As an option, the system interface 47-1700 may be implemented in the context of the architecture and environment of the previous Figures and/or any subsequent Figure(s). Of course, however, the interface 47-1700 may be implemented in any desired environment. It should also be noted that the aforementioned definitions may apply during the present description.

As shown, upon initialization of a payment process, in one embodiment, transaction information may be shown on a passcode entry screen of a mobile device. Further, in one embodiment, additional alerts may be capable of being displayed on the screen (e.g. text message alerts, calendar alerts, incoming call alerts, voicemail alerts, etc.). In one embodiment, the user may have the ability to present a face image to authorize the transaction. For example, in one embodiment, the user may utilize a camera of the mobile device to capture one or images of his/her face such that a facial recognition process may be utilized to determine whether to authorize the payment.

Once the payment has been confirmed, in one embodiment, post-payment functionality may be presented to the user on the mobile device.

FIG. 47-18 shows a mobile device interface 47-1800 for presenting post-payment functionality, in accordance with another embodiment. As an option, the system interface 47-1800 may be implemented in the context of the architecture and environment of the previous Figures and/or any subsequent Figure(s). Of course, however, the interface 47-1800 may be implemented in any desired environment. It should also be noted that the aforementioned definitions may apply during the present description.

As shown, in one embodiment, the post-payment functionality may be presented on a lock screen associated with the mobile device. In one embodiment, the post-payment functionality may include displaying an alert or notification indicating that the payment/transaction was successful. In another embodiment, the post-payment functionality may include displaying advertisements on the mobile device screen. In one embodiment, the advertisement may be provided by the business associated with the transaction. In another embodiment, the advertisement may be provided by a service provider (e.g. a social network service, etc.). In another embodiment, the advertisement may be provided by an advertiser. Of course, the advertisement may be provided based on any of the techniques described herein (e.g. targeted based on user information, etc.). See, for example, the description of FIGS. 47-1-47-9, in accordance with one embodiment.

As an option, content/icons/options, etc. of the interfaces of FIGS. 47-14-47-18 may be displayed for facilitating the initiation and completion of an e-wallet transaction without necessarily having to manually remove the mobile device from a standby mode, and without necessarily leaving the lock-screen. Of course, in other embodiments, initiation and completion of the e-wallet transaction with manual initiation and non-lock-screen functionality is contemplated, as well.

In still other embodiments, the ability to initiate and/or complete e-wallet transactions via the lock screen (see FIGS. 47-14-47-18) may be disabled (i.e. selectively enabled) via a settings interface. When such functionality is disabled, the e-wallet transaction may be initiated and/or completed via an e-wallet application interface screen (that may be accessed via a main menu screen, etc.).

Further, in one embodiment, the user may be presented with an option to receive targeted advertisements based on purchase, at a current time and/or in the future. Additionally, in one embodiment, the user may be presented with the option to share information (e.g. transaction information, purchase information, personal information, etc.) with one or more other systems (e.g. advertisers, etc.).

As an option, the aforementioned mobile device may be capable of operating in a location-specific mode. Specifically, in one embodiment, a location associated with the mobile device may be determined. Further determined may be a presence of at least one other person at the location. Still yet, a graphical user interface may be automatically displayed. Such graphical user interface may be specifically associated with the determined location and the determined presence of the at least one other person. In another embodiment, the system, method, or computer program product may be capable of determining a location associated with the mobile device and automatically determining that the location is proximate to a previously identified item of interest. To this end, a graphical user interface associated with the determined location and the previously identified item of interest may be displayed. More information regarding such location-specific features that may or may not be incorporated into any of the embodiments disclosed herein, may be found in U.S. patent application Ser. No. 13/652,458, filed Oct. 15, 2012, titled “MOBILE DEVICE SYSTEM, METHOD, AND COMPUTER PROGRAM PRODUCT,” which is incorporated herein by reference in its entirety.

The present application claim priority to U.S. Non-Provisional application Ser. No. 13/652,458, filed Oct. 15, 2012, which claims priority from U.S. Provisional Application No. 61/547,638, filed Oct. 14, 2011, U.S. Provisional Application No. 61/567,118 dated Dec. 5, 2011, U.S. Provisional Application No. 61/577,657 dated Dec. 19, 2011, U.S. Provisional Application No. 61/599,920 dated Feb. 16, 2012, and U.S. Provisional Application No. 61/612,960 dated Mar. 19, 2012, all of which are incorporated herein by reference in their entirety for all purposes. As an option, any one or more of the following embodiments (and/or any one or more features thereof) described in connection with any one or more of the subsequent Figure(s) may or may not be implemented in the context of any one or more of the embodiments (and/or any one or more features thereof) described in connection with any one or more Figure(s) of the above incorporated applications. Of course, however, any one or more of the following embodiments (and/or any one or more features thereof) may be implemented in any desired environment.

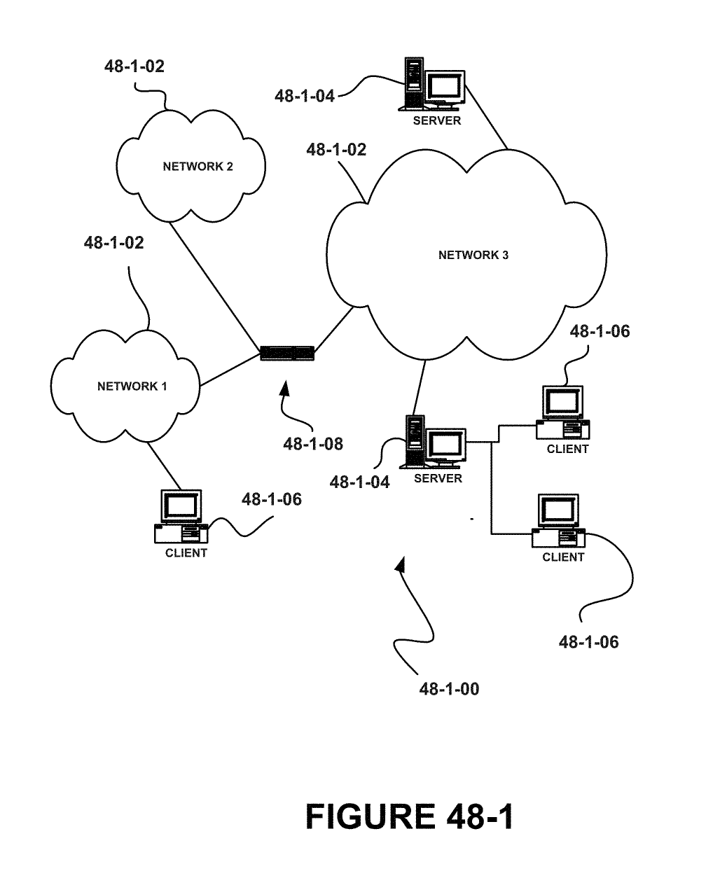

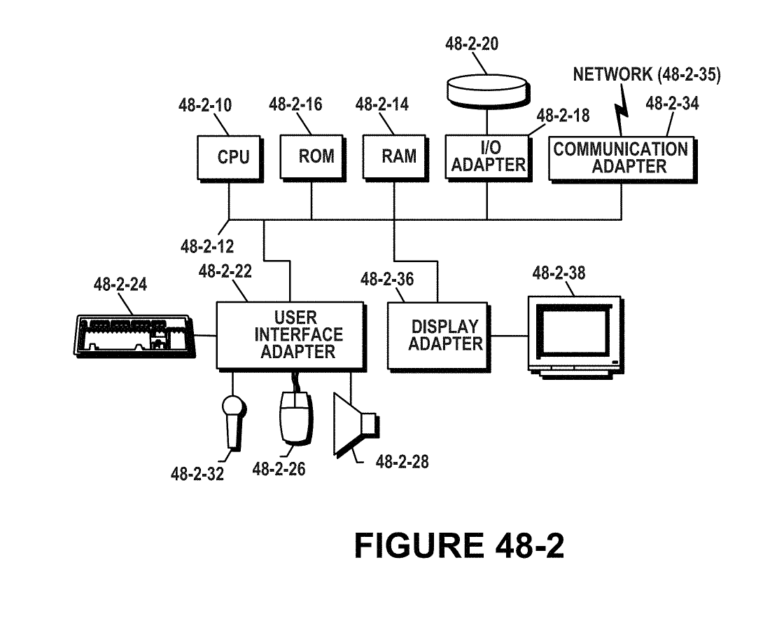

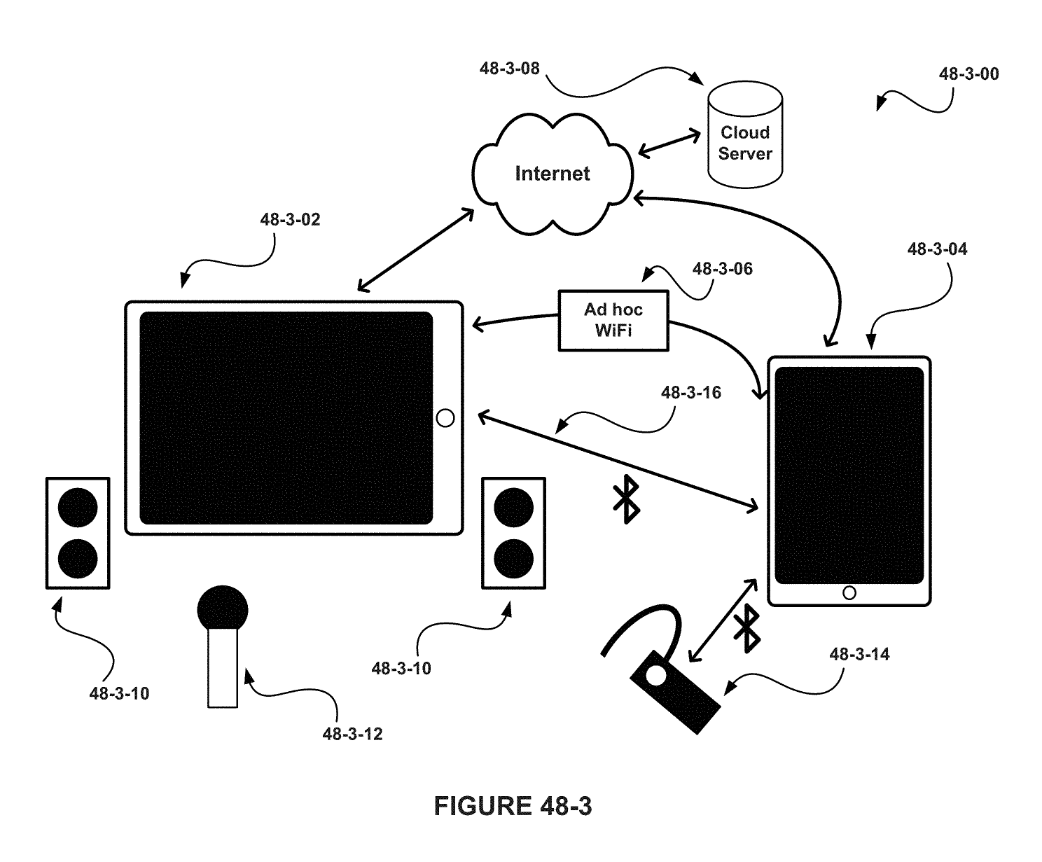

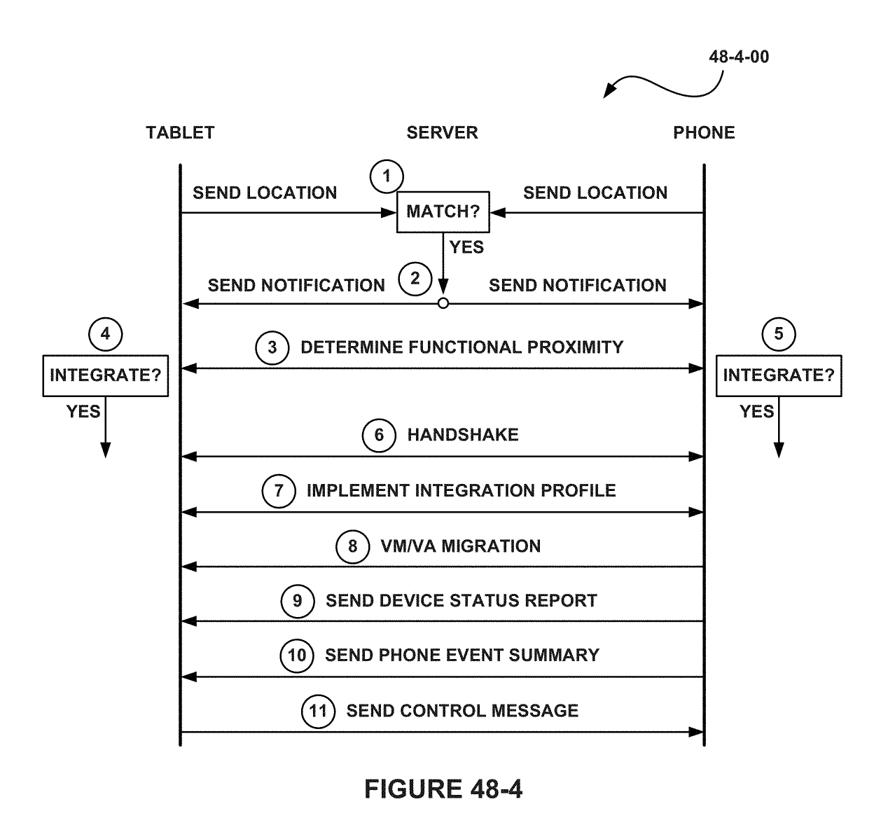

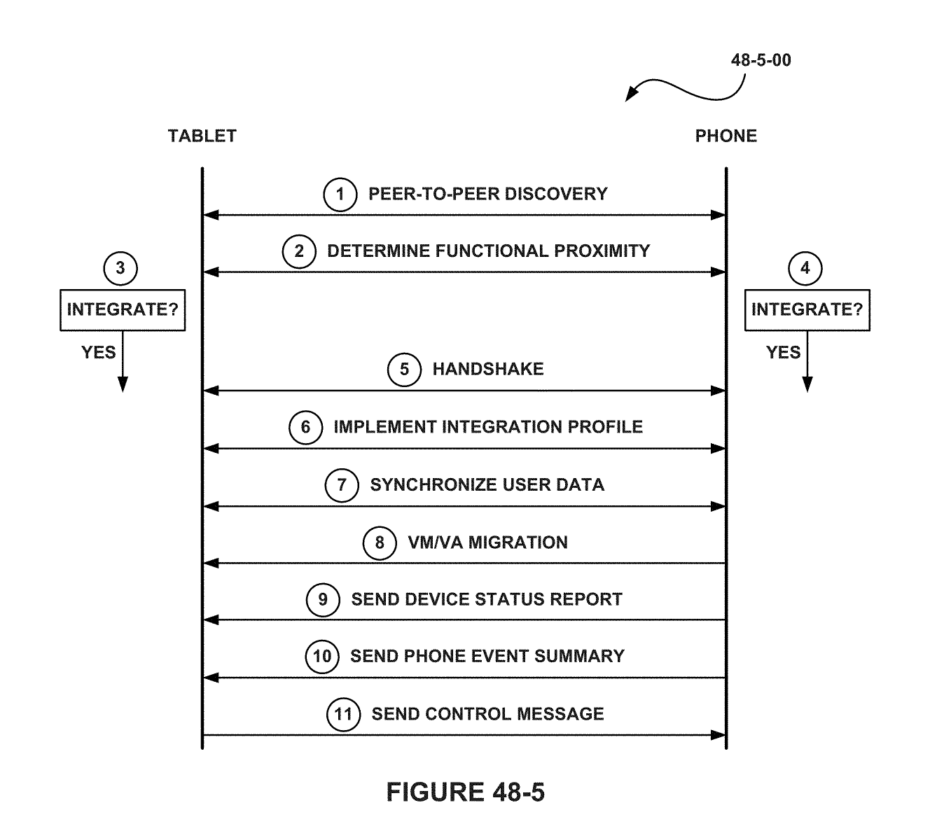

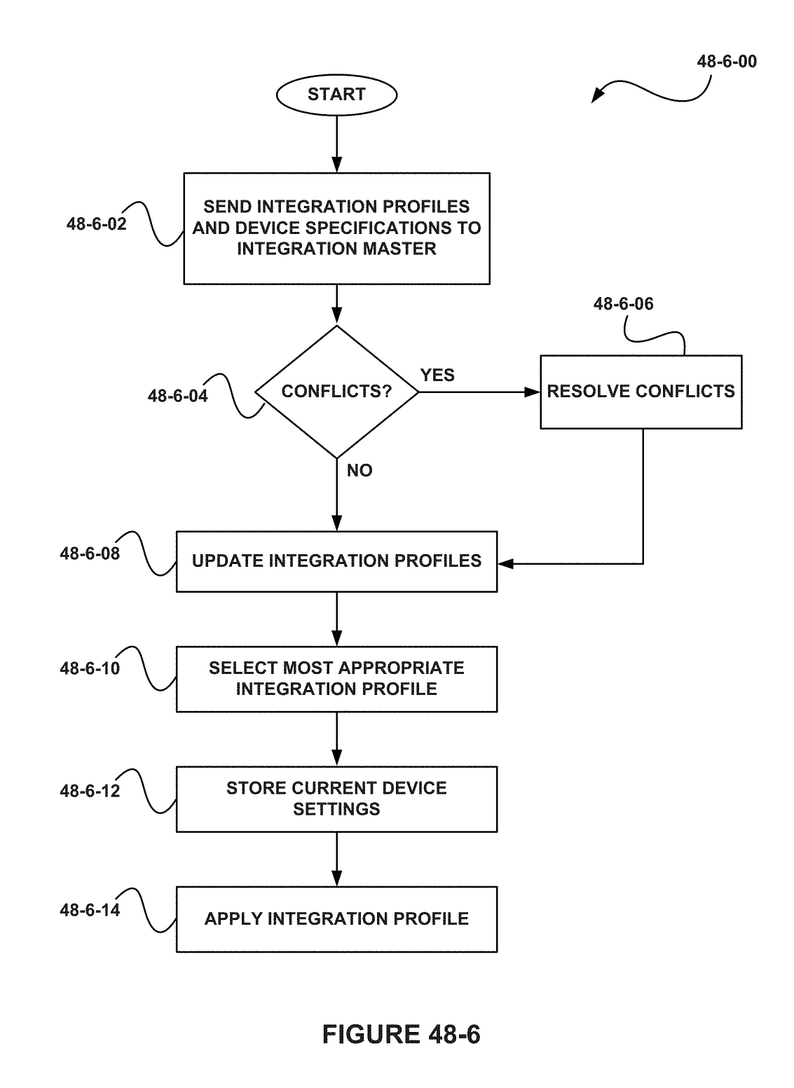

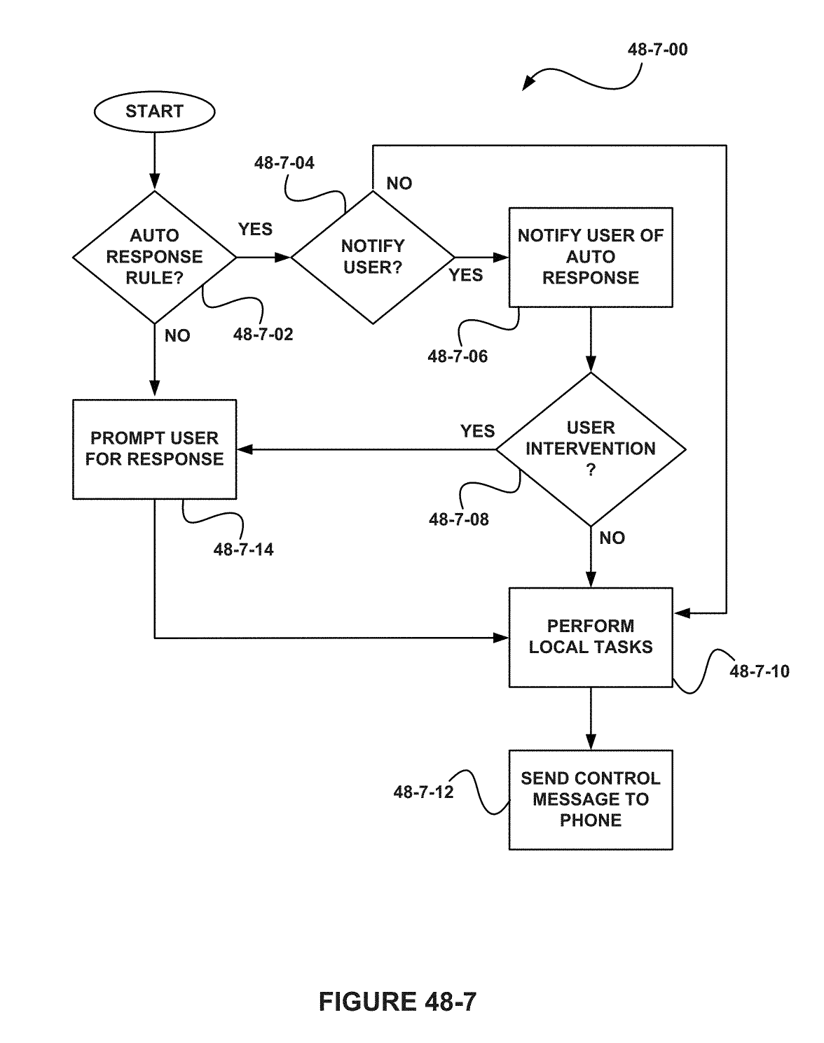

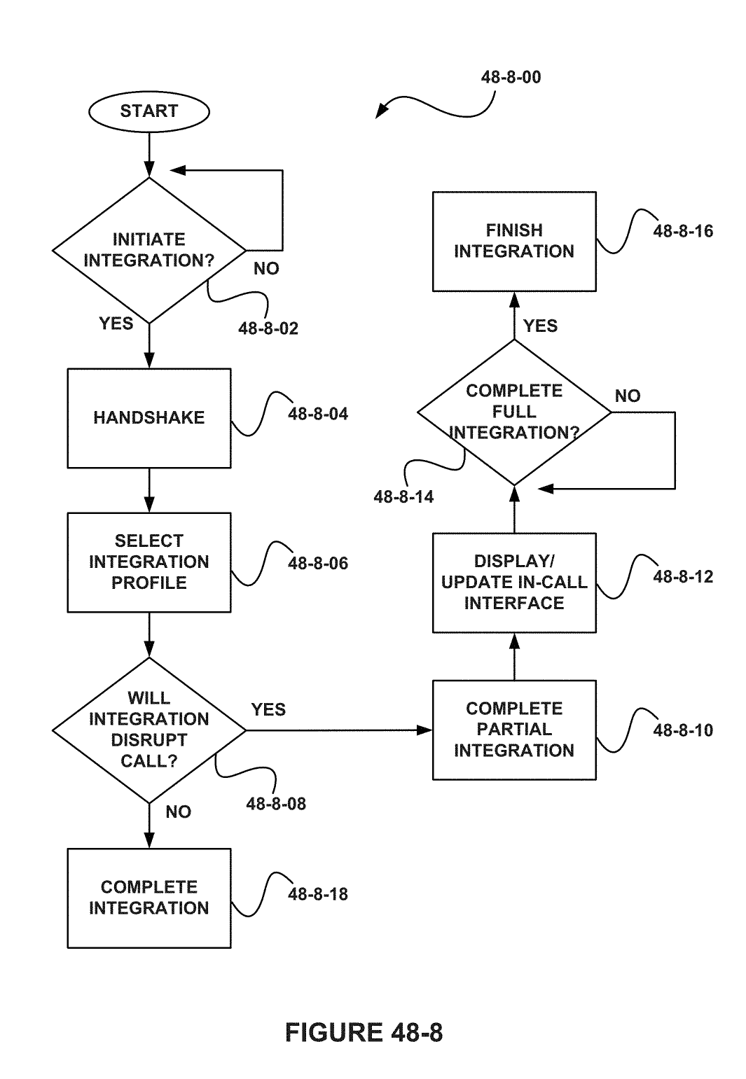

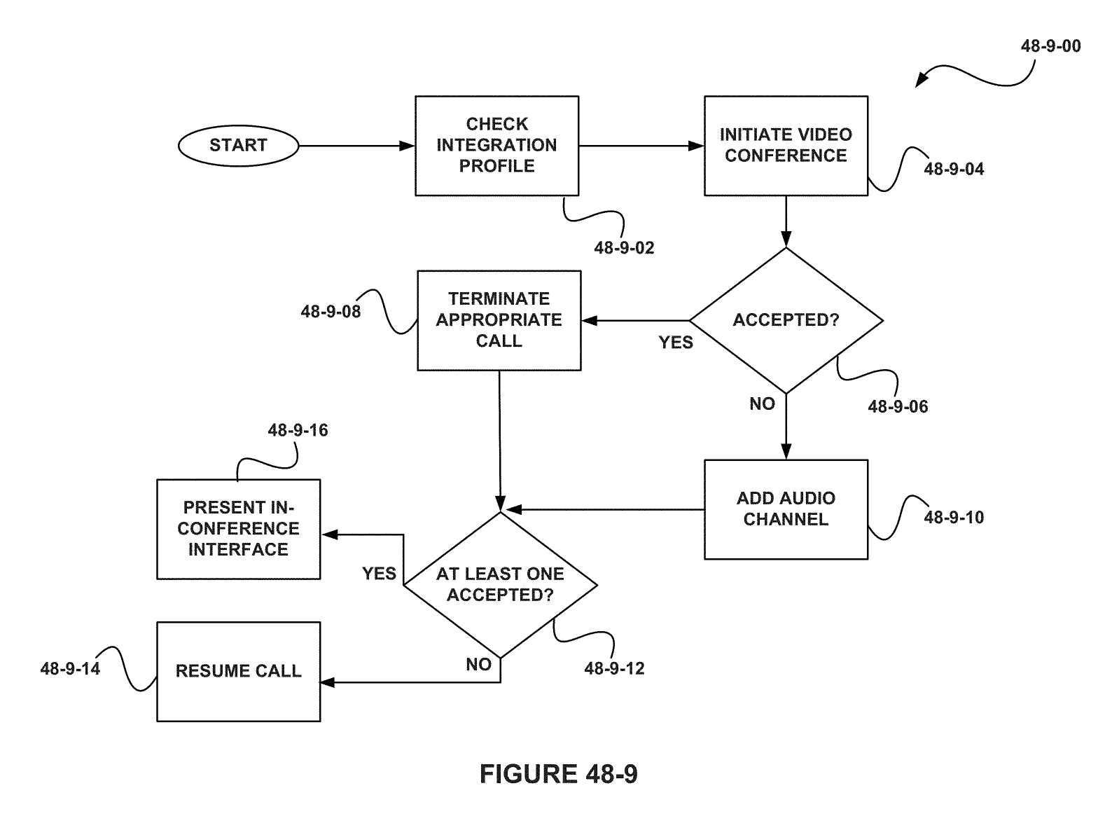

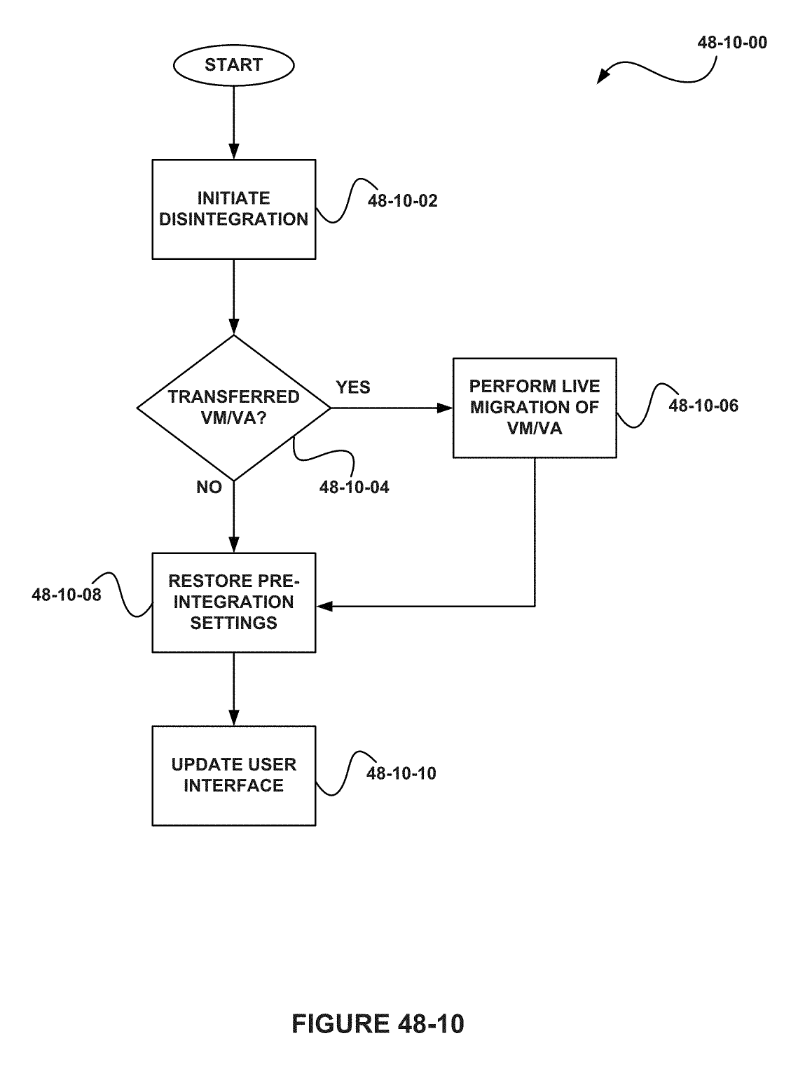

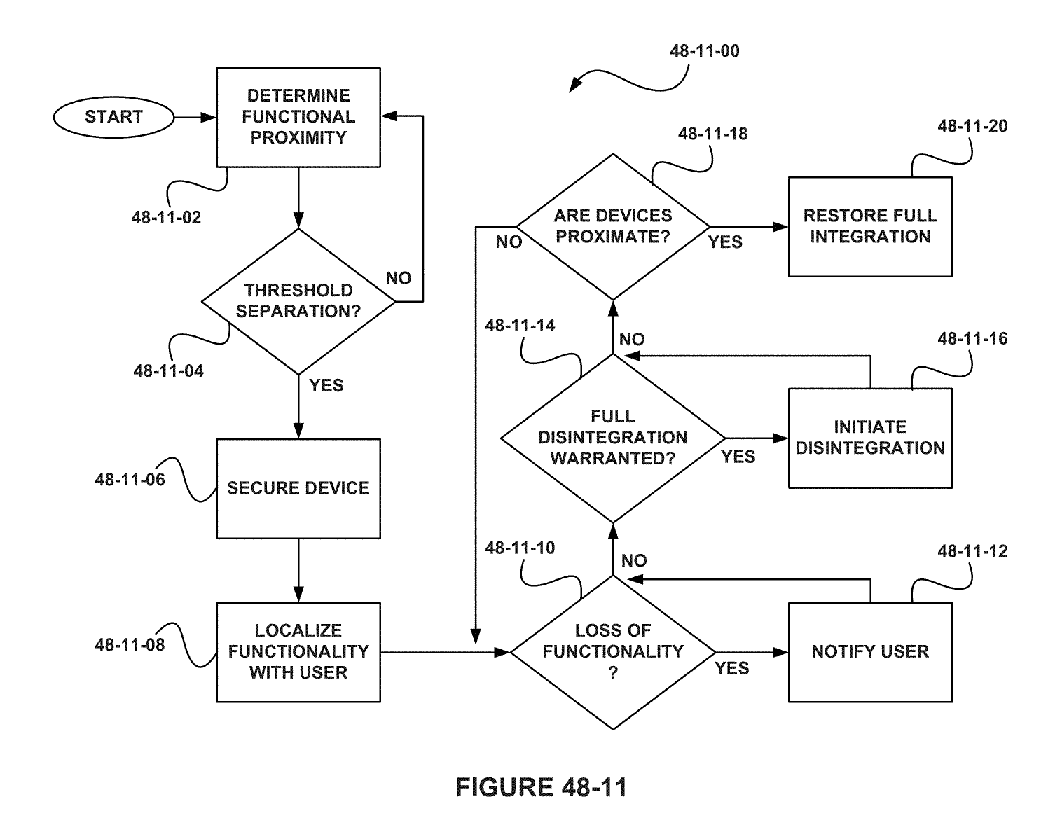

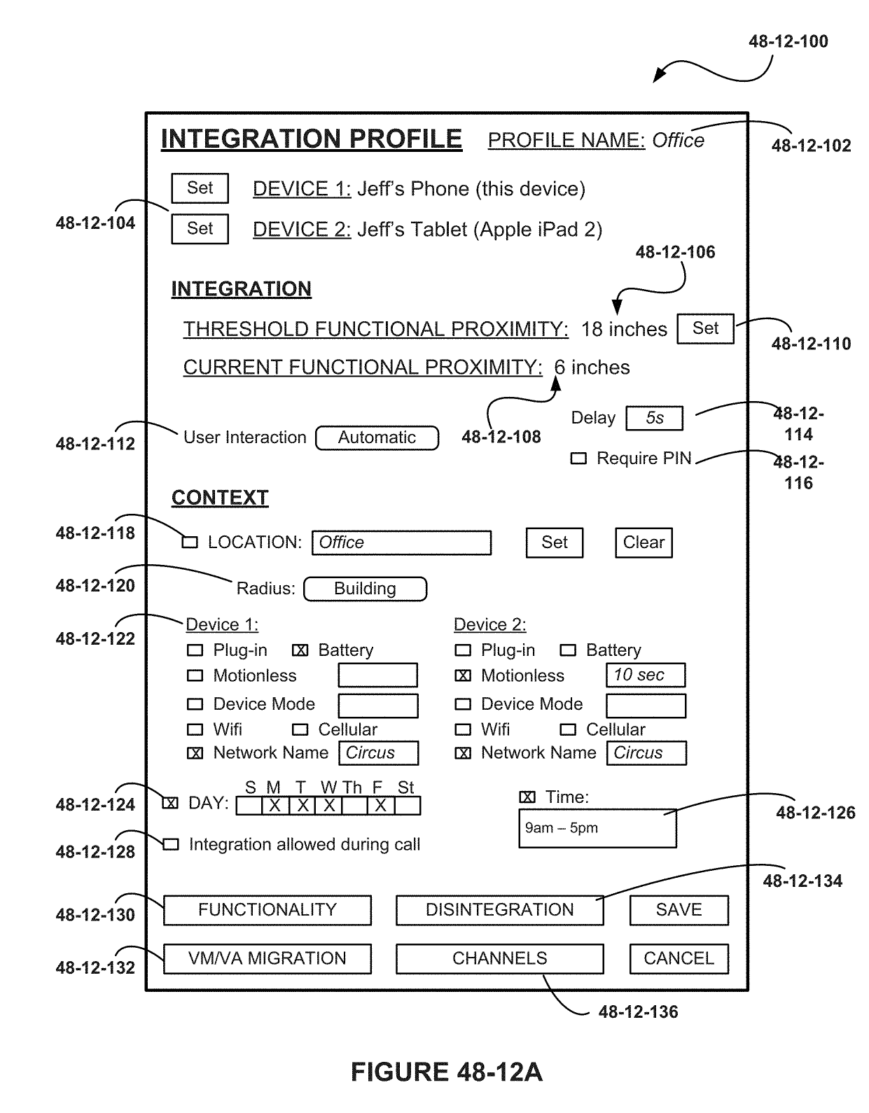

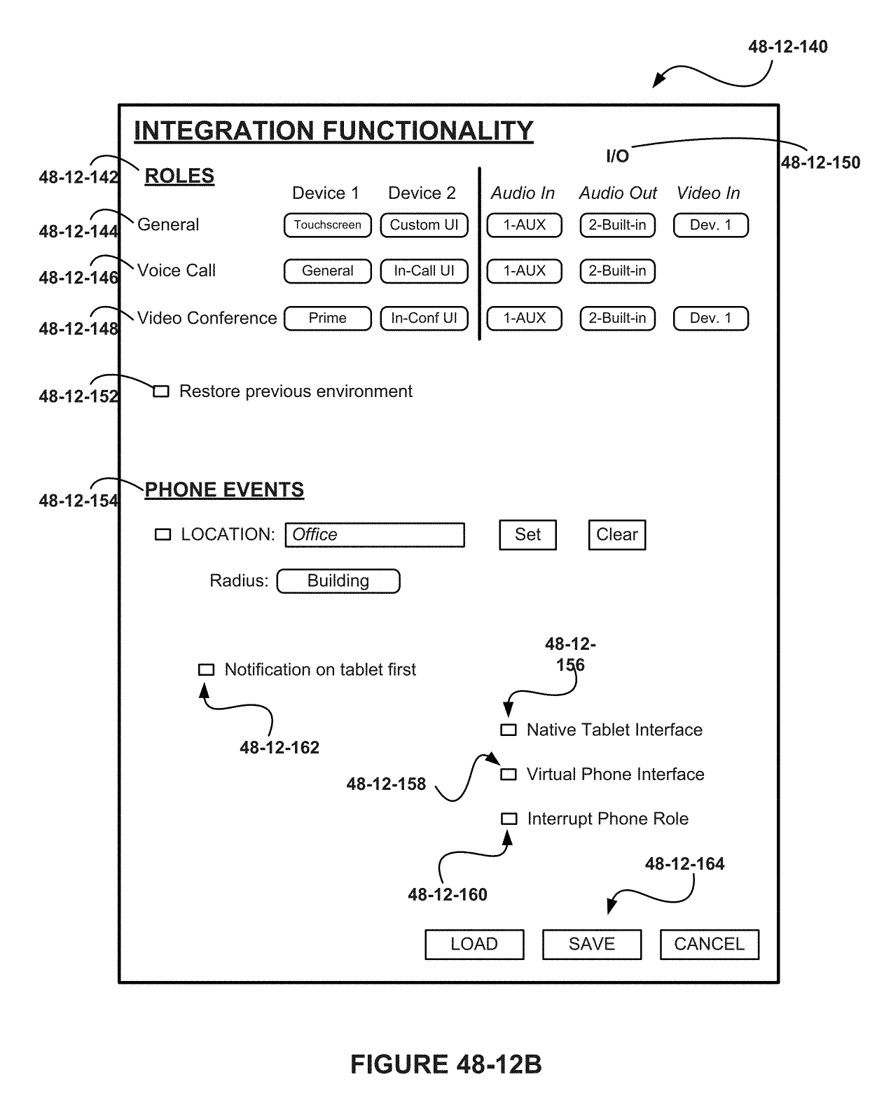

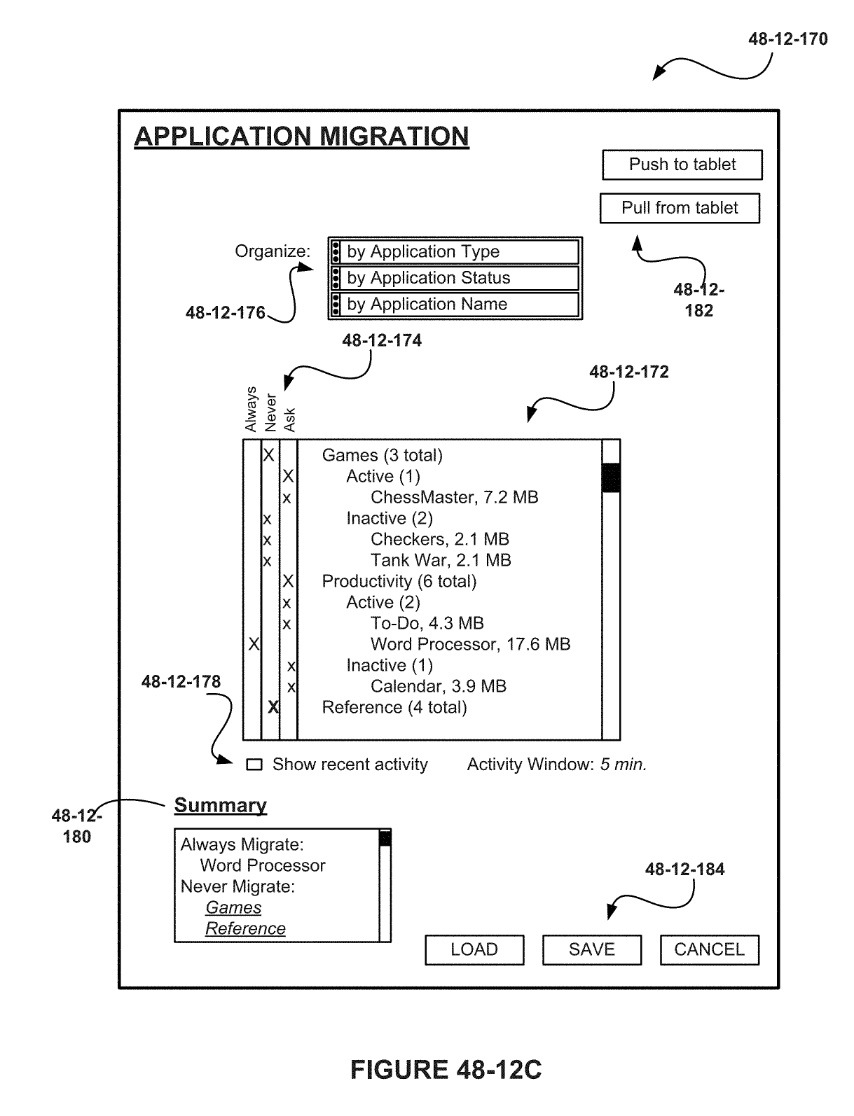

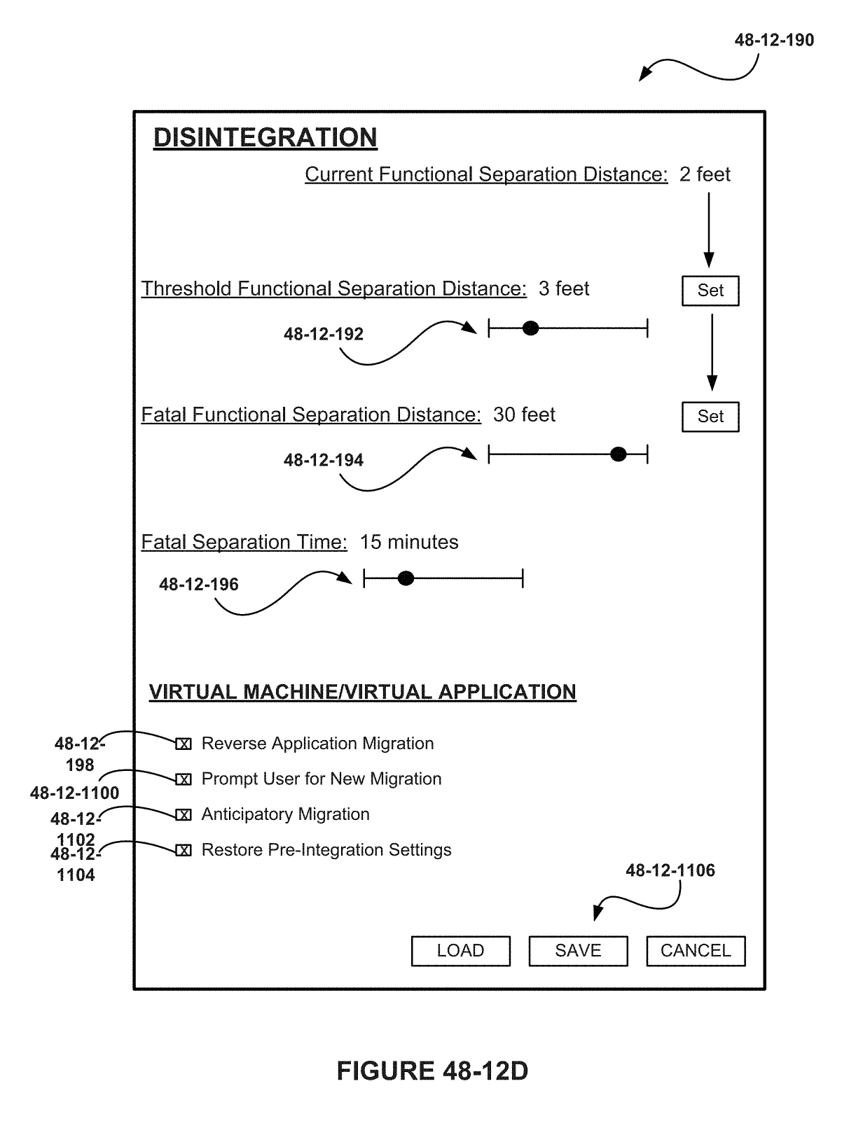

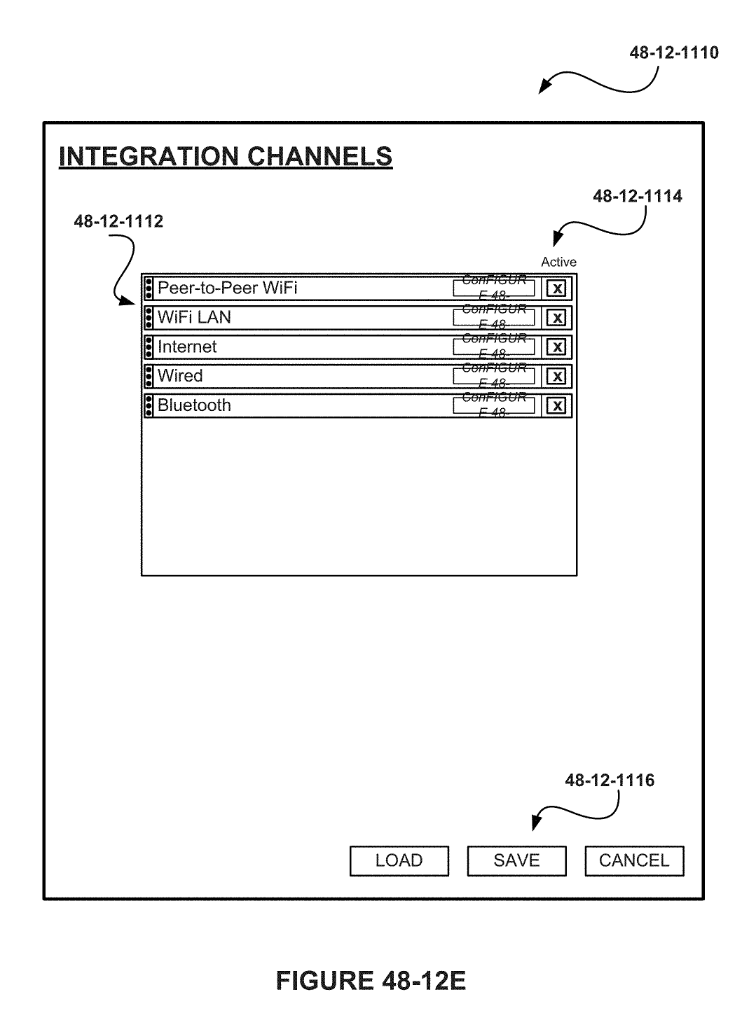

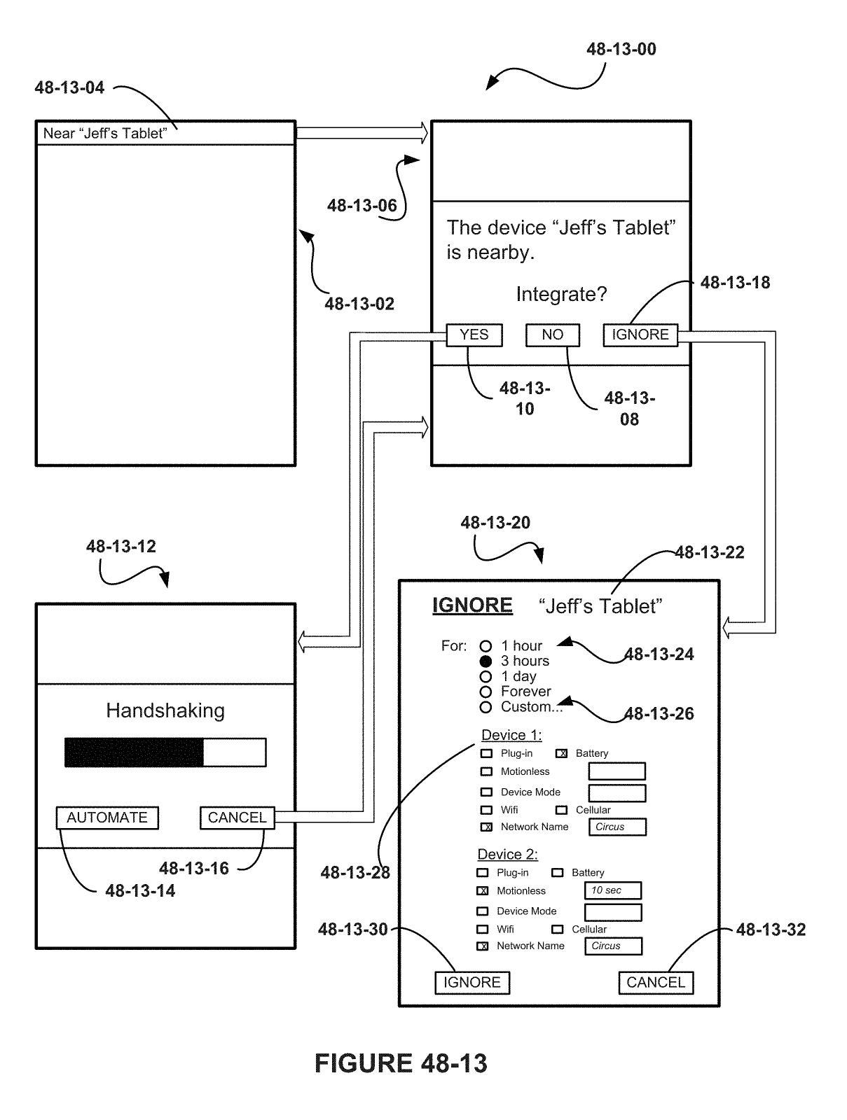

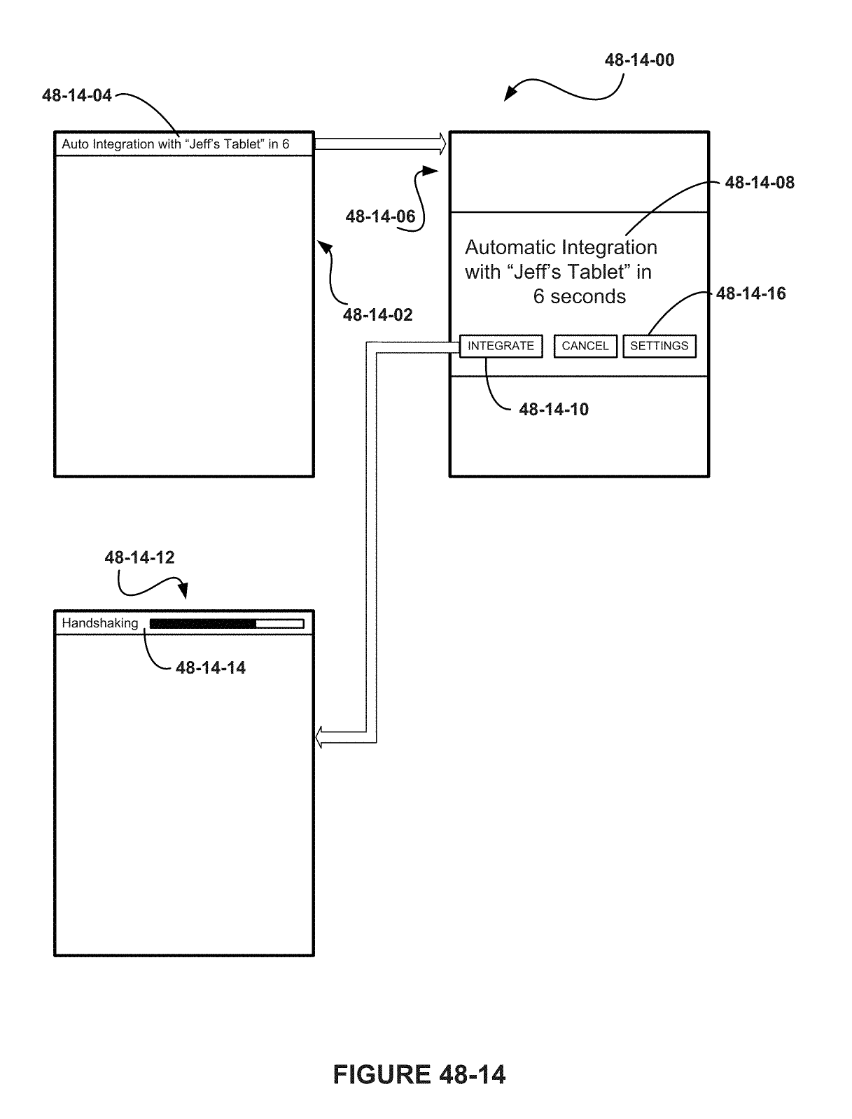

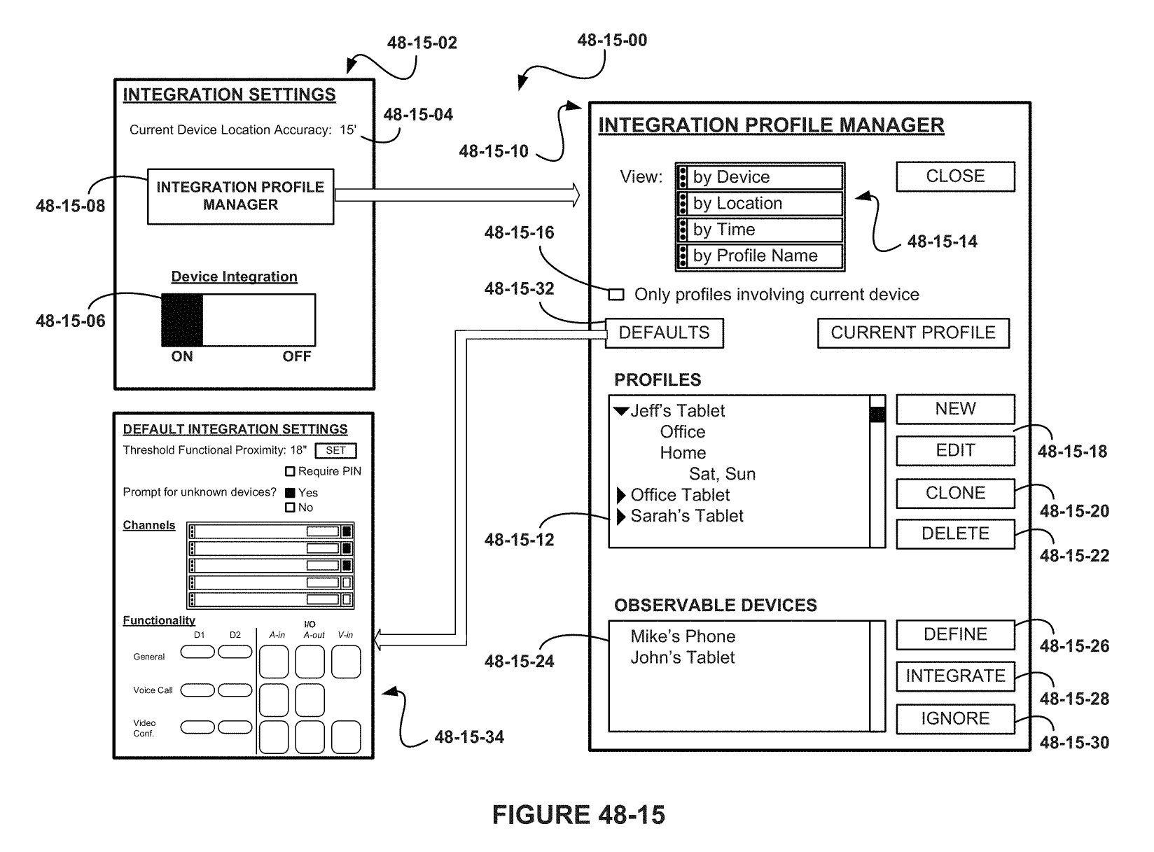

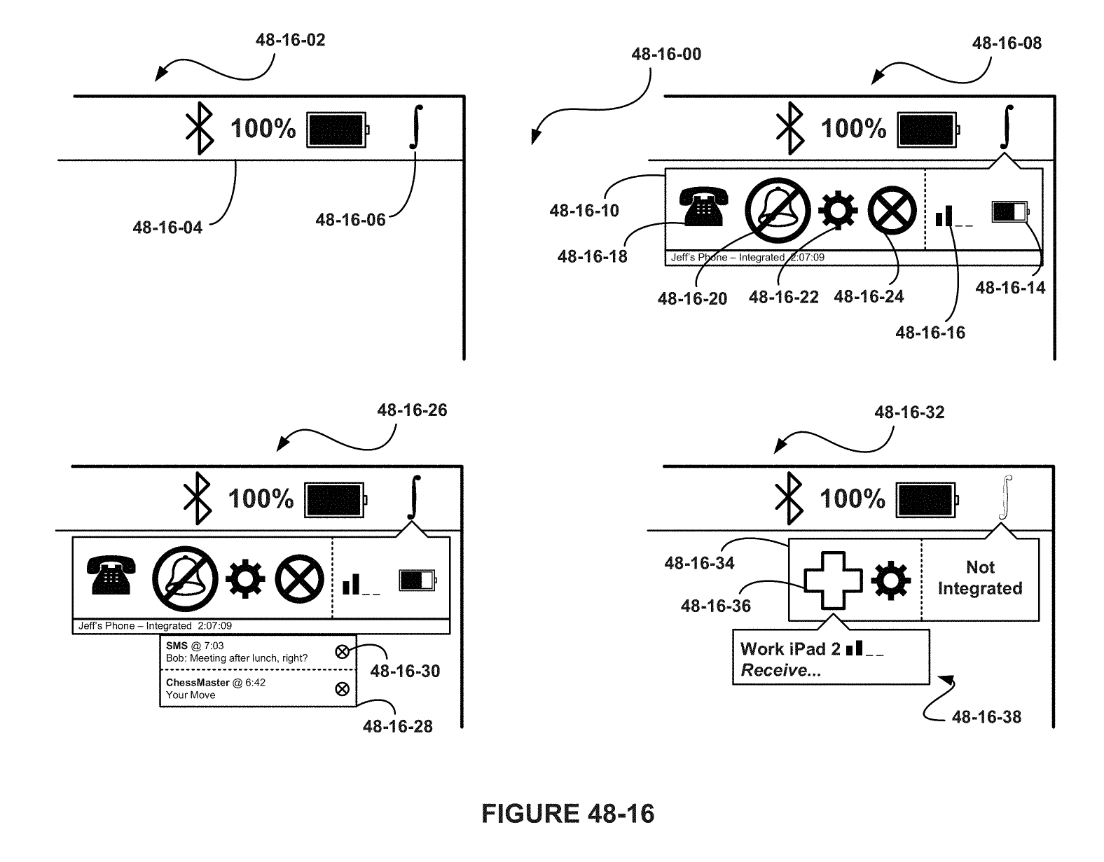

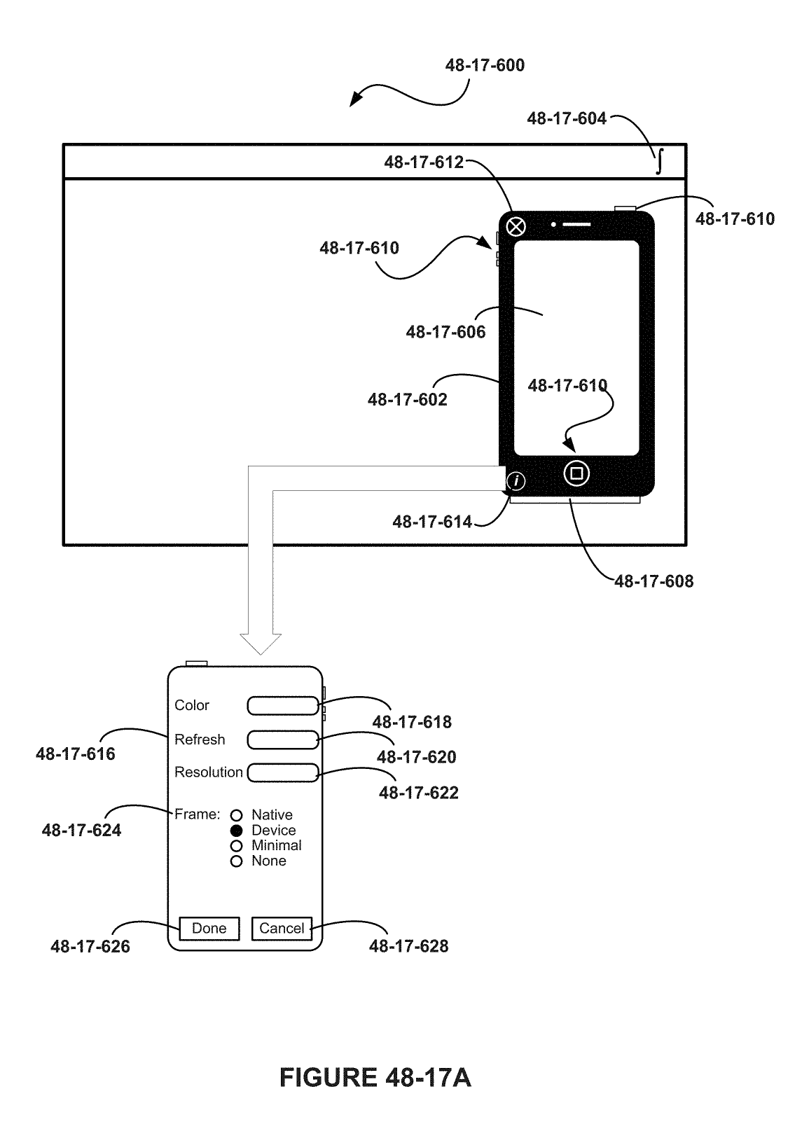

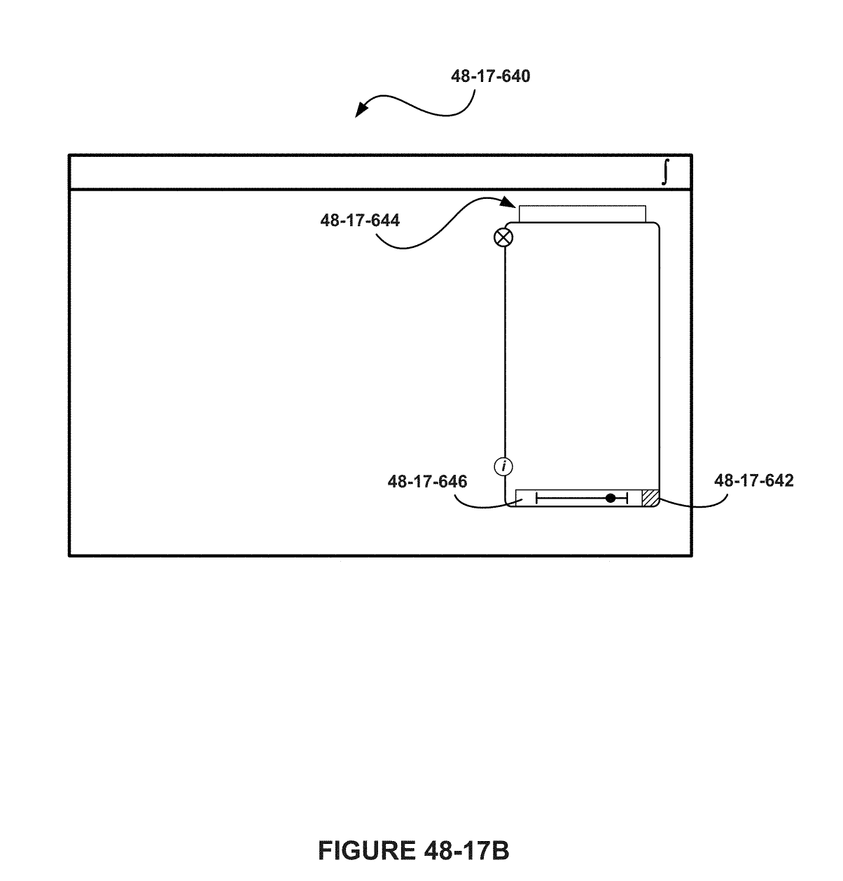

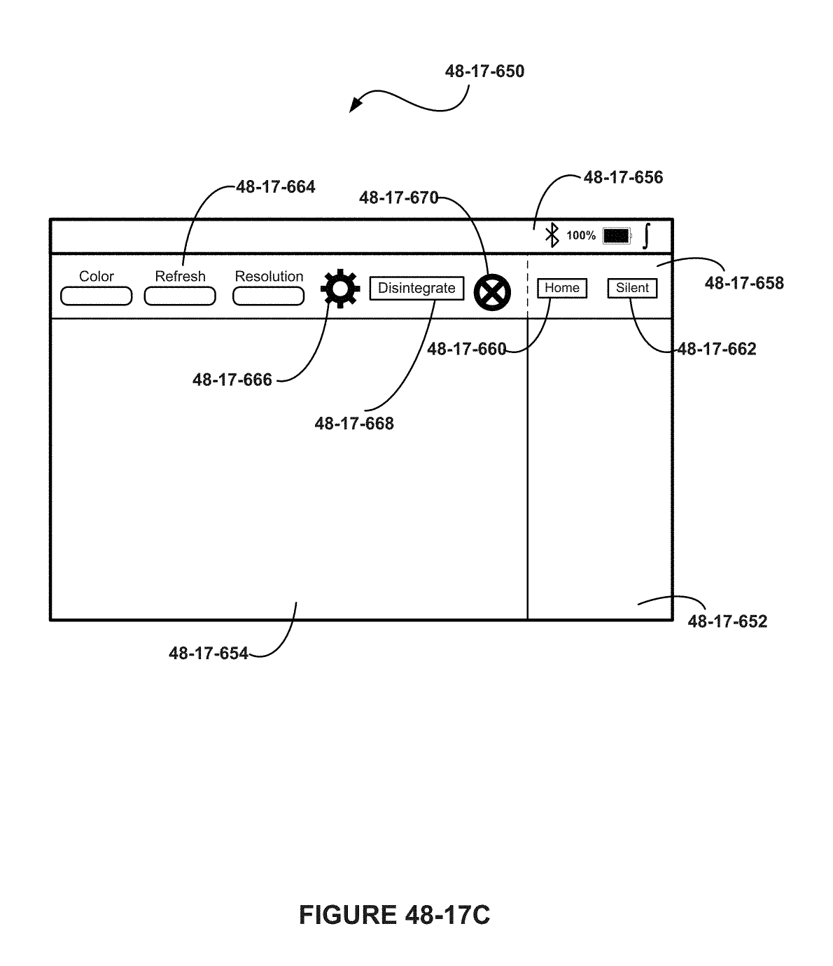

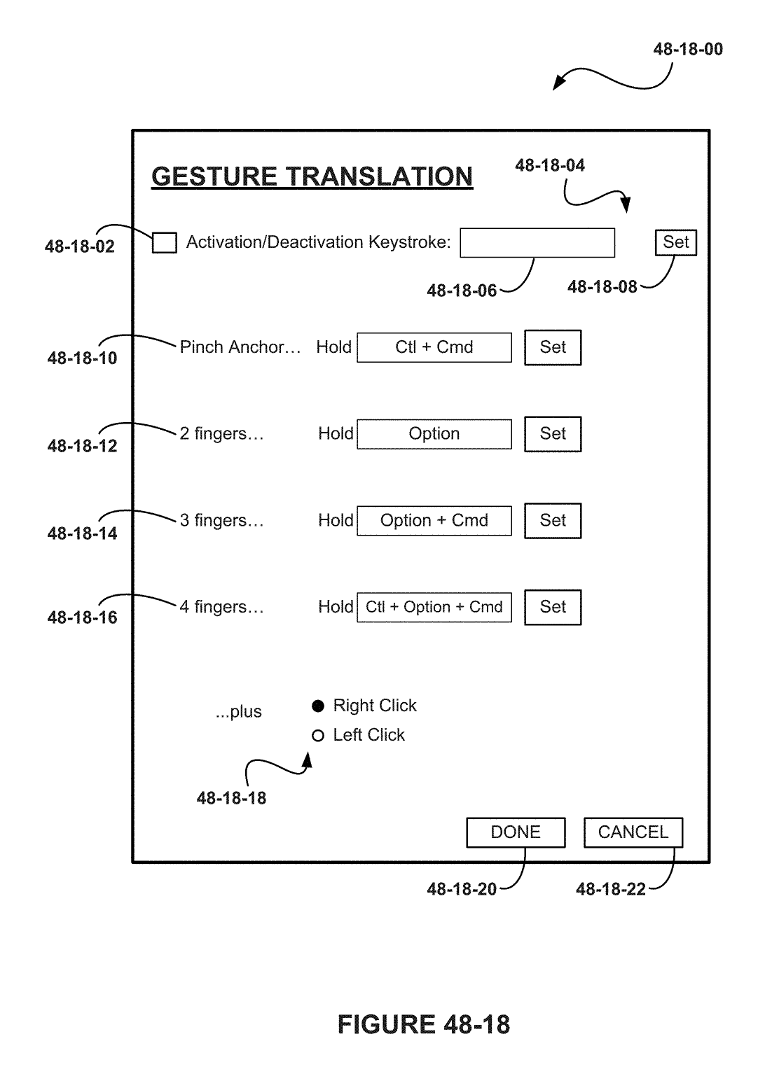

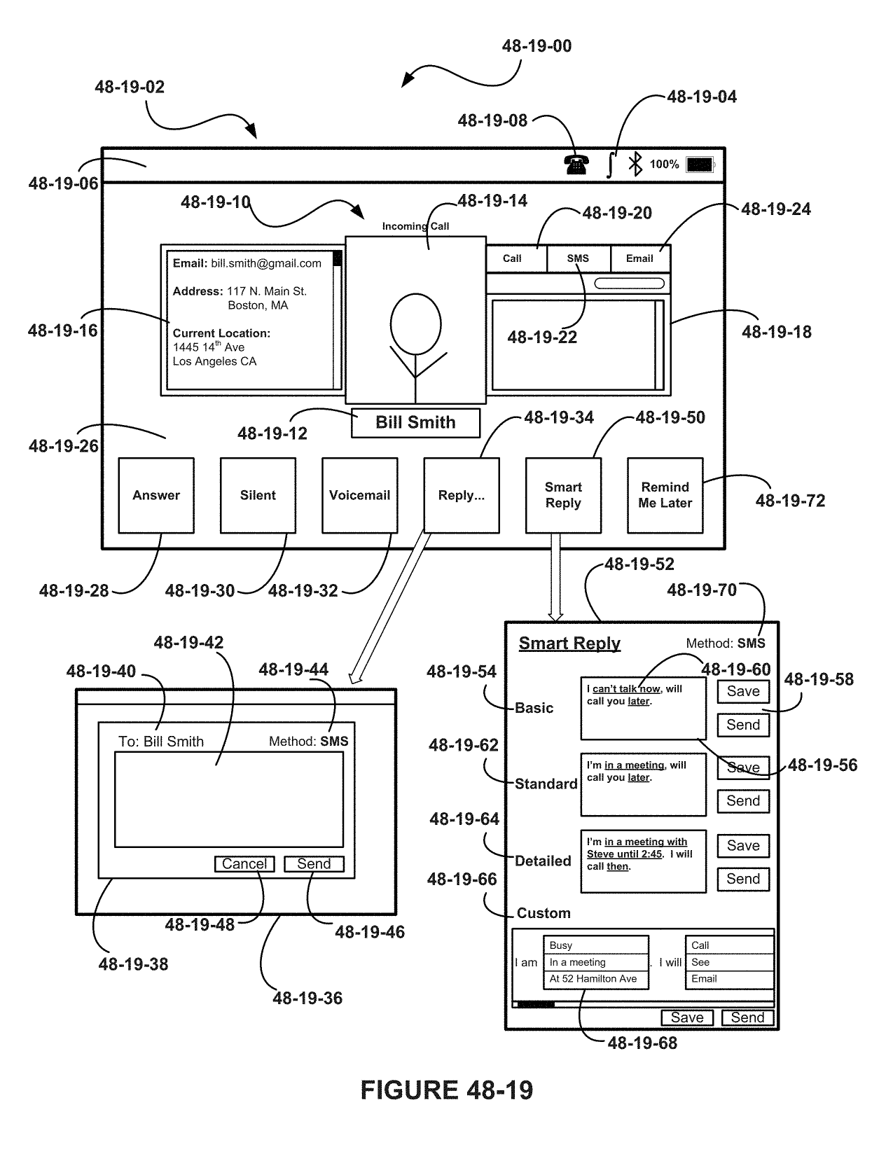

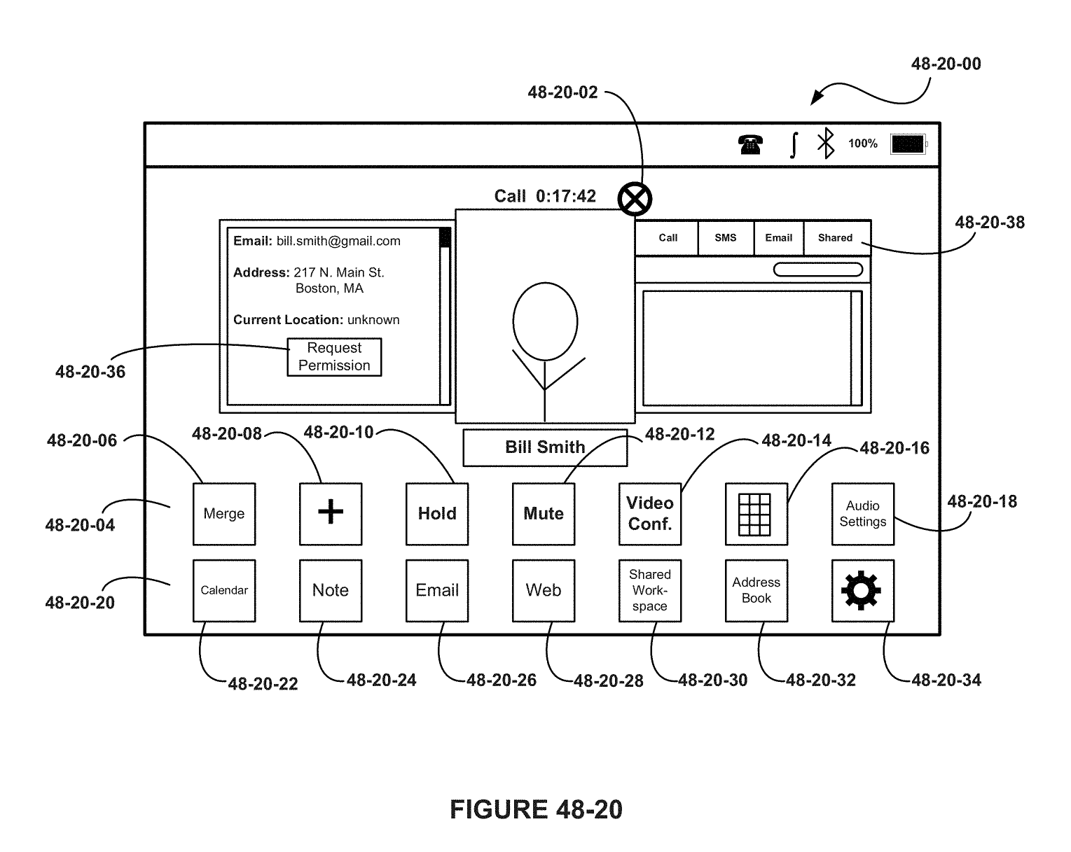

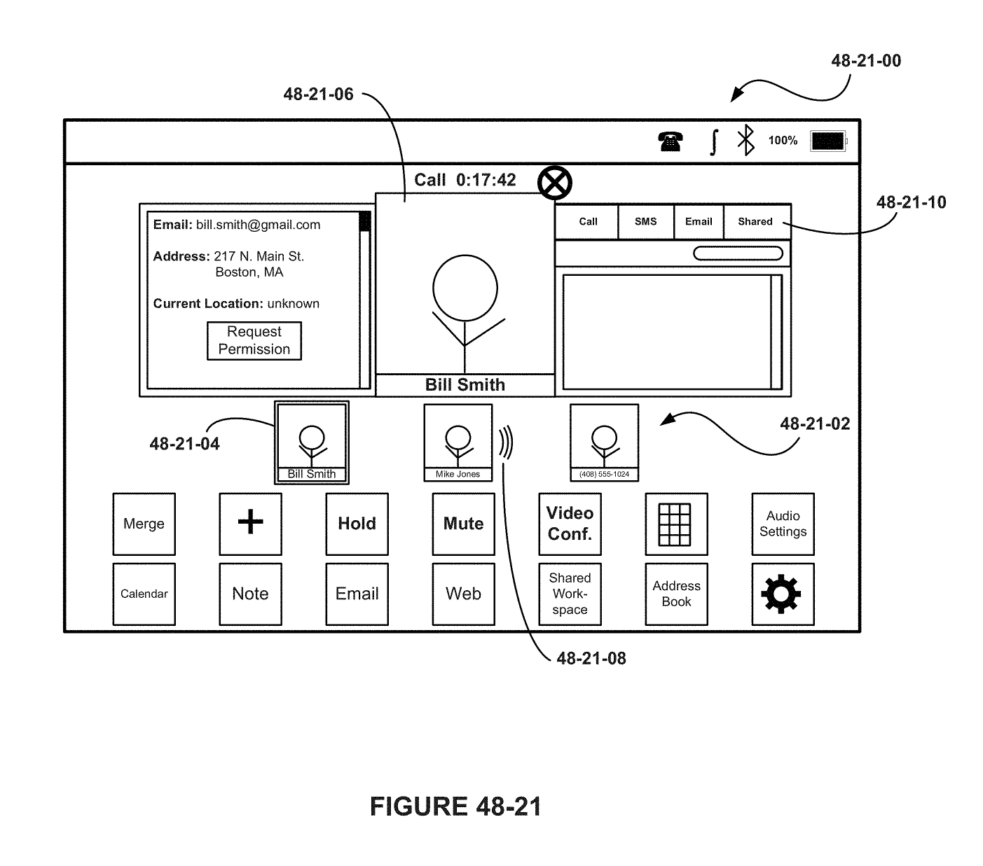

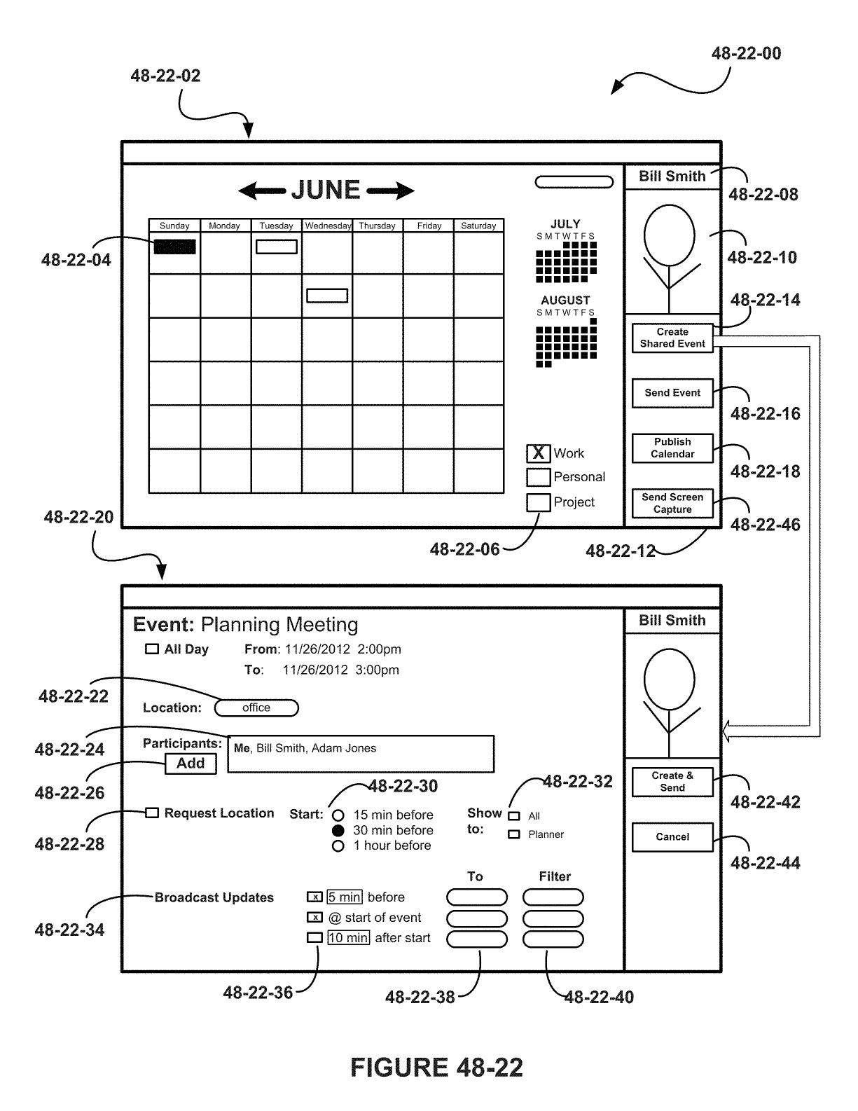

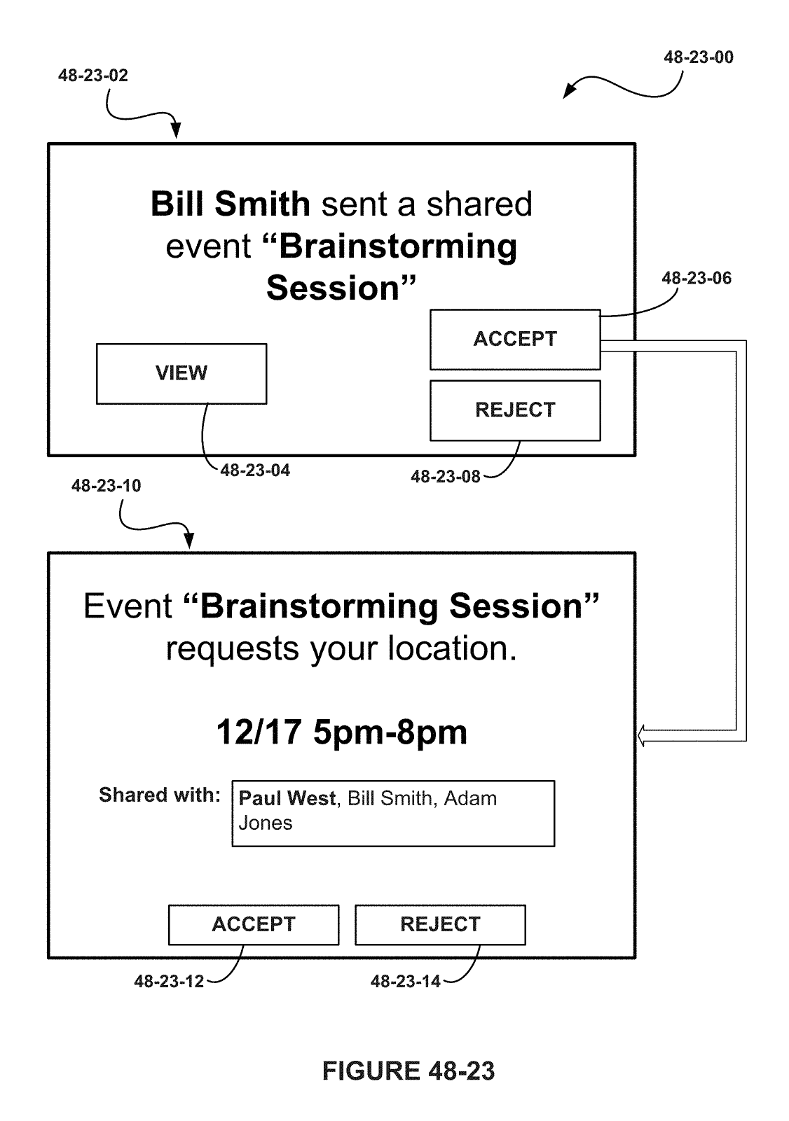

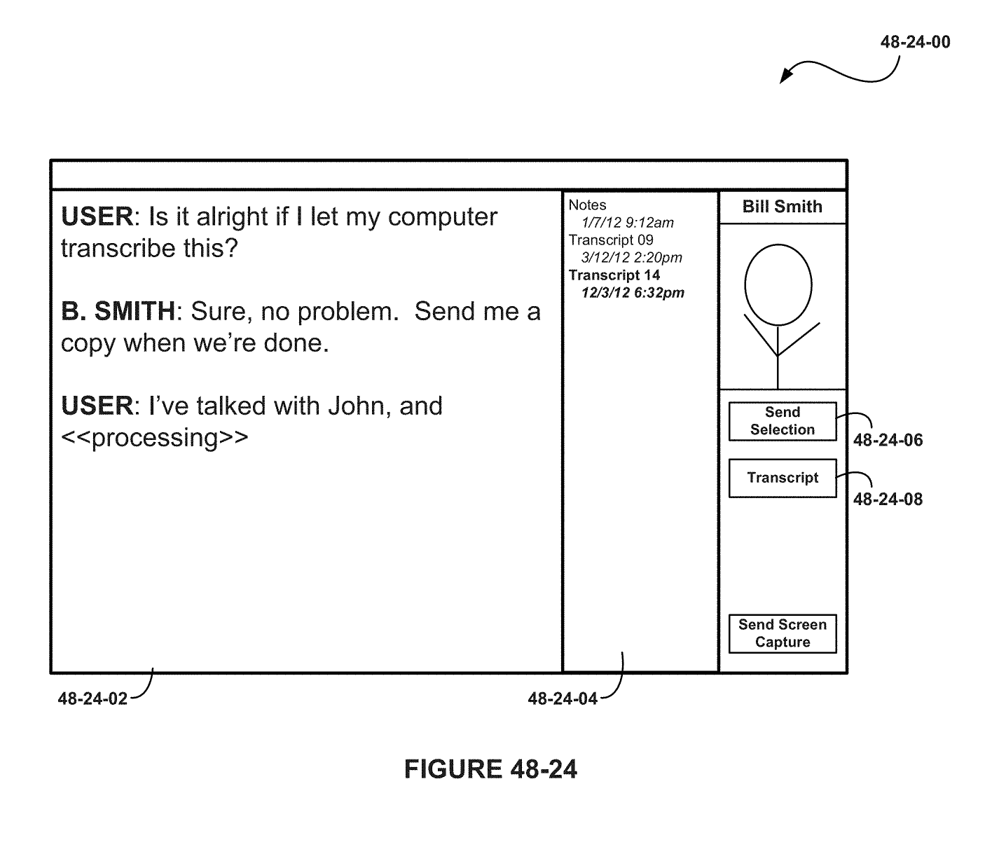

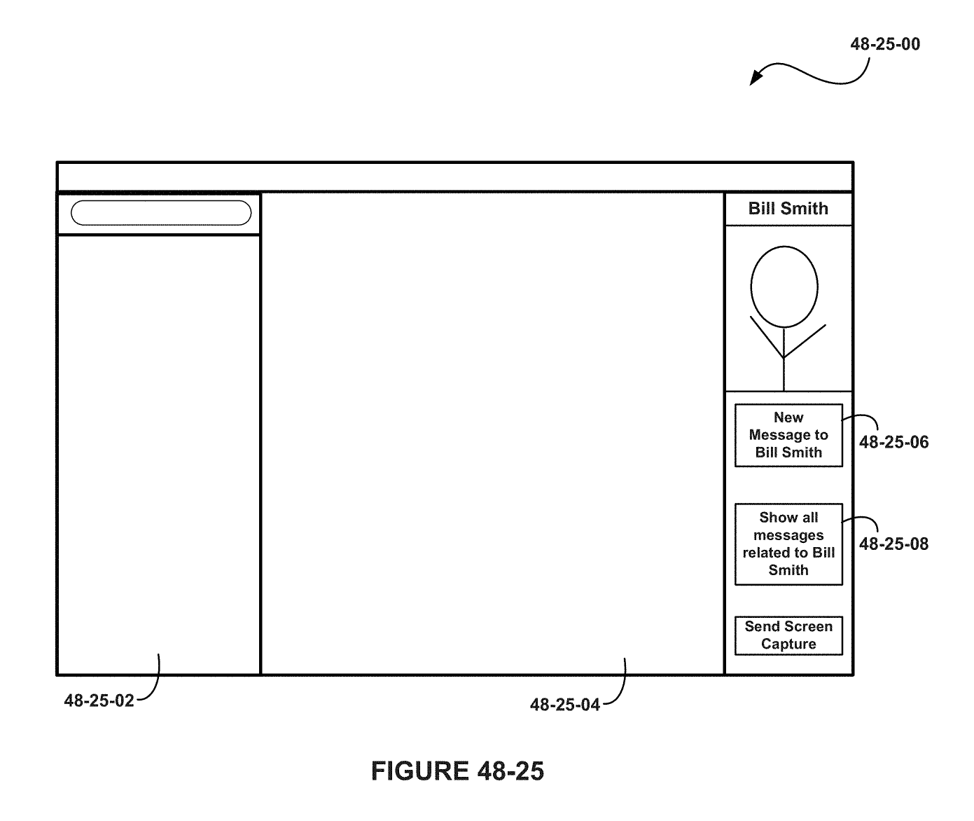

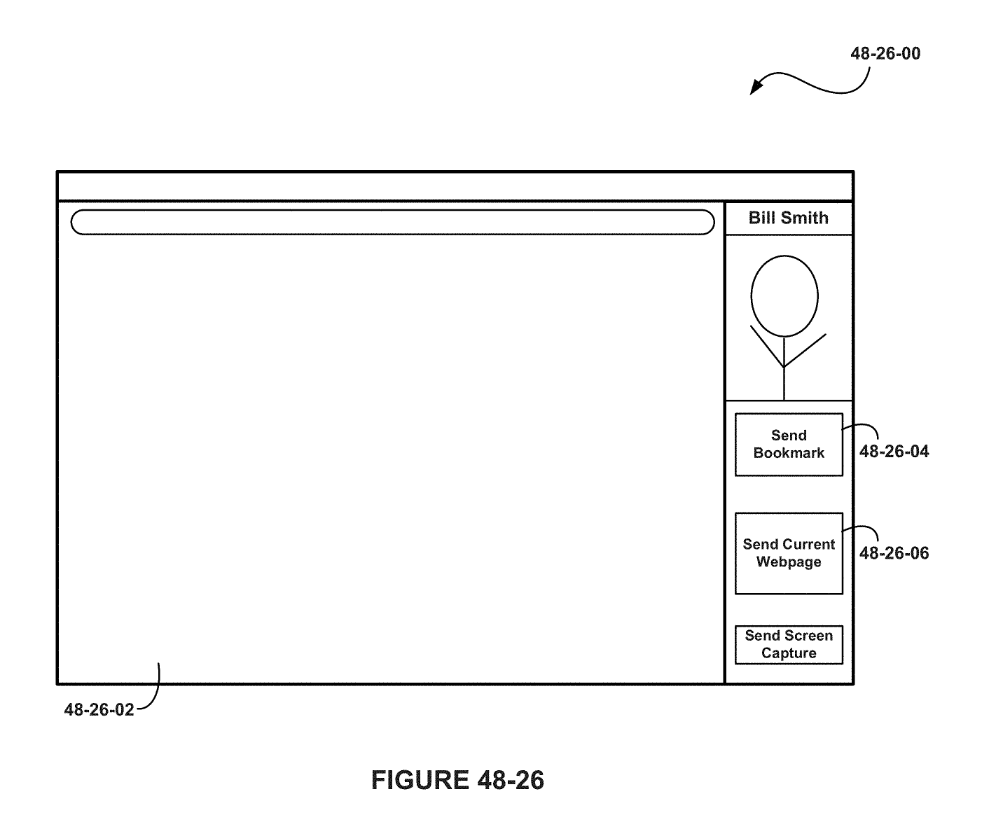

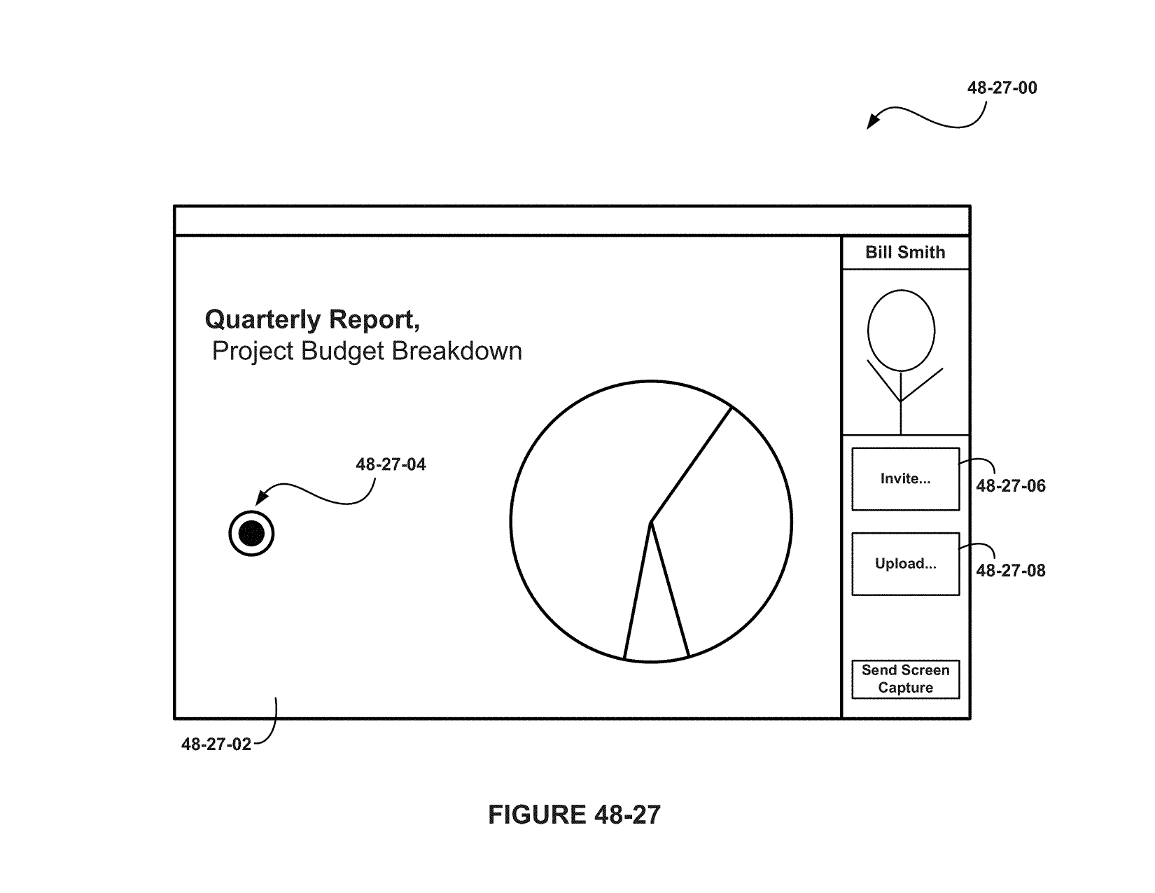

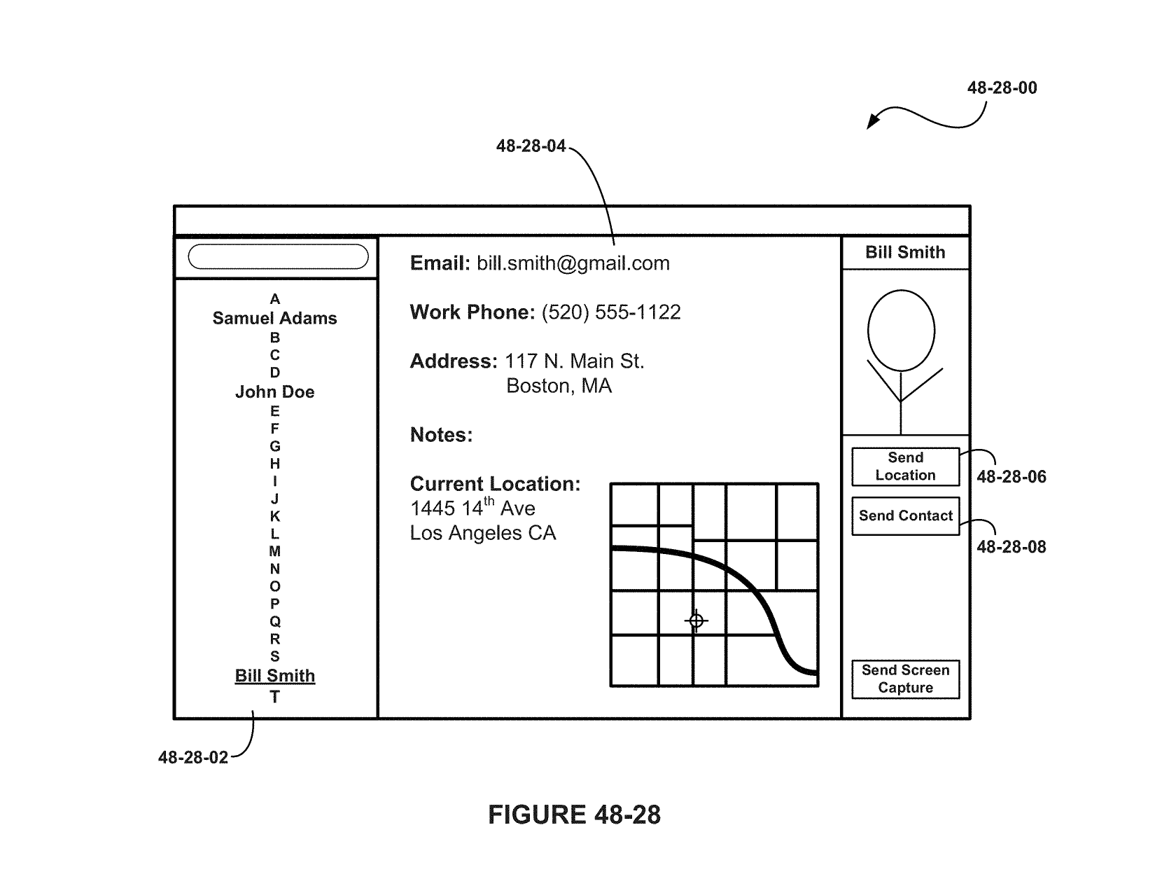

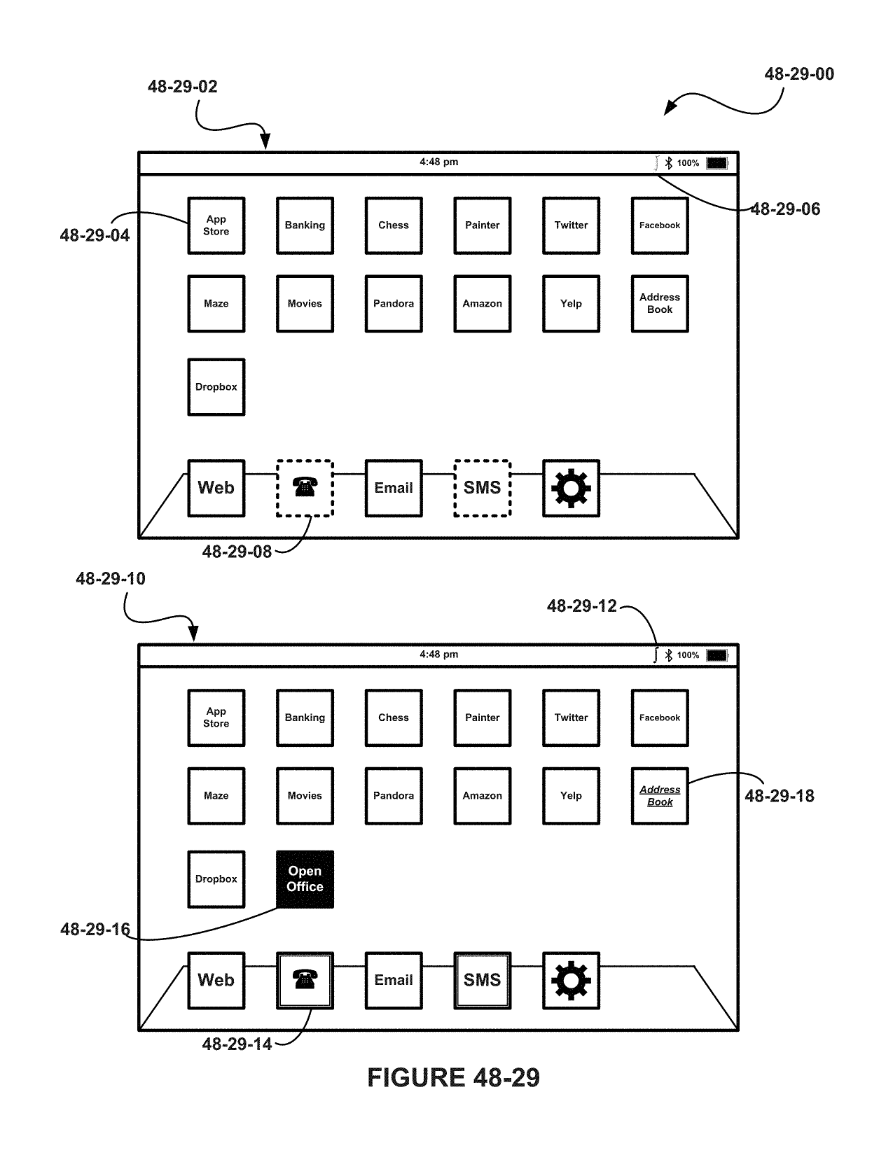

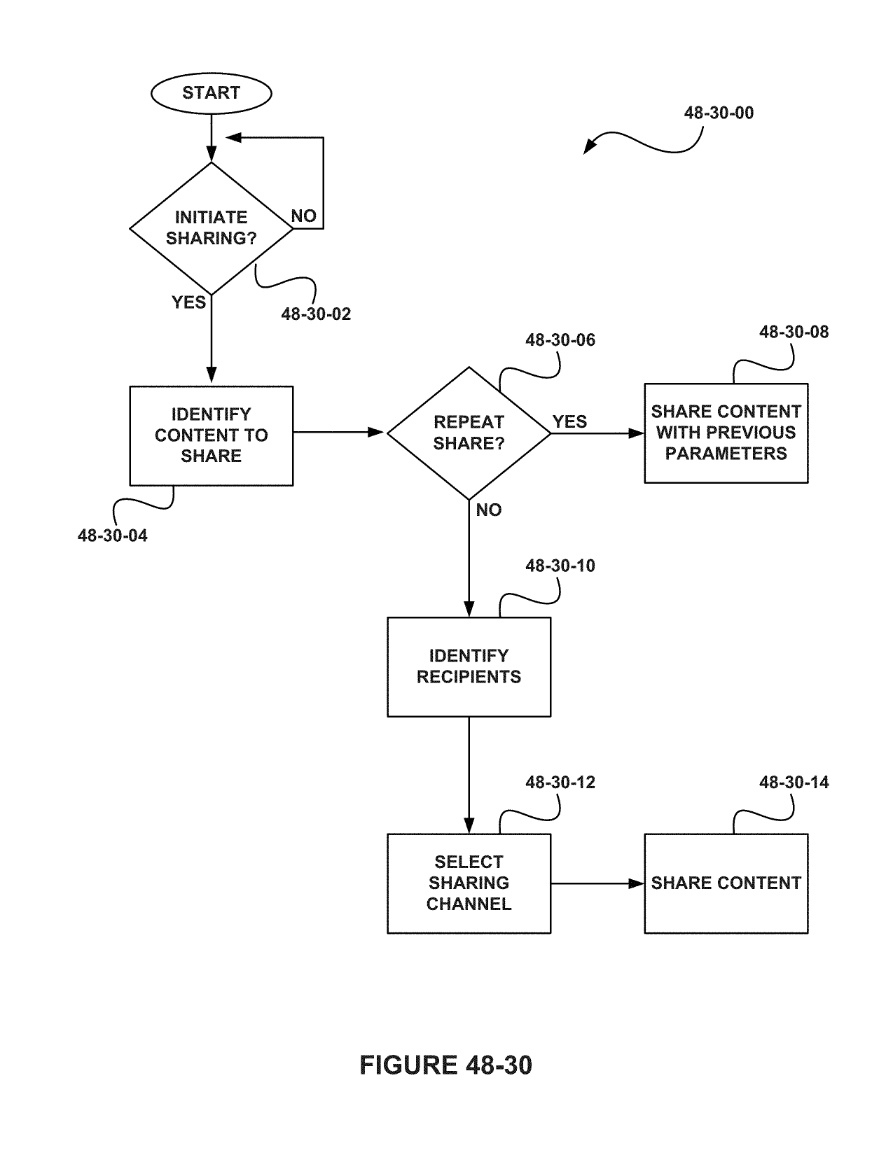

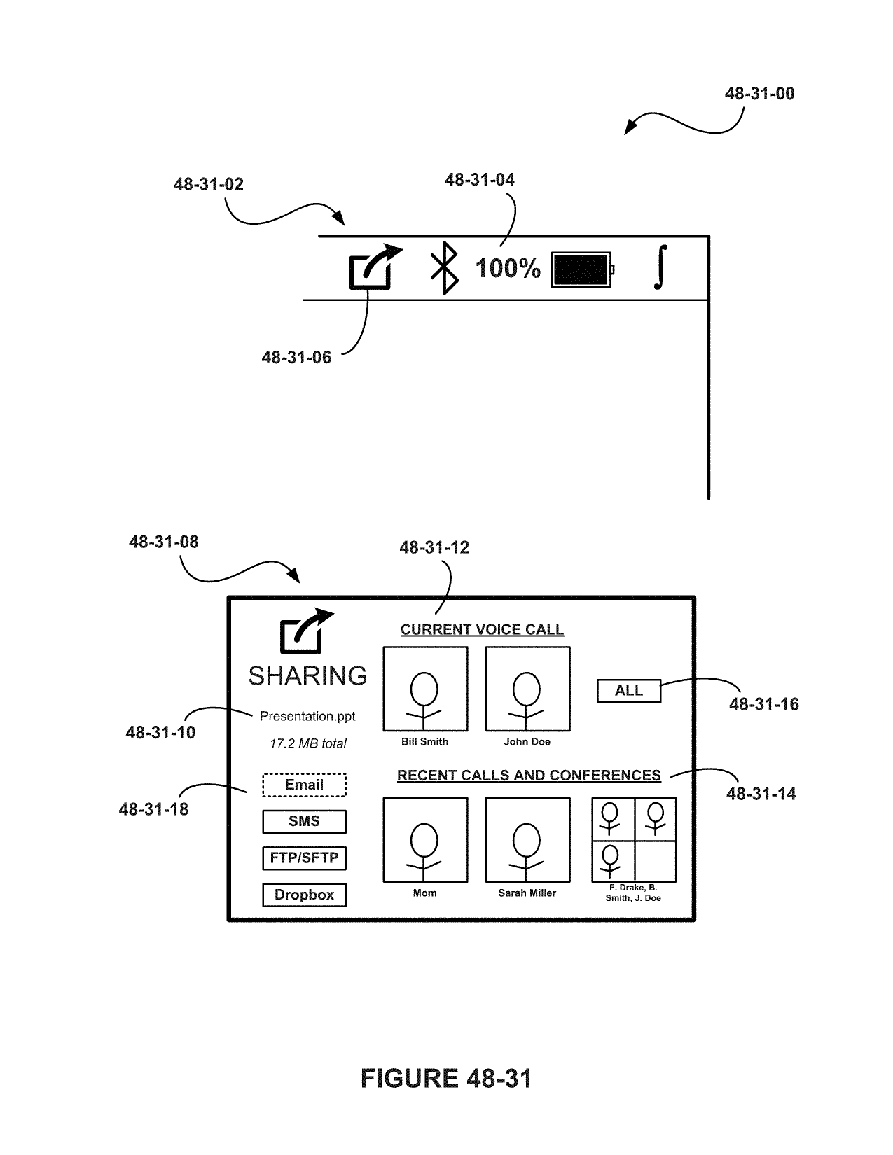

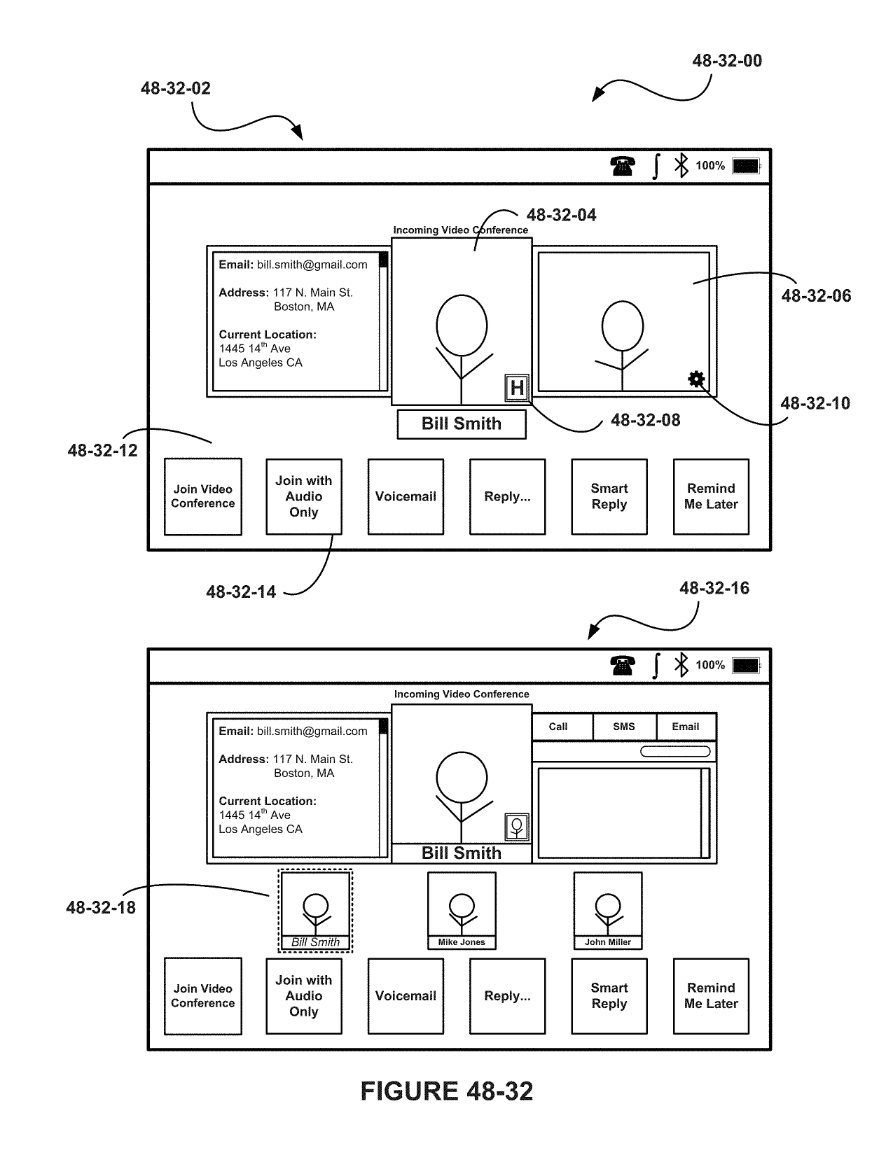

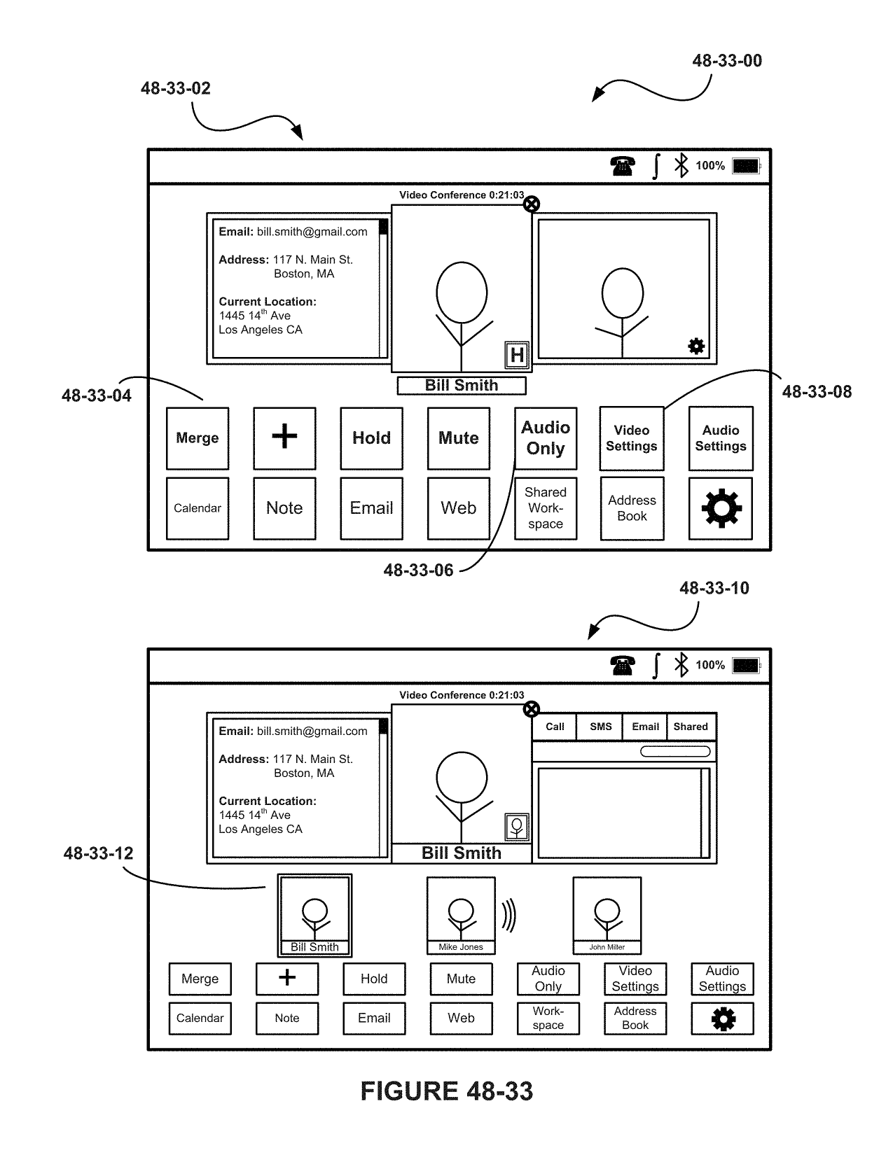

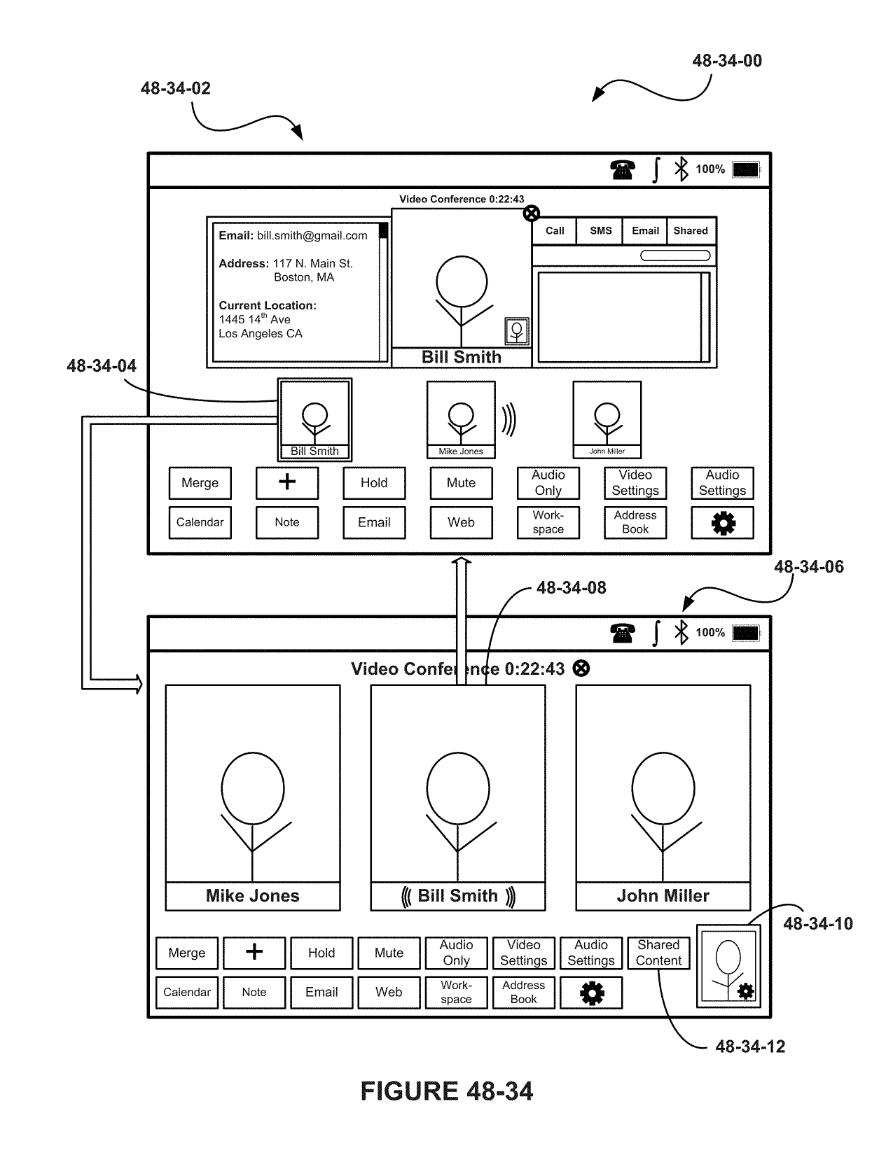

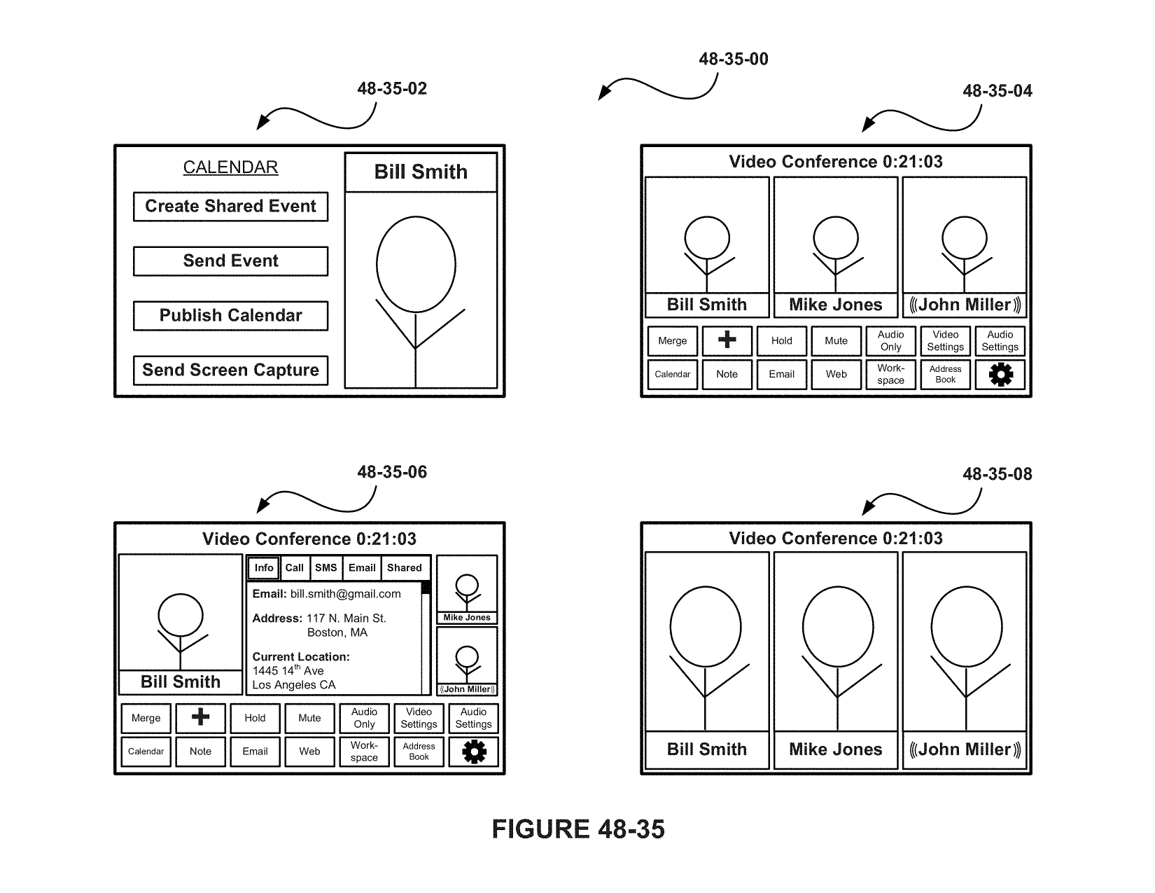

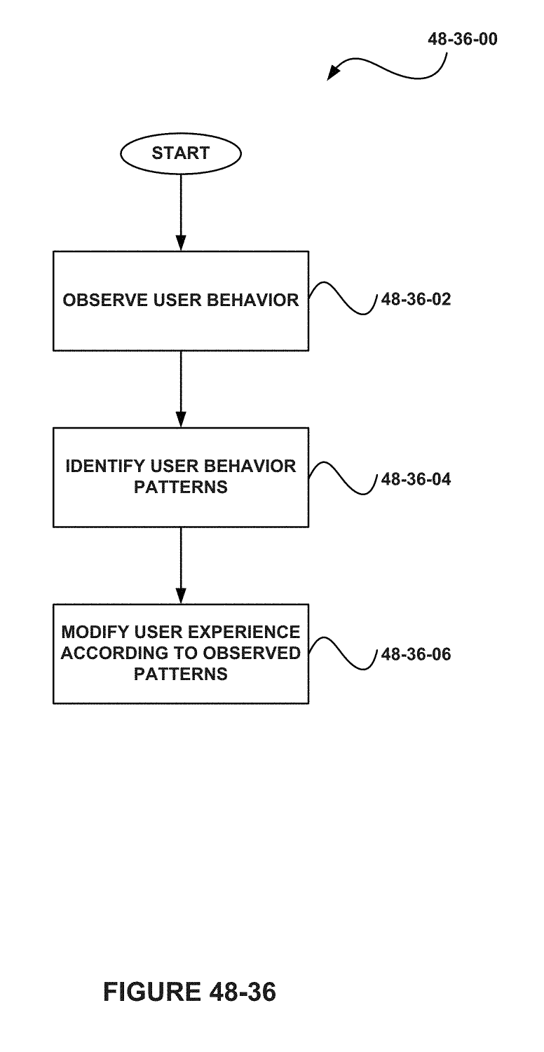

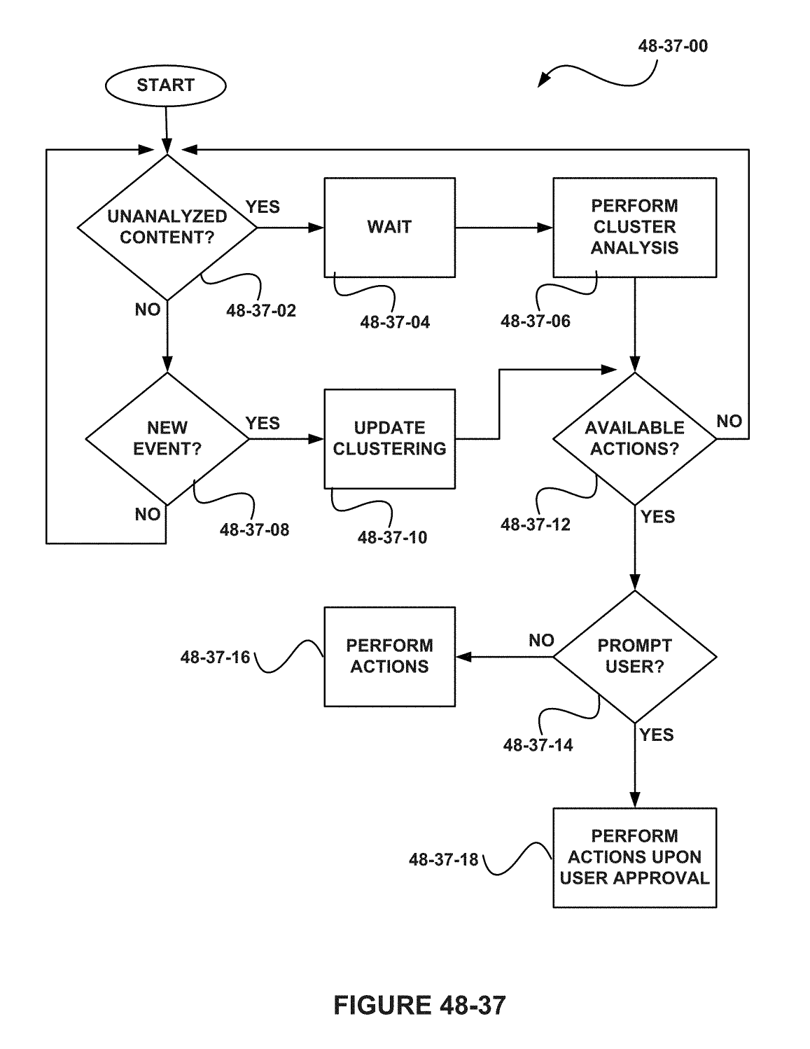

FIG. 48-1 illustrates a network architecture 48-1-00, in accordance with one embodiment. As shown, a plurality of networks 48-1-02 is provided. In the context of the present network architecture 48-1-00, the networks 48-1-02 may each take any form including, but not limited to a local area network (LAN), a wireless network, a wide area network (WAN) such as the Internet, peer-to-peer network, etc.

Coupled to the networks 48-1-02 are servers 48-1-04 which are capable of communicating over the networks 48-1-02. Also coupled to the networks 48-1-02 and the servers 48-1-04 is a plurality of clients 48-1-06. Such servers 48-1-04 and/or clients 48-1-06 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 48-1-02, at least one gateway 48-1-08 is optionally coupled therebetween.

FIG. 48-2 shows a representative hardware environment that may be associated with the servers 48-1-04 and/or clients 48-1-06 of FIG. 48-1, in accordance with one embodiment. Such figure illustrates a typical hardware configuration of a workstation in accordance with one embodiment having a central processing unit 48-2-10, such as a microprocessor, and a number of other units interconnected via a system bus 48-2-12.

The workstation shown in FIG. 48-2 includes a Random Access Memory (RAM) 48-2-14, Read Only Memory (ROM) 48-2-16, an I/O adapter 48-2-18 for connecting peripheral devices such as disk storage units 48-2-20 to the bus 48-2-12, a user interface adapter 48-2-22 for connecting a keyboard 48-2-24, a mouse 48-2-26, a speaker 48-2-28, a microphone 48-2-32, and/or other user interface devices such as a touch screen (not shown) to the bus 48-2-12, communication adapter 48-2-34 for connecting the workstation to a communication network 48-2-35 (e.g., a data processing network) and a display adapter 48-2-36 for connecting the bus 48-2-12 to a display device 48-2-38.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

FIG. 48-3 shows a system 48-3-00 for sending a control message to a mobile phone utilizing a tablet, in accordance with one embodiment. As an option, the system 48-3-00 may be implemented in the context of the architecture and environment of the previous Figures or any subsequent Figure(s). Of course, however, the system 48-3-00 may be implemented in any desired environment. It should also be noted that the aforementioned definitions may apply during the present description.

As shown, a tablet computer 48-3-02 may be included. Additionally, a phone device 48-3-04 may be included.

In various embodiments, the tablet and the phone may be integrated together, allowing the user to utilize the resources of both devices through a unified interface. For example, in one embodiment, the user may operate the phone by causing the tablet to send a control message to the phone. In the context of the present description, a control message refers to a signal sent to a device to serve as a substitute for direct user input. Thus, integration requires some form of communication to occur between the tablet and the phone.

In one embodiment, the tablet and the phone may communicate by various techniques. For example, in one embodiment, the phone and the tablet may communicate wirelessly through an ad-hoc, or peer-to-peer, Wi-Fi network 48-3-06, a Bluetooth channel 48-3-16, or any other wireless protocol, such as Wireless USB or near-field. Additionally, in one embodiment, the tablet and phone may communicate through a network, such as a local area network or wireless local area network. Furthermore, in one embodiment, the tablet and phone may communicate via an external network, such as the internet, or through an external server, such as a cloud server 48-3-08.

Integration facilitates the synergistic use of both devices to perform a variety of tasks. For example, in one embodiment, a process running on the phone may make use of speakers 48-3-10 and/or microphone 48-3-12 coupled to the tablet. Furthermore, in one embodiment, the phone may utilize a Bluetooth headset 48-3-14 as an audio input/output device. In another embodiment, the phone may utilize the tablet as a Bluetooth audio input/output device, via Bluetooth connection 48-3-16.

FIG. 48-4 shows an exemplary system flow 48-4-00 for sending a control message to a mobile phone utilizing a tablet, in accordance with one embodiment. As an option, the exemplary system flow 48-4-00 may be implemented in the context of the architecture and environment of the previous Figures or any subsequent Figure(s). Of course, however, the exemplary system flow 48-4-00 may be implemented in any desired environment. It should also be noted that the aforementioned definitions may apply during the present description.

As shown, a phone and a tablet may send location data to a server (e.g. see Step 1). In the context of the present description, location data may include, but is not limited to, GPS coordinates, names and signal strength of detectable Wi-Fi networks, assigned IP address, and/or any other data which may be used to determine the location of the device.

In various embodiments, the location data is used to facilitate a user in utilizing the phone and the tablet together. In some embodiments, the phone and the tablet may be associated with the same user. In one embodiment, the phone and the tablet are associated with a single user. In another embodiment, one or both devices may be associated with a plurality of users. In still another embodiment, one of the devices may be a public device, able to be temporarily associated with any user. As an option, a user may be required to provide authentication before being able to utilize a public device.

In one embodiment, location data may be sent to the server at regular intervals. In another embodiment, location data may be sent to the server only when device movement has been detected. For example, transmission of location data may be triggered by device accelerometer data. In yet another embodiment, location data may be sent to the server only after the device has been in motion for a predefined amount of time. In this way, location data may be kept up to date while reducing the amount of power expended determining and transmitting the data.

In various embodiments, the location data of the phone and tablet are compared by the server. If it is determined that the phone and tablet are within some threshold distance from each other, a notification is sent to the tablet and the phone indicating an integration may be possible (e.g. see Step 2). In one embodiment, the threshold distance may be based on the average distance between two devices being used by the same person. In another embodiment, the threshold distance may be governed by the device with the least accurate method for determining its location. For example, if the method used to locate the tablet is only accurate to within 20 feet, while the method to locate the phone is accurate to within 2 feet, the threshold distance may be set to 20 feet. In still another embodiment, the threshold distance may be set by a user. For example, in one embodiment, the threshold distance may be set by the user using a user interface similar to FIG. 30 of the previous application.

In some situations, the location data sent to the server may not be accurate enough to consistently distinguish between instances where a user may wish to integrate the two devices from instances where the two devices are close, but functionally separate. For example, the phone and tablet may be near each other, but separated by a wall. In various embodiments, upon receipt of a notification from the server indicating that the phone and tablet are within a threshold distance from each other, the devices may further determine their functional proximity to each other (e.g. see Step 3). In the context of the present description, functional proximity (or functional distance) refers to the separation between the two devices weighted by their ability to be used simultaneously by the same user. In the previous example, the two devices separated by a wall, while physically close, would be functionally distant.

In one embodiment, functional proximity may be determined using RFID tags embedded within the devices. In another embodiment, functional proximity may be determined using an NFC signal. In still another embodiment, functional proximity may be determined by bumping the two devices together and comparing the accelerometer data at a server.

In other embodiments, the functional proximity may be determined using sound. For example, in one embodiment, the ambient noise heard by each device may be transmitted to the server, and compared. In another embodiment, functional proximity may be determined by one device emitting a series of tones in a pattern specified by a server, and the other device comparing the tones heard with a verification code received from the server. As an option, the tones may be ultrasonic.

In various embodiments, upon determining that the phone and tablet are within a threshold functional proximity to each other, each device must determine whether to proceed with an integration (e.g. see Steps 4 and 5). In some embodiments, a user may be notified of a potential integration with a nearby device, and prompted whether to proceed. For example, in one embodiment, a user may be notified of a potential integration through one or more device outputs, including but not limited to, sound, vibration, a LED light, a GUI notification on a device screen, and/or any other device output. In another embodiment, a user may authorize or refuse the potential integration using one or more methods of device input, including but not limited to, a GUI interaction, triggering an accelerometer (e.g. tapping a pattern), pressing a hardware button, a voice command, and/or any other form of user input. As a specific example, in one embodiment, a user may be able to be notified of a potential integration and accept said integration without having to look at the screen of a device. As an option, in one embodiment, this “no look” authorization of an integration may be limited to devices preselected by the user.

In various embodiments, one or both of the devices may proceed with an integration without requiring user input. For example, in one embodiment, one or both devices may notify the user of a potential integration, and proceed with the integration unless the user intervenes within a certain period of time. In another embodiment, a device may proceed with the integration if one or more conditions are satisfied. These conditions may include, but are not limited to, device location, the amount of time elapsed since an accelerometer registered device movement, device identity, time of day, day of the week, and/or any other condition.

Furthermore, a device may automatically refuse an integration if one or more conditions are satisfied, in various embodiments. These conditions may include, but are not limited to, whether the device is being used by a different user, whether the devices is being powered by a battery, and/or any other condition.

In other embodiments, the determination whether or not to automatically proceed with an integration may be based upon a predefined computer mode, such as the desktop computer and tablet modes discussed in the previous application. For example, in one embodiment, whether or not an integration is automatically performed may be defined in a user interface similar to that shown in FIG. 34 of the previous application.

A successful integration requires both devices to proceed. If either device refuses the integration, the process is halted. As a specific example, if a tablet charging on a desk and a phone in a user's hand are both notified that they could potentially integrate, the tablet may automatically proceed with the integration based upon its motionless state and the identity of the phone. However, if the user presses a ‘decline’ button on the phone, the process is cancelled. In various embodiments, one or more conditions may have to be satisfied before another integration may be attempted, once an integration has been refused. These conditions may include, but are not limited to, whether a preset time period has elapsed, whether the user has manually requested an integration at one or both devices, whether the devices have been separated by a preset distance since the refusal, and/or any other condition.

As shown, if both devices determine that the integration should be allowed, the devices engage in a handshaking process (e.g. see Step 6). In the context of the present description, a handshake process refers to any process used to establish at least one communication channel between the two devices. In various embodiments, a communication channel between the two devices may utilize any of a number of protocols and technologies, including but not limited to, Wi-Fi or other wireless LAN methods, wired LAN or any wired communication protocol, Bluetooth, ad hoc Wi-Fi or other forms of peer-to-peer communication, and/or any other form of inter-device communication. As an option, the communication channel used for the integration may be turned on at the start of the handshaking process. In this way, the channel is only active when needed, preserving battery power and providing additional security.

In various embodiments, the handshaking process may also include a form of authentication. For example, in one embodiment, a user may be prompted to enter a passcode or PIN in one or both devices, to further verify user intention to integrate. In another embodiment, authentication may only be required the first time two devices are being integrated. As a specific example, the previously unknown tablet may display a passcode for the user to enter into their phone, to verify that this tablet should be trusted in the future.

Optionally, authentication may be required only in particular circumstances. For example, in one embodiment, authentication may only be required when integrating with previously unknown devices. In another embodiment, authentication may be required only when the integration is being performed away from one or more predefined locations, such as home and work. In still another embodiment, authentication may be required when using particular protocols, such as Bluetooth. Additionally, handshaking without authentication may be allowed in other circumstances. In one embodiment, authentication may not be required if both devices are on a wireless network previously designated as ‘trusted’. In another embodiment, authentication may not be needed if the integration prompt was manually selected by the user on both devices. As an option, a user may define the circumstances in which authentication may or may not be required.

As shown, once the devices are able to communicate, an integration profile is implemented (e.g. see Step 7). In the context of the present description, an integration profile refers to a predefined set of parameters for the integration being formed. For example, in one embodiment, an integration profile may include a collection of contextual triggers associated with one or more use scenarios for the tablet/mobile phone integration. These triggers may include, but are not limited to, location, the identities of the devices, time of day, day of the week, detectable wireless networks, the presence of one or more peripheral devices, accelerometer data, computer mode of one or both devices, and/or any other information which may be used to describe a use context for a tablet/mobile phone integration. In another embodiment, an integration profile may serve as a default profile with no contextual triggers specified.

In some embodiments, an integration profile may include preferences regarding the conditions under which an integration may be performed without user input. For example, in one embodiment, each device may refer to one or more integration profiles to determine whether to proceed with an integration without user input, or whether user input is needed (e.g. see Steps 4 and 5).

In a further embodiment, an integration profile may include one or more parameters describing the integration. For example, in one embodiment, an integration profile may specify what role the mobile phone will play in the integration. In various embodiments, the role of an integrated mobile phone may include, but is not limited to, a mouse, a trackpad, a camera, a keyboard, a customized input device, a display, a speaker, a microphone, and/or any other device role. In another embodiment, an integration profile may specify the role of the integrated tablet.

In yet another embodiment, an integration profile may specify what devices will be used for the various input and output functions of the integration. For example, in one embodiment, an integration profile may specify the method of various outputs and inputs, including, but not limited to, audio, display, and camera. In another embodiment, an integration profile may specify an ordered list of preferred input and output options. In some embodiments, input and output options may be specified globally. In other embodiments, an integration profile may specify particular input and output parameters for particular activities, such as phone calls and video conferences. As an option, other parameters associated with phone calls and video conferences may also be specified in the integration profile, as will be discussed later. In still another embodiment, an integration profile may specify policy regarding the offloading of a virtual machine or virtual applications from the phone to the tablet.

In various embodiments, multiple integration profiles may be associated with a device. In one embodiment, the process of selecting an appropriate integration profile to implement includes checking for conflicting profiles. In the context of the present description, conflicting profiles refers to two or more profiles whose contextual triggers are identical. In some embodiments, profiles whose triggers are a more specific subset of another profile's triggers may be allowed.

In some embodiments, integration profiles may be predefined by a user. The integration profiles themselves may come from different sources. In one embodiment, each device may store one or more integration profiles. The process of integration may include combining both sets of profiles, resolving any conflicts, and providing both devices with an updated set of profiles. As an option, a device may have different sets of integration profiles associated with different users. In another embodiment, the integration profiles may be stored on an external server, such as a cloud server. The maintenance of a single set of profiles prevents conflicts which could potentially slow down the integration process. Additionally, a user may be able to create or modify an integration profile using a web interface and/or a local application.

In one embodiment, the implementation of an integration profile may include storing one or more settings associated with one or both devices in their pre-integrated state. For example, in one embodiment, the devices may store the audio volume setting for both devices before implementing an integration profile which specifies a new volume. Upon disintegration, the devices may be restored to their individual former volumes. Other settings which may be stored may include, but are not limited to, volume, display brightness, security settings (e.g. time before autolock, passcode requirement, etc.), active application, network settings, display orientation lock, and/or any other setting, property, or parameter associated with the devices.

In various embodiments, after the devices are able to communicate and an integration profile has been implemented, one device may transfer one or more active processes to the other device. In one embodiment, this transfer may be performed via the live migration of a virtual machine or virtual application (e.g. see Step 8). This would allow a user to take advantage of resources which were unavailable before the integration without interrupting tasks. These resources may include a larger screen, greater processing power, enhanced I/O capabilities, or even better battery life.

In one embodiment, the live migration of a virtual machine or application may be performed by transferring the virtual machine or application over a communication channel established by the handshake. In another embodiment, the live migration may take place via a server, such as a cloud server. As an option, network connections from both devices may be routed through the cloud server, such that they may retain their distinct network addresses while preventing any disruption of an ongoing host-client or peer-to-peer session after the migration.

In some embodiments, a user may be prompted whether they wish to migrate one or more active processes to the other integrated device. In one embodiment, the prompt may appear on the device where the process is running, informing the user of expanded resources available on the other device. In another embodiment, the prompt may appear on the device with the larger display. In still another embodiment, the transfer may be automatic after the handshaking is completed. In yet another embodiment, the user may predefine specific applications, application types (e.g. games, video conferencing, etc.), or functionality to be automatically migrated after handshaking, without further user input. Of course, in one embodiment, these preferences may be specified in the definition of a computer mode, as discussed in the previous application, or in the integration profile implemented in Step 7.

While operating as part of a tablet/mobile phone integration, the mobile phone will periodically send a device status report to the tablet (e.g. see Step 9), in accordance with one embodiment. In the context of the present description, a device status report refers to information regarding the present capabilities of a device. These capabilities may include, but are not limited to, battery charge, cellular signal strength, communication capacity (e.g. ability to place and receive phone calls, SMS messages, etc.), peripheral devices such as a Bluetooth earpiece, and/or any other device capability. In some embodiments, the device status may be updated periodically. In other embodiments, at least a portion of the device status of the phone may be displayed in a user interface on the tablet.

Once a tablet and phone are integrated, they may serve roles distinct from those served when operated while apart. For example, in one embodiment, the tablet may serve as a display, while the phone may serve as a mouse, as depicted in FIG. 36c of the previous application. However, there may also be some roles which do not change. For example, in another embodiment, while the phone is being used as a mouse, it may also continue to run an application, or receive phone calls or SMS messages. In various embodiments, the tablet may be utilized to interact with the phone, without disrupting the way the phone is utilized in the integration.

As shown, a phone event summary is sent from the phone to the tablet (e.g. see Step 10), in accordance with one embodiment. In the context of the present description, a phone event refers to any event local to the integrated phone. Examples may include, but are not limited to, incoming phone calls, incoming SMS messages, system notifications, application notifications, dialog boxes and other user prompts spawned by processes running on the phone, and/or any other type of event or prompt associated with the phone.

Furthermore, in the context of the present description, a phone event summary refers to the data used to communicate the phone event to the user and elicit a response, if necessary. For example, in one embodiment, a phone event summary for an incoming phone call may include, but is not limited to, the phone number, caller ID information, and contact info (e.g. name, photograph, etc.) associated with the incoming call.

In another embodiment, a phone event summary for a SMS message may include, but is not limited to, the text of the message, the sender's identification (e.g. name, phone number, photograph, etc.). In yet another embodiment, a phone event summary for a system or application notification may include the text of the notification, and an icon representing the source of the notification. In still another embodiment, a phone event summary for a dialog box or other user prompt may include, but is not limited to, the text of the prompt, the user's options, and an icon representing the source of the prompt.

In other embodiments, a phone event summary may be a link which may be used to initiate real-time sharing of the phone display with the tablet. In one embodiment, the transmission of this link may be triggered by the occurrence of an event local to the integrated phone. In another embodiment, this link may be sent once the integration is complete.

Once the phone event summary is received by the tablet, the user will be prompted for input, if necessary, and a control message will be sent to the integrated phone (e.g. see Step 11), in accordance with one embodiment. In the context of the present description, a control message refers to a signal sent to a device to serve as a substitute for direct user input. One or more control messages may be sent in response to the receipt of a phone event summary. Additionally, one or more control messages may be sent without requiring the receipt of a phone event summary. In some embodiments, the type of control message sent to the mobile phone may vary depending upon the nature of the phone event summary and the form of user input requested.

In one embodiment, a control message may consist of an acknowledgement. For example, in one embodiment, where the phone event summary describes a notification generated by the mobile phone operating system or an application running on the mobile phone, the control message sent in response may comprise an acknowledgement that the user had been notified. In one embodiment, this reply may be sent automatically. In another embodiment, this reply may be sent only after the user has dismissed the notification. In this way, the mobile phone may remove the notification from a notification history local to the phone, having been assured that the user was notified and the notification dismissed. In some embodiments, the phone event summary may be presented to the user in the same manner as notifications local to the tablet. In other embodiments, the phone event summary may be presented to the user in a manner which indicates that the notification is local to the mobile phone. Of course, phone event summaries may be presented to the user in other forms, according to various embodiments.

In another embodiment, a control message may consist of one or more commands to be executed on the phone. For example, in one embodiment, where the phone event summary describes a dialog box generated on the mobile phone, the control message sent in response may include an indication of the button selected. As another example, where the phone event summary describes an incoming phone call, the control message sent in response may comprise a command to send the call to voice mail. In some embodiments, the phone event summary may be presented to the user by recreating the same event interface as would be seen on the phone. In other embodiments, the phone event summary may be presented to the user using an interface unique to the tablet, or the tablet/phone integration.

In yet another embodiment, a control message may consist of data describing a user's physical interaction with the tablet device. For example, in one embodiment, where the phone event summary includes a link used to initiate display sharing with the phone, the control message sent in response may include data generated by the user interacting with the tablet's touch screen. In this way, a user is not limited to interacting with phone applications designed to receive remote commands or notifications, but rather can operate the phone through the tablet as though using the phone itself. In some embodiments, the user may interact with the shared phone display in the same manner as they would interact with the actual phone. In other embodiments, the user may interact with the shared display using an input device not normally used with a phone, such as a mouse. As an option, the tablet may present the user with ways to execute multitouch gestures using a mouse cursor combined with some other form of input.

FIG. 48-5 shows an exemplary system flow 48-5-00 for sending a control message to a mobile phone utilizing a tablet, in accordance with another embodiment. As an option, the exemplary system flow 48-5-00 may be implemented in the context of the architecture and environment of the previous Figures or any subsequent Figure(s). Of course, however, the exemplary system flow 48-5-00 may be implemented in any desired environment. It should also be noted that the aforementioned definitions may apply during the present description.

In the context of the present description, an ad hoc integration between two devices refers to an integration initiated without an external server or preexisting network infrastructure. These external resources may be later utilized, but they are not required. In one embodiment, the ad hoc integration between a tablet and a phone may be completed without the need for any other device or infrastructure.

The ad hoc integration is initiated by some form of peer-to-peer discovery (e.g. see Step 1). For example, in one embodiment, a tablet may send a broadcast signal message using an ad hoc or peer-to-peer Wi-Fi protocol, which is received and acknowledged by the phone. In another embodiment, the peer-to-peer discovery may be as simple as physically connecting the two devices.

In various embodiments, the peer-to-peer discovery may include the transmission of a broadcast message, containing a device identifier. In some embodiments, this transmission may occur at a regular interval. In other embodiments, this transmission may be triggered by an event. Possible triggering events may include, but are not limited to, an increase in ambient light (e.g. a room light is turned on), an increase in ambient sound, being removed from a case, and/or any other event. In another embodiment, the triggering event and/or time interval may vary according to a predefined context, such as time of day, day of the week, location, whether the device is powered, and/or any other context.

Once the tablet and phone are aware of each other, the functional proximity may be determined (e.g. see Step 2). In addition to the methods for determining functional proximity previously discussed, ad hoc integration may also utilize the methods used to obtain location data (e.g. Step 1 of FIG. 48-4), except the data is sent directly to the other device, and not a central server. Of course, a server may also be utilized, in accordance with another embodiment.

In some embodiments, the determination of functional proximity may be conditionally performed, depending on whether the devices had previously been integrated. In one embodiment, a user may be prompted for permission to share location data with an unknown device to determine the potential for an integration. In another embodiment, functional proximity may be determined only for known devices, or if the user has requested the integration. In still another embodiment, the determination of the functional proximity may be performed solely on the user's known device; upon determining the devices are functionally proximate, the user's device may send an acknowledgement to the unknown device.

In other embodiments, the use of GPS data may be reserved for security purposes during the determination of functional proximity. A third party may attempt to gain access to a user's device by posing as a known device, which may be permitted to automatically integrate without user input. In one embodiment, the determination of functional proximity further entails the transmission of location data of a user's device, as well as the claimed identity of the other device, to a trusted external server. Upon receipt, the external server transmits a request to the other device, which responds with encrypted location data. The server may compare the two, and determine if the two devices are indeed at the same location. If they are not, the integration process is terminated. As an option, the user may be informed of the attempted integration.

As shown, once it is determined that the phone and tablet are functionally proximate to each other, each device must determine whether to proceed with an integration (e.g. see Steps 3 and 4). In one embodiment, the user's device may proceed with the integration without further confirmation, if the user has already provided input, such as granting permission to share location data or explicitly requesting an integration. In other embodiments, the determination may be made using the previously discussed methods.

If both devices determine that the integration should be allowed, the devices engage in a handshaking process (e.g. see Step 5) and implement an integration profile (e.g. see Step 6), as previously discussed.

In one embodiment, once the handshaking process is successfully completed, the two devices synchronize user data (e.g. see Step 7). In various embodiments, the user data which is synchronized may include, but is not limited to, contacts, calendars, tasks, notes, user preferences, bookmarks, stored passwords, and/or any other form of user data.

In various embodiments, after handshaking is done and the devices are able to communicate, one device may transfer one or more active processes to the other device. In one embodiment, this transfer may be performed via the live migration of a virtual machine or virtual application (e.g. see Step 8), as previously discussed.

The final step of the ad hoc integration of the two devices may include the periodic transmission of a device status from one device to another (e.g. see Step 9). Once the tablet and phone have been integrated, the phone may transmit phone event summaries to the tablet (e.g. see Step 10), which may respond with one or more control messages (e.g. see Step 11), in accordance with one embodiment.

FIG. 48-6 shows a method 48-6-00 for implementing an integration profile, in accordance with one embodiment. As an option, the method 48-6-00 may be implemented in the context of the architecture and environment of the previous Figures or any subsequent Figure(s). Of course, however, the method 48-6-00 may be implemented in any desired environment. It should also be noted that the aforementioned definitions may apply during the present description.

In various embodiments, the integration of a tablet and mobile phone proceeds according to an integration profile. In some embodiments, there may exist an external server, such as a cloud server, which possesses one or more integration profiles for the one or more devices associated with a user. As an option, this may be the server to which location data is reported in Step 1 of FIG. 48-4. In one embodiment, the selection of an integration profile to use in a particular situation may be made by an external server.

Alternatively, in another embodiment, the selection of an integration profile may be made by one of the devices being integrated. In one embodiment, the selection may be made after a communication channel has been established between the two devices. In the context of the present description, the device which makes this determination is referred to as the integration master, while the other device is referred to as the integration slave. In one embodiment, the device with the largest display (i.e. the tablet) may be used as the integration master, to facilitate user input. In another embodiment, the device most likely to be under the user's immediate control may be used as the integration master. As a specific example, if accelerometer data indicates that the mobile phone is being held by the user, while the tablet is stationary, the phone may be used as the integration master. In yet another embodiment, a user may specify which device to use as the integration master.

As shown, integration profiles and device specifications are sent from the integration slave to the integration master. See operation 48-6-02. In the context of the present description, device specifications refer to a description of the hardware and software capabilities of a device. In various embodiments, hardware capabilities may include, but are not limited to, display size, display resolution, power source (e.g. battery, power supply, etc.), battery charge, attached (i.e. wired) peripherals, paired (i.e. wireless) peripherals, audio output power and quality (e.g. frequency response, etc.), audio input sensitivity and quality (e.g. noise cancellation, etc.), camera resolution, cellular modem, and/or any other physical component associated with a device. Peripherals may include, but are not limited to, keyboards, mice, trackballs, trackpads, speakers, microphones, cameras, video cameras, and/or any other device which may be used in conjunction with a phone or tablet. In the context of the present description, software capabilities may include, but are not limited to, applications or programs capable of enabling video conferencing, VOIP communications, speech recognition, and/or any other software process, in accordance with one embodiment.

Once the integration profiles and device specifications have been received at the integration master, it is determined whether there are any conflicting integration profiles. See determination 48-6-04. In one embodiment, two integration profiles may be deemed conflicting if they require the same set of contextual triggers.

As shown, if it is determined that there are conflicting integration profiles, the conflicts are resolved. See operation 48-6-06. In one embodiment, a conflict between two integration profiles may be resolved by giving preference to the profile most recently defined or modified. In another embodiment, the user may be prompted to choose between two conflicting integration profiles. As an option, the user may be notified which profile is the most recent. In some embodiments, the resolution of a conflict results in the deletion of one of the integration profiles. In other embodiments, the resolution of a conflict does not alter the integration profiles, requiring a resolution be made every time the conflict arises. As an option, in one embodiment, only conflicts arising from the contextual triggers and device specifications at hand may be resolved, while the rest are ignored.

Once all conflicts have been resolved or ignored, the collection of integration profiles for both devices is updated. See operation 48-6-08. In one embodiment, the user may be prompted whether they wish to add new integration profiles to a device.

As shown, the integration master selects the most appropriate integration profile, based upon contextual triggers and device specifications. See operation 48-6-10. In the context of the present description, the most appropriate integration profile refers to the profile whose contextual triggers are most narrowly defined (and completely satisfied). In this way, general profiles may be defined for common situations, and be overridden in specific subsets of that situation.

Once an integration profile has been selected, the tablet and mobile phone store their current device settings. See operation 48-6-12. These settings may be restored to the devices once the integration has ended. The settings may include, but are not limited to, default audio input and output sources, volume, display orientation lock, display brightness, security settings (e.g. time before autolock, passcode requirement, etc.), active applications, network settings, and/or any other setting, property, or parameter associated with the devices. In another embodiment, the settings may include the active device computer mode, such as those disclosed in the previous application.

In one embodiment, all device settings may be stored. In another embodiment, only settings which will be changed by the implementation of the integration profile may be stored. In still another embodiment, settings which are stored, and then manually adjusted by the user while using the tablet/phone integration, may be deleted, allowing the user to adjust settings before disintegration. In yet another embodiment, a user may be prompted to indicate which settings to store for eventual restoration.

As shown, the selected integration profile is applied to the phone and tablet devices. See operation 48-6-14. In various embodiments, the application of an integration profile may include, but is not limited to, modifying audio inputs and/or outputs, modifying settings or preferences for specific applications (e.g. phone application, video conference application, etc.), adjusting volume, adjusting display brightness, and/or any other modification which may be specified in an integration profile.

FIG. 48-7 shows a method 48-7-00 for handling an incoming call utilizing a tablet/mobile phone integration, in accordance with one embodiment. As an option, the method 48-7-00 may be implemented in the context of the architecture and environment of the previous Figures or any subsequent Figure(s). Of course, however, the method 48-7-00 may be implemented in any desired environment. It should also be noted that the aforementioned definitions may apply during the present description.

In various embodiments, method 48-7-00 may be utilized for handling an incoming call. In one embodiment, the incoming call may be a voice call. In another embodiment, the incoming call may be an invitation to join a video conference. In still another embodiment, the incoming call may be an SMS message. FIG. 48-7- shows a method for handling an incoming call which is hosted on an integrated phone device (e.g. a call made using a cellular voice network, etc.). In some embodiments, a similar method may be utilized for handling an incoming call that is hosted on the integrated tablet device (e.g. a video conference, a VOIP-based call, etc.).

As shown, it is determined if there is an auto response rule which may be applied. See determination 48-7-02. In the context of the present description, an auto response rule refers to one or more predefined actions, whose automatic performance in response to an event is triggered by the satisfaction of a set of one or more contextual conditions or triggers. In one embodiment, one or more auto response rules may be defined for incoming calls.

In various embodiments, an auto response rule may be triggered based on the identity of the caller. For example, in one embodiment, an auto response rule may be defined such that it is used when a call is received from a particular entity, or one of a plurality of entities. In another embodiment, an auto response rule may be triggered when a call does not originate from a particular entity, or one of a plurality of entities. As a specific example, an auto response rule may be defined such that a call from someone not in the users list of contacts is silently sent to voice mail without requiring user input. Of course, in other embodiments, an auto response rule may require the existence of more than one contextual trigger.

In various embodiments, an auto response rule may be triggered based on the user's calendar. For example, in one embodiment, an auto response rule may be defined such that it is only used if the user's calendar indicates that a particular event is currently occurring. As a specific example, an auto response rule may be defined such that if the user's calendar indicates that a meeting is in progress, an automatic response may be made for all incoming calls.

In one embodiment, an auto response rule may be defined such that it is triggered during any event whose calendar data contains an event name, event location, or note containing one or more specific text strings (e.g. “meeting”, “mtg”, etc.). In another embodiment, the contextual trigger for an auto response rule may be based on the known participants of a calendar event. For example, an auto response rule may be defined such that all incoming calls will receive an automatic response during a scheduled meeting, unless the call is from someone who was supposed to be in the meeting. In yet another embodiment, an auto response rule may be triggered by the occurrence of a particular class of event, where the event class may be defined when the event is created in the calendar.

In another embodiment, an auto response rule may be defined such that it is triggered based on event data obtained from a source other than the user's calendar. For example, in one embodiment, data obtained from an electronic transaction made by the user (e.g. purchasing movie or event tickets, making restaurant reservations, etc.) may be used to schedule the use of a particular auto response rule. Said data may originate from the user's device, from an external server, or any other source.

In various embodiments, an auto response rule may be triggered by the location of the user's device. For example, in one embodiment, an auto response rule may be defined such that it is triggered when the user is at a user-defined location (e.g. home, office, church, etc.). In another embodiment, an auto response rule may be defined such that it is triggered when the user is at a particular type of location, where the type of the device's present location does not have to be specified by the user. As a specific example, an auto response rule may be defined such that it is utilized whenever it is determined that the user is inside a movie theater.

In some embodiments, an auto response rule may be triggered by the actual location of the device, as determined using GPS or other methods. In other embodiments, a rule may be triggered by the relative location of the device, as determined by the presence of identifying signals (e.g. RFID, NFC, etc.). As a specific example, a rule may be defined such that it is utilized whenever the device detects the presence of an RFID tag associated with the user's car.

In various embodiments, an auto response rule may be triggered by device motion. For example, in one embodiment, an auto response rule may be defined such that it is used whenever the user device is moving faster than a person can walk (i.e. the user is in a moving vehicle). In another embodiment, an auto response rule may be defined such that it is used whenever the device accelerometer data indicates the user is jogging or running. Device motion may be determined using location data such as GPS coordinates, accelerometer data, and/or any other method for determining motion or velocity.

In various embodiments, an auto response rule may be triggered based upon what applications are running on the users device. For example, in one embodiment, an auto response rule may be defined such that it is used whenever the user watching a streaming movie. Other example applications may include, but are not limited to, video conferencing applications, fitness applications, video and/or audio recording, and/or any other application.

In various embodiments, an auto response rule may be triggered based upon the time of day. For example, in one embodiment, an auto response rule may be defined such that it is only applied between the hours of 9 pm and 7 am. In another embodiment, an auto response rule may be defined such that it is only applied on weekends.

In various embodiments, an auto response rule may be triggered based upon the computer mode of one of the integrated devices, as described in the previous application. For example, in one embodiment, an auto response rule may be defined such that it is only applied when the integrated tablet is being used in a desktop computer mode.

In various embodiments, the use of an auto response rule may be conditioned upon user input. For example, in one embodiment, an auto response rule may be defined such that it may only be applied when the user has switched the phone to a “silent” mode (e.g. turned the ringer off, etc.).

Auto response rules may be associated with one or more responses. Responses may include, but are not limited to, sending a call to voice mail, responding to a call with an SMS message, responding with an email message, causing a ringer to go silent, and/or any other manner in which a user might respond to an incoming call.

Not only may the auto response rules be implemented depending upon the existence of predefined contextual triggers, but the content or nature of the response itself may vary depending upon context. In various embodiments, a response may vary depending upon the identity of the caller. For example, in one embodiment, response content may be personalized using the caller's name or predefined nickname. In another embodiment, the type and amount of information conveyed in a response may depend upon the caller's identity. As a specific example, an auto response rule may be defined such that all calls received during a scheduled meeting receive an automatic response via SMS, where all callers are informed that the user is unavailable, except for the user's spouse, who is informed that the user is in a meeting until 3 pm.

In various embodiments, a response may vary depending upon the user's schedule. For example, in one embodiment, a response may include what the user is presently doing. In another embodiment, a response may indicate when the user will be available (e.g. the next opening in the user's schedule, a scheduled time to return calls, etc.). In yet another embodiment, a response may vary depending upon the identities of scheduled event participants and the identity of the caller. As a specific example, an auto response rule may be defined such that all calls received during a scheduled event receive an automatic response via SMS, where all callers are informed that the user is unavailable, except for scheduled event participants, who are given an update as to the location of the event.

In various embodiments, a response may vary depending upon the user's location. For example, in one embodiment, a response may include the user's current location. In other embodiments, a response may vary depending upon the motion of the user's device. For example, in one embodiment, a response may indicate that the user is currently driving. As a specific example, an auto response rule may be defined such that a call from a predefined group of users will receive an automatic response that indicates that the user is driving, and reports their estimated arrival time to a predefined location or scheduled event location (e.g. “I'm driving, and am 12 minutes from home”, etc.).

In various embodiments, a response may vary depending upon the currently running application, or data obtained from a running application. For example, in one embodiment, a response which indicates a user's estimated time of arrival may also indicate whether the user is stuck in traffic, as determined by a navigation application. In another embodiment, a response may indicate the user's current activity (e.g. “I'm watching a movie, I'm jogging, etc.). Of course, the sharing of this information may be limited to a predefined list of callers.

In some embodiments, the responses attached to an auto response rule may be text-based messages (e.g. SMS, email, etc.). In other embodiments, the attached responses may be audio (e.g. prerecorded messages, messages generated using text-to-speech, etc.) or video (e.g. prerecorded video messages, computer generated video messages, etc.). In one embodiment, the format of the response may be determined by the format of the incoming call (e.g. a voice call responded to with a voice message, a video call responded to with a video, etc.).

In various embodiments, a response may include the use of a service allowing the caller to leave a message (e.g. voice mail, video messaging, etc.). For example, in one embodiment, a response may include an outgoing message whose content is specified by the auto response rule, coupled with a prompt for the caller to leave their own message. In some embodiments, the message recording service may be hosted on the user's device (e.g. simulating an actual call, but recording the callers message for later playback). In other embodiments, the message recording service may be hosted externally, including on an external server, through a third party service provider, the user's cellular network provider, and/or any other entity.

In some embodiments, a response may be predefined by the user. In other embodiments, a response may be predefined by a third party. In still other embodiments, a response may be defined by software, based upon observed user behavior. For example, in one embodiment, a record may be kept of all user interactions with their devices. These records may be used to find repeated behaviors, and examine the context associated with the behaviors. In one embodiment, when a correlation can be made between a context and a behavior, an auto response rule may be generated by the device.

In one embodiment, device generated auto response rules may reproduce user behavior patterns so far as they are predictable. As a specific example, a device may observe that the user never answers incoming calls during a scheduled meeting, but rather usually replies with a SMS message if the caller was in the user's contacts, and always replies with a SMS message indicating they are in a meeting and when they will be done if the caller was a family member. Upon observing this behavior repeated a predefined number of times, the device may generate two auto response rules for incoming calls received during a scheduled meeting, where caller identity is one of the triggers. Calls coming from a contact may result in the user being presented with an interface allowing an immediate response via SMS, while calls coming from family members may result in the same interface being presented to the user, but prefilled with a message indicating the meeting and when the user is free.

In some embodiments, the auto response rules may be defined and stored on the mobile phone and/or the tablet. In one embodiment, auto response rules may be defined, modified, and applied on devices even when they are not integrated. In another embodiment, auto response rules stored on each device are synchronized as part of integration. As an option, conflicting rules may be dealt with using the methods previously described for handling conflicting integration profiles. In other embodiments, auto response rules may be stored on a cloud server, which is accessed by each of the user's devices for an up-to-date set of rules. In one embodiment, these auto response rules may be defined and modified through the cloud server using a web interface.

In some embodiments, the determination x2502 as to whether an auto response rule should be applied may be based entirely upon the context surrounding the incoming call. In other embodiments, the determination may also be based, in part, upon user input. For example, in one embodiment, a user may disable one or more auto response rules, or one or more predefined groups of rules. As a specific example, a user may specify a group of auto response rules which are only to be available for application when the user has toggled a “silent” switch on one or both devices. In one embodiment, it may be possible for a user to enable or disable the entire auto response system with one or more user interactions.

If it is determined in 48-7-02 that an applicable auto response rule exists, it is then determined if the user should be notified. See determination 48-7-04. In one embodiment, a user may always be notified when an auto response rule is being applied. In another embodiment, the user may never be notified when an auto response rule is being applied.

In various other embodiments, a user may specify whether or not they are notified when an auto response rule is being applied. For example, in one embodiment, the auto response rule itself may contain instructions regarding whether to notify the user or not. As a specific example, a user may wish to be notified when their device automatically sends a message to a friends who called, but not be notified when sending a call from an unknown or blocked number directly to a special voice mail box. In another embodiment, a user may specify that they are always notified when a device generated auto response rule is being applied. In still another embodiment, a user may specify particular contexts (e.g. locations, times, days, computer modes, etc.) in which they are to be notified that an auto response rule is being applied, and contexts in which to never be notified (e.g. late at night, in movie theaters, etc.).

If it is determined in 48-7-04 that the user should be notified, the user is then notified that an auto response rule is being applied. See operation 48-7-06. In various embodiments, this notification may be made using a sound, vibration, flashing light, a device display, and/or any other method of alerting a user. In one embodiment, the notification is subtle, as to not overly disrupt the user experience with the device. As an option, the user may be told which auto response rule is being applied. In another embodiment, the manner of notification may depend upon the context. For example, the notification may be silent in a meeting, a vibration in a movie theater, and a sound while traveling. As an option, these contexts may be specified by the user.

As shown, once the user has been notified that an auto response rule is being applied, it is determined whether the user wishes to intervene. See determination 48-7-08. In various embodiments, the notification regarding the application of an auto response rule may be accompanied by an opportunity for the user to intervene before the response is made. For example, in one embodiment, the user may be given a particular amount of time to indicate they wish the event be handled differently. As an option, there may be a visual countdown provided. In another embodiment, the user may predefine the amount of time given to intervene. In still another embodiment, the user may be able to dismiss the countdown, and apply the auto response rule immediately.

If the user does not intervene, or if it is determined in x2504 that the user need not be notified, local tasks associated with the response are performed. See operation 48-7-10. In the context of the present description, local tasks refer to tasks which may be performed on the integrated tablet. In various embodiments, local tasks which may be associated with an auto response rule include, but are not limited to, sending an email or other message not explicitly requiring a cellular network, creating a reminder, and/or any other task which does not require sending a control message to a phone. Of course, in embodiments where the auto response rules are being utilized outside of an integrated environment, such as on a non-integrated phone, all tasks would be considered local.

As shown, a control message is sent to the phone. See operation 48-7-12. In various embodiments, an integrated tablet may send control messages to the integrated phone to perform tasks requiring hardware unique to the phone, such as sending a voice message to a caller, or an SMS message. In other embodiments, the integrated tablet may send a control message to the phone instructing it to perform a task which could have been performed by the tablet. The control message may take the forms previously discussed, or any other form of signal which may be used to control an aspect of the phone.

If it is determined in 48-7-02 that an auto response rule will not be applied, the user is prompted for a response to the incoming call. See operation 48-7-14. In one embodiment, the user may prompted using the phone display. In other embodiments, the user may be prompted using the tablet display. For example, in one embodiment, the user may be presented with a recreation of the phone user interface on the tablet display. In another embodiment, the user may be presented with a live transmission of the phone user interface on the tablet display. In still another embodiment, the user may be presented with a user interface, unique to the tablet, which displays all of the response options available to the user.

In various embodiments, the user may be presented with one or more response options as a result of an incoming call. Possible response options include, but are not limited to, answer the call, cause the incoming call notification (e.g. ringtone, vibration, etc.) to cease, refuse the call without sending to voice mail, send the caller directly to voice mail (or video mail, in the case of an incoming video conference call), create a reminder to contact the caller later, respond via SMS, respond via email, and/or any other possible response.

In various embodiments, the user may be presented with one or more predefined responses. For example, in one embodiment, the user may be presented with commonly used responses, such as “I'm on my way” or “I will call you later”. In another embodiment, the user may be presented with responses previously defined by the user. In still another embodiment, the user may be presented with the option to choose from recently sent responses. As an option, the choices may be limited to responses sent to that particular caller. In yet another embodiment, the user may be presented with one or more responses they have historically used most often for a particular caller, or in a particular context associated with the incoming call.

In one embodiment, the user may be presented with one or more responses or partial responses which are software generated, based on observed user behavior, similar to the device generated auto response rules previously discussed. In another embodiment, the user interface used to prompt the user for a response to the incoming call may be modified based upon observed user behavior. For example, in one embodiment, often chosen responses may have larger user interface elements than other responses. In another embodiment, the response options may be ordered and/or arranged on the user interface such that the most often used responses are easiest for the user to access.

In some embodiments, available responses may have a single, predefined form (e.g. text, voice, video, etc.). In other embodiments, a given response may be sent to the caller in a user selected form, whether as a prerecorded, device generated, or externally generated voice or video, or as some form of text-based message, or any other form a message may take.

In some embodiments, the user may be presented with response options based upon predefined auto response rules. For example, in one embodiment, the user may be presented with response options based upon an auto response rule whose contextual triggers are a partial match to the context surrounding the incoming call. As an option, a user may be able to specify how close a match the triggers must be before an auto response rule is presented as an option. In another embodiment, the user may be presented with responses generated by auto response rules which would have been applied, had the user enabled them.

In various embodiments, the user may be presented with context-sensitive response options. For example, in one embodiment, the content of the prepared responses available to the user may vary depending upon context, similar to responses generated by auto response rules, discussed earlier. In another embodiment, the user may be presented with multiple versions of the same response, varying by the amount of information conveyed. In this way, a user may easily choose between informing the caller they are busy, and informing the caller they are in a meeting which ends in an hour.

After the user has chosen a response, local tasks associated with the response are performed. See operation 48-7-10. In various embodiments, local tasks which may be associated with a user-selected response include, but are not limited to, answering a video conference call, activating a camera, turning on a light, pausing music or a video, activating Bluetooth devices or other peripherals, adjusting sound volume to a level appropriate for the selected response, sampling background noise in preparation for performing noise cancellation, and/or any other task. In other embodiments, local tasks associated with a user selected response may also include those associated with an auto response rule, as previously discussed. In yet another embodiment, the local tasks may include presenting to the user a user interface associated with actions available during a call.

As shown, a control message is sent to the phone as previously discussed. See operation 48-7-12.

FIG. 48-8- shows a method 48-8-00 for integrating a tablet with a mobile phone while a call is in progress, in accordance with one embodiment. As an option, the method 48-8-00 may be implemented in the context of the architecture and environment of the previous Figures or any subsequent Figure(s). Of course, however, the method 48-8-00 may be implemented in any desired environment. It should also be noted that the aforementioned definitions may apply during the present description.

On occasion, a user may have a call in progress on one device when they come close enough to another device for a potential integration. For example, a user may be speaking on their mobile phone when they sit down at a desk where their tablet is located.

In some embodiments, a device may refuse all integration attempts made during a call (e.g. integration does not proceed past Step 5 of FIG. 48-4-, etc.). In other embodiments, method 48-8-00 may be utilized to integrate the two devices without disrupting the call. Of course, in still other embodiments, this method may be used to integrate the devices without interrupting user activities other than an in-progress call, such as recording a video or viewing a movie.

As shown, it is determined whether to initiate integration. See determination 48-8-02. In some embodiments, this determination is similar to that made in steps 4 or 5 of FIG. 48-4 or steps 3 or 4 of FIG. 48-5, except it may be modified to avoid disrupting the user's call. For example, in one embodiment, if a user would normally have to interact with the phone to permit an integration, that permission may be sought through the tablet display instead, if the phone is being used for a call. In another embodiment, this may be accomplished by passing a message to the tablet through an external server, such as the server which receives location data. As an option, the user may be prompted to enter a password. In this way, accidental or malicious integrations may be prevented.

In another embodiments, all integration prompts that would have been presented to the user via the phone may be routed through a non-integrated tablet if the phone is being used for a call. This may be accomplished using a peer-to-peer connection between the two devices. In one embodiment, this connection may be limited in functionality, such that only a text prompt and a response may be transmitted.

In one embodiment, parameters related to integration may be adjusted when a device is being used for a call. For example, in one embodiment, the threshold functional proximity may be adjusted to take into account how the devices are being used. As a specific example, when a user is sitting at a desk with a phone and a tablet, the threshold functional proximity may be a few inches. However, if that user was talking on the phone as they sat down at the desk, it is unlikely the phone and tablet will be that close, so the threshold functional proximity may be expanded to permit integration at a greater distance.

If it is determined that integration should be initiated, the devices will proceed to handshake. See operation 48-8-04. In some embodiments, this handshaking may be identical to that performed in step 6 of FIG. 48-4 or step 5 of FIG. 48-5. In other embodiments, the procedure may be modified to avoid disrupting the user's call. For example, in one embodiment, any authentication which is performed as part of the handshaking process may utilize the device which is not being used for a call to obtain user input.

As shown, an appropriate integration profile is selected. See operation 48-8-06. In many embodiments, the selection of an appropriate integration profile is performed in a manner similar to step 7 of FIG. 48-4 or step 6 of FIG. 48-5. In some embodiments, efforts may be made to prevent interrupting the user's ongoing call. For example, in one embodiment, any integration profile conflicts which require user input to resolve may utilize the display of the device which is not being used for a call. In another embodiment, the device not being used for a call may automatically serve as the integration master.

In various embodiments, the user may have the option of making temporary adjustments to the integration profile, to prevent disruption of the ongoing call. For example, in one embodiment, the user may be prompted whether they wish to proceed with the application of potentially disruptive elements of the selected integration profile. These elements may include, but are not limited to, switching the call to a speakerphone, changing the camera and/or display being used for a video conference, switching to or from a Bluetooth device for call audio, switching to new channels/sources for audio input and output, and/or any other potentially disruptive activity which may be specified in an integration profile. In other embodiments, the integration profile may be modified without requiring user input. In one embodiment, the modifications to the profile may be temporary, such that once the call is over, the modifications are reversed and the integration profile is applied as originally defined. In another embodiment, the modifications may persist after the call has ended.

After an integration profile has been selected, it is determined whether the application of said profile will disrupt the ongoing call. See determination 48-8-08. In various embodiments, this determination may be made using, at least in part, an estimation of potential disruption. This estimation may be based upon a number of factors, including, but not limited to, the selected integration profile, network bandwidth, connection quality, signal strength, the load on an external server necessary for integration, and/or any other factor which may cause a disruption of the ongoing call.

As a specific example, in the case where the user using the phone for a video conference, and is integrating with a tablet using an integration profile which specifies that the tablet is to be used for video conferencing, and that all applications running on the phone should be transferred to the tablet through the live migration of a virtual machine. It may be determined that, due to a slow network, transferring the video conference to the tablet using the live migration will result in a disruption of the call.

In some embodiments, some degree of disruption may be allowed. For example, in one embodiment, an allowable disruption period may be defined. If the overall foreseeable disruption of the call is expected to be shorter than the allowable disruption period, it will be ignored.

If it is determined that integration will disrupt the ongoing call, a partial integration is completed. See operation 48-8-10. In the context of the present description, a partial integration refers to an integration which follows the selected integration profile as closely as possible, preserving functionality while not disrupting the ongoing call. As a specific example, if migrating a virtual machine from the phone to the tablet would disrupt the call, the migration may be cancelled. In another example, if the integration profile calls for the phone to serve as a mouse, but doing so would disrupt the call, that input functionality may be provided through the tablet display, even if the integration profile specifies otherwise.

Once the partial integration has been completed, an in-call user interface is displayed or updated. See operation 48-8-12. In some embodiments, the in-call user interface may be presented to the user on the device with the largest display. In this way, the user may have a visual indication of the success of the partial integration, and take advantage of newly integrated resources. In other embodiments, the in-call user interface may continue to be displayed on the device being used for the call, to provide a consistent user experience. As an option, there may be a visual indication that the partial integration has been completed.

In some embodiments, the in-call user interface may be updated after the partition integration to reflect functionality made available by the additional device. For example, in one embodiment, the user may be given new input/output options for audio and/or video. In another embodiment, the in-call user interface may be updated to reflect the availability of data or applications located on the additional device.

As shown, it is determined whether to complete the full integration. See determination 48-8-14. If it is determined that the integration should be completed, the full integration is performed. See operation 48-8-16. In some embodiments, the partial integration will not proceed to a full integration until it is determined that the call in progress will not be disrupted. For example, in one embodiment, this may mean that the remaining integration steps are delayed until the call has ended. In another embodiment, the remaining integration steps may be performed if the user takes an action which would diminish the effect of a disruption. As a specific example, if the user had previously indicated that they did not wish to switch to the microphone and speakers associated with a tablet for their ongoing phone call, and the integration profile specifies that all audio be routed through the tablet audio system, the integration may be completed before the call has ended if the user manually selects the tablet audio channels through the in-call user interface.

In another embodiment, the partial integration may not proceed to completion until the user has indicated they are ready for an associated transition. For example, if the complete integration will result in the call audio or video switch from one device to another, the system may wait for the user to indicate that they are ready for the change. In one embodiment, the user may cause the integration to proceed to completion through the in-call user interface, or some other user interface. In another embodiment, the user may provide this input through a method other than a device display, such as the accelerometer. As a specific example, the user may indicate their wish to complete the transition from speaking into a phone to speaking through a tablet by setting down the phone. As an option, the in-call user interface may indicate to the user that they system is ready to complete the integration, and may instruct the user how to trigger the remaining steps.

In some embodiments, the user may be informed of all the changes which have occurred due to the completion of the integration. In one embodiment, these changes may be reported using the in-call user interface. In another embodiment, a different user interface may be used to display the changes associated with the integration.

If it is determined in determination 48-8-08 that integration will not disrupt the call, a complete integration may be performed. See operation 48-8-18. In one embodiment, the user may be informed of all the changes which have taken place due to the integration. As an option, this information may be displayed in an interface which will not disrupt the ongoing call.

FIG. 48-9 shows a method 48-9-00 for escalating a voice call to a video conference utilizing a tablet/mobile phone integration, in accordance with one embodiment. As an option, the method 48-9-00 may be implemented in the context of the architecture and environment of the previous Figures or any subsequent Figure(s). Of course, however, the method 48-9-00 may be implemented in any desired environment.

It should also be noted that the aforementioned definitions may apply during the present description.

While engaged in a voice call using an integrated phone/tablet system, a user may wish to escalate to a video conference. As shown, the integration profile is checked. See operation 48-9-02. In various embodiments, an integration profile may specify the display, camera, microphone, and/or speaker to utilize when making a video conference. For example, the integration profile may specify that the tablet display is to be utilized in conjunction with a camera located on the phone.

The video conference is initiated from the appropriate integrated device. See operation 48-9-04. In one embodiment, the video conference may be initiated from the device on which the voice call is being made. In another embodiment, the video conference may be initiated from the device on which it will ultimately be displayed.

In various embodiments, the initiation of a video conference may result in all other call participants receiving a request to join the video conference. In one embodiment, the request may be sent to the other users using contact information available to the user who initiated the escalation, such as an address book. As an option, if no direct video conferencing contact information is available, instructions may be sent to those users using other communication channels, such as SMS or email, indicating how to join the conference. In another embodiment, the request may be sent to the other users using the communications channel being used for the ongoing voice call.

In some embodiments, a user may specify a preference for, or manually initiate, multichannel video conferencing. In the context of the present description, multichannel video conferencing refers to a conference between multiple users which involves more than one communications channel. For example, in one embodiment, a multichannel video conference may include screen sharing. In the context of the present description, screen sharing refers to transmitting a live view of at least a part of one user's workspace. This allows one user to demonstrate something on their device as though all participants were physically present.

In another embodiment, a multichannel video conference may include a shared workspace. In the context of the present description, a shared workspace refers to a virtual workspace with which one or more conference participants may interact. In one embodiment, conference participants may each contribute documents to this shared workspace, which may be viewed or modified by other participants. In another embodiment, a shared workspace may allow conference participants to simultaneously modify the same document. As an option, each user may have a unique cursor to indicate where they are working. In some embodiments, the shared workspace may be hosted by and managed using an external server, such as a cloud server. In other embodiments, the shared workspace may be hosted on the device of one of the conference participants, with document sharing and document changes being shared directly between conference participants. As an option, a shared workspace may also include cloud storage which is accessible by some or all participants. In some embodiments, a shared workspace may be used outside of the context of a multichannel video conference (e.g. in conjunction with a voice call, etc.).

In yet another embodiment, a multichannel video conference may include a virtual projector. In the context of the present description, a virtual projector refers to video feed which is transmitted to other conference participants, which is generated using a simulated hardware connection. From the point of view of the originating device, a projector or external display has been connected to the integrated system, except instead of projecting the video on a screen, it is transmitted to the other conference participants. In this way, a user may give a virtual presentation using the same software and methods they would use had all participants been in the same room. This would allow the presenter to use notes, timers, teleprompters, and/or other features which are available when using a projector or external display.

In still another embodiment, a multichannel video conference may include a live video feed. For example, in one embodiment, a multichannel video conference may include a live feed from another participant's camera. In another embodiment, a multichannel video conference may include a combination of the live video camera feeds coming from each participant.

Once the video conference has been initiated, it is determined whether the other participants have accepted the escalation request. See determination 48-9-06. If a participant accepts the video conference request, their call may be terminated. See operation 48-9-08. In some embodiments, the escalating user's participation in the voice call may not be terminated until all participants have accepted or refused the video conference.

If a call participant refuses the video conference request, they may be added to the video conference as an audio channel. See operation 48-9-10. In some embodiments, a participant may only be added to the video conference as an audio-only channel if they refuse the video conference request. In other embodiments, a participant may be added to the video conference as an audio-only channel if they do not accept the video conference request within a certain amount of time. In still other embodiments, a participant may be automatically added as an audio-only channel if the escalating user does not have direct video conference contact information for that participant. For example, the participant may be calling from a blocked number, or a number which is not associated with video conferencing functionality, and no other contact information is known.

In some embodiments, a call participant may be added to the video conference as an audio-only channel by routing the call through the escalating user. For example, in one embodiment, a participant on a cellular-based phone call may be added to the video conference as an audio-only channel by keeping the call active, and using the escalating user's integrated devices as a bridge between the cellular phone call and the video conference. In other embodiments, a call participant may be added to the video conference as an audio-only channel using an external server. For example, in one embodiment, a participant on a VOIP-based phone call may be added to the video conference as an audio-only channel by bridging the VOIP call and the video conference using a server. The server may be a VOIP server, a video conference server, or any other external server. Of course, in other embodiments, a VOIP call may also be routed through the escalating user's integrated device.

After all of the call participants have responded to the request to join a video conference, or after a certain amount of time has elapsed, it is determined whether at least one participant has accepted the request. See determination 48-9-12. If nobody accepted the request to join the video conference, the video conference is terminated and the voice call is continued as before. See operation 48-9-14.

If it is determined that at least one call participant has accepted the request to join a video conference, an in-conference user interface is presented to the user. See operation 48-9-16. In some embodiments, the in-conference user interface may utilize the displays of both integrated devices. In other embodiments, the in-conference user interface may utilize only one display. For example, in one embodiment, the video conference may utilize the tablet display, and the in-conference user interface may be presented on the phone display.

The in-conference user interface may display the various options available to the user during the video conference. These options may include, but are not limited to, available audio channels (e.g. Bluetooth, built-in audio for phone and tablet, etc.), available video sources, multichannel video conference options, and/or any other options or functionality which may be associated with a video conference.

In some embodiments, the video conference may include multiple participants. Each participant may be represented in the in-conference user interface as an icon, or as a live video feed. In one embodiment, the user may have the option to mute one or more participants, or to cut them off from the user's video feed(s). In another embodiment, the user may have the option to re-invite participants to the video conference who are currently participating as audio-only channels.

In various embodiments, a multichannel video conference may utilize the tablet display for a shared screen, a shared workspace, or a virtual projector, and the phone display for the in-conference user interface. In some embodiments, the user may have the option to interact with the shared workspace, shared screen, or virtual projector in a way that indicates a screen location to the other participants, but does not interact with any screen elements, similar to how a laser pointer would be used in a physical presentation.

In other embodiments, a user may be able to cycle through various channels of a multichannel video conference on the display of a single device. As an option, the user may be able to change the video channel through a gesture performed on a touch-sensitive display, such as a swiping motion.

FIG. 48-10 shows a method 48-10-00 for disintegrating a tablet/mobile phone integration, in accordance with one embodiment. As an option, the method 48-10-00 may be implemented in the context of the architecture and environment of the previous Figures or any subsequent Figure(s). Of course, however, the method 48-10-00 may be implemented in any desired environment. It should also be noted that the aforementioned definitions may apply during the present description.

As shown, the disintegration is initiated. See operation 48-10-02. In some embodiments, the disintegration of two integrated devices may be initiated manually by the user. For example, in one embodiment, the user may initiate disintegration by turning off one of the devices. In another embodiment, the disintegration may be initiated by the user manually putting a device to sleep.

In some embodiments, disintegration may be initiated automatically. For example, in one embodiment, disintegration may be initiated when the two devices have been separated. The disintegration may be initiated if the separation exceeds a predefined distance, or if the devices have been separated by more than another predefined distance for more than a predefined period of time. In another embodiment, disintegration may be initiated automatically if one or more aspects of the integrated system change. For example, disintegration may be initiated if one or both devices switch from being powered by an external source to running off of battery power. In various embodiments, when a disintegration has been automatically initiated, the user may be notified on one or both devices. This notification may be visual, auditory, tactile (e.g. a vibration, etc.), and/or any combination of notification forms.

In some embodiments, if there is a call, such as a voice call or video conference, in progress when the disintegration is initiated, steps may be taken to prevent the call from being disrupted. For example, in one embodiment, if the nature of the call is such that it may be transferred without disruption through the live migration of a virtual machine or application, said migration may be performed automatically in later steps. In another embodiment, if it is determined that there is no way to disintegrate the two devices without disrupting the call, the user may be notified, and presented with options. These options may include, but are not limited to, cancelling the disintegration or opening a new line of communication which will not be disrupted. In one embodiment, if the user does not take steps to preserve the call, and the call is disrupted by a disintegration, a message may be sent automatically to the other participant or participants of the disrupted call, informing them of the problem.

Once a disintegration has been initiated, it is determined if a virtual machine or virtual application needs to be transferred. See determination 48-10-04. In some embodiments, if a virtual machine or application was transferred when the devices were integrated, that same virtual machine or application (if still running) may be automatically migrated back to it's original device. In other embodiments, the user may be prompted to select which, if any, virtual machines and/or virtual applications should be transferred as part of the disintegration. In still other embodiments, the integration profile may specify what is to be done with running processes and applications in the case of a disintegration.

If it is determined that a transfer is needed, a live migration of the virtual machine or virtual application is performed. See operation 48-10-06. In some embodiments, this operation may simply be to conclude an anticipatory migration. In the context of the present description, an anticipatory migration refers to the migration of a virtual machine or application which is initiated (but not completed) in anticipation of a disintegration. When a disintegration has officially been initiated, the bulk of the migration will already have been completed. In this way, the system will be more responsive to automatic disintegration, and the amount of time the system spends in a transitory state (the state between integration and disintegration) will be reduced.

In various embodiments, anticipatory migration may be triggered by user behavior. For example, in one embodiment, if device accelerometers have determined that the device has been picked up, placed in a pocket or case, or moving, an anticipatory migration may be initiated. In other embodiments, anticipatory migration may be triggered by historical use observations. For example, in one embodiment, if it has been observed that the user triggers a disintegration every day at a certain time, an anticipatory migration may be triggered before that time, in preparation.

In some embodiments, when the migration of a virtual machine or application has been initiated automatically, the user may be warned to prevent a disruption of communications before the migration is complete. For example, in one embodiment, a user may be warned of a potential disruption if it is determined that the distance is increasing between two devices connected with an ad-hoc network. In another embodiment, the user may be warned if a decrease in signal strength is detected which may disrupt the migration. As an option, in these embodiments, the notification may override the user's instructions (e.g. making a sound even when the user has silenced a device, etc.).

After the migration of the virtual machine or application has been completed, or if such a migration is not required, the pre-integration settings for both devices are restored. See operation 48-10-08. In various embodiments, one or both devices may be restored to the state they were in before they were integrated. This may include, but is not limited to, device volume, peripheral connections (e.g. Bluetooth, etc.), display brightness, and/or any other aspect associated with the device.

As shown, the user interface is updated to reflect the disintegration. See operation 48-10-10. In various embodiments, this update may include, but is not limited to, removal of integrated device status notifications (e.g. signal strength, etc.), and the removal of one or more options in the in-call user interface for voice calls or video conferences.

FIG. 48-11 shows a method 48-11-00 of performing a partial disintegration of a tablet/mobile phone integration, in accordance with one embodiment.

As an option, the method 48-11-00 may be implemented in the context of the architecture and environment of the previous Figures or any subsequent Figure(s). Of course, however, the method 48-11-00 may be implemented in any desired environment. It should also be noted that the aforementioned definitions may apply during the present description.

During the course of normal use, a user of an integrated system may cause the devices to temporarily separate. For example, a user may take their tablet to a different room to share something with another person, leaving their phone behind. During the temporary separation, the integrated devices may be partially disintegrated, in an effort to provide security and preserve functionality.

As shown, the functional proximity is determined. See operation 48-11-02. In various embodiments, the functional proximity may be determined using any of the previously discussed methods. In one embodiment, the determination of functional proximity may be triggered by movement detected by device accelerometers. In another embodiment, the determination may be performed periodically.

In one embodiment, each device may be responsible for determining its own functional proximity to the other device. In another embodiment, once the functional proximity is determined, it may be shared between the devices through a communication channel established by the integration. In still another embodiment, the functional proximity may be reported to an external server by one device, and retrieved by the other device.

Using the functional proximity, it is determined whether the devices have reached a threshold functional separation. See determination 48-11-04. In the context of the present description, threshold functional separation refers to a predefined functional proximity beyond which partial disintegration may be required. In some embodiments, the threshold functional separation may be larger than the threshold functional proximity, to allow a user the freedom to reposition their integrated devices without the risk of unintentional partial disintegration.

In various embodiments, the threshold functional separation may be predefined by the user. In one embodiment, the threshold functional separation may be defined as part of an integration profile. In another embodiment, the threshold functional separation may be defined independent of the integration profile. In yet another embodiment, the threshold functional separation may be defined such that it depends upon one or more matters of context, including, but not limited to, location, time of day, day of the week, and/or any other contextual information.

In some embodiments, the threshold functional separations that have been defined may be synchronized between the devices during integration. In other embodiments, the devices may have different threshold functional separations. In these embodiments, where each device has its own definition of the threshold functional separation, each device may be responsible for determining when that threshold functional separation has been exceeded.

In still other embodiments, the threshold functional separation may be stored on an external server. For example, in one embodiment, an external server may store the threshold functional separation, and also determine whether the threshold functional separation has been exceeded by the two devices.

If it is determined that a device has exceeded a predefined threshold functional separation, the device is secured. See operation 48-11-06. In various embodiments, a device may be secured by implementing a device security profile. In the context of the present description, a device security profile refers to a predefined set of security measures, such as locking down a device using a password, as well as a predefined set of contexts in which those measures are to be applied. For example, in one embodiment, a device security profile may depend upon the location of devices. As a specific example, a set of device security profiles may be defined such that unlocking an integrated device while separated from its partner may require a four digit PIN at the office, a press of a button at home, and an alphanumeric password everywhere else. In other embodiments, the use of particular device security profiles may depend upon other factors, including, but not limited to, the time of day, the day of the week, the identity of the partner device, and/or any other contextual detail.

In various embodiments, the device security profile may depend upon whether a device is active or passive. In the context of the present description, an active device is one that is in the user's physical possession (e.g. in their hand, in a pocket or purse, in a case inside a backpack the user is wearing, etc.). This may be determined by detecting motion, using accelerometers, in accordance with one embodiment. Similarly, a passive device, in this context, is a device which is not in the user's physical possession. In other words, if the user has left the vicinity of one device, taking the other device with them, the device that went with the user is an active device, and the device left behind is a passive device. As a specific example, in one embodiment, a set of device security profiles may be defined such that if a device is passive, it may be locked with a password, while if the device is active, it may use whatever screen lock settings are used when the device is not integrated, such as a PIN unlock, or a simple gesture.

In some embodiments, each device may have one or more device security profiles. In other embodiments, the collection of device security profiles may be synchronized during integration, similar to the synchronization of integration profiles. In still other embodiments, the device security profiles may be maintained on an external server, which may be used to update one or more of a users devices.

In various embodiments, device security profiles associated with separating integrated devices may also include actions associated with preparing for a possible disintegration. For example, in one embodiment, a device security profile may be defined to include triggering an anticipatory migration of virtual machines and/or applications, as previously discussed.

As shown, functionality is localized with the user. See operation 48-11-08. While the integrated devices are separated, a partial disintegration may be performed to the extent necessary to allow as much functionality to remain with the user as possible, in accordance with various embodiments. In these embodiments, it may be assumed that an active device is a device which is still available to the user, and may serve as a target for localizing functionality. In one embodiment, the user may be prompted on both devices to indicate which device is still with them. A similar prompt may be used in the case where it is determined that both devices are moving, according to one embodiment. As an option, the devices may request a password or PIN.

For example, in one embodiment, if the integration profile specifies that all video conferencing is to utilize the camera and display of a tablet, and after the threshold functional separation is exceeded the phone is the only active device, incoming video conference requests may be routed to the phone automatically.

In another embodiment, the integration profile may specify that all voice calls utilize the speaker and microphone associated with a tablet. If, after sufficient separation, the tablet is the only active device, steps may be taken to ensure that telephone functionality remains available to the user. For example, in one embodiment, audio which may have previously been transmitted to the tablet via a Bluetooth connection may be sent to the now distant tablet via a communication channel which has greater range (e.g. local wireless network, peer-to-peer wireless network, etc.).

In various embodiments, a user may specify which functionality should or should not be preserved upon separation. For example, in one embodiment, a user may specify that certain functionality does not need to remain localized with the user if a particular device is the active device. As a specific example, a user may not wish to have a conversation via tablet speakers outside the confines of their office, so they may specify that voice call functionality does not need to be localized to the tablet when separated and active.

As shown, it is determined if any of the functionality associated with the integration has been lost due to the separation of the two devices. See determination 48-11-10. Sometimes only a portion of the integrated functionality is preserved in operation 48-11-08, or sometimes functionality is lost due to a degrading connection between the two device. If it is determined if a portion of the functionality associated with the integration has been lost, the user is notified. See operation 48-11-12.

In various embodiments, the user may be notified when some aspect of integrated functionality has been lost. For example, in one embodiment, if the quality of the network connection linking an active tablet to a passive phone degrades to the point that audio cannot be clearly transmitted between the two, the user may be notified that phone functionality has been lost. In some embodiments, the user may be notified by the disappearance of a status icon, a sound or vibration, an on-screen notification, a combination of these, or any other form of user notification.

As shown, it is determined if the separation has reached the point that would warrant a full disintegration. See determination 48-11-14. As previously discussed, in one embodiment, disintegration may be automatically initiated if the devices have been separated for more than a predefined amount of time. In another embodiment, disintegration may be automatically initiated if the devices become separated by more than a predefined distance. In some embodiments, these predefined times and distances may vary according one or more contexts, including location, time of day, day of the week, and/or any other context.

In one embodiment, disintegration may be automatically initiated if one or more functionalities is lost, or is about to be lost, due to the separation. For example, the user may specify that if a separation ever causes the ad hoc Wi-Fi connection between the devices to fail, disintegration may be automatically initiated. In another embodiment, the user may specify that if the signal strength of the ad hoc Wi-Fi drops below a certain level, disintegration may be initiated automatically.

If it is determined that disintegration is warranted, then disintegration is initiated. See operation 48-11-16. Otherwise, it is determined whether the devices are once again functionally proximate. See determination 48-11-18. Throughout the separation, the functional proximity may be repeatedly determined, either on a schedule, or in response to device movement, as previously described. As an option, the functional proximity may be determined more often than usual during a partial disintegration, to make the system more responsive to rapid changes in separation distance.

If it is determined that the devices have been brought within the threshold functional separation, the full integration is restored. See operation 48-11-20. For example, in one embodiment, all of the settings originally specified in the integration profile may be reapplied to the devices once they are closer than the threshold functional separation.

In various embodiments, the restoration of the full integration may also include the reversal of device security profiles which had been applied. For example, in one embodiment, restoring the full integration may cause both device displays to unlock, without requiring a password. In another embodiment, the restoration may cause both displays to unlock if a password is entered on either of the devices. In some embodiments, the device security profiles may specify a particular behavior upon the restoration of a full integration.

FIG. 48-12A shows a user interface 48-12-100 for defining an integration profile, in accordance with one embodiment. As an option, user interface 48-12-100 may be implemented in the context of the architecture and environment of the previous Figures or any subsequent Figure(s). Of course, however, user interface 48-12-100 may be implemented in any desired environment. It should also be noted that the aforementioned definitions may apply during the present description.

In various embodiments, user interface 48-12-100 may be used to define or modify an integration profile. In one embodiment, user interface 48-12-100 may be used to define the context and nature of an integration. As shown, the user interface 48-12-100 may include text fields 48-12-102 and 48-12-104 which identify the integration profile being defined, as well as the devices which may use the integration profile.

In various embodiments, the user may be able to specify one or both of the device identities. For example, in one embodiment, the user may be able to specify both devices. In another embodiment, a user may be limited to defining integration profiles which involve the device through which user interface 48-12-100 is being presented.

In one embodiment, a user may specify specific devices to which the profile may be applied. In other embodiments, a user may specify a subset of devices which share a particular attribute. For example, in one embodiment, a user may specify that the integration profile may be applied to devices from a particular manufacturer (e.g. “Apple iPads”, etc.). In another embodiment, a user may specify that the profile be applicable to device which have a particular physical attribute (e.g. “tablets with a 7+ inch screen”, etc.). In still another embodiment, a user may specify that the profile be applicable to all devices which are owned by a particular user.

As shown, text fields 48-12-104 may identify the devices which may use the integration profile by their user defined names (e.g. “Jeff's Tablet”, etc.), in accordance with one embodiment. As an option, additional information may be provided, including, but not limited to, device make and model (e.g. “Apple iPad 2”, etc.), an iconic depiction of the device, or other identifying information (e.g. “this device”, etc.).

In some embodiments, the devices may be specified by the user using a drop down menu. In other embodiments, the user may specify specific devices, or a class of devices, through a different interface.

The user interface 48-12-100 may include a text field 48-12-106 displaying the threshold functional proximity, which defines how close the devices specified in text fields 48-12-104 must be before that particular integration profile may be applied. Additionally, in one embodiment, the user interface may also include a text field 48-12-108 displaying the current functional proximity between the two devices.

In one embodiment the functional proximities may be displayed with units of distance (e.g. feet, meters, etc.). In another embodiment, the functional proximities may be displayed as signal strengths. In still another embodiment, the current functional proximity displayed in 48-12-108 may be reported as a percentage of the currently defined threshold functional proximity. In yet another embodiment, the proximities may be displayed using a unitless metric.

In various embodiments, the user interface may include a button 48-12-110 to define the threshold functional proximity. In one embodiment, button 48-12-110 may prompt the user to input a new value for the threshold functional proximity. In another embodiment, button 48-12-110 may define the current functional proximity 48-12-108 as the new threshold functional proximity. It should be noted that the term “button” may include/refer to any input mechanism (e.g. indicia for selection via a touchscreen, etc.).

As shown, in one embodiment, user interface 48-12-100 may include a drop down menu 48-12-112 which allows the user to specify the amount of user interaction needed to initiate an integration using that profile. In one embodiment, drop down menu 48-12-112 may include an “automatic” option, which means that if all contextual requirements, including the functional proximity, are met, integration will begin automatically. In another embodiment, the drop down menu may include a “prompt user” option, which means that if all contextual requirements, including the functional proximity, are met, the user will be prompted whether they wish to integrate the two devices.

In still another embodiment, the drop down menu 48-12-112 may include a “manual” option, which means that the profile will only be used if the user manually initiates an integration. In this way, a user may create an integration profile involving a device which is often in the proximity, but seldom integrated to (e.g. a device belonging to someone else, etc.). The user will not have their device use repeatedly interrupted with integration prompts, but still be able to easily integrate when so desired.

In one embodiment, user interface 48-12-100 may include text field 48-12-114 which allows the user to specify the timing related to the integration profile. As an option, the label associated with 48-12-114 may change depending on what has been selected in drop down menu 48-12-112. For example, if the user has specified that the profile be implemented automatically, text field 48-12-114 may be used to specify a delay within which the user may cancel the automatic integration, and may be labeled as such (e.g. “delay”, etc.). If the user has specified that the user be prompted concerning the potential application of the present integration profile, text field 48-12-114 may be used to specify the window of time during which a user may initiate the integration, before the option disappears, and may be labeled as such (e.g. “auto dismiss”, etc.).

In various embodiments, user interface 48-12-100 may include a check box 48-12-116 which allows the user to specify that a PIN or password is required before an integration is completed. In one embodiment, the user may specify a PIN or alphanumeric password associated with that particular integration profile. In another embodiment, selecting check box 48-12-116 may condition integration on the input of a PIN or password which is associated with a particular device. In yet another embodiment, the PIN or password may be associated with the user, across multiple devices.

In various embodiments, an integration profile may be defined such that integration will only occur in certain contexts. The user interface 48-12-100 may include one or more elements to allow the user to define the context in which that profile may be used.

In one embodiment, the user interface 48-12-100 may include a check box 48-12-118 which allows the user to specify that the integration profile only be used at a particular location. In various embodiments, the user may specify a particular location at which the integration profile may be used. In one embodiment, the user may enter a street address into a text field. In another embodiment, the user may select a business or person from their contacts. In still another embodiment, the user may be able to select from labeled locations (e.g. “home”, “office”, etc.). As an option, the user may be able to press a button which captures their present location and prompts them for a label. In yet another embodiment, the user may be able to indicate a location using a map.

In another embodiment, the user may be able to specify a location type in which the integration profile will be available. For example, the user may create a profile to be used in coffee shops. Whenever the location of the devices corresponds with the address of a known coffee shop, the profile will be available. Other location types may include airports, hotels, and/or any other type of location where an integration may be performed. In some embodiments, the determination of location type may be performed by both devices. In other embodiments, the determination may be made by just the integration master. In still other embodiments, the determination may be made on an external server which has access to the location data of both devices.

As shown, the user interface 48-12-100 may include a drop down menu 48-12-120, which allows the user to specify a radius around a location within which the integration profile will be available. A user may wish to define a profile that is only active within a certain room or building, such as in a work setting. A user may also wish to define a profile which is available over a larger area, such as a college campus, without having to create multiple profiles. As shown, in one embodiment, a user may be able to choose from a set of labeled radii (e.g. “room”, “building”, “1 block”, “4 blocks”, etc.). In another embodiment, a user may be able to chose a radius from a set of distances (e.g. 2m, 10m, 20m, etc.). In still another embodiment, a user may be able to enter a specific distance to be used as a radius. In yet another embodiment, the user may be able to use a map (e.g. drawing on the map, etc.) to indicate the boundaries of an area within which the integration profile will be available.

In various embodiments, the user interface may include a plurality of check boxes 48-12-122, which represent a plurality of contextual requirements related to the devices identified in text fields 48-12-104. In one embodiment, the contextual requirements may include the power source of the devices, whether battery or non-battery. As an option, a minimum charge level may be specified.

In another embodiment, the contextual requirements represented by the plurality of check boxes may include whether or not one or both of the devices have been motionless. As an option, the user may specify for how long the device must have been motionless before the integration profile is available. In still another embodiment, the contextual requirements may include the device mode of one or both devices, the identity of the network to which one or both devices are connected, the type of network connection, and or any other device related information.

In one embodiment, user interface 48-12-100 may include a plurality of check boxes 48-12-124 which allows the user to specify which days of the week that integration profile will be available. For example, a user may create a profile for use on work days, and another profile for use on the weekend. The user interface may also include a text field 48-12-126 which allows the user to specify the time of day during which the integration profile will be available. In another embodiment, the user may be able to specify different and/or multiple time periods for each day of the week.

In one embodiment, user interface 48-12-100 may include a check box 48-12-128 which allows the user to specify whether this integration profile should be available while one of the devices is being used for a voice call or video conference. In another embodiment, selecting this check box may allow the user to specify a different set of parameters to be used in that situation, such as an expanded threshold functional proximity, as previously discussed.

FIG. 48-12B shows a user interface 48-12-140 for defining integration functionality as part of an integration profile, in accordance with one embodiment. As an option, user interface 48-12-140 may be implemented in the context of the architecture and environment of the previous Figures or any subsequent Figure(s). Of course, however, user interface 48-12-140 may be implemented in any desired environment. It should also be noted that the aforementioned definitions may apply during the present description.

In one embodiment, user interface 48-12-100 of FIG. 48-12A may include a button 48-12-130 which allows the user to define or modify the various aspects of the functionality of the integration. In various embodiments, selecting button 48-12-130 may present a different user interface. For example, in one embodiment, user interface 48-12-140 may be used to define how the two devices will function while integrated.

Integration may allow some tasks which are normally confined to a single device to utilize the resources of two devices. When defining an integration profile, the role each device plays in carrying out said tasks may be defined. As shown, the user interface 48-12-140 may be utilized to define how each device will function in one or more use scenarios. For example, in one embodiment, the user interface may include a collection of drop down menus 48-12-142 associated with the roles each integrated device may fill in one or more use scenarios. Of course, in other embodiments, these roles may be associated with other types of user interface elements, such as a collection of check boxes or radio buttons.

As shown, the collection of integrated device roles 48-12-142 may include a plurality of drop down menus 48-12-144 to specify the general, or default, role each device will play while integrated. In one embodiment, a drop down menu representing the general roles for an integrated tablet may include one or more roles combining the functionality of a display with the functionality of an input device. For example, the general integrated tablet roles may include, but are not limited to, “display” (i.e. display only, no input) and/or “touchscreen” (i.e. display plus input). In another embodiment, general integrated tablet roles may include the roles which may be associated with a desktop computer mode, such as those shown in FIG. 34 of the previous application.

In various embodiments, the plurality of drop down menus 48-12-144 may include a drop down menu representing the general roles available for an integrated phone. In one embodiment, these general roles may include those of a visual nature, such as “display” or “touchscreen”. In another embodiment, the general roles for an integrated phone may include “widget”, which would utilize the phone as a screen to persistently display information the user desires, such as a calendar, a clock, a photo, a weather report, an email unread message counter, and/or any other type of display. In still another embodiment, these general integrated phone roles may include those of an interactive nature, such as “track pad”, “mouse”, “keyboard”, and/or any other input role which a phone could fill.

In some embodiments, the general integrated phone roles may also include “custom UI”, in which the phone would serve as a configurable user interface, providing user interface elements for a plurality of tasks, actions, macros, scripts, apps, and/or any other function which may be performed by either integrated device. In one embodiment, this user interface may be entirely user defined. In another embodiment, all or a part of this custom UI may be configured automatically, based upon observed user behavior. In yet another embodiment, this custom UI may be context-sensitive.

In another embodiment, the general integrated phone roles may include “locked”, where the phone display would remain off. This may be desirable in the case where the integrated phone does not have an external power source and battery life needs to be extended.

In various embodiments, the available general roles for the integrated tablet and integrated phone may be focused upon the advantages provided by each device. For example, the tablet roles may focus upon harnessing a superior display, while the phone roles may focus on ease with which a phone may be manipulated and repositioned. Of course, except in the case where a role relies upon a resource which is unique to only one of the devices, the tablet and phone roles may be interchangeable, in accordance with one embodiment.

In some embodiments, the user may be warned if they have chosen a pair of general integrated device roles which both lack input functionality (e.g. the tablet fills a “display” role, and the phone fills a “widget” role, etc.). In one embodiment, this warning may indicate to the user that one or more external input devices will be required. In another embodiment, the user may be prevented from choosing a pair of roles which preclude a form of input. In other embodiments, however, the user interface 48-12-140 may include a list of potential input sources which the user may reorder according to their desired priority. For example, a user may order the list such that if an external mouse is detected, it will have priority and the tablet will not be touch sensitive. The user may also order the list such that they will be able to interact with the integration via mouse as well as a touchscreen.

Similarly, in other embodiments, the user interface 48-12-140 may include a list of general integrated roles which the user may prioritize. As a specific example, the phone may fill the “custom UI” role until the need for a keyboard arises (i.e. an editable text field is selected, etc.), at which time it will become a keyboard.

In one embodiment, the user interface 48-12-140 may also provide the user with the ability to designate a prime display. In the context of the present description, the prime display refers to the device display upon which the most important user interaction will take place (e.g. a menu bar, notifications, etc.).

As shown, the collection of integrated device roles 48-12-142 may include a plurality of drop down menus 48-12-146 to specify the role each integrated device will play during a voice call. In one embodiment, an “in-call UI” role may use an integrated device to display a plurality of actions which a user may take during a call (e.g. “mute”, “speaker”, “escalate to video conference”, etc.). In another embodiment, a “caller info” role may use an integrated device to display information regarding the caller, which may include, but is not limited to, a photo, a call history, recent emails, and/or any other information related to the caller. In yet another embodiment, a “call transcript” role may use an integrated device to display a user interface containing a transcript of the call. As an option, the transcript may be generated automatically. In still another embodiment, a “prime display” role may use an integrated device as the prime display. For instance, a user may utilize the tablet as the prime display in general, but could have that display moved to the phone screen during a call, using the tablet to display caller information and related emails. Further more, in another embodiment, one or more of the general integration roles previously discussed may also be available during a voice call.

In one embodiment, both devices may be assigned roles from a single set of voice call device roles. As an option, the user may be prevented from selecting a conflicting set of roles, such as two identical roles. In another embodiment, the user may be able to choose from a set of roles for the integrated phone, and from a similar, yet enhanced, set of roles for the integrated tablet. These enhanced roles may take advantage of the additional resources of the tablet, such as a larger display. In some embodiments, user interface 48-12-140 may allow the user to customize various aspects of the interfaces and roles associated with a voice call.

In one embodiment, the behavior associated with a role specified in user interface 48-12-140 may be unchangeable during that use scenario (e.g. the in-call UI is displayed on the tablet until the call has ended, etc.). In another embodiment, the roles specified in this user interface may simply represent a default starting point; the user may be able to modify the functionality and/or role of one or both devices at any time, during any use scenario.

As shown, the collection of integrated device roles 48-12-142 may include a plurality of drop down menus 48-12-148 to specify the role each integrated device will play during a video conference. In one embodiment, an “in-conference UI” role may use an integrated device to display a plurality of actions which a user may take during a conference, similar to the “in-call UI” role for voice calls. Additionally, “caller info”, “conference transcript”, and “prime display” roles may exist, which are similar to roles discussed with respect to a voice call.

In various embodiments, the available device roles for a video conference may also include roles specific to the video streams being used. For example, in one embodiment, there may exist an “incoming video stream” role, which uses a device to display the one or more video streams coming from one or more other callers. In another embodiment, there may exist an “outgoing video stream” role, which displays the video stream the user is sending to other conference participants. As an option, if the user does not delegate the displaying of the outgoing video to a particular device, said video may be displayed in a reduced size within another user interface.

As with the device roles for voice calls, in one embodiment both devices may be assigned roles from a single set of video conference device roles. As an option, the user may be prevented from selecting a conflicting set of roles, such as two identical roles. The user may also be required to elect one of the devices to fill the “incoming video stream” role, in accordance with another embodiment.

In another embodiment, there may be one set of video conference device roles for the integrated phone, and a similar though enhanced set of roles for the integrated tablet, taking advantage of additional resources available on the tablet. In some embodiments, user interface 48-12-140 may allow the user to customize various aspects of the interfaces and roles associated with a video conference.

In some embodiments, the plurality of drop down menus 48-12-148 may include a drop down menu for selecting integrated device roles to be filled during a multichannel video conference (e.g. “shared workspace”, etc.). In other embodiments, said roles may be incorporated into the set of video conference roles.

In various embodiments, the user interface 48-12-140 may include a collection of drop down menus 48-12-150 specifying various audio and video channels to be associated with one or more use scenarios. For example, as shown, in one embodiment a user may specify the audio and/or video inputs and outputs to be used in the general, voice call, and video conference use scenarios. Possible inputs and outputs may include, but are not limited to, built-in speakers and microphones, external speakers and microphones, Bluetooth and other wireless audio and video devices, built-in cameras, external cameras, and/or any other input or output hardware which may be associated with an integrated device. Each drop down menu may list all of the options (e.g. tablet microphone, phone microphone, external microphone, etc.) available for each channel.

In some embodiments, the user interface 48-12-140 may include one or more lists of potential input and output sources which the user may reorder according to their desired priority. In one embodiment, there may be a list just for the general use scenario. For example, a user may order a list such that if an external speaker is connected to the tablet, it will have priority, otherwise the integration will prefer to use headphones connected to the phone. In another embodiment, there may be lists for each use scenario. For example, a user may specify that an external speaker be preferred over a Bluetooth headset in a general use scenario, but the Bluetooth headset have priority during a voice call. In still another embodiment, a user may specify a set of input and output priorities which are used in all use scenarios.

In some embodiments, the user may assign roles, inputs, and outputs for the general, voice call, and video conference use scenarios, as shown. In other embodiments, the user may specify roles, inputs, and/or outputs for other use scenarios. For example, in one embodiment, the user may make such specifications for the scenario where one of the integrated devices is being used to capture photos or video. As a specific example, a user may define roles for a photography use scenarios such that as the user takes photos with the phone, the captured images are immediately displayed on the tablet, where they may be tagged, retouched, or modified in some way.

In another embodiment, the user may use interface 48-12-140 or a similar interface to define preferred roles, inputs and outputs for use scenarios specific to particular applications. For example, a user could specify that, independent of how the general use scenario is defined, when a word processing application is being used, the phone display is used for an application specific user interface. See, for example, FIG. 40 of the previous application. In still another embodiment, a user may be able to define preferred roles, inputs, and outputs for use scenarios associated with a particular class of applications. For example, a user may define a particular set of audio input and output preferences to be used when playing a game.

In one embodiment, the user interface 48-12-140 may include a check box 48-12-152 to cause a user environment to be associated with and restored upon application of that particular integration profile. In the context of the present description, a user environment refers to the set of running applications, open documents, and/or settings which are in use at a particular time. By selecting check box 48-12-152, the environment that was in use the last time this particular integration profile was used will be restored as part of the next application.

In other words, if a user was running a particular application, viewing a particular document, and/or using a particular setting (e.g. sound volume, display brightness, etc.) the last time the integration association with this profile was disintegrated, that application/document will be restored the next time the profile is applied. This may be useful for integration profiles associated with a particular use context, such as being at work. As an option, in one embodiment, a user may be able to specify which aspects (e.g. applications, documents, settings, etc.) are preserved as part of a user environment.

In some embodiments, the application of an integration profile may cause the previous user environment to be restored. In other embodiments, the specifics of the user environment which is restored may be determined by previously observed user behavior. For example, if a user is observed running a particular application, using a particular system setting, or viewing a particular document (or website), at a particular time of day, that might be part of the user environment which is restored, depending on the time of day when the environment is restored.

As a specific example, a user may define an integration profile for use at their place of business, and specify that the user environment be restored. Historically, this user may spend the early morning sending and reading email, and then reviewing spreadsheets until lunchtime. Depending on the time of day when that user's “business integration” profile is applied, an email client may be opened showing unread email, or a spreadsheet application may be opened displaying the most recent document.

The user interface 48-12-140 may be utilized to define how phone events are handled by the integration. In one embodiment, the user interface 48-12-140 may include a collection of check boxes 48-12-154 associated with different methods of handling phone events. In another embodiment, this user interface may also include a button to allow the user to configure the selected method.

In one embodiment, the collection of phone event handling methods 48-12-154 may include a check box 48-12-156 to specify that phone events be handled on the tablet, using a native interface (i.e. using user interface elements native to the tablet, as opposed to images of UI elements generated by the phone). In this way, the larger display of the tablet may be utilized, allowing the user to deal with phone events without overly disrupting their use of the tablet.

In various embodiments, handling phone events through a native tablet interface may be accomplished through the insertion of hooks. For example, in one embodiment, one or more hooks may be inserted at runtime on the phone which intercept API calls, system events, and/or any other signal or occurrence associated with a need for user intervention (e.g. a dialog box, a warning message, etc.) or attention (e.g. an alert sound, a screen flash, etc.), and pass on the relevant information to the integrated tablet in the form of a phone event summary.

In one embodiment, the collection of phone event handling methods 48-12-154 may include a check box 48-12-158 to specify that phone events be handled on the tablet, using a virtual phone interface. In the context of the present description, a virtual phone interface refers to displaying at least a portion of a user interface or graphic generated by the integrated phone on the tablet, where the user may interact with it. In this way, phone events may be handled on the tablet through a familiar, predictable user interface. In some embodiments, this may be done without requiring the use of hooks, or having to modify phone application code to handle use while integrated.

In some embodiments, a virtual phone interface may be displayed which shows the entire phone display on the tablet. For example, in one embodiment, the virtual phone interface may be presented to the user framed within a depiction of the integrated phone. It should be noted that the use of a virtual phone interface does not require the phone display to be used. For example, the phone display may be turned off to preserve battery power, while the data

In other embodiments, only new or modified portions of the phone display may be shown in the virtual phone interface. For example, if the phone event involves the display of a dialog box, or updating an application icon with a badge or label, only that altered or new element may be shown on the tablet. In this way, phone applications do not have to include special code for integration, and the amount of graphical data sent to the tablet is reduced. In one embodiment, this virtual phone interface may be created by comparing the intended phone display with a display predating the phone event.

In one embodiment, the collection of phone event handling methods 48-12-154 may include a check box 48-12-160 to specify that phone events be handled on the phone, interrupting whatever role the phone may be filling at the time. This method makes the user experience more predictable and intuitive, with processes running on the phone being dealt with on the phone, and processes running on the tablet being dealt with on the tablet.

In one embodiment, user interface 48-12-140 may include a check box 48-12-162 which allows the user to specify that they be notified on the tablet before an interface for handling a phone event is presented. This would prevent a phone event from overly disrupting activity on the tablet, for instance, by obscuring a portion of the display. In various embodiments, these phone event notifications may be presented in a manner whose purpose is to avoid disturbing the user. For example, in one embodiment, phone event notifications may be incorporated into whatever system the tablet uses for notifications local to the tablet. In another embodiment, phone event notifications may be displayed using status icons located along the border of the tablet display. In yet another embodiment, phone event notifications may be made by momentarily displaying a representative icon on the tablet display. In still another embodiment, phone event notifications may be communicated to the user using a tone, or other sound.

In some embodiments, the user may interact with these phone event notifications to activate the phone event handling method selected in user interface 48-12-140. In other embodiments, interacting with the phone event notifications may provide the user with one or more choices, which may include, but are not limited to, activating a phone event handling method, or dismissing the phone event.

As shown, user interface 48-12-140 may include buttons 48-12-164 which allow the user to save the defined integration functionality settings, load an already defined set of integration functionality settings, or to revert to the previous settings and return to the previous user interface, in accordance with one embodiment. In some embodiments, the user may be given the option to give a name to the defined set of integration functionalities. In other embodiments, the loading and/or saving of settings may be done using the name given to the associated integration profile.

FIG. 48-12C shows a user interface 48-12-170 for defining application migration settings as part of an integration profile, in accordance with one embodiment. As an option, user interface 48-12-170 may be implemented in the context of the architecture and environment of the previous Figures or any subsequent Figure(s). Of course, however, user interface 48-12-170 may be implemented in any desired environment. It should also be noted that the aforementioned definitions may apply during the present description.

In one embodiment, user interface 48-12-100 of FIG. 48-12A may include a button 48-12-132 which allows the user to define or modify how the integration will handle the use of virtual machines and/or virtual applications. In various embodiments, selecting button 48-12-132 may present a different user interface. For example, in one embodiment, user interface 48-12-170 may be used to define how virtual machines and/or virtual applications will be utilized by integration.

As shown, user interface 48-12-170 may include a list 48-12-172 which allows the user to define which items will be migrated as part of the integration. In various embodiments, migration preferences may be specified with varying degrees of granularity. For example, in one embodiment, migration preferences may be defined for specific applications, all applications of a specific type (e.g. entertainment, communication, productivity, etc.), or all applications of a specific status (e.g. actively running, inactive, recently active, etc.). In other embodiments, preferences may be defined for other groupings of applications, including type of software license, application executable size (to ensure a rapid migration, etc.), and/or any other grouping.

In various embodiments, each row in list 48-12-172 may include text (e.g. “Productivity”, “Active”, “Calendar”, etc.), and one or more buttons to indicate a migration preference. For example, as shown, each row of the list includes text as well as a set of radio buttons 48-12-174 used to indicate migration settings, in accordance with one embodiment.

In some embodiments, there may be token items in list 48-12-172, which represent a dynamic group of applications whose members are determined at the time of integration. Such token items may include, but are not limited to, running applications and/or recently used applications.

In one embodiment, the set of migration options 48-12-174 may include a radio button indicating that an application or set of applications should always be automatically migrated as virtual applications or as part of a virtual machine when the integration profile is applied. In another embodiment, a user may further specify that if a particular application or set of applications are not running at the time of integration, they should be executed on the phone, then transferred as a virtual applications or as part of a virtual machine. This may be useful in cases where a user may not be certain that a crucial application will be available on an integrated tablet which is not exclusively under the user's control (e.g. a shared or borrowed tablet, etc.).

In one embodiment, the set of migration options 48-12-174 may include a radio button indicating that an application or set of applications should never be automatically migrated as virtual applications or as part of a virtual machine when the integration profile is applied. This may be useful for applications which the user may be confident will be installed on the integrated tablet, and which do not need local data, or which store their data on an external server, such as a cloud server. Designating such applications as off limits to automatic migration reduces the number of decisions the user may have to make at the time of integration.

In one embodiment, the set of migration options 48-12-174 may include a radio button indicating that a user should be prompted whether or not an application should be transferred as a virtual application or as part of a virtual machine via a live migration. In some cases, the user may which to limit such a prompt to the applications which are running at the time the integration profile is applied. However, a user may wish to be prompted regarding recently run applications, or applications which are often run, and not present on the tablet.

In some embodiments, the radio buttons which make up the set of migration options 48-12-174 may vary in appearance, depending upon how the button was selected. For example, in one embodiment, if a particular application is designated to always migrate because it is part of a group, the toggled radio button for that item may be a different color than buttons where were explicitly selected by the user. In this way, the user may be aware of what selections are due to a group, and which are explicit. This also makes it easier for a user to see where exceptions made for entire groups need to be made.

In some embodiments, items in list 48-12-172 may contain text describing a group (e.g. “Games”, “Active”, etc.) of applications or the name of a single application.

In other embodiments, this text may convey additional information. For example, in one embodiment, list items which represent groups of applications may indicate the number of applications within the group. In another embodiment, the style of the text (e.g. plain, italic, bold, etc.) may indicate whether or not the application is known to be installed on the tablet associated with that particular integration profile. In this way, a user may make a more informed decision whether or not an application should be forced to migrate as part of the integration process.

As shown, interface 48-12-170 may include a collection of drop down menus 48-12-176 which allow the user to organize items of list 48-12-172 by one or more criteria, in accordance with various embodiments. For example, in one embodiment, a user may specify a first, second, and third type of ordering for the list. Types of ordering may include, but are not limited to, by application name, by application status (e.g. running, recently run, inactive, etc.), by application type (e.g. games, productivity, etc.), by size (e.g. under 100 k, 100 k to 1 MB, etc.), and/or any other basis for grouping applications. In this way, a user may more easily specify migration preferences for groups of applications. As a specific example, a user may order the list by application type, and specify that all applications of the type “games” are to never be transferred during integration, through selecting a single button. Subsequently, a user may reorder the list, and specify that if a game is active, and under 500 k, it should always be migrated as part of integration.

In various embodiments, user interface 48-12-170 may include a button 48-12-178 which allows the user to specify that recently run applications should be indicated in list 48-12-172. For example, in one embodiment, recently run applications may be indicated by stylizing the item text in the list. In another embodiment, “recently run” may be one of the application status groups. As an option, the user may be able to specify how recent an application needs to have been run to qualify for this designation.

In one embodiment, user interface 48-12-170 may include a text field 48-12-180 which provides the user with a summary of all the migration settings which have been defined. In another embodiment, the partitioning of the summary may be identical to the set of migration options 48-12-174 (e.g. “always”, “never”, “ask”, etc.). As an option, the same stylization used in list 48-12-172 may also be used in text field 48-12-180, to convey the same information.

In some embodiments, user interface 48-12-170 may be used to specify application migration settings for virtual applications and/or virtual machines being migrated from the phone to the tablet as part of an integration. In other embodiments, user interface 48-12-170 may include buttons 48-12-182 which allow the user to parameterize a migration from phone to tablet, as well as a migration from tablet to phone. As an option, user interface 48-12-170 may be tabbed, with one tab for phone-to-tablet migration, and another tab for tablet-to-phone migration.

As shown, user interface 48-12-170 may include buttons 48-12-184 which allow the user to save the defined application migration settings, load an already defined set of application migration settings, or to revert to the previous settings and return to the previous user interface, in accordance with one embodiment. In some embodiments, the user may be given the option to give a name to the defined set of application migration settings. In other embodiments, the loading and/or saving of settings may be done using the name given to the associated integration profile.

FIG. 48-12D shows a user interface 48-12-190 for defining disintegration parameters as part of an integration profile, in accordance with one embodiment. As an option, user interface 48-12-190 may be implemented in the context of the architecture and environment of the previous Figures or any subsequent Figure(s). Of course, however, user interface 48-12-190 may be implemented in any desired environment. It should also be noted that the aforementioned definitions may apply during the present description.

In one embodiment, user interface 48-12-100 of FIG. 48-12A may include a button 48-12-134 which allows the user to define how and when the integration will end. In various embodiments, selecting button 48-12-134 may present a different user interface. For example, in one embodiment, user interface 48-12-190 may be used to define or modify the details and triggers for disintegration.

For example, in one embodiment, user interface 48-12-190 may include a slider 48-12-192 which allows the user to specify a threshold functional separation distance, or the functional distance at which a partial disintegration is initiated. As previously discussed, a functional distance may be represented as a unitless value, using units of distance, or using some other unit (e.g. signal strength, unique unit, etc.).

As shown, in one embodiment, user interface 48-12-190 may include a slider 48-12-194 which allows the user to specify a fatal functional separation distance. In the context of the present description, a fatal functional separation distance refers to the functional distance at which a full disintegration is triggered. In another embodiment, slider 48-12-194 may be used to specify an offset from an observed and/or calculated physical limit of the integration.

As a specific example, when first defining an integration profile to be associated with a particular location, the user may be prompted to leave one device at the most likely place of use (e.g. user's office, user's desk, etc.), and wander around with the other device, testing the limits of the integration. After determining the physical limitations, the user may utilize slider 48-12-194 to specify how close to this limit a full disintegration should be triggered.

In some embodiments, the range of sliders 48-12-192 and 48-12-194 may be static. In other embodiments, the range of one or both of these sliders may be dynamic. For example, in one embodiment, the upper limit of the threshold functional separation distance slider may be based upon (e.g. equal to, offset from, etc.) the currently defined fatal functional separation distance. In another embodiment, the upper limit of the fatal functional separation distance may be based upon the observed and/or calculated physical limits of the integration. For example, if it had been previously observed that the integration failed at a functional distance less than that chosen by the user, the user may be notified and the fatal functional separation distance may be modified.

In various embodiments, user interface 48-12-190 may include a text field displaying the current functional proximity between the two devices, if they are presently integrated and the integration profile is being defined using one of the devices. In one embodiment, the user interface may also include a button for each definable distance (e.g. threshold functional separation, fatal separation distance, etc.) which captures the value of the current functional proximity. This allows the user to simply arrange the devices in their desired positions and press a button, rather than guessing at a distance, or measuring. Additionally, this method takes into account the “functional” aspect of these distances (i.e. obstruction between the devices will increase the functional proximity, even if the spatial relationship remained unchanged).

In one embodiment, user interface 48-12-190 may include a slider 48-12-196 which allows the user to specify a fatal separation time. In the context of the present description, a fatal separation time refers to the maximum amount of time an integration may remain partially disintegrated (i.e. separated beyond the threshold functional separation distance) before a full disintegration is initiated. As an option, a user may disable this time limit, allowing the pair of devices to remain partially disintegrated indefinitely, so long as their separation remains between the threshold and fatal functional separation distances.

In one embodiment, user interface 48-12-190 may include a button 48-12-198 which allows the user to specify that any virtual applications and/or virtual machines which were migrated as part of the integration be migrated back to the originating device as part of the disintegration process. In another embodiment, this is may be specified on a per-application or per-group basis in a different user interface, such as 48-12-170.

Reversing the migrations performed at integration may increase the amount of time needed to disintegrate the devices. In one embodiment, specifying that the migrations should be reversed by selecting button 48-12-198 may inform the user the predicted amount of time and/or data transfer that such a reversal would take, based upon the currently defined application migration settings.

In another embodiment, specifying that the migrations should be reversed as part of disintegration may automatically modify the fatal functional separation distance, to ensure that the migration can reliably be completed before the integration fails due to physical limitations. As an option, this modification may be based upon previously observed user behavior, including, but not limited to, average walking speed, the average rate that communication channel signal strength degrades while partially disintegrated (as a function of time of day), and/or any other observable information which could be used to predict how quickly a partial disintegration may proceed to integration failure.

In one embodiment, user interface 48-12-190 may include a button 48-12-1100 which allows the user to specify that the user should be prompted before disintegration, having the option to migrate one or more currently active applications, independent of whether they were migrated at the time of integration. The timing of such a prompt may be based upon a number of factors. For example, in one embodiment, the prompt may be displayed at a time such that, should the user elect to migrate all active applications, the migration would be complete before integration failure. In another embodiment, the prompt may be displayed at a time such that, based upon observed user behavior, the migration of the set of applications most likely to be migrated will be complete before integration failure.

In one embodiment, user interface 48-12-190 may include a button 48-12-1102 which allows the user to specify that an anticipatory migration be initiated while the devices are partially disintegrated. Similar to the migration prompt previously discussed, the timing for the anticipatory migration may be based upon a number of factors. For example, in one embodiment, the start of the anticipatory migration may be triggered such that the bulk of the migration will be complete before the device separation is likely to have increased to the fatal functional separation distance. In another embodiment, the amount of resources (e.g. bandwidth, processor load, etc.) devoted to the anticipatory migration may depend upon how close the partially integrated devices are to reaching the fatal functional separation distance.

In one embodiment, user interface 48-12-190 may include a button 48-12-1104 which allows the user to specify that, upon disintegration, the devices will be restored to their pre-integration state. As a specific example, the devices may be restored to their previous sound volume, display brightness, active applications, and/or open documents. In another embodiment, the user may be able to specify what aspects will be restored upon disintegration. For example, a user may wish to restore their previous sound volume, but not return to a previous application, since they have since began working on something new.

As shown, user interface 48-12-190 may include buttons 48-12-1106 which allow the user to save the defined disintegration settings, load an already defined set of disintegration settings, or to revert to the previous settings and return to the previous user interface. In some embodiments, the user may be given the option to give a name to the defined set of disintegration settings. In other embodiments, the loading and/or saving of settings may be done using the name given to the associated integration profile.

FIG. 48-12E shows a user interface 48-12-1110 for defining integration channels as part of an integration profile, in accordance with one embodiment. As an option, user interface 48-12-1110 may be implemented in the context of the architecture and environment of the previous Figures or any subsequent Figure(s). Of course, however, user interface 48-12-1110 may be implemented in any desired environment. It should also be noted that the aforementioned definitions may apply during the present description.

In one embodiment, user interface 48-12-100 of FIG. 48-12A may include a button 48-12-136 which allows the user to specify which communications channels are to be used in the integration. In various embodiments, selecting button 48-12-136 may present a different user interface. For example, in one embodiment, user interface 48-12-1110 may be used to specify the settings and priority for the one or more communication channels available in integration.

In various embodiments, user interface 48-12-1110 may include a list 48-12-1112 of one or more potential communications channels to be used in an integration. In some embodiments, the user may use list 48-12-1112 to indicate a preferred order of importance for the various types of communications channels. Specifically, the first item on the list will be tried first; it an integration cannot be formed using that channel, the next channel will be attempted. In one embodiment, the user may drag items in the list to rearrange them. Furthermore, in one embodiment, each item in list 48-12-1112 may have a checkbox 48-12-1114 to indicate whether a channel may be used or not, as shown.

As shown, user interface 48-12-1110 may include buttons 48-12-1116 which allow the user to save the defined integration channel settings, load an already defined set of integration channel settings, or to revert to the previous settings and return to the previous user interface. In some embodiments, the user may be given the option to give a name to the defined set of integration channel settings. In other embodiments, the loading and/or saving of settings may be done using the name given to the associated integration profile.

FIG. 48-13 shows a plurality of user interfaces 48-13-00 for prompting a user to initiate an integration, in accordance with one embodiment. As an option, the plurality of user interfaces 48-13-00 may be implemented in the context of the architecture and environment of the previous Figures or any subsequent Figure(s). Of course, however, the plurality of user interfaces 48-13-00 may be implemented in any desired environment. It should also be noted that the aforementioned definitions may apply during the present description.

In various embodiments, the plurality of user interfaces 48-13-00 may be used to prompt a user regarding a potential integration. In one embodiment, plurality 48-13-00 may include user interface 48-13-02, which may be used to notify the user of a potential integration. As shown, the user interface 48-13-02 may include text field 48-13-04 which informs the user of a potential integration in a unobtrusive way, in accordance with one embodiment. In another embodiment, text field 48-13-04 may identify the detected device in one or more ways, including, but not limited to, a device name, a device make and model, a device owner, and/or any other identifying information. As an option, text field 48-13-04 may also indicate the last time an integration was performed with that device.

A user may be notified of a potential integration in other ways. In one embodiment, an icon may flash in a menu or status bar at the edge of a display, indicating that an integration may be possible. Interacting with the icon (e.g. touching it, clicking on it, etc.) may cause additional information to be displayed. In another embodiment, the potential integration may be indicated using sound and/or vibration. In still another embodiment, the user may be notified of a potential integration utilizing whatever method is used to display system events on the device.

In various embodiments, if the user takes no action, the notification presented in user interface 48-13-02 may disappear after a predetermined amount of time. If the user interacts with the notification (e.g. touch, clicking, etc.), the user may be presented with user interface 48-13-06. In one embodiment, user interface 48-13-06 may be used to prompt the user whether they want to proceed with an integration, or whether they wish to ignore the device in question. In another embodiment, the options and information provided by user interface 48-13-06 may be given through a popup menu, activated by interacting with the notification.

In one embodiment, user interface 48-13-06 may include button 48-13-08, which may be used to indicate that the user does not wish to perform an integration. Interacting with the button will dismiss the dialog box, and the user may resume normal operation of their device.

In one embodiment, user interface 48-13-06 may include button 48-13-10, which may be used to indicate that the user wishes to proceed with the integration. In various embodiments, if the user indicates that they wish to proceed with the integration, they may be presented with a dialog box similar to that shown in user interface 48-13-12.

In one embodiment, the plurality of user interfaces 48-13-00 may include user interface 48-13-12, which may be used to indicate the progress of the integration. As shown, user interface 48-13-12 may include a progress bar indicating how the integration is advancing, in accordance with one embodiment. As an option, the phase of integration (e.g. “handshaking”, “synchronizing integration profiles”, etc.) may also be indicated.

In various embodiments, user interface 48-13-12 may include button 48-13-14, which may be used to indicate that the user wishes to automate the integration process, to streamline the process in the future. In one embodiment, selecting button 48-13-14 may result in displaying an interface for defining an integration profile, such as the user interface depicted in FIG. 48-12A. As an option, the integration profile may be prepopulated with settings related to the context during which button 48-13-14 was activated. Specifically, the profile may be populated with contextual information such as the present location, whether or not one or both devices is running on battery power, the type of network being used, the time of day, and/or any other contextual information.

In various embodiments, user interface 48-13-12 may include button 48-13-16, which may be used to cancel the integration. In one embodiment, button 48-13-16 may cancel the integration and allow the user to return to their previous activity. In another embodiment, button 48-13-16 may cancel the integration and return the user to user interface 48-13-06.

In one embodiment, user interface 48-13-06 may include button 48-13-18, which may be used to indicate that the user does not wish to perform an integration, and furthermore wishes to ignore the device which triggered the prompt. In another embodiment, button 48-13-18 may present user interface 48-13-20 to the user. In the context of the present description, ignoring a device refers to suppressing any notifications which may be presented to a user regarding integrating with that device, and deactivating any integration profiles for that device which are triggered within the context of the ignore request. This allows a user to operate a device within the proximity of a potential integration without the repeated interruption of integration prompts.

In one embodiment, the plurality of user interfaces 48-13-00 may include user interface 48-13-20, which may be used to indicate how long, and in what context, a device should be ignored. As shown, user interface 48-13-20 may include a text field 48-13-22, which describes the device which will be ignored. In one embodiment, this description may be limited to the device's given name. In another embodiment, the description may include additional identifying information, such as make, model, owner, and/or any other identifying information. In still another embodiment, the description may be accompanied by an iconic representation of the device.

In various embodiments, user interface 48-13-20 may include a plurality of radio buttons 48-13-24 to indicate how long the device should be ignored. For example, in one embodiment, this collection of radio buttons may include one or more finite durations (e.g. 1 hour, 12 hours, 1 day, 1 week, etc.). In another embodiment, there may be a radio button associated with a text field, where the user may enter any duration they choose. In still another embodiment, the user may elect to ignore the device indefinitely.

In other embodiments, radio buttons 48-13-24 may include context based durations. For example, in one embodiment, a user may elect to ignore a device until they leave their present location. In other words, after they leave the present location, they will again be prompted concerning integration the next time they are in proximity to the device. As an option, the user may have to leave the location for a predefined amount of time.

As shown, the collection of radio buttons 48-13-24 may include a radio button 48-13-26 which provides an option for a customized “ignore” policy, in accordance with one embodiment. For example, in one embodiment, selecting this radio button may cause a collection of check boxes 48-13-28 representing contextual requirements to become available. In one embodiment, these contextual requirements are similar to those represented by the plurality of check boxes 48-12-122 depicted in FIG. 48-12A. This allows the user to ignore a device, but only in a particular set of circumstances. In some embodiments, the user may receive a warning if they have selected a set of contextual requirements that would conflict with a previously defined integration profile.

In one embodiment, user interface 48-13-20 may include button 48-13-30, which causes the ignore policy to be implemented. Furthermore, in one embodiment, user interface 48-13-20 may include button 48-13-32, which may be used to cancel the ignore policy and return to user interface 48-13-06.

FIG. 48-14 shows a plurality of user interfaces 48-14-00 for prompting a user regarding an automatic integration, in accordance with one embodiment. As an option, the plurality of user interfaces 48-14-00 may be implemented in the context of the architecture and environment of the previous Figures or any subsequent Figure(s). Of course, however, the plurality of user interfaces 48-14-00 may be implemented in any desired environment. It should also be noted that the aforementioned definitions may apply during the present description.

In various embodiments, the plurality of user interfaces 48-14-00 may be used to prompt a user regarding an automatic integration. In one embodiment, the plurality of user interfaces 48-14-00 may include user interface 48-14-02, which may be used to notify the user that an automatic integration is about to begin. As shown, the user interface 48-14-02 may include text field 48-14-04 which informs the user of the impending start of an automatic integration in an unobtrusive way, in accordance with one embodiment. In other embodiments, the user may be notified of the automatic integration in other ways, including, but not limited to, those methods previously discussed for notifying the user that a potential integration exists.

In various embodiments, a user may have a certain amount of time to intervene before an automatic integration is initiated. In one embodiment, this countdown may be indicated in the text field 48-14-04. In another embodiment, the passage of time may be indicated with a sound. For example, a device may make a sound when there are only 5 seconds remaining before the integration is automatically initiated.

In various embodiments, if the user takes no action, the integration will proceed automatically. In one embodiment, the text field 48-14-04 may be replaced with a progress bar, similar to that shown in user interface 48-14-12, depicting the advancement of the integration process. If the user does interact with the notification (e.g. touch, clicking, etc.), the user may be presented with user interface 48-14-06. In one embodiment, user interface 48-14-06 may be used to prompt the user whether they want to intervene in the automatic integration. In another embodiment, the options and information provided by user interface 48-14-06 may be given through a popup menu, activated by interacting with the notification.

In one embodiment, user interface 48-14-06 may include a text field 48-14-08, which identifies the other device involved in the automatic integration. In another embodiment, text field 48-14-08 may also show the time remaining before the integration proceeds. In some embodiments, the time given to the user to intervene in the automatic integration starts over once user interface 48-14-06 is displayed. In other embodiments, the time limit does not start over.

In one embodiment, user interface 48-14-06 may include a button 48-14-10, which causes the automatic integration to proceed immediately. As shown, selecting button 48-14-10 may cause user interface 48-14-12 to appear, in accordance to one embodiment. In a variety of embodiments, the plurality of user interfaces 48-14-00 may include user interface 48-14-12, which provides the user with an unobtrusive status bar 48-14-14, providing updates as to the progress of the integration without overly disrupting the use of the device. In other embodiments, the progress of the integration may be conveyed using another visual indicator, such as an animated status icon, or any other method of indicating progress.

In one embodiment, user interface 48-14-06 may include a button 48-14-16, which allows the user to modify the parameters of the automatic integration. For example, in one embodiment, selecting button 48-14-16 may present to the user the integration profile responsible for triggering the automatic integration, using a user interface such as the one depicted in FIG. 48-12A. In some cases, there may exist multiple integration profiles for the two devices in question. In one embodiment, the user may be informed of the existence of other profiles when presented with the profile actually responsible for the automatic integration.

FIG. 48-15 shows a plurality of user interfaces 48-15-00 for managing integration settings, in accordance with one embodiment. As an option, the plurality of user interfaces 48-15-00 may be implemented in the context of the architecture and environment of the previous Figures or any subsequent Figure(s). Of course, however, the plurality of user interfaces 48-15-00 may be implemented in any desired environment. It should also be noted that the aforementioned definitions may apply during the present description.

In various embodiments, the plurality of user interfaces 48-15-00 may be used to manage integration settings. In one embodiment, plurality 48-15-00 may include user interface 48-15-02, which may be used to activate or deactivate the ability of a device to integrate. As shown, the user interface 48-15-02 may include a text field 48-15-04 displaying the current device location accuracy limit. In the context of the present description, a location accuracy limit refers to the smallest discernable threshold distance. In various embodiments, the device location accuracy limit may be affected by GPS signal strength and the number of visible satellites, the number and identity of wireless networks detectable, and/or any other factor related to location determination. Reporting the accuracy limit to the user may help them best utilize the integration functionality. For example, they may be able to discern why an automatic integration is not triggering. In one embodiment, text field 48-15-04 may also display what the limiting factor is regarding the location accuracy, whether it is limited GPS signal, or the lack of a secondary location system, or some other factor.

In one embodiment, user interface 48-15-02 may include a switch 48-15-06, which may be used to enable or disable the integration functionality of the device. In another embodiment, this user interface may also be used to specify whether or not integration requests from other devices may be acknowledged. Furthermore, in one embodiment, user interface 48-15-02 may also include a button to display the integration profile for the current integration, if one exists.

In one embodiment, user interface 48-15-02 may include a button 48-15-08, which may be used to activate an integration profile manager. In various embodiments, selecting button 48-15-08 may result in displaying user interface 48-15-10, which may be used to manage one or more integration profiles. In some embodiments, integration profiles may be given user defined names. In other embodiments, the integration profiles may be identified by one or more of the key components of the profile, such as the identity of the devices, a location name, a time span, and/or any other part of the profile. In still other embodiments, integration profiles may be identified by both a given name, as well as items specific to the profile.

In various embodiments, user interface 48-15-10 may include a list 48-15-12 of integration profiles. As shown, in some embodiments, items in this list may be organized in a hierarchical fashion. In one embodiment, user interface 48-15-10 may include a collection of drop down menus 48-15-14, which allow the user to organize items of list 48-15-12 by one or more criteria. For example, in one embodiment, a user may specify a first, second, and third type of ordering for the list. Types of ordering may include, but are not limited to, by device identity, by location, by time, by profile name, and/or any other basis for grouping profiles. In some embodiments, if one or more of these criteria are not used, that information may be included for each item on the list.

As shown, in one embodiment, user interface 48-15-10 may include a check box 48-15-16 which allows the user to limit the items of list 48-15-12 to just the profiles which involve the device on which the interface is presently displayed. In some embodiments, a user's device may have access to integration profiles associated with that user which do not involve the present device. For example, in one embodiment, the profiles may be accessible from an external server. In another embodiment, the user's collection of profiles may be synchronized among devices every time an integration is performed.

In one embodiment, user interface 48-15-10 may include buttons 48-15-18, which may be used to create a new integration profile, or edit a profile which has been selected from list 48-15-12. Upon selecting one of these buttons, the user may be presented with an interface for defining or modifying an integration profile, such as those depicted in FIG. 48-12-1, in accordance with one embodiment.

In one embodiment, user interface 48-15-10 may include button 48-15-20, which may be used to clone an integration profile selected from list 48-15-12. Furthermore, in one embodiment, user interface 48-15-10 may include button 48-15-22, which may be used to delete a selected integration profile.

In one embodiment, user interface 48-15-10 may include a list 48-15-24 of observable devices. In some embodiments, the list of observable devices may include only devices with which integration is possible. In other embodiments, this list may include all detectible devices, independent of whether they are available for integration.

In various embodiments, the items in the list of observable devices 48-15-24 may be stylized to convey additional information. For example, in one embodiment, the text style (e.g. bold, etc.) of a list item may indicate whether or not an integration profile already exists for that device. As an option, the number of known integration profiles for that device may be indicated in the text description. In another embodiment, the text style (e.g. underlined, etc.) of a list item may indicate whether or not an integration has ever been formed between the observable device and the current device. In still another embodiment, the text style (e.g. italic, etc.) of a list item may indicate whether or not an observable device is available for integration.

In one embodiment, user interface 48-15-10 may include a button 48-15-26 to allow the user to define an integration profile for an observable device selected in list 48-15-24. As an option, if one or more integration profiles already exist for the selected device, the user may be presented with an interface listing the pre-existing integration profiles, and allowing the user to use one of these profiles as the basis for a new profile.

In one embodiment, user interface 48-15-10 may include a button 48-15-28 to allow the user to initiate an integration with a device selected from the list of observable devices. If an applicable integration profile already exists, it will be used, otherwise the default integration profile will be used. In some embodiments, if the selected device is not available for integration, button 48-15-28 may be disabled.

In one embodiment, user interface 48-15-10 may include a button 48-15-30 to allow the user to create or modify an ignore policy for a device selected from the list of observable devices. If selected, the user may be presented with user interface 48-13-20, as depicted in FIG. 48-13.

In one embodiment, user interface 48-15-10 may include a button 48-15-32 to allow the user to define or modify a default integration profile. If selected, the user may be presented with user interface 48-15-34, which may be used to define a default integration profile. As shown, user interface 48-15-34 possesses a number of features found within the user interfaces of FIG. 48-12A-48-12E, in accordance with one embodiment. Being a default profile, none of the contextual settings found in other integration profiles are needed. The remaining settings, such as communication channels, functionality, migration settings, and disintegration settings, may be defined in terms of priorities. For example, in one embodiment, the user may be given a list of potential values for each setting, which they may arrange according to their preferences. When the default profile is applied, each ordered group of settings is traversed in order of priority until an integration is successfully created.

FIG. 48-16 shows a plurality of user interfaces 48-16-00 for managing an integrated device, in accordance with one embodiment. As an option, the plurality of user interfaces 48-16-00 may be implemented in the context of the architecture and environment of the previous Figures or any subsequent Figure(s). Of course, however, the plurality of user interfaces 48-16-00 may be implemented in any desired environment. It should also be noted that the aforementioned definitions may apply during the present description.

In various embodiments, the plurality of user interfaces 48-16-00 may be used to manage, utilize, and monitor an ongoing integration from the display of one of the integrated devices. In one embodiment, plurality 48-16-00 may include user interface 48-16-02, which may be used to report the health of an integration at a glance. As shown, the user interface 48-16-02 includes status bar 48-16-04, which may be used to report the status of various aspects of the device (e.g. power, wireless signal, time, GPS status, etc.), and which remains visible in many use scenarios.

In various embodiments, status bar 48-16-04 may contain an icon 48-16-06 which is representative of the device's integration functionality. The appearance of the integration status icon may communication a variety of information. For example, in one embodiment, the appearance of the integration status icon may indicate whether or not there is an active integration. As a specific example, in one embodiment, if the integration status icon is only an outline, then there is no active integration. However, if the icon is solid, then there is an integration currently active.

In various embodiments, the color of the integration status icon 48-16-06 may represent the health of the presently active integration. In the context of the present description, the health of a integration refers to ease with which data may be sent between the two integrated devices. A determination of the health of a integration may be based upon wireless signal strength, bandwidth, network latency, and/or any other factor which may affect interdevice communications.

In some embodiments, this health may be reflected in the color of the integration status icon. For example, in one embodiment, a green integration status icon may indicate that the communication channel being used for the integration is operating in an ideal manner, while the color yellow may indicate that conditions are not ideal, but the integration is still stable. The color red may indicate that the health of the integration has degraded to the point that the user experience may be disrupted. Of course, in other embodiments, these colors may represent different levels of integration health, and different colors may be used.

In various embodiments, the integration status icon 48-16-06 may be used to indicate that the integration is disintegrating. For example, in one embodiment, a partial disintegration may be indicated by muting (i.e. reducing the saturation, etc.) the coloring of the status icon. In some embodiments, the details of a partial disintegration may be conveyed to the user through the integration status icon. For example, in one embodiment, the countdown to the fatal separation time may be indicated next to the integration status icon. In another embodiment, the interior, colored shading of the integration status icon may drain/fill up depending upon the current functional separation distance. In other words, if the icon is completely filled, the devices are about to reintegrate, and if the icon is completely empty, the fatal functional separation distance has been reached, and a full disintegration is about to begin.

In some embodiments, the integration status icon 48-16-06 may remain visible within status bar 48-16-04 at all times. In other embodiments, the integration status icon may periodically change into a different icon, to communicate various details regarding the integration to the user. For example, in one embodiment, if the signal strength of a communication channel unique to the other integrated device (e.g. cellular signal strength of an integrated phone, etc.) should fall below a certain level, the integration status icon may alternate between the usual symbol, and a symbol representing low signal strength. A similar method may be used to indicate that the other integrated device has low battery power.

In various embodiments, interacting with the integration status icon 48-16-06 may result in another interface being presented to the user. For example, in one embodiment, interaction with the integration status icon while there is an active integration may result in the display of user interface 48-16-08, which contains an integration status panel 48-16-10. As an option, this panel may appear to slide down from behind the status bar 48-16-04.

In various embodiments, an integration status panel may be used for controlling, modifying, initiating, and/or ending an integration. The contents of the panel may change, depending upon whether there is an active integration, and the nature of the other integrated device. For example, in one embodiment, integration status panel 48-16-10 may be used for controlling, modifying, and/or ending an ongoing integration.

As shown, integration status panel 48-16-10 may contain a text field 48-16-12, which provides information about the ongoing integration, in accordance with one embodiment. The information provided may include, but is not limited to, the identity of the other integrated device (e.g. given device name, device manufacturer and/or model, etc.), the name of the integration profile which was applied, the amount of time since the integration was created, and/or any other information regarding the integration.

In various embodiments, an integration status panel may provide information regarding the status of the other integrated device. For example, as shown, integration status panel 48-16-10 may indicate the other device's remaining battery charge (or whether it is connected to an external power source) through power status icon 48-16-14. As an option, the time remaining until the battery is fully charged may also be indicated. Furthermore, in some embodiments, integration status panel 48-16-10 may indicate the status of various other aspects of the other integrated device. For example, in one embodiment, the signal strength and network type of the other integrated device's cellular modem may be indicated using a cellular status icon 48-16-16. In another embodiment, the integration status panel 48-16-10 may indicate the amount of storage space that is available on the other integrated device.

In various embodiments, an integration status panel may allow the user to utilize functionality that is provided by the integration. For example, in one embodiment, integration status panel 48-16-10 may contain a phone icon 48-16-18, which may be used to open an interface for placing a phone call using an integrated phone. Examples of other functionality provided by or enhanced through integration which might be accessible through the integration status panel include, but are not limited to, video conferencing, video recording, enhanced input devices (e.g. using a phone as a custom input device, etc.), and/or any other functionality.

In various embodiments, an integration status panel may allow the user to perform functions otherwise delegated to a hardware interface on the other integrated device. For example, as shown, integration status panel 48-16-10 may contain an icon 48-16-20 which allows the user to “silence” incoming calls, similar to operating a physical “silence” switch on the integrated phone. As an option, the user may specify what this silent mode entails, whether all audible phone alerts are silenced, or whether all phone events are indicated through the integration status icon 48-16-06, without immediately employing one of the previously described phone event handling methods. In other embodiments, integration status panel 48-16-10 may contain similar iconic representations of other hardware functions of the other integrated device, such as putting the device into a sleep mode, activating a voice recognition mode, and/or any other functionality which may be accessed though a physical interaction with the other integrated device.

As shown, in one embodiment, integration status panel 48-16-10 may include a button 48-16-22 to give the user access to integration settings. For example, in one embodiment, interacting with button 48-16-22 may result in presenting the user with user interface 48-15-02 of FIG. 48-15-.

As shown, in one embodiment, integration status panel 48-16-10 may include a button 48-16-24 to allow the user to manually initiate a full disintegration. In some embodiments, the user may be prompted for confirmation before the disintegration begins, to prevent an accidental termination of the integration.

In various embodiments, the integration status icon 48-16-06 may be used to indicate the occurrence of a phone event. As previously discussed, in one embodiment, the user may have the option to be notified of a phone event before a phone event handling method is implemented. For example, in one embodiment, the occurrence of a phone event may cause the integration status icon to briefly change colors, pulse (i.e. change brightness in a cyclical manner, etc.), or any other kind of iconic animation. As an option, this indication may continue until the user manually dismisses the event or initiates a phone event handling method, as previously discussed. Of course, in the case where the phone is the prime display, similar interfaces and methods may be used to handle tablet events.

In various embodiments, interaction with the integration status icon in response to a phone event may result in the display of user interface 48-16-26, which contains a phone event notification panel 48-16-28. As an option, the phone event notification panel may appear to slide down from behind the integration status panel.

In some embodiments, a user may be notified of phone events through the same system used to notify regarding events which are local to the device serving as the prime display. In other embodiments, a user may be notified of phone events through a separate interface, such as the phone event notification panel 48-16-28. In some embodiments, the phone event notification panel may be displayed momentarily to the user, without requiring user input, in response to receiving a phone event summary from the integrated phone. In other embodiments, the phone event notification panel may only be shown in response to a user interaction, such as with the integration status icon 48-16-06.

In various embodiments, a phone event notification panel may be used to communicate the details regarding one or more phone events. The details which are reported for each phone event may include, but are not limited to, an event type (e.g. “SMS Message”, “Missed Call”, etc.), the name of the event-generating application (e.g. “ChessMaster”, etc.), the time and/or date of the event, amount of time elapsed since the event, an event summary (e.g. the first dozen words of a text message, an application status message, etc.), an icon representation of the event source (e.g. application icon, contact photo, etc.), a color indication of urgency, and/or any other information which could be conveyed as part of a phone event summary. In some embodiments, interacting with (e.g. touching, clicking on, etc.) a notification in the phone event notification panel may result in the initiation of an appropriate phone event handling method, as previously discussed.

In some embodiments, once a phone event notification panel has been displayed, it may be assumed that the user has been notified, and the notifications are removed automatically. In other embodiments, the notifications remain in the phone event notification panel until the user takes some action, whether it be initiating a phone event handling method, or dismissing the notification. In some embodiments, each notification may have a button 48-16-30 to clear the notification from the panel.

In various embodiments, interaction with the integration status icon while there is no active integration may result in the display of user interface 48-16-32, which contains an integration status panel 48-16-34. As an option, this panel may appear to slide down from behind the status bar 48-16-06.

An integration status panel will provide different options to the user, depending upon whether or not an integration is currently active. For example, in various embodiments, if there is no active integration, integration status panel 48-16-34 may contain a button 48-16-36 for manually initiating an integration. In some embodiments, interacting with button 48-16-36 may present the user with an observable device panel 48-16-38, which lists all devices which are detectable, and which are available for integration. This list may be formatted in a manner similar to observable device list 48-15-24 in FIG. 48-15. Furthermore, in one embodiment, observable device list 48-16-38 may contain an item labeled “Receive . . . ”, which may place the user's device in a state where it is receptive to integration attempts from other devices. This may make it easier for a user to integrate two devices for the first time.

FIG. 48-17A shows a plurality of user interfaces 48-17-600 for implementing a virtual phone interface, in accordance with one embodiment. As an option, the plurality of user interfaces 48-17-600 may be implemented in the context of the architecture and environment of the previous Figures or any subsequent Figure(s). Of course, however, the plurality of user interfaces 48-17-600 may be implemented in any desired environment. It should also be noted that the aforementioned definitions may apply during the present description.

In various embodiments, integration functionality may be utilized, and phone events may be handled, using a virtual phone interface, such as those depicted within the plurality of user interfaces 48-17-600. Utilizing the resources of one device through the interface of another may be a confusing concept for some users, and steps may be taken to make the operation of integrated devices more intuitive. For example, in one embodiment, virtual phone interface 48-17-602 may have the physical appearance of the integrated device it is being used to control.

A virtual phone interface may be displayed to a user under a number of circumstances. For example, in one embodiment, the user may specify that such an interface be displayed immediately in response to the receipt of a phone event summary. A user could define such a preference through user interface 48-12-140 of FIG. 48-12B. In another embodiment, the user could request that they be notified of a phone event before being presented with a virtual phone interface. In some embodiments, a user may be notified concerning a phone event through a change in the appearance of the integration status icon 48-17-604, and receive further information through a phone event notification panel, such as the one depicted in Figure x70. In one embodiment, virtual phone interface 48-17-602 may be displayed in response to the user interacting with an element within a phone event notification panel.

A phone event is not required to display a virtual phone interface. The user may wish to utilize functionality unique to the integrated device, using interface 48-17-602. In various embodiments, the user may cause a virtual phone interface to appear through an interaction with the integration status icon 48-17-604. For example, in one embodiment, the virtual phone interface may be activated by touching/clicking on the integration status icon, and holding down for a predetermined amount of time. In another embodiment, the virtual phone interface maybe activated by double tapping/clicking on the integration status icon. In still other embodiments, the virtual phone interface may be activated through a predefined touch gesture, or a predefined cursor gesture. As an option, the virtual phone interface 48-17-602 may appear to slide out of the side of the prime display. Furthermore, in another embodiment, the user may be able to specify which side of the screen the virtual phone interface is located on.

In various embodiments, the rest of the prime display may be obscured to some degree. This may be done to further convey to the user that they are controlling a different device through this new interface. For example, in one embodiment, the presence of user interface 48-17-602 may cause the remainder of the prime display to become slightly blurred. Other methods of obscuring the rest of the prime display may include, but are not limited to, desaturation of colors, a slight fading of brightness, a combination of these, and/or any other visual method of obscuring an image. As an option, a universal status bar (where the integration status icon 48-17-604 is located) may remain unchanged.

As shown, in one embodiment, virtual phone interface 48-17-602 may include a virtual phone display 48-17-606, which displays a video signal being created by the integrated phone. As previously mentioned, the display of the phone itself may be inactive, or filling a different role; the virtual phone display serves as a virtual display device, showing the user what they would see were they operating the phone in a disintegrated state.

In one embodiment, virtual phone display 48-17-606 may have a one-to-one pixel ratio with the actual display of the integrated phone. In another embodiment, there may be some form of scaling performed on the image displayed on the virtual phone display. In some embodiments, this scaling is performed on the phone, before transmission to the prime display. This could be useful in a situation where the integration is being maintained using a communication channel with limited bandwidth. In other embodiments, the scaling may be performed on the tablet, after transmission but before being displayed, taking advantage of potentially greater processing power possessed by the tablet.

Typically, phone applications are designed to be operated using a touchscreen interface. In some embodiments, assuming the prime display is touch sensitive, a user may interact with a virtual phone interface using touch, just as they would had they been using the phone directly. In one embodiment, the ability to interact with the virtual phone interface using touch may override a setting which renders the prime display unresponsive to touch input in other circumstances. As an option, only the virtual phone interface itself may become touch sensitive in such a situation.

In other embodiments, a user may interact with a virtual phone interface using a method other than touch. Input methods may include, but are not limited to, mouse, keyboard, trackball, trackpad, any combination of these, and/or any other input method. In one embodiment, a click with a cursor may be interpreted as a tap, and a click and drag with a cursor may be interpreted as a drag with a single finger. In another embodiment, there may be a set of predefined key combinations which may be used, in conjunction with a cursor, to perform common multitouch gestures. In this way, a user may interact with functionality localized on the integrated phone using a virtual phone interface without having to alter their method of input.

As shown, in one embodiment, virtual phone interface 48-17-602 may include a text field 48-17-608 identifying the integrated phone device. In another embodiment, text field 48-17-608 may be used to identify the integration profile being used. As an option, the age of the integration may be displayed.

As shown, in one embodiment, virtual phone interface 48-17-602 may include a plurality of buttons 48-17-610 which represent hardware buttons, switches, and other interfaces found on the actual integrated phone. Buttons 48-17-602 may be used to perform the same functions that their physical counterparts would perform on the integrated device. Such functions may include, but are not limited to, returning to a home screen, changing the system and/or ringtone volume on the phone, putting the phone into a sleep mode, and/or any other function which may be triggered by a hardware interface located on the integrated phone. In this way, a more intuitive user experience may be provided. Of course, in some embodiments, all of this functionality may be provided elsewhere, such as in the form of icons in an integration status panel, as previously discussed.

In one embodiment, virtual phone interface 48-17-602 may include a button 48-17-612 for closing the virtual phone interface. In some embodiments, activating button 48-17-612 may cause the transmission of a video signal from the phone to cease immediately. In other embodiments, activating button 07512 may cause the virtual phone interface to disappear, while the video signal continues to be transmitted from the integrated phone for a predetermined amount of time. In this way, a user may close the interface, and immediately open it back up without having to wait for the virtual phone display to connect to a new video signal from the phone. In one embodiment, the virtual phone interface may also be closed by double tapping/clicking outside of the interface.

The performance of the virtual phone display may be improved by reducing the amount of information being transmitted from the phone. In some embodiments, various aspects of the video signal sent by the integrated phone may be altered automatically to provide the best possible user experience (e.g. virtual display more responsive to input, less lag in displaying rapidly changing screen elements, etc.) In other embodiments, the user may be able to modify various aspects of the video signal being sent by the integrated phone. For example, in one embodiment, virtual phone interface 48-17-602 may include a button 48-17-614, which causes user interface 48-17-616 to be displayed. As an option, user interface 48-17-616 may be presented by causing the virtual phone interface 48-17-602 appear to flip over, exposing the back side of the virtual phone.

As shown, user interface 48-17-616 may be used to modify various aspects of the virtual phone interface, in accordance with one embodiment. For example, in one embodiment, user interface 48-17-616 may include a drop down menu 48-17-618 which allows the user to specify the color quality of the video signal. By reducing the number of colors used, less bandwidth may be used in transmitting the signal, potentially making the virtual phone display more responsive to rapidly changing screen elements. In one embodiment, the user may select from a variety of color bit-depths (e.g. 24-bit, 16-bit, etc.). In another embodiment, the user may be presented with a simplified set of color spaces (e.g. “best color”, “reduced color”, “greyscale”, etc.).

In one embodiment, user interface 48-17-616 may include a drop down menu 48-17-620 which allows the user to modify the refresh rate, or the frequency with which the virtual phone display is updated. Depending upon the nature of the user's activity within the virtual phone interface, the combination of a modified color quality with a modified refresh rate may provide an improved user experience. For example, in a situation where the user is working with an application whose interface does not change very often, or very rapidly, high color quality combined with a low refresh rate may provide a superior image with little noticeable lag. On the other hand, in a case where the interface is rapidly changing, a low color quality combined with a high refresh rate may provide superior responsiveness with a slight degradation in image quality. In one embodiment, the user may simply be given the choice between a high or low refresh rate. In another embodiment, drop down menu 48-17-620 may provide explicit refresh rates for the user to choose from. In some embodiments, the settings in drop down menus 48-17-618 and 48-17-620 may be linked, such that selecting a low color quality increases the refresh rate, and so forth. In other embodiments, these settings may remain independent.

In one embodiment, user interface 48-17-616 may include a drop down menu 48-17-622 which allows the user to modify the resolution of the video feed being transmitted by the integrated phone. A reduced resolution may provide a more responsive user experience. Additionally, if there are many other processes running on the integrated phone, such as applications which were not migrated during integration, transmitting a lower resolution video feed may free up needed processor resources. In some embodiments, the user may be given the choice of multiple resolutions. In other embodiments, the user's choices may be limited to a native resolution (e.g. full resolution of the phone, etc.), or a reduced resolution whose scaling is less processor intensive than others (e.g. both dimensions halved, etc.).

In one embodiment, user interface 48-17-616 may include a drop down menu 48-17-624 which allows the user to select a frame for the virtual phone interface. For example, in one embodiment, the user may select a “device” frame, such as the frame shown on virtual phone interface 48-17-602. Other possible frames include, but are not limited to, “native” (e.g. a frame which blends in with the rest of the tablet's native UI, etc.), “minimal” (e.g. a simple border, etc.), “none” (e.g. no visual barrier between the virtual phone display and the rest of the tablet interface, etc.), and/or any other type of frame which may be put around a virtual phone display.

In one embodiment, user interface 48-17-616 may include a button 48-17-626 which allows the user to save the modified settings and return to the virtual phone interface. Furthermore, in one embodiment, user interface 48-17-616 may include a button 48-17-628 which allows the user to return to the virtual phone interface without modifying the settings.

FIG. 48-17B shows a user interface 48-17-640 for implementing a virtual phone interface, in accordance with another embodiment. As an option, user interface 48-17-640 may be implemented in the context of the architecture and environment of the previous Figures or any subsequent Figure(s). Of course, however, user interface 48-17-640 may be implemented in any desired environment. It should also be noted that the aforementioned definitions may apply during the present description.

In some embodiments, the virtual phone interface may be pinned to one of the sides of the display. Additionally, the virtual phone interface may be at a fixed resolution. These constraints may interfere with the operation of the tablet while the virtual phone interface is active. However, in some embodiments, the user may have the ability to move and/or resize a virtual phone interface, such as virtual phone interface 48-17-640.

In one embodiment, virtual phone interface 48-17-640 may include a dynamic resizing element 48-17-642. In the context of the present description, a dynamic resizing element is a user interface element which allows a user to resize a window or panel. In one embodiment, this resizing may be performed by dragging the dynamic resizing element until the virtual phone interface is the desired size. As an option, the virtual phone interface may maintain the aspect ratio of the virtual phone display.

In one embodiment, virtual phone interface 48-17-640 may include a movable integration description 48-17-644, which allows a user to drag the virtual phone interface to a desired location within the prime display. Furthermore, in one embodiment, virtual phone interface 48-17-640 may include a transparency slider 48-17-646, which allows the user to modify the transparency of the virtual phone interface. In this way, the user may modify the virtual phone interface so that it interferes less with the operation of the integrated tablet. As an option, the transparency slider 48-17-646 may be hidden until the user hovers a cursor, or presses and holds a finger, over the area of the slider. Additionally, the other user interface elements of the virtual phone interface (e.g. close button, settings button, etc.) may fade out unless there is some sort of interaction nearby.

FIG. 48-17C shows a user interface 48-17-650 for implementing a virtual phone interface, in accordance with another embodiment. As an option, user interface 48-17-650 may be implemented in the context of the architecture and environment of the previous Figures or any subsequent Figure(s). Of course, however, user interface 48-17-650 may be implemented in any desired environment. It should also be noted that the aforementioned definitions may apply during the present description.

As shown, user interface 48-17-650 may include a virtual phone interface 48-17-652 as well as a scaled-down tablet interface 48-17-654, in accordance with one embodiment. In some embodiments, the dimensions of the virtual phone interface and tablet interface may be modified to reduce visual artifacts introduced by scaling. In some embodiments, one or both interfaces may be scaled down using pixel based methods. In other embodiments, the tablet interface 48-17-654 and/or the virtual phone interface 48-17-652 may utilize resolution independent methods of rendering text and other UI elements, to maintain usability even when scaled down.

Unlike other embodiments, user interface 48-17-650 does not overlap the virtual phone interface and the tablet interface, but rather presents them both in their entirety, albeit one or both interfaces are scaled down. In this way, the user may utilize the functionality unique to the phone through the virtual phone interface without interrupting their activities on the tablet.

In one embodiment, user interface 48-17-650 may include a status bar 48-17-656, which may include the usual status icons. Further more, in one embodiment, user interface 48-17-650 may include a virtual phone interface toolbar 48-17-658, which may be used to modify the virtual phone interface, as well as the integration itself.

In various embodiments, the virtual phone interface toolbar 48-17-658 may allow the user to utilize various aspects of the integrated phone. For example, in one embodiment, virtual phone interface toolbar 48-17-658 may include a button 48-17-660, which represents the hardware “home” button on the integrated phone, as well as a button 48-17-662, which represents the “silent” switch on the integrated phone. In other embodiments, other hardware buttons found on the integrated phone may be represented in the toolbar in iconic form. In still other embodiments, additional functionality unique to the phone (e.g. cellular phone interface, etc.) may also be represented on the toolbar in iconic form.

In various embodiments, the virtual phone interface toolbar 48-17-658 may allow the user to modify one or more parameters associated with the virtual phone interface. For example, in one embodiment, toolbar 48-17-658 may include a collection of drop down menus 48-17-664 which may allow the user to modify the color quality, refresh rate, and/or resolution of the video feed being sent from the phone to the virtual phone interface, as previously discussed in FIG. 48-17A.

In various embodiments, the virtual phone interface toolbar 48-17-658 may allow the user to modify one or more aspects of the ongoing integration. For example, in one embodiment, toolbar 48-17-658 may include a button 48-17-666 which may allow the user to modify the integration profile currently in use. In another embodiment, toolbar 48-17-658 may include a button 48-17-668 which may initiate a manual disintegration.

Finally, as shown, in one embodiment, the user interface 48-17-650 may include a button 48-17-670, which allows the user to dismiss the virtual phone interface. In some embodiments, the dismissal of the virtual phone interface may cause the tablet interface 48-17-654 to expand, pushing the toolbar 48-17-658 and virtual phone interface 48-17-652 off of the display.

FIG. 48-18 shows a user interface 48-18-00 for facilitating the operation of touch sensitive applications without the use of touchscreen, in accordance with one embodiment. As an option, user interface 48-18-00 may be implemented in the context of the architecture and environment of the previous Figures or any subsequent Figure(s). Of course, however, user interface 48-18-00 may be implemented in any desired environment. It should also be noted that the aforementioned definitions may apply during the present description.

In various embodiments, a user may desire to utilize a form of input that is not based upon touch when operating a pair of integrated devices. If both displays are being used, it is likely that neither device is being held by the user, but rather both are resting on a mount or some other stable surface. In such a case, the user may wish to use a keyboard and some sort of cursor based device (e.g. mouse, trackball, trackpad, etc.).

In many embodiments, basic touch interactions may be performed with a cursor-based form of input without difficulty. For example, a finger tap may be performed with the click of a mouse button; dragging actions are similarly equivalent. However, since software designed to be used with a touchscreen may sometimes employ touch gestures, or multitouch gestures, representative actions which use a keyboard and/or a cursor based device may be needed.

In various embodiments, user interface 48-18-00 may be used to facilitate the operation of touch sensitive applications using a keyboard and a cursor-based form of input. Further discussion will be done with respect to a mouse, but the same or similar methods and interfaces may be employed when working with other cursor-based inputs, such as a trackball.

In various embodiments, multitouch gestures may be simulated using mouse-based gestures combined with keyboard shortcuts. In some embodiments, these keyboard shortcuts may always be available for use. In this way, the barrier to the performance of these gesture replacements is reduced.

In other embodiments, user interface 48-18-00 may include check box 48-18-02, which allows a user to indicate that they wish to condition the availability of the gesture replacements upon the performance of an activation/deactivation keyboard shortcut. For example, in one embodiment, if the user has selected check box 48-18-02, a shortcut capture element 48-18-04 may become available.

In the context of the present description, a shortcut capture element refers to a user interface element which allows a user to define a keyboard shortcut associated with a command or function. In various embodiments, this element may include a text field which describes the one or more keys which must be pressed to employ the shortcut, and a button to allow the user to specify the keys. For example, as shown, activation shortcut element 48-18-06 may include a text field 48-18-04 and a button 48-18-08. As an option, when the user activates the button in a shortcut capture element, they may be prompted to perform the desired key press or key combination. The text field is then updated with the user's input. In some embodiments, shortcuts may be required to involve one or more modifier keys (e.g. shift, control, option, alt, command, etc.). In other embodiments, the user may define a shortcut using any key or combination of keys. As an option, a user may be warned if they have defined a shortcut that conflicts with a known system shortcut.

In some embodiments, activating the gesture replacement shortcuts using the activation shortcut may result in their being available for a limited amount of time.

As an option, a status icon representing the gesture replacements may appear in a status bar while the gesture replacement shortcuts are available. In other embodiments, the gesture replacement shortcuts may remain available for use until the activation shortcut is performed again. As an option, a status icon representing the gesture replacements may appear in a status bar while the gesture replacement shortcuts are available.

As shown, user interface 48-18-00 may include a shortcut capture element 48-18-10, which allows the user to define a shortcut to assist in the performance of a two-finger pinch or two-finger spread gesture, in accordance with one embodiment. The shortcut is used to set an anchor point, or in other words, to define where the first of the two fingers would be. As a specific example, the user may hold the shortcut keys (e.g. control+command, etc.) down, move the cursor to where the second finger would be, then click and drag in a direction, replicating a pinch or spread motion with respect to the two points.

As shown, user interface 48-18-00 may include a shortcut capture element 48-18-12, which allows the user to define a shortcut to assist in the performance of a two-finger tap or swipe, in accordance with one embodiment. The shortcut is used to represent the presence of a second finger (the cursor representing the first). As a specific example, the user may hold the shortcut key (e.g. option, etc.) down, and perform the desired gesture with the cursor. In other words, a two-finger tap may be performed by holding down option and clicking the mouse, while a two-finger swipe may be performed by holding down option, then clicking and dragging in the desired direction.

As shown, user interface 48-18-00 may include shortcut capture elements 48-18-14 and 48-18-16, which allow the user to define shortcuts to assist in the performance of three- and four-finger tabs and swipes, in accordance with one embodiment. Similar to the two-finger shortcut, these shortcuts are used to represent the presence of additional fingers. In many embodiments, the gesture replacements for three- and four-finger taps and swipes are identical to those representing two-finger taps and swipes, apart from the different shortcuts.

As shown, user interface 48-18-00 may include a collection of radio buttons 48-18-18, which allow the user to specify which mouse button must be pressed to perform the gesture replacements, in accordance with one embodiment. For example, in one embodiment, collection 48-18-18 may include buttons for the right mouse button and left mouse button. In some embodiments, other options may be available, such as a third mouse button and/or scroll wheel. In other embodiment, the options presented to the user in collection 48-18-18 may be dynamic, changing depending upon the input devices detected and/or required by an active integration profile.

In some embodiments, additional gesture replacements may be available, depending upon the nature of the cursor-based input device. For example, in one embodiment, the use of a mouse with a scroll wheel may result in user interface 48-18-00 including shortcut capture elements for multi-finger rotation and/or flicking.

In one embodiment, user interface 48-18-00 may include a button 48-18-20 which allows the user to save the modified settings and dismiss the interface. Furthermore, in one embodiment, user interface 48-18-00 may include a button 48-18-22 which allows the user to dismiss the user interface without modifying the settings.

FIG. 48-19- shows a plurality of user interfaces 48-19-00 for receiving and responding to a voice call, in accordance with one embodiment. As an option, the plurality of user interfaces 48-19-00 may be implemented in the context of the architecture and environment of the previous Figures or any subsequent Figure(s). Of course, however, the plurality of user interfaces 48-19-00 may be implemented in any desired environment. It should also be noted that the aforementioned definitions may apply during the present description.

In various embodiments, integration functionality may be utilized, and phone events may be handled, using a native tablet interface, such as those depicted within the plurality of user interfaces 48-19-00. The use of native tablet interfaces to perform integrated functions, or to take advantage of integrated hardware, provides a superior user experience, blurring the line between the devices to the point that all functionality appears to be provided by a single device.

In many embodiments, the user interface 48-19-02 may resemble what a user would see when receiving a voice call while using a pair of integrated devices. Before the incoming call, the only indication the user may have that they are using an integrated system may be the presence of an integration status icon 48-19-04 within a status bar 48-19-06, in accordance with one embodiment. In some embodiments, the availability of voice call functionality (e.g. the ability to place a call on a cellular voice network, VOIP network, etc.) may be indicated by the presence of an integrated phone status icon 48-19-08 within the status bar.

In some embodiments, an incoming voice call may cause an integrated system to display a native tablet pre-call interface 48-19-10, providing the user with a plurality of actions which may be taken in response to the call, as well as information about the caller. In other embodiments, user action may be required before interface 48-19-10 may be displayed. For example, in one embodiment, if the user has placed the integrated system into “silent” mode (e.g. using button x7020 of FIG. 48-16, etc.), an incoming voice call may be indicated visually using integrated phone status icon 48-19-08 (e.g. pulsing, flashing, color change, etc.). As an option, minimal information regarding the identity of the caller may also be displayed near the status icon 48-19-08 (e.g. a miniature contact photo, an abbreviated name, etc.). If the user interacts with (e.g. taps, clicks on, etc.) the integrated phone status icon 48-19-08 in response to an incoming call notification, native tablet pre-call interface 48-19-10 may be displayed, in accordance with one embodiment.

A pre-call interface may display the usual identifying information. For example, as shown, native tablet pre-call interface 48-19-10 may include a text field 48-19-14 containing the identity of the caller (e.g. a name, Caller ID data, a phone number, etc.), in accordance with one embodiment.

In various embodiments, pre-call interface 48-19-10 may include a text field 48-19-12. In some embodiments, text field 48-19-12 may display identifying information associated with a caller. Identifying information may include, but is not limited to, the caller's name, the caller's phone number, a caller ID message (e.g. “PRIVATE”, “WITHHELD”, etc.), a nickname or other data pulled from a user's contact record for the caller, and/or any other descriptive information.

In various embodiments, pre-call interface 48-19-10 may include descriptive graphic element 48-19-14. The contents of graphic element 48-19-14 may vary, depending on the nature of the caller. For example, in one embodiment, if the caller exists within a collection of contacts stored on either integrated device, a contact photo may be displayed within graphic element 48-19-14. In another embodiment, if the caller is not one of the user's contacts, graphic element 48-19-14 may display the location associated with the caller (e.g. area code, phone number prefix, etc.). In still another embodiment, if the caller is not one of the user's contacts, graphic element 48-19-14 may display an iconic representation of a person.

One of the advantages of an integrated system is that it may combine the voice call functionality of a phone with the larger display of a tablet, thus allowing for a greater amount of information related to a voice call to be displayed. In many embodiments, native tablet pre-call interface 48-19-10 may include a caller information panel 48-19-16, which may display a variety of information about the caller. As an option, caller information panel 48-19-16 may appear to slide out from behind graphic element 48-19-14. Furthermore, in some embodiments, the caller information panel may be resizable, allowing the user to make use of a large tablet display.

In one embodiment, caller information panel 48-19-16 may display whatever information is available from the user contact data stored on either integrated device (e.g. address, company, email, notes, etc.). In another embodiment, caller information panel 48-19-16 may include related information from calendar data stored on either integrated device (e.g. upcoming calendar events associated with the caller or the caller's organization, etc.).

In yet another embodiment, caller information panel 48-19-16 may display location data for the caller, such as data obtained from a social geolocation sharing service. Specifically, if the caller has previously granted the user permission to receive their location data, caller information panel 48-19-16 may display that data. In one embodiment, this location data may be displayed in the form of a street address. In another embodiment, this location data may be displayed in the form of a map, which may or may not also display the street address. In some embodiments, if the caller has not granted the user permission to know their location, caller information panel 48-19-16 may include a button in place of the location data, which would send a request to the caller, asking for permission to see their location. As an option, the user may specify whether the request is for permanent permission, or for a limited amount of time (e.g. 24 hours, etc.).

In still another embodiment, caller information panel 48-19-16 may display location data derived from the caller's phone number (e.g. area code, phone number prefix, etc.). As an option, in the case where the caller's identity is unknown, caller information panel 48-19-16 may display upcoming calendar events which are occurring near the geographic area associated with the caller's phone number, if that location is distinctly different from the user's current position. As a specific example, if the user had recorded a calendar event for next week, taking place in a distance city, and then receives a phone call from a hotel in that city, the user may be reminded of the upcoming event within the caller information panel.

In another embodiment, caller information panel 48-19-16 may display information regarding the caller obtained from a third party. Possible information sources may include, but are not limited to, reverse phone number lookup service, telemarketing reporting services, weather services, news services, and/or any other service which may provide information based upon a phone number or location.

In various embodiments, the information displayed within native tablet pre-call interface 48-19-10, or any other interface, may be automatically linked to appropriate data handlers using data detection methods. For example, if caller information panel 48-19-16 provides a street address for a caller, interacting with that address (e.g. tapping, clicking, etc.) may activate a mapping application displaying the location of the address, and providing directions for how to travel there. Other data which may be automatically linked to appropriate applications may include, but is not limited to, phone numbers, email addresses, street addresses, dates, and web URLs.

In many embodiments, native tablet pre-call interface 48-19-10 may include a communication history panel 48-19-18, which may display previous communications with the caller. As an option, communication history panel 48-19-18 may appear to slide out from behind graphic element 48-19-14. Furthermore, in some embodiments, the communication history panel may be resizable, allowing the user to take advantage of a large tablet display.

In various embodiments, communication history panel 48-19-18 may be organized as a series of tabs, each tab representing a form of communication which has previously been made with the caller. For example, in one embodiment, communication history panel 48-19-18 may include call history tab 48-19-20, to allow the user to view previous voice calls with the caller. In one embodiment, the user may be able to specify whether call history tab 48-19-20 displays missed calls, completed calls, or both. In another embodiment, call history tab 48-19-20 may also indicate the date the call was made, whether it was incoming or outgoing, and/or how long the call lasted. In some embodiments, call history tab 48-19-20 may also include data concerning previous video conferences. In other embodiments, video conference history may be provided in a separate tab. As an option, a video conference history tab may also identify all participants in a video conference. Other possible tabs include, but are not limited to, social network messages, instant messages, and/or any other form of communication.

In one embodiment, communication history panel 48-19-18 may include SMS history tab 48-19-22, to allow the user to view previous SMS messages sent to and received from the caller. In one embodiment, the user may be able to specify whether SMS history tab 48-19-22 is organized by discrete conversations, or whether all previous SMS messages involving the caller are presented as one collection. As an option, SMS history tab 48-19-22 may combine the SMS historical data stored on both integrated devices, creating a single history.

In one embodiment, communication history panel 48-19-18 may include email history tab 48-19-24, to allow the user to view previous emails sent to and received from the caller. In one embodiment, the user may be able to specify whether email history tab 48-19-24 is organized as hierarchical threads, or as a flat collection of messages. In another embodiment, the user may be able to specify whether email history tab 48-19-24 displays received emails, sent emails, or both.

In one embodiment, the user may only the data from one tab at a time within communication history panel 48-19-18. In another embodiment, the user may select more than one tab, causing communication history panel 48-19-18 to present the combined historical communication data as a single set. As an option, the data may be ordered chronologically. In still another embodiment, the user may be presented with a timeline indicating all communication events when more than one tab has been selected within the communication history panel 48-19-18. In yet another embodiment, the user may be able to specify the type of data displayed, and in what form, for each tab, through an interaction (e.g. touch and hold, right click, etc.) with the tab title, which may display a drop down menu with various options.

In one embodiment, the user may be able to use communication history panel 48-19-18 to search through past communications involving the caller. As an option, the user may be able to constrain the search to a certain period of time. In another embodiment, the user may be able to search specific portions of the communications (e.g. other recipients, senders, subject, content, contains image, etc.).

In various embodiments, the native tablet pre-call interface 48-19-10 may include a collection of buttons 48-19-26 which provide a plurality of response options to the user. For example, in one embodiment, collection 48-19-26 may include button 48-19-28, which may be used to answer the incoming call. In some embodiments, upon answering a call, the user may be presented with a native tablet in-call interface, such as the one shown in user interface 48-19-60.

In some embodiments, an integrated system may utilize the display of only one device. In other embodiments, an integrated system may make use of the displays of both devices, a prime display and a secondary display. In some cases, elements of a user interface may be spread across both screens. For example, in one embodiment, the collection of buttons 48-19-26 may be displayed on a secondary display.

In one embodiment, collection 48-19-26 may include button 48-19-30, which may be used to silence the incoming call. In various embodiments, button 48-19-30 may provide different functionality, depending upon how the user interacts with it. For example, in one embodiment, if the user taps or clicks on button 48-19-30, the incoming call may be silenced. In another embodiment, if the user has an extended interaction with button 48-19-30 (e.g. touch and hold, click and hold, right click, etc.), the user may be presented with the option of creating a policy to always silence calls coming from this particular caller. In one embodiment, such policies may be managed through a different user interface.

In some embodiments, the silence button 48-19-30 may only silence the ringtone. In other embodiments, button 48-19-30 may also dismiss the native tablet pre-call interface 48-19-10. In one embodiment, silencing an incoming call means that the call is ignored, and bypasses voicemail. In another embodiment, the silenced call may still go to voicemail.

In one embodiment, collection 48-19-26 may include button 48-19-32, which may be used to send the incoming call to a voicemail system. In various embodiments, button 48-19-32 may provide different functionality, depending upon how the user interacts with it. For example, in one embodiment, if the user taps or clicks on button 48-19-32, the incoming call may be sent to a voicemail. In another embodiment, if the user has an extended interaction with button 48-19-32 (e.g. touch and hold, click and hold, right click, etc.), the user may be able to choose from a plurality of prerecorded messages to play for the caller before sending them to a voicemail system.

In some embodiments, if the user taps or clicks on button 48-19-32, the integrated system may utilize the most appropriate prerecorded message in conjunction with a voicemail system. The most appropriate prerecorded message may be determined based upon one or more criteria, including, but not limited to, previous user behavior (e.g. what messages have been used for this caller in the past, etc.), the identity of the caller (e.g. is the caller one of the user's contacts, an unknown individual, etc.), and/or contextual information (e.g. time of day, day of the week, location of the user, the user's velocity, active integration profile, etc.). In one embodiment, the prerecorded message may also include a device generated audio message.

As a specific example, in one embodiment, if a user's calendar indicates that the user is traveling, the prerecorded message presented to a caller found within the user's contact data may indicate that the user is out of town. In one embodiment, context-based audio messages may be managed through a user interface.

In one embodiment, collection 48-19-26 may include button 48-19-34, which may be used to send a reply message to the caller via some method other than a voice call. These methods may include, but are not limited to, email, SMS message, social network messaging, instant messaging, and/or any other form of messaging. In various embodiments, button 48-19-34 may provide different functionality, depending upon how the user interacts with it. For example, in one embodiment, if the user taps or clicks on button 48-19-34, the user may be presented with an interface where they may input a reply message to be sent using a predefined default method. In another embodiment, if the user has an extended interaction with button 48-19-34 (e.g. touch and hold, click and hold, right click, etc.), the user may be able to choose from a plurality of methods with which to send a message to the caller in response to their voice call.

In some embodiments, if the user taps or clicks on button 48-19-34, the integrated system may utilize the most appropriate form of communication to reply to the caller. The most appropriate form of communication may be determined based upon one or more criteria, including, but not limited to, observed user behavior (e.g. what has the user done in this situation in the past, etc.), observed caller preferences (e.g. does the caller favor one form of communication over another, does the caller respond more readily to one form of communication than another, etc.), and/or any other criteria. In another embodiment, the integrated system may also select the most appropriate message origination source (e.g. what account to send the message from), based upon similar criteria.

In one embodiment, interacting with button 48-19-34 may present the user with user interface 48-19-36, which includes a dialog box 48-19-38 allowing the user to input a reply message to be sent to the caller. As shown, dialog box 48-19-38 includes a text field 48-19-40 which identifies the caller, in accordance with one embodiment. Furthermore, in one embodiment, dialog box 48-19-38 may include a text field 48-19-42 where the user may input a response message.

In one embodiment, dialog box 48-19-38 may include text field 48-19-44, which identifies the communication method with which the message will be sent. In some embodiments, a user may interact (e.g. tap, click, etc.) with text field 48-19-44 to cycle through the various methods available. In other embodiments, an extended user interaction (e.g. touch and hold, click and hold, right click, etc.) with text field 48-19-44 may allow the user to select from one or more different message origination points (e.g. email accounts, instant message accounts, social network accounts, etc.).

In one embodiment, dialog box 48-19-38 may include a button 48-19-46 to send the composed message. Furthermore, dialog box 48-19-38 may include a button 48-19-48 to return the user to the native tablet pre-call interface 48-19-10 without sending a reply message.

In one embodiment, collection 48-19-26 may include button 48-19-50, which may be used to send a smart reply to the caller. In the context of the present description, a smart reply refers to a message which is, at least in part, device-generated, the device-generated portion of the message being based upon contextual information. Contextual information may include, but is not limited to, calendar data, location data, user velocity, user contact data (e.g. user's relationship to the caller, etc.), and/or any other data related to the user or the integrated devices. An example of a smart reply would be some of the device generated responses used in conjunction with auto response rules, as previously discussed.

In various embodiments, button 48-19-50 may provide different functionality, depending upon how the user interacts with it. For example, in one embodiment, if the user taps or clicks on button 48-19-50, a default smart reply may be sent to the caller. In another embodiment, if the user has an extended interaction with button 48-19-50 (e.g. touch and hold, click and hold, right click, etc.), the user may be presented with a plurality of smart replies to choose from, providing varying degrees of information. These replies may be labeled for ease of use. For example, a “basic” response may indicate that the user is unavailable, while a “personal” response may indicate that the user is at the dentist, and will be done within an hour. In yet another embodiment, the user may be provided with an option to customize the smart replies available through button 48-19-50. In some embodiments, the user may be shown the response for each label. In other embodiments, only the label may be visible to the user while interacting with button 48-19-50.

In some embodiments, if the user taps or clicks on button 48-19-50, the integrated system may send the most appropriate smart response to the caller. The most appropriate smart response, or in other words, the response the user would most likely intend to send, may be determined based upon one or more criteria, including, but not limited to, observed user behavior (e.g. what has the user done in this situation in the past, etc.), observed caller responses (e.g. what additional information has the caller previously requested in response to various messages, etc.), and/or any other criteria. In another embodiment, the integrated system may also select the most appropriate message origination source (e.g. what account to send the message from) and message format (e.g. email, SMS message, etc.), based upon similar criteria.

In various embodiments, after an interaction with button 48-19-50, the user may be presented with a plurality of smart replies, as well as the option to customize said replies. In one embodiment, selecting the option to customize the smart replies may take the user to user interface 48-19-52, which may allow the user to define one or more labeled smart replies, as well as prepare a custom smart reply to send to the caller.

In one embodiment, user interface 48-19-52 may include one or more smart response editor elements, such as 48-19-54. In the context of the present description, a smart response editor element refers to the combination of text field containing a response, as well as a plurality of buttons which allow the user to save the current response and send the current response. For example, as shown, smart response editor element 48-19-54 includes a response text field 48-19-56, as well as a plurality of buttons 48-19-58.

In various embodiments, the response text field of a smart response editor element may include dynamic text. In the context of the present description, dynamic text refers to a portion of text which changes value (i.e. says something different, etc.) in response to a user interaction. For example, in one embodiment, if a user touches or clicks on a piece of dynamic text, it may cycle through a plurality of possible values. In some embodiments, dynamic text may have a different appearance than static text (e.g. different font, different style, different size, different color, animated, etc.).

The dynamic text found within the response text field of a smart response editor element allows a user to easily modify a response by cycling through a plurality of context-based response elements. In some embodiments, the set of response elements associated with a piece of dynamic text in a smart response are thematically related. For example, one set of response elements may describe a user's current activity, and comprise the values of “busy”, “in a meeting”, and “in a meeting with Bill”. The types of context-based response elements may include, but are not limited to, the user's current activity (e.g. in a meeting, etc.), the user's current location (e.g. away, on the road, at 117 N. Main Street, etc.), the user's schedule (e.g. later, after the meeting, at 3:45 pm, etc.), the user's intended future response activity (e.g. call, meet, email, conference, etc.), and/or any other context-based information. In one embodiment, the set of possible values for a piece of dynamic text may be thematically related, yet vary in degree of specificity. In another embodiment, the set of possible values may be thematically related, and of a similar level of specificity, yet vary in style, tone, and/or degree of formality (e.g. “I can't talk right now”, “Busy.”, “I am currently unavailable”, etc.).

In various embodiments, each possible value within a set of values that a piece of dynamic text draws from may be assigned a numerical score representative of that set's degree of freedom. For example, if a set is made up of thematically related values of varying specificity, a very vague value may have a score of zero, while a very specific, detailed value may have a score of ten. The same may be done for varying degrees of tone and formality (i.e. extremely casual language may have a low score, while very formal language may have a high score). In this way, preferred levels of specificity and formality may be maintained for responses to a particular caller, even if the theme or context of the response changes, facilitating the selection of a most appropriate smart response. In some embodiments, the user may be made aware of these scores, whether in numerical form, or in the form of icons.

In one embodiment, dynamic text may cycle through a set of possible values in response to a touch or a click. In another embodiment, touching or clicking on a piece of dynamic text may display the entire set of possible values, which the user may choose from. As an option, in the case of large sets of values, a subset of values may be displayed, which the user may scroll through.

As shown, user interface 48-19-52 may include a “basic” smart response editor element 48-19-54, a “standard” smart response editor element 48-19-62, and a “detailed” smart response editor element 48-19-64, in accordance with one embodiment. In another embodiment, the dynamic text within each of these smart response editors may draw from sets of values which have roughly the same specificity (e.g. values for dynamic text within the “basic” smart response will all be vague, etc.). In yet another embodiment, the user may be able to modify the labels assigned to each smart response, as well as select which set each piece of dynamic text draws from.

As shown, user interface 48-19-52 may include a custom smart response editor element 48-19-66, which may provide the user with more freedom in designing a smart response. For example, in one embodiment, the pieces of dynamic text 48-19-68 within a custom smart response editor element may be two dimensional in nature. In the context of the present description, a two dimensional piece of dynamic text is a dynamic text which draws from a two dimensional set of values, able to vary in both specificity as well as tone/formality. In various embodiments, different interactions may affect different dimensions of a two dimensional piece of dynamic text. For example, in one embodiment, variation in specificity may be associated with vertical motion (e.g. flicking up or down, click-dragging up or down, moving a scroll wheel, etc.), while variation in formality may be associated with horizontal motion (e.g. flicking left or right, click-dragging left or right, moving a scroll wheel while holding down a shift key, etc.). As an option, the interactions used for all dynamic text in user interface 48-19-52 may be consistent (i.e. all specificity variations are vertical, all formality variations are horizontal, etc.).

In one embodiment, user interface 48-19-52 may include a text field 48-19-70 which indicates how the smart response will be transmitted (e.g. email, SMS, social network, etc.). In another embodiment, a user may interact with (e.g. touch, click on, etc.) this text field to change the method of transmission. In some embodiments, the user may send the smart response using text-to-speech technology. In other words, the system would answer the incoming call, and read the smart response to the caller. As an option, the caller may then be sent to a voicemail system. In other embodiments, this functionality may be available to the user through the voicemail button 48-19-32.

In some embodiments, modifications made to the smart responses through user interface 48-19-52 may persist from caller to caller. In other words, if a user makes the “standard” smart response very formal, it may remain formal for all future callers. In other embodiments, the modifications made to the smart responses are maintained for each caller. Thus, a user may specify that all responses to one individual be casual, while those sent to a different individual are all formal. As an option, a user may define levels of specificity and formality for smart responses sent to particular contacts by assigning the previously discussed scores to their contact data (e.g. contact data has fields for specificity and formality, etc.). Furthermore, in another embodiment, preferred scores may be assigned to groups of contacts. As a specific example, a user may specify that all contacts within the group “family” should receive informal, very specific smart responses.

In one embodiment, collection 48-19-26 may include button 48-19-72, which may be used create a reminder for the user to contact the caller at a later time or date. In various embodiments, button 48-19-72 may provide different functionality, depending upon how the user interacts with it. For example, in one embodiment, if the user taps or clicks on button 48-19-72, the user may be reminded to contact the caller after a default amount of time has elapsed. In another embodiment, if the user has an extended interaction with button 48-19-72 (e.g. touch and hold, click and hold, right click, etc.), the user may be presented with a plurality of delays before such a reminder is displayed.

In another embodiment, interacting with button 48-19-72 may cause the creation of a reminder which will be triggered at a time based upon contextual data. For example, if a user is in a scheduled meeting and activates 48-19-72 in response to an incoming voice call, the reminder may be set to occur ten minutes after the scheduled end of the meeting. In yet another embodiment, the reminder created in response to activating 48-19-72 may be timed based upon observed user behavior, combined with contextual data. As a specific example, a system may avoid scheduling a reminder to return a voice call during a time in which the user has been consistently observed to refuse incoming calls (e.g. lunch time, etc.), and instead schedule the reminder for a time when the user has been observed making a number of voice calls.

FIG. 48-20 shows a user interface 48-20-00 for modifying an ongoing voice call, in accordance with one embodiment. As an option, user interface 48-20-00 may be implemented in the context of the architecture and environment of the previous Figures or any subsequent Figure(s). Of course, however, user interface 48-20-00 may be implemented in any desired environment. It should also be noted that the aforementioned definitions may apply during the present description.

As shown, user interface 48-20-00 is a native tablet interface which may be used to modify an ongoing voice call, or enhance the ongoing communication with one or more parties participating in the voice call. In many embodiments, the native tablet in-call interface may appear similar to the native tablet pre-call interface 48-19-00. For instance, in one embodiment, the native tablet in-call interface may have a caller information panel and/or a communication history panel, in addition to various information identifying the caller (e.g. contact photo, caller name, etc.).

In one embodiment, native tablet in-call interface 48-20-00 may include a button 48-20-02 for dismissing the in-call interface. In some embodiments, dismissing the in-call interface does not interrupt the voice call, but rather hides the interface, allowing the user to perform other functions. In one embodiment, the user may cause the in-call interface to reappear by interacting with the integrated phone status icon located in the status bar.

In various embodiments, in-call interface 48-20-00 may include a collection of buttons 48-20-04 which allow the user to perform various in-call operations. For example, in one embodiment, collection 48-20-04 may include buttons to merge two calls into a single conference call (e.g. button 48-20-06), add another person to an ongoing call (e.g. button 48-20-08), place a call on hold (e.g. button 48-20-10), and mute the ongoing voice call (e.g. button 48-20-12).

In one embodiment, collection 48-20-04 may include button 48-20-14, which may be used to escalate the voice call to a video conference. In various embodiments, this escalation may be performed using the method depicted in FIG. 48-9-. In some embodiments, if it is known that all other participants of a voice call are unable to support a video conference, button 48-20-14 may be disabled, and made to appear different (e.g. faded, etc.).

In one embodiment, button collection 48-20-04 may include button 48-20-16, for displaying a phone keypad. This may be used to interact with a phone based system that uses voice prompts and phone-generated tones as input.

As shown, button collection 48-20-04 may include button 48-20-18 for allowing a user to modify the integration audio settings while a call is in progress, in accordance with one embodiment. In one embodiment, activating button 48-20-18 may present the user with an interface where they may change the sources for audio input and output, volume, microphone sensitivity, and/or noise cancellation settings. In this way, a user may quickly and easily change the nature of the ongoing call (e.g. switch from speakerphone to a headset, etc.).

In various embodiments, in-call interface 48-20-00 may include a collection of buttons 48-20-20 which represent various applications. In some embodiments, activating an application via a button included in collection 48-20-20 may cause the application to appear with a modified user interface designed to facilitate applying the functionality of the application towards the ongoing voice call. In other embodiments, activating an application via the in-call interface may simply dismiss the in-call interface and execute the selected application in an ordinary manner.

In various embodiments, the collection of application buttons 48-20-20 may include a button 48-20-22 for launching a calendar application. In one embodiment, button 48-20-22 may launch a calendar application using a special user interface to facilitate operating the calendar application in conjunction with the ongoing voice call. The activities said interface may facilitate include, but are not limited to, creating a shared event, sending and receiving calendar events, and publishing a calendar, in accordance with one embodiment. See, for example, the plurality of user interfaces depicted in FIG. 48-22.

In various embodiments, the collection of application buttons 48-20-20 may include a button 48-20-24 for launching a note application. In one embodiment, button 48-20-24 may launch a note application using a special user interface to facilitate operating the note application in conjunction with the ongoing voice call. The activities said interface may facilitate include, but are not limited to, sending text, receiving text, and generating a transcript of the voice call, in accordance with one embodiment. See, for example, the user interface depicted in FIG. 48-24-.

In various embodiments, the collection of application buttons 48-20-20 may include a button 48-20-26 for launching an email application. In one embodiment, button 48-20-26 may launch an email application using a special user interface to facilitate operating the email application in conjunction with the ongoing voice call. The activities said interface may facilitate include, but are not limited to, creating a new message addressed to one or more participants of the voice call, and show all previous communications with one or more participants of the voice call, in accordance with one embodiment. See, for example, the user interface depicted in FIG. 48-25-.

In various embodiments, the collection of application buttons 48-20-20 may include a button 48-20-28 for launching a web browser application. In one embodiment, button 48-20-28 may launch a web browser application using a special user interface to facilitate operating the web browser application in conjunction with the ongoing voice call. The activities said interface may facilitate include, but are not limited to, sending and receiving bookmarks, sending the URL of the current web page, and receiving a URL, in accordance with one embodiment. See, for example, the user interface depicted in FIG. 48-26.

In various embodiments, the collection of application buttons 48-20-20 may include a button 48-20-30 for launching a shared workspace. In one embodiment, button 48-20-30 may launch a share workspace using a special user interface to facilitate operating the shared workspace in conjunction with the ongoing voice call. The activities said interface may facilitate include, but are not limited to, inviting one or more participants of the ongoing voice call to join a shared workspace, in accordance with one embodiment. See, for example, the user interface depicted in FIG. 48-27-.

In various embodiments, the collection of application buttons 48-20-20 may include a button 48-20-32 for launching an address book application. In one embodiment, button 48-20-32 may launch an address book application using a special user interface to facilitate operating the address book application in conjunction with the ongoing voice call. The activities said interface may facilitate include, but are not limited to, granting permission to access location data, requesting permission to access location data, sending personal contact information, sending a contact record, creating a new contact record, and displaying a contact record for the caller, in accordance with one embodiment. See, for example, the plurality of user interfaces depicted in FIG. 48-28-.

In various embodiments, user interface 48-20-00 may include a button 48-20-34 for specifying preferences regarding the collection of application buttons 48-20-20. In one embodiment, collection of application buttons 48-20-20 may be predefined, and fixed. As an option, the collection may be populated with applications which are likely to be used during a voice call and/or possess a modified user interface for use during a voice call. In other embodiments, the collection of applications may be dynamic. For example, in one embodiment, a user may select the members of the collection of applications. In another embodiment, the collection of applications may be automatically populated based upon observed user behavior (e.g. applications which are most used, applications which have previously been used during a voice call, applications which have been previously used during voice call with one or more participants of the current call, etc.).

As previously discussed, the caller information panel may display location data for a caller, in accordance with one embodiment. In various embodiments, user interface 48-20-00 may include a button 48-20-36 for requesting location data from a call participant, if permission to access such data does not already exist. As an option, the participant may have the option to grant temporary (e.g. 24 hour, etc.) permission, or permanent permission, which can later be revoked.

In various embodiments, the communication history panel of user interface 48-20-00 may include a shared content tab 48-20-38, to all the user to see content which has been shared in conjunction with the ongoing voice call. In one embodiment, the user may be able to perform operations on the content listed in shared content tab 48-20-38. Potential operations may include, but not limited to, opening a piece of content with an appropriate application, resending previously sent content, deleting content, viewing metadata associated with a piece of content, and/or any other operation which may be performed in association with content.

FIG. 48-21 shows a user interface 48-21-00 for modifying an ongoing voice call with multiple participants, in accordance with another embodiment. As an option, user interface 48-21-00 may be implemented in the context of the architecture and environment of the previous Figures or any subsequent Figure(s). Of course, however, user interface 48-21-00 may be implemented in any desired environment. It should also be noted that the aforementioned definitions may apply during the present description.

As shown, user interface 48-21-00 is a native tablet interface which may be used to modify an ongoing voice call, or enhance an ongoing communication with one or more parties participating in the voice call. In many embodiments, the native tablet in-call interface may appear similar to the native tablet pre-call interface 48-19-00. For instance, in one embodiment, the native tablet in-call interface may have a caller information panel and/or a communication history panel.

In various embodiments, user interface 48-21-00 may include a collection of buttons 48-21-02 which represent the participants of the ongoing voice call. In some embodiments, these buttons bear the image of the associated call participant (e.g. contact photo, etc.), or an iconic representation of the caller. Examples of possible iconic representations of a call participant may include, but are not limited to, a symbol, a map of the geographic area associated with the participant's area code, and/or any other visual representation. Furthermore, the button may also bear a text description of the call participant (e.g. name, phone number, etc.).

In various embodiments, a user may select a button representing a call participant, wherein the selection causes information associated with the selected call participant to be displayed in the in-call descriptive elements 48-21-06 (e.g. the caller information panel, the communication history panel, the descriptive graphic element, etc.). In some embodiments, the currently selected call participant button may be visually distinct from the rest of button collection 48-21-02. For example, as shown, selected button 48-21-04 is framed with a second border.

In some embodiments, the in-call descriptive elements 48-21-06 may display information associated with a call participant explicitly selected by the user from buttons 48-21-02. In other embodiments, these descriptive elements may display the information associated with the call participant who is currently speaking. As an option, a call participant may be required to speak for a predefined amount of time before their information replaces the information currently being displayed. In one embodiment, a user may specify how the subject of these descriptive elements is chosen (e.g. manually, automatically, etc.). Furthermore, in one embodiment, the user may override an automatically made choice by interacting with a button representing a participant. A second interaction may deselect said button, returning the system to automatically change the descriptive elements.

In various embodiments, user interface 48-21-00 may include icon 48-21-08, which indicates which call participant is currently speaking. In some embodiments, the user may be able to specify a threshold volume above which a participant may be considered to be speaking. In this way, different levels of background noise among call participants may be accounted for.

In various embodiments, user interface 48-21-00 may include a shared content tab 48-21-10. In some embodiments, the shared content tab may only list the content which has been sent to and/or received from the participant currently displayed in descriptive elements 48-21-06, in conjunction with the ongoing communication. In other embodiments, the shared content tab may list the content which has been sent to and/or received from all communication participants, in conjunction with the ongoing communication.

FIG. 48-22- shows a plurality of user interfaces 48-22-00 for using a calendar application, in accordance with one embodiment. As an option, the plurality of user interfaces 48-22-00 may be implemented in the context of the architecture and environment of the previous Figures or any subsequent Figure(s). Of course, however, the plurality of user interfaces 48-22-00 may be implemented in any desired environment. It should also be noted that the aforementioned definitions may apply during the present description.

In various embodiments, the plurality of user interfaces 48-22-00 may be used to operate a calendar application in conjunction with an ongoing or recently terminated communication. Specifically, the plurality of user interface 48-22-00 may be used in conjunction with a voice call or video conference which is in progress, or has recently ended. In some embodiments, user interfaces 48-22-00 may be available for a limited amount of time after a voice call or video conference has ended. In other embodiments, these user interfaces may be accessible, and utilized with respect to the previous communication, when accessed through an interface directly related to said communication (e.g. phone interface, video conference interface, an integrated phone interface, etc.).

In one embodiment, plurality 48-22-00 may include user interface 48-22-02, which may be used to review and modify data within a calendar application. User interface 48-22-02 may serve as a primary interface to a calendar application, in accordance with one embodiment. For example, as shown, user interface 48-22-02 includes an expanded monthly calendar, which may be populated with events 48-22-04, which may be organized into one or more calendar groups (e.g. work calendar, personal calendar, birthdays, etc.). In other embodiments, user interface 48-22-02 may be used to access any of the functionality available through the calendar application when executed outside of the context of an ongoing or recently terminated communication.

In one embodiment, the calendar in user interface 48-22-02 may be populated with events 48-22-04, which may be associated with one or more individuals. In some embodiments, the user interface elements (e.g. text, graphics, etc.) within user interface 48-22-02 which represent events which are associated with one or more participants of the ongoing or recently terminated communication may be visually distinguished from other events. For example, in one embodiment, these relevant events may be displayed with a pulsing animation. In another embodiment, the relevant events may be highlighted with a border.

In the case of a communication which involves more than one other participant, the relevant events may visually indicate which participants they are associated with, in accordance with one embodiment. In one embodiment, each participant in the communication may be associated with a distinct color, an association which may be indicated through the use of that color in user interface elements which identify the participants (e.g. contact photo, video feed, participant name, etc.) as well as calendar event elements which are associated with each participant. As a specific example, in the case of a multi-channel video conference, the video feed associated with each participant may have a uniquely colored border, the color corresponding with colored dots within relevant calendar event UI elements. In another embodiment, a user may be able to select a single communication participant, causing relevant events to become visually distinct.

In one embodiment, user interface 48-22-02 may include a plurality of check boxes 48-22-06 associated with calendar groups, which may be used to specify which calendar group events are visible within the user interface. In some embodiments, it may be possible for a user to publish a calendar group, allowing invited individuals to view calendar data associated with the published group. Similar to what was previously described with respect to calendar event elements, any of the calendar groups represented by plurality 48-22-06 may be visually distinguished if they have been subscribed to by a communication participant. The methods previously discussed for visually distinguishing relevant calendar event elements may be applied to relevant calendar groups, in accordance with one embodiment.

In some embodiments, user interface 48-22-02 may provide all of the functionality available when using the calendar application outside the context of an ongoing or recently terminated communication. In other embodiments, user interface 48-22-02 may provide enhanced functionality. For example, in one embodiment, user interface 48-22-02 may include an enhanced communication panel 48-22-08, which may facilitate the operation of an application in conjunction with an ongoing or recently terminated communication.

In the context of the present description, an enhanced communication panel refers to a user interface panel which may be used to provide synergy between an ongoing or terminated communication and the operation of an application. In many embodiments, it may provide information (e.g. name, contact photo, video feed, etc.) concerning one or more communication participants. Furthermore, an enhance communication panel may include one or more buttons associated with operations which combine the functionality of an application with information related to one or more communication participants (e.g. name, email, phone number, etc.).

In some embodiments, an enhanced communication panel may be displayed on the prime display, along side an application. In other embodiments, the enhanced communication panel may be displayed on a secondary display (e.g. the phone display, etc.). In still other embodiments, elements of the enhanced communication panel may be split between prime and secondary displays.

In various embodiments, an enhanced communication panel may include a visual element which may be used to identify one or more communication participants. For example, as shown, enhanced communication panel 48-22-08 includes a visual element 48-22-10, in accordance with one embodiment.

In one embodiment, visual element 48-22-10 may include a contact photo and name for a participant of a recently terminated voice call or video conference. In another embodiment, visual element 48-22-10 may display a video stream being received as part of an ongoing video conference. In cases where there is more than one communication participant (in addition to the user), a user may interact with (e.g. swipe, click, scroll, etc.) visual element 48-22-10 to cycle through various participants, in accordance with one embodiment. As an option, a reduced version of the visual data (e.g. contact photo, video feed, etc.) associated with the other participants may be displayed elsewhere (e.g. secondary display, along an edge of visual element 48-22-10, etc.). In another embodiment, visual element 48-22-10 may display the video stream/visual representation of all communication participants at the same time, in reduced size. In yet another embodiment, visual element 48-22-10 may display the video stream/visual representation of the communication participant who is currently speaking. As an option, a participant may be required to speak for a certain amount of time before visual element 48-22-10 changes, to avoid the distraction of a rapidly changing visual element.

In one embodiment, enhanced communication panel 48-22-08 may include a collection of buttons 48-22-12 which are associated with operations that combine the functionality of the calendar application with information related to one or more communication participants (e.g. name, email, phone number, etc.). In some embodiments, the operations made available by buttons 48-22-12 may change depending upon a context, such as which application interface is presently active.

In one embodiment, enhanced communication panel 48-22-08 may include a button 48-22-14 which may be used to create a shared event. In the context of the present description, a shared event refers to a calendar event which is associated with the user as well as one or more other individuals. For example, in one embodiment, button 48-22-14 may result in the creation of an event in which the user and all communication participants are listed as event participants. In another embodiment, the creation of a shared event may result in an event invitation being sent to all participants. As an option, the creation of a shared event may be performed using a user interface, such as user interface 48-22-20.

In one embodiment, enhanced communication panel 48-22-08 may include a button 48-22-16 which may be used to send a calendar event to one or more communication participants. In some embodiments, a calendar event may be sent via email to one or more other parties in a commonly supported data format such as iCalendar. In one embodiment, a user interaction (e.g. tap, click, etc.) with button 48-22-16 may result in the currently selected calendar event or events being sent to all communication participants. In another embodiment, an extended user interaction (e.g. touch and hold, click and hold, right click, etc.) with button 48-22-16 may provide the user with the ability to choose which of the communication participants should receive the selected event or events.

In one embodiment, enhanced communication panel 48-22-08 may include a button 48-22-18 which may be used to publish a calendar group to one or more communication participants. In some embodiments, a user may be able to publish a calendar group, or a collection of calendar events, to an external server, where other individuals with sufficient permission may subscribe to the published calendar group and receive updates. In one embodiment, button 48-22-18 may cause a selected calendar group to be published (if it is not already published), and issue an invitation to one or more communication participants granting them sufficient permission to subscribe to the published calendar group.

In one embodiment, a user interaction (e.g. tap, click, etc.) with button 48-22-18 may result in the currently selected calendar group being published to all communication participants. In another embodiment, an extended user interaction (e.g. touch and hold, click and hold, right click, etc.) with button 48-22-18 may provide the user with the ability to choose which of the communication participants should receive the invitation to subscribe to the published calendar group.

If a user activates button 48-22-16 to create a shared event, they may be presented with user interface 48-22-20. In various embodiments, user interface 48-22-20 may be used to create and transmit a shared event. As shown, user interface 48-22-20 resembles a standard event creation interface, where a user may define an event name, a start and end time and date, and other details.

In one embodiment, user interface 48-22-20 may include text field 48-22-22 for defining a location to be associated with the calendar event. In some embodiments, the contents of text field 48-22-22 may be treated as additional information to pass to other participants in the form of a note, without any further action taken in the absence of user interaction. In other embodiments, text field 48-22-22 may utilize one or more sources of data (e.g. the user's contact data stored on either integrated device, data from an external server, etc.) to automatically link the user's input with additional information. For example, in one embodiment, if the user were to enter “office” in the location text field, the system may correlate that input with the user's personal contact information, which includes the address for their place of employment. While the user may see the word “office” in text field 48-22-22, recipients of the shared event will see additional data, such as the street address. As an option, text within text field 48-22-22 which has been recognized and linked to additional data may be visually distinct from other text, letting the user know that the text has been linked to other data. As a further option, in some embodiments, the user may interact with (e.g. hover a cursor, touch and hold, etc.) a piece of recognized and correlated text to see the associated data.

In one embodiment, user interface 48-22-20 may include text field 48-22-24 for specifying who will be participating in the calendar event. In some embodiments, the contents of text field 48-22-24 may be automatically linked to additional information, similar to what has been described with respect to locations.

In various embodiments, the participants text field 48-22-24 may be automatically populated with the identities of all communication participants, when the shared event is being created in response to the activation of a button within an enhanced communication panel. As an option, the field may always list the user first, as the event creator. In some embodiments, names may be added directly to and deleted directly from text field 48-22-24. In other embodiments, the user may utilize button 48-22-26, which allows the user to select contacts from the address book data stored on both integrated devices.

In one embodiment, user interface 48-22-20 may include check box 48-22-28 which specifies whether the shared event will request permission from each participant to access their location data, for instance, through a social geolocation service. In many embodiments, the permission sought in relation to a shared event may be within a limited time frame. For example, in one embodiment, user interface 48-22-20 may include collection of radio buttons 48-22-30 which specify when the location data will be made available. Specifically, these radio buttons specify the amount of time before the event that the location data will first become available. In other embodiments, location permissions associated with a shared event may expire at the scheduled end of the event.

In various embodiments, user interface 48-22-20 may include a collection of check boxes 48-22-32 which specify who will have access to event participant location data. In one embodiment, the user may choose between giving access to the event creator and giving access to all event participants. In another embodiment, a user may be allowed to select specific participants who will have access to event participant location data.

In some embodiments, the use of shared event participant location data may be left to the discretion of the participants. In other words, if they take no action, the data will go unused. In other embodiments, the user may specify that an event participant location report be broadcast at one or more points in time, summarizing the relative location of one or more event participants. In one embodiment, the user may make such a specification using a collection of settings 48-22-34.

In various embodiments, user interface 48-22-20 may include a collection of checkboxes 48-22-36 to specify when a location report should be broadcast. For example, in one embodiment, a user may specify that a location report should be sent a predefined amount of time before the scheduled start of the event, at the time the event is scheduled to start, and/or after a predefined amount of time has elapsed since the scheduled event start time. In this way, event participants may be kept up to date regarding participants who are still en route, or have been delayed.

In various embodiments, user interface 48-22-20 may include a collection of drop down menus 48-22-38 which allow the user to specify who should receive the various location reports. For example, in one embodiment, a user may specify that the event planner alone should receive a report 10 minutes before the scheduled start of the event, and that all participants should receive a report 5 minutes after the event has begun.

In various embodiments, user interface 48-22-20 may include a collection of drop down menus 48-22-40 which allow the user to specify what will be reported in the various location reports. For example, in one embodiment, a user may specify that before the event starts, the report should indicate the location of all participants, while after the event has begun, only the location of participants who have not yet arrived should be reported.

The location of various event participants may be presented in a number of ways. For example, in one embodiment, a location report may state how far away a participant is from the planned event location. In another embodiment, the report may give an estimated time of arrival for one or more participants. As an option, such a report may be based upon current traffic conditions, weather conditions, a predicted route, and/or any other information which may be combined with the location of an event participant to estimate their time of arrival.

In one embodiment, an event participant location report may state how far away a participant is from the planned location of the event. In another embodiment, said report may state how far away a participant is from the bulk of the rest of the participants, if there a predefined fraction of participants are at a single location, which does not necessarily have to be the planned event location (e.g. a last minute change of plans, etc.).

In one embodiment, an event participant location report may provide the same information to all participants. In another embodiment, a different message may be sent to participants who have not yet arrived (e.g. “Hurry up, we're all waiting!”, etc.). Furthermore, in one embodiment, an event participant location report may be sent through various protocols, including, but not limited to, SMS and email.

As shown, user interface 48-22-20 may include a button 48-22-42 for creating the shared event as presently defined, and sending an invitation to all participants listed in text field 48-22-24, in accordance with one embodiment. Additionally, in one embodiment, user interface 48-22-20 may also include a button 48-22-44 which allows the user to return to a previous user interface without creating a shared event.

In various embodiments, user interface 48-22-02 may include a button 48-22-46 which allows a user to capture the contents of the screen and send said screen capture to one or more communication participants. In one embodiment, the user may be prompted to select a method of sending, and/or prompted regarding who should receive the screen capture. In another embodiment, the user may be able to select a portion of the display for capture, rather than the entire display. This functionality allows a user to quickly share the contents of the screen with other communication participants without worrying about whether or not they are able to receive the specific protocol of the application (e.g. iCalendar, etc.).

FIG. 48-23 shows a plurality of user interfaces 48-23-00 for receiving a shared calendar event, in accordance with one embodiment. As an option, the plurality of user interfaces 48-23-00 may be implemented in the context of the architecture and environment of the previous Figures or any subsequent Figure(s). Of course, however, the plurality of user interfaces 48-23-00 may be implemented in any desired environment. It should also be noted that the aforementioned definitions may apply during the present description.

In various embodiments, user interfaces 48-23-02 and 48-23-10 may be used to accept a shared calendar event created and sent by another individual. For example, as shown, user interface 48-23-02 informs the user that a person has sent them a shared event, which they can either accept or reject. In some embodiments, user interface 48-23-02 may also indicate to the user whether the shared event conflicts with an event already in the user's calendar. As shown, user interface 48-23-02 includes a button 48-23-04, which allows the user to view the details of the event.

In one embodiment, user interface 48-23-02 may include a button 48-23-06 for accepting the shared event, and a button 48-23-08 for rejecting or declining the event. In some cases, the event will request permission of participants to share their location data on a temporary basis. In such a case, and the user has elected to accept the shared event, they may be presented with user interface 48-23-10, in accordance with one embodiment.

As shown, user interface 48-23-10 may be used to grant or deny permission for one or more participants of a shared event to view the user's location data on a temporary basis, in accordance with one embodiment. Further, in one embodiment, user interface 48-23-10 may include buttons 48-23-12 and 48-23-14 for accepting or rejecting the request.

In one embodiment, all participants of a shared event which requests participant location information may be presented with said request through user interface 48-23-10, or a similar interface. In another embodiment, user interface 48-23-10 may only be presented if needed. For example, if a user has already granted permission to all parties who would be accessing the location data, there would be no need to gain further permission. As an option, the user may be informed that the shared event will involve the sharing of location data, but only with people who already have permission. In yet another embodiment, the user may be informed who will be receiving the location data, and among those individuals, who does not already have permission to do so.

FIG. 48-24 shows a user interface 48-24-00 for using a note application, in accordance with one embodiment. As an option, user interface 48-24-00 may be implemented in the context of the architecture and environment of the previous Figures or any subsequent Figure(s). Of course, however, user interface 48-24-00 may be implemented in any desired environment. It should also be noted that the aforementioned definitions may apply during the present description.

In various embodiments, user interface 48-24-00 may be used to operate a note taking application in conjunction with an ongoing or recently terminated communication. Specifically, user interface 48-24-00 may be used in conjunction with a voice call or video conference which is in progress, or has recently ended. In some embodiments, user interface 48-24-00 may be available for a limited amount of time after a voice call or video conference has ended. In other embodiments, this use interface may be accessible, and utilized with respect to the previous communication, when accessed through an interface directly related to said communication (e.g. phone interface, video conference interface, an integrated phone interface, etc.).

In various embodiments, user interface 48-24-00 may include a document 48-24-02 which allows the user to enter notes or other information. In some embodiments, document 48-24-02 may be purely text based. As an option, the document may support rich text (e.g. stylized, etc.). In other embodiments, document 48-24-02 may be a mixture of graphics and text. For example, in one embodiment, a user may enter text via various methods, as well as draw directly on the touchscreen of a tablet, or using some other touch-based input device, or using a cursor-based input device. In another embodiment, the note application may employ handwriting recognition, converting a users handwritten notes into proper text.

In various embodiments, user interface 48-24-00 may include a list of documents 48-24-04. In some embodiments, this list may be nested, allowing some form of hierarchical organization for the documents described within.

In various embodiments, user interface 48-24-00 may include a button 48-24-06 which allows a user to send a selected object to one or more communication participants. Objects which may be sent may include, but are not limited to, a portion of text or graphics selected within document 48-24-02, and one or more documents selected from within document list 48-24-04.

In various embodiments, user interface 48-24-00 may include a button 48-24-10 which creates a transcript of the ongoing communication using speech recognition technology. In one embodiment, a transcript may be made automatically for every call, but is only recorded after an explicit request from the user. In another embodiment, the transcription process may only begin after the user has made an explicit request. In some embodiments, communication participants may be automatically informed regarding the creation of a recording and/or a transcript of the conversation.

In some embodiments, the created transcript may also incorporate the original audio of the communication. In one embodiment, the audio may be correlated with the individual words of the transcript, such that the user may easily hear the audio associated with a particular part of the transcript through a simple interaction (e.g. tap, click, etc.). Furthermore, in one embodiment, there may exist a mechanism for the user to easily correct transcription errors by interacting with one or more words within document 48-24-02. In another embodiment, the degree of confidence in a transcription may be reflected in the style of text within document 48-24-02. In other words, a user may have a visual indication whether the transcription system is confident in the present interpretation of a particular word or words. This may assist a user in finding and correcting transcription errors.

FIG. 48-25 shows a user interface 48-25-00 for using an email application, in accordance with one embodiment. As an option, user interface 48-25-00 may be implemented in the context of the architecture and environment of the previous Figures or any subsequent Figure(s). Of course, however, user interface 48-25-00 may be implemented in any desired environment. It should also be noted that the aforementioned definitions may apply during the present description.

In various embodiments, user interface 48-25-00 may be used to operate an email application in conjunction with an ongoing or recently terminated communication. Specifically, user interface 48-25-00 may be used in conjunction with a voice call or video conference which is in progress, or has recently ended. In some embodiments, user interface 48-25-00 may be available for a limited amount of time after a voice call or video conference has ended. In other embodiments, this user interface may be accessible, and utilized with respect to the previous communication, when accessed through an interface directly related to said communication (e.g. phone interface, video conference interface, an integrated phone interface, etc.).

In one embodiment, user interface 48-25-00 may include a list 48-25-02 of emails, email accounts, and/or mailboxes. Furthermore, in one embodiment, user interface 48-25-00 may include a window 48-25-04 for displaying the contents of an email selected from list 48-25-02.

In various embodiments, user interface 48-25-00 may include a button 48-25-06 for creating a new email message addressed to one or more communication participants. In one embodiment, the message may be address to all communication participants, by default. In another embodiment, the user may be prompted to select which participants should receive the message. In yet another embodiment, the user may be notified if there are any communication participants for which an email address is unknown. As an option, the user may have an opportunity to enter an email address for said participants. Upon receipt of said addresses, the user may be prompted whether they wish to create or update an address book record for that particular communication participant.

In various embodiments, user interface 48-25-00 may include a button 48-25-08 for causing the display of all messages related to one or more communication participants. In some embodiments, the user may be prompted to select one or more communication participants to use as a selection criteria. In other embodiments, all communication participants may be used as a default selection criteria. In one embodiment, user interface 48-25-00 may display all messages related to one or more communication participants. In another embodiment, the user interface may only display messages which are related to all communication participants. As an option, the user may further narrow the selection criteria by specifying a date range, a text search, and/or any other search constraint.

FIG. 48-26- shows a user interface 48-26-00 for using a web browser application, in accordance with one embodiment. As an option, user interface 48-26-00 may be implemented in the context of the architecture and environment of the previous Figures or any subsequent Figure(s). Of course, however, user interface 48-26-00 may be implemented in any desired environment. It should also be noted that the aforementioned definitions may apply during the present description.

In various embodiments, user interface 48-26-00 may be used to operate a web browser application in conjunction with an ongoing or recently terminated communication. Specifically, user interface 48-26-00 may be used in conjunction with a voice call or video conference which is in progress, or has recently ended. In some embodiments, user interface 48-26-00 may be available for a limited amount of time after a voice call or video conference has ended. In other embodiments, this user interface may be accessible, and utilized with respect to the previous communication, when accessed through an interface directly related to said communication (e.g. phone interface, video conference interface, an integrated phone interface, etc.).

In various embodiments, user interface 48-26-00 may include a browser window 48-24-02, which may be used to view webpages. In one embodiment, browser window 48-24-02 may operate as a normal web browser, including the use of bookmarks.

In various embodiments, user interface 48-26-00 may include a button 48-26-04 for sending one or more bookmarks to one or more communication participants. For example, in one embodiment, the user may be prompted to select one or more web bookmarks to send to communication participants. In some embodiments, the user may select which of the communication participants will receive the bookmarks. In other embodiments, the selected bookmarks may be sent to all communication participants. Furthermore, in various embodiments, user interface 48-26-00 may include a button 48-26-06 for sending the URL of the webpage currently being viewed in browser window 48-26-02.

In various embodiments, bookmarks and/or other URLs may be sent to communication participants using various methods. For example, in one embodiment, bookmarks and URLs may be sent to communication participants using a text-based form of message, such as email or SMS. In another embodiment, bookmarks and URLs shared through user interface 48-26-00 may be automatically presented to the communication participants in a new browser window.

FIG. 48-27- shows a user interface 48-27-00 for using a shared workspace, in accordance with one embodiment. As an option, user interface 48-27-00 may be implemented in the context of the architecture and environment of the previous Figures or any subsequent Figure(s). Of course, however, user interface 48-27-00 may be implemented in any desired environment. It should also be noted that the aforementioned definitions may apply during the present description.

In various embodiments, user interface 48-27-00 may be used to operate a shared workspace in conjunction with an ongoing or recently terminated communication. Specifically, user interface 48-27-00 may be used in conjunction with a voice call or video conference which is in progress, or has recently ended. In some embodiments, user interface 48-27-00 may be available for a limited amount of time after a voice call or video conference has ended. In other embodiments, this user interface may be accessible, and utilized with respect to the previous communication, when accessed through an interface directly related to said communication (e.g. phone interface, video conference interface, an integrated phone interface, etc.).

In various embodiments, user interface 48-27-00 may include a shared workspace 48-27-02. In one embodiment, shared workspace 48-27-02 may allow all communication participants to view and interact with a workspace hosted by an individual. In another embodiment, shared workspace 48-27-02 may allow all communication participants to view and interact with a workspace hosted on an external server. In some embodiments, shared workspace 48-27-02 may allow all communication participants to view and interact with an application being executed by one participant. In other embodiments, shared workspace 48-27-02 may allow all communication participants to execute the same application, allowing them to view and modify the same document simultaneously.

As shown, shared workspace 48-27-02 may include a cursor 48-27-04, in accordance with one embodiment. In some embodiments, each participant may be associated with a visually distinct cursor. In this way, participants may draw attention to elements displayed within shared workspace 48-27-02. Furthermore, this may allow participants to understand who is performing what action on a shared document within shared workspace 48-27-02.

In various embodiments, user interface 48-27-00 may include a button 48-27-06 for inviting one or more communication participants to join a shared workspace. In one embodiment, this button may issue an invitation to all communication participants. In another embodiment, this button may allow the user to select which communication participants should be invited to join the shared workspace.

In various embodiments, user interface 48-27-00 may include a button 48-27-08 for uploading a document to a shared storage associated with shared workspace 48-27-02. In this way, a user may make a document readily available to the other participants, for their review. In some embodiments, any document opened within shared workspace 48-27-02 may be automatically uploaded to a shared storage. In one embodiment, the shared storage may be located on a cloud server. In another embodiment, the shared storage may be located on a device associated with one of the communication participants.

FIG. 48-28 shows a user interface 48-28-00 for using an address book application, in accordance with one embodiment. As an option, user interface 48-28-00 may be implemented in the context of the architecture and environment of the previous Figures or any subsequent Figure(s). Of course, however, user interface 48-28-00 may be implemented in any desired environment. It should also be noted that the aforementioned definitions may apply during the present description.

In various embodiments, user interface 48-28-00 may be used to operate an address book application in conjunction with an ongoing or recently terminated communication. Specifically, user interface 48-28-00 may be used in conjunction with a voice call or video conference which is in progress, or has recently ended. In some embodiments, user interface 48-28-00 may be available for a limited amount of time after a voice call or video conference has ended. In other embodiments, this user interface may be accessible, and utilized with respect to the previous communication, when accessed through an interface directly related to said communication (e.g. phone interface, video conference interface, an integrated phone interface, etc.).

In various embodiments, user interface 48-28-00 may include a window 48-28-02 which contains a list of contact records. In one embodiment, the names of contacts who are communication participants may be made visually distinct (e.g. different style, different size, different color, etc.). In another embodiment, a user may have the option of limiting the contact records listed in window 48-28-02 to those associated with communication participants.

In various embodiments, user interface 48-28-00 may include a window 48-28-04 which displays the data associated with a selected contact record. In one embodiment, window 48-28-04 may display data stored within a contact record, such as phone numbers, email addresses, street addresses, notes, and/or any other information concerning the contact. Furthermore, in one embodiment, window 48-28-04 may also display data obtained from an external source, including, but not limited to, navigation data to a recorded address from the contact record, the current location of the contact obtained from a social geolocation service, the current record for the contact's address and/or present location, and the travel time and/or distance from the user's present location to the contact's present location. In the case that the user does not have permission to receive the contact's current location, window 48-28-04 may include a button which allows the user to request permission to access the contact's location data.

In various embodiments, user interface 48-28-00 may include a button 48-28-06 which may be used to send the user's present location to one or more communication participants. In some embodiments, button 48-28-06 may be used to send permission to one or more communication participants to access the user's location through a social geolocation service.

In other embodiments, button 48-28-06 may be used to send the user's current location to one or more communication participants in the form of a message (e.g. email, SMS, etc.). For example, in one embodiment, button 48-28-06 may send a message containing the user's current street address. As an option, said message may include a link to a mapping service which would provide directions to the user's current location.

In various embodiments, user interface 48-28-00 may include a button 48-28-06 which may be used to send one or more selected contact records to one or more communication participants. In one embodiment, the contact records may be sent through a message, utilizing a standardized file format, such as vCard.

FIG. 48-29 shows a plurality of user interfaces 48-29-00 for launching an application, in accordance with one embodiment. As an option, the plurality of user interfaces 48-29-00 may be implemented in the context of the architecture and environment of the previous Figures or any subsequent Figure(s). Of course, however, the plurality of user interfaces 48-29-00 may be implemented in any desired environment. It should also be noted that the aforementioned definitions may apply during the present description.

Integration allows a user to harness the resources of two devices through a single interface (which may be spread across multiple displays). In some embodiments, the presence or absence of the additional resources provide through integration may be reflected by various aspects of the user interface. For example, in some embodiments, the home screen, or application launcher, may reflect the consequences of integration.

In various embodiments, the plurality of user interfaces 48-29-00 illustrate how a home screen may change depending upon whether or not a device is integrated. For example, in one embodiment, user interface 48-29-02 may be used to launch applications in the absence of an integration. Furthermore, in one embodiment, the lack of integration may be indicated by the appearance of the integration status icon 48-29-06 located in a status bar.

In one embodiment, user interface 48-29-02 may contain a plurality of buttons, such as button 48-29-04, which may be used to launch applications. As an option, one or more of these application buttons may be located in a dock (e.g. application button 48-29-08, etc.), or a designated portion of the user interface which is more accessible to the user than other locations.

In various embodiments, user interface 48-29-02 may contain one or more application buttons which are disabled because they are associated with functionality not available in the absence of an integration. For example, in one embodiment, tablet user interface 48-29-02 may contain phone button 48-29-08, which is disabled due to a lack of a local cellular modem or integration with a phone.

In some embodiments, applications which are not available due to the lack of an integration may still be visible, yet visually distinct from operational applications. In other embodiments, unavailable applications may be hidden from view until they become operational through an integration. As an option, the reappearance of the buttons associated with said applications may cause other buttons to shift in position, restoring the organization that existed during previous integrations.

In still other embodiments, the visibility of unavailable application buttons may depend upon their location. For example, in one embodiment, buttons for unavailable applications located in a dock (such as button 48-29-08) may remain visible, while buttons located elsewhere may be hidden. In this way, the user may have a predictable application dock.

Upon integration, the user interface for launching applications may change to reflect the additional resources now available. For example, see user interface 48-29-10. In one embodiment, user interface 48-29-10 may reflect the existence of an integration in a number of ways, including the appearance of integration status icon 48-29-12.

An integration between a tablet and phone may provide functionality not available on the tablet alone. In various embodiments, user interface 48-29-10 may include buttons such as button 48-29-14, which is for launching a phone application, which makes use of the integrated phone. Another example may be a SMS messaging application. In some embodiments, this button may be visually distinct (e.g. double frame, etc.) from application buttons associated with applications local to the tablet device, indicating that it is making use of integrated hardware. Additionally, a different appearance will remind the user that upon disintegration, this application button may become disabled, or disappear altogether, in accordance with various embodiments.

An integration between a tablet and a phone may result in one or more applications being transferred from the phone to the tablet as part of a live migration. In various embodiments, user interface 48-29-10 may include buttons such as button 48-29-16 for launching or making active an application which is running on the tablet as part of a virtual machine or virtual application. In some embodiments, each application which was migrated from one device to another as part of an integration may be incorporated into the local application launching interface as visually distinct (e.g. inverted color, etc.) application buttons. In this way, a user may be made aware that this application is not native to the tablet device. In one embodiment, virtual application buttons such as 48-29-16 may be placed in a predefined area within an application launching interface. In another embodiment, virtual application buttons may be placed in the next available spot within the organizational scheme of an application launcher.

An integration between a tablet and a phone may result in the aggregation of data stored on both devices. In various embodiments, user interface 48-29-10 may include buttons such as button 48-29-18, which are visually distinct (e.g. style of application name, etc.) from other application buttons, to indicate that they have access to aggregated data as part of the integration. As a specific example, if it is determined that both the phone and the tablet contain address book data, and the sets are not identical (indicating that an aggregation may represent a superior set of data), the address book application button may have a different appearance than it does when the tablet is used by itself.

In some embodiments, launching an application which has access to new information through the integration may result in the user being able to use the application with the aggregated set of data without altering the data stored on either device. In other embodiments, the user may be notified that there are differences between the two data sets, and may be prompted to choose whether to synchronize the two data sets.

In some embodiments, application buttons, such as button 48-29-18, may be visually distinct because they have access to additional information through the integration. In other embodiments, this visual distinction may be given to the buttons of applications which may make use of integrated hardware (e.g. camera, audio equipment, etc.).

A few examples have been given of ways to make buttons associated with applications visually distinct. Other examples may include, but are not limited to, variations in color saturation, some form of animation (e.g. pulsing, etc.), and/or any other method of modifying the appearance of an application button without overly obscuring the identity of the associated application.

FIG. 48-30 shows a method 48-30-00 for sharing content, in accordance with one embodiment. As an option, the method 48-30-00 may be implemented in the context of the architecture and environment of the previous Figures or any subsequent Figure(s). Of course, however, the method 48-30-00 may be implemented in any desired environment. It should also be noted that the aforementioned definitions may apply during the present description.

The integration of a tablet device and a phone device may combine a phone's ability to communicate with a tablet's ability to display more content. In many cases, a user may wish to share content from one of the devices with one or more individuals while (or after) communicating with them. In various embodiments, method 48-30-00 may be utilized to share content with individuals with whom a user is currently, or was previously, communicating, hereinafter referred to as communication participants.

As shown, it is determined whether to initiate the sharing of content. See determination 48-30-02. In various embodiments, sharing may be initiated by the user. For example, in one embodiment, the sharing of content may be initiated in response to a user interaction with a sharing widget, button, or some other kind of user interface element. As an option, said widget or button may be located in a status bar, typically located unobtrusively alone one edge of a device display. In another embodiment, the sharing of content may be initiated in response to some form of user input, including, but not limited to, a multitouch gesture, a key combination, a voice command, accelerometer input, and/or any other form of user input.

In one embodiment, sharing may be initiated through a content-handling system which may be part of the device operating system. In the context of the present description, content handling system refers to a method and user interface which may be provided by an operating system or application for manipulating, viewing, and/or transmitting content. An example of a content-handling system may be an interface which pops up, prompting the user to select an application to use to open selected content (e.g. “open with . . . ”, etc.). Another example is a system which allows a user to send content directly to a communication application or service, to be attached to a communication (e.g. an interface which gives options such as “Email to . . . ”, “Post to Facebook”, “Post to Twitter”, etc.).

In one embodiment, sharing may be initiated automatically. For example, in one embodiment, a device, or a pair of integrated devices, may monitor an ongoing communications (e.g. voice call, video conference, etc.) for contextual clues that the sharing of content may be desired. As a specific example, in one embodiment, the sharing of content may be initiated automatically when one of the communication participants is heard to say “can you send . . . ”, or “can you email me/us . . . ”, immediately followed by a response from the user.

In one embodiment, sharing may be initiated automatically, based upon previously observed user behavior. For example, in one embodiment, if a user has previously shared content in relation to a communication, they may be prompted with the option to do so in identical, or similar, future scenarios. In another embodiment, sharing may be initiated based upon previous behavior without prompting the user for confirmation before content is selected.

If it is determined that sharing should be initiated, the content to be shared is then identified. See operation 48-30-04. In some embodiments, the user may designate the content to be shared in one or more ways. For example, in one embodiment, the user may drag a piece of content, or an iconic representation of content, over to a user interface element operable to receive such objects. Examples of such user interface elements may include, but are not limited to, a sharing widget (e.g. status bar icon, etc.), a button, a predefined portion of the display, an iconic representation of one or more communication participants (e.g. contact photos, etc.).

In one embodiment, the user may designate the content to be shared by making an active selection through a user interface. In the context of the present description, an active selection refers to a portion of content which has been designated by the user as a target for a subsequent operation (e.g. cut, copy, clear, style change, etc.). In some embodiments, an active selection may be visually distinct from other content being displayed (e.g. framed within a border, shaded, animated, etc.).

In various embodiments, a user may make an active selection for the purpose of sharing content in a variety of ways. For example, in one embodiment, a user may select content to share by surrounding it with a bounding box created with a dragging user interaction (e.g. click and drag, touch and drag, etc.). In another embodiment, a user may select content to share by drawing a boundary around the desired content, either with a touch-based interaction or a cursor-based interaction. In some embodiments, a user may select content to share using the same selection method (and corresponding user interface elements and conventions) used to cut or copy content.

In various embodiments, default content may be shared if no other content has been selected by the user. In some embodiments, the user may select what content should be shared in the absence of further user selection. For example, the user may select a particular document, the current version of which will be shared in the absence of another content selection. In other embodiments, the user may not be able to change what content is shared by default, in the absence of a user selection. Other examples of potential default content to be shared may include, but are not limited to, a capture of one or more displays, an image captured from a camera associated with a device or integration, the user's contact info (e.g. vCard, etc.), and/or any other content.

In various embodiments, the content to be shared may be selected automatically. For example, in one embodiment, a device, or a pair of integrated devices, may monitor an ongoing communications (e.g. voice call, video conference, etc.) for contextual clues regarding what content would be the most appropriate to share. As a specific example, in one embodiment, content pertinent to an ongoing communication may be identified by searching for correlations between words, phrases, and numbers used in the communication and the content the user is able to share. In another embodiment, the search for a correlation may be limited to metadata associated with content (e.g. filename, modification date, etc.).

In one embodiment, content may be selected for sharing automatically, based upon previously observed behavior. For example, in one embodiment, if it has been observed that a particular piece of content, or a type of content, has been shared during communications with a certain set of participants, that content, or type of content, may be automatically selected for sharing during, or after, communications with the same set of participants. In another embodiment, the user may be presented with one or more pieces of content which are potentially pertinent to an ongoing or previous communication, based upon one or more criteria. Possible criteria for identifying potentially pertinent content includes, but is not limited to, documents or other content that the user has recently accessed or modified (e.g. the closer in time to the communication, the more potential for pertinence, etc.), sources of documents or other content (e.g. was it previously received from one of the communication participants, etc.), the identity of the creator of a document or other content (e.g. did one of the communication participants create the content, etc.), the combination of any of these criteria, and/or any other criteria which may indicate the potential relevance of a piece of content.

In some embodiments, content may be automatically selected, or the user may be presented with a selection of content automatically identified, every time sharing is initiated. In other embodiments, the automatic selection of content may be performed only in the absence of an explicit user selection of content (e.g. automatic selection may be the default, etc.).

In some embodiments, the user may be informed of what content has been automatically selected for sharing. In other embodiments, the user may be required to confirm the results of the automatic selection before the content is shared.

After the content to share has been identified, it is then determined whether to perform the sharing using parameters previously used to share content. See determination 48-30-06. In the case where a user wishes to share content in conjunction with a communication more than once, it may be beneficial to be able to quickly perform a sharing without having to redefine the sharing parameters. Sharing parameters may include, but are not limited to, the identity of recipients, the method of transmission, and/or any other parameter associated with the sharing of content.

In various embodiments, previously utilized sharing parameters may be used again in response to a user interaction. Examples of possible triggering user interactions include, but are not limited to, extended interactions (e.g. touch and hold, click and hold, etc.), alternative interactions (e.g. right click, etc.), multitouch gestures, key combinations, voice commands, and/or any other form of user interaction or input.

In various embodiments, previously utilized sharing parameters may be used again based upon the context of sharing. For example, in one embodiment, if a user has already shared content during an ongoing communication, subsequent sharing initiated during that communication may automatically utilize the same sharing parameters. Furthermore, in various embodiments, previously utilized sharing parameters may be used again automatically, based upon contextual clues obtained from an ongoing communication.

If it is determined that previous sharing parameters should be used, then the identified content is shared utilizing previous sharing parameters. See operation 48-30-08. In some embodiments, the sharing parameters of the last sharing may be used. In other embodiments, the sharing parameters from the last time content was shared with the same set of communication participants may be used.

If it is determined that reusing a previous set of sharing parameters would not be appropriate, the user may be prompted to define a new set of sharing parameters. As shown, sharing recipients are identified. See operation 48-30-10. In one embodiment, sharing may be automatically directed at all communication participants. In another embodiment, the user may be prompted to choose from participants of ongoing or previous communications.

In various embodiments, sharing recipients may be selected automatically. For example, in one embodiment, a device, or a pair of integrated devices, may monitor an ongoing communications (e.g. voice call, video conference, etc.) for contextual clues that the sharing of content may be desired. As a specific example, in one embodiment, a recipient may be selected automatically when one of the communication participants is heard to say “can you send me . . . ”, or “can you send Bill . . . ”, followed by an affirmative response from the user.

In various embodiments, sharing recipients may be selected automatically, based upon previously observed user behavior. For example, in one embodiment, if it has been observed that every time content is shared with a particular recipient, it is also shared with another recipient, or some other action is taken (e.g. a copy placed in cloud storage, etc.), similar action may be taken automatically in subsequent instances of sharing. As an option, the user may be notified of such an automatic action, and be given an opportunity to intervene.

As shown, the sharing channel is identified. See operation 48-30-12. In the context of the present description, a sharing channel refers to a method of sending content from the user to one or more recipients, or making said content available to one or more recipients. Possible sharing channels may include, but are not limited to, email, SMS, FTP/SFTP, web server (e.g. WebDAV protocol, etc.), cloud storage (e.g. Dropbox, SugarSync, Amazon S3, etc.), social network, collaboration or project management service (e.g. Basecamp, etc.), BitTorrent or other peer-to-peer file sharing, LAN/intranet file sharing (e.g. AFP-based, SMB-based, etc.), and/or any other method, protocol, server, or service which may be used to share content from one party to one or more other parties.

In some embodiments, the content shared with multiple recipients may be sent to all recipients through the same sharing channel. As an option, the user may be prompted to select the sharing channel when sharing is initiated. In other embodiments, different sharing channels may be used for different recipients. For example, in one embodiment, there may be defined a preferred sharing channel for each communication participants.

In some embodiments, a preferred sharing channel may be defined for a communication participant within a contact data record (e.g. it may be viewed and/or modified using an address book application, etc.). In other embodiments, a preferred sharing channel may be determined for each communication participant upon initiation of a communication. For example, in one embodiment, a user's system may automatically send a sharing channel request message to all communication participants; communication participants who are using a compatible communication system may send a response automatically, without requiring input from the communication participant, indicating a preferred sharing channel. In some embodiments, said determination may be performed at the start of every new communication. In other embodiments, said determination may be performed only in if the user's contact record for a communication participant does not contain a preferred sharing channel.

In various embodiments, a sharing channel request message may be sent and replied to using a variety of methods. For example, in one embodiment, the message and response may be transmitted through an external server, such as a cloud server. In another embodiment, the message and response may be sent through other messaging channels, such as SMS. In yet another embodiment, the message and response may be sent through the audio channel of an ongoing communication (e.g. using tones outside the range of human hearing, frequency modulation, etc.). In some embodiments, if a preferred sharing channel is not known for a communication participant, or cannot be determined, a default sharing channel may be used.

In some embodiments, a sharing channel may be used to send content directly to a recipient. As a specific example, a file may be placed in the cloud storage of a recipient. In other embodiments, a sharing channel may be used to make content available to a recipient. As an option, the recipient may be sent a message directing them to the now-available content. As a specific example, a file may be placed in the cloud storage of the user, and a message may be sent to a recipient containing a URL which allows the recipient to download the file through a web browser. In some embodiments, a user may be able to define a message which is sent to recipients when such a sharing channel is used.

In some embodiments, a sharing channel may be selected automatically. For example, in one embodiment, a device, or a pair of integrated devices, may monitor an ongoing communications (e.g. voice call, video conference, etc.) for contextual clues indicating a desired sharing channel. As a specific example, in one embodiment, an email sharing channel may be selected automatically when one of the communication participants is heard to say “can you email that to me . . . ”, or “email us . . . ”, followed by an affirmative response from the user.

In various embodiments, a sharing channel may be selected automatically, based upon previously observed user behavior. For example, in one embodiment, if it has been observed that every time content is shared with a particular recipient, it is shared using a particular sharing channel, similar action may be taken automatically in subsequent instances of sharing. As an option, the user may be notified of such an automatic action, and be given an opportunity to intervene.

After one or more recipients have been identified, and one or more sharing channels have been selected, the content is shared. See operation 48-30-14. In some embodiments, the content may be sent directly to a recipient. In other embodiments, the content may be made available, and a message is sent to a recipient instructing them how to obtain the content (e.g. a URL pointing to content stored in cloud storage, an IP address to an FTP server, etc.).

Method 48-30-00 for sharing content may be adapted for sharing content in other contexts, in accordance with one embodiment. For example, it may be utilized in a integrated system, or using a single device. Furthermore, this method may be used in conjunction with communication between individuals in the same physical vicinity (e.g. a meeting, a party, a classroom, etc.), in accordance with one embodiment.

FIG. 48-31 shows a plurality of user interfaces 48-31-00 for sharing content, in accordance with one embodiment. As an option, the plurality of user interfaces 48-31-00 may be implemented in the context of the architecture and environment of the previous Figures or any subsequent Figure(s). Of course, however, the plurality of user interfaces 48-31-00 may be implemented in any desired environment. It should also be noted that the aforementioned definitions may apply during the present description.

The integration of a tablet device and a phone device may combine a phone's ability to communicate with a tablet's ability to display more content. In many cases, a user may wish to share content from one of the devices with one or more individuals while (or after) communicating with them. In various embodiments, the plurality of user interfaces 48-31-00 may be used to share content with individuals with whom a user is currently, or was previously, communicating.

In various embodiments, user interface 48-31-02 may be used to facilitate the sharing of content through interaction with a status bar 48-31-04. For example, in one embodiment, status bar 48-31-04 may include a sharing widget 48-31-06, which provides easily accessed sharing functionality without overly disrupting the use of an application.

In various embodiments, a user may interact with sharing widget 48-31-06 to share content. For example, in one embodiment, a user may drag an object (e.g. text selection, image, document in iconic form, etc.) to the widget to initiate a sharing procedure. As an option, there may exist an API which would allow developers to include this drag-and-drop sharing functionality within an application.

In another embodiment, a user may select an object using a standard selection interaction, and then interact with (e.g. tap, click, etc.) sharing widget 48-31-06 to initiate a sharing procedure. In this way, all applications which support basic cut/copy/paste functionality (i.e. content can be selected before performing an operation) may be compatible with this method of sharing content, without any additional coding. As an option, interacting with the sharing widget when nothing is selected may trigger a screen capture, the resulting image becoming the content to be shared.

In some embodiments, a user may initiate the same or similar sharing process through a pre-existing sharing functionality. For example, in one embodiment, applications which make use of an operating system-based sharing mechanism (e.g. “email to . . . ”, “Post to Facebook”, “Post to Twitter”, etc.) may provide additional options when used in the context of an ongoing or recently terminated communication. As an option, the user may utilize said sharing mechanism to access a user interface which provides additional options, such as user interface 48-31-08.

In various embodiments, interacting with a sharing widget, or selecting an appropriate option within a system-wide sharing mechanism, may result in the display of user interface 48-31-08. As shown, user interface 48-31-08 may include a text field 48-31-10 which describes the content being shared, in accordance with one embodiment. The content description may include, but is not limited to, a file name, a file size, a file type and/or name of associated application, a creation date, a modification date, dimensions of an image, metadata (e.g. notes, EXIF data, etc.), and/or any other descriptive information. In some embodiments, text field 48-31-10 may be accompanied by one or more images, which may include, but are not limited to, a file icon, a creating application icon, a thumbnail preview of the content, and/or any other graphical representation of the content or descriptive data. In some embodiments, multiple pieces of content may be listed, and shared.

In various embodiments, user interface 48-31-08 may provide the user with one or more choices of destinations for the selected content. For example, in one embodiment, user interface 48-31-08 may include one or more buttons 48-31-12 which represent the participants of an ongoing communication (e.g. voice call, video conference, etc.). These buttons may be grouped under a label indicating the nature of the ongoing activity (e.g. “Current Voice Call”, etc.), a label which may change depending on the nature of the communication. In one embodiment, the buttons may bear the image of the communication participant they represent, or an icon if no image is available. Furthermore, in one embodiment, the buttons may be labeled with the communication participants name, or some other identifier (e.g. phone number, IP address, communication origination city, etc.) if a name is not known.

In one embodiment, a user may select only one button representing a communication participant. In another embodiment, a user may select multiple buttons. For example, one interaction (e.g. tap, click, etc.) may select the button, and a second interaction may deselect the button.

In various embodiments, user interface 48-31-08 may include one or more buttons 48-31-14 which represent the participants of previous communications. For example, in one embodiment, these buttons may represent all communications made within a certain time period (e.g. the last 3 hours, etc.). In another embodiment, buttons 48-31-14 may represent the most recent communications, independent of how long ago they took place.

In various embodiments, buttons 48-31-14 may bear the image of all participants (other than the user) of a particular previous communication. In the case of a communication involving more than one other participant, the button may be segmented to contain images or iconic representations of all other participants, in accordance with one embodiment. As an option, said images may spread out and expand in size in response to a user interacting with the button; the user may subsequently select the desired recipients of the content with further interactions, or may dismiss the expanded set of images with an interaction outside the boundary of the collection of representative images.

In various embodiments, buttons 48-31-14 may be labeled with descriptive information. The descriptive labels of buttons 48-31-14 may include, but are not limited to, the type of communication (e.g. voice call, video conference, etc.), the time and date that the communication took place, the duration of the communication, the names of the participants (e.g. full names, initials, abbreviated names, etc.), and/or any other descriptive information.

In one embodiment, user interface 48-31-08 may include a button 48-31-16 which allows the user to select all participants of the current communication with a single interaction. Furthermore, in one embodiment, all participants of the current communication may be selected by default. In another embodiment, the previously selected recipients may remain selected upon subsequent uses of user interface 48-31-08, if the associated communication is still relevant (e.g. current, or recent enough to merit being listed, etc.).

In various embodiments, user interface 48-31-08 may include a plurality of buttons 48-31-18 which represent various sharing channels through which content may be shared. In some embodiments, the user may specify which sharing channels are represented by buttons 48-31-18.

In one embodiment, one or more of the buttons 48-31-18 may be disabled, if the associated sharing channel is not compatible with the content being shared. For example, the size of the content may exceed a limit imposed on a particular channel. Furthermore, in one embodiment, one or more of the buttons 48-31-18 may be disabled if all of the selected recipients are unable to receive content through the associated channel(s). For example, the user may not have an email address for the selected participant(s). If the user has selected multiple recipients, and some, but not all, are not able to receive content through a particular sharing channel, the associated sharing channel button may be given a distinct appearance, or the user may be notified. The user may proceed with sharing the content through that channel, but will do so having been notified that one or more of the designated recipients will not receive it. As an option, the recipients who will not be able to receive the content may be indicated to the user, along with a prompt to verify the content should be shared through that channel.

Some sharing channels may require a method of addressing a recipient (e.g. email address, phone number for SMS, etc.). Other sharing channels may provide more flexibility. For example, in one embodiment, if a user elects to share selected content through a cloud storage service, said content may be sent directly to a shared directory associated with a recipient, said directory being noted in a contact record. If the user's records do not indicate a shared directory within cloud storage for a designated recipient, the content may be placed in the user's own cloud storage, and a link to the content may be sent through a channel which is available for said recipient (e.g. email, SMS, etc.). In addition to cloud storage, this flexibility may be achieved through other channels, including, but not limited to, FTP/SFTP servers, WebDAV servers, and/or any other sharing channel which may be linked to through a text-based message (e.g. a URL, an IP address, etc.) or an easily transmitted file (e.g. torrent, etc.).

In some embodiments, user interface 48-31-08 may be presented to the user in response to every interaction with sharing widget 48-31-06. In other embodiments, certain user interactions (e.g. press and hold, click and hold, right click, etc.) with the sharing widget may cause the selected/dragged content to be shared with the same recipients and through the same channel as was the last content which was shared. In this way, after the first instance of content sharing during an ongoing communication, subsequent content sharing with those individuals will require less effort. In some embodiments, if there is insufficient information to share content with any of the ongoing or previous communication participants through any sharing channel, sharing widget 48-31-06 may be disabled.

As discussed previously, these methods and interfaces for sharing content may be adapted for sharing content in other contexts, in accordance with one embodiment. For example, they may be used in conjunction with communication between individuals in the same physical vicinity (e.g. a meeting, a party, a classroom, etc.). Said sharing may be accomplished using peer-to-peer wireless networking, such as Wi-Fi direct. In such a case, buttons 48-31-12 of user interface 48-31-08 may display nearby individuals/devices which are receptive to such a form of sharing. Furthermore, in one embodiment, these methods and user interfaces for sharing content may be utilized in an integrated system of a tablet and a phone, as well as on a non-integrated tablet or phone.

FIG. 48-32 shows a plurality of user interfaces 48-32-00 for receiving and responding to a voice call, in accordance with one embodiment. As an option, the plurality of user interfaces 48-32-00 may be implemented in the context of the architecture and environment of the previous Figures or any subsequent Figure(s). Of course, however, the plurality of user interfaces 48-32-00 may be implemented in any desired environment. It should also be noted that the aforementioned definitions may apply during the present description.

In various embodiments, integration functionality may be utilized, and phone events may be handled, using a native tablet interface, such as those depicted within the plurality of user interfaces 48-32-00. In various embodiments, these user interface may be utilized to receive and respond to an invitation to join a video conference with one or more participants. For example, in one embodiment, user interface 48-32-02 may be used to receive and respond to an invitation to join a video conference with one other participant.

As shown, user interface 48-32-02 is similar in appearance and functionality to user interface 48-19-02 of FIG. 48-19-, in accordance with one embodiment. However, there are some differences due to involvement of video. For example, in one embodiment, descriptive graphic element 48-32-04 may display an incoming video stream of the individual inviting the user to join a video conference. In another embodiment, though, descriptive graphic element 48-32-04 may be a still image (e.g. contact photo, a frame taken from participant's video feed, etc.) or an iconic representation of the participant, similar to what is done for voice calls.

In various embodiments, the user may be given an opportunity to preview their own video stream before responding to an invitation to join a video conference. For example, in one embodiment, user interface 48-32-02 may include user video panel 48-32-06, which displays the user's own video stream. Furthermore, in one embodiment, user interface 48-32-02 may include button 48-32-08, which may be used to switch between displaying user video panel 48-32-06 and a communication history panel, which may be similar to panel 48-19-18 of FIG. 48-19-. In some embodiments, user interface 48-32-02 may display user video panel 48-32-06 by default. In other embodiments, user interface 48-32-02 may display whatever panel was visible the last time the user interface was active. Furthermore, in one embodiment, if the communication history panel is being displayed, button 48-32-08 may display the user's video stream at a reduced size.

In some embodiments, user interface 48-32-02 may include button 48-32-10, which may be used to define one or more parameters associated with the user's video stream. As an option, these parameters may be defined through a user interface. Possible video stream parameters may include, but are not limited to, an automatic or manual white balance, a digital zoom, a brightness, one or more video effects (e.g. color manipulation, distortion, mapping to a different color space, etc.), and/or any other parameter which may be associated with a video stream.

In various embodiments, user interface 48-32-02 may include a collection of buttons 48-32-12 which provide a plurality of response options to the user. In some embodiments, these response options may be similar to those provided by user interface 48-19-02 of FIG. 48-19-. For example, a user may have the option to accept the invitation to join the video conference, transfer the individual making the invitation to a voicemail system, send a reply or smart reply, or set a reminder to contact the participant at a later time. Furthermore, in one embodiment, collection 48-32-12 may include a button 48-32-14 which allows the user to join the video conference without sending a video stream (e.g. sending an audio stream only, etc.).

In the case where the user is being invited to an ongoing video conference made up of more than one participant, the user may be presented with user interface 48-32-16, in accordance with one embodiment. As shown, in one embodiment, the pre-conference user interface may include a collection of graphical representations of the video conference participants, such as collection of buttons 48-32-18. As an option, the representation associated with the individual who issued the invitation to the user may be visually distinct from the other representation.

FIG. 48-33 shows a plurality of user interfaces 48-33-00 for modifying an ongoing video conference, in accordance with one embodiment. As an option, the plurality of user interfaces 48-33-00 may be implemented in the context of the architecture and environment of the previous Figures or any subsequent Figure(s). Of course, however, the plurality of user interfaces 48-33-00 may be implemented in any desired environment. It should also be noted that the aforementioned definitions may apply during the present description.

In various embodiments, the user interfaces used to respond to, modify, and enhance a video conference may be similar in appearance and functionality as the user interfaces utilized in conjunction with voice calls. For example, plurality of user interfaces 48-33-00 may be utilized to modify or enhance an ongoing video conference involving one or more participants.

In one embodiment, user interface 48-33-02 may be utilized to modify or enhance a ongoing video conference involving one other participant. In various embodiments, user interface 48-33-02 may provide functionality similar to that provided by user interface 48-20-00 of FIG. 48-20-. For example, in one embodiment, user interface 48-33-02 may include collections of buttons 48-33-04 which allow the user to perform various in-conference operations, as well as interact with various applications, similar to buttons shown in FIG. 48-20-. However, in some embodiments, additional functionality may be needed due to the inclusion of a video stream.

In various embodiments, user interface 48-33-02 may include a button 48-33-06 which allows the user to turn off their camera, sending only an audio stream to the other conference participant. In one embodiment, this button may cause the camera video stream to be replaced with a video or image. Possible replacements for the camera video stream include, but are not limited to, a solid color (e.g. black, etc.), an iconic representation of a user, a looping video, a message indicating that the user has disabled the camera video stream, an image, and/or any other video stream. In some embodiments, the user may be able to define what is sent in the place of a video stream from a camera.

In various embodiments, user interface 48-33-02 may include a button 48-33-08 which allows the user to modify various settings related to the video conference. For example, in one embodiment, this button may allow a user to define what happens to the user's video stream when the user is no longer in view of the camera.

In some embodiments, the user's presence within the outgoing video stream may be determined using various methods, including, but not limited to, face detection, motion detection, and/or any other method of analyzing the content of a video stream. When the user is no longer in view of the camera, the outgoing video stream may be replaced with different content, in accordance with one embodiment. For example, in one embodiment, the video stream may be replaced with content associated with the user, including, but not limited to, a weather report for the user's current location, a slideshow of photos, a predefined message from the user (e.g. “I'll be right back”, etc.), and/or any other content.

In various embodiments, the outgoing video steam may be replaced with a loop of video containing the user. In some embodiments, the replacement video loop may be created automatically. For example, in one embodiment, the outgoing video stream may be captured and analyzed until a portion that is longer than a predefined length is able to be looped, as determined by comparing the difference between the first frame and the last frame. Of course, in other embodiments, other methods may be employed to create the video loop.

In some embodiments, the same type of content may be displayed when the user leaves the camera frame during a video conference, independent of who the other conference participants are. In other embodiments, the content displayed may depend upon who is participating in the video conference. As an option, a user may be able to define these settings using button 48-33-08.

In the case where the user is participating in an ongoing video conference made up of more than one participant, the user may be presented with user interface 48-33-10, in accordance with one embodiment. As shown, in one embodiment, the in-conference user interface may include a collection of graphical representations of the video conference participants, such as collection of buttons 48-33-12. As an option, these buttons may display the video streams associated the said participants. Furthermore, in one embodiment, the buttons associated with participants who are currently speaking and/or displayed in the in-conference descriptive elements may be visually distinct, similar to the user interface shown in FIG. 48-21-.

FIG. 48-34 shows a plurality of user interfaces 48-34-00 for modifying an ongoing video conference, in accordance with another embodiment. As an option, the plurality of user interfaces 48-34-00 may be implemented in the context of the architecture and environment of the previous Figures or any subsequent Figure(s). Of course, however, the plurality of user interfaces 48-34-00 may be implemented in any desired environment. It should also be noted that the aforementioned definitions may apply during the present description.

In various embodiments, the user interfaces used to modify and enhance a video conference may be dynamic, allowing a user to expand, minimize, or even hide various user interface elements. For example, in one embodiment, user interface 48-34-02 may include a plurality of buttons, such as button 48-34-04, which represent the participants of the video conference. In some embodiments, these representations may display the video streams associated with the participants. A user may interact with (e.g. touch, click, etc.) these representations to specify which participant is the target of descriptive elements of user interface 48-34-02.

In some embodiments, a the participant representations of user interface 48-34-02, such as button 48-34-04, may be used to change how the video streams are displayed. For example, in one embodiment, if a user interacts with a selected representation for a second time, user interface 48-34-06 may be displayed, hiding the caller information panel and the communication history panel, and enlarging the participant video streams 48-34-08. Furthermore, in one embodiment, user interface 48-34-06 may include an element displaying the user's video stream.

In some embodiments, interacting with one of the participant video streams in user interface 48-34-06 may present the user with user interface 48-34-02, where said participant is the focus of the descriptive elements.

As shown, user interface 48-34-06 may include a button 48-34-12 which may be used to display a list of content which has been shared in conjunction with the ongoing communication, in accordance with various embodiments. In one embodiment, said list may be presented in a similar manner as the participant video streams, reducing the size of the stream elements to provide room for the list. In other embodiments, a user may further expand the participant stream elements, hiding the buttons associated with operations and applications.

FIG. 48-35 shows a plurality of user interfaces 48-35-00 for utilizing a secondary display, in accordance with one embodiment. As an option, the plurality of user interfaces 48-35-00 may be implemented in the context of the architecture and environment of the previous Figures or any subsequent Figure(s). Of course, however, the plurality of user interfaces 48-35-00 may be implemented in any desired environment. It should also be noted that the aforementioned definitions may apply during the present description.

In some cases, an integration comprised of a phone and a tablet may utilize the displays of both devices. In various embodiments, the larger display of an integrated tablet may be used as a prime display, and the smaller display of a phone may be used as a secondary display. In some embodiments, the user interfaces shown previously may be adapted for use on a secondary display. For example, see the plurality of user interfaces 48-35-00.

As shown, in one embodiment, user interface 48-35-02 may be provided on a secondary display, and used to operate an application (e.g. calendar application, etc.) in conjunction with an ongoing or recently terminated communication (e.g. voice call, video conference, etc.). In this way, the application may be presented to the user on the prime display without any change in appearance to allow for the additional user interface elements needed to combine the application functionality with the communication.

As shown, in one embodiment, user interfaces 48-35-04 and 48-35-06 may be provided on a secondary display, and used to modify and/or enhance an ongoing communication. In another embodiment, a user may switch between these two user interfaces by interacting with the visual representation of a participant, as previously described with respect to FIG. 48-34.

As shown, in one embodiment, user interface 48-33-08 may be provided on a secondary display, and used to present video steams of the communication participants without taking up any of the display real estate on the prime display. This user interface may be used in conjunction with a shared workspace, in accordance with one embodiment.

In some embodiments, a user may be able to specify one or more user interface elements to be displayed on a secondary display. For example, in one embodiment, a user may specify that the caller information panel or the communication history panel be displayed on a secondary display while the prime display is devoted to video streams or an application. In some embodiments, the user may interact with a secondary display in a different manner than they interact with the prime display. For example, in one embodiment, a user may interact with a secondary display using a touchscreen, while the prime display may be controlled using a mouse.

FIG. 48-36 shows a method 48-36-00 for modifying the user experience, in accordance with one embodiment. As an option, the method 48-36-00 may be implemented in the context of the architecture and environment of the previous Figures or any subsequent Figure(s). Of course, however, the method 48-36-00 may be implemented in any desired environment. It should also be noted that the aforementioned definitions may apply during the present description.

In many cases, a user may perform an action, or a series of actions, in a predictable manner. Identifying said patterns may allow a device or plurality of devices to anticipate a user's intentions and assist them. The integration of a phone and a tablet, and the consolidation of their user observations, may facilitate the identification of behavior patterns. In various embodiments, method 48-36-00 may be utilized to modify the user experience according to observed user behavior.

As shown, user behavior is observed. See operation 48-36-02. In various embodiments, a variety of user behavior may be observed. Possible examples of observable behavior may include, but is not limited to, execution and/or termination of applications, modification of system settings (e.g. display brightness, volume, wireless interfaces, etc.), sending a message (e.g. email, SMS, social network, etc.), reading a message, deleting a message, opening a web site, capturing a photo and/or video, changing device orientation, operating a device hardware interface (e.g. silent switch, volume buttons, home button, sleep button, etc.), activation and/or deactivation of passcode-based device lock, joining a wireless network, changing a power source, and/or any other user behavior.

In some embodiments, observable user behavior may also include user actions taken within an application. For example, application-based user behavior which may be observed may include, but is not limited to, finance-related behavior (e.g. paying a bill, checking a bank balance, transferring money between accounts, making a purchase, etc.), entertainment-related behavior (e.g. purchasing tickets, making reservations, reading reviews, watching movie trailers, etc.), communication-related behavior (e.g. making a call, checking voicemail, creating and/or modifying a contact record, etc.), document-related behavior (e.g. opening a document, modifying a document, archiving or compressing a document, backing up a document, copying a document, creating a new document, deleting a document, etc.), schedule-related behavior (e.g. making a new calendar event, modifying a new calendar event, accepting and/or declining an invitation to an event, etc.), health-related behavior (e.g. recording a meal, recording a weight, recording a health-related reading, etc.), profession-related behavior (e.g. recording time spent on project, giving a presentation, etc.), any/or any other application-based user behavior.

In various embodiments, observations of user behavior may be stored in one or more log files. In some embodiments, user behavior logs may be stored on an external server, such as a cloud server. In other embodiments, user behavior logs may be stored on the device where the behavior was observed. In one such embodiment, user behavior logs of two devices may be combined upon integration. Furthermore, in one embodiment, observed user behavior may be recorded in a database.

In various embodiments, additional information may be recorded in association with observed user behavior. For example, in some embodiments, a user behavior log may describe a plurality of observed user behaviors, as well as data giving said behavior context. Examples of such contextual data may include, but are not limited to, behavior time and date, device identity, device location, active and/or observable wireless network, data related to a document associated with a user behavior (e.g. filename, metadata, etc.), the content of an associated document (e.g. identity of people in a picture, words in a text document, etc.), type of power supply (e.g. external, battery, etc.), local weather, and/or any other data which may provide context for an observed user behavior.

In some embodiments, all user behavior may be observed. In other embodiments, a user may be required to give permission before any observed user behavior is recorded or transmitted. In still other embodiments, a user may grant permission for specific types of user behavior to be recorded.

As shown, user behavior patterns are identified. See operation 48-36-04. In various embodiments, patterns within the observed user behavior may be identified automatically. The methods which may be employed to identify user behavior patterns may include, but are not limited to, machine learning, decision tree learning, cluster analysis, an artificial neural network, data mining, sequence mining, a Bayesian network, and/or any other method of identifying a pattern.

In some embodiments, user behavior patterns may be identified by considering all contextual data at the same time (e.g. a form of clustering analysis, etc.). In other embodiments, user behavior patterns may be identified sequentially. For example, in one embodiment, user behavior data may be searched for a pattern while organized with respect to time, or some other contextual dimension (e.g. location, device identity, etc.). Discovered patterns may then be further refined until a threshold confidence has been met. In the context of the present description, a confidence refers to a numerical value which may be assigned to a prediction, which is associated, at least in part, with the probability that the prediction is correct. Furthermore, a threshold confidence refers to a confidence value beyond which a prediction may be used to modify the user experience.

In some embodiments, a user may specify the threshold confidence level. For example, in one embodiment, a user may indicate a threshold confidence level explicitly, though a user interface. In another embodiment, a user may specify a threshold confidence level indirectly, by accepting or rejecting the proposed automation of various behaviors. Over time, the system may determine what threshold confidence would best fit the manner in which the user operates their devices.

In some embodiments, the analysis of recorded user behavior in search of patterns may be performed at regular intervals. In other embodiments, said analysis may be performed in response to an event, such as the observation of a new type of behavior. In still other embodiments, the analysis of recorded user behavior may be performed at times when the user is not utilizing all of a device or integrations processing power. By delaying the analysis until a time when the processor is idle, the user experience will not be detrimentally changed under the processing load.

As shown, the user experience is modified according to observed patterns. See operation 48-36-06. In various embodiments, the user experience may be modified according to observed patterns of user behavior in a variety of ways. For example, in one embodiment, upon identification of a user behavior pattern which has been previously observed, where said identification may be made with a sufficient degree of confidence before the entire behavior pattern has occurred, the user may be prompted with the option to have the rest of the behavior performed automatically. In another embodiment, said performance of the rest of the behavior may be performed automatically, without prompting the user for permission.

In various embodiments, the user experience may be modified by altering a user interface based upon observed user behavior patterns. For example, in one embodiment, if an observed behavior pattern indicates that a user selects a certain button within a user interface, given a particular set of circumstances, said button may be modified (e.g. made larger, moved to a more accessible location, made visually distinct, etc.) to facilitate its use when that set of circumstances arises. In another embodiment, certain user interface elements may be relocated to a secondary display, based upon the amount they are used. In some embodiments, the degree that a user interface element is modified may depend upon the confidence value for the behavior pattern.

In various embodiments, the user experience may be modified by launching applications based upon observed user behavior patterns. For example, in one embodiment, based upon previously observed user behavior, a particular application (e.g. a time tracker, a note application, etc.) may be automatically launched after the user completes a particular activity (e.g. speaks to a client on the phone, etc.).

In various embodiments, the user experience may be modified by altering system or application settings based upon observed user behavior patterns. For example, in one embodiment, a device or integration may develop a default volume level, based upon location, by observing when and where the user manually changes the volume. In some embodiments, one or more aspects, including system or application settings, defined within an integration profile may be modified based upon observed user behavior patterns.

In various embodiments, the user experience may be modified by defining auto responses and/or smart replies based upon observed user behavior patterns. For example, in one embodiment, a user may be prompted with a list of most likely responses they may send in reply to an incoming call. As an option, these predicted responses may be contextually dynamic, changing depending upon the current circumstances, as previously discussed.

FIG. 48-37 shows a method 48-37-00 for facilitating the use of content, in accordance with one embodiment. As an option, the method 48-37-00 may be implemented in the context of the architecture and environment of the previous Figures or any subsequent Figure(s). Of course, however, the method 48-37-00 may be implemented in any desired environment. It should also be noted that the aforementioned definitions may apply during the present description.

In various embodiments, method 48-37-00 may be utilized to automate various aspects of the user experience, facilitating the use of content in various contexts. This method is based upon observations made throughout the lifespan of a piece of content, as opposed to method 48-36-00 of FIG. 48-36, which is based upon user behavior. Like method 48-36-00, this method may be implemented within an integration, as well as on a single device, in accordance with one embodiment.

As shown, it is determined whether there is any unanalyzed content available. See determination 48-37-02. Examples of content may include, but are not limited to, photos, video, text, documents, applications, scripts, and/or any other discrete piece of content. In some embodiments, this method may be applied to content which is stored on a device or a pair of integrated devices. In other embodiments, this method may be applied to content stored on an external server, such as a cloud server. Examples of unanalyzed content may include, but are not limited to, content that the user recently created, content created by someone else which has been shared with the user, and/or any other content which has not been analyzed.

In some embodiments, whether or not a piece of content has been analyzed may be determined using data attached to the content, such as metadata. In one embodiment, a flag may be placed in the metadata of a piece of content indicating that it has been analyzed for a particular user on a particular device. In another embodiment, all of the data associated with the analysis may be embedded within the content as metadata. In other embodiments, all data associated with the analysis may be stored apart from the content. In such embodiments, whether or not a piece of content has been analyzed may be determined by comparing the identity of the content with the analysis data which has been stored.

If it is determined that one or more pieces of unanalyzed content are available, the system waits to proceed with further analysis. See operation 48-37-04. In some cases, the unanalyzed content may be introduced to a device or integration in bursts (e.g. taking photos at an event, receiving multiple documents in an email message, etc.). In such a case, it may be advantageous to suspend analysis until all related content has been obtained. In various embodiments, the analysis of the content may be delayed. In one embodiment, the length of the delay may be fixed, and applied to all unanalyzed content. In another embodiment, the length of the delay may depend upon the context in which the unanalyzed content first appeared on the device or integration. Possible contextual details which may be used to determine the length of the delay may include, but not limited to, calendar data (e.g. further analysis may be delayed until the scheduled end of an event where pictures are being taken, etc.), time of day (e.g. if a user typically receives a lot of email attachments during a particular window of time, etc.), and/or any other context. In yet another embodiment, the length of the delay may depend on the type of content (e.g. picture, video, document, etc.). In still another embodiment, the length of the delay may depend upon the source of the content (e.g. received from another individual, created by the user, etc.). Of course, in one embodiment, there is no delay, and the analysis of said content may begin as soon as possible.

As shown, a cluster analysis is performed on the unanalyzed content. See operation 48-37-06. In the context of the present description, cluster analysis refers to a method, formula, algorithm, or procedure for grouping a set of objects in such a way that similar objects are closer in state space than dissimilar objects. In this way, patterns may be recognized, and later exploited. In other words, cluster analysis may be considered a form of automatic classification.

In various embodiments, the results of such an analysis may be stored. In one embodiment, the results may be stored as a database. In some embodiments, the results may be stored on a device, or on one or both integrated devices. In other embodiments, the results may be stored on an external server, such as a cloud server. In one embodiment, analysis results may be stored for content which has since been deleted. As an option, analysis results for deleted content may be given less weight, thus allowing content-use patterns to evolve over time.

In some embodiments, the analysis performed on the unanalyzed content may be done using cluster analysis methods. In other embodiments, the automatic grouping and/or classification of content may be done using other methods. These methods may include, but are not limited to, pattern recognition, data mining, sequence mining, artificial intelligence, machine learning, evolutionary algorithms, and/or any other method, procedure, or technique which may be used to group similar objects.

In various embodiments, the cluster analysis performed on the unanalyzed content may be done on the basis of information associated with the content. For example, in one embodiment, the cluster analysis may be based, at least in part, upon the event history of a piece of content. In the context of the present description, a content event history refers to a chronological record of all operations performed on a piece of content, beginning with the creation of the content, and ending with the deletion of the content. Examples may include the resizing of a picture, or the transmission of a document in an email message. In this embodiment, content may be clustered according to what events are found in the history of each particular piece of content.

In various embodiments, the cluster analysis may be based on the substance of the content. For example, in one embodiment, the analysis may take into account the identity of people and places depicted in a photo or movie (e.g. facial recognition, voice recognition, landmark recognition, the parsing of text, etc.). Furthermore, in various embodiments, the cluster analysis may be based upon other gathered data, including, but not limited to, metadata (e.g. content creator, EXIF information, etc.), identity of the creation device, date and time of creation, size (e.g. file size, image resolution, etc.), any/or any other data which may be gathered and used to gather or classify the content. In some embodiments, this gathered data is then attached to the piece of content, facilitating the transfer of the content and associated data during an integration, or between two devices associated with a single user.

In some embodiments, the cluster analysis may be performed using device-specific data (i.e. content history from other devices is ignored). In other embodiments, all data associated with a single user may be considered during content analysis. For example, in one embodiment, as part of integration, if a piece of content exists on both devices, the content event history and associated data for said content may be merged for analysis. In some embodiments, the analysis is device-agnostic. In other embodiments, the analysis may take into account on which device a content event occurred.

If it is determined that there is not any unanalyzed content available, it is determined if any new content events have occurred. See determination 48-37-08. Examples of content events include, but are not limited to, the sharing of content (e.g. transmission through email, uploading to a server, etc.), duplication, deletion, modification (e.g. resizing an image, re-encoding a video, find and replace within a text document, etc.), compression or other form of archiving, and/or any other operation which may be performed on content.

In some embodiments, a content event which involves sharing content with another individual may automatically trigger the removal of all metadata associated with the cluster analysis from the copy being transmitted. This may be done to protect the privacy of a user.

If it is determined that one or more new content events have occurred, the clustering is updated. See operation 48-37-10. In various embodiments, the methods employed in operation 48-37-06 may also be employed here, to determine if a new cluster has formed, if previous clusters are now better defined, or if the recorded analysis needs to be updated in any way.

As shown, it is determined whether there are new cluster-based content actions available. See determination 48-37-12. In the context of the present description, a cluster-based content action refers to an action which may be taken on, or with, a piece of content, said action being recommended by the fact that some or all other members of an associated cluster have said action in their content event history. As a specific example, if there was a cluster of photos, all of which contain the recognized faces of the user's children, and all of which were subsequently resized and sent to relatives in an email message, the detection of a resize operation of a new photo featuring a user's child may have an available cluster-based content action, specifically, sending the photo to relatives via email.

In some embodiments, the determination of whether there are new cluster-based content actions available may depend upon a confidence value for the clustering results. For example, returning to the previous example, if there were photos of the user's children which had not been resized, they may not be able to be placed in that cluster with sufficient confidence to create a resize and email cluster-based content actions. In some embodiments, the user may explicitly set the threshold confidence level. In other embodiments, the threshold confidence level may be predefined, and static. In still other embodiments, the threshold confidence level may be defined by the user indirectly, by accepting or rejecting the proposed performance of cluster-based content actions which are near the presently defined threshold confidence value.

If it is determined that there are new cluster-based content actions available, it is then determined whether the user should be prompted. See determination 48-37-14. In various embodiments, whether or not a user is prompted regarding the availability of cluster-based content actions may depend on one or more factors. For example, in one embodiment, a user may be prompted regarding the performance of the content action only if the confidence value for the associated clustering is greater than the threshold, but not high enough to warrant automatic performance.

In another embodiment, the user may be always prompted for certain types of content actions. The types of content actions which may always require a user confirmation, independent of the associated confidence value, may include, but are not limited to, communication actions (e.g. sending an email, sending an SMS message, posting on a social network, etc.), irreversible actions (e.g. performing an irreversible modification on the only copy of a file, etc.), and/or any other type of action which would be overly detrimental should it malfunction. However, in one embodiment, the user may specify exceptions to this blanket requirement for user confirmation.

If it is determined that the user need not be prompted, the cluster-based content actions are performed. See operation 48-37-16. In various embodiments, the performance of said action or actions may result in the related content fitting in better with other content within a cluster. In some embodiments, the performance of a cluster-based content action may result in a subsequent determination that a new event has occurred (e.g. see determination 48-37-08).

In some embodiments, the performance of a cluster-based content action without prompting the user may be carried out without any indication that the action is being performed. In other embodiments, the user may still be notified of the performance of said action, though in an unobtrusive manner. As an option, the user may given a brief window of time in which they may intervene.

In various embodiments, one possible cluster-based content action may be to place the related content on one or more contextual content lists. In the context of the present description, a contextual content list refers to a list of content which is presented to the user in a particular context. Examples of contexts with which these lists may be associated include, but are not limited to, location-based (e.g. at the office, at home, at the store, etc.), action-based (e.g. participating in a video conference with a particular group of people, etc.), schedule-based (e.g. at the end of a scheduled meeting, etc.), and/or any other context.

The purpose of the contextual content lists is to make appropriate content readily available to the user in their current context. For example, in one embodiment, a location-based list associated with a user's office may be populated with documents recently opened while in the office. In another example, an action-based list associated with a video conference may be populated with content which is associated with (e.g. received from, created by, sent to, etc.) one or more participants.

In some embodiments, a contextual content list may be available to a user through a status bar icon, or some other user interface element which is always, or almost always, accessible to the user. In another embodiment, the contextual content list may be displayed to the user inside a file dialog box, or other prompt where a user must select one or more pieces of content. In still another embodiment, the contextual content list may be accessed through performing a multitouch gesture, or a key combination.

Other examples of cluster-based content actions which may be performed include, but are not limited to, sharing content, archiving content, backing up content to an external server, duplicating content, renaming content, modifying content (e.g. resizing an image, adding a signature, etc.).

If it is determined that the user should be prompted, the cluster-based content actions are performed upon user approval. See operation 48-37-18. In some embodiments, the performance of a cluster-based content action may result in a subsequent determination that a new event has occurred (e.g. see determination 48-37-08).

In some embodiments, the user may be prompted regarding the performance of a cluster-based content action as soon as it is identified as being available. In other embodiments, the user may be prompted in a context which matches the context where said action was performed on other members of the associated cluster. Returning to the previous example involving photos of the user's children, if previous photos were not resized and emailed to relatives until the user was at home (e.g. had returned from whatever event the children were involved in, etc.), the user may not be prompted regarding the performance of those content actions until they are at home.

In some embodiments, the prompt displayed to the user may give them the option to perform similar actions in the future without asking for confirmation. As an option, the user may manage such exceptions through a user interface, in accordance with one embodiment.

As an option, the aforementioned mobile device may be capable of operating in a location-specific mode, in the context of any of the embodiments disclosed hereinabove. Specifically, in one embodiment, a location associated with the mobile device may be determined. Further determined may be a presence of at least one other person at the location. Still yet, a graphical user interface may be automatically displayed. Such graphical user interface may be specifically associated with the determined location and the determined presence of the at least one other person. In another embodiment, the system, method, or computer program product may be capable of determining a location associated with the mobile device and automatically determining that the location is proximate to a previously identified item of interest. To this end, a graphical user interface associated with the determined location and the previously identified item of interest may be displayed. More information regarding such location-specific features that may or may not be incorporated into any of the embodiments disclosed herein, may be found in U.S. patent application Ser. No. 13/652,458, filed Oct. 15, 2012, titled “MOBILE DEVICE SYSTEM, METHOD, AND COMPUTER PROGRAM PRODUCT,” which is incorporated herein by reference in its entirety.

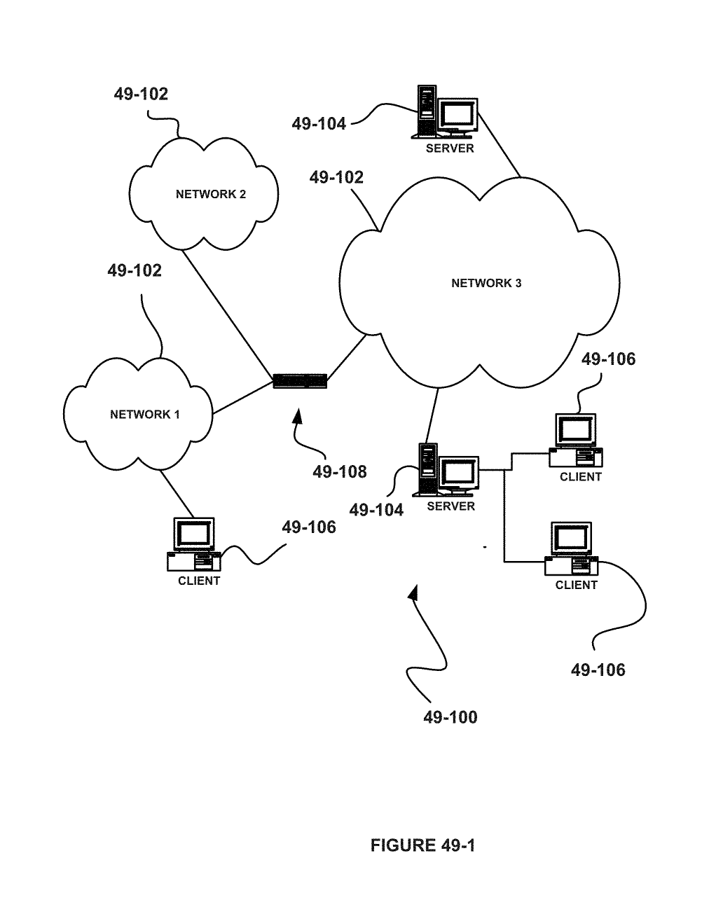

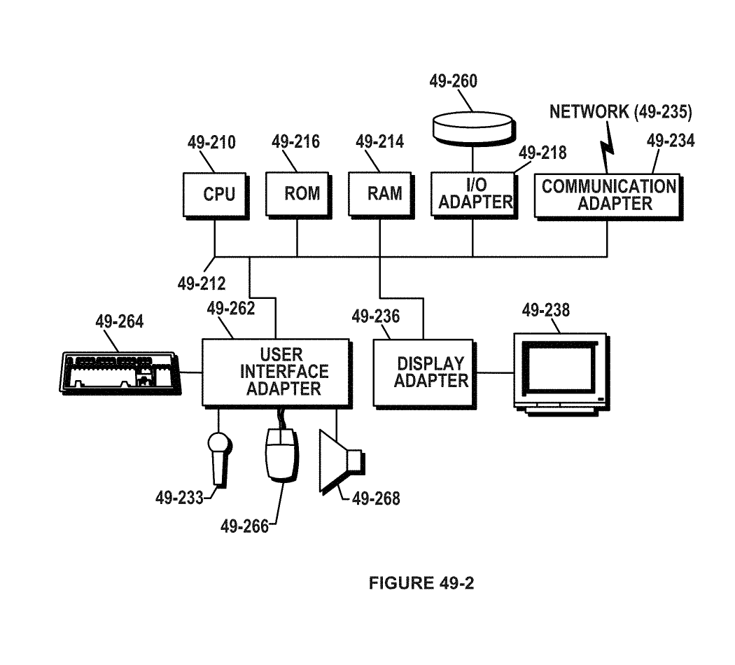

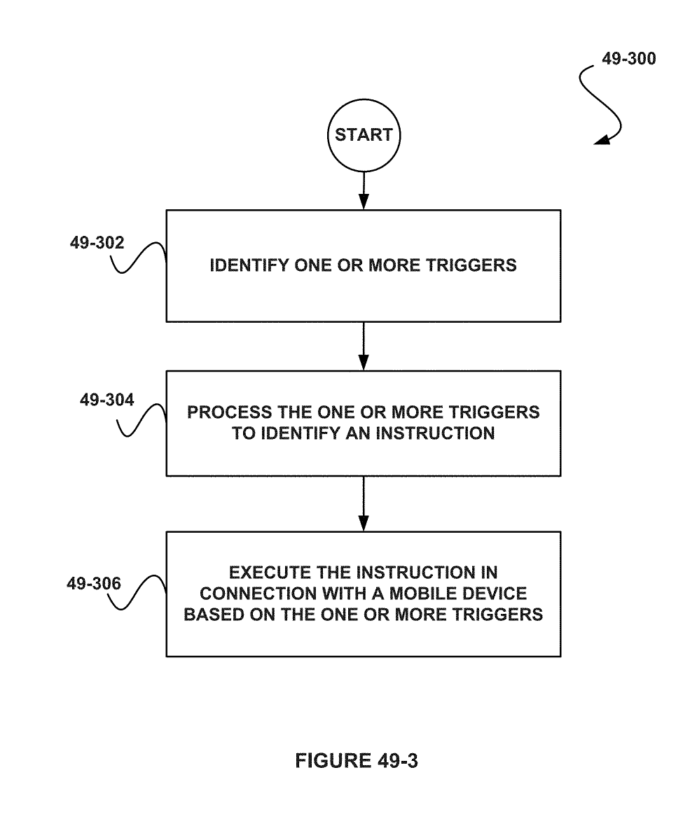

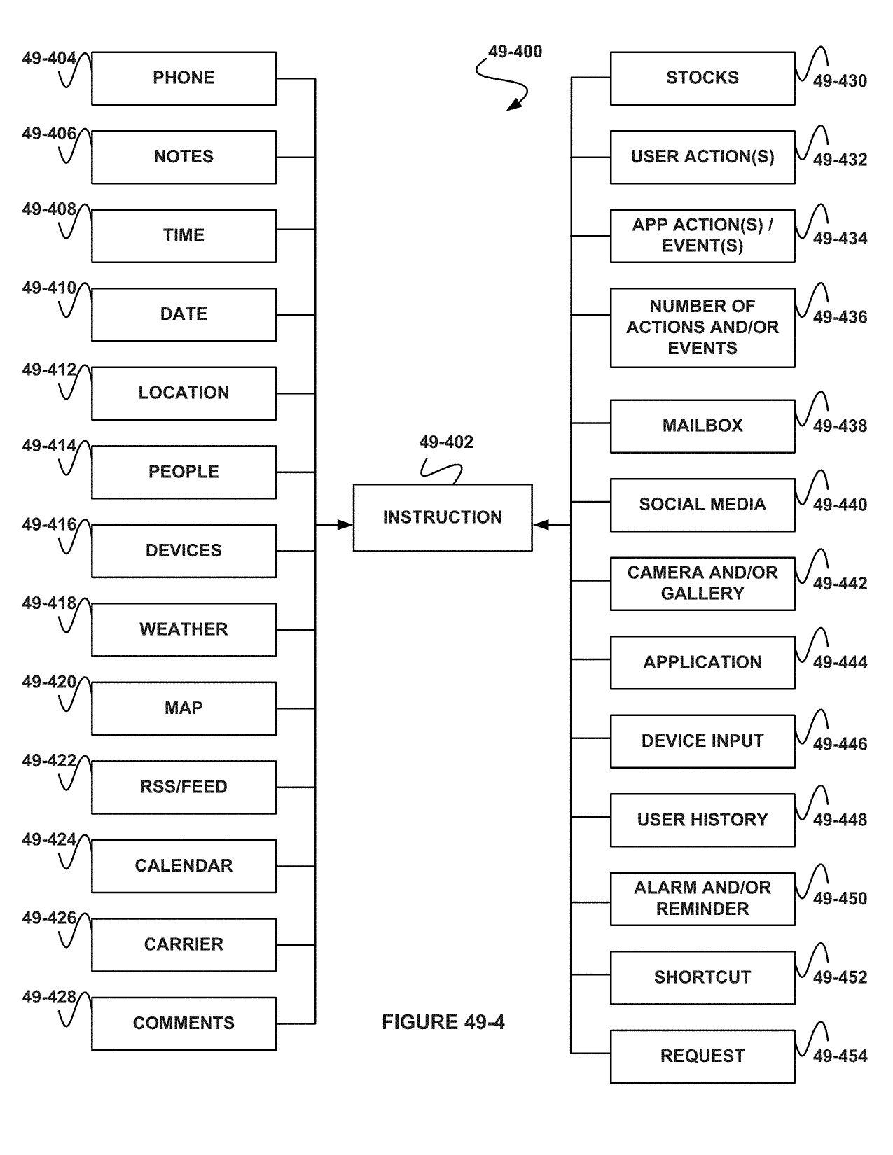

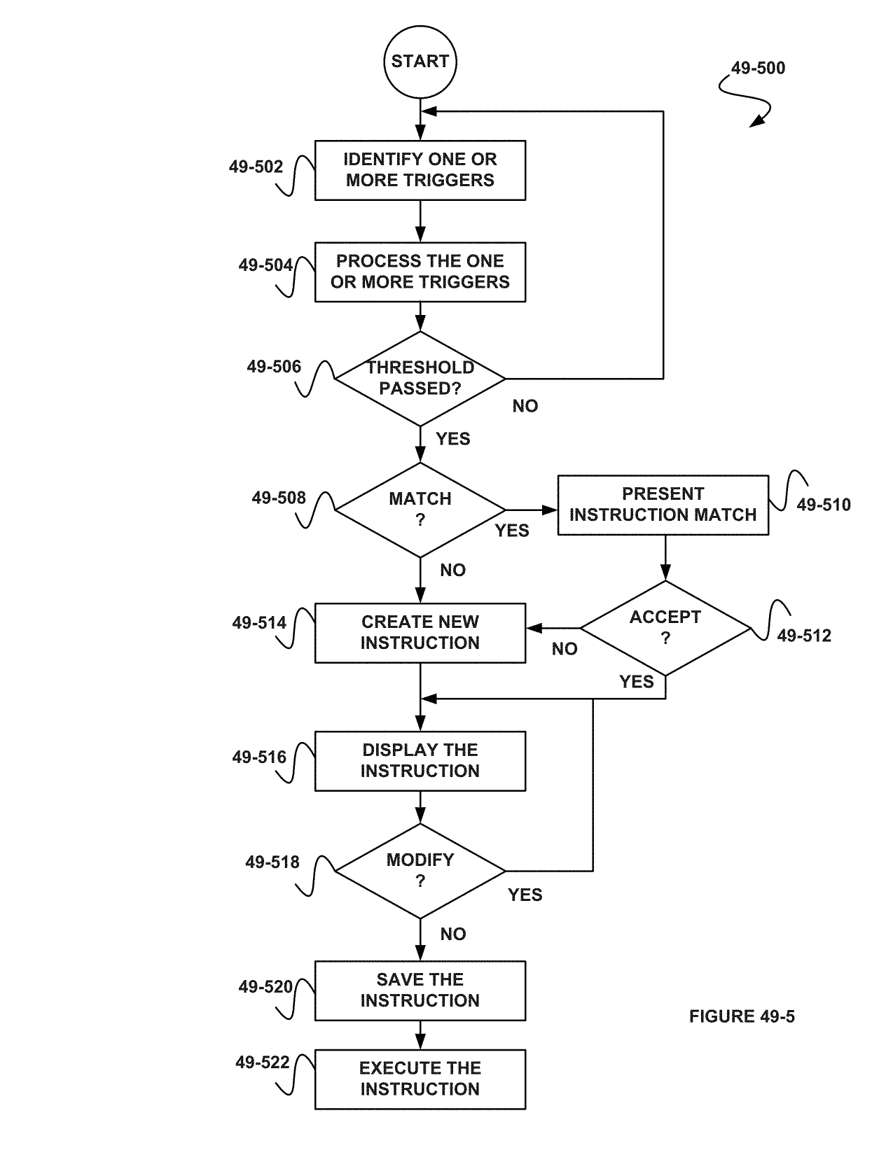

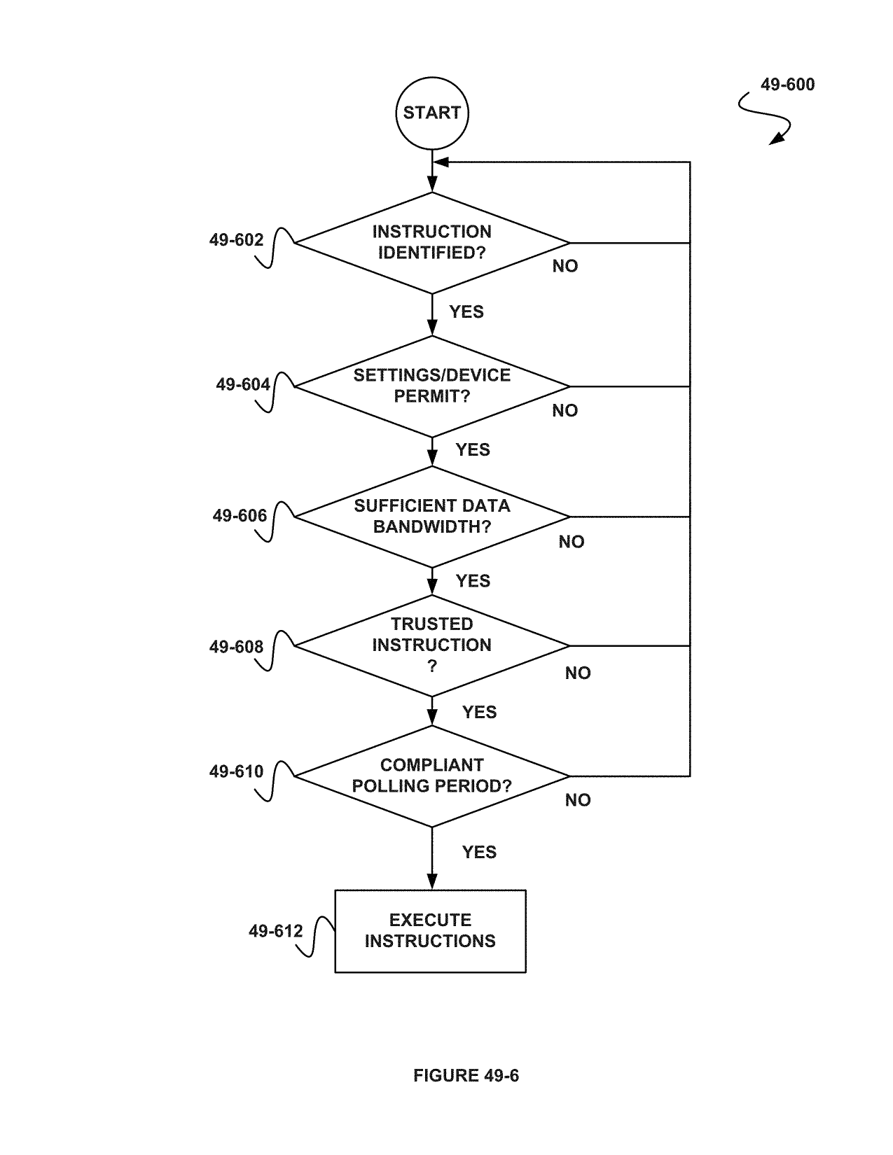

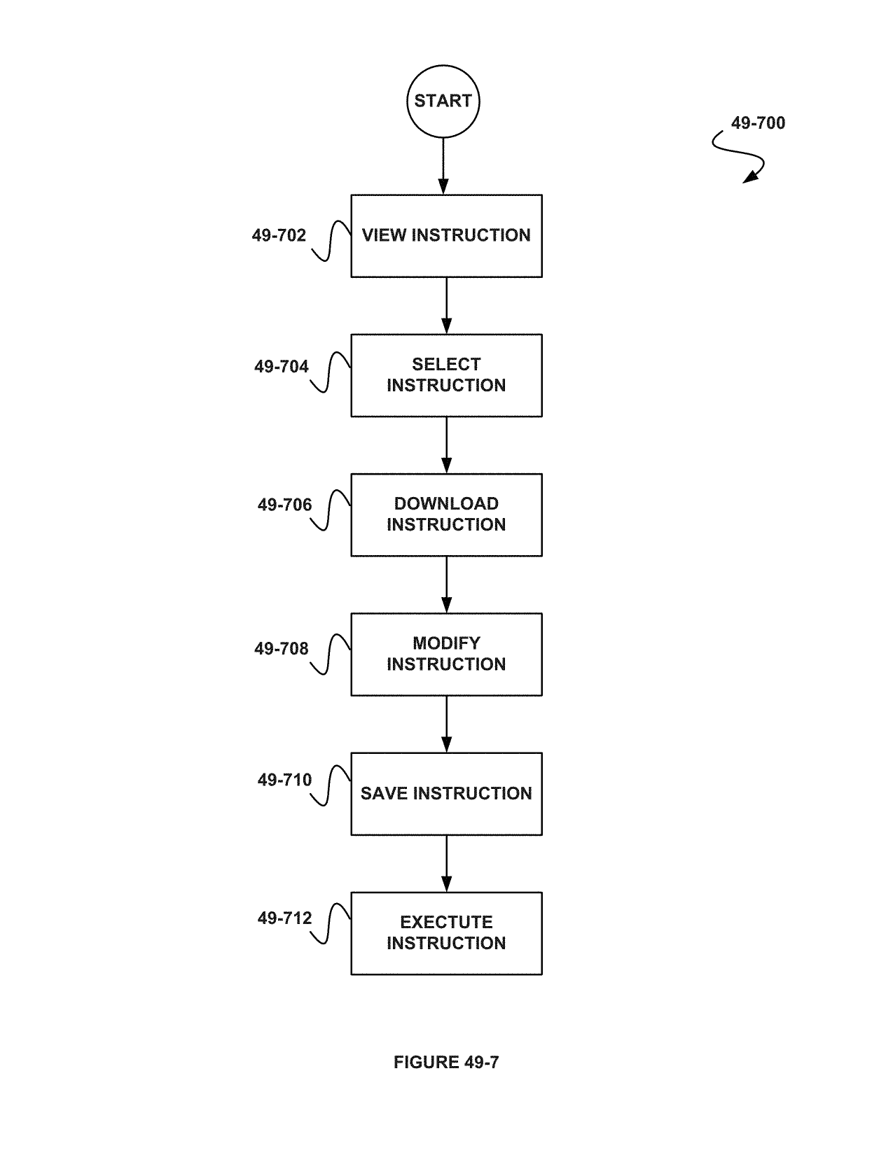

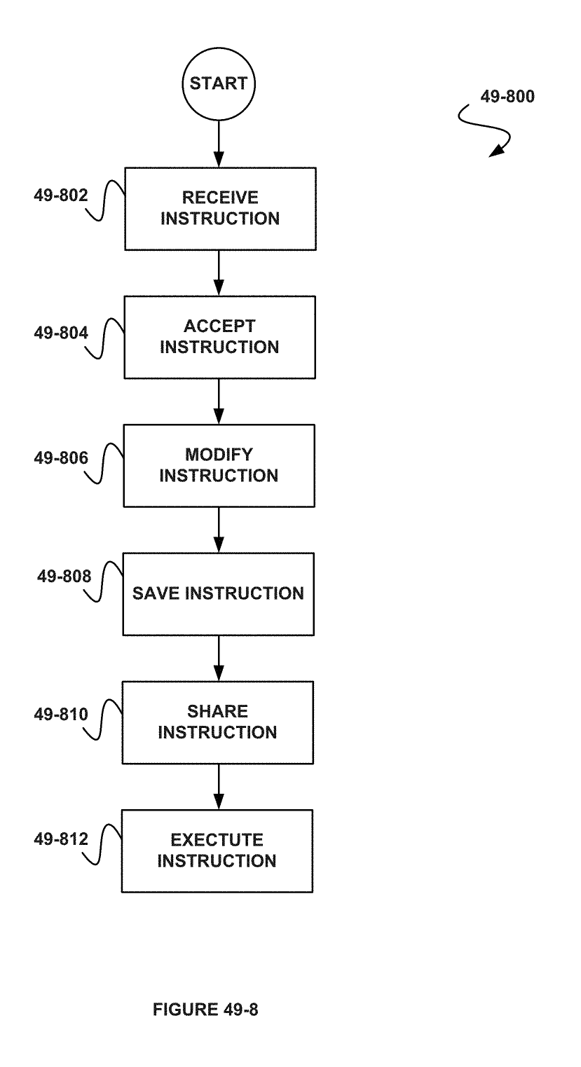

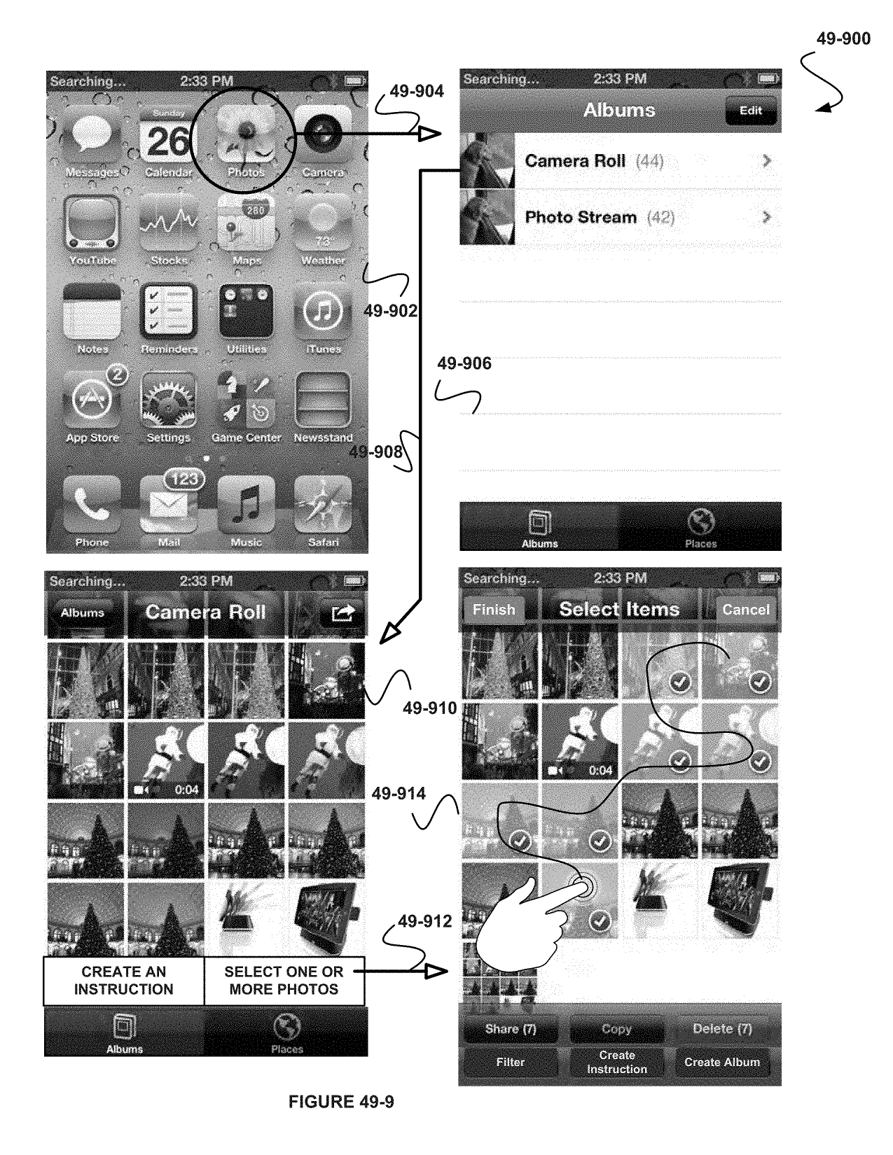

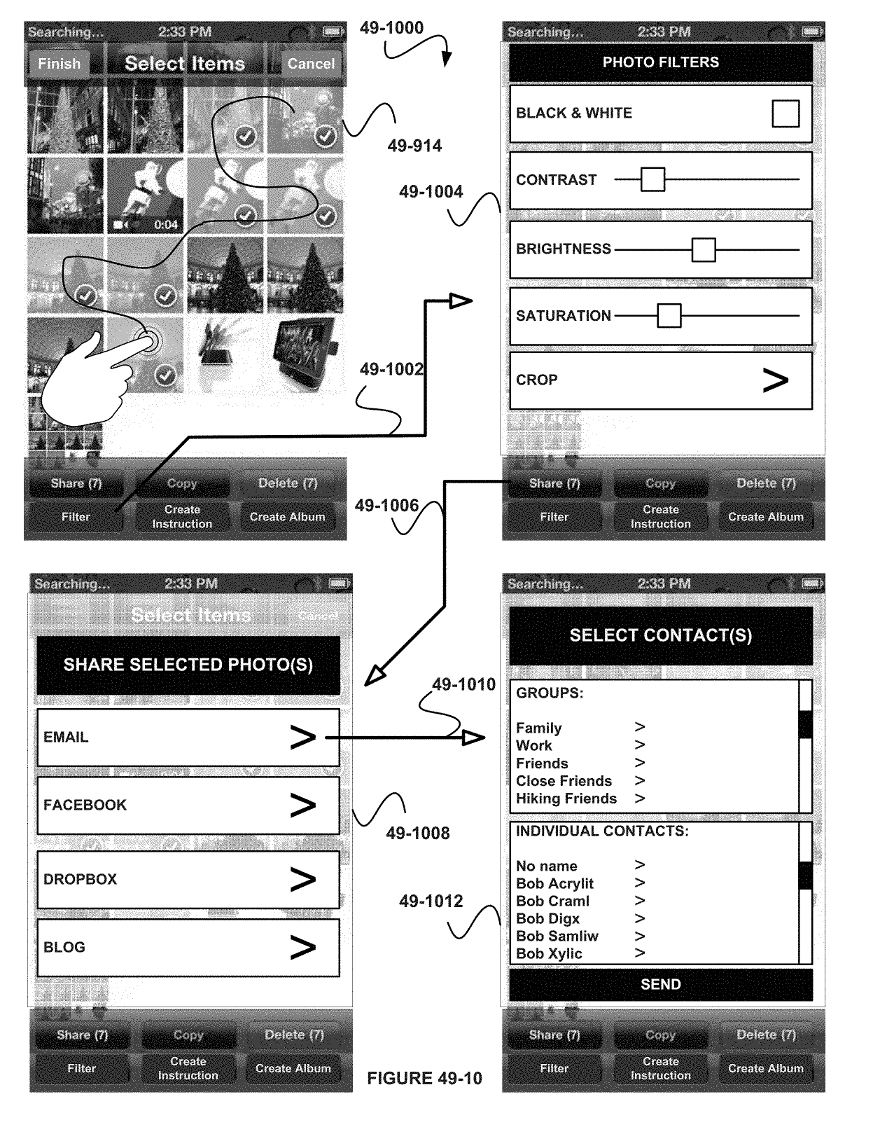

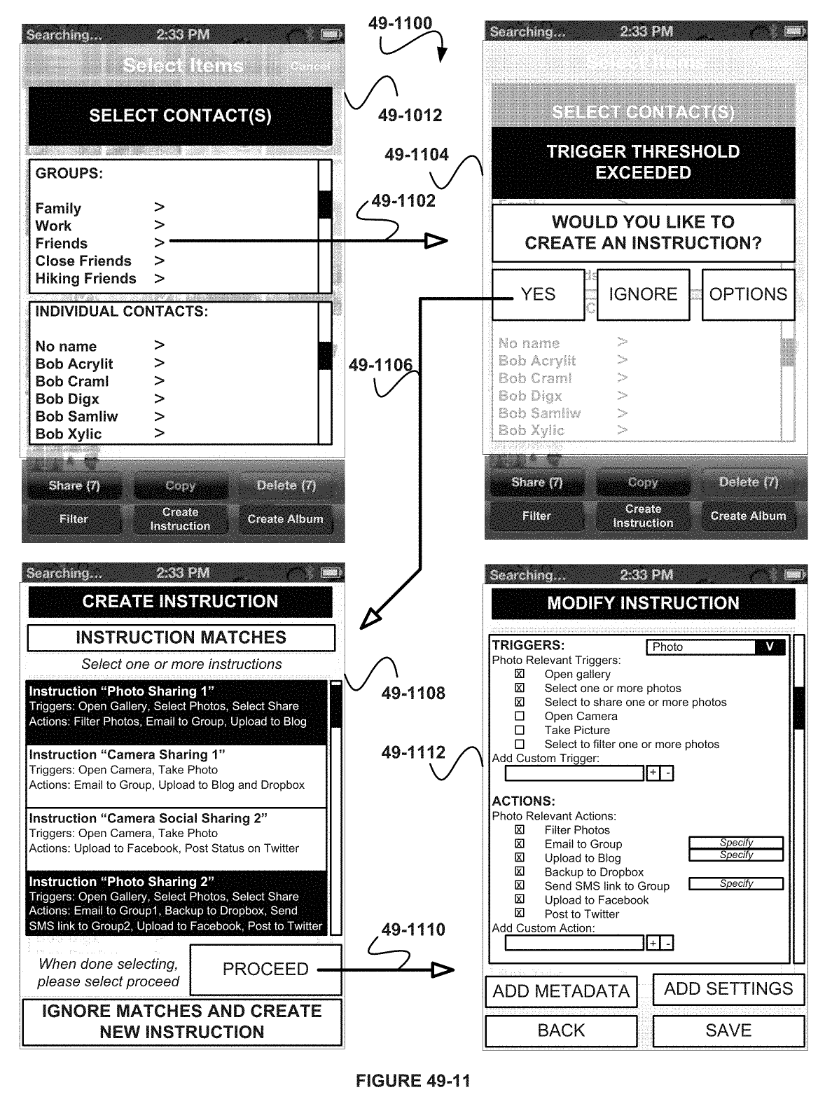

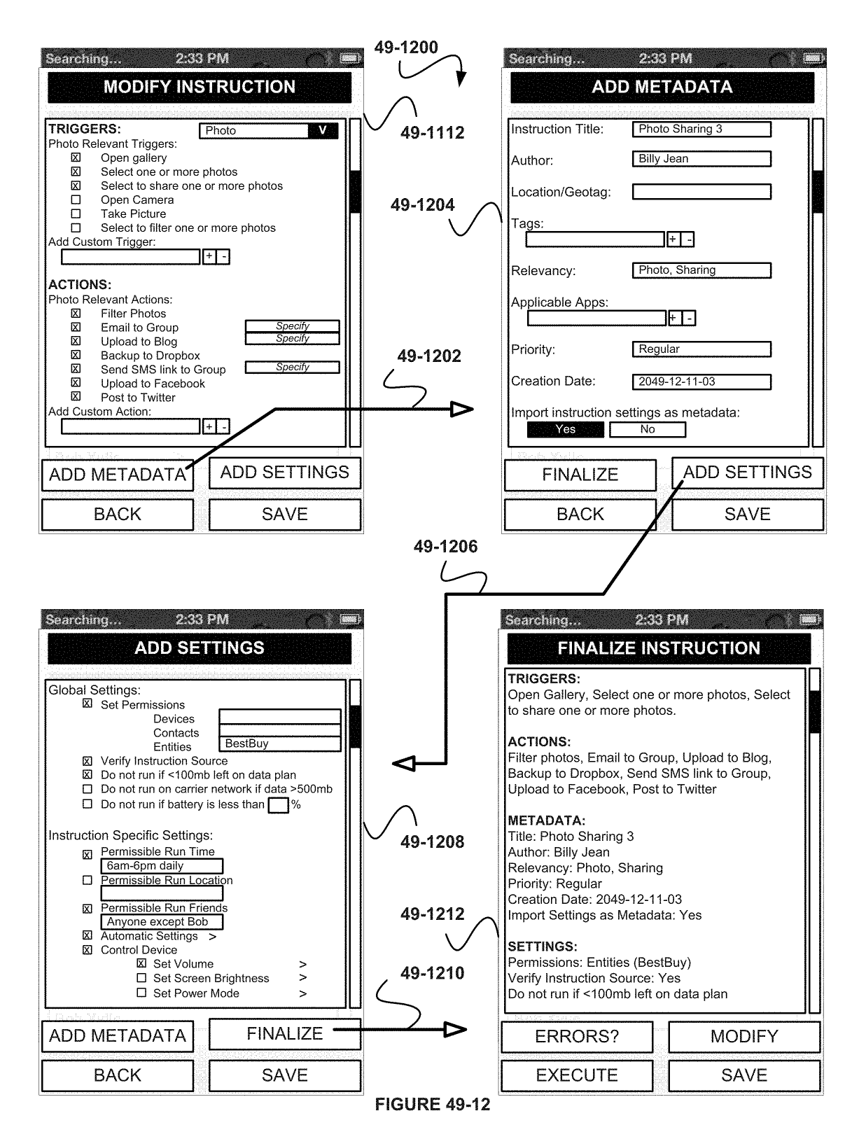

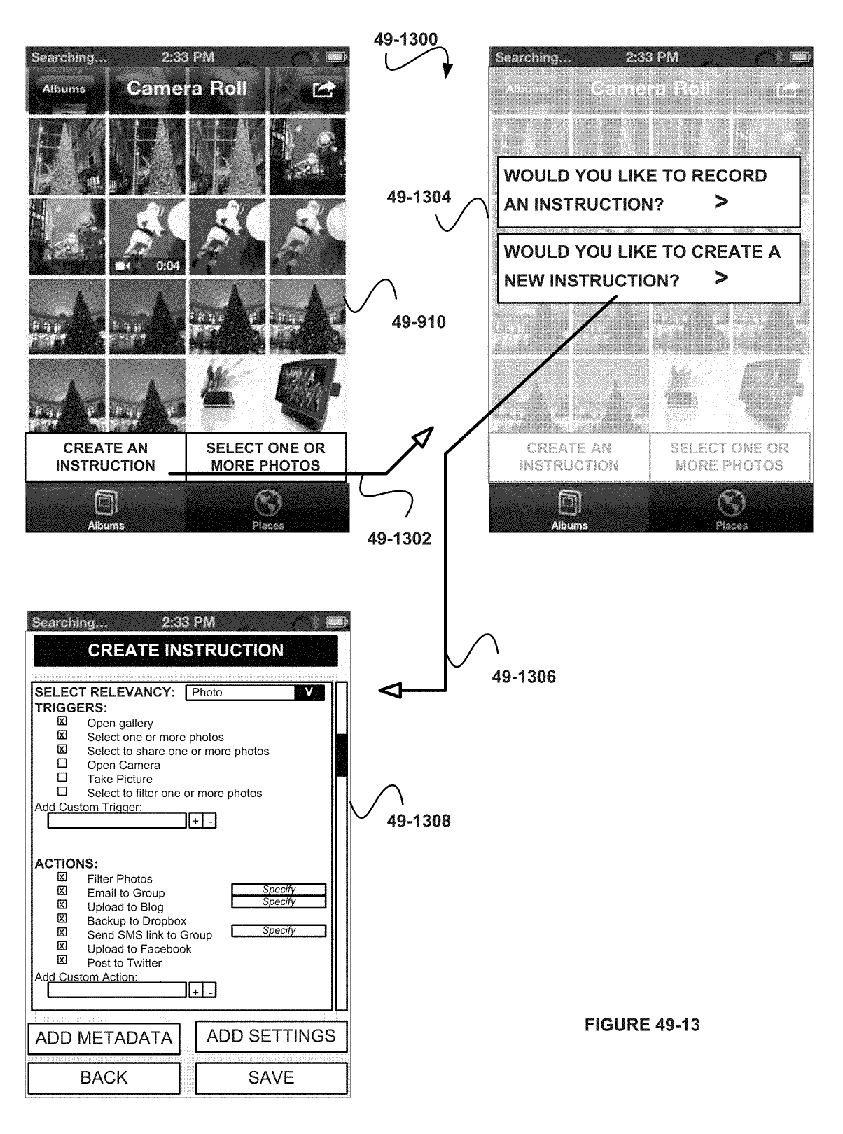

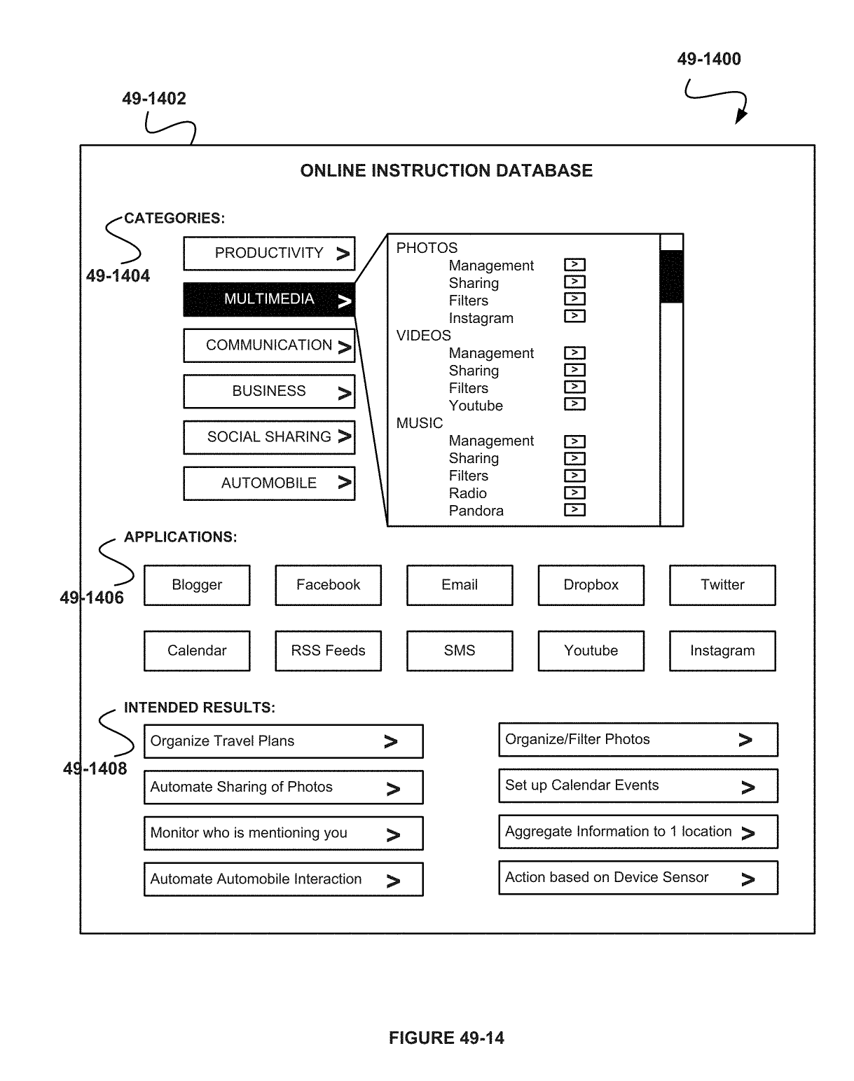

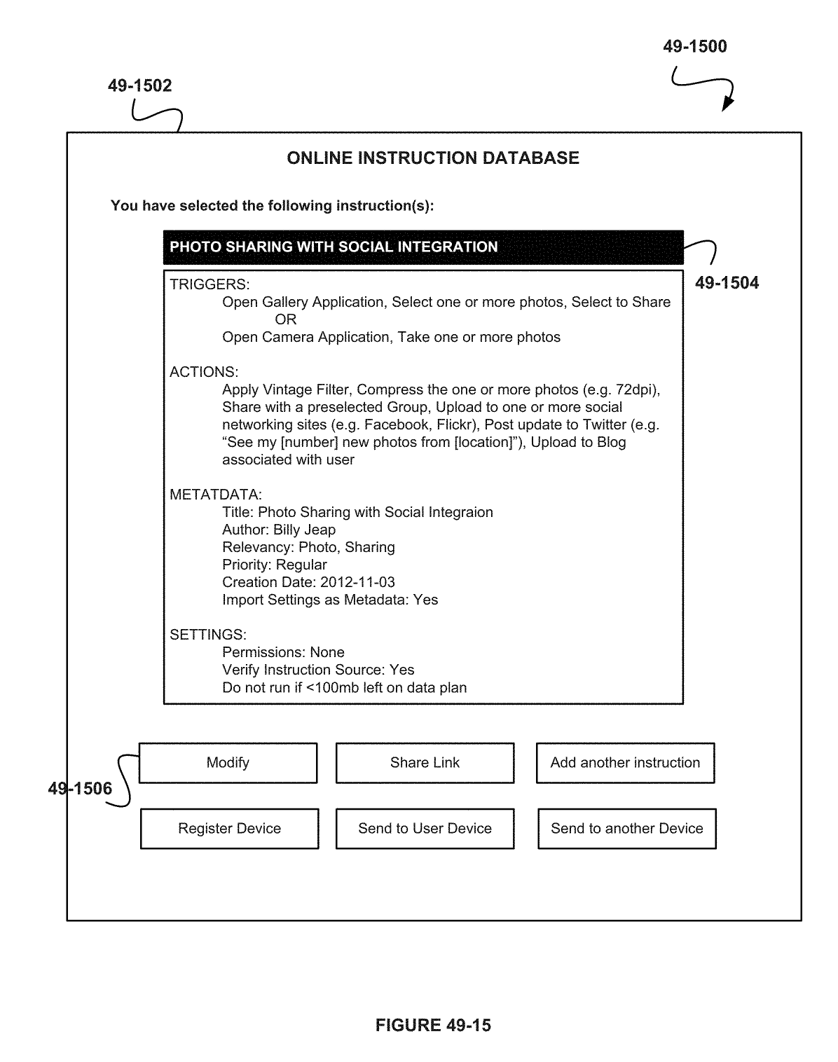

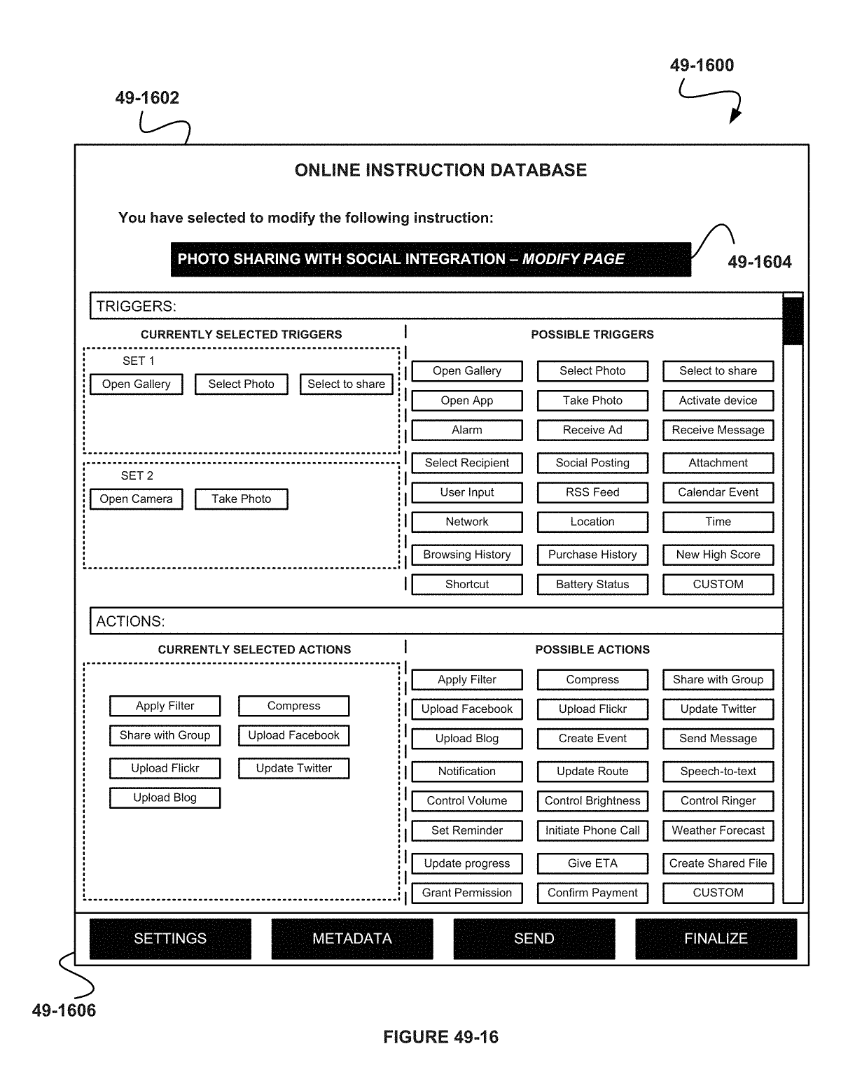

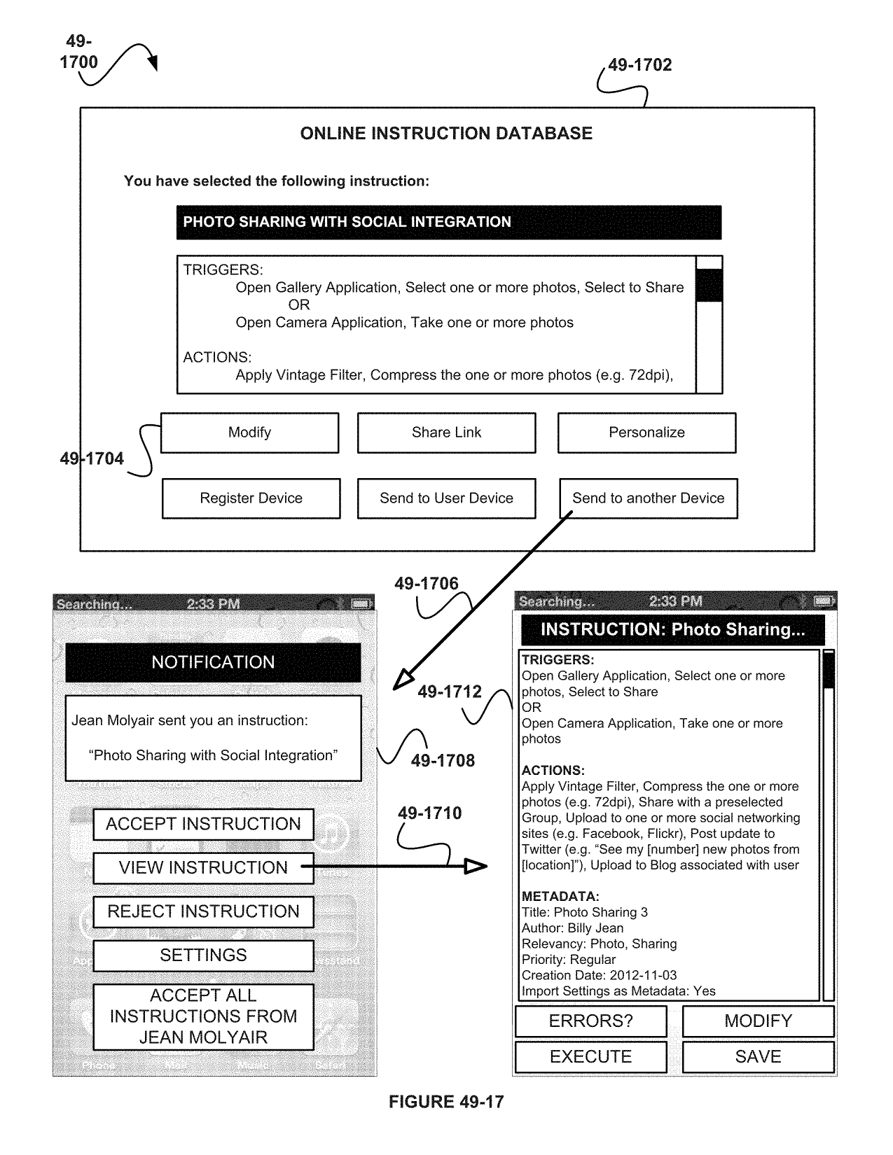

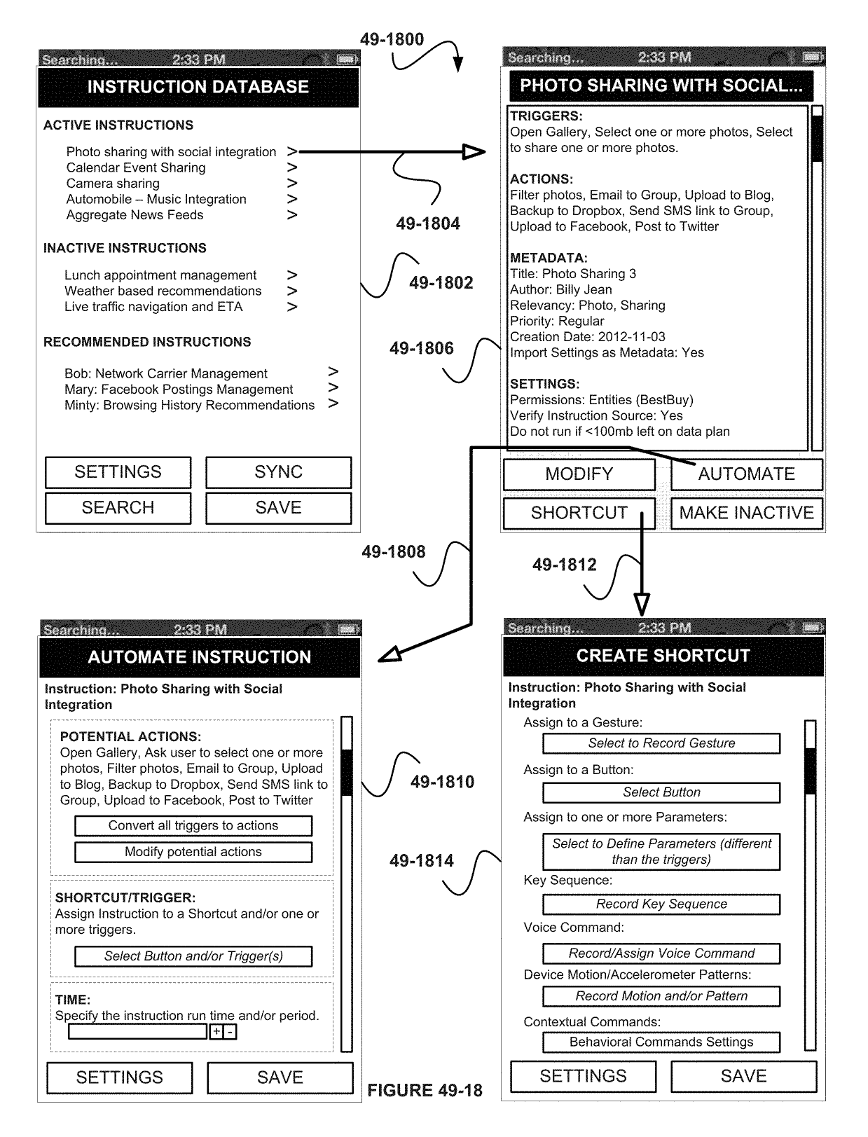

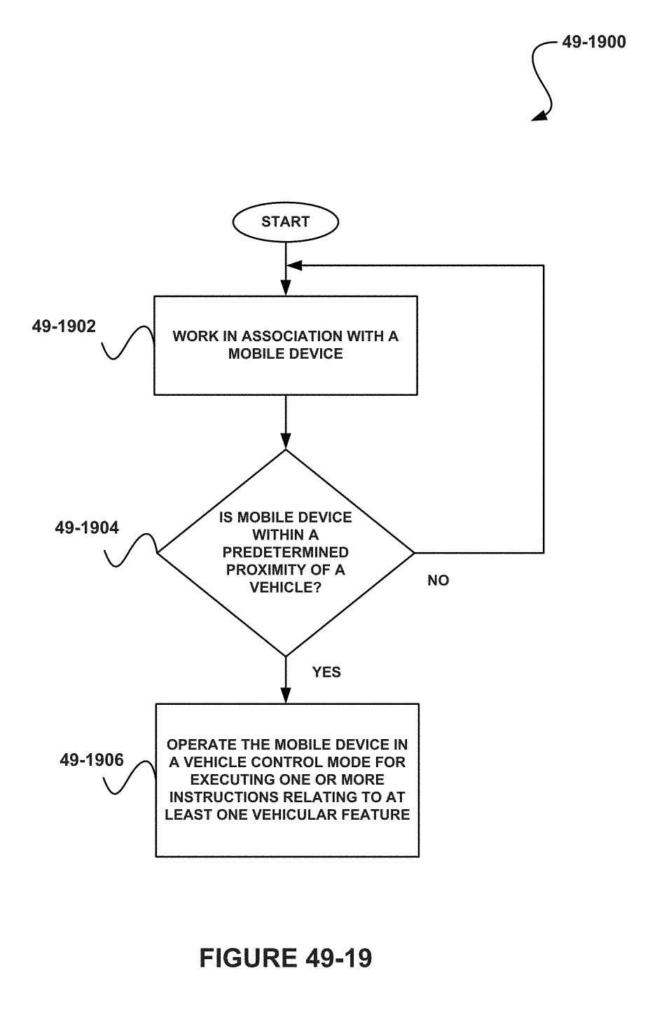

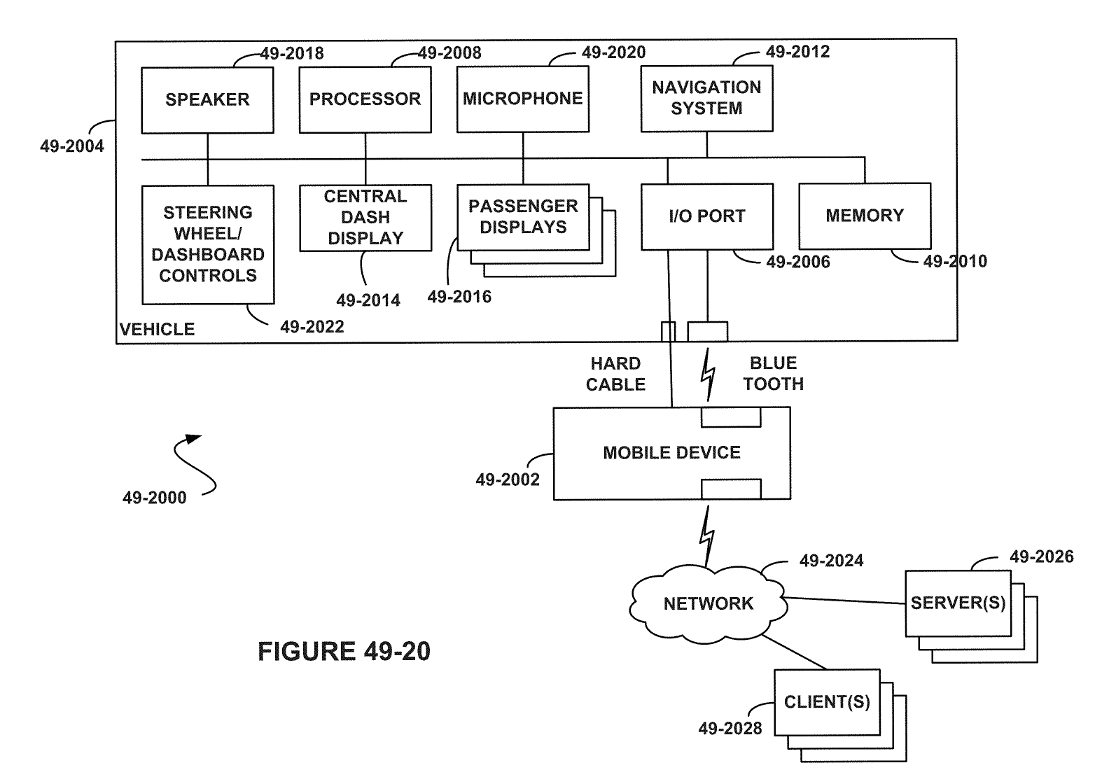

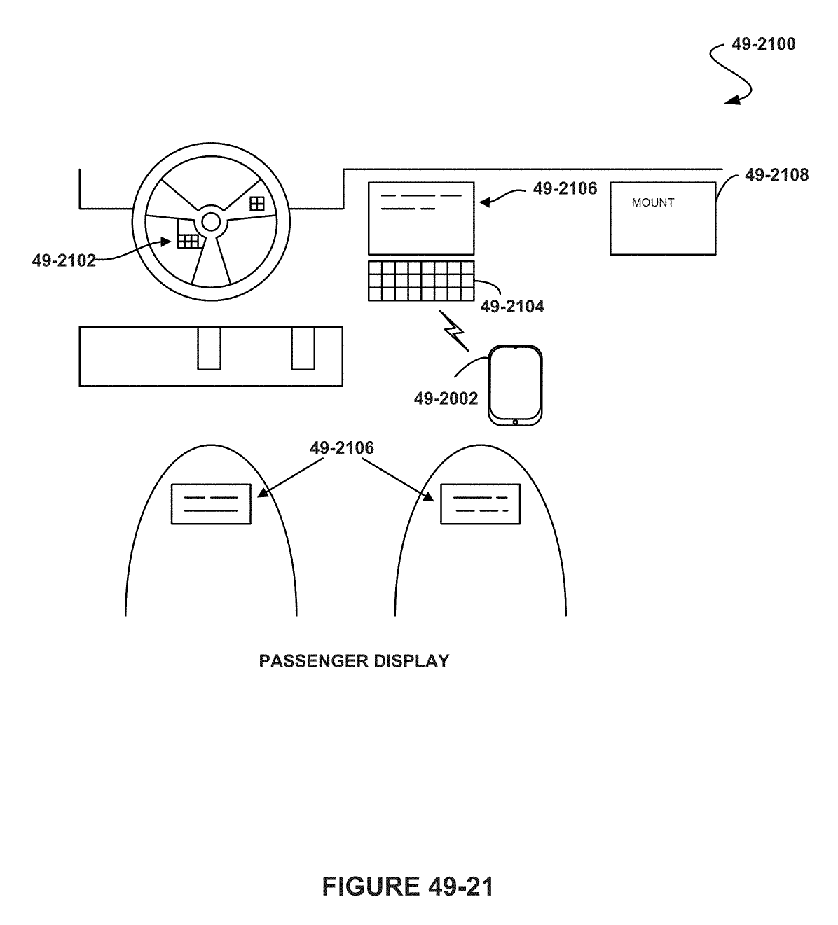

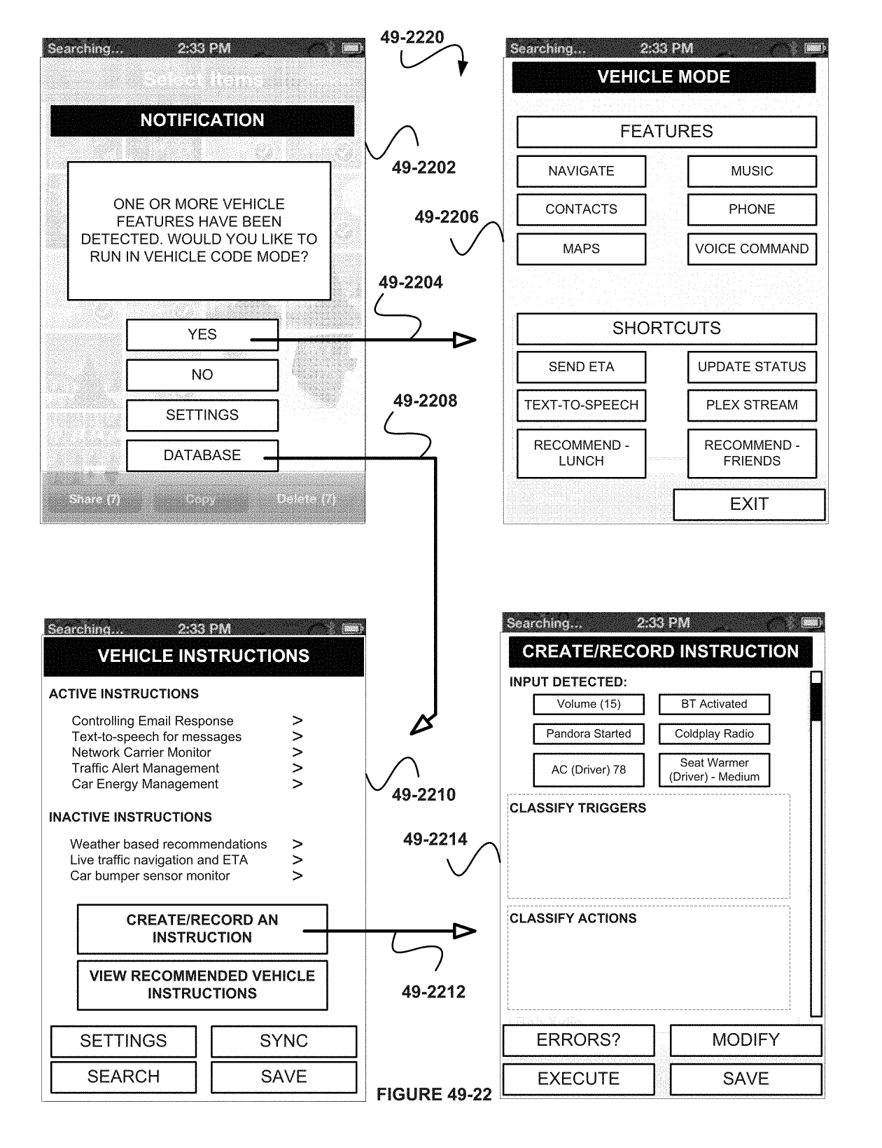

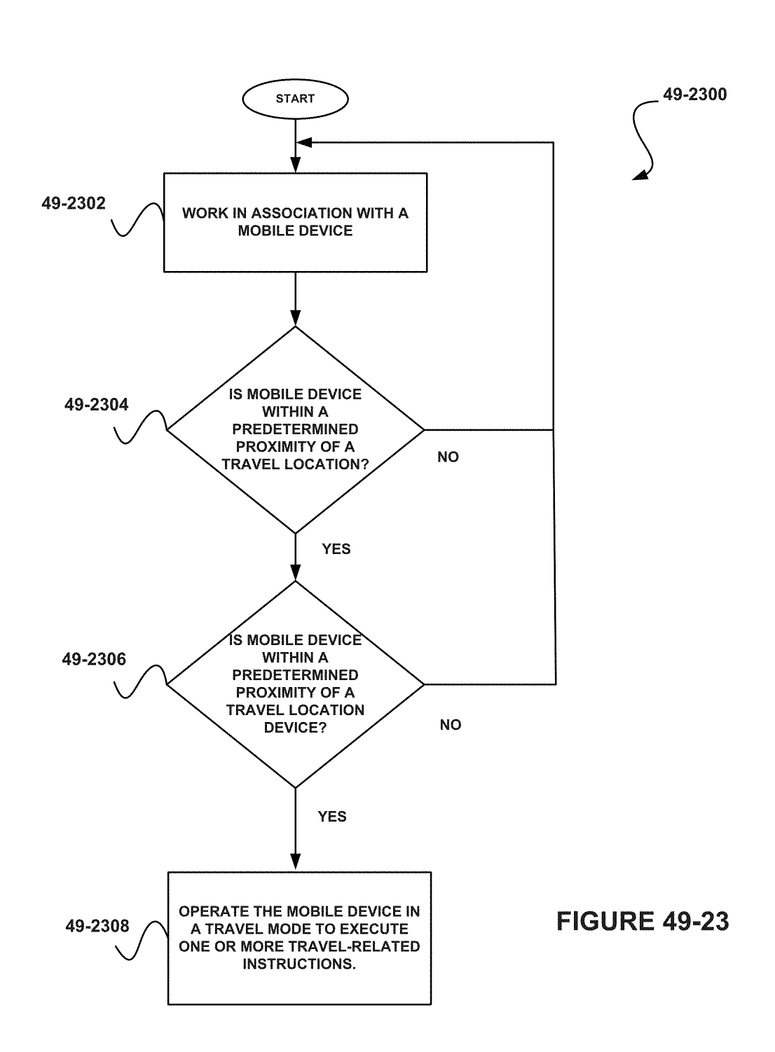

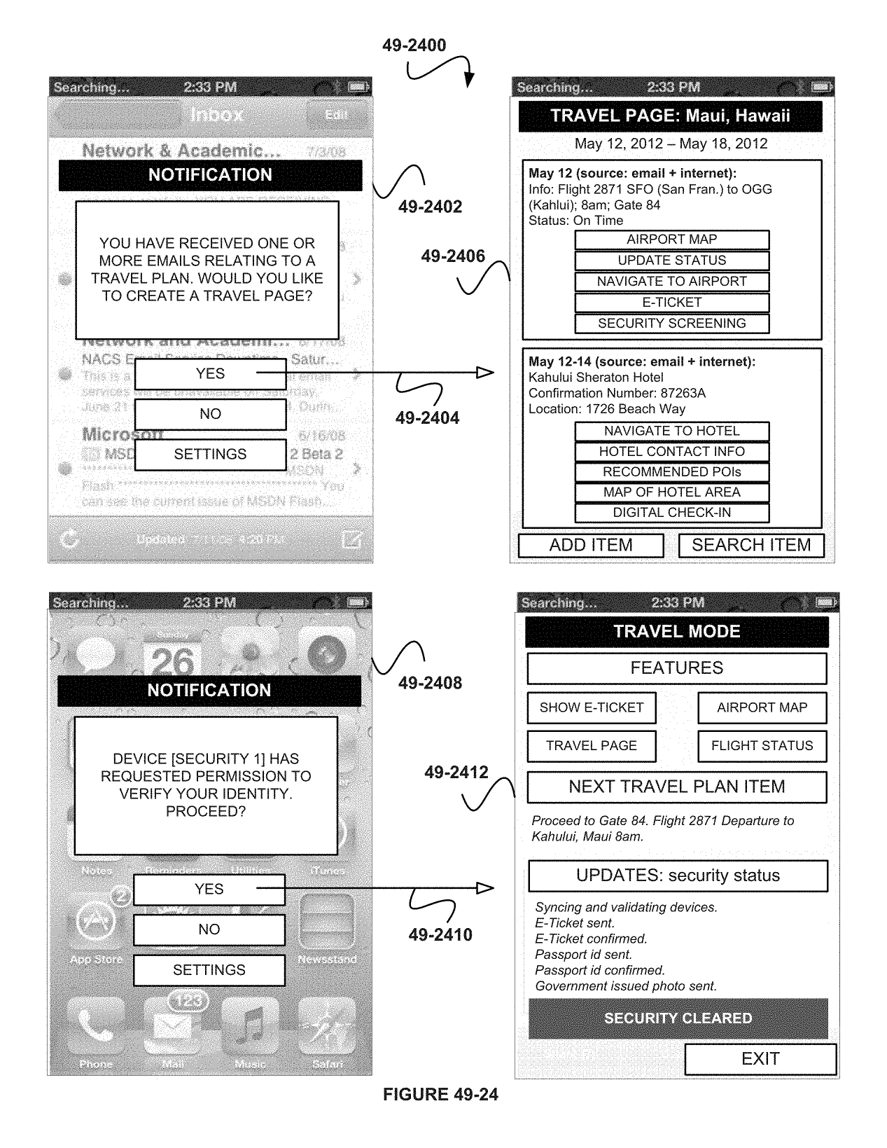

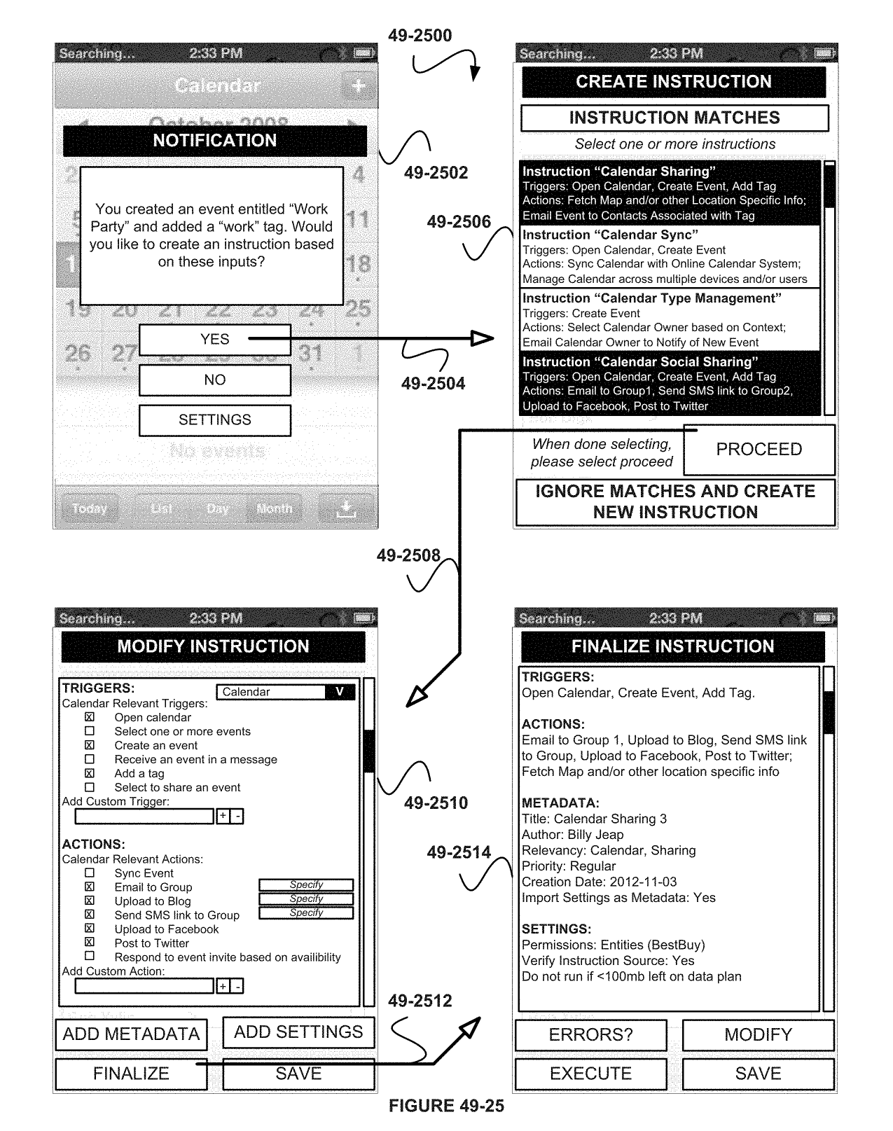

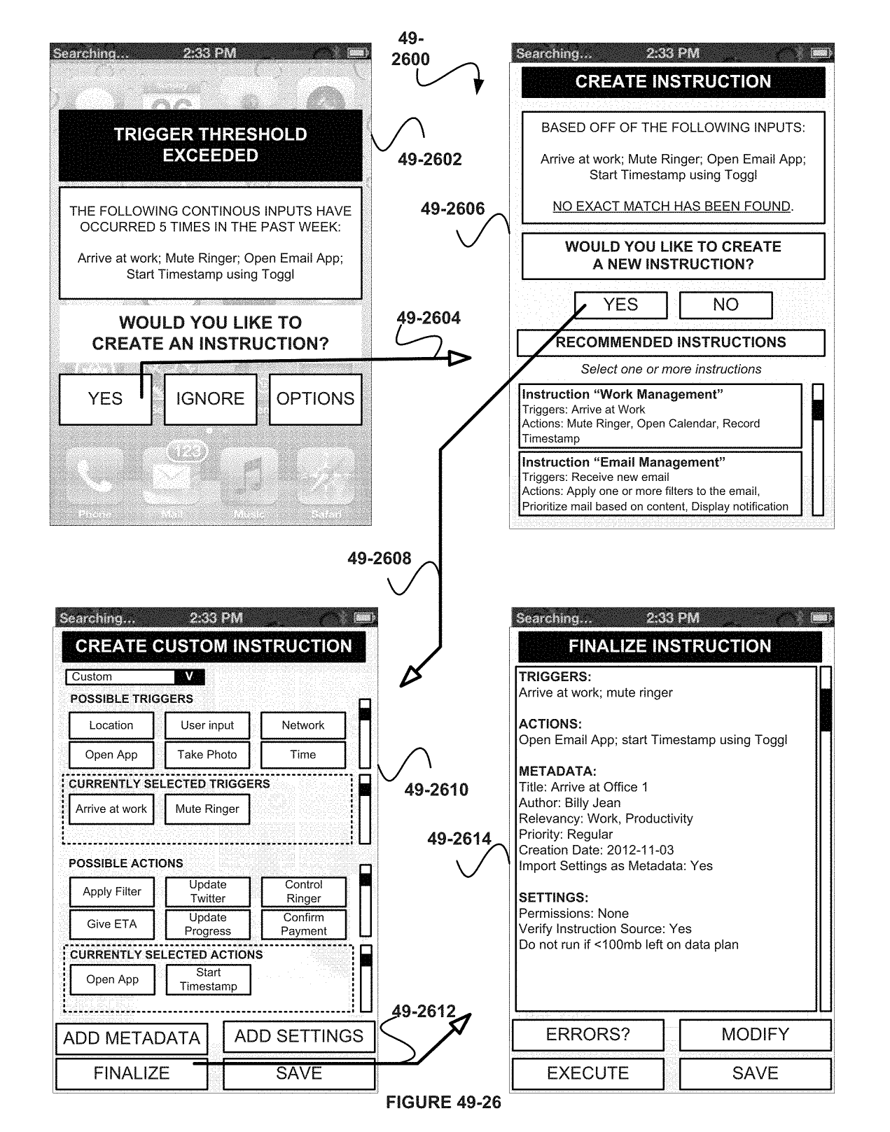

FIG. 49-1 illustrates a network architecture 49-100, in accordance with one embodiment. As shown, a plurality of networks 49-102 is provided. In the context of the present network architecture 49-100, the networks 49-102 may each take any form including, but not limited to a local area network (LAN), a wireless network, a wide area network (WAN) such as the Internet, peer-to-peer network, etc.

Coupled to the networks 49-102 are servers 49-104 which are capable of communicating over the networks 49-102. Also coupled to the networks 49-102 and the servers 49-104 is a plurality of clients 49-106. Such servers 49-104 and/or clients 49-106 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 49-102, at least one gateway 49-108 is optionally coupled therebetween.

FIG. 49-2 shows a representative hardware environment that may be associated with the servers 49-104 and/or clients 49-106 of FIG. 49-1, in accordance with one embodiment. Such figure illustrates a typical hardware configuration of a workstation in accordance with one embodiment having a central processing unit 49-210, such as a microprocessor, and a number of other units interconnected via a system bus 49-212.

The workstation shown in FIG. 49-2 includes a Random Access Memory (RAM) 49-214, Read Only Memory (ROM) 49-216, an I/O adapter 49-218 for connecting peripheral devices such as disk storage units 49-220 to the bus 49-212, a user interface adapter 49-222 for connecting a keyboard 49-224, a mouse 49-226, a speaker 49-228, a microphone 49-232, and/or other user interface devices such as a touch screen (not shown) to the bus 49-212, communication adapter 49-234 for connecting the workstation to a communication network 49-235 (e.g., a data processing network) and a display adapter 49-236 for connecting the bus 49-212 to a display device 49-238.

The workstation may have resident thereon any desired operating system. It will be appreciated that an embodiment may also be implemented on platforms and operating systems other than those mentioned. One embodiment may be written using JAVA, C, and/or C++ language, or other programming languages, along with an object oriented programming methodology. Object oriented programming (OOP) has become increasingly used to develop complex applications.

Of course, the various embodiments set forth herein may be implemented utilizing hardware, software, or any desired combination thereof. For that matter, any type of logic may be utilized which is capable of implementing the various functionality set forth herein.

FIG. 49-3 shows a method 49-300 for executing an instruction in connection with a mobile device, in accordance with one embodiment. As an option, the method 49-300 may be implemented in the context of the architecture and environment of the previous Figures and/or any subsequent Figure(s). Of course, however, the method 49-300 may be carried out in any desired environment.

As shown, one or more triggers are identified. See operation 49-302. Additionally, the one or more triggers are processed to identify an instruction. See operation 49-304. Further, the instruction is executed in connection with a mobile device based on the one or more triggers. See operation 49-306.

In the context of the present description, a trigger may include anything which may be associated with the mobile device and which may cause the mobile device to respond and/or take action in some manner. For example, in various embodiments, a trigger may include time, date, location, a phone conversation, notes, other devices near the user's mobile device (e.g. a device associated with a trusted entity, etc.), weather, a map (e.g. as an application on the mobile device, etc.), a rss feed, calendar, carrier information (e.g. signal strength, etc.), social media (e.g. comments, postings, uploads, etc.), stocks, an action (e.g. by a user, by an application, by a trusted entity, etc.), a plurality of actions (e.g. by the user, by an application, by a trusted entity, etc.), messaging platform (e.g. email, voicemail, SMS, etc.), camera, browsing history (e.g. of the user, of another entity, etc.), purchase history (e.g. of the user, of another entity, etc.), network (e.g. WiFi, NFC, Bluetooth, connectivity, etc.), speed (e.g. speed of the user, speed of a vehicle, etc.), a request (e.g. from another device, from a cloud based app, from another entity, etc.), an application (e.g. installed on the device, associated with an installed application, associated with an app management system, etc.), and/or any other feature which may cause the mobile device to respond and/or take action in some manner. In another embodiment, a trigger may include a macro, a script, and/or any other preconfigured set of one or more inputs.

An instruction may include one or more triggers and one or more response actions. A response action may include any action taken by the mobile device in response to one or more triggers. For example, in various embodiments, a response action may include posting and/or sending a message (e.g. via social network, via email, via SMS, etc.), displaying and/or suppressing a notification (e.g. text notification, audible notification, etc.), uploading and/or downloading a data file (e.g. photo, document, etc.), activating and/or deactivating a service (e.g. Bluetooth, WiFi, GPS, NFC, device volume, device screen brightness, etc.), creating a data file (e.g. email, document, photo, SMS, posting, etc.), modifying and/or deleting a data file (e.g. email, document, photo, SMS, posting, etc.), importing and/or exporting a data entry (e.g. contact, etc.), executing and/or quitting a mobile device app (e.g. Facebook app, Yelp app, Flickr app, etc.), send and/or receive a message (e.g. SMS, email, chat, etc.), accept and/or reject a connection (e.g. Facebook friend, Linked-in contact, CRM database management service, etc.), initiate and/or reject payment (e.g. ticket purchase, online service purchase, purchase verification email, etc.), completing a phone call, navigating to a destination, updating a user list (e.g. todo list, etc.), updating a count (e.g. kitchen item inventory, etc.), purchasing and/or ordering an item (e.g. grocery item, car oil etc.), scheduling an appointment (e.g. with a client, with a doctor, etc.), and/or taking any action in response to a trigger. In another embodiment, a response action may include a macro, a script, and/or any other preconfigured set of one or more actions.

Additionally, the response action may include an advertisement, a suggestion, incentive, useful information, a utilitarian function, and/or any type of an output. Useful information and/or utilitarian function may include, but are not limited to passes (e.g. boarding or travel passes, etc.), tickets (e.g. movie or event tickets, etc.), commerce-related programs/cards (e.g. loyalty program/cards, etc.), etc. In the context of the present description, an advertisement may include anything (e.g. media, deal, coupon, suggestion, helpful information/utility, etc.) that has at least a potential of incentivizing or persuading or increasing the chances that one or more persons will purchase a product or service.

Further, in one embodiment, the response action may occur based on availability of the user (e.g. active use of the device, no appointments listed, etc.). For example, in one embodiment, the response action may conditionally occur based on a facial recognition in connection with a user of the mobile device. In one embodiment, if it is determined that the user is viewing the mobile device, utilizing facial recognition, the action may occur utilizing the mobile device. In another embodiment, the action may occur based on movements by the user and/or device (e.g. as determined by accelerometers, gyroscopes, device sensors, etc.). For example, in one embodiment, the movement of the device may indicate the user is walking and has sat down (e.g. in a vehicle, etc.), whereupon the device Bluetooth system may be activated and Pandora may automatically begin to stream from the phone to a vehicle audio system. Of course, any response action may occur in response to any trigger.

Additionally, the application on the mobile device may include any type of online or locally stored application. In various embodiments, the application may include a social network application, a dating service application, an on-line retailer application, a browser application, a gaming application, a media application, an application associated with a product, an application associated with a location, an application associated with a store (e.g. an online store, a brick and mortar store, etc.), an application associated with a service, an application associated with discounts and/or coupon services, an application associated with a company, any application that performs, causes, or facilitates the aforementioned action(s), and/or any other type of application including, but not limited to those disclosed herein.

In the context of the present description, the mobile device may include any type of mobile device, including a cellular phone, a tablet computer, a handheld computer, a media device, a mobile device associated with a vehicle, a PDA, an e-reader, and/or any other type of mobile device.

In one embodiment, the trigger may include receiving a communication (e.g. advertisement, message, etc.) and the response action may include displaying an advisement. In one embodiment, the advertisement may be displayed in a non-intrusive manner. For example, in one embodiment, the action (e.g. advertisement, etc.) may be manifested utilizing a lock screen, or any other type of additional screen (e.g. swipe down screen, etc.), of the mobile device. In another embodiment, the action (e.g. advertisement, etc.) may be manifested during an unlocking of a lock screen of the mobile device. In still other embodiments, the action (e.g. advertisement, etc.) may be manifested in a manner that is integrated in any regular usage of the mobile device. Of course, any such manifestation of the aforementioned action may be presented in any manner that reduces an intrusiveness of a presentation thereof.

In another embodiment, the trigger may include receiving input from the user, including navigating to a gallery of photos, selecting photos to be shared, and selecting a recipient. The response action to such triggers may be to send the photos (e.g. email, SMS, etc.) to the recipient, to upload the photos (or a compressed folder of photos, etc.) to an account (e.g. social networking site, etc.) associated with the recipient, to modify (e.g. compress, apply filters, etc.) the photos before sending them to the recipient, and/or to take any other action relating to the selection of the photos and of a recipient. The instruction recorded therefore may include both the triggers (e.g. input from the user, etc.) and the response action or one or more actions.

Further still, in one embodiment, the trigger may include receiving a weather update (e.g. via RSS feed, via email, via weather application, via push update, etc.). A response action may include displaying a notification, causing a map application to update a route to account for weather conditions, causing a calendar appointment to calculate the time at which the user must leave to arrive at one or more appointments on time, sending an email notification to participants of an event regarding the weather update, and/or taking any other action in response to the weather update. The instruction recorded therefore may include both an update received (e.g. regarding weather, etc.) and one or more response actions (e.g. display notification, interact with other applications, etc.).

In the context of the present description, executing the instruction may include implementing the one or more triggers and the one or more response actions in any manner. For example, in various embodiments, executing the instruction may include applying a macro, causing one or more applications to interact, applying a script, applying a string of commands, and/or applying one or more triggers and one or more response actions. In one embodiment, the instruction may be executed automatically (e.g. as a result of one or more triggers, etc.) or manually. Additionally, in another embodiment, the instruction may be executed by a voice command, by a remote configuration (e.g. command from a remote device, etc.), and/or by any other manner.

As an example, in one embodiment, the instruction may include pressing a button on a homescreen (or anywhere located on the device, etc.), causing a string of commands to be implemented including determining all emails received from the last week from CONTACT_X, forwarding the batch of emails onto CONTACT_Y, archiving the emails to a predefined location (e.g. dropbox folder, etc.), and emailing a list of received emails to CONTACT_Z. In another embodiment, the instruction may be executed by giving a predefined voice command (e.g. “execute weekly email cleanup,” etc.). Of course, any command and/or string of commands (e.g. relating to one or more triggers and one or more actions, etc.) may be implemented by an instruction (e.g. via a shortcut, a button, a voice command, an app, etc.). As such, the instruction may be manually executed.

In a separate embodiment, the instruction may be executed automatically. For example, in one embodiment, the mobile device may indicate (e.g. via sensors, etc.) that the user has entered a restaurant. In response, the instruction may cause a response action to be automatically initiated including updating a status on social networking site (e.g. Facebook, Foursquare, etc.), sending a message (e.g. email, SMS, etc.) to participants of the event that the user has arrived, and/or taking any other action or actions as initiated by the instruction.

In another embodiment, the instruction may automatically execute (e.g. on a weekly basis, time trigger, etc.) a string of commands to be implemented including determining all emails received from the last week from CONTACT_X, forwarding the batch of emails onto CONTACT_Y, archiving the emails to a predefined location (e.g. dropbox folder, etc.), and emailing a list of received emails to CONTACT_Z. Of course, any command and/or string of commands (e.g. relating to one or more triggers and one or more actions, etc.) may be implemented in a similar. As such, the instruction may be automatically executed.

More illustrative information will now be set forth regarding various optional architectures and features with which the foregoing techniques discussed in the context of any of the present or previous figure(s) may or may not be implemented, per the desires of the user. For instance, various optional examples and/or options associated with the one or more triggers of operation 49-302, the instruction of operation 49-304, the executing of the instruction of operation 49-306, and/or other optional features have been and will be set forth in the context of a variety of possible embodiments. It should be strongly noted, however, that such information is set forth for illustrative purposes and should not be construed as limiting in any manner. Any of such features may be optionally incorporated with or without the inclusion of other features described.

FIG. 49-4 shows a system 49-400 for prompting an action by a platform in connection with a mobile device, in accordance with another embodiment. As an option, the system 49-400 may be implemented in the context of the architecture and environment of the previous Figures and/or any subsequent Figure(s). Of course, however, the system 49-400 may be implemented in the context of any desired environment. It should also be noted that the aforementioned definitions may apply during the present description.

As shown, one or more triggers 49-404-49-454 may cause an instruction 49-402 in connection with a mobile device to be executed. In one embodiment, a trigger may include a phone 49-404. In various embodiments, a phone call may trigger an action, including automatic speech-to-text dictation, the display of a notes application screen (e.g. to jot down some notes, etc.), rejection of the phone call, priority tagging (e.g. application of a different ringer, elevation of ringtone, etc.) of the phone call, the sending (e.g. via SMS, email, etc.) of a pre-scripted message response (e.g. “Inside of a noisy hall. I'll call you back after my event,” “Running a bit late—will be there in a few minutes,” etc.), and/or any other action. Of course, any pre-scripted message response may be sent, and in another embodiment, a list of pre-scripted messages may be presented to the user for selection, and if no selection is made, the top message response (e.g. determined by user usage, determined by relevancy, etc.) may be sent.

In other embodiments, the action taken in response to the phone call may be dependent on the user identity, a user tag, and/or any other information associated with the caller. For example, in one embodiment, the caller may be a manager or boss of the user, in which case the phone call may be prioritized (e.g. ringer volume increased, etc.). In another embodiment, the caller may have a tag of “client” and if the user does not answer the call, a message may be automatically sent (e.g. via SMS, via email, etc.) to the caller thanking him/her for the call and indicating that the user will respond to the call as soon as is possible. Of course, any message and/or action may be taken in response to the phone call.

In one embodiment, a trigger may include notes 49-406 such as text entered, a recorded audio, a speech-to-text function, and/or any other input associated with a note. In some embodiments, the notes may be associated with an app (e.g. Evernote, a notes app, phone, etc.), with an event (e.g. calendar item, etc.), with a contact (e.g. contact manager, etc.), and/or any other with any other feature (or app) of the mobile device. In another embodiment, the notes may include context awareness features such as the ability to determine who the note relates to (e.g. note may include the text “Call Bill,” etc.), what the note relates to (e.g. time, place, and/or other information associated with the text or audio of a note, etc.), and/or the ability to track the note (e.g. note sent from user to contact, and from the contact to another contact and so forth, etc.).

In various embodiments, a notes may trigger an action, including initiating a phone call (e.g. based on a contact listed in a note, etc.), sending a message (e.g. email, SMS, etc.), setting a reminder (e.g. calendar reminder, etc.), creating an event detail (e.g. calendar item, etc.), uploading information to an online server (e.g. social networking site, blog, etc.), and/or taking any other action in response to a note. In one embodiment, the note may be spoken as a voice command (e.g. “NOTE: remind me to clean the bathroom,” etc.) and may be set to remind the user based off of a proximity timer (e.g. if the user exceeds the proximity, it may activate the reminder, etc.), a time based timer (e.g. 12 pm the next day, etc.), a calendar based availability timer (e.g. device may recognize the user has free time the following day at 2 pm and may remind the user at that time due to the availability, etc.), and/or taken any other action relating to the voiced note.

In one embodiment, a trigger may include a time 49-408. For example, in various embodiments, a time may include the amount of time at a location, a time of day (e.g. morning, afternoon, night, etc.), an exact time (e.g. 6:43 pm, etc.), availability (e.g. free time in a schedule, etc.), and/or any other association to time. For example, in one embodiment, the mobile device may belong a young child, and at 9 pm, if the child is not at home, the current location of the child (e.g. based on GPS signal, etc.) may be pushed to other subscribing devices (e.g. mobile device associated with a parent, etc.). Of course, any action may be triggered in response to a time trigger.

In another embodiment, a trigger may include a date 49-410. For example, in various embodiments, a date may include a date range (e.g. an event lasting three days, vacation dates, etc.), a reoccurring day and/or range of the week and/or month and/or year (e.g. every Monday of the month, third Sunday of every month, quarterly and/or annual basis, etc.), a specific date (e.g. May 20, 2012, etc.), and/or any other association to a date. As an example, in one embodiment, the user of the mobile device may have an event scheduled for a specific date. In response to the event scheduled, the upcoming date may trigger one or more actions, including sending out a general reminder to participants, providing a weather forecast for the event, presenting any necessary detours to navigate to the event (e.g. based on scheduled construction issues, etc.), requesting participants to update a status (e.g. will attending, will not attend, etc.), and/or taking any other action in response to the event scheduled. In another embodiment, a preview (e.g. of an email, of a message, of a reminder, etc.) associated with a date may be automatically sent to a user of the mobile device for approval before being sent to a participant and/or another recipient contact.

Still yet, in another embodiment, a trigger may include a location 49-412. In various embodiments, a location may include a current location of the mobile device, a preconfigured address (e.g. address associated with “home,” “work,” and/or any preset location, etc.), a destination, and/or any other address. In various embodiments, the location may trigger a number of one or more actions, including updating a social networking site (e.g. Facebook, Foursquare, etc.), sending a message (e.g. email, SMS, etc.) to a contact, updating a management system (e.g. truck route progress, etc.), displaying a website associated with the location, displaying an app associated with the location (e.g. an app from the store, etc.), and/or taking any other action in response to the location.

In one embodiment, a trigger may include people 49-414. For example, in various embodiments, people may include individuals within a close geographic proximity (e.g. less than 10 feet, etc.) to the user, pre-selected contacts (e.g. favorite contacts, contacts with a tag, etc.), unknown individuals, and/or any person that may interact in some manner with the user's mobile device. For example, in various embodiments, people may trigger one or more actions, including a request to share information (e.g. meet new contacts, share business card, share data file such as a photo, etc.), to update a status on a social networking site (e.g. Facebook, etc.), to create a shared data file (e.g. shared whiteboard, etc.), to control another mobile device, and/or any other action in response to people.

As an example, in one embodiment, a user of a mobile device may be in close proximity to a group of friends. The mobile device may recognize (e.g. via device recognition, GPS location, etc.) the presence of the other friends and automatically update a status on a social networking site that the user is now with such friends. Any photos that are taken during the event may be instantly pushed and shared to other devices associated with the friends. Additionally, permission may be automatically granted to such friends to control at least some aspect (e.g. ability to push information, ability to control camera, etc.) associated with the user's mobile device. Of course, when the friends are beyond a threshold geographic proximity to the user, all automatic and applied settings may be terminated (e.g. sharing settings are severed, permissions are revoked, social networking updates of the group are halted, etc.).

In another embodiment, a trigger may include devices 49-416. For example, in various embodiments, devices may include any device located within a close geographically proximity (e.g. within 20 feet, etc.) of the mobile device of the user, any device already associated with the user's mobile device (e.g. known device associated with a trusted entity, etc.), any device not yet associated with the user's mobile device (e.g. new devices not before paired and/or connected, etc.), and/or any other device which may interact with the user's mobile device in some manner. Of course, devices may include other mobile devices, televisions, tablets, cash registers, and/or any other electronic device which may send and receive an electronic signal (e.g. to enable communication, etc.). In various embodiments, devices may trigger one or more actions, including a payment display page (e.g. electronic transfer, credit card charge, etc.), a display to share with and/or receive from another device (e.g. device associated with a trusted entity, etc.) data and/or information, stream data (e.g. photos, music, slideshow, videos, etc.) and/or other information (e.g. text feeds, etc.), display advertisements (e.g. relevant coupons and/or discounts, etc.), cause the user's mobile device display to function in another manner (e.g. secondary display to a master device, function as a mouse, keyboard, or another preselected function, etc.), and/or any other action taken in response to another device.

As an example, in one embodiment, the user's mobile device may detect that a cash register device is within a predetermined geographic proximity (e.g. within 10 feet, etc.). In response to the detection, the mobile device may display a payment display page with an option to pay. After the items have been scanned by the cash register, the items and total price may be displayed on the user's mobile device. The user may select to pay for the items using a stored payment account (e.g. credit card account, banking routing number and account, etc.). After the payment, the payment display page may automatically update a personal finance application with the pending transaction, as well as display to the user current budget balances. In another embodiment, current budget balances may be displayed to the user before processing the payment so that the user may verify that the purchase is within a predetermined expense budget.

In a further embodiment, the user's mobile device may detect other devices (e.g. relating to a brick and mortar store, etc.). Such other devices may seek to push coupons and/or ads, and/or invite the user to download and/or use an app associated with the store. In response, the mobile device may automatically filter and/or reject content pushed from other devices. For example, the user may indicate that all app requests are to be rejected except for entertainment related shops, and all content including coupons and/or ads are to be rejected unless it relates to a discount of at least 75%. If a coupon is at least 75% off, the coupon may be pushed and displayed to the user. Additionally, the user may have also configured the mobile device so that when such coupons and/or ads are displayed on the device, they are also automatically uploaded (e.g. to a blog, social networking site, etc.) and shared with other friends associated with the user.

In one embodiment, a trigger may include weather 49-418, including weather associated with the current location of the user, and/or weather associated with another location set by the user. The weather may trigger one or more actions, including displaying a notification (e.g. “weather is cool at 60 degree,” etc.), sending a message (e.g. SMS, email, etc.) to a contact (or participants of an event, etc.), rerouting a navigation route, displaying a recommendation (e.g. “take a coat,” safety recommendations, weather advisory warnings, etc.), and/or taking any action in response to the weather.

In another embodiment, a trigger may include a map 49-420. In one embodiment, the map may be a separate and distinct app. In another embodiment, the map may be included and be embedded within another app and/or feature associated with the mobile device (e.g. pushed interactive image from another device, device map platform, etc.). In various embodiments, the map may trigger one or more actions, including navigating to a location, finding a location (e.g. address, store, sites, etc.), displaying trusted entities (e.g. friends, etc.) near the user, estimating one or more times of arrival, displaying one or more overlays (e.g. bike view, real time traffic, pedestrian view, points of interest [POI], etc.), and/or any other action associated with the map app.

As an example, every time the user gets into a car, the user starts a map app to display real-time traffic updates. In response, the user activates a navigation feature to apply the quickest route home. In one embodiment, rather than go through the same process repeatedly, the user may automate the process so that as soon as the user enters the car (e.g. based off of sensors, etc.), the map application automatically displays real-time traffic feeds, selects the quickest route home, and then begins the navigation feature to apply the quickest route home. In another embodiment, the user may select a button the homescreen of the mobile device which would then start a navigation feature to apply the quickest route (from real time traffic updates) home. In a further embodiment, the user may give a verbal command (e.g. “navigate home,” etc.) to navigation feature to apply the quickest route (from real time traffic updates) home. Of course, any method may be used to save and execute the string of commands.

In another embodiment, on a daily basis, the user may open a map app to view possible locations to eat lunch. Additionally, the user may view other friends on the map who intend to eat lunch with the user. After selecting a location, the user sends a message out to all friends giving the location. Once at the location, the user sends a message out to all friends notifying them that the user has arrived. In one embodiment, rather than apply these same steps repeatedly (e.g. daily, etc.), the user may automate the process so that every morning, the map app gives a recommendation (e.g. based on Yelp ratings, etc.) of a lunch location, and after the user approves, the mobile device automatically sends a message to all friends. When the user arrives at the intended location, the mobile device may automatically send a message out to all friends that the user has arrived, as well as automatically display a map with a real time update of the location of each friend. Of course, permissions to view the location of a friend may be controlled by the friend (e.g. temporary permission, full permission, etc.). Additionally, in other embodiments, the string of commands may be saved to a button shortcut, and/or be used by a verbal command (e.g. send my friends a lunch update, view my friends, etc.), and/or executed in any manner.

In another embodiment, a trigger may include an RSS/Feed 49-422. In various embodiments, the RSS and/or Feed may be associated with an app (e.g. gaming app, food app, news app, etc.), may be an app (e.g. RSS management app, feed management app, etc.), may be associated with an online site (e.g. site which pushes updates to a mobile device, blog entries, news headlines, etc.), and/or may be associated with an RSS reader, feed reader, aggregator (e.g. web based, desktop-based, mobile device based, etc.), and/or any other app and/or RSS tool. The RSS/Feed may trigger one or more actions, including causing the mobile device to sound an audible and/or visible (e.g. flashing light, display feed on home screen, display feed on locked screen, etc.) notification, send a message (e.g. SMS, email, etc.), post a message (e.g. onto a blog, onto a social networking site, etc.), give a recommendation (e.g. best feed deal out of the past ten feeds, etc.), forward on the feed (e.g. to a contact, etc.), provide a summary (e.g. of the article referenced by the feed, etc.), provide a text-to-speech function (e.g. for immediate playback in a vehicle, etc.), and/or any other action taken in response to receiving an RSS and/or feed.

In some embodiments, the action may require approval by the user before being completed. For example, in various embodiments, receiving a RSS feed update may initiate the creation of a blog posting. The blog posting may be prepared (e.g. with text, graphics, photos, etc.) with a preview sent to the user (e.g. via mobile device app, via email, etc.). If the user approves of the preview (e.g. by selecting an “approve” button, etc.), the posting may be uploaded to a bog. Of course, any preview and/or approval process may be associated with an RSS and/or feed item.

In another embodiment, the user may belong to a technology group focusing on semi-conductors. Whenever the user receives a RSS and/or feed relating to a competitor's use of doping (e.g. addition of impurities in semiconductor material, etc.), the user immediately forwards on the update to all in the technology group. The user may automate the process so that whenever a RSS and/or feed is received which relates to semiconductors and which relates doping, the RSS and/or feed is immediately forwarded on to preselected members of the user's technology group. The string of commands (making up the automated process, etc.) may be saved within an app (e.g. RSS management app, etc.), by the mobile device (e.g. native utility on the device, etc.), by an online platform (e.g. online RSS feed subscription management site, etc.), and/or saved in any manner. Additionally, in other embodiments, the string of commands may be saved to a button shortcut, and/or be used by a verbal command, and/or executed in any manner.

In one embodiment, a trigger may include a calendar 49-424. In various embodiments, an action may be taken in response to a scheduled event (e.g. appointment, etc.), unscheduled time (e.g. free time, etc.), a metadata tag (e.g. appointment is tagged as relating to work, a priority tag associated with the event, etc.), an event creation source (e.g. created by another user on a shared calendar, etc.), an event duration (e.g. one hour, two days, etc.), and/or any other feature associated with a calendar. The calendar may trigger one or more actions, including rescheduling an event, notifying participants of an event of a conflict (e.g. new conflict, existing conflict, etc.), notifying participants of an event of newly added participants, finding and/or presenting related content (e.g. airline ticket, car rental, hotel rental, points of interest, etc.), displaying and/or playing a notification (e.g. audible, text, alarm, etc.), sharing an event (e.g. with a contact, with a participant, etc.), creating a shared resource to be used at the event (e.g. shared word processing document, shared photo platform, etc.), and/or taking any other action in response to a calendar.

As an example, in one embodiment, a user may set up an event relating to a business travel trip. After scheduling the time for the event, the user may search for airplane tickets, hotels in the vicinity, maps to get to the destination, and/or other items relating to the business travel trip. After making all such reservations and/or gathering the material, the user may send an overview of the event (e.g. location, hotels, car rental, etc.) to a business manager, as well as to a business accountant so that the user can be reimbursed for the trip. Such a series of one or more actions may be automated. For example, after creating an event (e.g. including time, dates, location, metadata tag indicating business trip, etc.), the calendar may fetch related items (e.g. airplane tickets, recommended hotels, rental car, etc.) and present a package to the user. After selecting an appropriate package, the calendar may communicate with each item to finalize the reservation. After receiving confirmation of each reservation (e.g. via email, etc.), the calendar app may generate an overview of the entire event (e.g. each confirmed reservation, location specifics, price for each item and total price, etc.). Such an overview may be sent to the user (e.g. preview pane, preview screen, via email, etc.) to obtain the user's approval. Once the user approves of the overview, it may be automatically sent to the user's manager and the business accountant. In this manner, the number of steps (and time) required of the user may be greatly reduced. Of course, any action may be taken in response to a calendar. Additionally, in other embodiments, the string of commands (e.g. one or more actions relating to the calendar event, etc.) may be saved to a button shortcut, and/or be used by a verbal command, and/or executed in any manner.

In another embodiment, a trigger may include a carrier. For example, in various embodiments, a carrier may include a network data signal, a network telephone signal, a roaming signal, and/or any other type of signal and/or feature associated with a carrier. In some embodiments, the carrier may be used to trigger one or more actions, including an ability to stop, cancel, and/or limit a feature and/or service (e.g. SMS, data, voice, specialized ringtones, etc.), send a message (e.g. SMS, email, etc.), enable emergency services and/or features (e.g. 911 calls only, etc.), and/or any other action relating to a carrier.

As an example, in one embodiment, the user of a mobile device may automate a process so that when the user is near exiting a carrier's data signal (e.g. based off of carrier coverage maps, etc.), the user's mobile device may automatically send out a message (e.g. SMS, email, etc.) to one or more contacts (e.g. preselected contacts, filtered contacts based on metadata tag, etc.) to inform them that the user will be losing coverage and will not be able to respond to messages (e.g. email, SMS, voice, etc.) immediately. Of course, the automatic one or more actions may relate to anything and/or be configured in any manner by the user. Additionally, in other embodiments, the string of commands (e.g. one or more actions relating to a network carrier signal, etc.) may be saved to a button shortcut, and/or be used by a verbal command, and/or executed in any manner.

In one embodiment, a trigger may include comments. For example, in various embodiments, comments may be associated with an online forum (e.g. blog, social networking site, video sharing site, photo sharing site, etc.), received via a messaging platform (e.g. email, SMS, chat, etc.), may include text, audio, photos, videos, and/or any other data file (e.g. document, spreadsheet, etc.), and/or may be received in any manner. In various embodiments, the comment may be analyzed to determine a context (e.g. based off of text, sender location, destination location, calendar item, purchase history, email history, browsing history, etc.), may be associated with a metadata tag (e.g. comment relates to vacation, Hawaii, family, and year 2012 tags, etc.), may be associated with a string of comments and/or conversation (e.g. chat, etc.), and/or may be associated with any item associated with the comments.

In one embodiment, the context of the comments may be used to trigger an action. For example, in various embodiments, the context may include any circumstances associated with a comment, and/or location information (e.g. GPS location information, a physical address, an IP address, shopping center, movie theatre, stadium, etc.), network information (e.g. information associated with the network currently being utilized or currently being accessed, etc.), information relating to applications being utilized (e.g. games, maps, camera, retailer, social networking, etc.), current activities (e.g. shopping, walking, eating, reading, driving, etc.), browsing activity, environment (e.g. environmental audio, weather, temperature, etc.), payment activities (e.g. just purchased coffee, groceries, clothes, etc.), comment history, social networking site history, actual text of comment, attachment associated with a comment, data item (e.g. photo, video, etc.) associated with a comment, and/or any other type of information which may relate in some manner to context and/or comments.

In one embodiment, the context may be determined based, at least on part, on information provided by one or more sensors, applications, inputs, software associated with the mobile device, an advertisement/content management platform, an operating system associated with the mobile device, and/or any context source. In another embodiment, the context may be determined based, at least in part, on current and/or past activities of the user (e.g. as determined by hardware/software associated with the mobile device, etc.). In another embodiment, the context may be determined by current and/or past activities of the mobile device. In another embodiment, the context may be determined based on a location of the user and/or the mobile device.

The context may include any circumstances that form one or more settings for an instruction (e.g. an input, display settings, location settings, content display, advertisement display, etc.). For example, in various embodiments, information for determining the context may include location information (e.g. GPS location information, a physical address, an IP address, shopping center, movie theatre, stadium, etc.), network information (e.g. information associated with the network currently being utilized or currently being accessed, etc.), applications being utilized (e.g. games, maps, camera, retailer, social networking, etc.), current activities (e.g. shopping, walking, eating, reading, driving, etc.), browsing activity, environment (e.g. environmental audio, weather, temperature, etc.), payment activities (e.g. just purchased coffee, groceries, clothes, etc.), and/or any other type of information associated with a context.

In some embodiments, based on the context of a comment, an action may be triggered, including setting an alarm and/or reminder (e.g. including setting a geofence border and/or trigger, etc.), creating and/or modifying a calendar event, providing a response to a comment (e.g. using pre-scripted responses, etc.), maintaining statistics (e.g. positive comments v. negative comments, etc.), posting a message (e.g. blog, social networking site, etc.), and/or taking any further action based off of the context of a comment. In other embodiments, a comment, regardless of the context, may be used to trigger an action, including giving a notification (e.g. 5 new comments, etc.), maintaining statistics (e.g. relating to comments generated, etc.), aggregating the comments to be presented to the user (e.g. displayed on a comments screen, overlay, menu, in an email, etc.), and/or taking any action in response to a comment.

As an example, in one embodiment, a user may post a blog posting which is published on more than one blog site. In response, comments relating to a blog posting may be posted on more than one site. The user's mobile device may take all such comments, aggregate them into one collection in a central comments repository (e.g. comments app, etc.). Additionally, in response to issues raised in the comments, the user may respond to such comments. Often, the issues raised may be very similar. Rather than respond to each comment individually, the user may automate responding to all pertinent comments (e.g. via a comments app on mobile device, etc.). The mobile device may identify a common issue in more than one comment (e.g. based on the text of the comments, etc.) and present the one or more issues to the user of the mobile device. The user may write one or more comment responses (e.g. based on the one or more issues identified, etc.). The mobile device may automatically select more one or more comment to which the response may pertain, request approval of the selected applicable comments from the user, and then the mobile device (e.g. comments app, etc.) may automatically post the response to the appropriate site. In this manner, an action may be taken in response to a context of a comment. Of course, in another embodiment, the user may write a comment response and then select a button to apply a string of preconfigured one or more actions, including formatting the response in a different manner (e.g. depending on the intended recipient and/or destination, etc.), modifying the text (e.g. insert name of original comment author, etc.), and/or taking any further action relating to the context of the comment.

In another embodiment, a comment may be received by the user from a trusted entity (e.g. friend, trusted business, etc.). The comment may include a confirmation of a ticket and/or an event. In response to the comment, the mobile device may automatically extract relevant information from the comment (e.g. date, location, time, participants, etc.), and based on the context (e.g. including the extracted relevant information, etc.) of the comment, create a calendar event, create a notification reminder (e.g. reminder set to one day before the event, reminder set using predetermined settings, etc.), post a social media posting (e.g. Facebook, etc.) indicating you will be attending an event, send an invite to other contacts (e.g. friends, etc.), import and/or download information (e.g. maps, etc.) relating to the event (e.g. information assembled within an event page, on a calendar item, etc.), and/or any other action taken in response to the context of the comment.

In a separate embodiment, an action may be triggered by a tag associated with a comment. For example, in one embodiment, a comment may be received and a tag may be associated with the comment indicating “work,” “tech group,” and “Boston location.” Based on the tag associated with the comment, the user's mobile device may automatically take an action by forwarding (e.g. via email, chat, SMS, etc.) the comment (or a link thereto) to one or more contacts (e.g. or predefined groups, etc.). Of course, in other embodiments, an action may be triggered in response to any element associated with a comment. Additionally, rather than apply one or more commands (e.g. one or more actions, etc.) automatically, the commands may be manually executed via a shortcut button, a voice command, and/or any other way.

In a separate embodiment, a set of threshold triggers may be required in order for one or more actions to be taken. For example, in one embodiment, a string of commands may relate to formatting a comment, including taking the written response, modifying it by inserting the name of the author of the original comment, applying site-specific formatting requirements (e.g. size, length, etc.), and/or uploading the response to each particular site. In order for such one or more actions to be executed, the manually executed button may have a set of threshold triggers including requiring a comment to have been received, the comment to contain an author name, and/or any other information and/or triggers which may relate to the comment. Of course, any triggers may be required in order to apply and/or execute a string of commands (e.g. one or more actions, etc.).

In one embodiment, a trigger may include stocks 49-430. For example, in various embodiments, stocks may include closing time prices, percent change of individual stocks and/or of a portfolio, top stock sales, supply and/or demand changes, new stocks released, companies recently have gone public, and/or any other information which may relate in some manner to stocks. In some embodiments, stocks may be used to trigger one or more actions, including aggregating stock changes (e.g. stocks daily report, etc.), presenting recommendations (e.g. sell/buy stocks, etc.), notifying one or more contacts (e.g. stock client, etc.), and/or taking any other action in response to the stocks. As an example, in one embodiment, a user of a mobile device may be notified of recent top stocks. In response, the user may often forward such top stocks to investors associated with the user, and based on the response, may take an action (e.g. buy/sell stock shares, etc.). The user may automate such a string of commands and/or process, including receiving notification of top stocks, sending (e.g. via email, SMS, chat, etc.) such notifications to one or more predetermined recipients (e.g. investing clients, etc.), and based on the response of the one or more recipients (e.g. sell, buy, no action, etc.), automatically complete a transaction based on the input from the one or more recipient. In one embodiment, the string of commands may be automatically implemented once a top stock notification is received. In another embodiment, the string of commands may be invoked and/or executed by the user (e.g. select which top stock notifications to send, etc.). Additionally, the string of commands may be executed via shortcut button, a voice command, and/or any other method.

In another embodiment, a trigger may include one or more user one or more actions 49-432. For example, in various embodiments, the one or more user one or more actions may include starting an application, interacting in some manner with an application (e.g. within app action, etc.), navigating a menu (e.g. app menu, OS menu, etc.), sending a message and/or invite (e.g. via email, SMS, chat, etc.), setting a reminder and/or alarm, creating an event (e.g. calendar, etc.), activating/deactivating and/or modifying a device setting and/or feature (e.g. volume, WiFi, Bluetooth, NFC, GPS, accelerometer, screen brightness, etc.), posting a message and/or status (e.g. social networking site, etc.), checking-in to a location (e.g. Foursquare check-in, actual reservation check-in, etc.), connecting to another device (e.g. secondary device, display, etc.), navigating to one or more websites, updating an app (e.g. financial app updated per transaction, etc.), receiving a voice command, receiving a swipe command (e.g. swipe action correlates to a command, etc.), and/or interacting in some manner (e.g. via an action, etc.) with the mobile device.

In some embodiments, one or more user actions may be used to trigger one or more actions, including starting an application, interacting in some manner with an application (e.g. within app action, etc.), navigating a menu (e.g. app menu, OS menu, etc.), sending a message and/or invite (e.g. via email, SMS, chat, etc.), setting a reminder and/or alarm, creating an event (e.g. calendar, etc.), activating/deactivating and/or modifying a device setting and/or feature (e.g. volume, WiFi, Bluetooth, NFC, GPS, accelerometer, screen brightness, etc.), posting a message and/or status (e.g. social networking site, etc.), checking-in to a location (e.g. Foursquare check-in, actual reservation check-in, etc.), connecting to another device (e.g. secondary device, display, etc.), navigating to one or more websites, updating an app (e.g. financial app updated per transaction, etc.), receiving a voice command, receiving a swipe command (e.g. swipe action correlates to a command, etc.), and/or interacting in some manner (e.g. via an action, etc.) with the mobile device. Of course, any action may be taken in response to a user action. Additionally, a string of commands (e.g. one or more actions, etc.) may be invoked and/or executed by a shortcut button, a voice command, and/or by any other method.

As an example, in one embodiment, a user may make a reservation (e.g. via Kayak.com app, etc.) for an upcoming travel. In response to the user action, the mobile device may create a calendar item (e.g. based on the date, time, and location of the reservation, etc.), notify predetermined contacts of the reservation (e.g. close friends, etc.), and give a page of recommendations (e.g. expected weather, maps of the area, etc.). Of course, any item and/or action may be taken in response to the user making a reservation.

In another embodiment, a trigger may include one or more app actions and/or events 49-434. For example, in various embodiments, one or more app actions and/or events may include creating an event (e.g. calendar item, etc.), recording an item (e.g. recording a game score onto an online score database, recording an audio clip, recording a video clip, etc.), downloading and/or uploading a data file (e.g. document, photo, video, audio, GPS location, Geotag, etc.), controlling in some manner a system feature (e.g. volume, screen brightness, WiFi, Bluetooth, GPS, camera, etc.), displaying one or more advertisement elements (e.g. ads, ad platform, etc.), displaying one or more notifications (e.g. reminders, alarms, updates, etc.), interacting with one or more apps (e.g. request info from another app, cause another app to take an action, etc.), updating an app (e.g. updating a database associated with the app, etc.), syncing (e.g. with an online database, with another device, etc.), controlling in some manner another device (e.g. display, trusted device, etc.), looking up information (e.g. barcode, etc.) via an online database system, tracking progress (e.g. education app, etc.), authenticating (e.g. a user, a device etc.), recording a trip (e.g. GPS path/track, breadcrumb trail, etc.), sending a product (e.g. postcard, etc.), buying/selling a product (e.g. via Amazon.com, etc.), buying/reserving a ticket (e.g. via Kayak.com, etc.), displaying and/or using a digital card (e.g. card in digital wallet, etc.), interacting with a media file (e.g. play video, play music, listen to radio, etc.), create a new contact entry (e.g. new contact, etc.), print a data file, apply a toddler and/or kid's mode, receiving an input (e.g. from a user, etc.), and/or any other action and/or event which may relate to an app. Of course, any action and/or event may be used to trigger an action.

In some embodiments, one or more app actions and/or events may trigger one or more actions, including creating an event (e.g. calendar item, etc.), recording an item (e.g. recording a game score onto an online score database, recording an audio clip, recording a video clip, etc.), downloading and/or uploading a data file (e.g. document, photo, video, audio, GPS location, Geotag, etc.), controlling in some manner a system feature (e.g. volume, screen brightness, WiFi, Bluetooth, GPS, camera, etc.), displaying one or more advertisement elements (e.g. ads, ad platform, etc.), displaying one or more notifications (e.g. reminders, alarms, updates, etc.), interacting with one or more apps (e.g. request info from another app, cause another app to take an action, etc.), updating an app (e.g. updating a database associated with the app, etc.), syncing (e.g. with an online database, with another device, etc.), controlling in some manner another device (e.g. display, trusted device, etc.), looking up information (e.g. barcode, etc.) via an online database system, tracking progress (e.g. education app, etc.), authenticating (e.g. a user, a device etc.), recording a trip (e.g. GPS path/track, breadcrumb trail, etc.), sending a product (e.g. postcard, etc.), buying/selling a product (e.g. via Amazon.com, etc.), buying/reserving a ticket (e.g. via Kayak.com, etc.), displaying and/or using a digital card (e.g. card in digital wallet, etc.), interacting with a media file (e.g. play video, play music, listen to radio, etc.), create a new contact entry (e.g. new contact, etc.), print a data file, apply a toddler and/or kid's mode, and/or any other action and/or event which may relate to an app. Of course, any action and/or event may be used to trigger an action.

As an example, in one embodiment, an app may record a GPS path of a user. In response to the recording, the app may upload the GPS tracks to an online system (e.g. online database, social networking site, etc.), update a status (e.g. “I'm hiking at ______” on Facebook, Geocached object found status update, etc.), display relevant advertisements (e.g. based on location, based on hiking activity, etc.), and/or take any other action in response to recording a GPS path of a user. Of course, any app action and/or event may trigger any action. Additionally, the string of commands (e.g. one or more actions, etc.) may be initiated and/or executed via a shortcut button, a voice command, and/or by any other method.

In another embodiment, a trigger may include one or more actions and/or events 49-436. For example, in various embodiments, one or more actions and/or events may include one or more actions and/or events (e.g. a number of steps in a string of actions and/or events, etc.) taken by a user, one or more actions and/or events (e.g. a number of steps in a string of actions and/or events, etc.) taken by an app, and/or any other action relating to the number of actions and/or events. In some embodiments, a number of actions and/or events (e.g. a number of steps in a string of actions and/or events, etc.) may trigger one or more actions, including prompting the user (of the mobile device, etc.) to save a string of actions, prompting the user (of the mobile device, etc.) to send a string of actions to a contact (e.g. friend, etc.), canceling/modifying a system resource (e.g. executing the one or more actions, and/or taking any other action relating to a number of actions and/or events.

As an example, in one embodiment, a user may take several steps relating to a photo album, including selecting a camera and/or gallery application, selecting an appropriate photo album (e.g. new photos, etc.), selecting one or more photos, selecting to share the one or more photos, selecting and/or inputting addresses (e.g. email address, etc.) of one or more photo recipients, inputting a message to be sent with the photos, and sending the message to the one or more photo recipients. After inputting such actions, the number of steps (actions) taken may cause a prompt to be displayed prompting the user to save the string of actions. In various embodiments, the user may set up the string of actions to be executed automatically every time four new photos (or any number) have been taken, to be executed whenever the user selects a shortcut button, to be executed in response to an input by the user (e.g. voice command, use of camera, etc.), to be executed in response to a timer (e.g. once a month, etc.), and/or to be executed in response to any trigger. Of course, any number of actions and/or events may be used to trigger an action.

In one embodiment, a trigger may include a mailbox 49-438. For example, in various embodiments, a mailbox may include a voice message, an email message, a SMS message, a chat message, scanned documents, social updates, RSS/Feed updates, a digital mailbox (e.g. digital mail service, digital archival, etc.), and/or any other item which may relate in some manner to a mailbox. In some embodiments, a mailbox may trigger one or more actions, including sending a message response (e.g. pre-scripted responses, etc.), posting a message (e.g. to an online platform, to a social networking site, etc.), archiving a message, deleting a message, applying a filter (e.g. move to a folder, auto-tag, star, mark as spam, etc.) to a message, forwarding a message, and/or interacting with a mailbox in any manner.

As an example, in one embodiment, a user may receive a message relating to technology. The user may then tag the email with a “technology” tag, move it to a technology folder, and forward it onto a friend interested in technology. In one embodiment, the user may automate the process whereby when an email is received, a filter is applied to it including tagging it with a “technology” tag, and moving it to a designated technology folder. Additionally, the message may be automatically forwarded onto a predetermined friend interested in technology. In another embodiment, a preview email may be sent to the user (e.g. with respect to the automatic forwarding of the email, etc.) for approval before being sent. Of course, any action may be taken relating to the email message received. Additionally, the string of commands (e.g. actions, etc.) may be saved to a shortcut button (e.g. manually initiated by the user, etc.), may be activated by a voice command, and/or may be controlled and/or initiated in any manner.

In another embodiment, a trigger may include social media 49-440. In various embodiments, social media may include receiving a posting (e.g. Facebook post, wall post, etc.), receiving an update (e.g. Twitter update, news update, blog update, etc.), receiving an email and/or instant messaging and/or chat (e.g. via social media site platform, etc.), interacting in some manner with a social media platform (e.g. magazines, Internet forums, weblogs, social blogs, microblogging, wikis, social networks, social site, dating forum, photo sharing site, vlog, music sharing site, etc.), interacting in some manner with a social media data file (e.g. podcasts, photographs and/or pictures, videos, document, etc.), submitting and/or receiving a rating (e.g. “like,” etc.), receiving and/or creating a social bookmark and/or tag, setting a level of trustworthiness (e.g. associated with a contact and/or friend, etc.), and/or interacting in any way with a platform and/or a site which facilitates interaction and dialogue.

In some embodiments, social media may trigger one or more actions, including uploading and/or reposting to a posting, uploading and/or sending an update (e.g. Twitter update, news update, blog update, etc.), sending an email and/or instant messaging and/or chat (e.g. via social media site platform, etc.), interacting in some manner with a social media platform (e.g. magazines, Internet forums, weblogs, social blogs, microblogging, wikis, social networks, social site, dating forum, photo sharing site, vlog, music sharing site, etc.), interacting in some manner with a social media data file (e.g. podcasts, photographs and/or pictures, videos, document, etc.), submitting and/or receiving a rating (e.g. “like,” etc.), receiving and/or creating a social bookmark and/or tag, setting a level of trustworthiness (e.g. associated with a contact and/or friend, etc.), and/or taking any action in response to a social media trigger.

For example, in one embodiment, a user may receive a social media update (e.g. relating to a video blog the user follows, etc.). In response to the social media update, the user may share the update by posting it on other social media sites (e.g. Facebook, Youtube, Twitter, etc.), sending the update to specific contacts (e.g. friends, etc.), rate the update (e.g. “like it,” etc.), and archiving it to a social database. Rather than apply many individual actions, the user may save all such one or more actions to a string of command. In various embodiments, the string of command may occur automatically based on the receipt of the blog update (or by any other trigger to automatically initiate the string of command), or may occur manually based on a shortcut button, a voice command, or any other input given by the user to initiate the string of commands.

In another embodiment, a trigger may include a camera and/or gallery 49-442. In various embodiments, a camera and/or gallery may include a live camera view, one or more photos (e.g. already taken photos, etc.), a webcam, a camera attached to the mobile device, a camera associated with another device (e.g. secondary device, etc.), an online gallery (e.g. photo sharing site, etc.), a voice activated camera feature, a camera filter (e.g. b&w, heavy saturation, etc.), a camera setting (e.g. exposure, aperture, etc.), and/or any feature associated with a camera and/or gallery.

In some embodiments, a camera and/or gallery may trigger one or more actions, including sharing a photo and/or an album (e.g. via photo sharing platform, via email, etc.), activating and/or deactivating a camera, activating and/or deactivating a camera option (e.g. time-lapse, webcam, collage, burst mode, panoramic, etc.), attaching a geotag (e.g. add GPS location to the photo, etc.) and/or other metadata tags, modifying and/or editing a photo (e.g. crop, resize, rasterize, etc.), altering camera types (e.g. video camera, still camera, digital camera, etc.), uploading captured images (e.g. to an online database, to a photo sharing site, etc.), applying a filter (e.g. b&w, heavy saturation, etc.), creating a photo collage (e.g. vignette of more than one photo, collection of more than one photo, etc.), and/or taking any other action in response to a camera and/or gallery. In various embodiments, the one or more actions taken in response to the camera and/or gallery may be executed automatically (e.g. in response to a trigger, etc.), in response to an action by a user (e.g. voice command, pressing a shortcut button, etc.), and/or in response to any other trigger.

As an example, in one embodiment, after a user takes a photo, the user may upload the photo to a photo sharing site (e.g. Flickr, etc.), a social media site (e.g. Facebook, etc.), and an online database site (e.g. Dropbox.com, etc.). The user may save such one or more actions to an instruction to be executed manually (e.g. button, shortcut, etc.) and/or automatically (e.g. when a photo is taken it triggers a series of other commands, etc.). Of course, a string of commands (e.g. actions, etc.) may be initiated in any manner (e.g. gesture, movement, action, etc.).

In another embodiment, a trigger may include an application 49-444. In various embodiments, an application may include any type of online or locally stored application, including a social network application, a dating service application, an on-line retailer application, a browser application, a gaming application, a media application, an application associated with a product, an application associated with a location, an application associated with a store (e.g. an online store, a brick and mortar store, etc.), an application associated with a service, an application associated with discounts and/or coupon services, an application associated with a company, any application that performs, causes, or facilitates the aforementioned action(s), and/or any other type of application including, but not limited to those disclosed herein.

In some embodiments, an application may trigger one or more actions, including recording an application action (e.g. internet usage, use of system resources, use of data and/or information associated with another application, etc.), modifying and/or activating and/or deactivating a system setting (e.g. WiFi, Bluetooth, NFC, volume, screen brightness, etc.), interacting with another app (e.g. associated or not associated with the initial application, etc.), uploading information (e.g. data file, metadata, stats, etc.), syncing information (e.g. data file, metadata, stats, etc.), and/or taking any action in response to the application. As an example, in one embodiment, after an application is opened, the user may dim the screen of the device to conserve power usage, retrieve recent social media postings from other apps (e.g. applications associated Facebook, Twitter, Foursquare, and/or Youtube, etc.), upload the user's current status (e.g. GPS location, hanging out with other contacts, etc.), and start a music app to listen to music. Rather than execute each action individually, the user may save such actions as a string of commands (e.g. actions, etc.) and which may be executed automatically (e.g. as soon as the app is opened, etc.), and/or manually (e.g. voice command, selecting a shortcut button, etc.). Of course, the string of commands may be executed and/or selected in any manner.

In another embodiment, a trigger may include device input 49-446. For example, in various embodiments, the device input may include receiving input from one or more sensors (e.g. accelerometer, gyroscope, camera, light, proximity, temperature, magnetometer, microphone, etc.), receiving input from one or more location based sensors (e.g. GPS, carrier triangulation, digital compass, barometer, altimeter, etc.), and/or any other sensor and/or device which may provide input to a mobile device. In some embodiments, the device input may trigger one or more actions, including starting and/or ending an application associated with the mobile device, recording a path (e.g. GPS tracks, etc.), activating and/or unlocking and/or restricting a service (e.g. premium features, app usage, etc.), activating and/or deactivate a mode (e.g. airplane mode, car mode, walking mode, office mode, etc.), activating and/or modifying and/or deactivating a device setting (e.g. volume, screen brightness, etc.), and/or taking any other action in response to the device input.

As an example, in one embodiment, every time a user gets into the user's car, the user activates the Bluetooth to communicate with the car's audio system, starts Pandora music application, and activates a car hand's free mode. In various embodiments, the user may save such actions to an instruction and execute the instruction automatically (e.g. when the user enters the user's car as determined by sensors, etc.), manually (e.g. giving a voice command, pressing a shortcut button, etc.), and/or in any other manner. In another embodiment, the sensors may sense that the user is in a plane (e.g. high altitude, traveling at a fast speed, etc.), and in response, deactivate the carrier network, activate a WiFi signal (e.g. for inflight WiFi service, etc.), decrease the brightness of the screen, and sign into to the WiFi using Gogo login credentials. In one embodiment, such actions may be implemented automatically (e.g. after detecting the user is in a plane, etc.), after receiving approval from a user (e.g. “It has been detected you are in a plane. Would you like to enable Airplane Mode?,” etc.), manually (e.g. voice command, button shortcut, etc.), and/or by any other manner.

In one embodiment, a trigger may include user history 49-448. In various embodiments, user history may include browsing history, purchase history, app usage history, battery usage history, location history, workout history (e.g. exercise regime, etc.), work history (e.g. time-in, time-out, etc.), and/or any other history which may be associated with the user. In some embodiments, user history may trigger one or more actions, including restricting use of a carrier network (e.g. data plan, etc.), providing targeted advertisements and/or relevant content (e.g. ads, recommended apps, relevant content based on context, etc.), starting and/or ending an app (e.g. maps app, exercise app, purchase app [e.g. Amazon, etc.], etc.), activating and/or modifying and/or deactivating a device setting (e.g. volume, screen brightness, etc.) and/or service (e.g. WiFi, Bluetooth, NFC, etc.), and/or taking any other action in response to user history.

In various embodiments, the user history may be aggregated periodically (e.g. once per month, placed in an archival directory, etc.) and/or aggregated continuously (e.g. real time archival of history, etc.). In other embodiments, the user history may be reviewed by the user or another user (e.g. manager, etc.) periodically (e.g. monthly report, etc.), manually (e.g. as requested by the user and/or another user, etc.), automatically (e.g. after each browsing session, as part of the shut-down and/or log off process of the device, etc.), and/or in any other manner.

As an example, in one embodiment, the user may frequently go to a site (e.g. Amazon, etc.), select a product, do a price-check (e.g. via Google, etc.) to see if the price is good, consider buying the product used versus new (e.g. consider shipping charges, consider reduced price of product, consider reputation of third party seller, etc.), and after making the final decision, buying the product and having the product shipped to the user. In various embodiments, such actions may be saved to an instruction and implemented automatically (e.g. product text inputted in search field of Amazon.com, etc.), manually (e.g. voice command, shortcut button, etc.), and/or in any other manner. In another embodiment, in response to the actions of the user (e.g. selecting a product, price-checking, etc.), the mobile device may display relevant content automatically (e.g. on locked-screen, on pull down screen, etc.), after receiving an approval from the user (e.g. “You recently searched for X. Would you like to receive relevant related content?,” etc.), manually (e.g. voice command, shortcut button, etc.), and/or in any other manner.

In various embodiments, a trigger may include an alarm and/or reminder 49-450, including playing an audio (e.g. music clip, etc.), showing a visual (e.g. flashing light, etc.), making a movement (e.g. vibrate the user's mobile device, etc.), communicating with another device (e.g. turn on television, turn on lights, etc.), and/or any other item which may be associated with an alarm and/or reminder. In some embodiments, an alarm and/or reminder may trigger one or more actions, including controlling in some manner the user's mobile device (e.g. increase/decrease volume and/or screen brightness, refresh content on locked screen, etc.), controlling in some manner an application associated with the mobile device (e.g. start and/or display a news app, a game puzzle app, etc.), controlling in some manner another device (e.g. another mobile device, television, secondary display, lights, smart appliance, etc.), and/or taking any other action in response to an alarm and/or reminder.

As an example, in one embodiment, the user may have a wake-up alarm that goes off at 6 am every morning. After the alarm has gone off, the user may turn on a light, turn on the television to get the latest news, check any email received on the user's mobile device, and check road traffic conditions. Rather than perform each action separately, the user may save such actions to an instruction and execute the instruction automatically (e.g. when the alarm goes off, etc.), manually (e.g. voice command, shortcut button, etc.), and/or in any other manner. In another embodiment, the mobile device may recognize the one or more actions performed by the user, and in response, prompt the user to save the instructions (e.g. as a string of commands, etc.).

In another embodiment, a trigger may include a shortcut 49-452, including a voice command, a displayed button (e.g. on a homescreen, on a menu, etc.), a gesture (e.g. swipe, a predetermined motion, etc.), a physical button (e.g. on the mobile device, etc.) or combination of two or more physical buttons, and/or any other function or item which may execute a string of one or more commands. In some embodiments, a shortcut may trigger one or more actions, including executing a saved set of commands and/or actions, controlling in some manner the mobile device, controlling in some manner one or more applications associated with the mobile device, and/or taking action in response to the shortcut. Each of the foregoing descriptions relating to FIG. 49-4 may each be associated with a shortcut. Of course, a shortcut may be applied to any further embodiment not disclosed herein.

In another embodiment, a trigger may include a request 49-454. In various embodiments, a request may include receiving a request from a network (e.g. WiFi, cellular carrier data network, cellular carrier voice network, etc.), a request from another device (e.g. secondary device, another mobile device, smart appliance, secondary display, etc.), a request from one or more applications (e.g. request for information, request for permission, request to control in at least some manner the mobile device or another device associated with the user, etc.), a request from one or more contacts (e.g. social media site contact, trusted contact, etc.), a request from a location (e.g. brick and mortar store, etc.), and/or from any other location and/or item which may provide a request.

In some embodiments, a request may trigger one or more actions, including granting and/or denying and/or modifying one or more permissions, downloading and/or installing an app, displaying content (e.g. ad, photo, video, text, interactive graphic, ticket, security credentials, etc.), starting an application, performing a function (e.g. complete a sale and/or transaction, etc.), verifying the identity of the user (e.g. via photo id, wireless handshake protocols, etc.), and/or taking any other action in response to the request.

As an example, when a user is at an airport, many requests may be made, including a request to transfer electronic luggage verification tabs (e.g. as a result of checking in baggage, etc.) to the user's mobile device from the personnel's computer, a request to display a boarding pass ticket, a request to display some form of identification, and a request to push updated gate change information to the device. Rather than accept and/or interact with each of the requests separately and individually, the user may choose to create an instruction (e.g. commands to accept multiple requests, etc.). In various embodiments, the instruction may be permanently saved (e.g. to a local cache, to an online database of instructions, etc.), may be temporarily saved (e.g. valid for only a set period of time, valid for only while the user is at a set location, valid for only requests made from airport personnel, etc.). After executing the saved instruction, any request made while the user is at the airport may be accepted and/or cause another function (e.g. string of commands, actions, etc.) to be performed.

In a separate embodiment, when a user is at a movie theater, the user may seek to buy a ticket using the user's mobile device. A request may be made from a device associated with the ticket teller to the user's mobile device to complete the transaction. After completing the transaction, a request may be made at the door for the user to display the ticket purchased. Additionally, while at the movie theater, a friend of the user may send a request to share a photo taken, and/or interact with the user in some manner. In various embodiments, rather than interact separately and individually with each request, the user may automate the process so that any request made while the user is located at the movie theater may be granted, and/or any request made by movie theater personnel may be granted, and/or any request made by friends located also at the movie theater may be granted. Of course, the user may control the instruction in any manner.

In various embodiments, the user may fully control the instruction, including the duration (e.g. length of time, etc.), the scope (e.g. location, friends, proximity, etc.), the permissions (e.g. ability for trusted personnel to read and/or write and/or edit information, ability for friends to read and/or send information, etc.), and/or any other item which may be associated with controlling in some manner the instruction. In some embodiments, the instruction may be saved to a local cache (e.g. on the user's mobile device, etc.), to an online server and/or database, to a cache associated with another device (e.g. secondary device, attached storage, etc.), and/or to any item, system, and/or environment where an instruction may be saved. In other embodiments, after an instruction has been created, a user may modify an instruction, including adding and/or removing triggers and/or actions.

In another embodiment, one or more instructions may be collected and/or organized in an instruction database, including a hierarchal database structure, a relational database, and/or any other type of organized database system. In various embodiments, the one or more instructions may be displayed in a drop-down menu format (e.g. list box, etc.), a hierarchal format, organized into groups and/or page elements, and/or structured in any manner.

In various embodiments, the one or more instructions may be further controlled, including modifying a time of applicability (e.g. when I hang out with my friends, only when I am alone, etc.), associating it with a schedule (e.g. 6-9 am daily, month of September, at 10 am today for my appointment, always, etc.), associating it with a context (e.g. location, time, participants, etc.), and/or taking any other action to control at least in part the one or more instructions. Of course, in other embodiments, the instructions may be further controlled by applying one or more additional triggers (e.g. time of applicability trigger, schedule trigger, context trigger, etc.).

In one embodiment, the one or more instructions may be recorded and/or created and/or modified on the user's mobile device. In another embodiment, the one or more instructions may be sent by another user and/or device. For example, in one embodiment, the user may have created an instruction which takes photos taken in the last week, compiles them into a photo newsletter, and emails it out to everyone designated in contacts as a favorite. The user may send (e.g. via email, via a link, via bumping the two devices, via Bluetooth, via physical cord, etc.) the instruction to another contact, and/or receive an instruction from another entity in a similar manner.

In a further embodiment, one or more instructions may be selected and/or downloaded from a service, server, and/or online database. For example, in one embodiment, a collection of instructions may be found on an online service. The user may navigate to the online service (e.g. via a website address, etc.) and may select one or more instructions organized by category, by function, by apps used, and/or organized in any manner. In various embodiments, the instructions may be sent to the user's mobile device, including downloading (e.g. from a website, etc.), pushing (e.g. from online service, etc.), synching (e.g. instructions management app on mobile device, etc.), and/or receiving the instruction in some manner on the user's mobile device.

FIG. 49-5 shows a method 49-500 for saving one or more instructions with a mobile device, in accordance with another embodiment. As an option, the method 49-500 may be implemented in the context of the architecture and environment of the previous Figures and/or any subsequent Figure(s). Of course, however, the method 49-500 may be implemented in the context of any desired environment. It should also be noted that the aforementioned definitions may apply during the present description.

As shown, one or more triggers are identified. See operation 49-502. In various embodiments, the one or more triggers may be identified using an input (e.g. screen surface input, microphone, multi-touch sensor, proximity sensor, vision-based commands and/or guidance, etc.), a sensor associated with the user's mobile device (e.g. GPS, accelerometer, NFC, gyroscope, temperature, magnetometer, barometer, altimeter, etc.), and/or by any other method. In one embodiment, the one or more triggers may be identified through a continuous (e.g. continuous motion and/or input, continuous menu selection, etc.) and/or near continuous (e.g. touching sequence includes a pause, wait for app to respond, wait for page load, etc.) process and/or motion. In a separate embodiment, the one or more triggers may be identified through a non-continuous process and/or motion. For example, in one embodiment, the trigger may include a context awareness (e.g. location, etc.), an action by the user (e.g. start social networking app, etc.), and a new photo to have been taken, each of which may be identified separately and in a non-continuous manner, before an instruction is triggered to upload a new photo with geotag metadata to a social networking site.

In one embodiment, the triggers may be inputted and/or collected at any time (e.g. whenever the user is using the mobile device, etc.). In other embodiments, the triggers may be inputted and/or collected based on an input and/or recording designation. For example, in one embodiment, the user may open an instruction app and select a “record now” option to record one or more triggers and/or actions. In other embodiments, the user may give a voice command “record now” to record one or more triggers and/or actions. Of course, the one or more triggers and/or actions may be recorded in any manner, and in response to any action and/or input.

Additionally, the one or more triggers may be processed. See operation 49-504. For example, in various embodiments, the one or more triggers may be processed using a processor on the user's mobile device, using a carrier network (e.g. trigger actions and/or metadata identified by the carrier, etc.), using an online service (e.g. trigger actions and/or metadata identified by an online service, etc.), and/or using any other type of network and/or service whereby the one or more triggers may be processed.

As shown, it is determined whether a threshold has been passed. See determination 49-506. In one embodiment, a threshold may include requiring a minimum amount of actions and/or triggers (e.g. at least four input actions from the user, etc.). In another embodiment, a threshold may relate to creating and/or recording new instructions. For example, in one embodiment, a trigger may include one action of the user opening up an application. In response to the trigger, a saved instruction may include taking one or more actions, including setting power usage profiles (e.g. conserve battery, etc.), setting a volume level (e.g. mute, etc.), and/or taking any other action. In contrast, in another embodiment, a user may give an input of at least four actions (e.g. open gallery, select one or more photos, select to share photos, select recipients, etc.), and based off of the four actions, a threshold may be passed (e.g. minimum three actions, etc.) whereupon the user's mobile device may prompt the user to save the actions to an instruction, look up an instruction based on the actions, and/or take any other action in response to the set of input actions.

If it is determined that a threshold has been passed, it is determined whether the one or more triggers match an existing instruction. See determination 49-508. For example, in various embodiments, the triggers may be compared to saved instructions on the user's mobile device (e.g. associated with instructions app, saved in local cache, etc.), on an online server system (e.g. online database, online service, online server, etc.), on another device (e.g. within a near geographic proximity to the user, from a trusted source, etc.), and/or on any platform, device, and/or system.

As shown, if a match is found, an instruction match is presented. See operation 49-510. For example, in various embodiments, an instruction match may be presented by a separate GUI (graphical user interface), a screen overlay, a pop-up box, may be visual, textual, and/or audible, and/or be presented in any manner. In one embodiment, an exact match of triggers may be displayed with a list of accompanying actions taken in response to the one or more triggers. In another embodiment, a match of instructions including at least the one or more triggers used may be displayed. For example, in one embodiment, the user may have recorded one or more triggers, including enabling the GPS, starting a map application, and displaying a map overlay of friends nearby. In response to such triggers, a match (or list of matches) may be displayed to the user including instructions which include the detected triggers as well as other triggers, such as selecting friends designated as favorite, and selecting friends that are within a proximity of 4 miles. The instruction may include one or more actions, including inviting friends (e.g. via each contact's preferred method of contact [email, SMS, chat], etc.), and posting an update on Facebook (e.g. regarding a status update, etc.). Of course, the foregoing example is only one embodiment of a match. A match may be composed of any triggers and/or actions.

In one embodiment, a user may control how a match (or list of matches) is displayed, including applying filters and/or restrictions (e.g. display only exact trigger matches, display top five most popular trigger matches, etc.), controlling the manner of the display (e.g. fill entire screen, notification in notification bar, text and/or audible notification, etc.), automating at least one aspect of the match (e.g. post update of instruction to a site, etc.), and/or taking any other action to control at least an aspect of a match (or list of matches).

As shown, it is determined whether a user accepts the presented instruction match. See determination 49-512. In various embodiments, the instruction match may be accepted by selecting a button (e.g. physical button, screen button, etc.), giving a voice command (e.g. “accept,” etc.), exceeding a time threshold (e.g. 10 seconds, etc.), applying an automatic function (e.g. automatic acceptance based on whether exact trigger match is determined, automatic acceptance based on ratings of the match by one or more friends, etc.), giving a gesture (e.g. swipe motion, etc.) and/or movement (e.g. shake device, etc.), and/or giving any other input to indicate acceptance of the presented instruction.

If it the user does not accept the instruction match, or if the one or more triggers do not match an instruction, a create new instruction page is displayed. See operation 49-514. In one embodiment, the create new instruction page may be associated with the mobile device (e.g. associated with an installed app, etc.). In another embodiment, the create new instruction page may be a website, a portal to an online website, and/or associated with an online service. In one embodiment, tools may be presented to the user to create a new instruction. For example, in various embodiments, tools may include pre-inputted triggers and/or actions, an ability to input a custom (e.g. not before inputted, etc.) trigger and/or action, and/or any other tool which may facilitate creating a new instruction. In one embodiment, recommended triggers and/or actions may be presented to the user.

For example, in one embodiment, a user may input one or more triggers, including starting a gallery application, selecting photos, and applying a filter to all photos (e.g. b&w, saturation level, brightness, etc.). Based on such triggers, an instruction match may not be found (or a found instruction match may be rejected), whereupon a create new instruction page may be presented to the user, which may include the detected triggers, recommended additional one or more triggers, potential one or more actions, recommended instructions (e.g. a set of one or more recommended triggers and/or actions), and/or any other element which may facilitate the creation of a new instruction. The recommended one or more triggers and/or the one or more actions may include a recommendation to select one or more contacts as recipients of the selected photos, upload the selected photos to a social networking site (e.g. Facebook, etc.), back up the photos to a digital archive (e.g. Dropbox.com, etc.), send a multimedia message (e.g. text with image, etc.) to one or more recipients, and/or taking any further action. Alternatively, a recommended instruction may be presented based on the inputted triggers, with an additional trigger of selecting to share the photos, and based off of the combined set of triggers, taking action including sharing the photos with family (e.g. via email, etc.), uploading the photos to a personal blog, and archiving them on an online data storage site. Of course, in one embodiment, the user of the mobile device may combine one or more triggers and/or actions as desired, and/or may select any recommended instruction.

In a further embodiment, the create new instruction page may include the ability to drag and drop the one or more triggers and actions, to interact with one or more widgets (e.g. trigger widget, action widget, etc.), an ability to run and/or see a preview of the instruction, to select and/or deselect elements (e.g. triggers, actions, etc.) from a list, to select and/or deselect one or more hyperlinks (e.g. relating to a trigger, action, etc.), and/or further interact with the create new instruction page in any manner.

As shown, after creating a new instruction (or accepting a presented instruction match), the instruction may be displayed. See operation 49-516. In various embodiments, the instruction may be displayed on a GUI, a separate page and/or pane, by text (e.g. textual description of the one or more triggers and actions, etc.), by graphic (e.g. graphic of the one or more triggers and actions, etc.), in a flowchart format (e.g. input order of triggers leading to execution order of actions, etc.), and/or in any other manner. In some embodiments, the instruction may be displayed with interactive elements (e.g. ability to modify and/or change the one or more triggers and/or actions, etc.) and/or may be displayed in a static manner (e.g. no input permitted).

It is determined whether to modify the instruction. See determination 49-518. For example, in various embodiments, the user may specify the run times (e.g. only at night, only when I take photos, etc.), format (e.g. color, position, etc.), notifications (e.g. text, audible, frequency, ringtone, etc.), additional rules (e.g. do not run if I am driving, do not run if another instruction is being run, etc.), and/or any further information and/or features which may relate in some manner to the instruction. In various embodiments, input on whether to modify the instruction (e.g. yes, no, etc.) may be received by a touch sensor, a voice command, a physical button (e.g. on the device, etc.), and/or in any other manner.

As shown, if it determined to not modify the instruction, the instruction may be saved. See operation 49-520. In one embodiment, the instruction may be permanently saved, including saving it to a local cache (e.g. associated with the user's mobile device, associated with an app, etc.), to an online database (e.g. online instruction database, online data backup, online instruction service, online server, etc.), to another device (e.g. associated with a trusted contact of the user, etc.), and/or to any other storage medium. In other embodiments, the saving of the instruction may be associated with an app (e.g. product specific app, instruction app, etc.), a native utility on the device (e.g. native app, native OS Platform, etc.), and/or any other feature on a mobile device. In another embodiment, the instruction may be saved to a shortcut (e.g. graphic and/or icon, text hyperlink, touch button, device button, etc.), to a gesture, and/or to any other element associated with the mobile device which may execute the instruction.

In one embodiment, the user may opt to classify all triggers as actions and save such actions to a shortcut (e.g. button, gesture, voice command, etc.). In another embodiment, the user may opt to retain one or more triggers (e.g. input from the user, etc.) which may then cause one or more actions to be executed.

Further, the instruction may be executed. See operation 49-522. In one embodiment, after creating and/or saving the instruction, the mobile device may prompt the user whether it is desired to execute and/or run the instruction immediately. In other embodiments, the instruction may be executed in response to a shortcut (e.g. a button, a gesture, a voice command, etc.), and/or in response to the saved one or more triggers.

As an example, in one embodiment, a user may give a voice command (e.g. “run photo instruction #1,” etc.), tap and/or press a button (e.g. on a screen associated with the mobile device, physical button on mobile device, etc.), give a preconfigured motion and/or gesture (e.g. a swipe, etc.), and/or select any other item which has been preconfigured to execute one or more instructions. In such an embodiment, the preconfigured item, or combination of items (e.g. voice command, button, motion, etc.) may be saved as the sole trigger associated with the instruction. In a separate embodiment, an instruction (e.g. associated with a shortcut, etc.) may be set to be executed on a set basis (e.g. run every other Friday, every night, etc.). Of course, in other embodiments, an instruction may be set to any other automatic configuration and/or setting.

Additionally, in another embodiment, a user may give one or more triggers to execute the instruction. For example, the user may create a calendar event, including inputting an event time, time, and location. The user may then choose to share the event with a group of contacts (e.g. work clients, etc.). Based off of such inputs, an instruction prompt may be displayed on the screen (e.g. “Would you like to run Share Work Event Instruction,” etc.). If the user chooses to accept the prompt, an instruction may be run including fetching a map based off of the location, creating an e-invite, sending the e-invite to preselected recipients, monitoring responses from the recipients (e.g. accept, do not accept, etc.), and compiling a feedback response (e.g. to be presented to the user in the form of an email, etc.). Of course, the foregoing example is only one example of a set of triggers executing an instruction and subsequent actions associated with the instruction. Any combination of one or more triggers and/or one or more actions may be saved to an instruction.

In another embodiment, an instruction may be received from another device. For example, in one embodiment, a user may push an instruction from a first mobile device to a second mobile device associated with a second user. The second user may configure the mobile device settings to permit pushing instructions, syncing instructions, and/or sharing instructions in any manner. Further, in one embodiment, the instructions pushed from a trusted source may be automatically saved and/or executed on the first mobile device. For example, in one embodiment, the user may have already indicated that a contact was a trusted source, and based on the trustworthiness of the source, the contact may push an instruction (e.g. relating to a clientele management process, etc.) from the contact's mobile device to the user's mobile device. In one embodiment, the pushed instruction may require user input before proceeding (e.g. acceptance to receive instruction, acceptance to execute pushed instruction, etc.). In another embodiment, the pushed instruction may execute automatically after being pushed to the user's mobile device.

FIG. 49-6 shows a method 49-600 for executing one or more instructions with a mobile device, in accordance with another embodiment. As an option, the method 49-600 may be implemented in the context of the architecture and environment of the previous Figures and/or any subsequent Figure(s). Of course, however, the method 49-600 may be implemented in the context of any desired environment. It should also be noted that the aforementioned definitions may apply during the present description.

As shown, it is determined whether an instruction is identified. See determination 49-602. In various embodiments, an instruction (e.g. combination of one or more triggers and one or more actions, etc.) may be identified by one or more triggers (e.g. predetermined one or more input from the user, a shortcut, etc.), an instruction match on the user's mobile device (e.g. saved instruction, app recognizes instruction, etc.), an instruction match on an online site (e.g. online instruction database, online instruction service, etc.), an instruction match on another device associated with the user (e.g. trusted device in close proximity to the user, etc.), and/or by any other method.

If it is determined that an instruction is identified, it is determined whether the settings and/or device permit executing the instruction. See determination 49-604. For example, in various embodiments, the settings and/or device may include settings relating to time, location, and/or people involved (e.g. do not run “Fred Instruction” if Fred is near, etc.), a battery status (e.g. do not run if less than 20% battery, etc.), a storage amount (e.g. do not run if less than 2 gb storage space, etc.), a data amount (e.g. restrict use of uploading photos while on carrier network, do not transfer data files over 200 mb, etc.), a permission (e.g. to execute instructions from trusted contacts, etc.), verifying an instruction source (e.g. instruction downloaded from an online source, instruction received from another device, etc.), a data transfer rate (e.g. only transfer using WiFi, only transfer if rate is greater than 1 mb/sec, etc.) and/or configuring any other setting associated with one or more instructions.

If it is determined that the settings and/or device permit executing the instruction, it is determined whether there is sufficient data bandwidth. See determination 49-606. For example, in various embodiments, sufficient data bandwidth may include a data transfer rate (e.g. minimum of 2 mb/sec, etc.), a sufficient amount of available data usage (e.g. based on data plan associated with the mobile device, etc.), a preferred network type (e.g. no data transfer while roaming, etc.), and/or any further item associated with data bandwidth.

If it is determined that there is sufficient data bandwidth, it is determined whether the instruction is trusted. See determination 49-608. For example, in various embodiments, determining whether the instruction is trusted may include verifying an instruction source (e.g. device, contact, etc.) and/or an instruction author (e.g. creator of the instruction, etc.), receiving instruction credentials (e.g. name and/or password, etc.), engaging in a security handshake (e.g. cryptographic protocol compliance, etc.), ensuring that the instruction is virus free (e.g. no viruses, worms, and/or malicious content, etc.) and/or any other item which may establish whether the instruction is to be trusted.

In another embodiment, an instruction may be verified using an instruction trustworthy app (e.g. virus scan app, Norton, etc.) associated with the instruction (or the device, or the app responsible for the instruction, etc.). In one embodiment, notwithstanding the lack of trust associated with an instruction, a user may still choose to execute and run an instruction by labeling an instruction as being trustworthy (e.g. “The source of this instruction is not trustworthy. Would you like to override the current settings and execute the instruction?,” etc.). In another embodiment, in order to override a lack of trust associated with an instruction, a user may need to input a device administrator password and/or further authenticate in some manner to prevent any malicious activity. In such an embodiment, overriding a lack of trust may thereby reclassify the instruction as being a trusted instruction.

If it is determined that the instruction is trusted, it is determined whether the instruction is compliant with a polling period. See determination 49-610. For example, in various embodiments, a polling period may include periodically syncing (e.g. every 15 minutes, etc.) new and/or modified instructions (e.g. with an online database, etc.), periodically running (e.g. every 15 minutes, etc.) one or more instructions (e.g. a shortcut to an instruction including one or more triggers [shortcut button] and one or more actions, etc.), waiting for one or more triggers to complete (e.g. a trigger may be receipt of a new email and/or news article, etc.), and/or any other element which may relate to complying with a polling period. As an example, in one embodiment, the user may indicate that an instruction may relate to gathering the latest RSS feeds, filtering such RSS feeds by only including updates relating to cellular phone technology, and compiling such feeds into a report. The user may also indicate (e.g. as metadata associated with the instruction, as a polling period setting, etc.) that the instruction is to be run once a day at 6 pm. Of course, the polling period may relate to any time period and/or frequency.

As shown, if it is determined that the instruction is compliant with a polling period, the instructions may be executed. See operation 49-612. Of course, determinations 49-602-49-610 may occur simultaneously, in any order, and/or in any other manner.

FIG. 49-7 shows a method 49-700 for executing one or more instructions with a mobile device, in accordance with another embodiment. As an option, the method 49-700 may be implemented in the context of the architecture and environment of the previous Figures and/or any subsequent Figure(s). Of course, however, the method 49-700 may be implemented in the context of any desired environment. It should also be noted that the aforementioned definitions may apply during the present description.

As shown, an instruction may be viewed. See operation 49-702. In various embodiments, an instruction may be viewed on the user's mobile device, including viewing one or more instructions on an app (e.g. instruction store app, etc.), through an online portal (e.g. website, web portal, etc.), and/or through any portal and/or app which provides access (e.g. ability to view and/or download, etc.) to one or more instructions. In one embodiment, the user may view instructions associated with the user (e.g. previously downloaded, created instructions, active instructions, etc.). In another embodiment, the user may view new instructions (e.g. instructions not previously downloaded, etc.).

In various embodiments, an instruction store may include categorizations of instructions (e.g. productivity, social networking, calendar management, photo management, etc.). Of course, the instructions may be organized in any manner. In one embodiment, new instructions may be associated with the OS of the user's mobile device, including presenting new instructions as possible OS alterations and/or customizations (e.g. modify manner in which the phone responds based on different one or more triggers, etc.). In another embodiment, new instructions may be associated with a specific app (e.g. Facebook app, Dropbox app, Yelp app, etc.), with a genre of apps (e.g. business productivity apps, client management apps, social networking apps, etc.) which may be managed by a central instruction service (e.g. app platform, OS Native Utility, etc.), and/or with any app and/or item which may execute the one or more instructions.

In a separate embodiment, an instruction may be received via a messaging platform (e.g. SMS, email, chat, etc.). The user may select to save and/or associate the instruction with an installed app (e.g. managed by a specific app, managed by an OS Native Utility, etc.), with an app which may need to be downloaded and/or installed, with the messaging platform app (e.g. instruction is executed from directly within the messaging platform [e.g. email app, SMS app, chat app, etc.], etc.). Of course, new instructions may be viewed on any platform, associated with any app, and/or displayed in any manner.

In a further embodiment, an instruction may be viewed at the request of the user. For example, in various embodiments, the instruction may take an action to view one or more instructions, including browsing an online portal (e.g. instruction site, instruction database, etc.), navigating a specific app (e.g. app associated with a specific business and/or product and/or brick and mortar store, etc.), navigating an instruction store (e.g. instruction management app, etc.), receiving a text and/or chat and/or message (e.g. email, posting response, etc.), and/or taking any other action wherein the user requests to view one or more instructions.

As shown, an instruction may be selected. See operation 49-704. In some embodiments, the selection may include selecting one or more instructions (multiple instructions), combining more than one instruction together into an instruction packet (e.g. of more than one instruction, etc.), mixing and matching desired instructions, and/or taking any other action to select the one or more instructions in some manner.

In one embodiment, the instructions may be selected using the user's mobile device. In other embodiments, the one or more instructions may be selected using another device (e.g. device associated with another entity, a second mobile device, a computer, etc.), a device associated with a physical store (e.g. brick and mortar store, etc.), a device associated with an automobile (e.g. infotainment system console, etc.), and/or any other device which may permit selection of one or more instructions.

As shown, the one or more instructions may be downloaded. See operation 49-706. In one embodiment, the one or more selected instructions may be requested from the user's mobile device and downloaded to the user's mobile device. In other embodiments, the one or more selected instructions may be requested from another device and downloaded to the user's mobile device. In such an embodiment, the user may set trustworthy and/or permission settings associated with contacts, devices, and/or other entities (e.g. brick and mortar store, etc.).

As an example, in one embodiment, an employee of a corporation may be issued a mobile device, which may belong to and be controlled by the company. When instructions (e.g. client management, employee resources, etc.) need to be updated and/or downloaded to each employee's phone, a central app management section (or any person and/or group) may update and/or create an instruction and push (e.g. send to each employee's device to be executed, etc.) such an instruction to each employee's device. Of course, the employee's device may be controlled in any manner (e.g. send any type of instruction to the device, etc.).

Additionally, in other embodiments, the user's mobile device may display a notification of new one or more instructions, including displaying a status of one or more instructions (e.g. “HR Dept installed 2 new automatic executing instructions on your device: Instruction A (client management); Instruction B (employee resource),” etc.), a compliance agreement notification (e.g. “Please select ‘accept’ if you agree to the terms of the new one or more instructions,” etc.), an employee input (e.g. “The downloaded Instruction from HR relates to sales. Would you like to install and/or execute (i.e. make it active) this instruction?,” etc.), and/or any other notification relating to the one or more instructions.

In various embodiments, the user of the mobile device may set and/or control the level of permissions associated with pushing and/or installing one or more instructions on the user's mobile device. For example, in one embodiment, the user may be the sole entity permitted to install and/or execute instructions on the mobile device. In other embodiments, the user may grant permission to a group (e.g. “family” designation in metadata of contact, etc.), a specific entity (e.g. Bob, BestBuy stores, etc.), a location (e.g. instructions pushed from X location, instructions may be pushed while I am present at X location, etc.), a device (e.g. trusted device, established connections with one or more devices, etc.), and/or to any other entity and/or criteria which may relate in some manner to permissions.

In some embodiments, the permission may be complete and/or may be partial. For example, in various embodiments, partial permission may include an ability for another entity to send an instruction to a user's mobile device (e.g. execution may be dependent on the user accepting and/or giving some other approval of the instruction, etc.), to recommend (e.g. Bob recommends “Instruction A.” Would you like to check it out?,” etc.), to send a link to (e.g. within an email, etc.), to push a notification to the user's device (e.g. “Hi. I've been trying out this Instruction. It works great. Let me know if you like it.,” etc.), to push an Instruction to the user's device (e.g. install, download, begin to execute, etc.), and/or to partially interact with the user's mobile device in some manner.

As shown, one or more instructions may be modified. See operation 49-708. In various embodiments, modifying the one or more instructions may include adding and/or deleting a specific trigger and/or action (e.g. as included in the downloaded instruction, etc.), adding and/or deleting a custom trigger and/or action (e.g. an item created by user, etc.), adding metadata to the instruction (e.g. name, creator, date modified, title, etc.), associating the instruction with one or more settings (e.g. time of applicability, permission level required in order to run, data network restriction, polling period, battery status requirement, etc.), and/or taking any further action to modify one or more instructions.

In one embodiment, a time threshold may be applied to modifying the one or more instructions. For example, in one embodiment, if the user does not modify the downloaded instruction within a set time period (e.g. 30 min, etc.), the instruction may be automatically saved and/or implemented (e.g. ready for execution, etc.). In another embodiment, the user may configure device settings such that when an instruction is downloaded, it is automatically saved and implemented (e.g. ready for execution, etc.). Of course, the user may modify the manner in which any automatic settings are applied to an instruction. For example, in some embodiments, the automatic settings may relate to applying a set of predetermined settings (e.g. including permissions, etc.) and/or metadata, interacting with the downloaded instruction to determine if it is safe to use (e.g. virus free, malicious software free, etc.), and/or applying any item (or items) which may be automated.

In another embodiment, modification to an instruction may be made at any time (e.g. after download, after install, after save, after executing, etc.). As an example, in one embodiment, the user may select an instruction and apply (e.g. after it has already been saved and executed, etc.) settings including making modifications to the saved instruction (e.g. actions, triggers, metadata, device settings, etc.). As such, settings and/or modifications relating to an instruction may be made at any period after downloading the instruction.

As shown, an instruction may be saved. See operation 49-710. In one embodiment, the instruction may be permanently saved, including saving it to a local cache (e.g. associated with the user's mobile device, associated with an app, etc.), to an online database (e.g. online instruction database, online data backup, online instruction service, online server, etc.), to another device (e.g. associated with a trusted contact of the user, etc.), and/or to any other storage medium. In other embodiments, the saving of the instruction may be associated with an app (e.g. product specific app, instruction app, etc.), a native utility on the device (e.g. native app, native OS Platform, etc.), and/or any other feature on a mobile device. In another embodiment, the instruction may be saved to a shortcut (e.g. graphic and/or icon, text hyperlink, touch button, device button, etc.), to a gesture, and/or to any other element associated with the mobile device which may execute the instruction.

In one embodiment, the user may opt to classify all triggers as actions and save such actions to a shortcut (e.g. button, gesture, voice command, etc.). In another embodiment, the user may opt to retain one or more triggers (e.g. input from the user, etc.) which may then cause one or more actions to be executed.

Further, the instruction may be executed. See operation 49-712. In one embodiment, after creating and/or saving the instruction, the mobile device may prompt the user whether it is desired to execute and/or run the instruction immediately. In other embodiments, the instruction may be executed in response to a shortcut (e.g. a button, a gesture, a voice command, etc.), and/or in response to the saved one or more triggers.

As an example, in one embodiment, a user may give a voice command (e.g. “run photo instruction #1,” etc.), tap and/or press a button (e.g. on a screen associated with the mobile device, physical button on mobile device, etc.), give a preconfigured motion and/or gesture (e.g. a swipe, etc.), and/or select any other item which has been preconfigured to execute one or more instructions. In such an embodiment, the preconfigured item, or combination of items (e.g. voice command, button, motion, etc.) may be saved as the sole trigger associated with the instruction. In a separate embodiment, an instruction (e.g. associated with a shortcut, etc.) may be set to be executed on a set basis (e.g. run every other Friday, every night, etc.). Of course, in other embodiments, an instruction may be set to any other automatic configuration and/or setting.

Additionally, in another embodiment, a user may give one or more triggers to execute the instruction. For example, the user may create a calendar event, including inputting an event time, time, and location. The user may then choose to share the event with a group of contacts (e.g. work clients, etc.). Based off of such inputs, an instruction prompt may be displayed on the screen (e.g. “Would you like to run Share Work Event Instruction,” etc.). If the user chooses to accept the prompt, an instruction may be run including fetching a map based off of the location, creating an e-invite, sending the e-invite to preselected recipients, monitoring responses from the recipients (e.g. accept, do not accept, etc.), and compiling a feedback response (e.g. to be presented to the user in the form of an email, etc.). Of course, the foregoing example is only one example of a set of triggers executing an instruction and subsequent actions associated with the instruction. Any combination of one or more triggers and/or one or more actions may be saved to an instruction.

FIG. 49-8 shows a method 49-800 for executing one or more instructions with a mobile device, in accordance with another embodiment. As an option, the method 49-800 may be implemented in the context of the architecture and environment of the previous Figures and/or any subsequent Figure(s). Of course, however, the method 49-800 may be implemented in the context of any desired environment. It should also be noted that the aforementioned definitions may apply during the present description.

As shown, an instruction may be received. See operation 49-802. In various embodiments, the instruction may be received from another device (e.g. secondary device, device associated with a trusted contact, device associated with a trusted entity such as a brick and mortar store, etc.), a messaging platform (e.g. email, SMS, chat, social networking messaging platform, etc.), an installed app (e.g. specific app installed on the mobile device, etc.), a network (e.g. WiFi, Bluetooth, etc.), a carrier (e.g. data carrier, mobile phone carrier, etc.), an online portal (e.g. website, web portal, etc.), an instruction store (e.g. instruction database, instruction repository, etc.), an OS platform (e.g. sync updates to device, etc.), a host system (e.g. a system to which the mobile device is physically connected, etc.), and/or from any system from which an instruction may be sent.

In another embodiment, an instruction may be received at the request of another entity (e.g. other than the user of the mobile device, etc.). For example, in various embodiments, the instruction may be received via a notification (e.g. from a contact, from a trusted entity, from a trusted device, etc.) prompting the user to take an action (e.g. view an instruction, download an instruction, etc.), via a message (e.g. email, chat, SMS, etc.), via a link (e.g. HTML link, download location site, etc.), via an attachment (e.g. to a message, etc.), and/or via any communication and/or data sent to the user's mobile device.

In one embodiment, a user may configure settings to enable notification and/or installation of instructions from trusted entities and/or sources. For example, the user may select filters to be applied to incoming notifications (e.g. relating to one or more instructions), including the type (e.g. clientele instructions, productivity instructions, etc.), the complexity (e.g. only permit at most 10 combined triggers and/or actions, etc.), the content (e.g. relating only to cell phone technology, etc.), a keyword (e.g. “AT&T,” etc.), and/or any other filter which may relate in some manner to a notification. In some embodiments, the filters may be applied by an OS Native Utility (e.g. system app, system feature, etc.), an installed app (e.g. app associated with Yelp.com, Dropbox.com, Facebook.com, etc.), and/or by any system and/or feature associated with the user's mobile device. In other embodiments, the user may select to reject all notifications relating to instructions.

In another embodiment, one or more instructions may be received based off of a context associated with the user, including location information (e.g. GPS location information, a physical address, an IP address, shopping center, movie theatre, stadium, etc.), network information (e.g. information associated with the network currently being utilized or currently being accessed, etc.), applications being utilized (e.g. games, maps, camera, retailer, social networking, etc.), current activities (e.g. shopping, walking, eating, reading, driving, etc.), browsing activity (e.g. history, etc.), purchase activity (e.g. history, etc.), environment (e.g. environmental audio, weather, temperature, etc.), payment activities (e.g. just purchased coffee, groceries, clothes, etc.), and/or any other type of information.

As an example, in one embodiment, a user may have researched online how to get to an airport. Additionally, the user may have received an email confirming a flight purchase as well as a hotel reservation. Based on the context of such information, the user may be presented with a notification (e.g. on the device, via messaging platform, etc.) for an instruction (e.g. “Travel Instruction,” etc.) which may including triggers such as receipt of a travel purchase and an event creation in a calendar app, as well as actions including aggregating travel information into one location (e.g. an event page, etc.), fetching and downloading relevant trip information (e.g. maps, public transportation information, etc.), posting a status update on a social networking site, and fetching emergency information (e.g. emergency numbers, headquarter contact info, etc.) for each of the reservations. As such, an instruction may be received at the request of another entity and/or as the result of contextual input.

In a separate embodiment, a user may be located at a restaurant for a lunch appointment, text the lunch appointment participant that the user has arrived, post a status update on a social networking site, and browse the internet searching for reviews of the lunch location and recommended food to eat. Based on the context of such information, the user may be presented with a notification (e.g. on the device, via messaging platform, etc.) of a relevant instruction (e.g. “Lunch Location Instruction,” etc.), which may include triggers such as time (e.g. near lunchtime, etc.), location (e.g. near a restaurant, etc.), a calendar time (e.g. lunch appointment, etc.), as well as actions including texting the one or more participants that you have arrived, providing a real-time update of where other participants are located (e.g. based on permissions as set by the user and the one or more participants, etc.), and fetching and displaying relevant reviews of the location's menu and/or offerings. As such, an instruction may be received at the request of another entity and/or as the result of contextual input.

Additionally, in a further embodiment, the received notification of a relevant instruction may be relevant to one or more inputted triggers (e.g. opening an application, browsing for a keyword, calling a contact, etc.) and/or may be the result of a contextual understanding (e.g. location, time, contacts near, past browsing history, etc.). As such, a notification relating to one or more instructions may be given based on trigger inputs and/or contextual information and/or a request from an entity. Further, in another embodiment, more than one instruction may be given in a notification, including a list of possible relevant instructions (e.g. enable the user to choose from among highly relevant instructions, etc.).

As shown, one or more instructions may be accepted. See operation 49-804. In various embodiments, the instruction match may be accepted by selecting a button (e.g. physical button, screen button, etc.), giving a voice command (e.g. “accept,” etc.), exceeding a time threshold (e.g. 10 seconds, etc.), applying an automatic function (e.g. automatic acceptance based on whether notification source is trusted, automatic acceptance based on ratings of the match by one or more friends, etc.), giving a gesture (e.g. swipe motion, etc.) and/or movement (e.g. shake device, etc.), and/or giving any other input to indicate acceptance of the presented instruction.

In some embodiments, the user may opt to forgo an acceptance step if the instruction passes a trustworthy threshold, including verifying the source of the instruction, the level of popularity of the instruction, the degree of friendship to the source (e.g. distant friend, close friend, etc.), and/or through applying any other test to the instruction associated with a notification.

As shown, one or more instructions may be modified. See operation 49-806. In various embodiments, modifying the one or more instructions may include adding and/or deleting a specific trigger and/or action (e.g. as included in the downloaded instruction, etc.), adding and/or deleting a custom trigger and/or action (e.g. an item created by user, etc.), adding metadata to the instruction (e.g. name, creator, date modified, title, etc.), associating the instruction with one or more settings (e.g. time of applicability, permission level required in order to run, data network restriction, polling period, battery status requirement, etc.), and/or taking any further action to modify one or more instructions.

In one embodiment, a time threshold may be applied to modifying the one or more instructions. For example, in one embodiment, if the user does not modify the downloaded instruction within a set time period (e.g. 30 min, etc.), the instruction may be automatically saved and/or implemented (e.g. ready for execution, etc.). In another embodiment, the user may configure device settings such that when an instruction is downloaded, it is automatically saved and implemented (e.g. ready for execution, etc.). Of course, the user may modify the manner in which any automatic settings are applied to an instruction. For example, in some embodiments, the automatic settings may relate to applying a set of predetermined settings (e.g. including permissions, etc.) and/or metadata, interacting with the downloaded instruction to determine if it is safe to use (e.g. virus free, malicious software free, etc.), and/or applying any item (or items) which may be automated.

In another embodiment, modification to an instruction may be made at any time (e.g. after download, after install, after save, after executing, etc.). As an example, in one embodiment, the user may select an instruction and apply (e.g. after it has already been saved and executed, etc.) settings including making modifications to the saved instruction (e.g. actions, triggers, metadata, device settings, etc.). As such, settings and/or modifications relating to an instruction may be made at any period after downloading the instruction.

As shown, an instruction may be saved. See operation 49-808. In one embodiment, the instruction may be permanently saved, including saving it to a local cache (e.g. associated with the user's mobile device, associated with an app, etc.), to an online database (e.g. online instruction database, online data backup, online instruction service, online server, etc.), to another device (e.g. associated with a trusted contact of the user, etc.), and/or to any other storage medium. In other embodiments, the saving of the instruction may be associated with an app (e.g. product specific app, instruction app, etc.), a native utility on the device (e.g. native app, native OS Platform, etc.), and/or any other feature on a mobile device. In another embodiment, the instruction may be saved to a shortcut (e.g. graphic and/or icon, text hyperlink, touch button, device button, etc.), to a gesture, and/or to any other element associated with the mobile device which may execute the instruction.

In one embodiment, the user may opt to classify all triggers as actions and save such actions to a shortcut (e.g. button, gesture, voice command, etc.). In another embodiment, the user may opt to retain one or more triggers (e.g. input from the user, etc.) which may then cause one or more actions to be executed.

As shown, an instruction may be shared. See operation 49-810. In various embodiments, the instruction may be shared by uploading the instruction to an online database (e.g. instruction store, instruction repository, instruction sharing site, etc.), sending the instruction to a recipient (e.g. contact, entity, via email, via chat, etc.), posting the instruction to a sharing platform (e.g. social networking platform, etc.), sending a link (or any representation of the instruction) to a recipient, beaming the instruction (e.g. via NFC, via Bluetooth, via close proximity data transfer, etc.) to another entity, and/or taking any other action to share the instruction.

As an example, in one embodiment, the user may wish to receive to share an instruction with a friend who is in close proximity to the user. The user may bring the user's mobile device within a close proximity (e.g. within 2 inches, etc.) of another device to transfer the instruction from one device to another (e.g. via NFC, via WiFi direct, etc.). In another embodiment, a user may be engaging in a conversation with a friend via a chat application. Using such an application, the user may share an instruction by sending a package (e.g. of the instruction with metadata and settings, etc.) to the friend. Of course, the instruction may be transferred in any manner.

Further, the instruction may be executed. See operation 49-812. In one embodiment, after creating and/or saving the instruction, the mobile device may prompt the user whether it is desired to execute and/or run the instruction immediately. In other embodiments, the instruction may be executed in response to a shortcut (e.g. a button, a gesture, a voice command, etc.), and/or in response to the saved one or more triggers.

As an example, in one embodiment, a user may give a voice command (e.g. “run photo instruction #1,” etc.), tap and/or press a button (e.g. on a screen associated with the mobile device, physical button on mobile device, etc.), give a preconfigured motion and/or gesture (e.g. a swipe, etc.), and/or select any other item which has been preconfigured to execute one or more instructions. In such an embodiment, the preconfigured item, or combination of items (e.g. voice command, button, motion, set of commands, etc.) may be saved as the sole trigger associated with the instruction. In a separate embodiment, an instruction (e.g. associated with a shortcut, etc.) may be set to be executed on a set basis (e.g. run every other Friday, every night, etc.). Of course, in other embodiments, an instruction may be set to any other automatic configuration and/or setting.

Additionally, in another embodiment, a user may give one or more triggers to execute the instruction. For example, the user may create a calendar event, including inputting an event time, time, and location. The user may then choose to share the event with a group of contacts (e.g. work clients, etc.). Based off of such inputs, an already saved instruction may be displayed on the screen (e.g. “Would you like to run Share Work Event Instruction,” etc.). If the user chooses to accept the prompt, an instruction may be run including fetching a map based off of the location, creating an e-invite, sending the e-invite to preselected recipients, monitoring responses from the recipients (e.g. accept, do not accept, etc.), and compiling a feedback response (e.g. to be presented to the user in the form of an email, etc.). Of course, the foregoing example is only one example of a set of triggers executing an instruction and subsequent actions associated with the instruction. Any combination of one or more triggers and/or one or more actions may be saved to an instruction.

FIG. 49-9 shows a mobile device interface 49-900 for receiving one or more triggers, in accordance with another embodiment. As an option, the mobile device interface 49-900 may be implemented in the context of the architecture and environment of the previous Figures and/or any subsequent Figure(s). Of course, however, the mobile device interface 49-900 may be implemented in the context of any desired environment. It should also be noted that the aforementioned definitions may apply during the present description.

As shown, a mobile device interface display 49-902 may be displayed. In various embodiments, a mobile device interface display may include a homescreen, a locked screen, a screen saver, a pull down display, a secondary display (e.g. external, secondary device, etc.), and/or any other type of display which may be associated with the mobile device. Additionally, an application may be selected 49-904. In one embodiment, the application may include a photo management app, a camera, a calendar, a map, a weather app, a notes app, a reminders app, a settings app, a phone app, a mail app, a music app, a browser app, and/or any app which may be capable of being selected.

In one embodiment, if a photos app is selected, a display of one or more albums 49-906 may be presented to the user. In one embodiment, the displayed albums may include albums synced with an online server (e.g. picasa albums, facebook albums, flickr albums, etc.), stock albums (e.g. provided by the operating system, an application, an online server, etc.), context-sensitive albums (e.g. automatic organization of photos based off of metadata such as year, location, etc.), and/or any type of album organization. Of course, in other embodiments, the user may define one or more albums and may manually add photos to the created one or more albums, and/or create a rule to add photos to the created one or more albums.

In various embodiments, the albums may be arranged according to one or more selected criteria (e.g. rules, alphabetical, location, date, etc.). In some embodiments, the display of one or more albums may include one or more tabs (e.g. alphabetical, location, date, people, etc.), a drop down menu, a hierarchal menu display, and/or any other item whereby the albums may be filtered and/or arranged.

As shown, an album may be selected 49-908, and a display 49-910 showing the photos associated with the album may be displayed. In various embodiments, an album may be selected by touching an icon (e.g. an album icon, etc.) on a screen and/or display, giving a voice command (e.g. “open camera roll,” etc.), moving the mobile device in some manner (e.g. two forward movements selects the icon, a movement right or left selects a different icon, etc.), receiving an input from another device (e.g. secondary mobile device, keyboard, mouse, etc.), and/or receiving any other type of input wherein an album may be selected.

In one embodiment, the display showing the photos associated with the album may include one or more options. In various embodiments, the one or more options may include an ability to create an instruction, to select one or more photos, to categorize and/or arrange the photos in some manner, to share one or more photos and/or albums, and/or to interact with the photos and/or album in some manner.

As shown, the option to select one or more photos may be selected 49-912, and a display 49-914 showing the one or more selected photos may be displayed. In various embodiments, one or more photos may be selected, including individually selecting (e.g. by touching, giving voice command, using secondary device, etc.) each photo, selecting photos based on the trace path of the input (e.g. finger, stylus, etc.), selecting a metadata criteria (e.g. data, location, people included, etc.), selecting a recommendation from a contact (e.g. photos selected by a contact associated with a shared online album, etc.), selecting a recommendation from the mobile device (e.g. based on relevancy and/or context, from the app, from the operating system, etc.), selecting a popularity vote (e.g. associated with an online and/or shared album, etc.), and/or selecting any other item which may be associated with selecting one or more photos. In one embodiment, the trace path may be continuous (e.g. continuous input motion, one input path, etc.), or non-continuous (e.g. multiple input paths, broken input path, etc.).

Additionally, the trace path may be located on one page (e.g. one display screen) and/or on more than one page (e.g. multiple screens, tabbed screens, scrollable screen, etc.). In one embodiment, various methods may be utilized to select and/or navigate the one or more displays associated with the mobile device, including using a predetermined input to scroll (e.g. two fingers sliding up, etc.), a predetermined input to select (e.g. one finger slide and/or selection, etc.), a predetermined input to switch to an additional tab and/or additional album (e.g. two finger slide to the side, etc.), and/or using any other predetermined input to navigate the one or more displays associated with the mobile device and/or select the one or more photos.

In one or more embodiments, options may be shown which are associated with the selected one or more photos, including an ability to share (e.g. email, upload to online server and/or service, upload to blog, upload to social networking site, etc.), copy, delete, filter (e.g. use selected photos to select other like photos, etc.), edit (e.g. batch edit of photos, etc.), create one or more albums (e.g. of the selected photo(s), etc.), combine (e.g. create montage, etc.), create one or more photo books (e.g. through online server and/or service, through another app associated with the mobile device, etc.), to interact with any other app (e.g. associated with the mobile device, etc.) and/or take any other action which may relate to the one or more selected photos. Of course, after selecting one or more photos, the selected one or more photos may be deselected using a predetermined input (e.g. select the same photo twice, etc.).

FIG. 49-10 shows a mobile device interface 49-1000 for receiving one or more triggers, in accordance with another embodiment. As an option, the mobile device interface 49-1000 may be implemented in the context of the architecture and environment of the previous Figures and/or any subsequent Figure(s). Of course, however, the mobile device interface 49-1000 may be implemented in the context of any desired environment. It should also be noted that the aforementioned definitions may apply during the present description.

As shown, interface 49-914 is displayed. A filter option may be selected 49-1002 and a photo filter display 49-1004 may be shown. In various embodiments, a filter option may be selected by an input (e.g. finger, stylus, secondary device, mouse, keyboard, etc.), by a voice command (e.g. “select filter,” etc.), and/or in any other manner. In other embodiments, a photo filter display may include filters such as ability to control the contrast, brightness, saturation, color, and/or white balance, ability to crop, to change the photo to black & white, to rotate, to apply a scene mode (e.g. landscape, night, portrait, sunset, backlit, etc.), to apply a border, to insert a caption and/or other modifications (e.g. custom photo edits, etc.), and/or to take any other action to filter the selected one or more photos in some manner.

In various embodiments, a share option associated with the selected one or more photos may be selected 49-1006. In some embodiments, the share option may be selected before or after the photo filters are applied, and/or may be selected at any time after the one or more photos have been selected. An interface 49-1008 associated with the share option may be displayed and may include ability to share the selected one or more photos by email, to Facebook (e.g. upload and/or post, etc.), to Dropbox (e.g. backup photos, etc.), to a blog (e.g. public or private, etc.), to an online storage site, to an online social media site, to another detected device (e.g. sent via WiFi, sent via NFC, sent via Bluetooth, etc.), and/or to any other destination selected by the user of the mobile device.

In another embodiment, the option to email the selected one or more photos may be selected 49-1010 and an interface 49-1012 associated with the option to email may be displayed. In various embodiments, possible destinations may include one or more contacts and/or groups. In some embodiments, the recipients may be preselected (e.g. associated with a group, commonly selected list of contacts based off of frequency of selection, etc.), associated and/or organized with one or more groups (e.g. based off of tags associated with the individuals, etc.), organized according to a recommendation by a contact, and/or organized in any other manner. In other embodiments, the recipients may be individually selected and/or managed (e.g. added to email, deleted from email, etc.).

After selecting the one or more possible destinations and/or recipients, the user may select “send” to send the photos to the selected destinations (e.g. contacts, groups, etc.). In some embodiments, the photos may be reduced in size (e.g. decreased resolution, etc.) and/or modified in another manner to optimize being sent. Of course, in another embodiment, the original photo(s) may be sent without any modification. In another embodiment, the one or more selected photos may be sent in multiple emails (e.g. batch of emails, etc.) based on a message size (e.g. maximum message size limited by application, etc.), a number of attachments (e.g. no more than 15 attachments per email, etc.), and/or any other criteria which may affect the one or more emails being sent.

In other embodiments, the email may be sent based off of one or more context sensors, including a location (e.g. send email when user is at home, etc.), a network (e.g. send only when connected to WiFi, etc.), one or more devices (e.g. send email when user is within a set geographic threshold to another contact's device, send email when user is within a set geographic threshold to a secondary device, etc.), a time (e.g. a minimum of five minutes at a location before sending the email, send email at 8 pm, etc.), and/or any other context aware criteria.

FIG. 49-11 shows a mobile device interface 49-1100 for creating one or more instructions, in accordance with another embodiment. As an option, the mobile device interface 49-1100 may be implemented in the context of the architecture and environment of the previous Figures and/or any subsequent Figure(s). Of course, however, the mobile device interface 49-1100 may be implemented in the context of any desired environment. It should also be noted that the aforementioned definitions may apply during the present description.

As shown, interface 49-1012 associated with the option to email may be displayed. A group of contacts may be selected 49-1102. In response to the selection 49-1102, a trigger threshold interface 49-1104 may be displayed.

In one embodiment, a trigger threshold may be displayed based on the number of consecutive actions (e.g. within a set time period, e.g. 30 seconds, between each action, etc.) by the user. For example, in one embodiment, the user may open a photo application, select an album, select one or more photos, apply one or more filters to the selected photos, select to share the selected photos via email, and select one or more recipients. In one embodiment, a minimum threshold (e.g. predetermined and/or selected by the user and/or the app, etc.) of six actions may cause a trigger threshold to be displayed. In various embodiments, exceeding a trigger threshold may cause a prompt to be displayed including a prompt to save such detected actions to an instruction, look up an instruction based on the actions, and/or take any other action in response to the set of input actions.

In one embodiment, the user may choose to ignore the trigger instruction prompt. Additionally, in another embodiment, the user may select and/or configure settings under the options prompt. In one embodiment, settings found under the options prompt may include the minimum threshold value before a prompt is displayed, actions to be displayed once a trigger threshold has been exceeded, automatic settings (e.g. after 5 continuous actions, automatically show instruction match screen, etc.), permission settings (e.g. receiving and/or sending one or more instructions, etc.), and/or any other feature which may relate in some manner to an instruction. Of course, in other embodiments, the options prompt may relate to global settings (e.g. device settings, user anonymous settings, etc.), user settings (e.g. user specific settings, etc.), and/or any other set of settings relating to a profile, identity, and/or device.

As shown, a “yes” prompt may be selected 49-1106, and a create instruction interface 49-1108 may be displayed. In various embodiments, a create instruction interface may display one or more instruction matches. For example, in one embodiment, the instruction matches may relate in some manner to the identified input actions (e.g. to one or more actions given by the user, etc.). In one embodiment, the user may set a threshold relevancy value (e.g. minimum of two same actions, etc.) that must be met in order for a match to be displayed. Based on one or more camera and/or photo relevant actions, a match may include “Instruction ‘Photo Sharing 1’; Triggers: Open Gallery, Select Photos, Select Share; Actions: Filter Photos, Email to Group, Upload to Blog,” “Instruction ‘Camera Sharing 1’; Triggers: Open Camera, Take Photo; Actions: Email to Group, Upload to Blog and Dropbox,” “Instruction ‘Camera Social Sharing 2’; Triggers: Open Camera, Take Photo; Actions: Upload to Facebook, Post Status on Twitter,” “Instruction ‘Photo Sharing 2’; Triggers: Open Gallery, Select Photos, Select Share; Actions: Email to Group 1, Backup to Dropbox, Send SMS link to Group 2, Upload to Facebook, Post to Twitter,” and/or any other relevant match.

In one embodiment, if a threshold of actions matches an instruction, the instruction may be automatically selected. For example, in one embodiment, the input actions may include opening a gallery, selecting photos, and selecting to share the photos via email and Facebook. A threshold may be configured so that if an instruction includes all of the input actions, it may be automatically selected as the relevant instruction match. In another embodiment, if more than one instruction results after the threshold is exceeded, all such results may be presented to the user for selection.

Additionally, in one embodiment, more than one instruction match may be selected. For example, the user may be interested in possible actions and/or triggers from more than one instruction match (e.g. sharing features of a match, productivity features of another match, etc.). As such, selecting more than one instruction match may enable the user to add, remove, and/or modify the combined instruction in any manner.

In another embodiment, the user may disregard the instruction matches and select to create a new instruction. Additionally, in one embodiment, a create instruction interface may display by default a new instruction interface rather than one or more instruction matches. Of course, the default view of the create instruction interface may be set and/or configured by the user (e.g. via options, via app settings, via Native Utility Platform, etc.).

After selecting the one or more instruction matches, the “proceed” prompt may be selected 49-1110, and a modify instruction interface 49-1112 may be displayed. In various embodiments, the modify instruction interface page may include possible triggers and actions, the ability to add, remove, and/or customize the triggers and/or actions, the ability to specify details (e.g. specify contacts in a group, specify blog details, specify application, etc.) relating to the triggers and/or actions, identify the relevancy (e.g. photo, calendar, contact management, productivity, video, social media, sharing, etc.) of the triggers and/or actions, and/or any other feature which may modify the instruction in some manner.

In one embodiment, actions and/or triggers relating to the selected one or more instructions may be displayed and/or modified. For example, in one embodiment, the relevancy may be automatically set (e.g. based off of the relevancy tag of the one or more instruction matches, etc.), and/or may be set by the user (e.g. via drop down menu, etc.). In another embodiment, upon selection of the relevancy, the triggers and/or actions may change to display a set of relevant triggers and/or actions. After the relevant triggers and/or actions are displayed, items relevant to the selected one or more instruction matches may be pre-selected. Additionally, if an item included with the one or more instruction matches is not included with the relevant triggers and/or actions, it may be added to the list of triggers and/or actions. In a further embodiment, a custom trigger and/or action may be added and/or deleted, including inserting a trigger and/or action not associated with the relevant triggers/actions (e.g. an item associated with productivity, etc.), creating a new trigger and/or action not associated with any previously created trigger and/or action, and/or adding any item not already listed with the relevant triggers and/or actions.

In some embodiments, a photo relevancy may display photo relevant triggers, including the ability to open a gallery, select one or more photos, select to share one or more photos, open camera, take picture, select to filter one or more photos, and/or select any other function which may relate to photos. Additionally, in another embodiment, a photo relevancy may display photo relevant actions, including the ability to filter photos, email to a group, upload to a blog, backup to Dropbox, send SMS link to a group, upload to Facebook, post to Twitter, and/or select any other action which may relate to photos.

In various embodiments, the modify instruction interface may display one or more options, including the option to add metadata, to add settings, to go back (e.g. to the prior screen and/or interface, etc.), and/or to save. Of course, any option which may relate to the modify instruction interface and/or to navigating the create instruction interface may be displayed. In one embodiment, saving the instruction may include storing the instruction in a local cache on the mobile device, on an online server and/or database, on a local database, and/or on any other device and/or storage hardware. In one embodiment, at the time of saving the instruction, a backup copy of the instruction may be saved in another location. Additionally, in another embodiment, saving the instruction may include sending and/or posting the instruction to an instruction database site to be shared with other users.

FIG. 49-12 shows a mobile device interface 49-1200 for creating one or more instructions, in accordance with another embodiment. As an option, the mobile device interface 49-1200 may be implemented in the context of the architecture and environment of the previous Figures and/or any subsequent Figure(s). Of course, however, the mobile device interface 49-1200 may be implemented in the context of any desired environment. It should also be noted that the aforementioned definitions may apply during the present description.

As shown, modify instruction interface 49-1112 may be displayed and the add metadata prompt may be selected 49-1202. The add metadata interface 49-1203 may be also displayed.

In one embodiment, the add metadata interface may include the ability to insert an instruction title, an author, a location/geotag, a tag (e.g. data content, application content, etc.), a relevancy (e.g. photo, sharing, etc.), applicable apps (e.g. apps which may relate and/or may be included in the instruction, etc.), priority (e.g. high, regular, low, priority with respect to other instructions being executed, etc.), creation date, the ability to import instruction settings as metadata (e.g. settings are also imported as metadata values associated with the instruction, etc.), and/or any other value which may relate to metadata.

In various embodiments, the metadata may be stored internally (e.g. in the same file as the instruction, etc.) and/or externally (e.g. in a separate file other than the instruction, etc.). Additionally, the metadata may be formatted in a human readable format (e.g. XML, etc.) and/or in a non-human readable format (e.g. binary, etc.).

As shown, an add settings option may be selected 49-1206, and an add settings interface 49-1208 may be displayed. In various embodiments, the add settings interface may include global settings, such as permissions (e.g. associated with device, contacts, entities, locations, etc.), ability to verify the instruction source (e.g. in the instance where an instruction is sent from another contact and/or device to the user's mobile device, etc.), restrictions where the instruction will not run if there is less than 100 mb left on the data plan, will not run on the carrier network if the data exceeds 500 mb, will not run if the battery is less than a set amount, and/or any other feature which may relate globally to the instruction and/or the application managing instructions. Of course, in another embodiment, any global setting may be modified on an individual instruction by instruction basis.

In various embodiments, the add settings interface may include instruction specific settings, including permissible run time (e.g. morning, night, 6 am-6 pm daily, Monday-Friday, etc.), permissible run locations (e.g. based off of device location, etc.), permissible run friends (e.g. instruction may be run when a device and/or contact is near, instruction may be prevented to be run when a device and/or contact is near, etc.), automatic settings (e.g. configure user's mobile device based on triggers, actions, and/or settings, etc.), settings associated with controlling the user's mobile device (e.g. set volume, set screen brightness, set power mode, etc.), and/or any other settings which may relate in some manner to the instruction. In another embodiment, a user may download and/or select a set of predefined settings (e.g. included in the instruction file, etc.), and/or may input all settings relating to the instruction.

As shown, a finalize option may be selected 49-1210 and a finalize instruction interface may be displayed 49-1212. In one embodiment, the finalize instruction interface may display all triggers, actions, metadata, settings, and/or any further information which may relate in some manner to the created instruction. In one embodiment, the user may select an errors option to verify if there are any errors associated with the instruction (e.g. inconsistent rules, inadequate permissions, etc.) and/or any errors associated with executing the instruction (e.g. with respect to other instructions, with respect to system resources, with respect to other applications, etc.).

In another embodiment, a modify option may be selected to modify the selected triggers, actions, metadata, and/or settings. In one embodiment, an execute option may be selected to immediately execute (e.g. run, etc.) the created instruction. Further, in another embodiment, the instruction may be saved, including storing the instruction in a local cache on the mobile device, on an online server and/or database, on a local database, and/or on any other device and/or storage hardware. In one embodiment, at the time of saving the instruction, a backup copy of the instruction may be saved in another location. Additionally, in another embodiment, saving the instruction may include sending and/or posting the instruction to an instruction database site to be shared with other users.

FIG. 49-13 shows a mobile device interface 49-1300 for creating one or more instructions, in accordance with another embodiment. As an option, the mobile device interface 49-1300 may be implemented in the context of the architecture and environment of the previous Figures and/or any subsequent Figure(s). Of course, however, the mobile device interface 49-1300 may be implemented in the context of any desired environment. It should also be noted that the aforementioned definitions may apply during the present description.

As shown, a display 49-910 showing the photos associated with the album may be displayed. A “create an instruction” option may be selected 49-1302, and a “create an instruction” prompt interface 49-1304 may be displayed.

In various embodiments, a create an instruction interface may be displayed automatically (e.g. threshold exceeded of input actions, another device may cause an instruction to be recorded, etc.), and/or may be displayed manually (e.g. in response to selecting a button, etc.). In some embodiments, a create an instruction interface may prompt the user with “would you like to record an instruction?,” “would you like to create a new instruction?,” and/or any other prompt associated with a new instruction.

In one embodiment, the ability to record an instruction may include giving further input actions, including opening application, navigating within the application (e.g. accessing submenus and/or subpages, etc.), taking an action within the application (e.g. open item, modify item, initiate program, etc.), modifying device setting (e.g. brightness, volume, permissions, network, etc.), interacting with one or more applications (e.g. backup data to Dropbox, share via Facebook, find restaurants via Yelp, etc.), and/or taking any other action which may be inputted and recorded by the mobile device. In a separate embodiment, an instruction may be recorded including input actions on a secondary device (e.g. second mobile device, input device, device associated with a trusted contact, etc.), sensors not physically associated with the mobile device (e.g. sensors on a secondary device, sensors in a car, sensors at an airport, etc.), and/or through any other input system.

In another embodiment, selecting the prompt to create a new instruction 49-1306 may cause a create instruction interface 49-1308 to be displayed. In various embodiments, the create instruction interface page may include possible triggers and actions, the ability to add, remove, and/or customize the triggers and/or actions, the ability to specify details (e.g. specify contacts in a group, specify blog details, specify application, etc.) relating to the triggers and/or actions, identify the relevancy (e.g. photo, calendar, contact management, productivity, video, social media, sharing, etc.) of the triggers and/or actions, and/or any other feature which may modify the instruction in some manner.

In one embodiment, any action and/or trigger relating to a relevancy criterion may be displayed and/or modified. For example, in one embodiment, the relevancy may be automatically set (e.g. based off of the relevancy tag of the application source, etc.), and/or may be set by the user (e.g. via drop down menu, etc.). In another embodiment, upon selection of the relevancy, the triggers and/or actions may change to display a set of relevant triggers and/or actions. In a further embodiment, a custom trigger and/or action may be added and/or deleted, including inserting a trigger and/or action not associated with the relevant triggers/actions (e.g. an item associated with productivity, etc.), creating a new trigger and/or action not associated with any previously created trigger and/or action, and/or adding any item not already listed with the relevant triggers and/or actions.

In some embodiments, a photo relevancy may display photo relevant triggers, including the ability to open a gallery, select one or more photos, select to share one or more photos, open camera, take picture, select to filter one or more photos, and/or select any other function which may relate to photos. Additionally, in another embodiment, a photo relevancy may display photo relevant actions, including the ability to filter photos, email to a group, upload to a blog, backup to Dropbox, send SMS link to a group, upload to Facebook, post to Twitter, and/or select any other action which may relate to photos.

In various embodiments, the create instruction interface may display one or more options, including the option to add metadata, to add settings, to go back (e.g. to the prior screen and/or interface, etc.), and/or to save. Of course, any option which may relate to the modify instruction interface and/or to navigating the create instruction interface may be displayed. In one embodiment, saving the instruction may include storing the instruction in a local cache on the mobile device, on an online server and/or database, on a local database, and/or on any other device and/or storage hardware. In one embodiment, at the time of saving the instruction, a backup copy of the instruction may be saved in another location. Additionally, in another embodiment, saving the instruction may include sending and/or posting the instruction to an instruction database site to be shared with other users.

FIG. 49-14 shows an online interface 49-1400 for creating one or more instructions, in accordance with another embodiment. As an option, the online interface 49-1400 may be implemented in the context of the architecture and environment of the previous Figures and/or any subsequent Figure(s). Of course, however, the online interface 49-1400 may be implemented in the context of any desired environment. It should also be noted that the aforementioned definitions may apply during the present description.

As shown, an online instruction database interface 49-1402 may be displayed. In one embodiment, the online instruction database may be associated with a website (e.g. accessed via an html address, site external to the user's current network, etc.), with an internal server (e.g. site located within the user's current network, etc.), with one or more secondary devices (e.g. instruction database may be located on another device, etc.), and/or with any other database system. In various embodiments, the online instruction database may be managed by an app (e.g. as downloaded on the user's mobile device, etc.), by a separate entity (e.g. not affiliated with the app, etc.), by a collaboration of more than one user (e.g. a wiki of instructions, etc.), and/or by any other entity which may manage at least in part the online instruction database.

In one embodiment, the online instruction database may be organized by categories 49-1404, applications 49-1406, and/or intended results 49-1408. For example, in another embodiment, categories may include general instruction designation, such as productivity, multimedia, communication, business, social sharing, automobile, and/or any other category which may relate globally to one or many instructions. In one embodiment, each category may be comprised of one or more subcategories. As an example, in one embodiment, the multimedia category may be comprised of several subcategories such as photos, videos, music, and/or any other subcategory which may relate to multimedia. Each subcategory may be further refined. For example, photos may be further refined by relating to management, sharing, filters, and/or instagram. Videos may relate to management, sharing, filters, and/or youtube. Music may relate to management, sharing, filters, radio, and/or Pandora. Of course, each subcategory may be comprised of any number and type of refining categories. Additionally, in another embodiment, each refining category (e.g. management, sharing, filters, etc.) and subsequent category may be potentially further refined.

In various embodiments, the categories may be displayed as a set of tabs, as a hierarchal menu (e.g. menu which may be expanded and/or collapsed, etc.), as a set of links, and/or in any other manner whereby the categories and subcategories may be accessed. In some embodiments, a user utilizing the online instruction database may add additional categories and/or may modify existing categories and/or break-downs. In another embodiment, permission may be granted to a user to modify and/or add categories.

In one embodiment, the online instruction database may be organized by applications. In various embodiments, the applications may relate to applications involved in at least one instruction, applications that are used predominately used (e.g. over half of the triggers and/or actions relate to the application, etc.) by at least one instruction, applications that have been rated as popular, and/or any other application category and/or organization designation. In some embodiments, the applications organization may be edited and/or a new application designation added. In other embodiments, permission may be granted to a user to modify and/or add application designations.

In the instance where an application has not hitherto been used in an instruction, the online instruction database may permit the user to add a new application to be recognized by the online instruction database. In various embodiments, a new application may be added by providing a link (e.g. HTML address, etc.) associated with the application, selecting the application from an online search result (e.g. Google search results, etc.), and/or providing information to validate the authenticity of the application. In one embodiment, validating the authenticity of the application may include confirming the existence of the application, inputting the correct name of the application (i.e. prevent misspellings, etc.), and/or incorporating additional application features to be used by the online instruction database (e.g. other features beyond those targeted and/or used by the user in the created instruction, etc.).

In one embodiment, the online instruction database may be organized by intended results. For example, in various embodiments, intended results may include organize travel plans, automate sharing of photos, monitor who is mentioning you, automate automobile interaction, organize/filter photos, set up calendar events, aggregate information to 1 location, action based on device sensor, and/or any category which is focused on the intended result of the instruction.

In some embodiments, the intended results categories may be populated based off of the popularity of downloaded instructions. Additionally, the online instruction database may request (e.g. through a prompt, question and response, etc.) the intended use of the instruction at the time the user seeks to download (or send) the instruction. In this manner, the online instruction database may collect information relating to each downloaded and/or sent instruction, and may use such information to populate and rank intended results categories.

FIG. 49-15 shows an online interface 49-1500 for viewing one or more selected instructions, in accordance with another embodiment. As an option, the online interface 49-1500 may be implemented in the context of the architecture and environment of the previous Figures and/or any subsequent Figure(s). Of course, however, the online interface 49-1500 may be implemented in the context of any desired environment. It should also be noted that the aforementioned definitions may apply during the present description.

As shown, the online instruction database interface 49-1502 may display one or more selected instructions 49-1504. In one embodiment, when more than one instruction has been selected, the resulting selected instructions interface will display an instruction combining all previously selected instructions.

As an example, a user may have selected one or more instruction dealing with photo sharing and social integration. The title of the instruction may be displayed as “photo sharing with social integration.” Of course, any title may be displayed and the title may be modified as desired by the user. In one embodiment, more than one set of triggers may have been previously selected by the user. The more than one set of triggers may be displayed as one combined set of triggers, or in another embodiment, more than one set of triggers may be associated with the instruction. For example, in one embodiment, one set of triggers may include open gallery application, select one or more photos, and select to share, and another set of triggers may include open camera application, and take one or more photos. The instruction therefore may be associated with both sets of triggers. Of course, any number of sets of triggers may be associated with the instruction.

In various embodiments, one or more actions may be associated with the selected instruction. For example, in one embodiment, the instruction may relate to photo sharing with social integration and the instruction actions may include apply vintage filter, compress the one or more photos, share with preselected group, upload to one or more social networking sites, post update to twitter, and/or upload to blog associated with user. In some embodiments, the user may specify further details relating to each action item, including, for example, specifying the level of compression associated with the photos (e.g. reduce to 72 dpi, etc.), specifying the users to be included in a group to which the photos will be sent, specifying login credentials for one or more social networking sites (e.g. Facebook, Flickr, Twitter, etc.), specifying login credentials for one or more blogs, and/or providing any further information relating to one or more actions.

Additionally, in one embodiment, metadata and settings may be displayed which are associated with the instruction. In another embodiment, where more than one instruction was previously selected, the metadata and settings may reflect more than one creation date and/or author. In one embodiment, the online instruction database will combine items that may be combinable (e.g. relevancy, priority, title, etc.). In various embodiments, metadata may include a title, author, relevancy (e.g. of the intended use, of applications used, etc.), priority (e.g. high, regular, low, priority with respect to other instructions being executed, etc.), creation date, the ability to import instruction settings as metadata (e.g. settings are also imported as metadata values associated with the instruction, etc.), and/or any other value which may relate to metadata.

In various embodiments, the metadata may be stored internally (e.g. in the same file as the instruction, etc.) and/or externally (e.g. in a separate file other than the instruction, etc.). Additionally, the metadata may be formatted in a human readable format (e.g. XML, etc.) and/or in a non-human readable format (e.g. binary, etc.).

In other embodiments, the settings may include global settings, such as permissions (e.g. associated with device, contacts, entities, locations, etc.), ability to verify the instruction source (e.g. in the instance where an instruction is sent from another contact and/or device to the user's mobile device, etc.), restrictions where the instruction will not run if there is less than 100 mb left on the data plan, will not run on the carrier network if the data exceeds 500 mb, will not run if the battery is less than a set amount, and/or any other feature which may relate globally to the instruction and/or the application managing instructions. Of course, in another embodiment, any global setting may be modified on an individual instruction by instruction basis.

In various embodiments, settings may also include instruction specific settings, including permissible run time (e.g. morning, night, 6 am-6 pm daily, Monday-Friday, etc.), permissible run locations (e.g. based off of device location, etc.), permissible run friends (e.g. instruction may be run when a device and/or contact is near, instruction may be prevented to be run when a device and/or contact is near, etc.), automatic settings (e.g. configure user's mobile device based on triggers, actions, and/or settings, etc.), settings associated with controlling the user's mobile device (e.g. set volume, set screen brightness, set power mode, etc.), and/or any other settings which may relate in some manner to the instruction. In another embodiment, a user may download and/or select a set of predefined settings (e.g. included in the instruction file, etc.), and/or may input all settings relating to the instruction.

As shown, the online instruction database interface may include one or more options 49-1506 associated with the selected one or more instructions, including the ability to modify, share link, add another instruction, register device, send to user device, send to another device, and/or any other feature which may relate to the instruction. In some embodiments, the ability to modify may include add, removing, and/or modifying in any manner the triggers, actions, metadata, settings, and/or any element associated with the instruction; the ability to share a link may include sending (e.g. via email, via html send form, via SMS, via chat, etc.) a link (e.g. HTML address, etc.) associated with the selected one or more instructions; the ability to add another instruction may include searching and adding in an additional one or more instructions; the ability to register device may include registering a device that is associated with the user (e.g. mobile device, desktop device, automobile, etc.); the ability to send to user device may include sending the displayed instruction to a default device (as preselected by the user, etc.); the ability to send to another device may include sending the displayed instruction to another device associated with the user and/or sending the instruction to a device not associated with the user (e.g. a device associated with a trusted contact, a device with permission to the user to modify, etc.). Of course, any option associated with the selected one or more instructions may be displayed.

FIG. 49-16 shows an online interface 49-1600 for modifying an instruction, in accordance with another embodiment. As an option, the online interface 49-1600 may be implemented in the context of the architecture and environment of the previous Figures and/or any subsequent Figure(s). Of course, however, the online interface 49-1600 may be implemented in the context of any desired environment. It should also be noted that the aforementioned definitions may apply during the present description.

As shown, the online instruction database interface 49-1602 may display an instruction to be modified 49-1604. In one embodiment, the modification page may relate to one or more previously selected instructions. In another embodiment, the modification page may relate to creating a new instruction (e.g. not based on any previously existing instructions, etc.).

In various embodiments, the modification page associated with the online instruction database interface may display triggers, actions, settings, metadata and/or any other information. In one embodiment, the triggers may be separated into a “currently selected trigger” column and a “possible trigger” column. In such an embodiment, the user may drag and drop one or more triggers from the “possible trigger” column to the “currently selected trigger” column. Each trigger may be represented by a selectable (e.g. movable, etc.) box. In one embodiment, if a possible trigger has been moved to the “currently selected triggers” column, additional information may be requested of the user. For example, in one embodiment, a possible trigger may be “open app” whereupon when the trigger is moved to “currently selected triggers,” a prompt may be displayed requesting the user to indicate what app or type of app the trigger should relate to (e.g. open gallery, open email app, open Facebook, open Yelp, etc.).

In one embodiment, more than one set of triggers associated with the instruction may be configured and/or created by the user. For example, if it was desired to create an instruction focusing on photo sharing with social integration, one set of triggers may focus on the opening of a gallery app whereas another set of triggers may focus on a camera app. Of course, any number of sets of triggers may be created and/or configured.

In one embodiment, all possible triggers may be listed in the “possible triggers” column. In another embodiment, the possible triggers may be displayed in response to a selection of a relevancy criteria, including, for example, productivity (e.g. time management, email, calendar, etc.), multimedia (e.g. photos, videos, music, etc.), communication (e.g. chat, SMS, email, etc.), business (e.g. CRM features, contact management, etc.), social sharing (e.g. social media posting, trusted device management, etc.), automobile (e.g. integration with infotainment system, management of communication, etc.), and/or any other relevancy category which may filter in some manner the possible triggers displayed. In various embodiments, the relevancy criteria may be displayed as a drop-down menu, as a set of links, as set of tabs (e.g. selection of the tab will display the associated possible triggers, etc.), and/or in any other manner.

In other embodiments, the currently selected triggers and the possible triggers may be displayed in any manner, including displaying the one or more triggers (including the currently selected triggers and/or the possible triggers) in a list (e.g. hierarchal list, etc.), as icons, in an interactive frame (e.g. wizard assistance in creating an instruction, etc.), as selectable objects, and/or in any other manner. Additionally, in other embodiments, the one or more possible triggers may be dragged and dropped, selected (e.g. select icon and/or text and/or check a selection mark next to a desired trigger, etc.), written in code (e.g. formulate instruction via code including requests and/or integration of possible triggers, etc.), and/or used in any manner.

In various embodiments, possible triggers may include the ability to open a gallery, select a photo, select to share an item, open an app, take a photo, activate a device, set an alarm, receive an ad, receive a message, select a recipient, create and/or receive a social posting, send and/or receive an attachment, request and/or receive user input, receive an RSS feed, receive and/or create a calendar event, connect to a network, and/or be associated with a location, time, browsing history, purchase history, new high score, a shortcut, a battery status, a custom item, and/or any other item which may relate to some input to the user device. In other embodiments, the possible trigger may relate to an action by a user, by another device (e.g. secondary device, server, etc.), by another user (or trusted contact), by an app (e.g. associated with the user's mobile device, associated with another device and/or user, etc.), and/or any input source.

In other embodiments, possible actions may include ability to apply a filter, to compress a file (e.g. photo, music, video, pdf, document, etc.), share an item with a group, upload item to Facebook, upload item to Flickr, update Twitter, upload an item to a blog, create an event (e.g. calendar appointment, party, e-vite invitation, etc.), send a message, receive and/or create a notification, update a route (e.g. GPS route, GPS tracks, etc.), enable and/or disable speech-to-text, control volume (e.g. of the device, of another associated device, etc.), control brightness (e.g. of the device, of another associated device, etc.), control ringer (e.g. of the device, etc.), set a reminder, initiate a phone call, provide and/or request a weather forecast, update progress (e.g. on a project, on a route, etc.), give an ETA (e.g. when the user will arrive at a destination, when a project will be turned in, etc.), create a shared file, grant a permission (e.g. to a user, to a device, to a group, etc.), confirm a payment (e.g. electronic transfer of funds, electronic purchase, etc.), apply a custom action, and/or take any other action. In some embodiments, the action may relate to a user, a user's mobile device, another device (e.g. secondary device, server, etc.), another user (or trusted contact), an app (e.g. associated with the user's mobile device, associated with another device and/or user, etc.), and/or any device or entity.

As shown, the online instruction database interface modification page may include one or more options 49-1606, including settings, metadata, send, and/or finalize. In one embodiment, the settings option may include global settings, such as permissions (e.g. associated with device, contacts, entities, locations, etc.), ability to verify the instruction source (e.g. in the instance where an instruction is sent from another contact and/or device to the user's mobile device, etc.), restrictions where the instruction will not run if there is less than 100 mb left on the data plan, will not run on the carrier network if the data exceeds 500 mb, will not run if the battery is less than a set amount, and/or any other feature which may relate globally to the instruction and/or the application managing instructions. Of course, in another embodiment, any global setting may be modified on an individual instruction by instruction basis.

In various embodiments, the settings may include instruction specific settings, including permissible run time (e.g. morning, night, 6 am-6 pm daily, Monday-Friday, etc.), permissible run locations (e.g. based off of device location, etc.), permissible run friends (e.g. instruction may be run when a device and/or contact is near, instruction may be prevented to be run when a device and/or contact is near, etc.), automatic settings (e.g. configure user's mobile device based on triggers, actions, and/or settings, etc.), settings associated with controlling the user's mobile device (e.g. set volume, set screen brightness, set power mode, etc.), and/or any other settings which may relate in some manner to the instruction. In another embodiment, a user may download and/or select a set of predefined settings (e.g. included in the instruction file, etc.), and/or may input all settings relating to the instruction.

In one embodiment, the metadata may include the ability to insert an instruction title, an author, a location/geotag, a tag (e.g. data content, application content, etc.), a relevancy (e.g. photo, sharing, etc.), applicable apps (e.g. apps which may relate and/or may be included in the instruction, etc.), priority (e.g. high, regular, low, priority with respect to other instructions being executed, etc.), creation date, the ability to import instruction settings as metadata (e.g. settings are also imported as metadata values associated with the instruction, etc.), and/or any other value which may relate to metadata.

In various embodiments, the metadata may be stored internally (e.g. in the same file as the instruction, etc.) and/or externally (e.g. in a separate file other than the instruction, etc.). Additionally, the metadata may be formatted in a human readable format (e.g. XML, etc.) and/or in a non-human readable format (e.g. binary, etc.).

In one embodiment, the send option may include sending the created instruction to a device associated with a user, a device associated with another contact (e.g. permission may be granted to the user [either preselected or when the instruction is received] to control some aspect of another device, etc.), an instruction repository (e.g. online instruction database, internal server, etc.), an email address, a backup archive (e.g. Dropbox, etc.), and/or to any other location desired by the user.

In another embodiment, a finalize option may display all triggers, actions, metadata, settings, and/or any further information which may relate in some manner to the created instruction. In one embodiment, a finalize option may include an ability to check for errors in the created instruction, including checking for inconsistent rules, inadequate permissions, instruction execution inconsistences (e.g. with respect to other instructions, with respect to system resources, with respect to other applications, etc.), and/or any possible error associated with the instruction.

FIG. 49-17 shows an online and mobile interface 49-1700 for sending and receiving an instruction, in accordance with another embodiment. As an option, the online and mobile interface 49-1700 may be implemented in the context of the architecture and environment of the previous Figures and/or any subsequent Figure(s). Of course, however, the online and mobile interface 49-1700 may be implemented in the context of any desired environment. It should also be noted that the aforementioned definitions may apply during the present description.

As shown, an online instruction database interface 49-1702 may include displaying an instruction. In various embodiments, the displayed instruction may have been created and/or modified previously by the user, may be the result of selecting one or more instructions by the user, may have been sent by a trusted contact (e.g. a friend, etc.) to the user (e.g. via email, via link, via recommendation, etc.), and/or may have been created and/or selected in any manner.

In various embodiments, the online instruction database interface may include one or more options 49-1704 associated with the instruction, including the ability to modify, share link, add another instruction, register device, send to user device, send to another device, and/or any other feature which may relate to the instruction. In some embodiments, the ability to modify may include add, removing, and/or modifying in any manner the triggers, actions, metadata, settings, and/or any element associated with the instruction; the ability to share a link may include sending (e.g. via email, via html send form, via SMS, via chat, etc.) a link (e.g. HTML address, etc.) associated with the selected one or more instructions; the ability to add another instruction may include searching and adding in an additional one or more instructions; the ability to register device may include registering a device that is associated with the user (e.g. mobile device, desktop device, automobile, etc.); the ability to send to user device may include sending the displayed instruction to a default device (as preselected by the user, etc.); the ability to send to another device may include sending the displayed instruction to another device associated with the user and/or sending the instruction to a device not associated with the user (e.g. a device associated with a trusted contact, a device with permission to the user to modify, etc.). Of course, any option associated with the instruction may be displayed.

As shown, the send to another device option may be selected 49-1706. In various embodiments, the user of the online instruction database may be presented with an interface to select the appropriate device to send the instructions. In one embodiment, the user may select one or more devices, may input information (e.g. phone number, device id, etc.) relating to a new device, and/or modify information of any existing device profiles. In another embodiment, a permission level may be associated with each device. For example, in various embodiments, the permission level may relate to a granted permission level sent by a user of the device (e.g. the recipient on the mobile device may designate a permission level associated with the sender of the instruction, etc.), to a permission level associated with a group (e.g. permission to implement instructions based on role and/or user identity, etc.), and/or to any other permission which may be associated with a device and the sending user of the instruction.

In one embodiment, a device may not have an associated permission. In such an embodiment, when the user of the device receives an instruction from the user (or device), the receiving user may designate a permission level to be associated with the sending user (or device). In various embodiments, the receiving user may permit the sending user (or device) to have permission to add and install instructions, to push information relating to the instruction to the receiving user's device (e.g. but not to install them, etc.), to install a temporary and/or trial version (e.g. limited features, etc.) of the instruction, and/or to have any other permission to interact with the receiving user's mobile device in some manner.

As shown, in response to an instruction being sent (e.g. from an online instruction database, etc.), a notification interface 49-1708 may be displayed on the receiving user's mobile device. Of course, in other embodiments, any device may function as the receiving device. In one embodiment, the notification may indicate the user that sent the instruction and the instruction title. For example, in one embodiment, the notification may display “Jean Molyair sent you an instruction: ‘Photo Sharing with Social Integration.’” Of course, any notification may be displayed. For example, in another embodiment, the user of the mobile device may have already granted permission to “Jean Molyair” to add and install instructions on the user's mobile device. In such an embodiment, the notification may notify the user of an instruction that was added by “Jean Molyair.”

In various embodiments, the notification interface may also include one or more options, including accept instruction, view instruction, reject instruction, settings, and/or accept all instructions. In one embodiment, the accept instruction may include installing and saving the instruction to a device instruction database. In some embodiments, the device instruction database may be synced with an online instruction database.

In another embodiment, the reject instruction may include denying installation of the instruction, filtering (e.g. blocking, etc.) further instruction notifications from a specific source (e.g. Jean Molyair, etc.), and/or rejecting in some manner the sent instruction. In some embodiments, settings may include management of sources (e.g. black list, white list, acceptable sources, etc.), the granting of one or more permissions (e.g. user X has permission to send and install one or more instructions, user permissions, device permissions, app permissions, etc.), the manner of notifications (e.g. notification display, notification sound, notification action, etc.), requests for recommended instructions (e.g. by the device, by the app, invitation sent to one or more contacts, etc.), communication between one or more device (e.g. do not accept an instruction from an unknown device, unknown device must be determined as trustworthy before acceptance of an instruction, etc.), communication between an online instruction database and a device instruction database, and/or any other setting associated in some manner with the instruction notification page.

In one embodiment, the user may select an option to accept all instruction. In one embodiment, the option may relate to a specific instruction source (e.g. Jean Molyair, etc.). In other embodiments, the option may relate to a device source (e.g. device ID xxxxx, etc.), an IP address, a website, a genre (e.g. instruction may relate to “productivity,” etc.), and/or any other feature and/or identification which may relate in some manner to the instruction.

As shown, the view instruction option may be selected 49-1710. In response an instruction interface 49-1712 may be displayed. In various embodiments, the instruction interface may include triggers, actions, settings, metadata, and/or any other information associated with the instruction. As an example, in one embodiment, the sent instruction may be entitled “Photo Sharing with Social Integration;” the triggers may include open gallery application, select one or more photos, select to share, or open camera application, take one or more photos, and/or any other trigger which may relalte to the photo sharing with social integration; the actions may include apply vintage filter, compress the one or more photos (e.g. 72 dpi), share with a preselected group, upload to one or more social networking sites (e.g. Facebook, Flickr, etc.), post update to Twitter (e.g. “see my [number] new photos from [location],” etc.), upload to blog associated with user, and/or taking any other action in response to the one or more triggers; the metadata may include the title of the instruction, the author, relevancy, priority, creation date, the ability to import settings as metadata, and/or any other relevant information; the settings may include any further information relating in some manner to the instruction.

In one embodiment, the instruction interface may include one or more options, including ability to check for errors, to modify the instruction, to execute the instruction, and to save the instruction. Of course, in other embodiments, any type of option may be associated with the instruction.

In one embodiment, the ability to check for errors may include verifying device capability (e.g. sufficient resources, applicable apps have been downloaded, etc.), one or more permissions (e.g. user must have permission to access database X in order to run the instruction, etc.), one or more triggers and/or actions (e.g. verify that the correct order of triggers and/or actions is included, etc.), and/or any other feature which may in some manner check for errors in the instruction. In other embodiments, the ability to modify the instruction may include modifying in some manner the one or more triggers, actions, metadata, and/or settings.

As an example, in one embodiment, a user accessing an online instruction database may select an instruction and choose to send the instruction to another device, or a device not associated with the user. A page (or pop-up display, etc.) may be displayed requesting further information from the user including the name of the new device, the cell phone number of the device (e.g. if the device was a mobile phone, etc.), the name of the user associated with the device, an identification associated with the device (e.g. device id, etc.), a time of delivery (e.g. immediate, 6 pm on 12/02/12, etc.), and/or any other information which may relating to sending the instruction to another device. After sending the instruction, a confirmation page (or pop-up display, etc.) may be displayed indicating that the instruction was successfully sent. In the event that there was an error in sending the instruction, an error page may be displayed indicating the applicable error (e.g. insufficient permission, no such device exists, etc.).

In one embodiment, devices may be registered (e.g. provide detailed information associated with the device, etc.) with an online instruction database or with a device instruction database. In one embodiment, in order for an instruction to be downloaded, sent, and/or created on a device, the device may be registered with an instruction database (e.g. online, on device, etc.). In other embodiments, a device may not need to be registered with an instruction database in order to download and/or receive an instruction. In such an embodiment, at the receipt (e.g. from downloading and/or receiving, etc.) of an instruction, a link may also be provided to register the device with an online or device instruction database. In a further embodiment, registering a device may permit additional features (e.g. premium features, etc.) to be accessed and/or used by the user.

FIG. 49-18 shows a mobile interface 49-1800 for managing one or more instructions, in accordance with another embodiment. As an option, the mobile interface 49-1800 may be implemented in the context of the architecture and environment of the previous Figures and/or any subsequent Figure(s). Of course, however, the mobile interface 49-1800 may be implemented in the context of any desired environment. It should also be noted that the aforementioned definitions may apply during the present description.

As shown, an instruction database interface 49-1802 may be displayed. In one embodiment, the instruction database interface may include a list of active instructions, inactive instructions, recommended instructions, and/or options associated with the instruction database. In another embodiment, the active instructions may include any instruction which is actively being used. In various embodiments, the separation of active and inactive instructions may occur automatically by the device. For example, in one embodiment, a created instruction may indicate that the instruction would be valid (i.e. would be active, etc.) for one week. After a week of use, the instruction may then be designated as “inactive.” In other embodiments, if an error is found in the instruction (e.g. with a trigger, with an action, etc.), an instruction may also be placed in an “inactive instructions” category. Of course, in another embodiment, the categorization of active and inactive instructions may occur manually by the user.

In one embodiment, the recommended instructions may include one or more instructions which have been received but not yet installed and made active. For example, in one embodiment, a recommended instruction may be received from a contact (e.g. trusted contact, friend, device, etc.). In another embodiment, a recommended instruction may be included based on a recommendation from the user's device. For example, in one embodiment, the user may have given a set of input actions repeatedly (e.g. twice in a month, etc.) but not sufficiently frequent (e.g. at least twice in a week, etc.) to trigger a display associated with an instruction creation threshold. In such an embodiment, the mobile device may recommend one of more instructions based on the device usage history (e.g. actions taken by the user, actions taken by one or more apps, etc.). Of course, in another embodiment, the device may recommend one or more instructions based on any input and/or history associated with the device.

In one embodiment, the sync option may include syncing one or more instructions between the user's device and another database, including for example, a database in the cloud (e.g. cloud database, etc.), on a server (e.g. on local network, on external network, etc.), on another device (e.g. secondary device, device associated with a trusted contact, etc.), and/or any other device which may also store one or more instructions. In another embodiment, the search option may include the ability to search among previously used instructions (e.g. inactive instructions, etc.), active instructions, recommended instructions, as well as search potential instructions on an instruction database. In a further embodiment, the save option may include the ability to save the instruction database to more than one location (e.g. on the device, on a separate storage card associated with the device, etc.).

As an example, in one embodiment, active instructions may include “photo sharing with social integration,” “calendar event sharing,” “camera sharing,” “automobile—music integration,” and/or “aggregate news feeds;” inactive instructions may include “lunch appointment management,” “weather based recommendations,” “live traffic navigation and ETA;” recommended instructions may include “Bob: Network Carrier Management,” “Mary: Facebook Postings Management,” “Minty: Browsing History Recommendations.”

In one embodiment, an active instruction “Photo Sharing with social integration” may be selected 49-1804 and an instruction page 49-1806 may be displayed. In various embodiments, an instruction page may include the one or more triggers and actions, metadata, and settings previously selected and/or accepted. In various embodiments, one or more options may be displayed including modify (e.g. change some aspect of the triggers, actions, metadata, and/or settings, etc.), automate, shortcut, and/or make inactive (e.g. remove the instruction from an active instruction designation, etc.). In other embodiments, the one or more options may be displayed as drop down menus. In another embodiment, an option to delete the instruction may be displayed.

As shown, an automate option may be selected 49-1808 and an automate instruction interface 49-1810 may be displayed. In various embodiments, an automate instruction interface may include displaying potential actions. In one embodiment, it may be desired to convert all triggers to actions. For example, in one embodiment, the number of triggers may be reduced by saving the instruction to a shortcut (e.g. button, gesture, etc.). Of course, in another embodiment, an option to modify the potential actions may be displayed, which may permit the user to add and/or remove potential action items (e.g. taken from the prior triggers, taken from the prior actions, taken from action and/or trigger database, etc.), and/or taken any other action to modify in some manner the instruction. In one embodiment, the potential actions may be modified after converting all triggers to actions.

In another embodiment, the automate instruction interface may include an option to assign the instruction to a shortcut and/or one or more triggers (e.g. other than those initially associated with the instruction, etc.). In various embodiments, the shortcut may be associated with a gesture, a button, a parameter, a sequence, a voice command, a device input, and/or any other feature which may be capable of causing the execution of an instruction. Of course, in other embodiments, any trigger (e.g. any input action, etc.) may be used as a shortcut and/or trigger.

In one embodiment, the automate instruction interface may include the ability to add in time instruction, including specifying the run time (e.g. run at 6 am, etc.), run period (e.g. daily, weekly, February 23, etc.), run duration (e.g. only run for maximum of 10 minutes, etc.), run cycle (e.g. only run 10 times, etc.), and/or any other option relating to time and the instruction. In another embodiment, the automate instruction interface may also include one or more thresholds (e.g. shortcut will not execute the instruction unless the user is at location X, the shortcut and/or trigger are pressed for a minimum of 3 seconds, etc.).

As shown, a shortcut option may be selected 49-1812 and a create shortcut interface 49-1814 may be displayed. In various embodiments, the create shortcut interface may include the ability to assign the instruction to a gesture (e.g. ability to record a custom gesture, selection of a predefined gesture, an input gesture on the device display, etc.), to a button (e.g. device physical button, software button, icon, etc.), to one or more parameters (e.g. input actions, device sensors, etc.), to a key sequence (e.g. keyboard command sequence, keyboard shortcut, etc.), to a voice command (e.g. record command, select from preconfigured commands, etc.), to a device motion/accelerometer pattern (e.g. move device in an “8” motion, move device up, move device to the side, etc.), to one or more contextual commands (e.g. identification of environment, identification of users, user is standing up or sitting down, user has entered a specific room, etc.), and/or any other feature (e.g. software based, physical, etc.) which may include assignment of a shortcut. Of course, any item associated with the device may potentially be assigned a shortcut. In another embodiment, options associated with the create shortcut interface may include settings (e.g. displayed options, etc.), save (e.g. to the device, to an online database, etc.), and/or any other item associated with creating a shortcut.

FIG. 49-19 shows a method 49-1900 for executing one or more instructions with a mobile device in a vehicle control mode, in accordance with another embodiment. As an option, the method 49-1900 may be implemented in the context of the architecture and environment of the previous Figures and/or any subsequent Figure(s). Of course, however, the method 49-1900 may be implemented in the context of any desired environment. It should also be noted that the aforementioned definitions may apply during the present description.

As shown, a computer readable medium works in association with a mobile device. See operation 49-1902. In one embodiment, the mobile device may include a device with cellular phone capabilities. In another embodiment, the mobile device may include a short-range wireless communication protocol headset, including Wireless USB, Bluetooth, Wi-Fi, or any other wireless protocol which may function at a short-range.

Additionally, a computer readable medium determines whether the mobile device is within a predetermined proximity of a vehicle. See operation 49-1904. In one embodiment, the mobile device may detect the presence of a particular device (e.g. the vehicular system, etc.) by receiving a transmitted signal (e.g. RFID, NFC, WiFi, ZigBee, Bluetooth, etc.). In another embodiment, the vehicular system may detect the presence of the mobile device.

In some embodiments, the proximity may be set to a specific threshold. For example, the signal strength may be set at a predetermined quality (e.g. HIGH, etc.) before connection is established. In other embodiments, the transmitted signal may only be accessible within a set threshold range (e.g. 3 feet, etc.) around the vehicle.

In one embodiment, the determination of whether the mobile device is within a predetermined proximity of a vehicle may be automatic (e.g. an automatic connection established between the car system and the mobile device, etc.). In other embodiments, the determination may occur manually (e.g. mobile device must be placed in a mount, a mobile device must receive a wired connection, an “accept connection” screen must be accepted, etc.).

In some embodiments, the determination may include an authentication step. For example, in one embodiment, the mobile device may exchange security tokens with the vehicle system as part of determining whether the mobile device is within a predetermined proximity of a vehicle. Of course, any cryptography and/or security features may be implemented in determining whether the mobile device is within a predetermined proximity of a vehicle.

In various embodiment, the determination as to whether the mobile device is within the predetermined proximity of the vehicle may be accomplished by determining whether the mobile device is in communication with the vehicle via a short range wireless communication protocol, by determining whether the mobile device has been manually put in a vehicular control mode, by determining whether the mobile device has been physically coupled to the vehicle, and/or by any other method whereby the mobile device is determined to be within a predetermined proximity of the vehicle.

As shown, if the mobile device is within a predetermined proximity of a vehicle, the mobile device is operated in a vehicle control mode for executing one or more instructions relating to at least one vehicular feature. See operation 49-1906. In one embodiment, vehicle control mode may include a collection of properties in association with at least one vehicle feature. For example, in various embodiments, the properties may include, but are not limited to, user preferences, input options, output options, power conservation policies, processing capacity, access permissions, and/or any other type of setting that may be attributable to a tablet computer or a phone device.

In one embodiment, the vehicle control mode may include static settings. In other embodiments, the vehicle control mode may include dynamic features (e.g. settings based on devices in a predetermined proximity, etc.). In a further embodiment, the vehicle control mode may include more than one sub-mode (e.g. season mode, time of day mode, etc.). For example, switching between modes may be done automatically (e.g. environmental, spatial, temporal, and/or situational triggers, etc.) or manually (e.g. triggered by user input, etc.). In this way, the properties can be tailored to specific use environments and situations, maximizing the functionality and interaction of the tablet computer or phone device and the vehicle. Further, in another embodiment, a vehicular feature may include any feature associated with a vehicle. For example, in various embodiments, the vehicular feature may include an audio feature, a video feature, a navigation feature, an augmented reality feature, a social networking feature, a vehicle control feature (e.g. heated seats, air conditioning, etc.), and/or any other feature which may be associated with a vehicle.

In one embodiment, the vehicle control mode may be activated automatically. For example, in one embodiment, when the mobile device is within a predetermined proximity of the vehicle, an application on the device may be activated to control at least some aspect of the vehicular system (e.g. music selection, volume, directions, lighting, heated seats, emergency services etc.).

In other embodiments, the vehicle control mode may be activated manually. For example, in one embodiment, the mobile device may be placed on a mount within the vehicle, and thereby, activate an application on the device to control at least some aspect of the vehicular system (e.g. music selection, volume, directions, lighting, heated seats, emergency services etc.).

Of course, the mobile device may be connected in any manner (e.g. wired or wirelessly, etc.) to the vehicle assembly. Additionally, any number of devices may be connected to the vehicular system and control at least one vehicular feature.

In another embodiment, operating the mobile device in a vehicle control mode for controlling at least one vehicular feature may be based upon user input (e.g. hardware switch, GUI input, etc.). In another embodiment, the determination may be based on peripherals geographically near the device. For example, in one embodiment, a car display arrangement (e.g. vehicle system, etc.) may include a wireless microphone, a wireless database (e.g. to store contacts, directions, pushed notifications, etc.), and/or any other type of peripheral which may be used within a vehicle. Upon being brought near any of these peripherals, the mobile device may recognize the peripherals, and based off of the recognition, automatically operate the table computer or phone device in a vehicle control mode.

In some embodiments, operating the mobile device in a vehicle control mode may serve as a trigger for one or more instructions. For example, in one embodiment, an instruction may relate to a vehicle audio system, which may include a vehicle mode trigger, the user sitting down (e.g. based off of accelerometer sensor, etc.), and interaction with a Bluetooth audio system. Based off of these triggers, an instruction may run including activating Pandora, selecting a specific channel, and setting the volume level. Of course, any instruction may be configured to run in vehicle control mode.

In a separate embodiment, an instruction may relate to receiving a communication (e.g. email, chat, etc.) while in the vehicle. One or more triggers may include a vehicle mode trigger, and receiving an email or a text or a chat. Using the audio system on the vehicle assembly, the device may request whether the user wishes the device to read (e.g. text-to-speech capabilities, etc.) to the user. Upon input from the user (e.g. voice command “yes,” etc.), the device may proceed to read the communication. After reading, the device may request whether the user wishes to respond in some manner (e.g. call back, send a communication back, etc.) to the received communication. Of course, in other embodiments, any instruction may be configured to relate in some manner to the vehicle mode.

FIG. 49-20 shows a communication system 49-2000, in accordance with one possible embodiment. As an option, the system 49-2000 may be implemented in the context of the architecture and environment of the previous Figures or any subsequent Figure(s). Of course, however, the system 49-2000 may be carried out in any desired environment. It should also be noted that the aforementioned definitions may apply during the present description.

As shown, a mobile device 49-2002 is capable of interfacing with a vehicle 49-2004 including various components of the vehicle 49-2004. The phone device or tablet computer 49-2002 may include any mobile device capable of interfacing with a vehicle 49-2004 including a lap-top computer, hand-held computer, mobile phone, personal digital assistant (PDA), a music player (e.g. a digital music player, etc.), a GPS device, etc.

In various embodiments, the mobile device 49-2002 may communicate with a vehicular assembly system (e.g. a communication and entertainment system, etc.) corresponding to the vehicle 49-2004 via a wireless connection (e.g. Bluetooth, etc.), or via a cable connection (e.g. a USB cable, a serial cable, etc.). As an option, the mobile device 49-2002 may interface with the communication and entertainment system vehicle utilizing an I/O port 20106 of the vehicle 49-2004. In various embodiments, the I/O port 49-2006 may include a serial port, a USB port, FireWire/i.LINK ports, etc. In one embodiment, the I/O port 49-2006 may include a wireless communication port.

Using this interface, the mobile device 49-2002 may interface with various components and functionality of the vehicle, such as an onboard computer system including a processor 49-2008, memory 49-2010 (e.g. DRAM, flash memory, etc.), an onboard navigation system 49-2012, displays (e.g. a central display 49-2014, and one or more passenger displays 49-2016, etc.), audio communication devices (e.g. speakers 49-2018, a microphone 49-2020, etc.), and various other components and functionality of the vehicle included in the vehicular assembly system. The interface may also allow a user of the vehicle 49-2004 to access and/or control the phone device or tablet computer 49-49-2002 utilizing controls associated with the vehicle 49-2004, such as steering wheel, and dashboard radio controls 49-2022. Additionally, the user may access and/or control the mobile device utilizing the microphone 49-2020 through voice commands.

Using these components and controls, a user may access and utilize one or more wireless networks 49-2024 associated with the mobile device 49-2002. Coupled to the networks 49-2024 may be servers 49-2026 which are capable of communicating over the networks 49-2024. Also coupled to the networks 49-2024 and the servers 49-2026 is a plurality of clients 49-2028.

Such servers 49-2026 and/or clients 49-2028 may each include a desktop computer, lap-top computer, hand-held computer, mobile phone, personal digital assistant (PDA), peripheral (e.g. printer, etc.), any component of a computer, and/or any other type of logic. In order to facilitate communication among the networks 49-2024, at least one gateway is optionally coupled therebetween.

It should be noted that the computer system of the vehicle 49-2004 may include various software and applications for facilitating communication between the vehicle 49-2004 and the mobile device 49-2002. For example, in various embodiments, the vehicle computer system may include an operating system (e.g. Windows Mobile, Linux, etc.), embedded speech recognition software, telephone call steering systems, automated telephone directory services, character recognition software, and imaging software.

In one embodiment, the user's mobile device may be used to control in some manner an aspect of the vehicle (e.g. in response to an ad/content, etc.). In a further embodiment, the mobile device may identify additional peripherals and/or devices associated with the vehicle, and based off of the identification, use such peripherals and/or devices to interact more fully with the user. For example, in one embodiment, an instruction may be executed by the mobile device which controls in some manner a feature and/or device (e.g. display, audio setting, etc.) associated with the vehicle. In another embodiment, an instruction may be executed by a different device (e.g. associated with a friend, associated with a contact, associated by a nearby device, etc.) which controls in some manner an aspect of the vehicle. In such an embodiment, the ability to control the vehicle may be dependent on the allocation of sufficient permissions. In this manner, instruction from more than one device may be used to interact with other users and the car assembly.

In one embodiment, a vehicle may be a trigger for an instruction. For example, in one embodiment, the vehicle mode may trigger ads and/or content relating to possible destinations and/or relevant content en route, pursuant to a predefined instruction. In another embodiment, a relevant instruction (e.g. based off of usage history, preferences, etc.) may be presented to the user. In one embodiment, the mobile device may determine that the user is in a vehicle, that it is near lunch time, and that the user's next appointment is in one hour. Based off of these triggers, the mobile device may execute an instruction including giving a recommend (e.g. through the vehicle's audio, etc.) a lunch destination to the user. If the user agrees (e.g. voice command of “yes,” etc.), the mobile device may update the navigation system with the new lunch destination.

In another embodiment, a user may be in a new city. Traveling through the city, the mobile device may receive one or more triggers including recognizing that the user has not been to the city before and is currently in a vehicle. Based off of such triggers, an instruction may be run requesting to the user whether a tour audio stream is desired. If the user gives an affirmative voice command, the mobile device may play tour audio streams to the vehicle (e.g. “On your left is the oldest Bank Building in the area. Built in 1864, it survived the fire of 1880 and the earthquake of 1910,” etc.). Of course, anything may be presented to the user based on the instruction.

FIG. 49-21 shows a configuration 49-2100 for an automobile capable of interfacing with the mobile device of FIG. 49-20, in accordance with one possible embodiment. As an option, the configuration 49-2100 may be implemented in the context of the architecture and environment of the previous Figures or any subsequent Figure(s). Of course, however, the configuration 49-2100 may be carried out in any desired environment. It should also be noted that the aforementioned definitions may apply during the present description.

As shown, the mobile device 49-2002 may be coupled to the automobile utilizing a wired connection (e.g. a USB connection, etc.), or a wireless connection (e.g. Bluetooth, etc.). In one embodiment, the mobile device 49-2002 may be placed on a mount 49-2108. The mount may provide a wired or wireless connection to the automobile system.

Using this connection, a user (e.g. a driver or passenger, etc.) may operate the mobile device 49-2002, via the automobile, using voice commands, steering wheel controls 49-2102, radio controls 49-2104, and/or dashboard controls. Furthermore, the mobile device may communicate with vehicle displays (e.g. main displays, passenger displays 49-2106, etc.) such that content associated with the mobile device (e.g. stored content, streaming content, etc.) may be displayed. For example, the mobile device may communicate stored video to at least one of the passenger displays 49-2106. Additionally, the mobile device may communicate streaming (e.g. new ad/content, etc.) or stored audio (e.g. saved past ad/content, etc.) such that the audio may be transmitted utilizing an audio system of the automobile.

By interfacing the mobile device 49-2002 with the automobile, voice-activated, hands-free calling may also be implanted. For example, a “Push to Talk” button on the steering wheel may allow the user to access contacts stored in a contact list of the mobile device 49-2002 by voice command. Furthermore, the user may be able to switch use from the mobile device 49-2002 to the vehicle control system transparently. For example, a user may push a “Telephone” button on the steering wheel to automatically transfer a current telephone call to the automobile communication system of the automobile without having to hang up and call again.

As an option, the text messages received by the mobile device 49-2002 may be converted to audio utilizing a vehicle on-board processor and associated voice-to-text software. The communication system of automobile may then output the converted text in an audio stream via speakers. In one embodiment, the communication system associated with the automobile may include a main display 49-2106 for displaying activities associated with the mobile device 49-2002, along with other functionality (e.g. navigational functionality, etc.).

For example, the communication system may display any feature that is capable of being displayed using the mobile device 49-2002. In various embodiments, such features may include an ad and/or content notification, caller ID, call waiting, conference calling, a caller log, a list of contacts, a signal strength icon, and a phone battery charge icon, a music list, a content list, etc. Additionally, voice-activated music may also be implemented. For example, the on-board communication and entertainment system may allow a user to browse through music collections by genre, album, artist, and song title using simple voice commands.

In one embodiment, the passenger displays 49-2106 may all display the same material (e.g. video, music, ad, content, etc.). In another embodiment, the passenger displays may be independently operated (e.g. each displaying a different video stream, personalized ads and/or content, etc.) and/or operated independently by the mobile device 49-2002. In a further embodiment, the passenger displays 49-2106 may include permanent displays. For example, the passenger displays may be installed into the automobile architecture (e.g. installed into the dashboard, the backs of seats, etc.). In another embodiment, the passenger displays 49-2106 may include transportable displays. For example, the passenger displays may include a tablet computer or mobile device and each may be placed in an installed mount on the automobile (e.g. on the dashboard, in the backs of seats, in a roof mount, etc.).

In various embodiments, the mobile device 49-2002 may be set up to operate in a master-slave relationship with the passenger displays on the automobile. In one embodiment, the mobile device may automatically configure the passenger displays based on predetermined settings (e.g. the screen most in the front of the automobile displays navigation details, screens in the back of the automobile display videos and/or relevant ads and/or content, etc.). Of course, the screens may be configured in any manner based on input from the phone device or tablet computer.

In a further embodiment, if multiple mobile devices or tablet computers are present in an automobile, the mobile devices or tablet computers may apply preconfigured settings wherein only one mobile device may control the automobile system features, and the other mobile devices or tablet computers may remain as slave devices to the one master mobile device. For example, in one embodiment, a parent passenger may wish to control automobile features (e.g. navigation, music, etc.) as well as control what is displayed (e.g. ad and/or content, etc.) on each of the child passenger's display (e.g. on the passenger displays, on another phone device or tablet computer, etc.). The parent passenger's mobile device may be used to control at least some vehicular feature, as well as control other devices and/or displays within a preconfigured proximity range.

In a separate embodiment, if multiple mobile devices or tablet computers are present in an automobile, one or more instructions may be executed. For example, in one embodiment, an instruction on a device associated with a parent may relate to child restrictions. A trigger may include a vehicle control mode and the identification of one or more known devices (e.g. associated with another passenger, associated with a child, etc.). Based on the triggers, an instruction may be run from the device associated with the parent whereby one or more settings (e.g. music control restrictions, volume restriction, dvd content restrictions, etc.) are implemented on each of the other devices in the vehicle. Of course, any instruction relating to any number of devices may be configured and executed.

FIG. 49-22 shows a mobile device interface 49-2220 for interacting with one or more instructions, in accordance with one possible embodiment. As an option, the mobile device interface 49-2200 may be implemented in the context of the architecture and environment of the previous Figures or any subsequent Figure(s). Of course, however, the mobile device interface 49-2200 may be carried out in any desired environment. It should also be noted that the aforementioned definitions may apply during the present description.

As shown, a notification interface 49-2202 may be displayed. In one embodiment, the notification interface may relate to a vehicle control mode. For example, the notification may include a text box displaying “One or more vehicle features have been detected. Would you like to run in vehicle control mode?” Of course, in other embodiments, the text box may include any text. In one embodiment, the user may respond by giving a voice command (e.g. “yes,” “no,” etc.), providing a motion (e.g. motioning up with the device to indicate ‘yes,’ etc.), selecting an icon and/or button on the device display (e.g. “yes” button, “no” button, etc.), and/or providing any other action to indicate a response. In one embodiment, one or more options may be displayed, including a “yes” button, a “no” button, settings, and/or a database button.

In one embodiment, a “yes” button may be selected 49-2204, and a vehicle mode interface 49-2206 may be displayed. In various embodiments, the vehicle mode may include one or more features including the ability to navigate, access music, access contacts, use a phone, access maps, and provide a voice command. Of course, in other embodiments, any feature may be displayed. In one embodiment, most frequently used features may be displayed. In other embodiments, the features may be manually selected by the user, may be inputted based on a recommendation from another contact, and/or managed in some other manner.

In other embodiments, one or more instruction shortcuts may be displayed, including send ETA (e.g. to contacts, to predefined group, etc.), update status (e.g. via Facebook, via Twitter, etc.), provide text-to-speech (e.g. for incoming communication, etc.), plex stream (e.g. provide audio stream from plex server, etc.), recommend lunch (e.g. provide recommendation for lunch based off of preferences and the presence of other contacts near the user, etc.), recommendations from friends (e.g. provide and/or filter recommendations from friends relating to nearby sites and/or locations, etc.), and/or any other instruction which may be saved as a shortcut.

As shown, in one embodiment, a database option may be selected 49-2208, and a vehicle instruction database interface 49-2210 may be displayed. In one embodiment, the vehicle instruction database interface may display active instructions, inactive instructions, the ability to create/record an instruction, the ability to view recommended vehicle instructions, and one or more options.

In one embodiment, the active instructions may include any instruction which is currently configured to actively be executed (e.g. in response to one or more triggers, etc.). As an example, in various embodiments, active instructions may include controlling email response, text-to-speech for messages, network carrier monitor, traffic alert management, and/or car energy management. Additionally, in another embodiment, the inactive instructions may include any instruction which is no longer configured to actively be executed (e.g. instruction which has expired, instruction which is no longer valid, instruction which has one or more errors, etc.). As an example, in various embodiments, inactive instructions may include weather based recommendations, live traffic navigation and ETA, and/or car bumper sensor monitor. Of course, any instruction may be designated as active or inactive.

In various embodiments, the user may select any of the active or inactive instructions to view the instruction and/or to modify in some manner the instruction. In another embodiment, an instruction may be created and/or recorded. For example, in one embodiment, a user may select to record an instruction including setting the volume on the car assembly system, setting a driver side air temperature (e.g. air conditioning, heater, etc.), starting Pandora, and selecting a specific radio station to run. After recording the actions, the user may select one or more triggers to trigger the actions, including running the phone in vehicle control mode, and exceeding a time threshold of the mobile device being in the vehicle for longer than 30 seconds. Of course, any input action may be set as a trigger for the instruction.

In other embodiments, the one or more options may include settings, ability to sync, ability to search, and ability to save. In various embodiments, settings may include one or more adjustments (e.g. notifications, audible alerts, display configuration, interaction with vehicle assembly configuration, etc.), vehicle control global settings (e.g. how the mobile device interacts with the vehicle assembly, etc.), and/or any other setting which may relate to the instruction.

In one embodiment, the sync option may include syncing one or more instructions between the user's device and another database, including for example, a database in the cloud (e.g. cloud database, etc.), on a server (e.g. on local network, on external network, etc.), on another device (e.g. secondary device, device associated with a trusted contact, etc.), and/or any other device which may also store one or more instructions. In another embodiment, the search option may include the ability to search among previously used instructions (e.g. inactive instructions, etc.), active instructions, recommended instructions, as well as search potential instructions on an instruction database. In a further embodiment, the save option may include the ability to save the instruction database to more than one location (e.g. on the device, on a separate storage card associated with the device, etc.). Of course, in another embodiment, any option associated with the instruction may be displayed.

As shown, the ability to caret/record an instruction may be selected 49-2212 and a create/record instruction interface 49-2214 may be displayed. In various embodiments, the create/record instruction interface may include one or more input actions. For example, in one embodiment, it may have been detected (e.g. via record an instruction, etc.) that user altered the car system volume, activated Bluetooth, started Bluetooth, selected Coldplay radio station, set the AC (driver side) to 78 degrees, set the seat warmer (driver side) to medium. In one embodiment, the user may classify such input actions as a trigger or as an action. In a further embodiment, the user may record additional input actions to be included as a trigger and/or action.

In other embodiments, the user may select one or more possible inputs without recording an action input. For example, in one embodiment, the user may select a trigger or action from a list of possible triggers and/or actions. In another embodiment, the possible triggers and/or actions to be selected may be organized by popularity, category (e.g. business, social media, etc.), application (e.g. vehicle, device integration, etc.), and/or by any other organization feature.

In one embodiment, the ability to check for errors may include verifying device capability (e.g. sufficient resources, applicable apps have been downloaded, vehicle assembly capability, etc.), one or more permissions (e.g. user must have permission to access database X in order to run the instruction, etc.), one or more triggers and/or actions (e.g. verify that the correct order of triggers and/or actions is included, etc.), and/or any other feature which may in some manner check for errors in the instruction. In other embodiments, the ability to modify the instruction may include modifying in some manner the one or more triggers, actions, metadata, and/or settings. In a further embodiment, the user may select to execute the instruction immediately (e.g. run the instruction, etc.), or may select to save the instruction (e.g. active instruction, etc.).

FIG. 49-23 shows a method 49-2300 for executing one or more instructions with a mobile device in a travel mode, in accordance with another embodiment. As an option, the method 49-2300 may be implemented in the context of the architecture and environment of the previous Figures and/or any subsequent Figure(s). Of course, however, the method 49-2300 may be implemented in the context of any desired environment. It should also be noted that the aforementioned definitions may apply during the present description.

As shown, a computer readable medium works in association with a mobile device. See operation 49-2302. In one embodiment, the mobile device may include a device with cellular phone capabilities. In another embodiment, the mobile device may include a short-range wireless communication protocol headset, including Wireless USB, Bluetooth, Wi-Fi, or any other wireless protocol which may function at a short-range. In other embodiments, the computer readable medium may include any device capable of communicating via a wireless communication protocol.

Additionally, a computer readable medium determines whether the mobile device is within a predetermined proximity of a travel location. See operation 49-2304. In one embodiment, the mobile device may be aware of a calendar event involving a travel location and may sense (e.g. via GPS, etc.) when the mobile device is near the travel location. In another embodiment, the mobile device may include context awareness sensors (e.g. location sensors, environment sensors, network sensors, device communication sensors, etc.) to determine that the mobile device is near a travel location.

As an example, in one embodiment, the mobile device may receive a GPS signal indicating the user is near an airport (e.g. or a popular tourist destination site, or a car rental agency, or a hotel, or any travel location, etc.), may sense one or more wireless networks (e.g. via WiFi, etc.) whose identification includes an airport relevant string (e.g. Oakland Airport Wifi, etc.), may identify one or more devices (e.g. baggage scanners, airline check-in, etc.) which may be associated with an airport, and/or detect and/or receive an input indicating an airport context.

In some embodiments, the proximity of a travel location may be set to a specific threshold. For example, the signal strength may be set at a predetermined quality (e.g. HIGH, etc.) before connection is established. In other embodiments, the transmitted signal may only be accessible within a set threshold range (e.g. 3 feet, etc.) around the travel location.

As shown, if it determined that a mobile device is within a predetermined proximity of a travel location, a computer readable medium determines whether the mobile device is within a predetermined proximity of a travel location device. See operation 49-2306. In one embodiment, the mobile device may detect the presence of a particular device (e.g. located at the travel location, etc.) by receiving a transmitted signal (e.g. RFID, NFC, WiFi, ZigBee, Bluetooth, etc.). In another embodiment, the travel location device may detect the presence of the mobile device. In other embodiments, the computer readable medium may include any device capable of communicating via a wireless communication protocol.

In one embodiment, the determination of whether the mobile device is within a predetermined proximity of a travel location device may be automatic (e.g. an automatic connection established between a device at the travel location and the mobile device, etc.). In other embodiments, the determination may occur manually (e.g. mobile device must be connected to a temporary airport system, a mobile device must receive a wired connection, an “accept connection” screen must be accepted, etc.).

In various embodiment, the determination as to whether the mobile device is within the predetermined proximity of the travel location device may be accomplished by determining whether the mobile device is in communication with the travel location device via a short range wireless communication protocol, by determining whether the mobile device has been manually put in a travel mode, by determining whether the mobile device has been physically coupled to a device at the travel location, and/or by any other method whereby the mobile device is determined to be within a predetermined proximity of the travel location.

Of course, the mobile device may be connected in any manner (e.g. wired or wirelessly, etc.) to the travel location device. Additionally, any number of devices may be connected to the travel location device.

In some embodiments, the determination may include an authentication step. For example, in one embodiment, the mobile device may exchange security tokens with the travel location device as part of determining whether the mobile device is within a predetermined proximity of a travel location. Of course, any cryptography and/or security features may be implemented in determining whether the mobile device is within a predetermined proximity of a travel location.

As shown, if the mobile device is within a predetermined proximity of a travel location device, the mobile device is operated in a travel mode for executing one or more travel-related instructions. See operation 49-2308. In one embodiment, travel mode may include a collection of properties in association with at least one travel feature. For example, in various embodiments, the properties may include, but are not limited to, user preferences, input options, output options, power conservation policies, processing capacity, access permissions, and/or any other type of setting that may be attributable to a tablet computer or a phone device.

In one embodiment, the travel mode may include static settings. In other embodiments, the travel mode may include dynamic features (e.g. settings based on devices in a predetermined proximity, etc.). In a further embodiment, the travel mode may include more than one sub-mode (e.g. season mode, time of day mode, etc.). For example, switching between modes may be done automatically (e.g. environmental, spatial, temporal, and/or situational triggers, etc.) or manually (e.g. triggered by user input, etc.). In this way, the properties can be tailored to specific use environments and situations, maximizing the functionality and interaction of the tablet computer or phone device and the travel location. Further, in another embodiment, a travel location feature may include any feature associated with a travel location. For example, in various embodiments, the travel location feature may include an audio feature, a video feature, a navigation feature, an augmented reality feature, a social networking feature, a checking-in feature, a points of interest feature, a baggage recovery and/or tracking feature, a travel status update feature, and/or any other feature which may be associated with a travel location.

In one embodiment, the travel mode may be activated automatically. For example, in one embodiment, when the mobile device is within a predetermined proximity of the travel location, an application on the device may be activated to control at least some aspect of the mobile device system (e.g. audio, volume, directions, lighting, emergency services, ticket display, parking spot id, etc.).

In other embodiments, the travel mode may be activated manually. For example, in one embodiment, the mobile device may be placed on a mount at a check-in kiosk, and thereby, activate an application on the device to execute a travel-related instruction (e.g. check-in the passenger, verify the passenger identity, pass through security related requirements, etc.).

In another embodiment, operating the mobile device in a travel mode for may be based upon user input (e.g. hardware switch, GUI input, etc.). In another embodiment, the determination may be based on peripherals geographically near the device. For example, in one embodiment, a travel location display arrangement (e.g. at a kiosk, at a terminal, etc.) may include a wireless database (e.g. flight status information, directions, emergency contact information, etc.), one or more devices to assist travelers (e.g. devices to give recommendations, devices to pass a coupon and/or discount, etc.), and/or any other type of peripheral which may be used at the travel-related location. In one embodiment, upon being brought near any of these peripherals, the mobile device may recognize the peripherals, and based off of the recognition, automatically operate the table computer or phone device in a travel mode.

In some embodiments, operating the mobile device in a travel mode may serve as a trigger for one or more instructions. For example, in one embodiment, an instruction may relate to a travel location check-in system, which may include a travel mode trigger, and the mobile device approaching a check-in kiosk. Based off of these triggers, an instruction may run including activating a travel app, displaying ticket purchase information (e.g. confirmation code, etc.), and/or rejecting all unimportant phone calls while the user is at the kiosk. Of course, any instruction may be configured to run in travel mode.

In a separate embodiment, an instruction may relate to passing through a security screening check point at an airport. The instruction may include one or more triggers including operating in travel mode, sensing one or more travel location devices (e.g. wireless database system, etc.), and coming within a set proximity (e.g. 10 feet, etc.) of a security screening device. In response, the instruction may run one or more actions including displaying identification information (e.g. photo, individual id, current address, etc.), validating a security device (e.g. security token, etc.), prompting the user to accept the security token, and after receiving acceptance, validating identification information from the mobile device. In one embodiment, the mobile device may be used to receive and/or transfer a finger associated with the user of the mobile device. In one embodiment, the request for information (e.g. at a security screening, etc.) may be received from a travel location device. In another embodiment, the mobile device may initiate and/or send information regardless of a request from a travel location device.

FIG. 49-24 shows a mobile device interface 49-2400 for interacting with one or more instructions, in accordance with one possible embodiment. As an option, the mobile device interface 49-2400 may be implemented in the context of the architecture and environment of the previous Figures or any subsequent Figure(s). Of course, however, the mobile device interface 49-2400 may be carried out in any desired environment. It should also be noted that the aforementioned definitions may apply during the present description.

As shown, a notification interface 49-2402 may be displayed. In one embodiment, the notification interface may relate to a context-aware program. For example, in one embodiment, the notification may display “You have received an email relating to a travel plan. Would you like to create a travel page?” Of course, any notification may be displayed. In various embodiments, an app associated with managing one or more instructions may be used to be context aware (e.g. of input communications such as email or text, of new apps on the device, of device capabilities, etc.). In other embodiments, a device OS platform system, an online (e.g. website, etc.) system, may be used to gather context aware information relating to the user, the mobile device, any app, and/or any other item associated with the user of the mobile device.

In various embodiments, one or more options may be presented to the user, including the ability to indicate “yes,” the ability to indicate “no,” and/or settings. In one embodiment, settings may relate to the instruction app, the device OS platform system (e.g. which may manage the instructions, etc.), and/or any other system and/or app which may relate to the instruction. In various embodiments, the settings may include global settings (e.g. notifications for all alerts, manner of display, audible alerts, etc.), travel mode (or any mode) specific settings, an instruction specific settings, and/or any other setting associated with the notification and/or instruction.

As shown, in one embodiment, a “yes” option may be selected 49-2404, and a travel page interface 49-2406 may be displayed. In one embodiment, the travel page may aggregate information from one or more sources which may relate to the same travel plans. In various embodiments, information may have been received via a text message, a chat message, a telephone voice recording (e.g. voice mail, etc.), browsing history (e.g. user entered in information on a travel related site, etc.), and/or any other source.

For example, in one embodiment, the user may have received an email relating to a flight reservation, and another email relating to a hotel reservation. Based on the receipt of the email, a notification may be displayed requesting if the user would like to create a travel page. If it is desired to create a travel page, a travel page associated with the reservations (e.g. flight reservation, hotel reservation, etc.) may be created. In various embodiments, the travel page may aggregate information (e.g. taken from one or more emails, taken from online sources, etc.), provide one or more information-specific options (e.g. maps, status, ticket information, navigation assistance, etc.), and/or provide any other relevant option and/or ability. In one embodiment, the aggregation may occur based off of one or more similar criteria (e.g. dates, content, destination, activity, etc.).

In one embodiment, the flight reservation and hotel reservation may relate to a similar date and location. For example, in various embodiments, the travel page may display a pane associated with the flight reservation and another pane associated with the hotel reservation. Of course, in other embodiments, the information may be displayed in any manner.

In one embodiment, the pane associated with the flight reservation may include information-specific options, including an airport map, ability to update status (e.g. arrival time of flight, departure gate, etc.), ability to navigate to airport (e.g. in a car, etc.), e-ticket (e.g. confirmation code, digital ticket, etc.), and/or security screening (e.g. information to assist in passing through security, etc.). In another embodiment, the pane associated with the hotel reservation may include information-specific options, including ability to navigate to hotel, hotel contact information, recommended POIs (points of interest, etc.), map of hotel area, and/or ability to digital check-in. Of course, any relevant option associated with the reservation (and/or activity, etc.) may be presented to the user.

In another embodiment, the user of the mobile device may control the manner that the information-specific options are displayed. For example, in one embodiment, the instruction app (or OS platform system, etc.) may automatically determine the most relevant options to be displayed associated with the travel information. In other embodiments, the user may manually select the options (e.g. from a list, etc.) to be displayed associated with the travel information.

In other embodiments, additional information may be collected and displayed on the travel page. For example, in one embodiment, information may be gathered from a reservation email, and additional information relating to the reservation may be gathered from another source (e.g. website, app, etc.). As an example, in one embodiment, an email may be received associated with a flight reservation. Such an email may contain the flight number, the confirmation reservation number, the departure city, the arrival city, and/or other information. Additional information related to the flight reservation may be gathered from the internet, including the departure gate and the status associated with the flight (e.g. on time, delayed, etc.). Further, additional information may relate to the one or more information-specific options. For example, an airport map, ability to navigate to the airport, ability to update status (e.g. on time, delayed, etc.), and/or security screening (e.g. provide information to facilitate security, security-specific app options, identity verification process, etc.) may be gathered, at least in part, from information on the internet and/or from another source (e.g. airport database, secondary device, etc.).

In another embodiment, additional information may be gathered based off of information in an email relating to a hotel reservation. In various embodiments, the hotel reservation email may indicate the dates, location, confirmation number, and/or other reservation relevant information. Additional information may be provided in the form of additional text and/or information-specific options, including ability to navigate to the hotel, recommended points of interest (e.g. from Yelp reviews, etc.), map of the hotel area, and/or ability to digitally check-in. Of course, in other embodiments, any additional information may be displayed and may be gathered from any source (e.g. internet, app, secondary device, etc.).

In a further embodiment, the travel page may include one or more options, including the ability to add an item, search for an item, and/or take any other option associated with the travel page. In one embodiment, an item may include a reservation, an activity (e.g. theater, concert, etc.), a restaurant, a meeting, and/or any other item which may relate in some manner to the travel page. In another embodiment, the ability to search for one or more items may permit the user to find one or more pertinent items (e.g. if the travel page had many items, searching for a particular item may be useful, etc.). In one embodiment, the displayed panes may change according to what would be most pertinent. For example, in one embodiment, the panes may change depending on the time associated with each pane. For example, after a pane's pertinence has expired (e.g. departing flight has been boarded and taken off, etc.), then the next relevant pane (e.g. the next activity and/or event, etc.) may be displayed.

As shown, a notification interface 49-2408 may be displayed. In one embodiment, the notification interface may relate to another device. For example, in one embodiment, the notification may display “Device [security 1] has requested permission to verify your identity. Proceed?” Of course, any notification may be displayed. In one embodiment, the notification may display information at the request of another device. In another embodiment, the notification may display information at the request of the user's mobile device (e.g. instruction app, any app, OS platform system, etc.).

As an example, in one embodiment, the user may be near a security screening checkpoint. In response to coming within a threshold proximity of a security device (e.g. associated with a security personnel, etc.), a prompt may be displayed on the user's mobile device requesting if it was desired to permit the security personnel's device to verify the user's identity. In various embodiments, one or more security protocols may be implemented to ensure the integrity of the identity validation. In some embodiments, a wired connection, a NFC protocol, and/or any other system may be used to preserve the integrity of the identity validation.

In various embodiments, one or more options may be presented to the user, including the ability to indicate “yes,” the ability to indicate “no,” and/or settings. In one embodiment, settings may relate to the instruction app, the device OS platform system (e.g. which may manage the instructions, etc.), and/or any other system and/or app which may relate to the instruction. In various embodiments, the settings may include global settings (e.g. notifications for all alerts, manner of display, audible alerts, etc.), travel mode (or any mode) specific settings, an instruction specific settings, and/or any other setting associated with the notification and/or instruction.

As shown, a “yes” option may be selected 49-2410, and a travel mode interface 49-2412 may be displayed. In one embodiment, a travel mode interface may include security relevant features (e.g. e-ticket check-in, identity validation, etc.). In other embodiments, a separate security interface may be provided.

In various embodiments, a travel mode interface may include one or more features, a next travel plan item, and/or relevant updates. In one embodiment, one or more features may include show e-ticket, display airport map, display travel page, display flight status, and/or any other feature which may be relevant to the travel mode. Of course, in various embodiments, any feature option may be displayed. In one embodiment, the features options may be automatically displayed according to a relevancy (e.g. based off of most frequently used features, popularity from other users, etc.). In other embodiments, the features options may be manually selected by the user (e.g. by a list of all possible features, etc.).

In another embodiment, the next travel plan item may be displayed, which may include the next scheduled activity, reservation, and/or any item which may be relevant to the travel mode. In one embodiment, the next travel plan item may be taken from a travel page associated with a travel. Of course, in other embodiments, the next travel item may be taken from any source (e.g. online itinerary database, secondary device, etc.).

In one embodiment, relevant updates may relate to a notification, a next travel plan item, an input from another device, and/or any other information which may include an update. As an example, in one embodiment, the update may relate to a notification associated with a request for a security device to verify the user's identity. In response, the update may indicate the status of verifying the user's identity, including syncing and validating the devices, sending an e-ticket, confirming the e-ticket, sending a passport id, confirming the passport id, sending a government issued photo, and/or displaying any other update associated with the security identity validation. In one embodiment, an update result may be displayed below the updates, including, for example, “security cleared,” and/or any other update result which may relate in some manner to the one or more updates. In one embodiment, an option to exit the travel mode may be displayed, whereupon if the option is selected, the travel mode may end. Of course, even after the travel mode has been exited, one or more triggers may later activate the travel mode.

FIG. 49-25 shows a mobile device interface 49-2500 for interacting with one or more instructions, in accordance with one possible embodiment. As an option, the mobile device interface 49-2500 may be implemented in the context of the architecture and environment of the previous Figures or any subsequent Figure(s). Of course, however, the mobile device interface 49-2500 may be carried out in any desired environment. It should also be noted that the aforementioned definitions may apply during the present description.

As shown, a notification interface 49-2502 may be displayed. In one embodiment, the notification interface may relate to an event (e.g. the mobile device and/or an app may be context-aware, etc.). For example, in one embodiment, the notification may display “You created an event entitled ‘Work Party’ and added a “work” tag. Would you like to create an instruction based on these inputs?” Of course, any notification may be displayed. In various embodiments, an app associated with managing one or more instructions may be used to be context aware (e.g. of app events and/or updates, of input communications such as email or text, of new apps on the device, etc.). In other embodiments, a device OS platform system, an online (e.g. website, etc.) system, may be used to gather context aware information relating to the user, the mobile device, any app, and/or any other item associated with the user of the mobile device.

In various embodiments, one or more options may be presented to the user, including the ability to indicate “yes,” the ability to indicate “no,” and/or settings. In one embodiment, settings may relate to the instruction app, the device OS platform system (e.g. which may manage the instructions, etc.), and/or any other system and/or app which may relate to the instruction. In various embodiments, the settings may include global settings (e.g. notifications for all alerts, manner of display, audible alerts, etc.), travel mode (or any mode) specific settings, an instruction specific settings, and/or any other setting associated with the notification and/or instruction.

In some embodiments, the instruction app (or OS platform system, another app, etc.) may monitor the input actions to create a possible instruction. For example, creating a calendar event, sending a photo, updating a social networking page, posting a blog post, checking for restaurants with good reviews, receiving an email, traveling to a same location, and/or giving and/or receiving any input action may be used to display a prompt for creating a new instruction. In some embodiments, a threshold requirement (e.g. two times, etc.) on the input actions may be required before a notification prompt is displayed.

As shown, a “yes” option may be selected 49-2504, and a create instruction interface 49-2506 may be displayed. In various embodiments, a create instruction interface may display one or more instruction matches. For example, in one embodiment, the instruction matches may relate in some manner to the identified input actions (e.g. to one or more actions given by the user, etc.). In one embodiment, the user may set a threshold relevancy value (e.g. minimum of two same actions, etc.) that must be met in order for a match to be displayed. Based on creating an event and adding a work tag, a possible match may include “Instruction ‘Calendar Sharing’; Triggers: Open Calendar, Create Event, Add Tag; Actions: Fetch Map and/or other Location Specific Info; Email Event to Contacts Associated with Tag,” “Instruction ‘Calendar Sync’; Triggers: Open Calendar, Create Event; Actions: Sync Calendar with Online Calendar System; Manage Calendar across multiple devices and/or users,” “Instruction ‘Calendar Type Management’; Triggers: Create Event; Actions: Select Calendar Owner based on Context; Email Calendar Owner to Notify of New Event,” “Instruction ‘Calendar Social Sharing’; Triggers: Open Calendar, Create Event, Add Tag; Actions: Email to Group 1, Send SMS link to Group 2, Upload to Facebook, Post to Twitter,” and/or any other relevant match.

In one embodiment, if a threshold of actions matches an instruction, the instruction may be automatically selected. In another embodiment, if more than one instruction results after the threshold is exceeded, all such results may be presented to the user for selection. Additionally, in one embodiment, more than one instruction match may be selected. For example, the user may be interested in possible actions and/or triggers from more than one instruction match (e.g. sharing features of a match, productivity features of another match, etc.). As such, selecting more than one instruction match may enable the user to add, remove, and/or modify the combined instruction in any manner.

In another embodiment, the user may disregard the instruction matches and select to create a new instruction. Additionally, in one embodiment, a create instruction interface may display by default a new instruction interface rather than one or more instruction matches. Of course, the default view of the create instruction interface may be set and/or configured by the user (e.g. via options, via app settings, via Native Utility Platform, etc.).

After selecting the one or more instruction matches, the “proceed” prompt may be selected 49-2508, and a modify instruction interface 49-2510 may be displayed. In various embodiments, the modify instruction interface page may include possible triggers and actions, the ability to add, remove, and/or customize the triggers and/or actions, the ability to specify details (e.g. specify contacts in a group, specify blog details, specify application, etc.) relating to the triggers and/or actions, identify the relevancy (e.g. photo, calendar, contact management, productivity, video, social media, sharing, etc.) of the triggers and/or actions, and/or any other feature which may modify the instruction in some manner.

In one embodiment, actions and/or triggers relating to the selected one or more instructions may be displayed and/or modified. For example, in one embodiment, the relevancy may be automatically set (e.g. based off of the relevancy tag of the one or more instruction matches, etc.), and/or may be set by the user (e.g. via drop down menu, etc.). In another embodiment, upon selection of the relevancy, the triggers and/or actions may change to display a set of relevant triggers and/or actions. After the relevant triggers and/or actions are displayed, items relevant to the selected one or more instruction matches may be pre-selected. Additionally, if an item included with the one or more instruction matches is not included with the relevant triggers and/or actions, it may be added to the list of triggers and/or actions. In a further embodiment, a custom trigger and/or action may be added and/or deleted, including inserting a trigger and/or action not associated with the relevant triggers/actions (e.g. an item associated with productivity, etc.), creating a new trigger and/or action not associated with any previously created trigger and/or action, and/or adding any item not already listed with the relevant triggers and/or actions.

In some embodiments, a calendar relevancy may display calendar relevant triggers, including the ability to open calendar, select one or more events, create an event, receive an event in a message, add a tag, select to share an event, and/or select any other function which may relate to a calendar. Additionally, in another embodiment, a calendar relevancy may display calendar relevant actions, including the ability to sync event, email to group, upload to blog, send SMS link to group, upload to Facebook, post to Twitter, respond to event invite based on availability, and/or select any other action which may relate to a calendar.

In various embodiments, the modify instruction interface may display one or more options, including the option to add metadata, to add settings, to finalize, and/or to save. Of course, any option which may relate to the modify instruction interface and/or to navigating the create instruction interface may be displayed. In one embodiment, saving the instruction may include storing the instruction in a local cache on the mobile device, on an online server and/or database, on a local database, and/or on any other device and/or storage hardware. In one embodiment, at the time of saving the instruction, a backup copy of the instruction may be saved in another location. Additionally, in another embodiment, saving the instruction may include sending and/or posting the instruction to an instruction database site to be shared with other users.

As shown, a finalize option may be selected 49-2512 and a finalize instruction interface may be displayed 49-2514. In one embodiment, the finalize instruction interface may display all triggers, actions, metadata, settings, and/or any further information which may relate in some manner to the created instruction. In one embodiment, the user may select an errors option to verify if there are any errors associated with the instruction (e.g. inconsistent rules, inadequate permissions, etc.) and/or any errors associated with executing the instruction (e.g. with respect to other instructions, with respect to system resources, with respect to other applications, etc.).

In another embodiment, a modify option may be selected to modify the selected triggers, actions, metadata, and/or settings. In one embodiment, an execute option may be selected to immediately execute (e.g. run, etc.) the created instruction. Further, in another embodiment, the instruction may be saved, including storing the instruction in a local cache on the mobile device, on an online server and/or database, on a local database, and/or on any other device and/or storage hardware. In one embodiment, at the time of saving the instruction, a backup copy of the instruction may be saved in another location. Additionally, in another embodiment, saving the instruction may include sending and/or posting the instruction to an instruction database site to be shared with other users.

FIG. 49-26 shows a mobile device interface 49-2600 for interacting with one or more instructions, in accordance with one possible embodiment. As an option, the mobile device interface 49-2600 may be implemented in the context of the architecture and environment of the previous Figures or any subsequent Figure(s). Of course, however, the mobile device interface 49-2600 may be carried out in any desired environment. It should also be noted that the aforementioned definitions may apply during the present description.

In one embodiment, a notification interface 49-2602 may be displayed. In one embodiment, the notification interface may relate to exceeding a trigger threshold. For example, in various embodiments, the trigger threshold may relate to receiving a set of continuous action inputs repeatedly (e.g. five times, etc.) in a given time period (e.g. week, month, etc.). In one embodiment, the action inputs and trigger threshold may be monitored by the instruction app. However, in other embodiments, an instruction database (e.g. associated with an online system, associated with the mobile device, etc.), another app, an OS/Platform native utility system, and/or any other software system may monitor the action inputs and trigger threshold.

As an example, in one embodiment, a trigger threshold notification may display “The following continuous inputs have occurred 5 times in the past week: arrive at work, mute ringer, open email app, start timestamp using Toggl.” A prompt may also be displayed “Would you like to create an instruction.”

In various embodiments, the trigger threshold may be based off a behavioral context. For example, in some embodiments, a behavioral context may include monitoring keystrokes, motions, destinations, and/or any other input which may provide a context to the behavior of the user. As an example, in one embodiment, a user may have repeatedly in the past performed a set of input actions (e.g. but not sufficient to trigger a threshold, etc.). Based off of the past input actions, the instruction app (or whatever system is monitoring the input actions) may prompt the user if the user would like the device to finish a combination of keystrokes, motions, and/or any other input the user would normally give. In this manner, the device may learn from the user and recommend instructions based off of past usage and/or actions. Additionally, in learning from the user, the device may assist in increasing the efficiency (e.g. decreasing the actions taken by the user, etc.) of the user. Of course, the behavioral context may monitor any action and/or may be restricted as desired by the user.

In some embodiments, one or more options associated with the notification interface may include a “yes” button, an “ignore” button, and an “options” button. In some embodiments, selecting ignore will cause the notification to exit. In other embodiments, selecting ignore may also cause any future related notifications to not be displayed. In one embodiments, selecting options may include adjusting one or more settings (e.g. adjust threshold, notification display, audible alerts, etc.) relating to a trigger threshold. In some embodiments, the options may relate globally to an instruction app. In other embodiments, the options may relate specifically to the displayed notification.

As shown, a “yes” button may be selected 49-2604, and a create instruction interface 49-2606 may be displayed. In one embodiment, the detected action inputs may be displayed. In some embodiments, one or more matches (e.g. based on the action inputs, etc.) may be displayed. In one embodiment, an exact match (e.g. using all of the action inputs, etc.) may not be found. In another embodiment, one or more recommended instructions may be displayed which may relate in some manner to at least one of the input actions. For example, in one embodiment, an exact match to the action inputs (e.g. arrive at work, mute ringer, open email app, start timestamp using Toggl, etc.) may not be found, but a recommended instruction may be found, including “Instruction ‘Work Management’; Triggers: Arrive at Work; Actions: Mute Ringer, Open Calendar, Record Timestamp,” “Instruction ‘Email Management’; Triggers: Receive new email; Actions: Apply one or more filters to the email, Prioritize mail based on content, Display notification,” and/or display any other instruction which may relate in some manner to the input actions.

As shown, a “yes” option may be selected 49-2608, and a create custom instruction interface 49-2610 may be displayed. In various embodiments, the create custom instruction interface may include a relevancy drop-down box (e.g. photo, calendar, business, social networking, etc.), one or more possible triggers, currently selected triggers, one or more possible actions, currently selected actions, and/or options associated with the custom instruction interface including add metadata, add settings, finalize, and/or save. Of course, any feature and/or item may be displayed on the create custom instruction interface.

In one embodiment, the possible triggers may include location, user input, network, open app, take photo, time, and/or any other trigger. In another embodiment, the possible actions may include apply filter, update twitter, control ringer, give ETA, update progress, confirm payment and/or any other action. In one embodiment, possible triggers and/or actions may be dragged and dropped to the currently selected triggers pane and/or currently selected actions pane, respectively. In other embodiments, the possible triggers and/or actions may be displayed as a list of selectable options (e.g. a user may star and/or select in some manner desired triggers and/or actions, etc.), as a dropdown menu of possibilities, and/or in any other manner.

In one embodiment, an add metadata option may provide an interface which includes the ability to insert an instruction title, an author, a location/geotag, a tag (e.g. data content, application content, etc.), a relevancy (e.g. photo, sharing, etc.), applicable apps (e.g. apps which may relate and/or may be included in the instruction, etc.), priority (e.g. high, regular, low, priority with respect to other instructions being executed, etc.), creation date, the ability to import instruction settings as metadata (e.g. settings are also imported as metadata values associated with the instruction, etc.), and/or any other value which may relate to metadata.

Additionally, an add settings option may provide an interface which includes global settings, such as permissions (e.g. associated with device, contacts, entities, locations, etc.), ability to verify the instruction source (e.g. in the instance where an instruction is sent from another contact and/or device to the user's mobile device, etc.), restrictions where the instruction will not run if there is less than 100 mb left on the data plan, will not run on the carrier network if the data exceeds 500 mb, will not run if the battery is less than a set amount, and/or any other feature which may relate globally to the instruction and/or the application managing instructions. Of course, in another embodiment, any global setting may be modified on an individual instruction by instruction basis.

In various embodiments, the add settings interface may also include instruction specific settings, including permissible run time (e.g. morning, night, 6 am-6 pm daily, Monday-Friday, etc.), permissible run locations (e.g. based off of device location, etc.), permissible run friends (e.g. instruction may be run when a device and/or contact is near, instruction may be prevented to be run when a device and/or contact is near, etc.), automatic settings (e.g. configure user's mobile device based on triggers, actions, and/or settings, etc.), settings associated with controlling the user's mobile device (e.g. set volume, set screen brightness, set power mode, etc.), and/or any other settings which may relate in some manner to the instruction. In another embodiment, a user may download and/or select a set of predefined settings (e.g. included in the instruction file, etc.), and/or may input all settings relating to the instruction.

As shown, a finalize option may be selected 49-2612 and a finalize instruction interface may be displayed 49-2614. In one embodiment, the finalize instruction interface may display all triggers, actions, metadata, settings, and/or any further information which may relate in some manner to the created instruction. In one embodiment, the user may select an errors option to verify if there are any errors associated with the instruction (e.g. inconsistent rules, inadequate permissions, etc.) and/or any errors associated with executing the instruction (e.g. with respect to other instructions, with respect to system resources, with respect to other applications, etc.).

In another embodiment, a modify option may be selected to modify the selected triggers, actions, metadata, and/or settings. In one embodiment, an execute option may be selected to immediately execute (e.g. run, etc.) the created instruction. Further, in another embodiment, the instruction may be saved, including storing the instruction in a local cache on the mobile device, on an online server and/or database, on a local database, and/or on any other device and/or storage hardware. In one embodiment, at the time of saving the instruction, a backup copy of the instruction may be saved in another location. Additionally, in another embodiment, saving the instruction may include sending and/or posting the instruction to an instruction database site to be shared with other users.

As an option, the aforementioned mobile device may be capable of operating in a location-specific mode, in the context of any of the embodiments disclosed hereinabove. Specifically, in one embodiment, a location associated with the mobile device may be determined. Further determined may be a presence of at least one other person at the location. Still yet, a graphical user interface may be automatically displayed. Such graphical user interface may be specifically associated with the determined location and the determined presence of the at least one other person. In another embodiment, the system, method, or computer program product may be capable of determining a location associated with the mobile device and automatically determining that the location is proximate to a previously identified item of interest. To this end, a graphical user interface associated with the determined location and the previously identified item of interest may be displayed. More information regarding such location-specific features that may or may not be incorporated into any of the embodiments disclosed herein, may be found in U.S. patent application Ser. No. 13/652,458, filed Oct. 15, 2012, titled “MOBILE DEVICE SYSTEM, METHOD, AND COMPUTER PROGRAM PRODUCT,” which is incorporated herein by reference in its entirety.

In various other optional embodiments, the features, capabilities, and/or technology, etc. of the television, mobile devices, and/or mobile device applications, etc. disclosed in the following patents/applications may or may not be incorporated into any of the embodiments disclosed herein: U.S. Pat. No. 8,078,397, U.S. Pat. No. 7,669,123, U.S. Pat. No. 7,725,492, U.S. Pat. No. 7,788,260, U.S. Pat. No. 7,797,256, U.S. Pat. No. 7,809,805, U.S. Pat. No. 7,827,208, U.S. Pat. No. 7,827,265, U.S. Pat. No. 7,890,501, U.S. Pat. No. 7,933,810, U.S. Pat. No. 7,945,653, U.S. Pat. No. 7,970,657, U.S. Pat. No. 8,010,458, U.S. Pat. No. 8,027,943, U.S. Pat. No. 8,037,093, U.S. Pat. No. 8,081,817, U.S. Pat. No. 8,099,433, US20080033739A1, US20080046976A1, US20090144392A1, US20090198487A1, US20100049852A1, US20100132049A1, US20100164957A1, US20100169327A1, US20100198581A1, US20100229223A1, US20100257023A1, US20110044354A1, U.S. Non-Provisional application Ser. No. 13/652,458, filed Oct. 15, 2012; U.S. Provisional Application No. 61/547,638, filed Oct. 14, 2011; U.S. Provisional Application No. 61/567,118 dated Dec. 5, 2011; U.S. Provisional Application No. 61/577,657 dated Dec. 19, 2011; U.S. Provisional Application No. 61/599,920 dated Feb. 16, 2012; and/or U.S. Provisional Application No. 61/612,960 dated Mar. 19, 2012. Each of the foregoing patents/applications is hereby incorporated by reference in its entirety for all purposes.

The elements depicted in flow charts and block diagrams throughout the figures imply logical boundaries between the elements. However, according to software or hardware engineering practices, the depicted elements and the functions thereof may be implemented as parts of a monolithic software structure, as standalone software modules, or as modules that employ external routines, code, services, and so forth, or any combination of these, and all such implementations are within the scope of the present disclosure. Thus, while the foregoing drawings and description set forth functional aspects of the disclosed systems, no particular arrangement of software for implementing these functional aspects should be inferred from these descriptions unless explicitly stated or otherwise clear from the context.

It will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods or processes described above, and steps thereof, may be realized in hardware, software, or any combination of these suitable for a particular application. The hardware may include a general-purpose computer and/or dedicated computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals.

It will further be appreciated that one or more of the processes may be realized as computer executable code created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software.

In one embodiment, each method described above and combinations thereof may be embodied in computer executable code that, when executing on one or more computing devices, performs the acts and/or provides the capabilities thereof. In another embodiment, the methods may be embodied in systems that perform the acts and/or provides the capabilities thereof, and may be distributed across devices in a number of ways, or all of the functionality may be integrated into a dedicated, standalone device or other hardware. In another embodiment, means for performing the steps associated with the processes described above may include any of the hardware and/or software described above. All such permutations and combinations are intended to fall within the scope of the present disclosure.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1-112. (canceled)

113. A system, comprising:
a non-transitory memory storing instructions; and
one or more processors in communication with the non-transitory memory, wherein the one or more processors execute the instructions to:
identify one or more triggers associated with a selection of two or more photos;
receive a first selection of a photos application;
present a plurality of photos displayed within the photos application;
receive a first input corresponding with a trace path associated with the presented plurality of photos;
transform the first input to a selection of two or more of the plurality of photos;
in response to the selection, process the one or more triggers to identify an instruction; and
execute the instruction in connection with a mobile device, based on the one or more triggers.

114. A device, comprising:
a non-transitory memory storing instructions; and
one or more processors in communication with the non-transitory memory, wherein the one or more processors execute the instructions to:
display a plurality of photos;
receive first input data corresponding with a trace path associated with the displayed plurality of photos;
transform the first input data to a selection of two or more of the plurality of photos;
determine whether a second input data is received, wherein if second input data is received, the selection is modified and updated;
receive a third input to share the two or more of the plurality of photos corresponding with the selection, where the two or more of the plurality of photos are uploaded to a server;
share the two or more of the plurality of photos corresponding with the selection, based on the third input and the upload.

115. The device of claim 114, wherein the first input data is based on a touch input.

116. The device of claim 114, wherein the trace path is based on a touch input.

117. The device of claim 114, wherein the trace path is based on a stylus input.

118. The device of claim 114, wherein the trace path corresponds to a single continuous input motion.

119. The device of claim 114, wherein the trace path is increased based on the second input data.

120. The device of claim 114, wherein the trace path is decreased based on the second input data.

121. The device of claim 114, wherein the trace path is located on more than one user interface page.

122. The device of claim 121, wherein the more than one user interface page corresponds with a scrollable screen displayed on the device.

123. The device of claim 114, wherein the two or more of the plurality of photos corresponding with the selection are further grouped into a first album.

124. The device of claim 114, wherein the two or more of the plurality of photos corresponding with the selection are further grouped into a first montage.

125. The device of claim 114, wherein the share includes uploading the two or more of the plurality of photos corresponding with the selection to a social networking site.

126. A computer-implemented method, comprising:
displaying, using a processor, a plurality of photos;
receiving, using the processor, first input data corresponding with a trace path associated with the displayed plurality of photos;
transforming, using the processor, the first input data to a selection of two or more of the plurality of photos;
determining, using the processor, whether a second input data is received, wherein if second input data is received, the selection is modified and updated;
receiving, using the processor, a third input to share the two or more of the plurality of photos corresponding with the selection;
uploading, using the processor, the two or more of the plurality of photos to a server;
sharing, using the processor, the two or more of the plurality of photos corresponding with the selection, based on the third input and the upload.

127. A computer program product comprising computer executable instructions stored on a non-transitory computer readable medium that when executed by a processor instruct the processor to:
display a plurality of photos;
receive first input data corresponding with a trace path associated with the displayed plurality of photos;
transform the first input data to a selection of two or more of the plurality of photos;
determine whether a second input data is received, wherein if second input data is received, the selection is modified and updated;
receive a third input to share the two or more of the plurality of photos corresponding with the selection;
upload the two or more of the plurality of photos to a server;
share the two or more of the plurality of photos corresponding with the selection, based on the third input and the upload.

128. The device of claim 114, wherein the two or more of the plurality of photos are uploaded to the server in response to the selection.

129. The device of claim 114, wherein the two or more of the plurality of photos are uploaded to the server before the selection.

130. The device of claim 114, wherein the trace path corresponds to a multiple non-continuous input motions.

131. The device of claim 114, wherein the trace path corresponds to a broken non-continuous input motion.

132. The device of claim 114, wherein the one or more processors execute the instructions to permit the trace path to span multiple user interface pages such that the trace path causes a scroll operation among the multiple user interface pages.
